(19) United States
(12) Patent Application Publication
(10) Pub. No.: US 2024/0273630 A1
(43) Pub. Date: Aug. 15, 2024

(54) Information Generation Device, Information Presentation System, And Information Generation Program

(71) Applicant: RISINGBULL.INC, Tokyo (JP)

(72) Inventor: Tetsuya FUJIMURA, Tokyo (JP)

(21) Appl. No.: 18/279,779

(22) PCT Filed: Mar. 8, 2022
(86) PCT No.: PCT/JP2022/009952

§ 371 Date: Sep. 1, 2023

(30) Foreign Application Priority Data
Mar. 8, 2021 (JP) 2021-036764
Jul. 20, 2021 (JP) 2021-119879

(51) Int. Cl. G06Q 40/06; G06Q 40/04

(52) U.S. Cl. CPC G06Q 40/06; G06Q 40/04

(57) ABSTRACT

Provide an evaluation on the trading data for investment commodities. The server (30) includes an information generation unit (3021) configured to generate, for each period, trading profit and loss level trading data classified into levels according to the trading situation of the investment commodity in each period, according to the trading situation of the investment commodity in each period, the trading profit and loss level trading data classified into levels, and the trading profit and loss level trading data classified into levels from the trading profit and loss level trading data, calculate the trading profit and losses level valuation indicators classified into levels from the trading profit and loss level trading data, calculate the trading profit/loss level valuation indicator classified into levels from the trading profit and loss level trading data, and generate valuation information of trading profit/loss and unrealized profit/loss per period using the trading profit/loss level valuation indicator and the unrealized profit and losses level valuation indicator.

### TECHNICAL FIELD

The present invention relates to an information generating apparatus, an information presentation system, and an information generation program.

### BACKGROUND OF THE INVENTION

Conventionally, a system for advising individual investors has been known. For example, Patent Literature 1 discloses financial investment management, portfolio management, and educational and analytical tools for a member via an Internet site.

### CITATION LIST

### Patent Literature

Japanese Patent Publication No. 2003-531444 (published Oct. 21, 2003, published Oct. 25, 2001).

### SUMMARY OF INVENTION

### Technical Problem

While there are tools for evaluating static portfolios and stocks, there are currently no tools for acquiring trading data of investors, evaluating and diagnosing trading data that dynamically changes based on the trading data of the investors and then comparing and advising others.

Although trading is a factor of investor disparities, there are no services to evaluate, diagnose, compare, and advise on under present circumstances.

In the past, brokerage firms' sales representatives offered free services based on the trading data of individual investors to grasp the current situation and make proposals for improvement while comparing them with other customers. On the other hand, in recent years, due to the spread of securities transactions over the Internet, functions such as proposals from securities companies having trading data, diagnosis, and comparison with others have been lost, particularly in net securities. As a result, the problems mentioned above are considered to be more remarkable.

As a result of the inability to compare and understand the current situation of whether or not the correct trading is being done, and the loss of the advice function, the investment gap among individual investors has widened, and speculative trading has also been encouraged. “There are also current situations that do not lend themselves to the direction of investment.” “Investors are becoming confused because they are no longer aware of what trading should be done.”

It is an object of an aspect of the present invention to provide an evaluation related to trading data for investment commodities.

### Solution to Problem

To solve the above problem, an information generating apparatus, according to an aspect of the present invention, is an information generating apparatus that generates information regarding the profit and loss of an investment commodity and includes an information generating apparatus that acquires trading data for investment commodity and evaluation change an investment commodity held at the beginning of a predetermined period and/or an investment commodity held at the end of the predetermined period concerning the trading data.

In information generating apparatus according to an aspect of the present invention, the information generation unit includes an information generating apparatus that performs evaluation change at an initial price for trading data of an investment commodity that has been purchased at the beginning of the predetermined period and performs evaluation change at an end price for trading data of an investment commodity that is held at the end of a predetermined period.

According to the above configuration, it is possible to evaluation change of the investment commodity in a predetermined period.

In the information generating apparatus, according to an aspect of the present invention, the information generation unit generates the unrealized profit and loss after the evaluation change of the investment commodity held at the end of a predetermined period.

An information generating apparatus, according to an aspect of the present invention, is an information generating apparatus that generates information on trading profit and loss by investment type and includes an information generation unit that acquires trading data for investment commodity, generates investment subject-specific trading data in which the trading data by investment target, and generates information on trading profit and loss for each investment subject and/or information on unrealized profit and loss for each investment subject using the investment subject-specific trading data.

According to the above configuration, it is possible to obtain information relating to trading profit and loss for each investment target and information relating to unrealized profit and loss for each investment target. For example, evaluation information related to each brand's unrealized profit and loss is obtained.

An information generating apparatus according to an aspect of the present disclosure includes an investment commodity that generates information about a profit and loss of a an information generating apparatus, and includes an information generation unit that generates an investment commodity for obtaining a trading data of a Unrealized profit and loss valuation indicators, creating a Trading data by investment target in which trading data is classified for each investment target, and valuation indicators for Trading Profit and Loss for each investment target and/or evaluating a Unrealized profit and loss for each investment target using Trading data by investment target.

In the information generating apparatus, according to an aspect of the present invention, the information generation unit generates comparison information of trading profit and loss between investment targets and/or comparison information of comparative information on unrealized profits and losses between investments the trading profit and loss level valuation information and/or the unrealized profit and loss level valuation information between the investment targets.

According to the above-described configuration, information on comparing trading profit and loss and unrealized profit and loss is obtained between investment targets.

In order to solve the above problem, an information generating apparatus in accordance with an aspect of the invention is an information generator for generating information on evaluation of profit and loss of an investment commodity, and acquires trading data of the above investment commodity, creates aggregated trading data by period by classifying the above trading data by period.

And The information generator generates information by obtaining trading data of the above-mentioned investment commodities, creating period-by-period aggregate trading data Unrealized profit and loss level trading data classifying the above-mentioned trading data for each period, and creating, from the above-mentioned trading data for each period, trading profit and loss level trading data, which is the source of one of the levels of profit and loss, and unrealized profit and loss data, which is the source of one of the levels of profit and loss, according to the trading conditions of the above-mentioned investment commodities in each period.

The trading profit and loss level indicators are calculated from the above trading profit and loss level data to evaluate the trading profit and loss, which is one of the levels of profit and loss, and the unrealized profit and loss level indicators are calculated from the above Unrealized profit and loss level trading data to evaluate the unrealized profit and loss, which is one of the levels of profit and loss, and the above trading profit and loss level valuation indicators and the above unrealized profit and loss level valuation indicators are used to calculate the valuation indicators for each of the above periods.

The information generating section generates evaluation information on trading profit and loss and unrealized profit and loss for each of the above periods using the above trading profit and loss level valuation indicators and the above unrealized profit and loss level valuation indicators.

According to the above configuration, it is possible to evaluate the overall profit and loss of the investment commodity. In addition, by calculating each valuation indicators of the aggregated trading data by period, there is an effect that the trading status or the holding status for each period becomes clear, and the feature of the investment commodity in the group for each period becomes clear.

In the information generating apparatus according to an aspect of the invention, when the above period is from the first time point to the second time point, the above information generator may, with respect to the trading data for investment commodity already purchased at the first time point in the above aggregated trading data by period, change the base valuation of the investment commodity from the unit price at the time of purchase to the unit price at the first time point. For the trading data for investment commodity held at the second point in time, the most recent closing price of the investment commodity may be changed from the unit price at the time of sale or the current unit price to the unit price at the second point in time.

According to the above configuration, changing the reference base valuation and the latest closing value of the aggregated trading data by period makes it possible to accurately evaluate the profit and loss from the first to the fourth level for each period.

In the information generating apparatus, according to one aspect of the present invention, the above information generation unit may generate ranking information of the profit and loss on sales and unrealized profit and loss within the above period by ranking within the above period using the above trading profit and loss level valuation indicators and the above unrealized profit and loss level valuation indicators.

According to the above configuration, it is possible to confirm the order within the period from the ranking result of the profit and loss level valuation indicators of each profit and loss level. For example, when the investment objects are ranked according to the winning profit margin of the traded data, an issue with a high winning profit margin and an issue with a low winning profit margin become clear, and an issue with a high winning profit margin can be selected.

In order to solve the above problem, an information generating apparatus in accordance with an aspect of the invention is an information generator for generating information on evaluation of profit and loss of an investment commodity, and acquires trading data of the above investment commodity, creates aggregated trading data by period by classifying the above trading data by period.

And The information generator generates information by obtaining trading data of the above-mentioned investment commodities, creating period-by-period aggregate trading data classifying the above-mentioned trading data for each period, and creating, from the above-mentioned trading data for each period, trading profit and loss level trading data, which is the source of one of the levels of profit and loss, and unrealized profit and loss data, which is the source of one of the levels of profit and loss, according to the trading conditions of the above-mentioned investment commodities in each period.

The trading profit and loss level indicators are calculated from the above trading profit and loss level data to evaluate the trading profit and loss, which is one of the levels of profit and loss, and the unrealized profit and loss level indicators are calculated from the above Unrealized profit and loss level trading data to evaluate the unrealized profit and loss, which is one of the levels of profit and loss, and the above trading profit and loss level valuation indicators and the above unrealized profit and loss level valuation indicators are used to calculate the valuation indicators for each of the above periods.

The information generating section generates evaluation information on trading profit and loss and unrealized profit and loss for each of the above periods using the above trading profit and loss level valuation indicators and the above unrealized profit and loss level valuation indicators.

According to the above configuration, it is possible to evaluate the overall profit and loss of the investment commodity. In addition, by calculating each valuation indicators of the aggregated target trading data by investment target, each investment commodity's trading status or holding status becomes clear, and the feature of the investment commodity in the group of each investment subject becomes clear.

In the information generating apparatus, according to an aspect of the present invention, the information generation unit may generate information indicating a comparison result of the trading profit and loss and the unrealized profit and loss between the investment targets by comparing the trading profit and loss level valuation indicators and the unrealized profit and loss level valuation indicators between the investment targets.

According to the above configuration, it is possible to clarify the difference in the trading status and the holding status between the investment targets.

### Advantageous Effects of Invention

According to one mode of the present invention, evaluation about the trading data of investment commodity can be provided.

### BRIEF DESCRIPTION OF THE DRAWINGS

FIG. 1 is a figure to show a hardware configuration of an advice presentation system in the first embodiment of the invention.

FIG. 2 is a block figure to show a configuration of a terminal and a server in the first embodiment of the invention.

FIG. 3 is a diagram illustrating an outline of processing of the advice presentation system 1 according to the present embodiment.
(A) is a diagram showing an example of trading data of an investment commodity according to the first embodiment of the present invention, and (b) is a diagram showing an example of valuation indicators of trading data according to the first embodiment of the present invention.

FIG. 5: Flowchart showing the diagnostic process by the principal rotation period according to Embodiment 1.

FIG. 6 is a flowchart showing a diagnosis process based on a Winning profit margin according to a first embodiment of the present invention.

FIG. 7 is a flowchart showing a diagnosis process based on a Losing loss ratio according to a first embodiment of the present invention.

FIG. 8 is a flowchart showing a diagnosis process based on trading profit and loss according to a first embodiment of the present invention.

FIG. 9 is a flowchart showing a classification process of the trading pattern according to the first embodiment of the present invention.

FIG. 10 is a flowchart illustrating a diagnostic process according to the rise and fall rate of the holdings according to the first embodiment of the present invention.

FIG. 11 is a flowchart showing a ranking process according to the principal increase or decrease rate according to the first embodiment of the present invention.

FIG. 12 is a flowchart showing the processing of the overall profit and loss analysis according to the first embodiment of the present invention.

FIG. 13 is a diagram showing an example of an overall profit and loss, trading profit and loss, and an appraisal value of unrealized profit and loss according to the degree of detail according to the first embodiment of the present invention.

FIG. 14 is a diagram illustrating an example of valuation indicators of a holding commodity according to an embodiment 1 of the present invention.

FIG. 15 is a diagram illustrating an example of a pattern of the held goods according to the first embodiment of the present invention.

FIG. 16 is a diagram showing an example of an initial screen of a stock investment simulation according to a second embodiment of the present invention.

FIG. 17 is a diagram showing an example of a question screen of a stock investment simulation according to a second embodiment of the present invention.

FIG. 18 is a diagram showing a transition of a stock price in a stock investment simulation according to a second embodiment of the present invention.

FIG. 19 is a diagram showing the transition of an appraised value for each branch of each question in the stock investment simulation according to the second embodiment of the present invention.

FIG. 20 is a diagram showing a configuration of an information display system according to the fourth embodiment of the present invention.

FIG. 21 is a diagram showing a comparison of the method of the evaluation process according to the fourth embodiment of the present invention.

FIG. 22 is a diagram for explaining the Aggregated trading data by period according to the fourth embodiment of the present invention.

FIG. 23 is a diagram illustrating the Aggregated trading data by period according to the fourth embodiment of the present invention.

FIG. 24 is a diagram showing a procedure of revaluation according to the fourth embodiment of the present invention.

FIG. 25 is a diagram illustrating an example of changing the Trading data with trading profit and loss by period according to the fourth Embodiment of the present invention.

FIG. 26 is a diagram illustrating an example of changing the Trading data with trading profit and loss by period according to Embodiment 4 of the present invention.

FIG. 27 It is a diagram showing a procedure of re-evaluation of the Trading data with unrealized gain and loss according to the fourth embodiment of the present invention.

FIG. 28 is a diagram showing an example of a table of Aggregated trading data by investor according to a fourth embodiment of the present invention.

FIG. 29 Is a diagram illustrating an example of a table of the Aggregated Target Trading Data by Investment Target according to the fourth embodiment of the present invention.

FIG. 30 is a diagram for explaining a difference between Aggregated trading data by profit and loss and Profit and loss level trading data according to the present embodiment.

FIG. 31 is a diagram showing a difference between the process of the old system and the new system of the Aggregated trading data by profit and loss according to the fourth embodiment of the present invention.

FIG. 32 is a diagram showing five methods of evaluation method according to the fourth embodiment of the present invention.

FIG. 33 is a diagram (processing the trading profit and loss level trading data of FIG. 26) illustrating an example in which the trading profit and loss level trading data according to the present embodiment is extracted (or classified, aggregate, processed).

FIG. 34 is a diagram showing the relationship between sales and loss and unrealized profit and loss according to the fourth embodiment of the present invention (not including cash).

FIG. 35 is a diagram showing the relationship between buy and loss and unrealized profit and loss according to the fourth embodiment of the present invention (including cash).

FIG. 36 is a diagram showing a breakdown and the opportunity loss of the appraised value of the profit and 1 trading data by period according to the fourth embodiment of the present invention.

FIG. 37 Trading profit and loss and cash according to the fourth embodiment of the present invention, is a diagram showing the relationship between unrealized profit and loss.

FIG. 38 is a diagram showing the extraction of the winning profit level data according to the fourth embodiment of the present invention.

FIG. 39 is a diagram illustrating extraction of winning-profit level data according to the present embodiment.

FIG. 40 is a diagram showing the processing data (new method) of FIG. 38 in the fourth embodiment of the present invention.

FIG. 41 is a diagram calculated step by step from the profit and loss level trading data according to the fourth embodiment of the present invention.

FIG. 42 is a diagram calculated by stepping on the profit and loss level trading data according to the present embodiment.

FIG. 43 is a diagram showing a specific example of calculation of the profit and loss level stage valuation indicators according to the fourth embodiment of the present invention.

FIG. 44 is a conceptual diagram of a second level (trading profit and loss level trading data) according to the fourth embodiment of the present invention.

FIG. 45 is a diagram illustrating a specific example of a second level (trading profit and loss level trading data) according to the present embodiment.

FIG. 46 is a diagram illustrating a specific example of a second level (an unrealized profit and loss level) according to the present embodiment.

FIG. 47 is a diagram showing the effect of the leverage effect and the compounding effect according to the fourth embodiment of the present invention.

FIG. 48 is a diagram showing a specific example of an aggregated target comparison process according to a fourth embodiment of the present invention.

FIG. 49 is a diagram showing a component comparison process according to the fourth embodiment of the present invention.

FIG. 50 is an explanatory diagram of a comparison process of profit and loss level metrics according to the fourth embodiment of the present invention.

FIG. 51 is a diagram showing a specific example of a ranking description according to the fourth embodiment of the present invention.

FIG. 52 is an explanatory diagram of the components ranking according to the fourth embodiment of the present invention (when the investor and the stock are aggregation target).

FIG. 53 is a diagram showing a specific example of a Multilayered ranking according to the fourth embodiment of the present invention.

FIG. 54 is a diagram showing a specific example of Aggregated target ranking according to a fourth embodiment of the present invention.

FIG. 55 is a diagram illustrating a specific example of the Ranking by multilayered and aggregated target according to the fourth embodiment of the present invention.

FIG. 56 is a diagram showing a specific example of a ranking by profit and loss level according to the fourth embodiment of the present invention.

FIG. 57 is a diagram illustrating a specific example of Linked unrealized profit and loss level trading data according to the fourth embodiment of the present invention.

FIG. 58 is a diagram showing a specific example of winning pattern 1 level trading data according to the fourth embodiment of the present invention.

FIG. 59 Is a diagram illustrating an example of unrealized profit and loss pattern level trading data according to the fourth embodiment of the present invention.

FIG. 60 is a diagram illustrating a specific example of Linked unrealized profit and loss level trading data according to the present embodiment.

FIG. 61 It is a diagram showing a specific example of a winning pattern 1 level trading data according to a fourth embodiment of the present invention.

FIG. 62 is a figure illustrating an exemplary pattern winning according to the present embodiment.

FIG. 63 is a diagram illustrating three comparison processes according to the present embodiment.

FIG. 64 is an information flow diagram of a client and a server according to the fourth embodiment of the present invention.

FIG. 65 is a diagram showing that the generation of investment issues and articles according to the fourth embodiment of the present invention is synonymous with the results of the advice generation system.

FIG. 66 is a figure indicating which data according to the fourth embodiment of the present disclosure is to be accumulated.

FIG. 67 is a figure illustrating a process using a hardware-resource according to the fourth embodiment.

FIG. 68 is a diagram showing a processing method of the information processing system according to the fourth embodiment of the present invention.

FIG. 69 is a figure showing a flow of a process performed by the servers 3 of the information processing system according to the fourth embodiment.

FIG. 70 is a figure showing the process 2 of the information processing device according to the fourth embodiment.

FIG. 71 is a figure indicating a computation process of the information processing device according to the fourth embodiment.

FIG. 72 is a figure showing data configuration of the information processing system according to the fourth embodiment.

FIG. 73 is a figure indicating a look-up table method of the information processing system according to the fourth embodiment.

FIG. 74 is a diagram showing an AI machine learning process of the information processing process according to the fourth embodiment of the present invention.

FIG. 75 is a diagram showing a reference diagram of a display table according to the fourth embodiment of the present invention.

FIG. 76 is a diagram showing a summary of the process of the trading data according to the fourth embodiment of the present invention.

FIG. 77 is a diagram illustrating a flow up to the evaluation step of the information processing process according to the fourth embodiment of the present invention.

FIG. 78 It is a diagram showing valuation indicators determination step according to a fourth embodiment of the present invention.

FIG. 79 Is a diagram showing valuation indicators importance judgment display step according to the fourth embodiment of the present invention.

FIG. 80 is a diagram showing valuation indicators importance judgment process according to the fourth embodiment of the present invention.

FIG. 81 is a diagram showing valuation indicators importance judgment process 2 according to the fourth embodiment of the present invention.

FIG. 82 is a diagram showing a machine learning model of the valuation indicators importance judgment process according to the fourth embodiment of the present invention.

FIG. 83 is a diagram showing valuation indicators importance judgment process 2 according to the fourth embodiment of the present invention.

FIG. 84 is a diagram showing a generation display step of the ranking article according to the fourth embodiment of the present invention.

FIG. 85 is a diagram illustrating the identification of the unopposed trading data and the current value valuation process according to the fourth embodiment of the present invention.

FIG. 86 is a diagram showing a method of capturing the investment commodity price according to the fourth embodiment of the present invention.

FIG. 87 Is a diagram showing the creation of the aggregated trading data by period according to the fourth embodiment of the present invention.

FIG. 88 is a notation diagram of the Linked type holding status evaluation according to the fourth embodiment of the present invention.

FIG. 89 shows a table reference method of the information processing process according to the fourth embodiment of the present invention.

FIG. 90 is a diagram showing a network according to the fourth embodiment of the present invention.

FIG. 91] is a database related view according to the fourth embodiment of the present invention.

FIG. 92 Indicating the related figure of AI training according to the fourth embodiment.

FIG. 93 is showing the association of the table lookup according to the fourth embodiment.

FIG. 94 Indicating a trading data according to the fourth embodiment.

FIG. 95 is a figure first phase figure of AI training according to the fourth embodiment of the present disclosure.

FIG. 96 is a detailed figure second phase figure of AI training according to the fourth embodiment.

FIG. 97 is a detailed figure third phase figure of AI training according to the fourth embodiment.

FIG. 98 is a detailed diagram of a fourth phase diagram of AI training according to a fourth embodiment of the present disclosure.

FIG. 99 is a table of data to be summarized by period according to the fourth embodiment.

FIG. 100 is a summary figure of FIG. 24 to FIG. 26 according to the fourth embodiment.

FIG. 101 is a figure of the first phase according to the fourth embodiment.

FIG. 102 is a figure for describing the second to fourth phases according to the fourth embodiment.

FIG. 103 is an issue selection validation chart figure according to the fourth embodiment.

FIG. 104 is verification chart of stock purchase period according to the fourth embodiment.

FIG. 105 is an issue investment trend chart of another investor in retention period according to the fourth embodiment.

FIG. 106 is issue investment trend chart 2 of another investor in retention period according to the fourth embodiment.

FIG. 107 is an explanation diagram of a step of calculating valuation indicators according to a fourth embodiment of the present invention.

FIG. 108 is an explanatory figure of a combined table of purchase data and sell data according to the fourth embodiment.

FIG. 109 is a leverage effect and a compound interest effect chart according to the fourth embodiment.

FIG. 110 is a figure of a plurality of methods for calculating valuation indicators according to the fourth embodiment.

FIG. 111 is a calculation table figure of valuation indicators according to the fourth embodiment.

### MODE FOR CARRYING OUT THE INVENTION

### Embodiment 1

Hereinafter, a fourth embodiment of the present invention will be described in detail. Note that the details of the diagnosis results, advice, and the like shown below are merely examples, and do not limit the present invention.

### Advice Presentation System 1

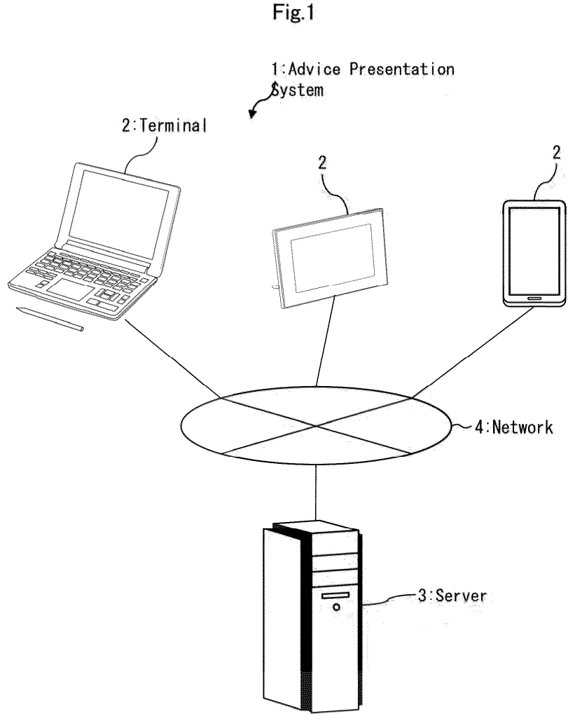

An advice presentation system (information presentation system) 1 according to the present embodiment will be described with reference to the drawings. FIG. 1 is a diagram illustrating a hardware configuration of an advice presentation system 1 according to the present embodiment. As illustrated in FIG. 1, the advice presentation system 1 includes a terminal (terminal device) 2 and a server (the information generating apparatus) 3. The terminal 2 and the server 30 are configured to be able to communicate with each other via the network 4.

The terminal 2 acquires trading data by manipulation of a user, reading from a recording medium, or the like, and displays advice corresponding to the trading data, and is, for example, a PC, a tablet terminal, a smart phone, or the like. The servers 3 generate advice related to trading of investment commodity. The network 4 is a network including the Internet. Incidentally, investment commodity includes stock (including Japanese stock and foreign stock), investment trust, exchange traded fund (ETF), foreign exchange margin transactions (FX), and the like.

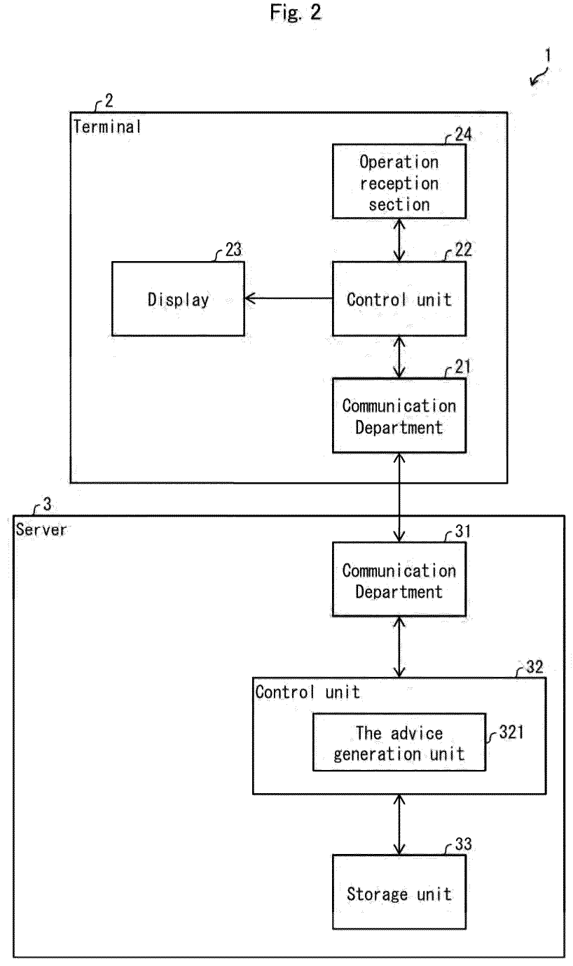

FIG. 2 is a block diagram illustrating a configuration of the terminal 2 and the server 3 according to the present embodiment.

### Terminal 2

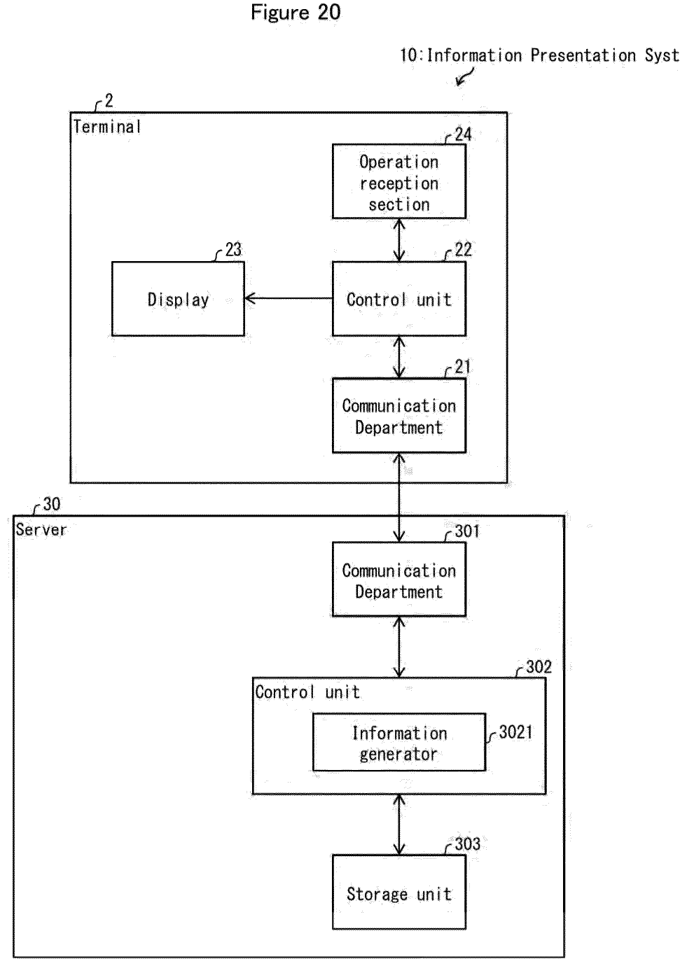

As illustrated in FIG. 20, the terminal 2 includes a communication unit 21, a control unit 22, a display unit 23, and an operation-accepting unit 24. The communication unit 21 communicates with the server 3. The control unit 22 controls the entire terminal 2, and is, for example, one or a plurality of processors. The display unit 23 displays data according to an instruction from the control unit 22, and is, for example, a liquid crystal display or the like. The operation accepting unit 24 accepts an operation of a user, and is, for example, a keyboard, a mouse, a touch panel, or the like.

### (Server 3)

As illustrated in FIG. 2, the servers 3 include a communication unit 31, a control unit 32, and a storage unit 33. The communication unit 31 communicates with the terminal 2. The control unit 32 controls the entire server 30, and is, for example, one or a plurality of processors. The storage unit 33 stores a data according to an instruction from the control unit 22, and is, for example, a hard disk device, a flash memory, or the like.

The control unit 32 includes an advice generation unit (information generation unit) 321. The advice generation unit 321 acquires trading data of an investment commodity, acquires basic data from the acquired trading data, calculates valuation indicators with reference to the acquired basic data, and generates information indicating the calculated valuation indicators. Next, the advice generation unit 321 performs diagnosis with reference to the valuation indicators, and generates information indicating the result of the diagnosis. Then, the advice generation unit 321 generates information indicating advice corresponding to the diagnosis result.

Here, the evaluation refers to calculating and evaluating each index from trading data, and the diagnosis refers to diagnosing what type of trading has been performed based on these indices, and the advice refers to advising based on the evaluation result and the diagnosis result. However, the process of evaluation, diagnosis, and advice is not essential and may be provided separately.

Further, the advice generation unit 321 may acquire the profit and Total losing loss from trading data, calculate valuation indicators with reference to the profit and Total losing loss, and generate information indicating the calculated valuation indicators. Next, the advice generation unit 321 may acquire the sum trading profit and loss and the total unrealized profit and loss from the trading data, calculate valuation indicators with reference to the total trading profit and loss and the total unrealized profit and loss, and generate information indicating the calculated valuation indicators. Then, the advice generation unit 321 may acquire the total winning profit, the total losing loss, and the total unrealized profit and loss from the trading data, calculate valuation indicators with reference to the total winning profit, the total losing loss, and the total unrealized profit and loss, and generate information indicating the calculated valuation indicators.

Further, the advice generation unit 321 may acquire the traded data from the trading data, classify the traded data into a pattern corresponding to the buying value, the selling value, and the market value after the sale, calculate the profit and Total losing loss for each pattern, calculate the valuation indicators with reference to the profit and Total losing loss for each pattern, and generate information indicating the calculated valuation indicators. The market value after the sale indicates the market value after a certain period of time after the sale, and includes, for example, the market value after three months of the sale, the market value after one year, and the market value at the valuation. The terminal 2 presents the information generated by the advice generation unit 321 to the user.

Further, the advice generation unit 321 may calculate valuation indicators with reference to the trading data, compare and rank the investors with reference to the calculated valuation indicators, and generate information indicating the comparison and ranking of the investors as the valuation indicators. The comparison here refers to the comparison of the valuation indicators of the investor with the valuation indicators of another investor, the average value of the valuation indicators, and the like.

### (Processing Overview of the Advice Presentation System 1)

FIG. 3 is a diagram illustrating an outline of processing of the advice presentation system 1 according to the present embodiment. An outline of the processing of the advice presentation system 1 will be described with reference to FIG. 3.

### (Step S301)

In the terminal 2, the control unit 22 acquires the trading data for investment commodity from the operation acceptance unit 24 or the like, and transmits the trading data to the server 3 by the communication unit 21. Details of the trading data will be described separately.

### (Step S302)

In the server 3, the control unit 32 receives the trading data from the terminal 2 by the communication unit 31. The advice generation unit 321 calculates valuation indicators from the trading data. The control unit 32 transmits the calculated valuation indicators to the terminal 2 as an evaluation result by the communication unit 31. Details of the valuation indicators will be described separately.

### (Step S303)

In the terminal 2, the control unit 22 receives the evaluation result from the server 3 by the communication unit 21, and causes the display unit 23 to display the evaluation result.

### (Step S304)

In the server 3, the advice generation unit 321 diagnoses the User trading trend or sell from the valuation indicator calculated in the step S302. The control unit 32 transmits the diagnosed tendency of buying and selling to the terminal 2 as a diagnosis result by the communication unit 31.

### (Step S305)

In the terminal 2, the control unit 22 receives the diagnosis result from the server 3 by the communication unit 21, and causes the display unit 23 to display the diagnosis result.

### (Step S306)

In the server 3, the advice generation unit 321 compares and ranks the investors from the assessment indices calculated in the step-wise S302. The control unit 32 transmits the comparison data and the ranking data of the investor to the terminal 2 by the communication unit 31.

### (Step S307)

In the terminal 2, the control unit 22 receives the comparison data and the ranking data of the investor from the server 3 by the communication unit 21, and causes the display unit 23 to display the comparison and the ranking of the investor.

### (Step S308)

In the server 3, the advice generation unit 321 generates advice on the sale and purchase of the investment commodity by referring to the trading data for investment commodity, the valuation indicators, the user trading trend, the comparison data of the investor, the ranking data, and the like. The control unit 32 transmits the generated advice to the terminal 2 by the communication unit 31.

### (Step S309)

In the terminal 2, the control unit 22 receives, from the server 3 by the communication unit 21, advice on the sale and purchase of the investment commodity, and causes the display unit 23 to display the advice.

Note that, in the server 3, calculate of valuation indicators, storage in a DB, creation of diagnostic data, and storage in a DB, which are performed by referring to trading data to be evaluated, are executed by, for example, a batching process. DB is set, for example, in the storage unit 33 of the server 3.

### (Examples of Trading Data)

FIG. 4A is a diagram illustrating an example of trading data of an investment commodity according to the present embodiment. The following is an example of a stock as an investment commodity. As illustrated in FIG. 4A, the trading data includes a brand code, the number of shares to be purchased, a purchase date, and a purchase price. The sold data also includes the sale date and the sale price. In addition, the trading data in the case of entering from selling (for example, in the case of conducting a margin transaction or the like) includes a brand code, the number of shares to be sold, the date of sale, and the selling price. The repurchased data further includes a repurchase date and a repurchase price.

The brand code is a code for specifying a brand of a stock to be traded. The number of shares purchased is the number of shares purchased by the user. The purchase date is the date the user purchased the stock. The purchase price is a stock price when the user purchases a stock. The sale date is the date the user sold the stock. The selling price is a stock price when the user sells the stock.

### (Examples of Valuation Indicators)

FIG. 4 is a figure exemplifying valuation indicators of according to the present embodiment Trading valuation indicators of. The following is an example of a stock as an investment commodity. As illustrated in FIG. 4B, the valuation indicators is calculated by a plurality of evaluation axes. As the valuation indicators, for example, a turnover force, a Winning profit margin, a Losing loss ratio, a trading profit and loss, an increase/decrease rate of a holding stock, a principal increase/decrease rate, and the like are examples.

The basic numerical values to be described later refer to numerical values obtained from trading data such as principal, elapsed period, and number of trades. The valuation indicators refers to an index calculated from the basic numerical values and the like. The evaluation axis refers to a point of view for evaluating trading data, and is composed of a single or a plurality of valuation indicators.

As an example of the evaluation axis, the rotation force is an example of an evaluation axis indicating how much the user rotates the principal at what pace, in other words, how often the user replaces the issue. Examples of the index related to the rotational force include an average retention period, a Number of principal turnover, a Number of days of revolution of principal, and an average trading period difference. The rotational force index is an index for evaluating, comparing, diagnosing, and advising on how often the trading is conducted.

The average retention period is the average of the retention periods of trading stocks. The number of revolutions of the principal is an index indicating the number of revolutions of the principal in a predetermined period, and is calculated by “the trading price in a predetermined period divided by the principal”. The principal rotational period is an average value of a period in which the principal rotates by one revolution, and is calculated by “the number of days of a predetermined period divided by the Number of principal turnover”. The average trading period difference is calculated by “Average trading period for winning-Average trading period for losing”.

The Winning profit margin, which is an example of the evaluation axis, is an example of an evaluation axis indicating the profit ratio for winning, and is calculated from winning data obtained by classifying the traded data by “profit amount per winning/trade/selling price per winning”. The profit amount per win is calculated by “total profit amount/number of wins”. The trading value per winning is calculated by “total trading value in the case of winning/number of winning”. The Winning profit margin is an example of an evaluation axis for evaluating, comparing, and diagnosing winning patterns and advising on how to win.

The Losing loss ratio, which is an example of the evaluation axis, is an example of an evaluation axis indicating a Losing loss ratio in the case of loss, and is calculated from the loss data obtained by classifying the traded data by “loss amount per loss/trading price per loss”. The amount of loss per loss is calculated by “total loss divided by the number of loss.” The trading value per loss is calculated by “total trading value in the case of a loss divided by the number of losses”. The Losing loss ratio is an example of an evaluation axis for evaluating, comparing, and diagnosing a loss pattern, and advising a method of reducing the loss to a state of the art.

The trading profit and loss which is an example of an evaluation axis is an example of an evaluation axis which shows the whole of the profit and loss by the traded goods in a prescribed period,

“trading profit and loss=Win rate×price of winning×Winning profit margin/number of wins×Principal×(number of days elapsed/Turnover period of the principal)/trade price per transaction+(1−Winning rate)×Trading value when losing[77730000yen]×Losing loss ratio[−0.08]/Loss count×Principal×(number of days elapsed/Turnover period of the principal)/trading price per transaction.

Trading profit and loss is the evaluation axis of the traded data including the winning and losing, and is an example of the axis for evaluating where there is a problem in the trading and where it is good. Trading profit and loss is an example of an evaluation axis for advising how to extract methods, evaluate, compare, and diagnose problems, and achieve further trading. The overall profit and loss is calculated by “total profit and loss=trading profit and loss+unrealized profit and loss.”

An example of the valuation axis is the rate of decline in the number of stocks held, which is an example of the valuation axis calculated by “the amount of profit and loss of the total number of stocks held/the amount of money held.” The total profit and loss of the issues held is the sum of the stock's “(current price-buy price)×number of shares purchased.” The amount held is the total value of the “purchase price×number of shares purchased” of the stock held. The rise and fall rate of stocks held is an example of an evaluation axis that evaluates, compares, diagnoses, and analyzes the data that has not yet been sold, and is an example of an evaluation axis that provides advice on the state in which stocks are held without being sold after they have been purchased.

The rate of change in principal, which is an example of the evaluation axis, is calculated by “total profit and loss/principal” and “(profit and loss+profit and loss of the entire holding issue)/principal/elapsed period (year)”. The principal increase/decrease rate is an example of an evaluation axis for performing a comprehensive evaluation, evaluating, comparing, diagnosing, and advising on the trading situation and the holding situation.

### (Details of the Diagnostic Process)

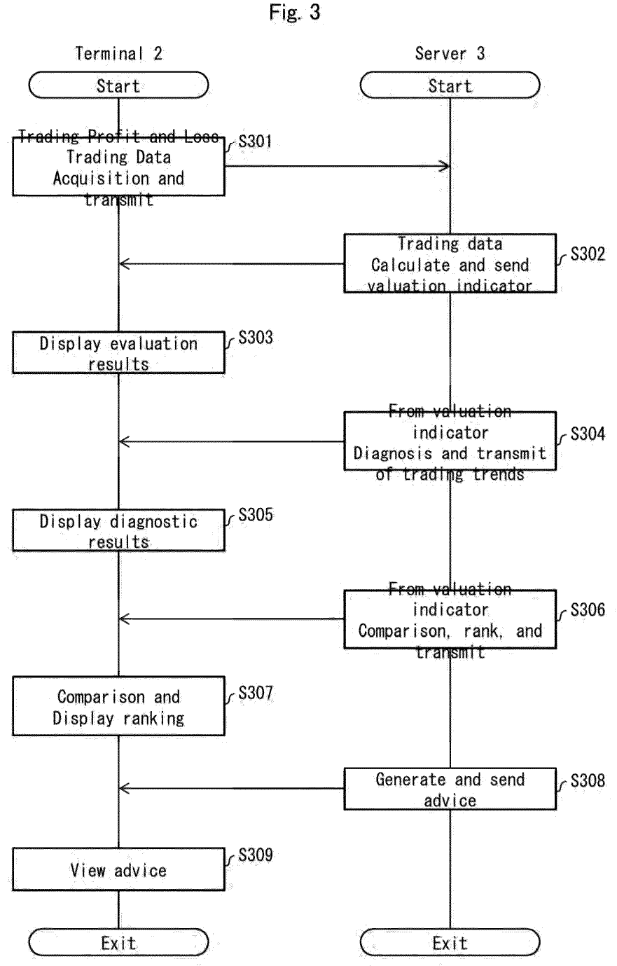

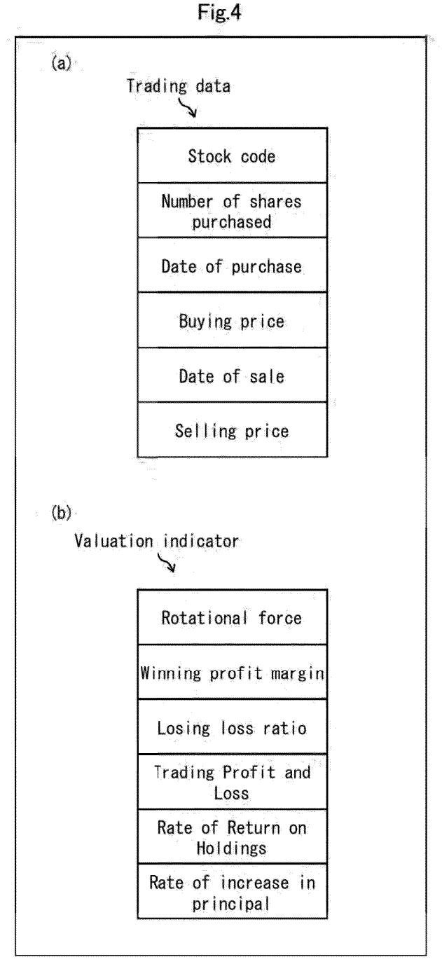

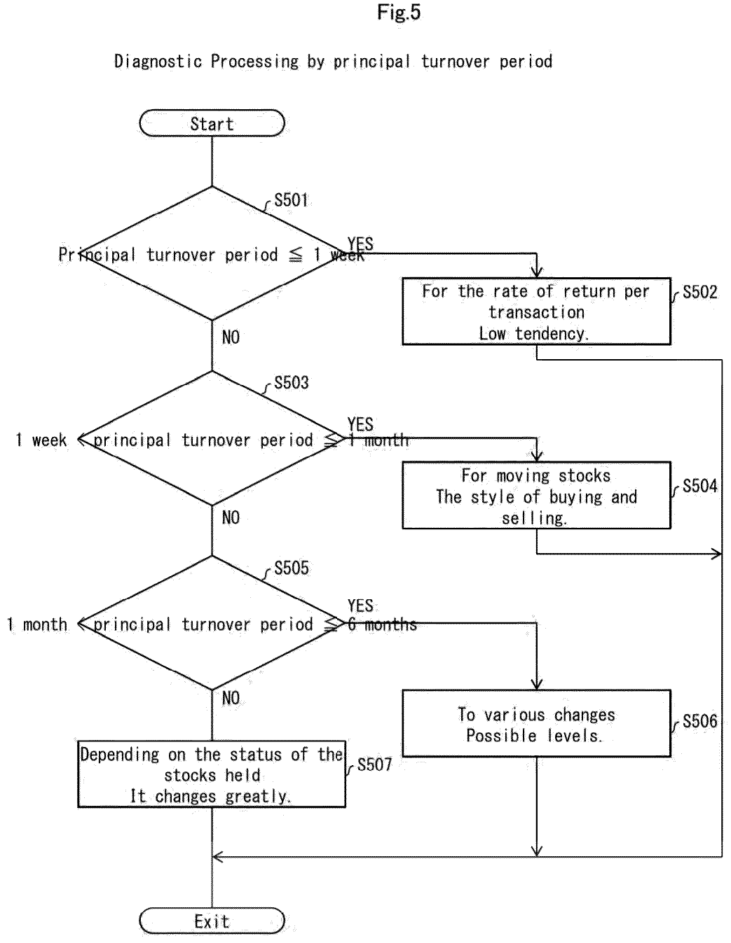

FIG. 5 to FIG. 11 are flowcharts illustrating a diagnosis process performed by the advice generation unit 321 in the server 3 according to the present embodiment. FIG. 5 shows a diagnosis process according to the principal rotational period.

### (Step S501)

The advice generation unit 321 determines whether or not the principal rotational period is within one week. When the Number of days of revolution of principal is less than one week (YES in step S501), the advice generation unit 321 executes a process of step S502. When the Number of days of revolution of principal is longer than one week (NO in step S501), the advice generation unit 321 executes a process of step S503.

### (Step S502)

As the trading tendency of the user, the advice generation unit 321 may be configured to:
Information about user trading trends
Information about the reasons for the user's tendency to buy or sell
Information on social aspects of user trading trends
Information to improve user trading trends
   Generate a diagnostic outcome including (the same applies to S704, S705 of steps).

As an example, the advice generation unit 321 performs, for example, the following evaluation, comparison, diagnosis, and advice on the evaluation axis of the rotational force as the trading tendency of the user. In other words, “he conducts frequent trades close to day trading and scalping. Because the principal turns one turn within a week, the stocks are replaced frequently. There is a tendency to emphasize technical emphasis and win rate, and both wins and losses usually tend to be low per trade. It is important to look at other indicators, such as Winning profit margin. As an improvement proposal, if the average trading period difference is negative or close to zero, we recommend that you extend the average trading period for winning. Comparison and diagnosis are made.

### (Step S503)

The advice generation unit 321 determines whether or not the principal rotational period is longer than one week and within one month. When the principal turnover period is longer than one week and is less than one month (YES of step S503), the advice generation unit 321 executes a process of step S504. When the principal turnover period is longer than one month (NO in step S503), the advice generation unit 321 executes a process of step S505.

### (Step S504)

As an example, the advice generating unit 321 as a user buying and selling tendency, “Because it rotates once within one month, when viewed in one year, more than 10 issues have been replaced. It falls into the category of swing trades, but due to its broad concepts, the average trading period and trading value per trade are further broken down by the degree to which they are traded. In general, however, the style is to trade stocks that are moving, with an emphasis on technical and an incentive-backed stock. In order to increase assets in this type, the difference between the win rate, the Winning profit margin, and the Losing loss ratio is important. Refer to the evaluation axes such as Winning profit margin, Losing loss ratios, and overall returns. Comparison and diagnosis are made.

### (Step S505)

The advice generation unit 321 determines whether or not the principal rotational period is longer than one month and within six months. When the Number of days of revolution of principal is longer than one week and is less than one month (YES of step S505), the advice generation unit 321 executes a process of step S506. When the Number of days of revolution of principal is longer than 6 months (NO in step S505), the advice generation unit 321 executes a process of step S507.

### (Step S506)

As an example, the advice generating unit 321 is a trading frequency in which the issues are replaced several times a year as a user's buying and selling trend. If the “average trading period in the event of winning−average trading period in the event of losing” is large and positive, it can be said that there is a high likelihood of asset formation. Naturally, it is determined by the relationship with other evaluation axes, but with respect to the frequency of trading, it can be conducted at a loose frequency, and the level is capable of responding to various changes. It is possible to cope with not only technical and fundamental but also rapid changes in market trends and the world situation. In this buying and selling trend, the most important is the difference between the Winning profit margin and the Losing loss ratio. The greater the difference, the better the operation. Comparison and diagnosis are made.

### (Step S507)

As an example, the advice generating unit 321 greatly changes the trading tendency according to the situation of the holdings when both the average retention period and the Number of days of revolution of principal exceed six months as the buying and selling tendency of the users. This is because there are many cases in which holdings have unrealized losses. This is a case in which it is not possible to cut a loss and only holds unwanted stocks, that is, it is salted. In the past, banks also had a large number of NPLs, and they fell into deep territory, but nonperforming household loans (non-performing assets) were the presence of Stocks locked up. This is likely to be caused by excessive buying and selling, and in many cases this tendency is included. When combined with other assessment axes, it determines whether this is true or not. Especially, the important evaluation axis is the diagnosis of trading profit and loss and the analysis of holding status. In terms of trading advice, when the above applies, the company should buy and sell stocks while organizing them in small increments. Comparison and diagnosis are made.

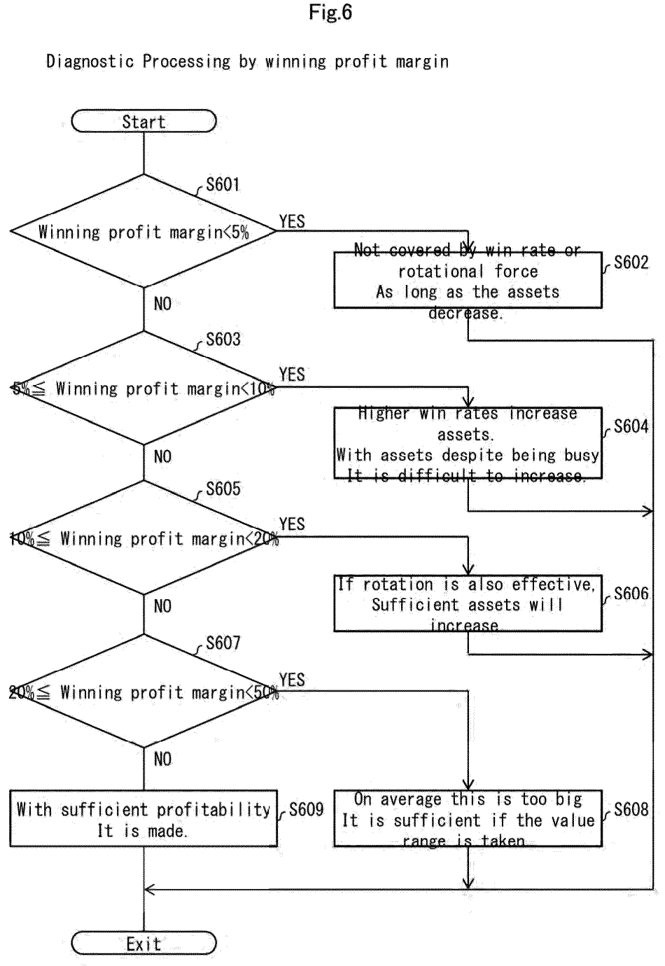

FIG. 6 is a flowchart showing a diagnosis process of the advice generation unit 321 in the server 3 according to the present embodiment based on the Winning profit margin.

### (Step S601)

The advice generation unit 321 determines whether or not the Winning profit margin of return is less than 5%. When the Winning profit margin is less than 5% (YES in step S601), the advice generation unit 321 executes the process of step S602. When the Winning profit margin is not less than 10%, that is, is not less than 10% (NO in step S603), the advice generation unit 321 executes the process of step S605.

### (Step S602)

As the trading tendency of the user, the advice generation unit 321 may be configured to:
Information about user trading trends
Information about the reasons for the user's tendency to buy or sell
Information on social aspects of user trading trends
Information to improve user trading trends
   Generates a diagnostic result including (step S604, S606, S608, S609 as well).

As an example, the advice generating unit 321 has “too low a Winning profit margin” as a buying and selling trend of the user. Therefore, unless the win rate or turnover is covered, assets will decrease. If the Winning profit margin is lower than the losing loss ratio, there is still more room for improvement. If the average retention period when winning is less than one week, it may be a little too early. The selection of stocks to buy may be bad in the first place. See Indicators in Pattern Trading Analysis. Comparison and diagnosis are made.

### (Step S603)

The advice generation unit 321 determines whether or not the Winning profit margin is equal to or greater than 20% and less than 50%. If the Winning profit margin is greater than 5% and less than 10% (YES in step S603), the advice generator 321 performs the process in step S604. When the Winning profit margin is not less than 10%, that is, is not less than 10% (NO in step S603), the advice generation unit 321 executes the process of step S605.

### (Step S604)

As an example, the advice generating unit 321 may be a transaction in which the asset increases if the turnover rate is high, the losing loss ratio is suppressed, and the winning rate is high, as a tendency for the user to buy and sell. However, if the above conditions are not met, there is a tendency for assets to not increase despite being busy. While buying and selling may be good, there may be difficulties in selecting stocks. It is necessary to examine this along with other evaluation axes. However, if a large price range cannot be obtained, it is necessary to reconfirm whether there is a mistake in security selection. Trading profit and loss and trading pattern analysis must be used to check whether there are any mistakes in stock selection. Comparison and diagnosis are made.

### (Step S605)

The advice generation unit 321 determines whether or not the Winning profit margin is equal to or greater than 10% and less than 20%. When the Winning profit margin is 10% or more and less than 20% (YES of step S605), the advice generation unit 321 executes a process of step S606. If the Winning profit margin is not less than 20%, i.e., 20% or more (NO in step S605), the advice generator 321 performs step S607.

### (Step S606)

As an example, the advice generating unit 321 has a high Winning profit margin and is excellent as a user buying and selling trend. The win rate is high, and the losing loss ratio is held down. If the revolution is also effective, the rhythm of the asset increases sufficiently. If possible, a further rise in the Winning profit margin would increase the rate of asset growth. Can you extend the average retention period when you win? By analyzing the winning stocks by analyzing trading profits and losses and trading patterns, I would like to consider how to increase the pace of growth. The use of strategic stocks increases the likelihood of a larger price range. Comparison and diagnosis are made.

### (Step S607)

The advice generation unit 321 determines whether or not the Winning profit margin is equal to or greater than 20% and less than 50%. If the Winning profit margin is more than 20% and less than 50% (YES in step S607), the advice generator 321 performs the process in step S608. If the Winning profit margin is not less than 50%, i.e., 50% or more (NO in step S607), the advice generator 321 performs step S607.

### (Step S608)

As an example, the advise generating unit 321 can be said to be sufficient if such a large value range is taken on average as the buying and selling trend of the user. It is necessary to pay attention to how effective the turnover is, the losing loss ratio, the win rate, and the loss on the holdings. If there are drawbacks in the above points, there is still room for improvement. Especially important is the rotational force. If the rotational force is too low, there is likely to be more room for asset growth. Comparison and diagnosis are made.

### (Step S609)

As an example, the advice generating unit 321, as a user buying and selling tendency, is able to obtain sufficient profit by looking at only this number. If the other figures below are also excellent, the assets are getting an increasing rhythm. (1) Ideally, there should be no problem in terms of how effective the turnover is, whether (2) the losing loss ratio is, whether (3) the winning rate is, and (4) whether the holding has lost. If there is a problem with any of the four above, then improve from there. For example, while there are many stocks in which stocks have large losses and profits are firmly determined, the stocks are left with no loss cut, so it is important to learn how to deal with a loss as soon as possible. Profits should be confirmed slowly, and loss cuts should be made early. Comparison and diagnosis are made.

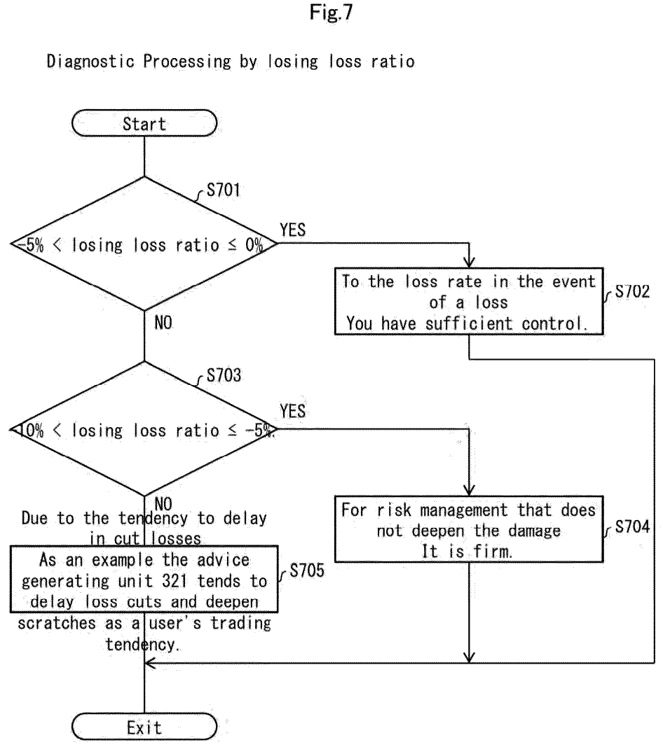

FIG. 7 is a flowchart illustrating a diagnosis process performed by the advice generation unit 321 in the server 3 according to the present embodiment based on the losing loss ratio.

### (Step S701)

The advice generation unit 321 determines whether or not the losing loss ratio is greater than −10% and less than or equal to −5%. When the losing loss ratio is greater than −5% and less than or equal to 0% (YES of step S701), the advice generation unit 321 executes the process of step S702. When the losing loss ratio is not greater than −5%, that is, −5% or less (NO of step S701), the advice generation unit 321 executes the process of step S703.

### (Step S702)

As the trading tendency of the user, the advice generation unit 321 may be configured to:
Information about user trading trends
Information about the reasons for the user's tendency to buy or sell
Information on social aspects of user trading trends
Information to improve user trading trends
   Generate a diagnostic outcome including (the same applies to S704, S705 of steps).

As an example, the advice generating unit 321 can sufficiently control the loss ratio for loss as a trading tendency of the user, and is an excellent result. If the Winning profit margin and win rate are sufficient and there is no problem in the holding situation, it can be said that the rhythm of increasing assets. The most important thing, however, is how big the “Winning profit margin+losing loss ratio.” If the Winning profit margin is 5 percent and the losing loss ratio is −5 percent, the difference is zero. If the win rate is 50%, buying and selling will have no loss or profit. You are busy buying and selling. On the other hand, if the Winning profit margin is 30 percent and the losing loss ratio is −5 percent, the difference is 25 percent, which is large enough. In this case, even a 50% chance of winning increases enough money. It should be examined in conjunction with other indicators, but the losing loss ratio can be said to be excellent. Comparison and diagnosis are made.

### (Step S703)

The advice generation unit 321 determines whether or not the losing loss ratio is greater than −10% and less than or equal to −5%. When the losing loss ratio is greater than −10% and less than or equal to −5% (YES of step S703), the advice generation unit 321 executes the process of step S704. When the losing loss ratio is not greater than −5%, that is, −5% or less (NO of step S701), the advice generation unit 321 executes the process of step S703.

### (Step S704)

As an example, the advice generating unit 321 sufficiently suppresses the losing loss ratio as a trading tendency of the user, and the risk management that does not deepen the damage is firmly established. Loss-cut works very well unless there are stocks with deep wounds in their holdings. In this case, it is most important that the Winning profit margin is well above the losing loss ratio. If the two indices are at similar levels, they will eventually become victorious. If the wealth is not increasing for busy periods, profit determination must be made slowly and early. Trading pattern analysis needs to be checked to ensure that the initial stock selection is correct. Comparison and diagnosis are made.

### (Step S705)

As an example, the advice generating unit 321 tends to delay loss cuts and deepen scratches as a user's trading tendency. In order to achieve a rhythm of increasing assets, it is very important to carry out loss-cutting quickly, cleanly, and control losses. If there was a loss of 20% on the assumption that there was an asset of 1 million yen, it would be 0.8 million yen. Next, in order to return to 1 million yen, we must generate as much as 25% profit. If profits are generated, there will be a virtuous cycle in which profits are generated. Conversely, if a large loss is made and funds are reduced, the principal will be reduced, and it will be forced to do so with fewer and fewer funds, making it difficult to ascend. If possible, the losing loss ratio should be kept below 10%. Comparison and diagnosis are made.

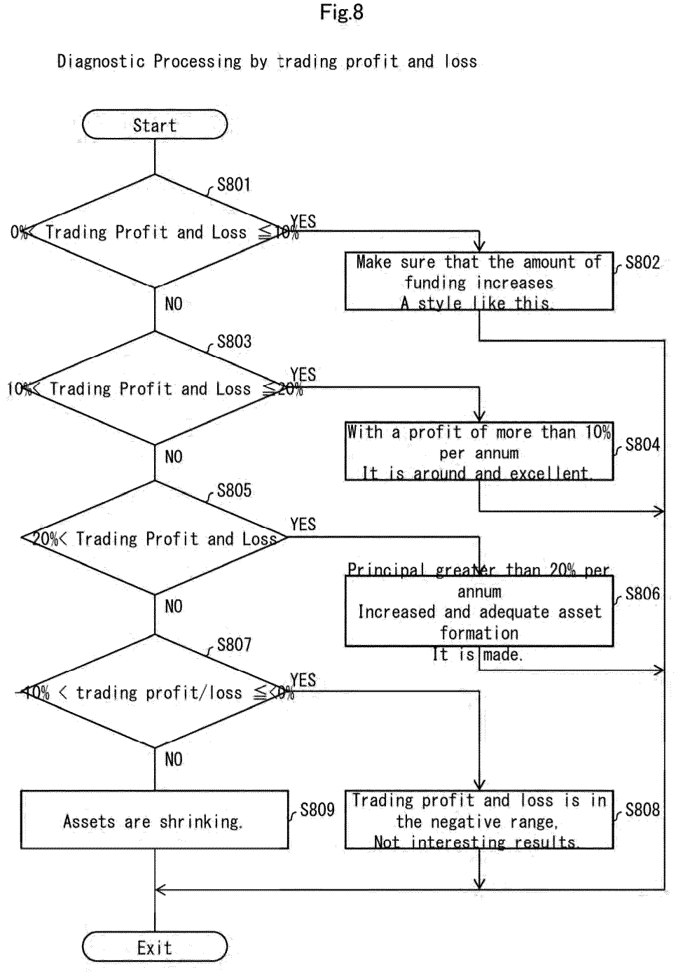

FIG. 8 is a flowchart illustrating a diagnosis process based on trading profit and loss performed by the advice generation unit 321 in the server 3 according to the present embodiment.

### (Step S801)

The advice generation unit 321 determines whether or not the trading profit or loss is greater than 0% and equal to or less than 10%. When the trading profit/loss is greater than 0% and less than or equal to 10% (YES of step S801), the advice generation unit 321 executes a process of step S802. When the trading profit and loss is equal to or less than 0% or greater than 10% (NO of step S801), the advice generation unit 321 executes a process of step S803.

### (Step S802)

As the trading tendency of the user, the advice generation unit 321 may be configured to:
Information about user trading trends
Information about the reasons for the user's tendency to buy or sell
Information on social aspects of user trading trends
Information to improve user trading trends
   Generates a diagnostic result including (step S804, S806, S808, S809 as well).

As an example, the advice generating unit 321 is, as a user buying and selling tendency, “It is very important to have a style in which funds steadily increase in the current era of low interest rates.” However, in terms of greed, there is still room for improvement. Comparison and diagnosis are made.

### (Step S803)

The advice generation unit 321 determines whether or not the trading profit or loss is greater than 0% and equal to or less than 10%. When the trading profit and loss is greater than 10% and less than or equal to 20% (YES of step S803), the advice generation unit 321 executes a process of step S804. When the trading profit/loss is less than or equal to 10% or greater than 20% (NO of step S803), the advice generation unit 321 executes a process of step S805.

### (Step S804)

As an example, the advice generating unit 321 is excellent, as a user buying and selling tendency, as the profit exceeds 10% when it is annualized. However, in terms of greed, it is in the 10% range, including the compounding effect, so we can aim at another level. It is important to look at other indicators to improve the points for improvement. If the Winning profit margin is bad, the improvement is made, and if the turnover rate is bad, the turnover is raised a little. Comparison and diagnosis are made.

### (Step S805)

The advice generation unit 321 determines whether or not the trading profit or loss is greater than 20%. When the trading profit and loss is larger than 20% (YES of step S805), the advice generation unit 321 executes a process of step S806. When the trading profit or loss is not larger than 20%, that is, when the trading profit or loss is 20% or less (NO of step S805), the advice generation unit 321 executes the process of step S807.

### (Step S806)

As an example, the advice generating unit 321, as a buying and selling trend of the user, the principal has increased by more than 20% per annum, and the asset has been sufficiently formed. Afterwards, by improving bad indicators and better good indicators, we can aim for further improvement. While trading stocks do well, holding stocks are ideal if they also have a lot of valuation gains. Comparison and diagnosis are made.

### (Step S807)

The advice generation unit 321 determines whether or not the trading profit or loss is greater than −10% and equal to or less than 0%. When the trading profit and loss is greater than −10% and less than or equal to 0% (YES of step S807), the advice generation unit 321 executes a process of step S808. When the trading profit or loss is −10% or less (NO of step S807), the advice generation unit 321 executes a process of step S809.

### (Step S808)

As an example, the advice generating unit 321 is a user's trading tendency in the negative zone for trading, and the result is not interesting even if the buying and selling is hard. This is particularly true of stockholdings that have problems. It is important to first find points for improvement of where to improve. Trading pattern analysis shows whether there is a problem with trading and whether there is a problem with security selection. Depending on which buying and selling patterns are more common, we can see which is more problematic in buying and selling or in selecting stocks. If there is a problem with buying and selling, calculate the “Winning profit margin+losing loss ratio.” If the “Winning profit margin+losing loss ratio” is close to zero or negative, it is important to improve this figure (increase the positive) by slowly determining profit and making loss cut early. Let us ascend to the positive sphere by increasing the victory rate. Try to work as advised. Comparison and diagnosis are made.

### (Step S809)

As an example, the advice generating unit 321 as a tendency for users to buy and sell is “decreasing by more than 10% per year, and assets are on a downward trend.” If the situation of the holdings is so good, it is necessary to make improvements in trading, and to make changes in a variety of points. Where to fix it, the starting point is to identify which patterns are dominant in your buying and selling by analyzing trading patterns. If there is a problem with security selection, it is important to change that point first. Try to buy and sell strategic stocks. If there is a problem with trading, there are problems such as slow loss cut, premature profit determination, poor win rate, and too slow turnover. Look at your performance on each evaluation axis and revise it from where there is much room for improvement. I think there is a high likelihood that it will be improved by following the advice more than ever before. Comparison and diagnosis are made.

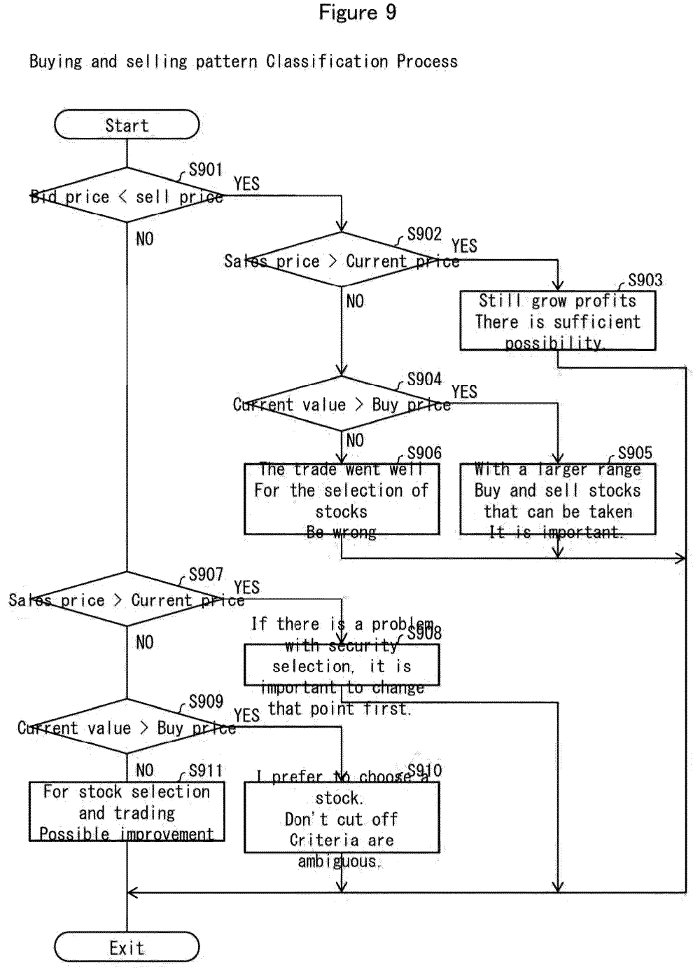

FIG. 9 is a flowchart illustrating a processing of classifying a trading pattern performed by the advice generation unit 321 in the server 3 according to the present embodiment. In the following processing, the determination is made using the current value, but the determination may be made using the market value after the sale (including the market value and the current value three months after the sale) without being limited to the current value.

### (Step S901)

The advice generation unit 321 determines whether or not the buy/sell price is smaller than the sell price. When the buy/sell price is smaller than the sell price (YES in step S901), the process of step S902 is executed. When the bid value is not smaller than the offer value, that is, when the offer value is equal to or larger than the offer value (NO in step S901), the process of step S907 is executed.

### (Step S902)

The advice generation unit 321 determines whether or not the selling price is smaller than the current price. When the selling price is smaller than the current price (YES in step S902), the process of step S903 is executed. When the selling price is not smaller than the current price, that is, when the selling price is equal to or larger than the current price (NO in step S902), the process of step S904 is executed.

### (Step S903)

As the trading tendency of the user, the advice generation unit 321 may be configured to:
Information about user trading trends
Information about the reasons for the user's tendency to buy or sell
Information on social aspects of user trading trends
Information to improve user trading trends
   Generates a diagnostic result including (step S905, S906, S908, S810, S911 as well).

As an example, the advice generating unit 321 is, as the buying and selling trend of the user (winning pattern 1[buying price<selling price<current price]), a user with a large number of this buying and selling pattern is sufficiently likely to still grow profit. Stock selection is not wrong, and later we need to look at whether the price range is larger or profit is too early. Also, even if it is too slow, it may be losing other opportunities, and the rotational surface is also important. Comparison and diagnosis are made.

Further, the advice generation unit 321 generates an advice corresponding to the winning pattern 1 that “in the future, it is possible to further improve whether to skillfully conduct the sale and purchase from the stock selection stage or how to perform the stock exchange.” Generate the advice.

### (Step S904)

The advice generation unit 321 determines whether or not the current value is larger than the purchase value. If the current price is larger than the purchase price (YES in step S904), the process of step S905 is executed. When the current price is not larger than the purchase price, that is, when the current price is equal to or smaller than the purchase price (NO in step S904), the process of step S906 is executed.

### (Step S905)

As an example, the advisory generating unit 321 performs the stock selection skillfully by a user with a large trading pattern as a buying and selling trend (winning pattern 2[buying and selling price<and selling price≥current price and buying price>buying price]). However, in terms of greed, it is important to buy and sell stocks with larger price ranges. Especially in the case of low Winning profit margins. The Winning profit margin does not rise because the firm buys and sells stocks with large price ranges.—Information on the reasons for the user's trading tendency

Furthermore, the advice generating unit 321 is improved by switching to buying and selling of strategic stocks in accordance with the winning pattern 2. In this case, the most important indicator is to improve the Winning profit margin. Generate the advice.

### (Step S906)

As an example, the advisor generating unit 321 sets the buying and selling tendency of the user (winning pattern 3 [buying price<selling price and selling price≥current price and current price≤buying price]). The user with a large number of this buying and selling pattern made a mistake in the selection of stocks in the first place, buying stocks that should not be bought at that time, and buying and buying and selling only because he immediately sold them, the buying and selling was successful, but the selection of stocks was wrong. When this is the case, it means that there is a high likelihood that stocks in motion, such as materials stocks and speculative stock, will be blinded, and that stocks that will not be profitable if you do not buy or sell, or, conversely, that stocks that will be lost if you keep holding. Therefore, we have to buy and sell. Comparison and diagnosis are made.

Furthermore, in accordance with the winning pattern 3, the advice generating unit 321 “is not a stock that cannot be held with peace of mind, it is important to select a stock that is safe to hold and rising.” Then you can afford to buy and sell more. Generate the advice.

### (Step S907)

The advice generation unit 321 determines whether or not the selling price is larger than the current price. When the selling price is larger than the current price (YES in step S907), the process of step S908 is executed. When the selling price is not larger than the current price, that is, when the selling price is equal to or smaller than the current price (NO in step S907), the process of step S909 is executed.

### (Step S908)

As an example, the advisory generating unit 321 has a problem with security selection for a user with a large number of such trading patterns as a user's trading tendency (loss pattern 1[buy≥sell price>current price]). Today, these losses come as you give your hands to popular stocks, or you give your hands to speculative stock that come out of ingredients. The essence of these stocks is the stocks that must not be held, and those that will lose a lot if sold. Comparison and diagnosis are made.

Furthermore, the advice generating unit 321 in accordance with the loss pattern 1, when there are many loss pattern 1 and winning pattern 3, it is necessary to substantially change the stock selection. To change from a style in which trading profits are earned by aiming at an opportunity to a style of investment. Because buying and selling is likely to be a skillful person, it is possible that the performance will increase dramatically if the firm selects stocks. First, try buying and selling strategic stocks. Generate the advice.

### (Step S909)

The advice generation unit 321 determines whether or not the current value is larger than the purchase value. If the current price is larger than the purchase price (YES in step S909), the process of step S910 is executed. When the current price is not larger than the purchase price, that is, when the current price is equal to or smaller than the purchase price (NO in step S909), the process of step S911 is executed.

### (Step S910)

As an example, the advice generating unit 321 provides a tendency for a user to buy or sell (loss pattern 2[bid price≥bid price and sell price≤current price and present price>bid price]). For a user who has a large trading pattern, there are cases in which the selection of issues is good, but the judgment criteria are ambiguous when the loss is cut too early or when not cut off. Other indicators should also be considered. If there is a large number of winning patterns 1, stock selection can be said to be excellent. Comparison and diagnosis are made.

In addition, the advice generating unit 321 responds to the loss pattern 2, and the asset increases as the transaction becomes more skillful. Winning profit margins, losing loss ratios, and differences are important indicators. Generate the advice.

### (Step S911)

As an example, the advice generating unit 321 provides room for improvement in both security selection and trading for users with a large trading pattern as a buying and selling trend of users (loss pattern 3[buying price≥current price≥selling price]). However, in this buying and selling pattern, the loss is kept small, and if the winning is large, the ideal winning method may be achieved. Comparison and diagnosis are made.

Further, the advice generation unit 321 generates an advice corresponding to the loss pattern 3 that “it is important to correct the mistake in the issue selection if the loss is large.” Generate the advice.

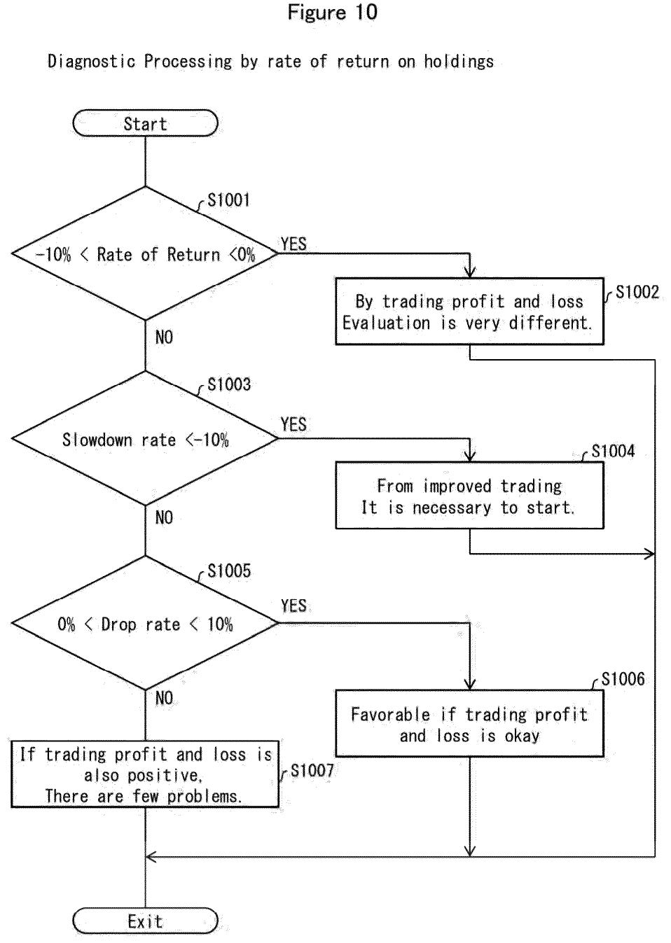

FIG. 10 is a flowchart illustrating a diagnosis process performed by the advice generation unit 321 in the server 3 according to the present embodiment based on the rise and fall rate (hereinafter, simply referred to as “rise and fall rate”) of the held issue.

The advice generation unit 321 classifies the trading data into the held issue data and the traded data, and calculates the rise and fall rate of the held brand by referring to the held brand data. Then, the advice generation unit 321 executes the following diagnosis processing.

### (Step S1001)

The advice generation unit 321 determines whether or not the rate of rise and fall is greater than −10% and equal to or less than 0%. When the hike rate is greater than −10% and less than or equal to 0% (YES of step S1001), the advice generation unit 321 executes a process of step S1002. When the hike rate is less than or equal to −10% or greater than 0% (NO of step S1001), the advice generation unit 321 executes a process of step S1003.

### (Step S1002)

As the trading tendency of the user, the advice generation unit 321 may be configured to:
Information about user trading trends
Information about the reasons for the user's tendency to buy or sell
Information on social aspects of user trading trends
Information to improve user trading trends
Generates a diagnostic comparison result including (also in steps S1004, S1006, S1007).

As an example, the advice generator 321 as a user buying and selling tendency, “Some stocks are profitable while others are losing money. In addition, valuation varies considerably depending on trading profit and loss. If trading gains and losses are large and positive, the problem is small. If trading gains and losses are small and negative, there is a great deal of room for improvement. It is important for you to recognize your own trading patterns by analyzing your trading gains and losses, along with the 6 Patterns of Trading Analysis, etc. As trading and selection of stocks improves, holdings should also improve. It may be a long road ahead, but there is so much room for improvement and so many factors that will change. Comparison and diagnosis are made.

### (Step S1003)

The advice generation unit 321 determines whether or not the rise-fall rate is −10% or less. When the fall rate is −10% or less (YES in step S1003), the advice generation unit 321 executes a process of step S1004. When the fall rate is not equal to or less than −10% (NO in step S1003), the advice generation unit 321 executes a process of step S1005.

### (Step S1004)

As an example, the advice generation section 321 says that the user's trading tendencies are such that “Stocks locked up have appeared, and there seems to be much room for improvement unless the trading profit/loss is not so good. We need to start by looking at the overall decision to buy and sell, and other ways to improve the buying and selling process. Because it is very likely that these holdings are the stocks that were left behind because they could not be bought or sold and could not be cut at a loss. It is very important in the case of stocks to dismiss Failed issue as soon as possible. Do not pull it all the time. It's easy to speak, but it's hard to lose cut. If you are not good at it, try mimicking the support content first. Because a cut-off opens up the possibility of a stock at once. It is important to reorganize holdings little by little and turn them into a position of unrealized profit. Comparison and diagnosis are made.

### (Step S1005)

The advice generation unit 321 determines whether or not the rise-fall rate is greater than 0% and less than 10%. When the hike rate is larger than 0% and smaller than 10% (YES of step S1005), the advice generation unit 321 executes the process of step S1006. When the fall rate is 10% or more (NO in step S1005), the advice generation unit 321 executes a process of step S1007.

### (Step S1006)

As an example, the advice generation section 321 says, “If there is no problem with trading profit and loss, it can be said that the user's trading trend is favorable. However, it is important to look at this in conjunction with the trading pattern analysis. In the classification process of trading patterns, if there are many winning patterns 2 and 3 instead of winning pattern 1, then the stock selection needs to be reviewed. This is because they are likely to be buying stocks that do not have a large price range. To use more strategic issues that can have larger price ranges. Comparison and diagnosis are made.

### (Step S1007)

As an example, the advice generation section 321 says, “If there is no problem with trading profit and loss, it can be said that the user's trading trend is favorable. However, other evaluation axes such as turnover, win-profit ratio, loss-loss ratio, and win rate should be looked at together. Improve weak areas. Comparison and diagnosis are made.

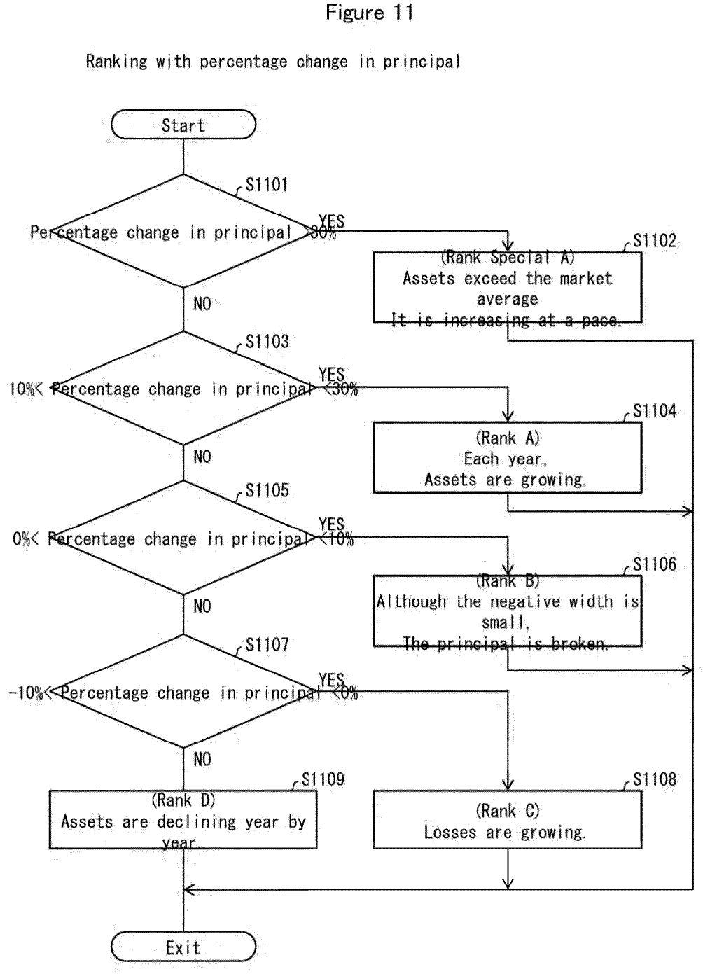

FIG. 11 is a flowchart showing a ranking process by the principal increase/decrease rate of the advice generation unit 321 in the server 3 according to the present embodiment. Note that the advice generation unit 321 may perform comparison processing and ranking processing using valuation indicators other than the principal increase/decrease rate, or may perform comparison processing and ranking processing using a plurality of valuation indicators.

### (Step S1101)

The advice generation unit 321 determines whether or not the principal increase/decrease rate is greater than 30%. When the principal increase/decrease rate is greater than 30% (YES of step S1101), the advice generation unit 321 executes a process of step S1102. When the principal increase/decrease rate is not greater than 30% (NO in step S1101), the advice generation unit 321 executes a process of step S1103.

### (Step S1102)

As the trading tendency of the user, the advice generation unit 321 may be configured to:
Information about user trading trends
Information to improve user trading trends
   Generates a diagnostic comparison result including (also in steps S1004, S1006, S1007).

As an example, the advice generation section 321 states that the user's trading propensity (rank special A) is “Ideal, as assets are increasing at a faster pace than the market average. It depends on the weight of trading gains/losses and valuation gains, but if trading gains/losses are the main factor, rotation is also effective. Comparison and diagnosis are made.

Further, the advice generation unit 321 generates an advice corresponding to the rank special A that “by improving the weakness in each evaluation axis, the profitability is further increased and the pace of increase in assets is likely to increase.” Generate the advice.

### (Step S1103)

The advice generation unit 321 determines whether or not the principal increase/decrease rate is greater than 10% and equal to or less than 30%. If the principal increase/decrease ratio is greater than 10% and less than or equal to 30% (YES in step S1103), the advice generator 321 performs step S1104. If the principal increase/decrease ratio is 10% or less (NO in step S1103), the advice generator 321 performs step S1105.

### (Step S1104)

As an example, the advice generation section 321 states that the user's trading trend (rank A) is “Even if it is not so much per year, the funds are getting bigger and bigger every year, and the operation is such that the profits keep growing. The pace is above average, although uneven from year to year. Comparison and diagnosis are made.

In addition, the advice generation section 321 asks, according to rank A, “Please check the indicator of how your increase compares to the Nikkei average and see how your increase compares to the market average. If it is below the market average, there is still room for improvement. Recognize and improve weak areas even if they are above. Generate the advice.

### (Step S1105)

The advice generator 321 determines whether the principal increase or decrease is greater than 0% and less than or equal to 10%. When the hike rate is greater than-10% and less than or equal to 0% (YES of step S1001), the advice generation unit 321 executes a process of step S1002. When the trading profit or loss is −10% or less (NO of step S807), the advice generation unit 321 executes a process of step S809.

### (Step S1106)

As an example, the advice generation section 321 states as the user's trading tendency (rank B), “The negative range is small, but the principal is undervalued, and there is room for improvement in various ways. First, let's check in this order: are there losses on stocks held, or are there losses on trades? Comparison and diagnosis are made.

Furthermore, the advice generator 321 will generate advice according to rank B: “If you are losing money on your holdings, then the inability to cut your losses is the first point to be corrected. Whether or not the initial selection of stocks to buy is appropriate is also a key point. Generate the advice.

### (Step S1107)

The advice generation unit 321 determines whether or not the principal increase/decrease rate is greater than −10% and equal to or less than 0%. When the hike rate is greater than −10% and less than or equal to 0% (YES of step S1001), the advice generation unit 321 executes a process of step S1002. When the trading profit or loss is −10% or less (NO of step S807), the advice generation unit 321 executes a process of step S809.

### (Step S1108)

As an example, the advice generation section 321 says that the user's trading tendency (rank C) is “Losses are mounting and we recommend an immediate improvement. The first step is to understand the problem. If there is a loss on stocks held, check to see if there is a loss on stocks already traded. In the case of losses on traded stocks, further reference should be made to the win rate, losing loss rate, trading pattern analysis, etc. Comparison and diagnosis are made.

In addition, the advice generator 321 should “improve from particularly bad areas,” according to rank C. See advice on how to improve from a bad evaluation axis. Generate the advice.

### (Step S1109)

As an example, the advice generation unit 321 says, “Assets are decreasing year by year,” as the user's tendency to buy and sell (rank D). It is important to first identify what the problem is, whether it is the trading profit/loss or the return on the stocks held. Comparison and diagnosis are made.

In addition, the advice generation section 321 will generate advice based on rank D, which is similar to the following: “Are you unable to cut your losses and the unrealized losses on your holdings are increasing, or are your assets not increasing even a little while you are busy because you are turning too fast? For the former, the losing loss ratio and six trading pattern analysis are important. For the latter, the Winning profit margin, Comprehensive analysis of losses, and a revolution index are important. Generate the advice.

### (Decompose of Trading Profit and Loss)

The following is the decomposition formula of the trading profit and loss.

“trading profit and loss=Win rate×price of winning×Winning profit margin/number of wins×Principal×(number of days elapsed/Turnover period of the principal)/trade price per transaction+(1−Winning rate)×Trading value when losing[77730000yen]×Losing loss ratio[−0.08]/Loss count×Principal×(number of days elapsed/Turnover period of the principal)/trade price per transaction

The following is a decomposition formula of trading profit and loss including a numerical example when the principal is 5 million yen. Numerical examples are shown in parentheses in [ ].

“trading profit and loss=Winning rate[0.33]×trading value when winning[29.7million yen]×winning rate[0.41]/winning number of times×Principal[5million yen]×(number of days elapsed[1224]÷Turnover period of the principal[53])/purchase price per transaction[670000yen]+(1−Winning rate)×Trading value when losing[77730000yen]×Loss rate[−0.08]/Loss count×Principal[5million yen]×(number of days elapsed[1224]÷Turnover period of the principal[53])/purchase price per transaction[670000yen]

The advice generation unit 321 of the server 3 generates a decomposition formula of the trading profit and loss including a numerical value as a diagnosis result regarding the trading data of the user. Further, the advice generation unit 321 generates an advice referring to valuation indicators including at least a winning rate, a Winning profit margin, a losing loss ratio, and the Turnover period of the principal (principal revolution period) included in the decomposition formula.

### Example of Advice

An example of the advice according to the present embodiment will be described below. The advice generation unit 321 of the server 3 generates each advice. The control unit 22 of the terminal 2 causes the display unit 23 to display each advice. Note that the contents of the following advice are given by way of example and are not intended to limit the present invention.

### First Example of Advice

“I am good at buying and selling with an extremely high turnover rate when the Number of days of revolution of principal is three days.” The principal amount of 1 million yen has been rotated by 100 per year, resulting in a trading price of 100 million yen. Because the rotational is too fast, the rate of return per revenue is always low.

In particular, the Winning profit margin of 5% may be too low.

The winning rate is 60%, the winning rate is 5%, and the loss rate is −8%. The winning rate is high, but the loss is large, and loss cutting tends to be delayed, so it is also an urgent task to improve the loss rate. ┘

### Second Example of Advice

“I don't like to buy or sell. Over the past year, I have kept holding when I bought, and I have not bought or sold. I believe that the company has a wealth of funds, and has a stance of buying and holding good stocks.

With respect to the principal amount of 10 million yen, the trading price is 5 million yen and the cash is 5 million yen remaining. The ratio of winning stocks is 80% and the return on winning stocks is 1.2 times higher. It is considered an investment stance of carefully selecting good stocks and purchasing them with a little-by-little timing. The loss ratio for losing stocks is also kept low at around −10%. This is a stance of carefully selecting and investing in stocks. It is precisely because we have financial resources that we can do business.

However, there are many major opportunities in the stock market. Don't buy or sell, and don't replace stocks. This means that there is a high probability of missing that opportunity. By increasing the trading value, we can earn many times more revenue opportunities than the principal. With a principal of 10 million yen, we would like to see a dramatic increase in earnings opportunities by changing issues once every three months. It's too busy once a week, but if it's about once every three months, it's a level that doesn't take much time. The ability to refresh once every three months makes it easier to incorporate issues that meet the needs of the market, so be able to respond to changes on an ad hoc basis.

Stocks are a continuum of changes, so even those with plenty of funds to buy and sell or replace stocks that respond to changes are essential. However, the issues that should be bought differ from time to time, and the response to change is not easy. Trading support supports that side.

### Third Example of Advice

“The Number of days of revolution of principal is one year. In other words, we only buy at a principal of 1 million yen once a year and do not buy or sell, but continue to hold. This is the trading price of 1 million yen. Trading is zero, but the stock has a 20% win rate and a −30% loss rate. You are in a state where you are unable to move while you are damaged. I bought it and left it unattended, so I did not cut it early, and it deepened my scratches.

First of all, we recommend that you try to buy or sell a portion of the product. By generating profits through the revitalization of the funds that have been moved, the motivation for the revitalization of other salting stocks will be generated, and the direction of the improvement will be gradually shifted. The most important thing you need to be careful when moving is to make early losses and slowly determine your profits. I think it will be difficult until I get used to it, so I recommend that you follow the buying and selling support.

### (Fourth Example of Advice)

“The Number of days of revolution of principal is one month and there is a moderate turnover. The trading value of 6 revolutions and 6 million yen per year for the principal of 1 million yen. The winning rate is 40%, the winning rate is 40%, and the losing rate is −8%.

The winning rate is low, but the winning rate is very high at 1.4 times, and the loss cut in the event of a loss is kept at −8%, so we can say that it is an ideal buying and selling because the assets are steadily increasing. The frequency of rotational is also about once every two months, and the issues are replaced, so they are not busy.

In the event of a win, the average retention period exceeds three months, and in the event of a loss, the trading period is two weeks. This means that “the win is large and slow, and the loss is small and the company withdraws quickly.” Thus, the Company conducts trading for asset formation.

### Example 5 of Advice

“The Number of days of revolution of principal is one month and there is a moderate turnover. The trading value is 12 turns and 12 million yen per year with respect to the principal of 1 million yen. The winning rate is 70%, the winning rate is 5%, and the loss rate is −15%. We are aware of the winning rate and have a high winning rate, but the winning rate is too low, the loss rate is too large, and the asset has declined. In addition, the retention period for winning stocks is too short and profits tend to be determined immediately. On the other hand, in the case of losing stocks, the retention period for losing stocks is prolonged, resulting in an increase in losses.

Loss cutting tends to be delayed, so it is urgent to improve the loss rate.

### [Basic Numerical Values (Basic Data) and Specific Examples of Valuation Indicators]

The advice generation unit 321 calculates valuation indicators from the basic numerical value. The calculation of the valuation indicators varies according to the level of profit and loss (degree of detail). Since the valuation indicators changes, the evaluation can also be performed in stages, and compare, diagnosis, and advice can also be performed in stages. Specific examples of the difference in the valuation indicators according to the level are shown below. The following are specific examples, and do not limit the present invention.

### (Specific Examples of Evaluation of Total Profit and Loss)

The advice generation unit 321 calculates the principal increase/decrease rate by “principal increase/decrease rate=profit/Total losing loss/principal”, and evaluates the profit/Total losing loss.

For the basic values,
Principal,
Total profit and loss
Purchase price
Proceeds from sale
Number of purchases
Current valuation
Lapsed days
Average number of days held
Rate of decline in the benchmark (Nikkei Average, etc.) during the elapsed period

### And so on.

The valuation indicators includes a rotation force index and an overall index.

As a rotational force index,
Number of revolutions (=purchase price/principal)
Number of days of revolution (=number of days elapsed/number of revolutions)
Average number of days held

### And so on.

As a comprehensive index,
Principal profit-loss ratio (=total profit-loss/principal)
Average purchase price
Average profit/loss (=total profit/loss/number of purchases)
Principal profit-loss ratio (=purchase price/principal×sum profit-loss/number of purchases/purchase price/number of purchases)
Principal profit/loss ratio (=number of revolutions×average profit/loss per revolution/purchase price per revolution)
Comparison with the Nikkei Average, Cash Ratio, Investment Ratio, and Current Investment Amount

### And so on.

### (Specific Examples of Evaluation of Total Profit and Loss)

The advice generation unit 321 calculates the principal increase/decrease rate by “principal increase/decrease rate=(Total trading profit and loss+total Unrealized profit and loss)/principal” and evaluates the Total trading profit and loss.

For the basic values,
Principal
Total trading gains and losses
Purchase price
Number of wins
Total profit in the winning case
Total winning purchases
Total prices from the sale of the winners
Number of losings
Total lost purchases
Total prices from sale of losings
Total loss for losing
Number of trades
Proceeds from sale
Lapsed days
Average trading period

### And so on.

In valuation indicators,
Rotational force
Number of rotational of trading securities (=purchase price/principal)
Number of days of trading stocks (=number of days elapsed/number of revolutions)
Average number of days trading stocks hold
Ratio of profit/loss on principal (=Total trading profit and loss/principal)
Winning rate of trading stocks (=number of wins/number of trades)
Winning profit per trading issue (=winning profit/number of wins)
Profit ratio in the case of winning of trading securities (=profit in the case of winning/trading
value in winning)
Loss per trade (=Loss in case of loss/Number of losses)
Loss ratio for loss in a trading stock (=loss in the case of a loss/trading value of a loss)

### And so on.

For example, trading gains and losses can be divided into the following components: This decomposition makes it possible to ascertain the nature of trading.

Total trading profit and loss=sale price at the time of winning(33%)×winning(29.7million yen)×profit ratio at the time of winning(0.41)/number of winning+(1−winning ratio)×sale price at the time of losing(77730000yen)×profit ratio at the time of losing(−0.08)/number of losing×Principal(5million yen)×(number of days elapsed(1224)/Turnover period of the principal(53))/purchase price per transaction(670000yen)

Trading loss and gain are determined by turning power, profit margin in the case of losing, loss rate in the case of winning, original, winning rate, etc. By dividing the factors, it is possible to evaluate which factors are strong or weak, and the tendency of buying and selling becomes clear.

For example, unrealized profit and loss can be divided into the following components:

Unrealized profit and loss=winning percentage(33%)×trading prices in winning(29.70million yen)×gain rate in winning(0.41)÷number of wins+(1−winning percentage)×trading prices in losing(77.73million yen)×gain rate in losing(−0.08)÷number of losses×principal(5million yen)×(elapsed days(1,224)÷turnover period in days of principal(53))÷trading price per trade(0.67million yen).×Principal(5million yen)×(number of days elapsed(1224)/Turnover period of the principal(53))/purchase price per transaction(670000yen)

Regarding the valuation of Unrealized profit and loss, the rotational power, the profit ratio in the case of winning, the Loss ratio for loss, the principal, the winning ratio, etc. are also important.

### (Specific Example of Evaluation of Total Winning Profit)

The advice generation unit 321 calculates the principal increase/decrease rate by “principal increase/decrease rate=(Total winning profit+Total losing loss+total unrealized profit and loss)/principal” and evaluates the Total winning profit.

For the basic values,
Principal
Total profit
Purchase price
Proceeds from sale
Lapsed days
Average trading days

### And so on.

In valuation indicators,
Rotational force
Number of revolutions (=purchase price/principal)
Number of days of revolution (=number of days elapsed/number of revolutions)
Average number of days held
Winning profit margin (=Total winning profit/winning purchase price)
Win rate (=number of wins÷number of trades)
Winning profit per round (=winning profit/winning profit number of winning)
Rate of return for winning (=return for winning+buying and selling of price for winning)
Total profits of the winners
Purchase price per win (=purchase price per win/number of wins)

### And so on.

For example, the winning profit is divided into the following elements.

Winning profit=(=winning number÷number of times of sale)(33%)×trading price when winning(29.7million yen)×profit rate when winning(=(profit of winning pattern1+profit of winning pattern2+profit of winning pattern3)/trading price(0.41))/winning number)×(principal(5million yen)×(elapsed day(1224)/Turnover period of the principal(53))/trading price per time(670000yen))

Winning profit=profit of winning pattern1+profit of winning pattern2+profit of winning pattern3

Winning profit=profit that would have been obtained in winning pattern1−lost profit after sale of winning pattern1+loss that would have been avoided by sale of winning pattern2+profit that would have been obtained by holding winning pattern2+profit that would have been obtained by holding winning pattern3(current valuation-purchase amount)−loss of winning pattern3(loss when holding is continued)−loss that could have been avoided by selling winning pattern3(current valuation-sale amount)

### (Specific Example of Evaluation of Winning Profit Pattern)

The advice generation part 321 is calculated by the original increase/decrease ratio=(the total unrealized profit and loss+winning pattern 1+the sum of gains in winning pattern 2+the sum of gains in winning pattern 3+the Losing loss pattern 1+the sum of losses+the loss of loss pattern 2+the sum of the loss of loss pattern 3)€ the original amount of Total winning profit is evaluated.

In the basic value of winning pattern 1,
Principal,
Total profit
Purchase price
Proceeds from sale
Lapsed days
Average trading days
Total profit and loss after sale
Total profit and loss in the case of holding
Total trading gains and losses, etc.

As valuation indicators for winning pattern 1,
Average retention period, Total profit earned if not sold
Profit gained if not sold per transaction
Profit earned if not sold/profit from winning pattern 1
Gross profit earned
Gross profit earned/profit from winning pattern 1
Average retention period
Period elapsed after failure to sell
retention period if not sold after purchase,
Gross profit earned by the company/retention period if not sold after purchase
Profit earned if not sold/Period passed if not sold

### And so on.

For example, the profit of the winning pattern 1 is divided into the following elements.

Profit of winning pattern1=rate of winning pattern1(=(number of times of winning pattern1/number of times of winning)×(number of times of winning/number of times of trading))×trading price in winning pattern1(ten thousand yen)×profit rate in winning pattern1(=profit of winning pattern1/trading price of winning pattern1)/number of times of winning pattern1×Principal(5million yen)×number of days elapsed(1224)/Turnover period of the principal(=(number of days elapsed/(trading price/principal))(53)/purchase price per time(670000yen))

Profit in winning pattern1=profit that would have been earned in winning pattern1−lost profit after the sale of winning pattern1

Profit ratio of winning pattern1=(profit that would have been obtained in winning pattern1−lost profit after sale of winning pattern1)/sale price of winning pattern1

Profit of winning pattern1=rate of winning pattern1(=number of times of winning pattern1/number of times of sale)×sale price in winning pattern1(10000yen)×(profit that would have been obtained in winning pattern1−lost profit after sale of winning pattern1)/sale price of winning pattern1/number of times of winning pattern1

### (Overall Profit and Loss)

In the server 3, the advice generation unit 321 acquires the trading data for investment commodity, acquires the basic numerical value (basic data) from the acquired trading data, calculates valuation indicators relating to the trading profit and loss and the unrealized profit and loss from the acquired basic numerical value, acquires valuation indicators relating to the overall profit and loss from the calculated valuation indicators, and generates information indicating the acquired valuation indicators.

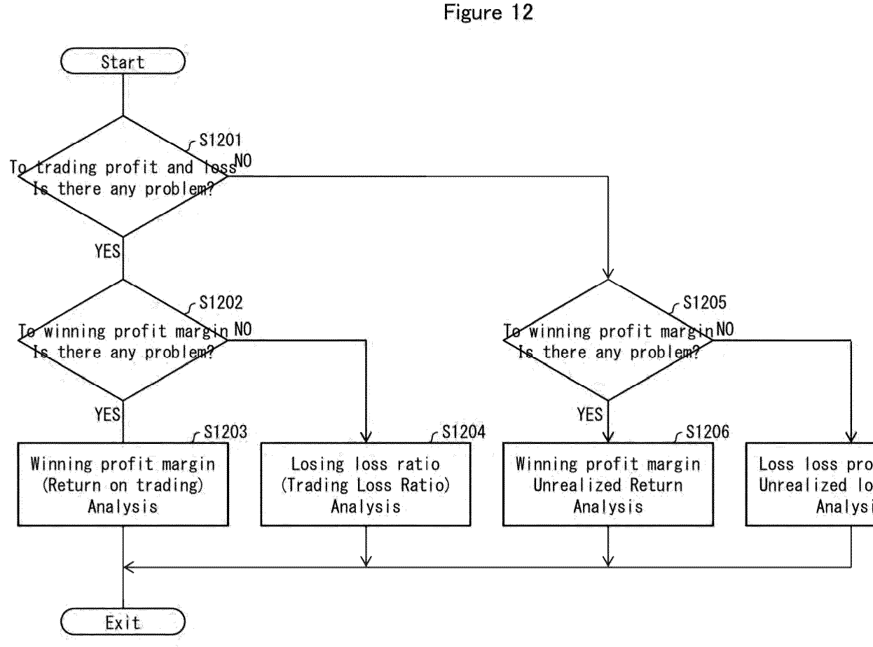

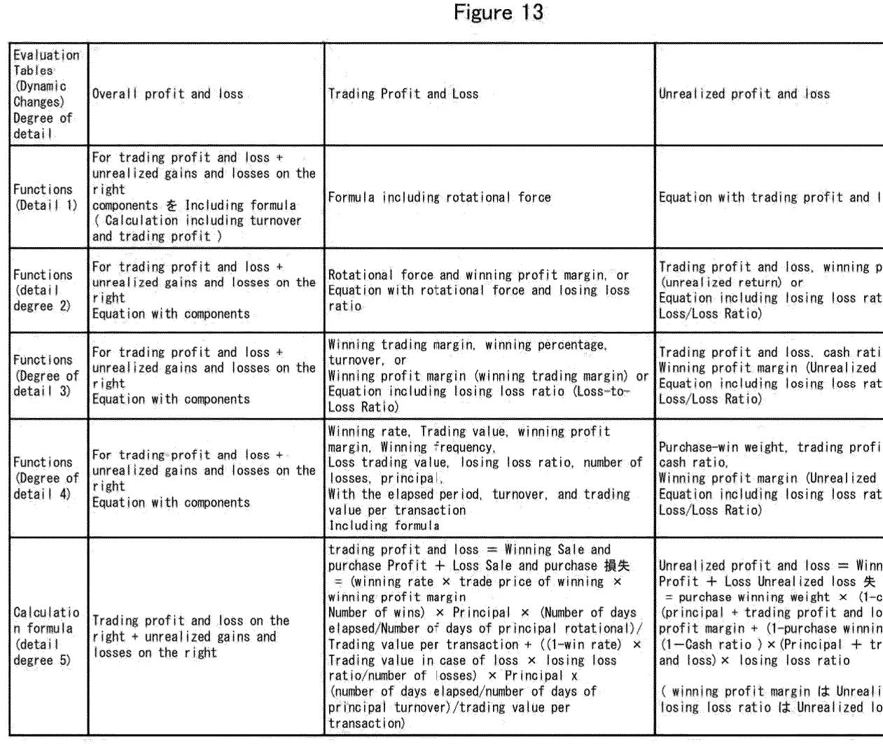

FIG. 12 is a flowchart illustrating a process of the overall profit and loss analysis according to the present embodiment. FIG. 13 is a diagram illustrating an example of evaluation values of total profit and loss, trading profit and loss, and unrealized profit and loss according to the degree of detail according to the present embodiment.

As shown in FIG. 13, the total profit or loss is expressed as the sum of the trading profit or loss and the Unrealized profit and loss. Unrealized profit and loss are related to increase or decreases and decreases in trading gains and losses as a parameter of the formula. According to this, there is a possibility that Unrealized profit and loss increases in accordance with an increase in sales profit or loss, and there is an increased possibility that overall profit or loss increases. That is, it is possible to expect the compound interest effect of the overall profit and loss by the synergistic effect of the sales profit and loss and the unrealized profit and loss.

In other words, the total profit or loss is the sum of the profit or loss including the Unrealized profit and loss overall from the investment commodity and the realized profit or loss.

As a measure of total profit and loss,
Rotational force
Winning profit margin (return on trading and unrealized rate of return)
Losing loss ratio (trading loss ratio and unrealized loss ratio)
Cash ratio
Buy win weight (Unrealized Trading Winner)
Win rate (rate of trade)

### And so on.

The overall profit and loss is influenced by various valuation indicators according to the degree of detail of the evaluation value, and various valuation indicators according to the degree of detail are subject to evaluation. For example, when using a calculation formula with a degree of detail of 5, the most subdivided valuation indicators is used, so that a more detailed analysis evaluation is possible.

As shown in FIG. 12, in the server 3, the advice generation unit 321 clarifies the points to be improved by grasping, as a procedure of diagnosis, a general framework such as where is good and where is bad by analyzing the overall profit and loss, and deepening the bad points.

### (Step S1201)

The advice generation unit 321 determines whether or not there is a problem in the trading profit or loss among the overall profit or loss. When the trading profit or loss is problematic (Yes of step S1201), the advice generation unit 321 performs determination of step S1202. When there is no problem in the trading profit or loss (that is, there is a problem in the Unrealized profit and loss) (No of the step S1201), the advice generation unit 321 performs the determination of the step S1205.

### (Step S1202)

The advice generation unit 321 determines whether or not there is a problem in the Winning profit margin (trading profit ratio). When the Winning profit margin is problematic (Yes in step S1202), the advice generation unit 321 executes a process of step S1203. When there is no problem in the Winning profit margin (that is, there is a problem in the Losing loss ratio) (No of step S1202), the advice generation unit 321 executes the process of step S1204.

### (Step S1203)

The advice generation unit 321 analyzes the Winning profit margin (trading profit ratio).

### (Step S1204)

The advice generation unit 321 analyzes a Losing loss ratio (trading loss rate).

### (Step S1205)

The advice generation unit 321 determines whether or not there is a problem in the Winning profit margin (unrealized profit rate). When the Winning profit margin is problematic (Yes in step S1205), the advice generation unit 321 executes a process of step S1206. When there is no problem in the Winning profit margin (that is, there is a problem in the Losing loss ratio) (No of step S1205), the advice generation unit 321 executes the process of step S1207.

### (Step S1206)

The advice generation unit 321 analyzes the Winning profit margin (unrealized profit ratio).

### (Step S1207)

The advice generation unit 321 analyzes a Losing loss ratio (unrealized loss rate).

As a specific example of the step S1205 to the step S1207, for example, when the absolute value of the Winning profit margin (unrealized profit rate) is larger than the threshold value A and the absolute value of the losing loss ratio (unrealized Losing loss ratio) is smaller than the threshold value B (<threshold value A), the advice generation unit 321 may generate a diagnosis indicating that the Winning profit margin is sufficiently large and the Losing loss ratio is sufficiently small, and an advice for realizing loss by selling a brand in which a small Losing loss ratio is recorded, and for purchasing an investment commodity with a larger profit potential at the sold price. Because of the large winning profit, it is reasonable to achieve the loss as soon as possible within the margin. However, when the length of retention period (for example, the number of days, the number of months, and the like) of issue on which the smaller losing loss ratio is recorded is shorter than the predetermined value, the advice generation unit 321 does not generate the above-described diagnosis and advice. This is because retention period is still short, and the operation result of issue may not have been obtained.

In the analysis of S1203, S1204, S1206, S1207 of steps, it may be analyzed whether winning profit margin or the lost profit rate is larger (outperforming) than the comparison target (for example, the Nikkei average).

According to the above, for example, “Starting from the diagnosis of overall profit and loss, the turnover is high, but the winning profit margin is low and trading profit is low, so the compounding effect is not effective, the unrealized loss is large, and the overall profit and loss is negative. Or “The Winning profit margin is low and the Losing loss ratio (unrealized loss) is high because the company is unable to cut losses and lengthens its holdings of stocks that have lost money, causing unrealized losses to grow while quickly selling them when profits are made. The evaluation can be multifaceted, such as investment commodity is an investment commodity including Fx, stock, investment trust, and ETF, and refers to a variable product whose value fluctuates. However, it is not a strictly unique formula. For example, trading price per time can be replaced by (trading price/number of trades).

Unrealized profit and loss is expressed as a function of, for example, cash ratio, trading income, and winning profit margin (unrealized return). Overall profit and loss by investment commodity is the sum of trading profit and loss and unrealized profit and loss. Thus, overall profit and loss is affected by these valuation indicators.

### (Effect of Decomposing Overall Profit and Loss)

In addition to determining whether the profit earned by investment commodity is unrealized profit or a certain profit (the most rough way of evaluating), the effects of cash ratio on profit and loss and compound interest effect that profit is profitable are examined. By comprehensively examining rotational force, the profit rate of winning, the loss rate of losing, etc., it is possible to comprehensively evaluate the point where there are many problems and improve the point of improvement, thereby enabling diagnosis.

For example, if trading profit and loss is large, winning profit margin is high, and losing loss ratio is low, but the unrealized losses are large. There is a big problem in the unrealized loss, and there is an improvement point, so it is an example that it is necessary to evaluate it in more detail intensively.

For example, if the unrealized profit is large and the selected issue is bought at a good timing, and winning profit margin (unrealized profit rate) is high, but there are still many issue with unrealized loss, and the turnover is not effective at all, it is likely that trading profit and loss will be created (loss, etc.), the funding will be more efficient, and rotational force will be improved, so that the need for this is conveyed.

### (Unrealized Profit and Loss)

Unrealized profit and loss is an unrealized profit and loss that refers to an unrealized profit and loss and is calculated from trading's purchase price (or proceeds from sales, if short-selling). It is the unrealized gain or loss calculated from the Unrealized profit and loss usually refers to the difference between an appraised value of a commodity calculated by market price and purchase price of the commodity.

### Definition of Terms

Winning profit refers to Unrealized profit that have not yet been realized or determined.

Winning profit margin is the unrealized rate of return, which is calculated as “winning profit/winning purchase price”. The winning purchase price is purchase price of unrealized profit and loss (i.e., purchase price of the product that has not made the other trading) that makes up unrealized profit.

Losing loss refers to unrealized losses that have not yet been realized or determined.

Losing loss ratio is an unrealized loss rate and is calculated by “losing loss÷purchase price of loss”. The losing purchase price is a purchase price that configures unrealized profit and loss and that configures unrealized loss.

Cash ratio refers to the ratio of the amount of money remaining as cash to the amount of money that can be purchased (principal+trading profit and loss+deposits and withdrawals). The deposit and withdrawal is cash increased or decreased by depositing and withdrawing after principal insertion. “1−cash ratio” means the percentage of the amount available for purchasing that is the amount owned by the product.

Buy win weight is the ratio of purchase price constituting unrealized profit among purchase price. Accordingly, “1−buy win weight” means the ratio of purchase price constituting unrealized loss among purchase price.

Unrealized profit and loss is composed of cash ratio, trading profit and loss, buy win weight, Winning profit margin (unrealized rate of return), losing loss ratio (unrealized rate of loss), and the like, as expressed in FIG. 13 equation.

Not only trading profit and loss described above, but also unrealized profit and loss and overall profit and loss can be evaluated in stages.

### (Example of Evaluating Total Unrealized Gain and Loss)

The advice generation unit 321 evaluates total unrealized gain and loss.

For the basic values,
Principal
Total unrealized gain and loss
Purchase price of issue not yet sold (or repurchased issue)
current valuation of issue not yet sold (or repurchased issue)
Lapsed days
Holding stock Winning Count
Total Unrealized profit on winning holding stock
Holding stock's winning purchase price
Holding stock Loss Count
Total loss for losing for holding stock
Holding stock's losing trading price
Number of purchases
Holding stock count
Average number of days held

### And so on.

In valuation indicators,
Rotational force
Principal growth rate (=(purchase price+cash)/(principal+deposit and withdrawal))
Annual principal growth rate (=principal growth rate/years elapsed)
Average number of days held
Profit and loss rate (=total unrealized gain and loss/purchase price sum)
Winning percentage (=number of winning÷number of purchases)
Winning profit per round (=winning profit/winning profit number of winning)
Rate of return for winning (=return for winning÷purchase price for winning)
Issue share
Share of winning issues
Share of losing issues
Profit and loss ratio (by issue)
Average percentage change (annualized conversion)
Unrealized loss and gain weight
Trading profit and loss weight
Nikkei percentage change

### And so on.

### (Unrealized Profit and Loss Evaluation Value Detail)

As shown in FIG. 13, unrealized profit and loss can be evaluated by, for example, a five-stage evaluation value with varying degrees of detail.

The degree-of-detail 1 is expressed by a formula including a trading history. That is, in the server 3, the advice generation unit 321 may calculate valuation indicators including trading profit and loss from the basic numerical value as valuation indicators related to unrealized profit and loss, and generate the information indicating the calculated valuation indicators.

The two-degree-of-detail can be expressed in terms of formulas that include trading profits, Winning profit margin (unrealized margins), or losing loss ratio (unrealized loss-rates). In other words, in the server 3, the advice generation unit 321 may calculate valuation indicators including trading profit and loss and winning profit margin or losing loss ratio from the basic numerical value as valuation indicators related to unrealized profit and loss, and generate the information indicating the calculated valuation indicators.

The degree-of-detail 3 can be expressed in terms of formulas that include trading profit, cash ratio, and Winning profit margin (unrealized margin) or losing loss ratio (unrealized loss-rate). That is, in the server 3, the advice generation unit 321 may generate the information indicating the calculated valuation indicators by calculating valuation indicators including trading profit and loss, winning profit margin or losing loss ratio, and cash ratio from the basic value as valuation indicators related to unrealized profit and loss.

The degree of detail 4 is expressed by a formula including buy win weight, principal, trading profit and loss, cash ratio, Winning profit margin (unrealized rate of return), and losing loss ratio (unrealized rate of loss). That is, in the server 3, the advice generation unit 321 may calculate valuation indicators including trading profit and loss, winning profit margin or losing loss ratio, cash ratio, and buy win weight from the basic numerical values as valuation indicators related to unrealized profit and loss, and generate the information indicating the calculated valuation indicators.

The calculation formula of the detail degree 5 is as follows.

Unrealized profit and loss=buy win weight×(1−cash ratio)×(principal+trading profit and loss)×Winning profit margin+(1−buy win weight)×(1−cash ratio)×(principal+trading profit and loss)×losing loss ratio

If there is a cash receipt and disbursement after principal is thrown, the equation for the degree of detail 5 is as follows.

Unrealized profit and loss=buy win weight×(1−cash ratio)×(principal+trading profit and loss+deposit and withdraw)×Winning profit margin+(1−buy win weight)×(1−cash ratio)×(principal+trading profit and loss+deposit and withdraw)×losing loss ratio

Where Winning profit margin is the unrealized rate of return and losing loss ratio is the unrealized rate of loss.

That is, in the server 3, the advice generation unit 321 may generate, as unrealized profit and loss information valuation indicators, trading profit and loss, winning profit margin or losing loss ratio, cash ratio, buy win weight, and principal from the basic numerical values, and generate the calculated valuation indicators.

Further, after the evaluation according to the degree of detail, it is determined which indicator has a large problem, and an advice indicating improvement from the index having a large problem is generated. That is, in the server 3, the advice generation unit 321 may preferentially generate information indicating a low-valuation indicators among a plurality of valuation indicators related to unrealized profit and loss.

Further, the advice generation unit 321 may generate information indicating diagnosis, ranking, comparing, or advice using overall profit and loss or valuation indicators related to unrealized profit and loss. For example, since the calculation of valuation indicators enables various evaluations, valuation indicators may be compared with other products, and the comparison may be included in the diagnosis, ranking, comparison, and advice.

### (Evaluation, Diagnosis, and Advice of Holding Products)

In the server 3, the advice generation unit 321 may calculate purchase price sum (purchase price), the commodity appraised value, and the benchmark appraised value from the basic numerical values, compare purchase price sum, the commodity appraised value, and the benchmark appraised value with each other, and generate a diagnosis regarding the property status or information indicating the advice according to the comparison result.

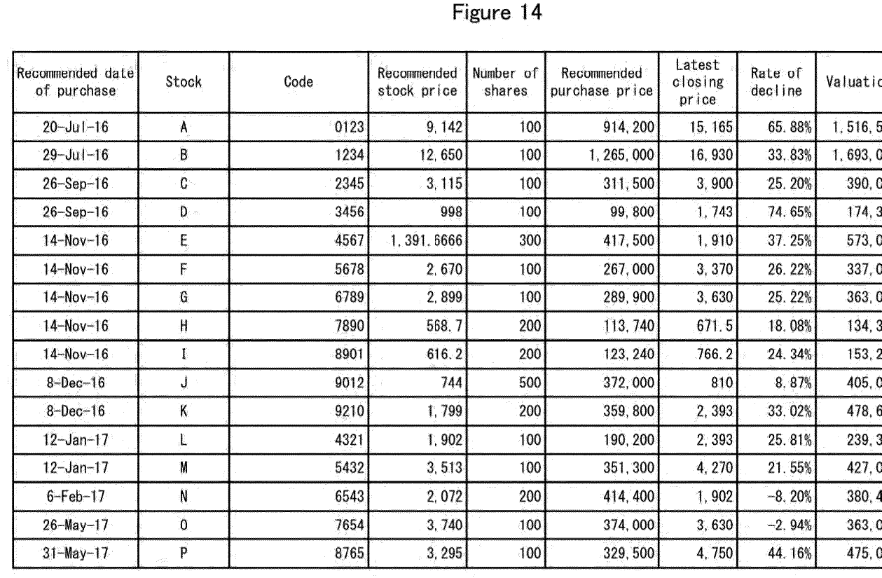

FIG. 14 is a figure exemplifying valuation indicators of the held product according to the present embodiment.

The procedure of the advice generation unit 321 evaluating the property status of the product held by the user, that is, the product that has not been subjected to the reverse trading after the purchase (or the sale in the event of a short sale) is described below. Comprehensive evaluation of the held products can be performed by the following procedure.

(S1) The advice generation unit 321 calculates “purchase price×percentage change of the product” of the respective held products. Percentage change of the product is percentage change from the time of purchasing to the present. The advice generation unit 321 calculates percentage change of the product by the following Expression 1.

Percentage change of the product=(present appraised value-purchase amount)/purchase amount×100[%] Equation 1

(S2) The advice generation unit 321 sums up “purchase price×percentage change of the product” of the respective held products. The total amount shall be the product appraised value. The product appraised value indicates the total of the current appraised values for each held product.

(S3) The advice generation unit 321 calculates the “purchase recommended amount×benchmark percentage change” of the held products. The benchmark percentage change is percentage change from the time of the buy recommendation to the present. Benchmarks are not limited to Nikkei averages, TOPIX, etc., but may be an appraised value by dedicated software, stock price of a particular issue, etc. The advice generation unit 321 calculates the benchmark percentage change by the following Expression 1.

Benchmark percentage change=(current benchmark-benchmark when buying is recommended)/benchmark when buying is recommended×100[%] Equation 2

(S4) The advice generation unit 321 sums the “purchase recommended amount×benchmark percentage change” of the held products. The total amount shall be the benchmark appraised value. The benchmark appraised value indicates the sum of the current appraised values of the products in question, assuming that the products linked to the benchmark are purchased at the same price.

(S5) The advice generation unit 321 compares purchase price sum, the commodity appraised value, and the benchmark appraised value, and generates a diagnosis regarding the property status or information indicating the advice according to the comparison result. Purchase price sum indicates the sum of purchase price for the respective held products.

Thus, for example, when the product appraised value exceeds the benchmark appraised value, it is possible to evaluate how much amount exceeds the benchmark appraised value. If the product evaluation is less than the benchmark valuation, it is possible to evaluate how much the product valuation is less. If the benchmark is the Nikkei Average, it can be assumed that the Nikkei 225 index-type product is better than the actual product, so it can be diagnosed that the selection of issue is problematic.

Also, even if the benchmark an appraised value is above the product an appraised value, there are many investments in period that are achieving better performance. By showing the performance, it is possible to provide tips and advice for achieving better performance. For example, if issue B is held only by period, it performs three times as much as holding stock A, which is a good example of tips and advice.

### (Pattern Classification of Holding Products)

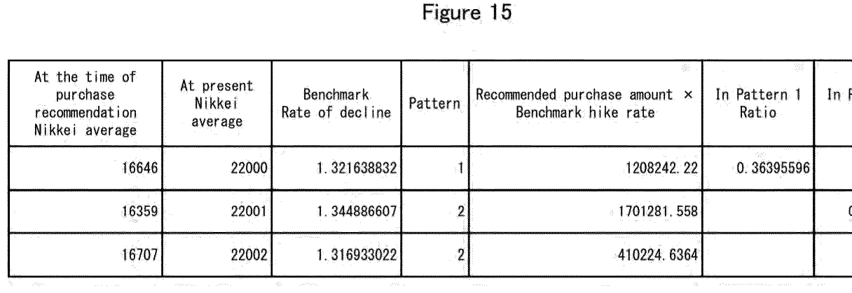

FIG. 15 is a figure illustrating an exemplary pattern of the held product according to the present embodiment.

In the server 3, the advice generation unit 321 may acquire unreversed trading data from trading data, classify unreversed trading data into patterns corresponding to the current value, the purchase price, percentage change, and percentage change of the benchmark of investment commodity held, calculate purchase price or the commodity appraised value for each pattern from unreversed trading data, and generate information indicating the diagnosis or the advice regarding the asset status according to the ratio of purchase price or the commodity appraised value for each pattern.

First, the advice generation unit 321 performs pattern classification of each held product. The advice generation unit 321 classifies the product held by the user into the following four patterns. That is, the winning pattern 1 is one in which the present price is larger than the bid price and percentage change of issue is larger than the benchmark percentage change. The winning pattern 2 is one in which the present price is greater than the bid price and percentage change of issue is less than the benchmark percentage change. Loss Pattern 1 is one in which the present price is less than the bid price and percentage change of issue is greater than the benchmark percentage change. Loss Pattern 2 is one in which the present price is less than the bid price and percentage change of issue is less than the benchmark percentage change.

Next, the advice generation unit 321 calculates purchase price total or the commodity appraised value for each of the four patterns described above, calculates the ratio of the amount of each pattern to the total of the four patterns, and generates a diagnosis or an advice according to the ratio of each pattern or the amount of which pattern is the largest.

For example, if winning pattern 1 is 70% and winning pattern 2 is 30%, the advice generating unit 321 generates an advice that diagnoses “is above the mean, the buying issue is good, and the buy timing is good” and “refers to the indicator of how much is exceeded”.

If winning pattern 2 is 80%, winning pattern 1 is 10%, and losing pattern 1 is 10%, the advice generator 321 says, “Profits are being made, but they are not exceeding the benchmark. The diagnosis, “There is a lot of room for improvement,” he said. Generate advice to “aim for above-average results.

If Losing Pattern 1 accounts for 80% of the total, the advice generator 321 will say, “Although we have lost money, it is because the benchmark is down. For this reason, the loss is kept small. Also, if the loss pattern 1 accounts for 80%, the advice generation unit 321 generates an advice to recommend early loss cutting, such as the diagnosis that the loss is caused by a decrease in the benchmark, such as “I have lost money, but the benchmark has fallen. For that reason, the loss is kept small.” However, it does not change that the loss is recorded, and it is important not to continue holding the stock for a long time by, for example, losing the stock early.

In addition, when losing pattern 2 accounts for 90% of the losses, “Unrealized losses are dragging heavily. The diagnosis, “We recommend improvements in both the timing of purchases and the selection of stocks,” he said. The art of cutting losses is also important, and we want to learn early on not only the selection of stocks and the timing of purchases, but also how to cut losses when they fail,” generates the advice.

### (Effect of Evaluating Unrealized Profit and Loss)

By adding trading profit and loss to the components of unrealized profit and loss to be evaluated, the following advantages can be obtained.

First, unrealized profit and loss is highly dependent on the previously determined trading profit and loss and purchase price is increased if the firm's earnings are large. According to this, when trading profit is large, even the same profit rate is effective in obtaining a larger profit. Conversely, when trading profit and loss is negative, purchase price is reduced, so the same rate of return is less profitable.

(Principal+trading profit and loss)÷principal or (principal+trading profit and loss+deposit and withdrawal)÷(principal+deposit and withdrawal) is an indication of how much principal is increasing due to trading profit and loss. These indicators greatly affect unrealized profit and loss because purchase amount, which is one of the components of unrealized profit and loss, is represented by (principal+trading profit and loss-cash balance) and so on.

According to the above, it has been clarified that the increase or decrease in trading profit and loss has a large effect on unrealized profit and loss, and thus the so-called compound interest effect can be clarified and quantified in the assessment and diagnosis of the investment profit and loss.

In addition, buy win weight and cash ratio are important valuation indicators, and it is important to raise buy win weight among the products held. And, like trading profit and loss, how much the difference between Winning profit margin (unrealized rate of return) and losing loss ratio (unrealized rate of loss) should be increased is important and added to the evaluation target. This enables multifaceted evaluations and diagnostics even with the same unrealized profit and loss.

If cash ratio is too high, an opportunity loss occurs and unrealized profit that would have been obtained can be estimated, and these are also important factors to be evaluated. Opportunity loss can be calculated by “cash×unrealized profit and loss ratio”. In addition, Winning profit margin (unrealized rate of return), losing loss ratio (unrealized rate of loss), and the difference are critical elements for managing unrealized profit and loss and are evaluated. If you have a lot of unrealized losses and exceed trading profit and loss level, it is problematic and should be improved first.

For example, it is important to obtain a method of increasing winning profit margin and a method of reducing losing loss ratio (unrealized loss rate), which enables multifaceted assessment.

Based on these evaluation values, it can be diagnosed. Then, various comparisons, such as comparisons with other comparisons and comparisons with the average, become possible. Ranking is possible and ranking is also possible. As a result, the advice based on the evaluation diagnosis comparison ranking becomes possible.

### Embodiment 2

Hereinafter, the embodiment 2 of the present invention will be described. For convenience of explanation, members having the same functions as those of the members described in the first embodiment are denoted by the same reference numerals, and the description thereof will not be repeated.

In the present embodiment, not only the evaluation to the actual trading but also the virtual trading (simulation) is performed by the user based on the previous actual stock price or event, and the advice generation unit 321 of the server 3 performs the evaluation on the virtual trading. That is, unlike the actual trading data, the user makes a trading determination in accordance with the previous stock price or event according to the form of answering the question displayed on the terminal 2. Then, the evaluation of trading and profit and loss by the advice generation unit 321 branches in accordance with the individual judgment of the user.

In particular, the servers 3 generate information about the virtual trading of investment commodity in the past. In the server 3, the advice generation unit 321 acquires the initial condition including the start time of the virtual trading and holding status of investment commodity and cash assumed at the start time. Then, the advice generation unit 321 sequentially generates two or more question screens including the date of the event occurring after the start time and the questions and options related to trading of investment commodity, using the initial condition.

The question screen may further include an event.

In addition, the questionnaire may further include an appraised value of the held property including investment commodity and cash at the date of the event.

Further, the advice generation unit 321 may calculate the appraised value of each investment commodity on the date of the first event as 100, and calculate the appraised value of each investment commodity on the date of the second and subsequent events as an index with respect to 100.

FIG. 16 is a figure illustrating an initial-screen of the simulated equity investments (virtual trading) according to the present embodiment. As shown in FIG. 16, the terminal 2 displays the initial-screen of the stock-investment-simulation. When the user clicks the “start” button displayed on the initial screen, the terminal 2 starts the stock investment simulation.

FIG. 17 is a figure illustrating an example of a questionnaire of the stock-investment-simulation according to the present embodiment. As shown in FIG. 17, the terminal 2 displays a questionnaire of the stock-investment-simulation. The question screen displays events, dates, questions, hints, elapsed time, held assets, and options. An event indicates that it can be occurring at that time. The date indicates the date when the event occurred. The question indicates a problem for the user. The hint indicates, for example, detailed advice on investment, which is different from the event. The elapsed time indicates the time elapsed since the start of the stock investment simulation. The held asset indicates the amount of the asset currently held by the user. There are four options for the question, for example, sale of A.J's stock, holding of B.J's stock, switching from C.J's stock to K's stock, and switching from D.J's stock to L's stock.

The process is described below. The process includes an initial condition, Question 1, and a result report.

### Initial Conditions

The initial conditions include date, holding status (issue and number of shares, cash), and initial an appraised value. Early an appraised value is an appraised value of all assets, including stock and cash. The initial condition may be held by the server 3 as a default condition or may be set by the user.

Specific examples of the initial conditions are shown below.
Date 0 is defined as the starting point of the stock investment simulation.
   Case of 4 stocks (A, B, C, D)
   The number of shares for issue A is a1 share, for issue B is b1 share, for issue C is c1 share, and for issue D is d1 share.
Initial an appraised value α (e.g., 4 million yen)

An appraised value of issue at the time of starting the simulated equity investments may be indexed to 100. Note that the user may start the stock-investment simulation while holding only cash, or may hold both cash and stock at a predetermined ratio.

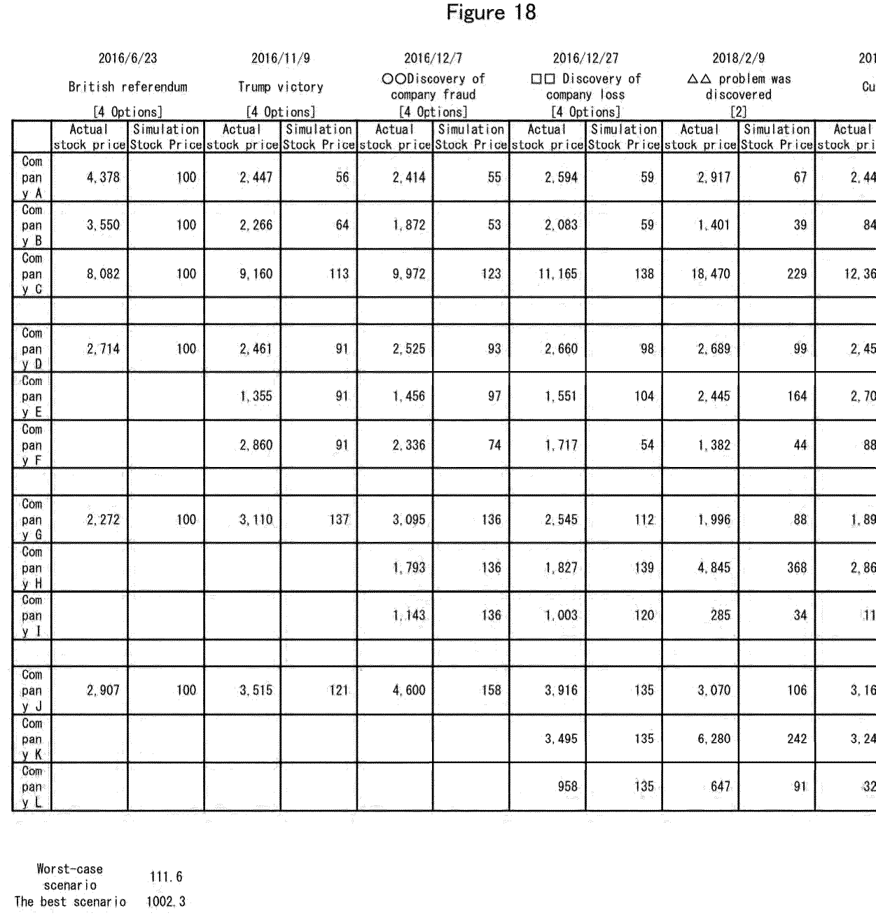

FIG. 18 is a figure showing the change in stock price in the simulated equity investments according to this embodiment. FIG. 18 shows the actual stock price and simulated stock price for the dates of the events. The actual stock price is literally the actual stock price. The simulated stock price is stock price expressed as an index, where stock price of each issue in 2016 Jun. 23 is 100, and thereafter stock price of each issue is expressed as an index relative to 100.

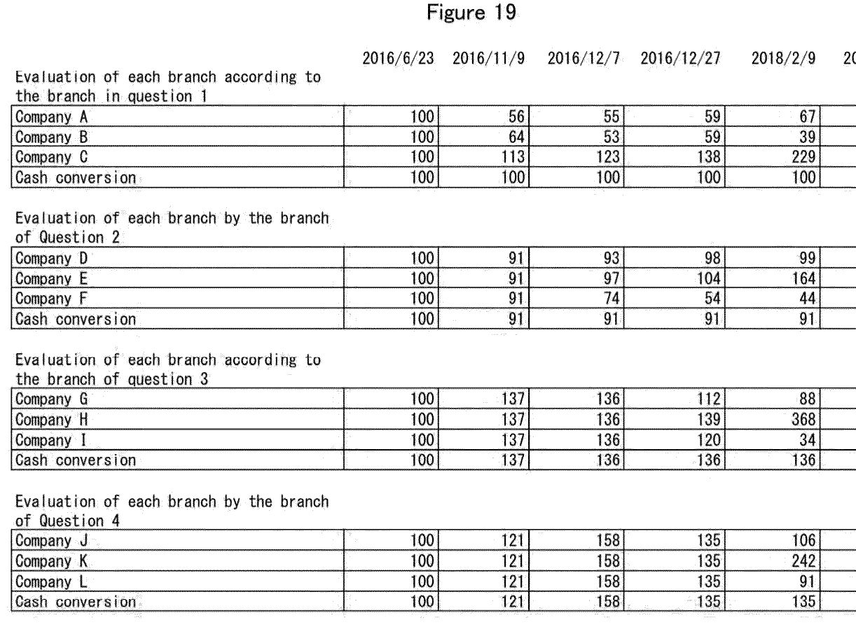

FIG. 19 is a figure showing the transition of an appraised value for each branch of each question in the stock-investment-simulation according to the present embodiment. An appraised value of the respective issue in 2016 Jun. 23 is set to 100, which is the first reference index. In addition, issue's an appraised value at the time of the branching of Question 2 in Nov. 9, 2016, is set to 91, which is an appraised value of a certain issue and is an index of 100. They make it easier to evaluate what issue should have been bought at that time by looking at the change in evaluation amount.

For example, when issue is replaced from G to E, cash is actually left over. This is complicated, so suppose that all proceeds from sales were replaced by E. Therefore, in 2016 Nov. 9, an appraised value of Company E is 91. In practice, if cash is left in excess, an appraised value 91 is a breakdown of E Company 80 and cash 11. An appraised value of 91 is assumed to be a case where cash is 0, but if it is more realistic, it can be assumed that cash is too large.

The above-mentioned case assumes that all of the funds to be sold are allocated to the funds to be purchased, but because of stock of units, it is a more realistic case that cash is left in practice. In this case, cash balance moves at the time of issue replacement, and such a case can also be displayed.

Each question will be described below. The dates for each question (question 1 to question 5) are 2016 Jun. 23, 2016 Nov. 9, 2016 Dec. 7, 2016 Dec. 27, and 2018 Feb. 9, respectively.

### Question 1

Date 1 (2016 Jun. 23)
An appraised value β (Sum of an appraised value calculated by stock price at Point1 o'clock of A, B, C, and D issue)
   Issue a Status Explanation and Offering Options
Description of the market as a whole or of the date of issue that requires judgment
4 case options

One example of issue ownership is the sale of issue a, maintenance of issue an ownership, transfer to E issue, and transfer to F issue. When simulating equity investments with cash alone, options include purchasing issue a, holding cash, and purchasing other issue.

### (Question 2)

Date 2 (2016 Nov. 9)
Holding
   Issue a Status Explanation and Offering Options
4 Case options (sell of D issue, holding of D issue, transfer to K issue, transfer to L issue)

### (Question 3)

Date 3 (2016 Dec. 7)
   Issue a Status Explanation and Offering Options
4 Case options (sell of D issue, holding of D issue, transfer to K issue, transfer to L issue)

### (Question 4)

Date 4 (2016 Dec. 27)
   Issue a Status Explanation and Offering Options
4 Case options (sell of D issue, holding of D issue, transfer to K issue, transfer to L issue)

### (Question 5)

Date 5 (Feb. 9, 2018)
2 cases of choice (sale of holding stock, prohibition of sale of holding stock)

4×4×4×4×2=512 an appraised value are calculated according to the answers to questions 1 to 5.

Stock price of the respective issue for the respective dates shall be 1A the “closing price of issue a on the date of Question 1”, 2C shall be “closing price of C issue on the date of Question 2”, and so on. Stock price at the beginning of the simulated equity investments shall be 0A, 0B, 0C, 0D.

The advice generation unit 321 calculates an appraised value (on an index basis) of all the patterns when the index at the starting point of issue is 100.

First, the advice generation unit 321 calculates four an appraised value at the date 1 of the question 1 as follows.
(1) Cases where issue a was sold
   Total of 1A×a1(cash), 1B×b1, 1C×c1, and 1D×d1. Or, if on an index basis, the sum of 100×1A/0A, 100×1B/0B, 100×1C/0C, and 100×1D/0D.
(2) Cases where issue a is retained
   1A×a1(A issues), 1B×b1(B issues), 1C×c1(C issues), and 1D×d1(D issues).
(3) In the case of switching from stocks A to stocks E:
   1E×e1
   E stocks (number of shares of E stocks calculated by 1A×a1/1E: e1 shares)
   Total of 1A×a1(cash), 1B×b1, 1C×c1, and 1D×d1.
(4) In the case of switching from issue a to F issue
   1F×f1
   F issue (number of shares of F issue calculated by 1A×a1/1F: f1 shares)
   Total of 1B×b1, 1C×c1, and 1D×d1.

Next, the advice generation unit 321 calculates an appraised value of the respective cases where the question 1 branches at the time point of the question 2 as follows.
(1) Cases where issue a was sold
   1A×a1(cash), 2B×b1, 2C×c1, 2D×d1. On an exponential basis, the sum of 100×1A/0A, 100×2B/0B, 100×2C/0C, and 100×2D/0D.
(2) Cases where issue a is retained
   Total of 2A×a1(A issues), 2B×b1, 2C×c1, 2D×d1.
(3) Transfer to E issue
   2E×e1
   E stocks (number of shares of E stocks calculated by 1A×a1/1E: e1 shares)
   1A×a1(cash), 2B×b1, 2C×c1, 2D×d1.
(4) In the case of switching to stocks F:
   2F×f1
   F issue (number of shares of F issue calculated by 1A×a1/1F: f1 shares) Total of 2B×b1, 2C×c1, 2D×d1.

Similarly, the advice generation unit 321 calculates an appraised value by setting stock price of holding stock or issue purchased to stock price at the date of the question 3 and the question 4. This makes it possible to grasp the transition of an appraised value of issue.

For example, in Case 3 of Question 1, an appraised value changes in stock price of E issue in order to be transferred from issue a to E issue. For example, in Case 3 of Question 2, in order to be transferred from B issue to G issue, stock price of an appraised value changes at first, but E issue's stock price of an appraised value changes after the transfer.

In this way, four an appraised value transitions are formed for each question. Thus, there are 512 combinations in this case, depending on the combination. That is, when the user answers each question, the user branches in 512 ways.

An appraised value changes over time, and the outcome of how much it eventually became is also branched out into 512 lines.

According to the above, it is possible to calculate an appraised value of the four cases of Question 1 and grasp the transition thereof. An appraised value of the four cases in Question 2 can be calculated and the transition can be grasped. An appraised value of 4 cases in Question 1, an appraised value of 4 cases in Question 2, an appraised value of 4 cases in Question 3, and an appraised value of 4 cases in Question 4 can be calculated using stock price at the respective time points.

### (Specific Example)

For example, in the case of the example, the best scenario is the case where all three issue other than recruitment were sold in February 2018 with the third choice. The appraised value of the property is 1,020,000 yen.

On the other hand, the worst-case scenario is the case where all the fourth choices are made. An appraised value is 1120000 yen.

In other words, the 512 cases fall within a range of 1120000 to 10.2 million yen. Then, the ranking of final appraised value can be calculated.

The best scenario is, of course, No. 1. The worst scenario is, of course, 512 places.

The answer results include ranking, final appraised value, change in evaluation amount, final stocks held, and cash, valuation profit, unrealized profit and loss, trading profit and loss, rotational force, diagnosis result, winning percentage, profit ratio for winning, loss ratio for loss, rating values, and advice.

### (Modification)

If you choose a date-based option, an appraised value transition for that question is determined. So an appraised value can be traced in time series. Originally, it may be started with cash alone. In order to clarify compound interest effect, the question may be further diverged, such as how issue replaced by the question is further executed. It is merely an example, and the number of questions may be small or large.

The larger the number of questions, the larger the opening, the bifurcation, and the larger the number of combinations. The more choices you have in your question, the closer it is to reality and the more combinations you have.

The determination of a plurality of issue may be included on the same date, or may be partially sold. Short selling or ETF may be included.

### (Learning Process)

Depending on the evaluation, it may be guided to the e-learning material in order to reinforce the weakness. For example, if rotational force is too high and trading performance has not been improved, the relevant teaching materials are collated in a database and learned through linking and providing content.

In the advice presentation system 1, the learning and theoretical learning to reinforce the weak point are learned according to the evaluation, and a mechanism to change the practice through the learning and change trading and change the evaluation is executed.

E-Learning has a mechanism that requires testing and confirmation testing to proceed before proceeding. In cooperation with such a mechanism, it is necessary to reinforce weaknesses to encourage students to learn, and then perform practical trading again to achieve results.

According to the above, it is possible to provide a learning path to the user when the user does not know what to learn or how to learn.

### Effect of Embodiment 2

Depending on the individual trading decisions, the user can experience how an appraised value changes, how the ratings diverge, and how the rankings change. In addition, users can understand and experience the process of dynamically changing personal assets and expanding investment disparities. That is, it is possible to make the user realize that the judgment of each trading greatly affects the investment-result.

As a result, the user's desire to learn about asset management can be extracted, and the learning effect can be further created.

### Embodiment 3

Embodiment 3 of the present invention will be described below. For convenience of explanation, members having the same functions as those of the members described in the first and second embodiments are denoted by the same reference numerals, and the description thereof will not be repeated.

In the present embodiment, an overall diagnosis performed by the advice presentation system 1 will be described.

### (Defining Overall Profit and Loss and General Diagnostics)

Overall profit and loss is profit and loss of the sum of unrealized profit and loss and trading profit and loss. Comprehensive diagnosis refers to a diagnosis that combines individual diagnoses for overall profit and loss, unrealized profit and loss, and trading profit and loss.

The advice generation unit 321 combines the individual diagnoses for overall profit and loss, unrealized profit and loss, and trading profit and loss to perform the comprehensive diagnosis for trading status of the user.

### (Significance of Comprehensive Diagnosis)

The results of investments are actually intertwined by multiple factors. Higher winning profit margin usually leads to lower rotational force when winning. Conversely, the lower the loss rate, the higher rotational force is associated. It is important to comprehensively diagnose these complex factors in order to see the whole.

For example, the greater trading benefit, the more affected the configuration of unrealized profit and the sharper compound interest effect. On the other hand, if there is no trading benefit, even if unrealized profit rate is high, the funds will not increase more than expected. In some cases, even if winning profit margin is low, rotational force may be higher. Each element has a complex effect on others.

For example, if winning percentage is low, but winning profit margin is high and losing loss ratio is low, it can be very well operated. If winning percentage is low, winning profit margin is low, losing loss ratio is low, and the “winning profit margin+losing loss ratio” is negative, the wealth is greatly reduced depending on the number. Comprehensive diagnostics are crucial because even if the other numbers are the same, only one number is smaller, resulting in an entirely different diagnosis result.

### (Effects and Examples of Comprehensive Diagnosis)

Even if the results of individual diagnoses alone are not known, an appropriate diagnosis result can be obtained by performing a comprehensive diagnosis by combining the results of a plurality of individual diagnoses.

For example, with respect to trading earnings, if the revenue is ±0, but unrealized profit is formed and wins, retention period is lengthened, only the good issue remains, and the bad issue is falsely diagnosed by looking at trading profit and loss only. It is only an instance that an appropriate diagnosis can be made by making a comprehensive judgment, including unrealized profit and loss diagnosis and winning-pattern analysis.

Even when rotational force is high, retention period is short, and winning profit margin and losing loss ratio are also low, some people earn winning percentage and have good operation. In one embodiment, the overall diagnosis result is good if there are other prominent parts, even if the diagnosis is not good individually.

These examples are the opposite diagnosis result to the individual diagnosis result and provide the reason for the need for comprehensive diagnostics.

### (Overall Diagnostic Process)

Unrealized profit and trading profit and loss, which are overall profit and loss, are formed by entanglement of various elements. Principal rate of annual growth has been determined by complex factors, and there are various types and various backgrounds even when the same results are produced. Diagnosis by complex factors is essential for the analysis of circumstances, and the process is performed by combining various valuation indicators.

### (Diagnosis by Type)

One method of the comprehensive diagnosis performed by the advice presentation system 1 is a type-based diagnosis. In the process of the type-specific diagnosis, the advice generation unit 321 calculates various valuation indicators, determines a combination of valuation indicators (a range of two or more valuation indicators), and classifies trading status of the user in accordance with the numerical value of valuation indicators.

Trading status can be categorized according to the combination of various indicators. A type that is the result of classification is defined as a type.

The types vary. They can be classified into large categories and small categories. The elements required to determine the types are various valuation indicators such as rotational force and winning profit margin described above. The types can be classified according to how the various valuation indicators are combined.

Different types can be assigned to different types, depending on how valuation indicators is combined. Only by changing the number of the partitions, there will be a change from type A to type B. However, it will be possible to clearly classify the categories that were not clear and rough until now by the number, and it will be possible to manage each type.

### (Examples of Type Classification)

The day trading type is one in which rotational force is very high, Number of days of revolution of principal is one day to several days, winning profit margin and losing loss ratio are sufficiently small, and winning percentage is the key to profitability.

The short-term swing trade types have a high rotational force and a Number of days of revolution of principal of about one week (4 days to 14 days, etc.). winning profit margin and losing loss ratio are also small, at around 5%, and winning percentage is the key to earning power.

Large value-range types are those in which rotational force is lower, but winning profit margin is overwhelmingly higher than losing loss ratio and the wealth is increased.

The long-term deferred type has a low rotational force and an average retention period of more than 360 days. It is dominated by unrealized profit and loss rather than trading profit and loss and has a large unrealized profit and loss breakdown, winning profit margin (unrealized) and losing loss ratio (unrealized) and cannot be sold.

The salted type has a low rotational force, a high losing loss ratio, a low winning profit margin, and an unrealized loss.

Importantly, valuation indicators can be typed and delineated by objective numbers. It may be derived by combining a plurality of delineations shown in each individual diagnosis.

For example, an evaluation value of rotational force diagnostics is 3 days or less, and a high weight (50% or more) is Pattern 1 in winning pattern analyses. It is regarded as a high-revolution type of the progressive type, because it is a type that has been successfully operated with a revolution effect anyway.

Various combinations are conceivable, and the combinations are free and can produce many types. Each valuation indicators that is the source of the individual diagnosis can obtain enough diagnosis result alone, but by using this combination, it can be further analyzed and the diagnosis can be made deeper and more precise.

For example, in individual diagnoses, rotational force is between 7 and 30 days, and winning profit margin is greater than 20% and losing loss ratio is reduced to 10%. This type has a total of 200 individuals, all of whom are capable of diagnosing and analyzing different types, such as high principal growth rates, more than 20% annually, 70% wealth growth, and an average annual growth of 25%.

### (Effects of Diagnosis by Type)

The effect provided by the type-specific diagnosis may be that the user knows that the user's own type is sharp, easy to compare with others, and has a variety of ways. In particular, the user's own standing position is clarified by comparison and ranking with persons of the same type, and there is an effect that a track to be improved can be made.

### (Ranking by Type, Comparison)

One way of comprehensive diagnostics performed by the advice presentation system 1 is to compare and rank evaluation values including principal change rate and the like among the types summarized by a plurality of factors. The advice generation unit 321 compares and ranks the evaluation values of the users for each of the types classified according to the numerical values of the plurality of valuation indicators.

Ranking and comparing the evaluation values for each type allows comparison and ranking of the evaluation values among groups in similar manners.

In the same way, it is possible to learn from others what to do in a better direction. For example, those who have a good result in a swing trade type are referring to which numbers are good.

### (Ranking by Type, Effect of Comparison)

By calculating the above evaluation values for each type, it is expected that an effect of clarifying which type is superior and which type is inferior will be obtained. Thus, for example, the average principal growth rate (annual rate) of the swing-trade type average is 10%, but the average principal growth rate (annual rate) of the large-scale type average is 25%, and the number of failures is small.

For example, if winning percentage is very high, winning profit margin is high, and the winning pattern occupies more than one among the above-mentioned types, the user can improve on the inferior figure compared with his own figure. In addition, although the ranking is good in the whole, the comparison with other such as an average number among the user's own types becomes easy, and the deeper analysis becomes possible.

### (Sample Diagnosis Result Report)

The following is a sample diagnosis result report for a user's trading status. Note that (dynamic change) below refers to a text or a numerical value or the like that dynamically changes according to trading data of the user.

The following is a sample report for the overall diagnosis result.
Comprehensive diagnosis
Diagnosis by Type
   A's trade type was determined to be a swing trade type (dynamically changing).
Type description
   The swing-trade type (dynamically changing) is a short-term swing trade type, with a high rotational force and a Number of days of revolution of principal of about a week (e.g., 4 days to 14 days), with winning profit margin and losing loss ratio as small as around 5%, and winning percentage as the key to earning power.
Your rank in the swing trade type (the rate of change in principal (annual rate of interest)) is 3rd out of 100 (dynamic change).
Order of types (averaged over principal change rate (annual rate of interest))
   25th out of 50 types (dynamic change)
Your overall ranking is 250 out of 1000(dynamic change).
Combined diagnosis
   Trading income formula and unrealized profit and loss formula (dynamically changing)
Comparison with the mean (dynamic change)
Good value (dynamic change)
Inferior value (dynamic change)
Overall diagnosis result (dynamically changing)

Among the swing trade types, the number is three, but among the total number is 250 out of 1000, so there seems to be sufficient room for improvement.

Particularly good numbers are rotational force and winning percentage, and poor numbers are the consequence of lower winning profit margin.

The following is a sample report for an individual diagnosis result.
Individual diagnosis
Rotational force Diagnostics
Diagnosis result (dynamically changing)
Evaluation Tables (Dynamic Changes)
Description (Dynamic Change)
Winning profit margin Diagnostics
Losing loss ratio Diagnostics
Winning pattern analysis
Loss pattern analysis
Trading profit and loss Analyses
Unrealized profit and loss Analyses
Overall profit and loss Analyses

### Embodiment 4

Hereinafter, a fourth embodiment of the present invention will be described in detail. For convenience of explanation, members having the same functions as those of the members described in the first, second, and third embodiments are denoted by the same reference numerals, and the description thereof will not be repeated. Further, the following comparative results, ranking results, diagnosis result, advice, and the like are exemplary, and are not intended to limit the present disclosure.

### (Information Presentation System 10)

The information presentation system 10 according to the present embodiment will be described with reference to the drawings. FIG. 20 is a figure showing a configuration of the information-presenting system 10 according to the present embodiment. As shown in FIG. 20, the information presentation system 10 includes a terminal (terminal device) 2 and a server (an information generating apparatus) 30. The terminal 2 and the server 30 are configured to be able to communicate with each other via the network 4.

The terminal 2 acquires a trading data by a user's manipulation, reading from a recording medium, or the like, and displays various types of data corresponding to trading data, and is, for example, a PC, a tablet terminal, a smart phone, or the like. The servers 30 generate various outcomes related to trading of investment commodity. The network 4 is a network including the Internet. Incidentally, investment commodity includes stock (including Japanese stock and foreign stock), investment trust, exchange traded fund (ETF), foreign exchange margin transactions (FX), and the like.

FIG. 20 is also a blocking figure indicating the configuration of the terminal 2 and the servers 30 according to the present embodiment.

### (Terminal 2)

As illustrated in FIG. 20, the terminal 2 includes a communication unit 21, a control unit 22, a display unit 23, and an operation-accepting unit 24. The details of each unit are the same as those of the first embodiment.

### (Server 30)

As shown in FIG. 20, the server 30 has a communication unit 301, a control unit 302, and a memory unit 303. Communication section 301 is the part that communicates with terminal 2. The control unit 302 controls the server 30 as a whole, e.g., one or more processors. The storage unit 303 stores a data according to an instruction from the control unit 302, and is, for example, a hard disk device, a flash memory, or the like.

The control unit 302 includes an information generation unit 3021. The information generation unit 3021 acquires investor (or investment commodity) trading data, generates aggregated target trading data from the acquired trading data, extracts and processes aggregated target trading data, creates a profit and loss level trading data (even if it has been carried in a previous step), calculates valuation indicators by referring to profit and loss level trading data, and generates information for displaying the calculated valuation indicators. Next, the information generation unit 3021 refers to valuation indicators to perform comparison, and generates information indicating the result of the comparison. A ranking is performed by referring to valuation indicators, and data indicating the outcome of the ranking is generated. Diagnostics are performed by referring to valuation indicators, and data indicating the outcome of the diagnosis is generated. Then, the information generation unit 3021 generates information indicating advice according to evaluation, comparison, ranking, diagnosis results, and the like. The information generation unit 3021 displays the generated information and generates and distributes article information and the like by various methods.

In this case, valuation indicators indication means that valuation indicators is displayed by calculating trading data. The evaluation here refers to the calculation and evaluation of the respective valuation indicators from trading data. Comparison refers to comparison with others using the calculated valuation indicators. Ranking refers to ranking based on valuation indicators. Diagnosis refers to the diagnosis of what trading has been done based on valuation indicators. Advice refers to advice based on assessment results, comparative results, ranking results, and diagnosis result. Indication here refers to displaying outcomes such as valuation indicators, assessments, comparisons, rankings, diagnostics, advice, etc. Generation and distributing article information and the like refers to generating and distributing valuation indicators, evaluating, comparing, ranking, diagnosing, advising, and the like as article information. However, the process of displaying, evaluating, comparing, ranking, diagnosing, and advising valuation indicators is not all essential and may provide at least one.

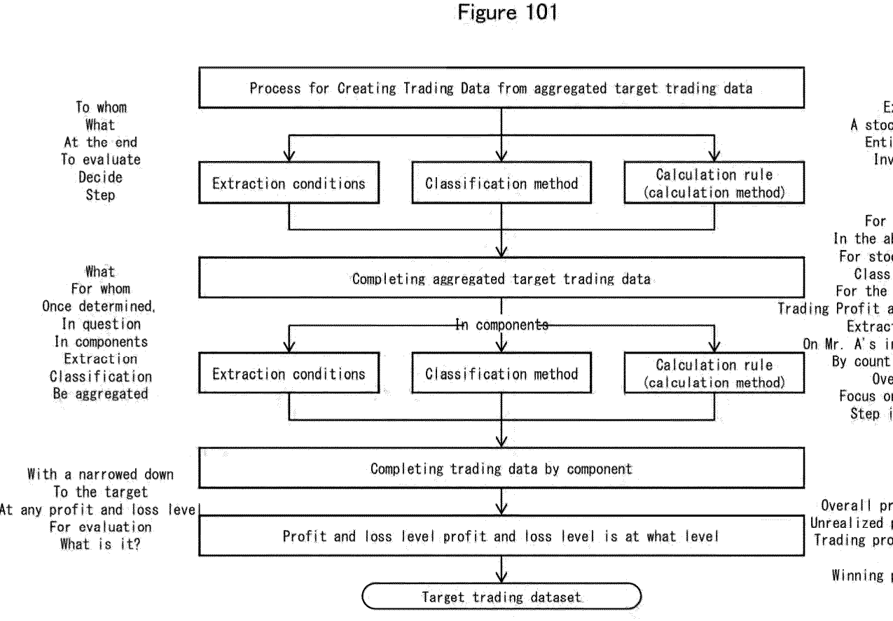

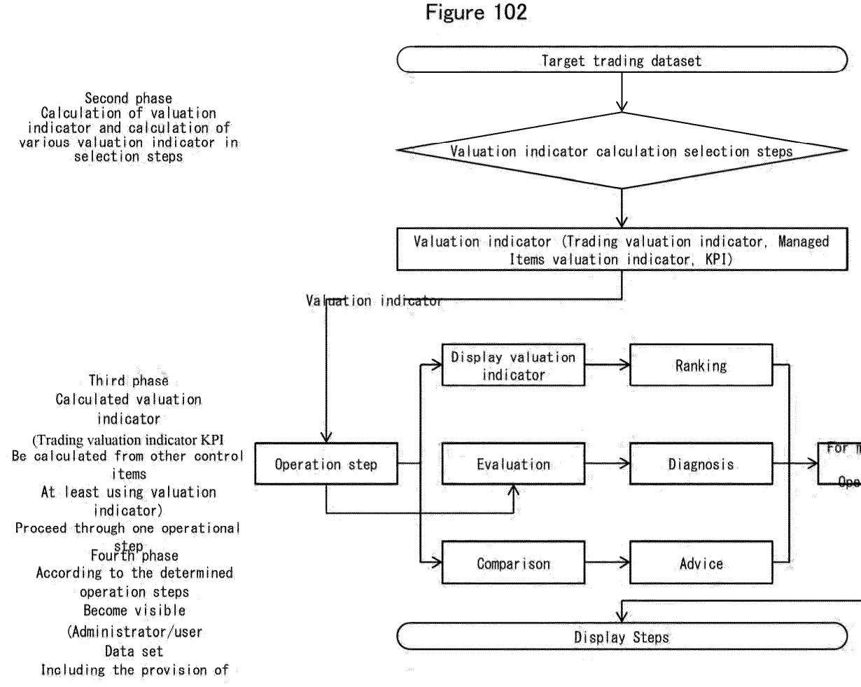

The system is shown first. The preparation phase is a first step, and is a preliminary step for processing accurately in the information processing system. For the first phase, see FIG. 101. For the second to fourth phases, see FIG. 102. Fifth to twelfth steps are referred to.

### (First Step)

The first step is a step of acquiring trading data, i.e., a step of acquiring a trading data or the like including trading data from a brokerage firm, a user, or the like. Usually, trading data gathered here is the next object to be processed. Of course, for securities of trading, such as brokers, this retrieval step can be reduced (or eliminated).

The first steps include storing trading data in DB of the storage unit 33. Further, the first step includes a problem given by the user, an article to be distributed, a decision, a request, and the like by the administrator. The first step may include a phase of processing into a fixed format. Usually, formats such as CSV files are mixed with buy and sell data, so that purchase data and sell data are opposed to each other, and data that are not opposed to each other are assigned market price, etc., and formatting as trading data is prepared. The first steps may include a displaying phase or may include an AI phase.

### (Second Step)

The second step is a step of creating an aggregated target trading data, and is a step of collecting a plurality of acquired trading data or extracting and classifying based on a certain criterion. The second steps may include increasing or decreasing data items as needed. The second step may include, for example, the phase of increasing brokerage items, increasing brokerage items, or increasing technical index value. These data items are basically associated with purchase data or sell data. Processing phases such as calculation of the total value, calculation of the average value and the maximum value, calculation of the composition ratio, and the like may be included.

The second steps include storing aggregated target trading data in DB of the storage unit 33. Aggregated target trading data may be managed in other tables and linked when needed. For example, other tables may include an Investment Tables, investor Tables, Performance Updates Tables, Technical Indicators Tables, Investment Types Tables, etc. A separate table containing the same items as trading data items (for example, stock code or stock code and date of purchase) can be prepared and linked by a common item, so that the information managed by the separate table can be included in aggregated target trading data item. Then, aggregated target trading data can be extracted by the information processing system, can be used as a component (component trading data), and can be expected to be used in various applications.

Trading data can measure buy and sell on a single basis, contain buy and sell items, or create and manage separate items for buy and sell. A trading data is a mix of buy-and-sell items, and a trading data is a mix of buy-and-sell items. However, a trading that doesn't have a market price and data of that date can be used. The second step may include a phase of processing. In addition, aggregated target trading data may include at least one extraction parameter by the information processing system, or may include all general extraction patterns by the information processing system, such as a OR and a AND.

The second steps may include a displaying phase or an AI phase (e.g., machine-learning, intelligent computation).

### (Third Step)

The third step is a step of creating a component-specific trading data, and is a step of further classifying aggregated target trading data by component, and extracting, classifying, and aggregating them. The third step may include an aggregation phase in which components are classified by component, and a total value or an average value is calculated for each component, or a composition ratio is calculated. The third step includes storing trading data for each component in DB of the storage unit 33. A's trading data for each component is defined as investor's aggregated trading data by investor classified and processed by issue for each component. Trading data may be further narrowed down by extracting criteria after classifying or may be aggregated. The third steps may include a displaying process or may include an AI (machine-learning, intelligence computation, etc.) process.

### (Fourth Step)

The fourth step is a step of creating a profit and loss level trading data, and is a step of determining a target profit and loss or profit and loss rate (average ROI). If you are targeting trading profit and loss ratio, create a trading profit and loss level trading data (even if you have it in a previous step). The target profit and loss (or average trading profit and loss ratio (mean of ROI)) further classifies and extracts the above trading data (aggregated target trading data, component trading data). It is also possible to bring the fourth step before the third step or before the second step.

The fourth step may include a process of calculating the aggregation, sum, mean, max, and processing values for each component (e.g., calculating purchase amount (purchase price×purchase quantity)). The fourth steps may include displaying profit and loss level trading data or storing profit and loss level trading data in DB of the storage unit 33. The fourth steps may include AI (machine-learning, intelligence computation, etc.) processing.

The first to fourth steps determine the target profit and loss (or profit and loss rate) and the most of the extracted trading data and control items (items on the horizontal axis in the tables and items on the databases) to be improved.

### (Fifth Step)

The fifth step is a step of calculating valuation indicators, which is defined as profit and loss level trading data as profit and loss (or average trading profit and loss ratio (mean of ROI)) of profit and loss created above affecting the target. The fifth step is a step of aggregating, extracting, or selecting valuation indicators calculated in this step, including valuation indicators calculated up to the fourth step.

The first through fifth steps are the basis. In the first through fifth steps, the target profit and loss (or average trading profit and loss ratio (mean of ROI)) to be improved and the classified and extracted trading data (profit and loss level trading data and component trading data, aggregated target trading data), control items (horizontal axis in tables), and valuation indicators (or average trading profit and loss ratio (mean of ROI)) to be influenced are determined. The fifth step may include a processing calculation process or may include a display process. The fifth step includes the storage of the storage unit 33 in DB. The fifth steps may include AI (machine-learning, intelligence computation, etc.) processing.

### (Sixth Step)

The sixth step is an assessment step of trading status and holding status of the subject. Note that the sixth to tenth steps are out of order and are not essential steps. The sixth step is a step in which the target trading data determines how valuable it is, and the information processing system examines good points, bad points, and the like, and the information processing system evaluates the target for which the value is determined. The sixth step is to evaluate the present state and the historical state by expressing the state in valuation indicators in response to the improvement of the target profit and loss.

The sixth step is a step of evaluating the target valuation indicators using profit and loss (or average trading profit and loss ratio (mean of ROI)) calculated up to the fifth step, and is a step of determining and evaluating which valuation indicators to use and how to evaluate (including maxima, averages, composition ratios, etc.). For example, if valuation indicators is trading profit and loss level trading data, trading status is evaluated. The sixth step may include a processing calculation process or may include a display process. The sixth step includes storing the evaluation result in DB of the storage unit 33. The sixth steps may include AI (machine-learning, intelligence computation, etc.) processing.

### (Seventh Step)

The seventh step is a comparison step with the comparison object. The seventh step is a step of determining which valuation indicators is to be compared, which valuation indicators is to be compared, and how to be compared (including the largest value, the mean value, the composition ratio, etc.) using valuation indicators calculated in the fifth step. The seventh step may include a process calculation phase. Of course, the seventh step includes storing the comparison result in DB of the storage unit 33. The seventh step may include a displaying process or may include an AI (machine-learning, intelligence computation, etc.) process.

### (Eighth Step)

The eighth step is a ranking step for each aggregation target from the component. The eighth step is a step of using valuation indicators and the like calculated in the fifth step to decide on which criterion and which valuation indicators to rank and how to rank. The eighth step may include a processing calculation process or may include a display process. The eighth step includes storing the result of the ranking in DB of the storage unit 33. The eighth steps may include AI (machine-learning, intelligence computation, etc.) processing.

### (9th Step)

In the ninth step, valuation indicators calculated in the fifth step is used to diagnose which valuation indicators is bad and where is good. The ninth step may include a processing calculation process or may include a display process. The ninth step includes storing diagnosis result in DB of the storage unit 33. The ninth steps may include AI (machine-learning, intelligence computation, etc.) processing.

### (Step 10)

The tenth step is an advice step (the sixth step to the tenth step are out of order and are not indispensable steps), that is, a step of displaying valuation indicators up to the ninth step, a result of diagnosis, a result of comparison, a result of evaluation, a result of ranking, and the like (or only the step). The tenth step is, for example, a step of providing advice to improve the user's future trading behavior by indicating how the target profit and loss (or average trading profit and loss ratio (mean of ROI)) changes as valuation indicators judged to be bad in diagnosis result changes. The tenth step may include a processing calculation process or may include a display process. The tenth step also includes storing the advice to DB of the storage unit 33. The tenth steps may include AI (machine-learning, intelligence computation, etc.) processing.

### (Eleventh Step)

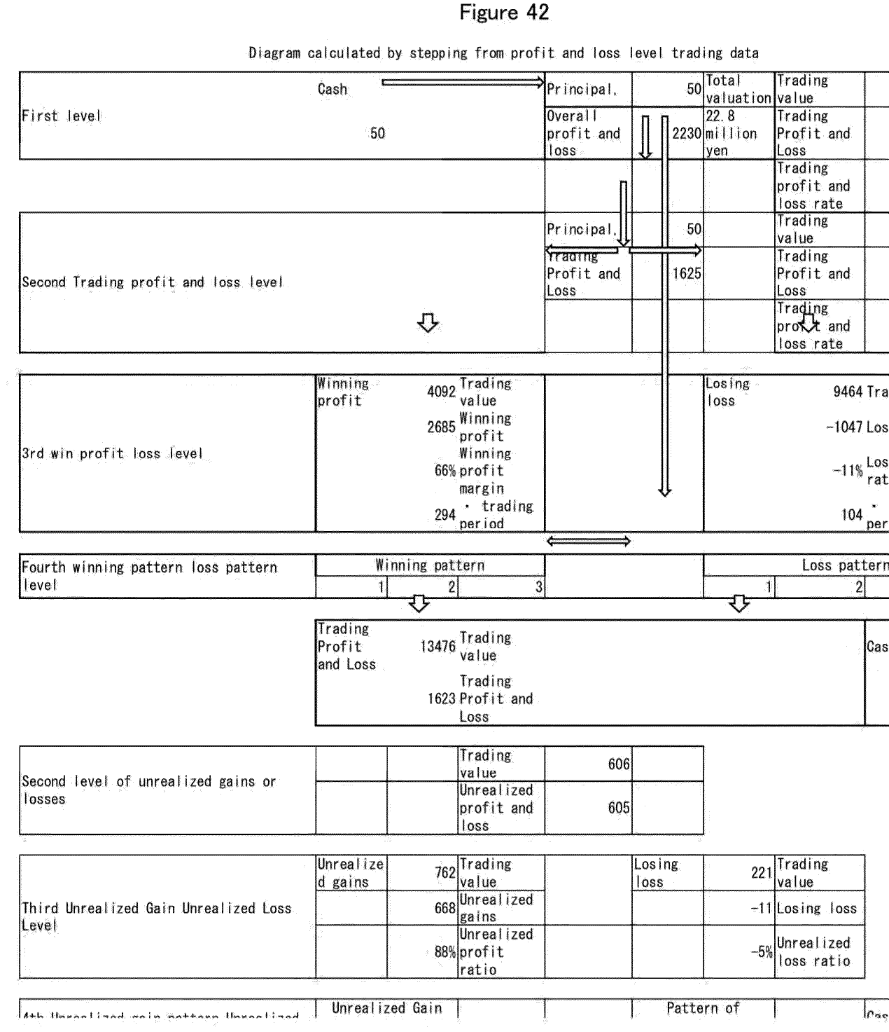

The eleventh step is a display step (the sixth to tenth steps are out of order and are not essential steps). By the tenth step, valuation indicators was displayed, and the results of the advice, the diagnosis, the comparison, the evaluation, and the results of the ranking, valuation indicators calculation, etc. are stored in DB of memory part 33 of server 3, as shown in FIG. 2 and FIG. 42, and output separately.

Output results up to the tenth step are simply a list of numbers, a result of numbers, a text-based result, comparative tables, ranking data, etc., and whether they are easy to understand or understandable is another issue. In order to make the content convenient, easy to understand, and easy to understand for the user, the display step of the eleventh step and the subsequent steps are also very important.

In each step, this display step may be included or may be performed collectively before being shown to the user. Of course, the eleventh step includes storing the displayed content in DB of the storage unit 33. The eleventh steps may include AI processing, or may be in a table lookup format. In addition, a display process may be defined in each step. The eleventh step may include a machining calculation process.

### (Step 12)

The twelfth step is an article generation and distribution step (the sixth to tenth steps are out of order and are not essential steps). By the tenth step, valuation indicators was displayed, and as a result of the advice, the diagnosis was made, the results were compared, and the results were evaluated, the results were ranked, and the results of valuation indicators calculation, etc. were received, and their results sets were stored in DB of memory part 33 of server 3, as shown in FIG. 2 and FIG. 42, respectively, and were output separately. The resulting data set can be stored in DB along with the process. The administrator can also use it for e-mail delivery, article delivery, and blogging articles (twelfth step).

### (Problem Solving System and Data Generation System)

The first step to the twelfth step is the flow of data generation system by the information processing system from inputting (causing) trading data. On the contrary, this is also a system in which various problems are solved (cause) when a problem (result) is input. Therefore, when inquiring about the results of the output up to the twelfth step, the answer can be answered in all cases. This is the method of utilizing the information processing system as a problem solving system.

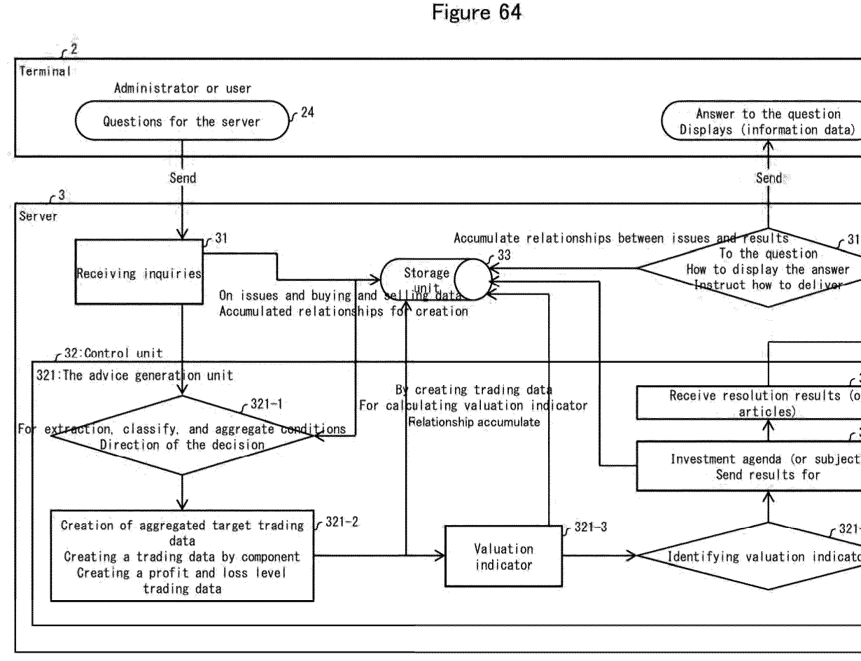

FIG. 64 is a figure indicating a flow of data between the terminal 2 and the servers 30 according to the fourth embodiment.

FIG. 64 is a detailed explanation of FIG. 2. In the first embodiment, the administrator (or the user) displays diagnosis result answer from the inquiry to the servers 3 in order to obtain diagnosis result. As a result, FIG. 64 is a figure of an information processing system that indicates that the relationship between the creation of trading data and the calculation of valuation indicators, the relationship between the problem and the result, the relationship between the problem and the creation of trading data, and the like can be stored in the storage unit 33, accumulated, and retrieved as needed. In the problem solving system, a problem and a trading data are created, valuation indicators is calculated, valuation indicators is identified, a solution to the investment problem is generated, and the result is accumulated in the storage unit 303. These relationships are associated with each other, and by storing and storing the relationships, the relationship that valuation indicators of A is calculated from trading data of A is accumulated, and the accumulation of the relationships can be used in various aspects.

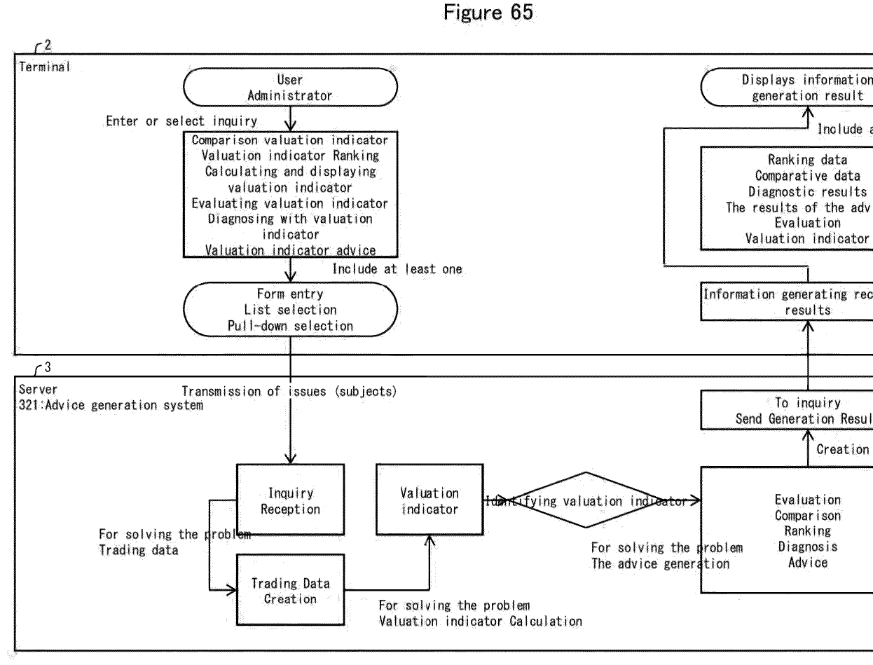

FIG. 65 is a figure indicating that the inquiry according to the fourth embodiment is synonymous with that of the information processing device. FIG. 65 is a process figure from the inquiry to the answer, and the inquiry is a figure indicating that various outcomes data created by the information processing system are indicated.

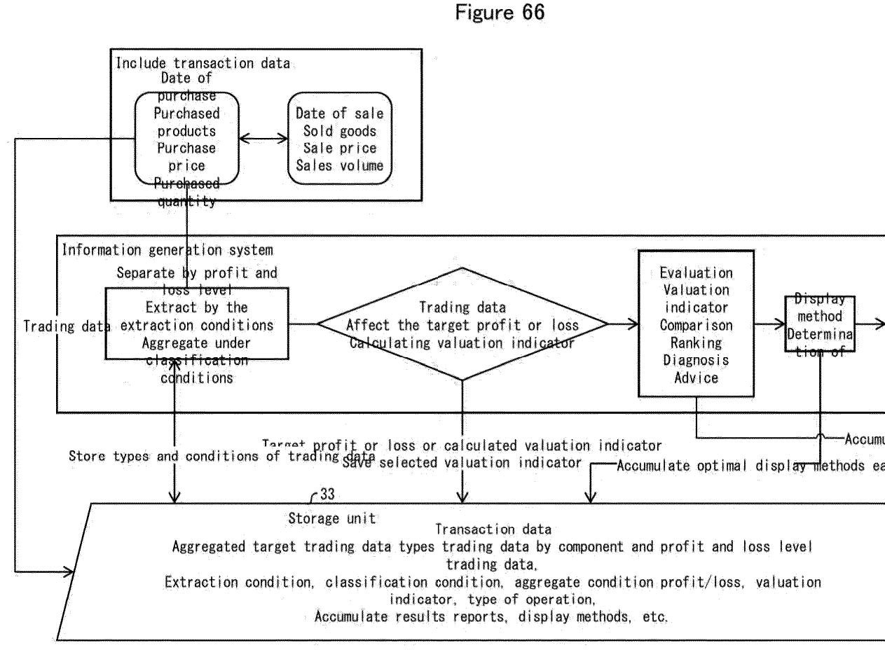

FIG. 66 is a figure indicating which data according to the fourth embodiment of the present disclosure is to be accumulated. FIG. 66 mainly represents the relation between the information processing system and the storage unit. Each time the advice is generated, the various data are accumulated in the storage unit 33. Such a process is similar to the process of generating the resulting data from inquiry input.

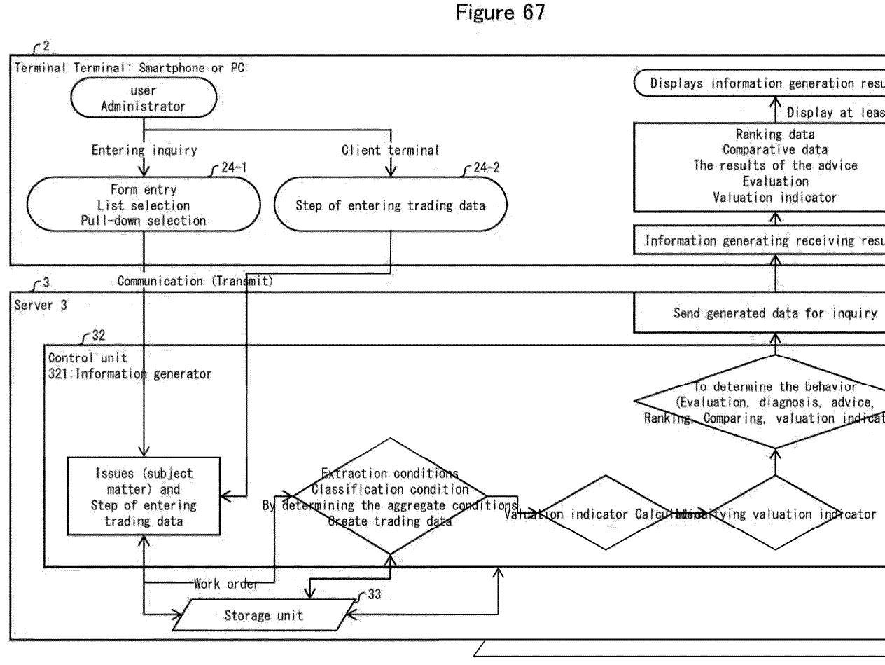

FIG. 67 is a figure illustrating a process using a hardware-resource according to the fourth embodiment. FIG. 67 is a hardware-configuration figure and is a figure indicating how the hardware-configuration is linked. The step of receiving the input of the information of the user or the administrator is performed by the terminal 2.

After that, the inputted information is transmitted to the servers 3, and information such as a task and trading data is accumulated in the storage unit 33. Upon receipt of an inquiry or trading data, data is extracted from the storage unit 33, and a work instruction for what kind of work should be performed is designated to aggregated target trading data. With regard to trading data, trading data is created by determining the extracting conditions, the classifying conditions, and the aggregate conditions. valuation indicators is calculated from trading data, and is also referred to the storage unit 33 at this time. The optimal valuation indicators is identified from a number of valuation indicators, and the operation is determined. Whether valuation indicators is displayed, evaluated, advised, ranked, or compared is determined, and valuation indicators is used to determine how the expressions should be expressed. Also at this time, cooperation with the storage unit 33 is performed, and it is determined with reference to a table or the like. Finally, the results are output, transmitted, and sent to terminal 2, the results are received, and the results are displayed in a determined display method. Such processing is the same not only for the problem solving system but also for the advice generation system and the article generating system.

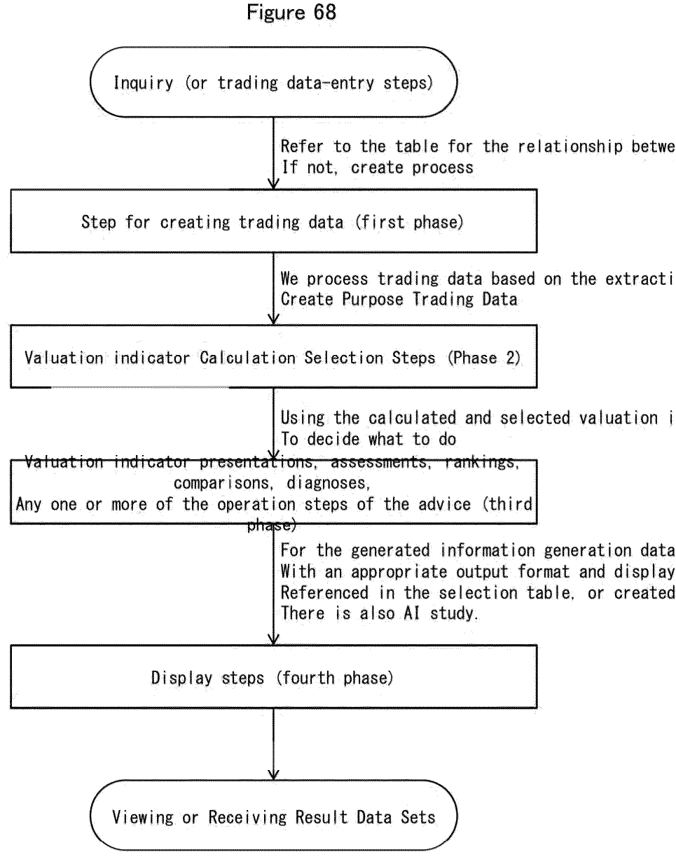

FIG. 68 is a figure showing a method for solving the inquiry of the information processing device according to the fourth embodiment. In this method, not only the problem solving system but also the advice generation system and the article generating system are similar.

FIG. 68 is a detailed explanation of FIG. 2. As shown in FIG. 2, which includes input from the terminal 2 by a user or an administrator (trading data in a broad sense, issue of investment, data, etc.), the operation acceptance unit 24 accepts a data (in the first embodiment, the step of inquiring the server 3 by inputting an inquiry to these servers is performed on the management screen. This input is not a special action but an action performed by a normal administrator). (This input is not a special act, but one that is normally performed by the administrator.) The communication unit 21 of the terminal 2 transmits these data to the servers 3. The communication unit 31 receives these data from the servers 3. The advice generation unit 321 of the control unit 32 of the server 3 creates the generation process on the received data, and generates the advice data through the creation of trading data, the calculation of valuation indicators, and the like, and generates valuation indicators data, the assessment data, the comparison data, the ranking data, the diagnosis data, and the advice data (sequentially stored in the storage unit 33). The communication unit 31 of the server 3 transmits the results to the terminal 2. The communication unit 21 of the terminal 2 receives the result, and the control unit 22 causes the display unit 23 to display the result.

In the case of the trading data, as described, the trading data is created through processing such as extraction from the trading data (creation of Aggregated target trading data), classification, etc. (creation of component trading data), aggregation, etc. (creation of Profit and loss level trading data, etc.), and the valuation indicators is calculated, and results such as evaluation, diagnosis, advice, comparison, and valuation indicators results are output using the valuation indicators (in the case of an administrator user, it is needless to say that this may be the case), and the result data is displayed on the display unit 23 of the terminal 2. Although these are the same as the previous descriptions, the steps of the query are, of course, not answerable to any question, but data calculated from trading data can be answered to a variety of different questions, as described in many specific examples.

In the step of the problem solving system, as shown in FIG. 68, the inquiry input (24-1)(an action normally performed by an administrator or an inquiry from a user, or the like, regardless of the method) is similarly subjected to the generation process, and finally, the display unit 23 of the terminal 2 displays the solution result of the problem (in the case of an administrator, the result set is received, and in the case of a user, the display is not all). This operation instruction is a sequence of operations performed by the various data calculated in the second to tenth steps described above, viewed from the opposite side.

As a specific example, it is clear at a glance, and the problem of “winning percentage is how many % can be calculated from trading profit and loss trading data by the number of wins/number of trades. In Mr. A's diagnosis result, part of valuation indicators calculated from trading profit and loss trading data is related to winning percentage calculated by the number of wins/number of trades.

In other words, it is possible to look at the relation between trading data and valuation indicators in the direction “trading data→Calculation of valuation indicators” or in the direction “valuation indicators→How to Extract trading data” so that the inquiry can be resolved.

Therefore, the process of determining the extraction, classify, and aggregate conditions is equivalent to “how to extract (including classification and aggregation) trading data from the viewpoint of valuation indicators” for the question of calculating valuation indicators, for example. When trading data is extracted, the result is the same as this valuation indicators.

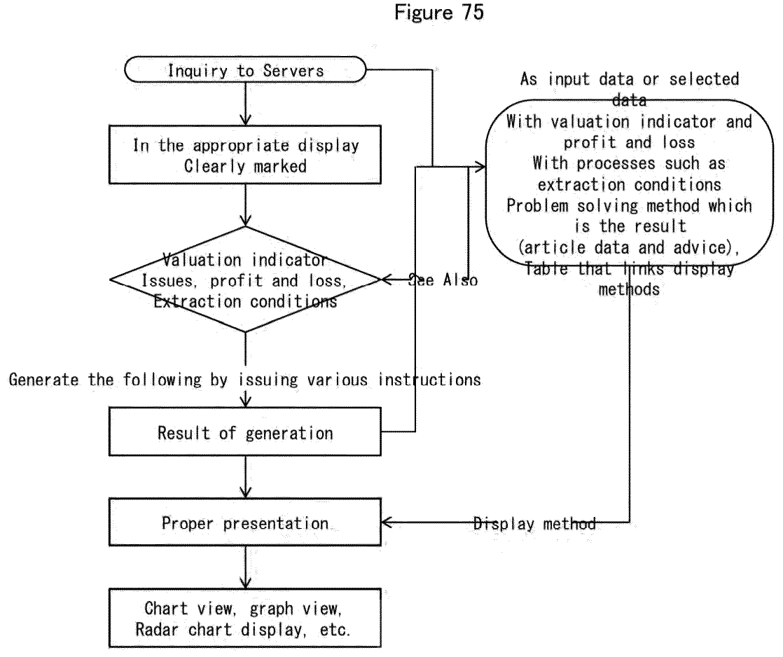

Therefore, this decision process can determine the extraction criteria that trading data should be extracted in order to calculate valuation indicators by creating a table stating that this valuation indicators will be generated when trading data is extracted (see FIG. 75). The process is all possible from the second step to the eleventh step.

Therefore, the numbers, tables, and presentation results (e.g., advice results, diagnosis result, ranking results, etc.) calculated in the second to eleventh steps can all be correlated by following how they were calculated. The same applies to valuation indicators calculated in the first embodiment.

In the context of creating a winning profit trading data from trading data and calculating winning profit margin, winning profit margin is derived, and diagnosis result and so on. For the challenge of “Mr. A's diagnosis result is desired,” the process is described as a step. Therefore, if these are made into a database, various problems will appear and various procedures will appear. Machine-learning enables us to answer a variety of investment challenges (conversely, by creating a stack of valuation indicators that can be obtained in this way, data can accumulate and answer a number of investment challenges).

FIG. 68 is a figure that shows how the query is resolved. There are a query input step, a trading data creation step, valuation indicators calculation step, an operation step, and a displaying step, and each of them is described in detail below. These steps are the same for not only the problem solving system but also the advice generation system and the article generating system.

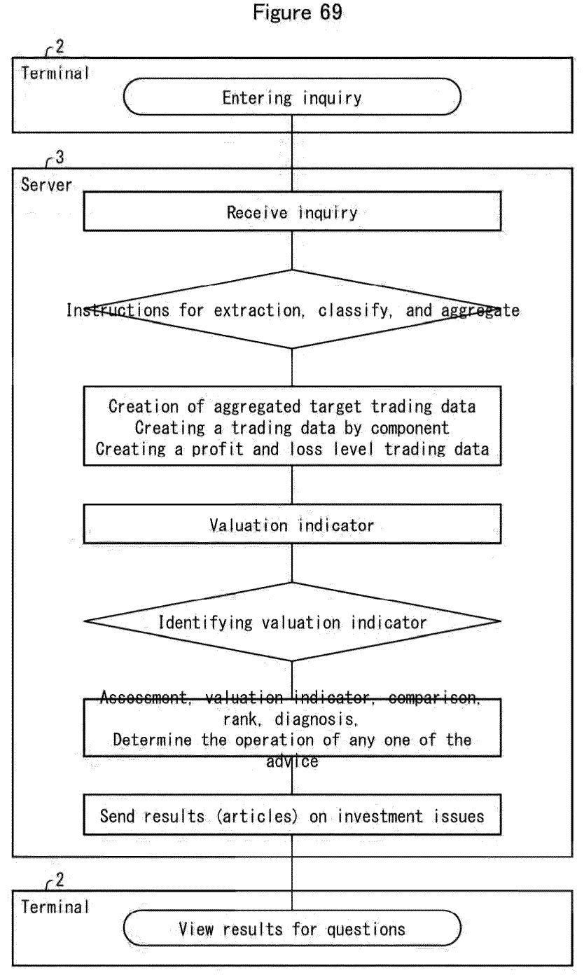

FIG. 69 is a figure showing a flow of a process performed by the servers 3 of the information processing system according to the fourth embodiment. FIG. 69 is a figure indicating how the process of the servers 3 is performed. This processing is the same not only for the problem solving system but also for the advice generation system and the article generating system.

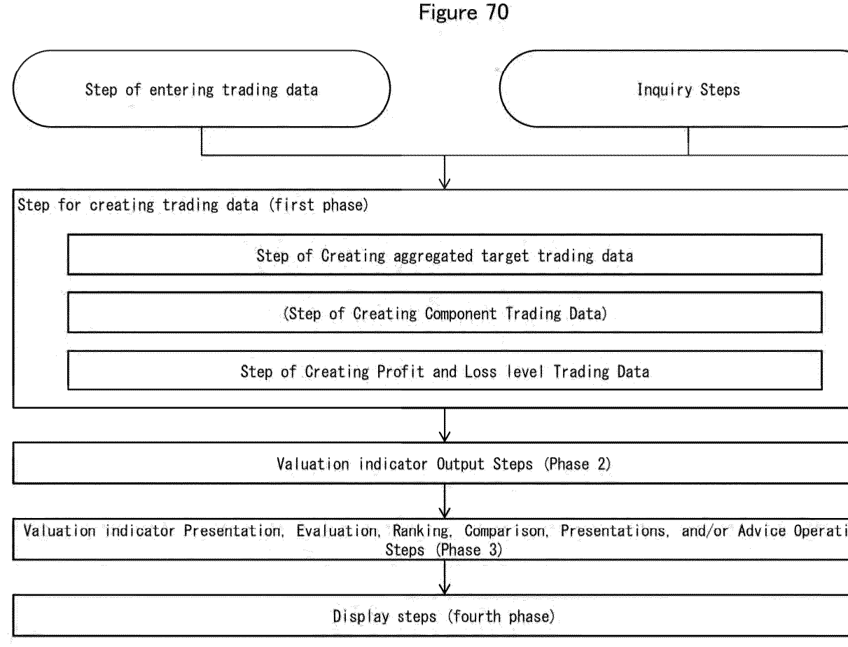

FIG. 70 is a figure showing the process 2 of the information processing device according to the fourth embodiment. FIG. 70 is a figure supplementing trading data entry in FIG. 68. In this processing method, not only the problem solving system but also the advice generation system and the article generating system are similar.

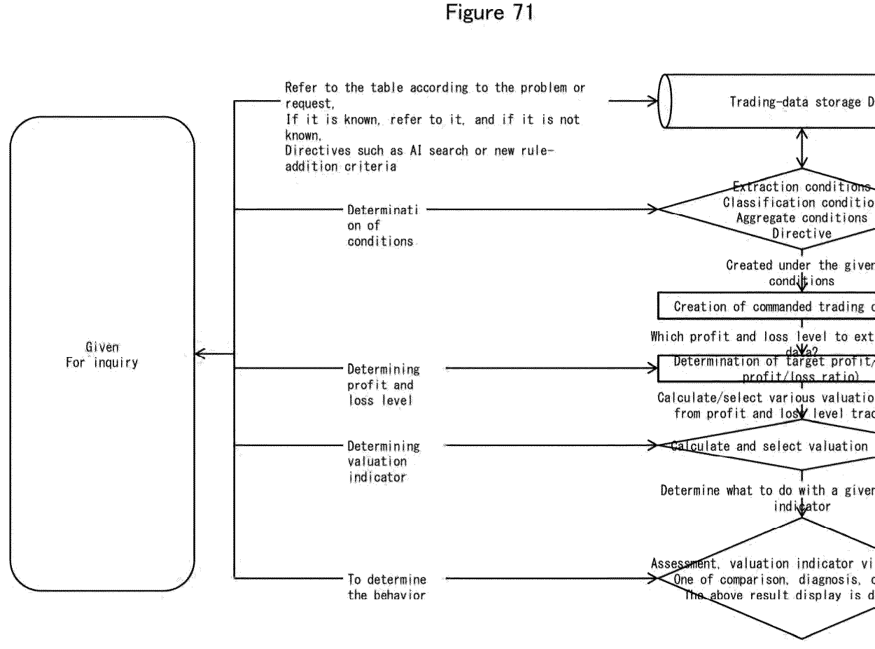

FIG. 71 is a figure indicating a computation process of the information processing device according to the fourth embodiment. FIG. 71 is a figure indicating what computation process is performed for a given task. A trading data is created by directing trading data to determine the extraction conditions, classification conditions, and aggregation conditions. trading of the target is determined from trading data, and valuation indicators that affects trading of the target is calculated and selected. valuation indicators is used to determine what kind of action (at least one of which is advised to evaluate) is to be performed, and a computation process is performed to determine the indication of the outcome. This calculation processing is the same not only for the problem solving system but also for the advice generation system and the article generation system.

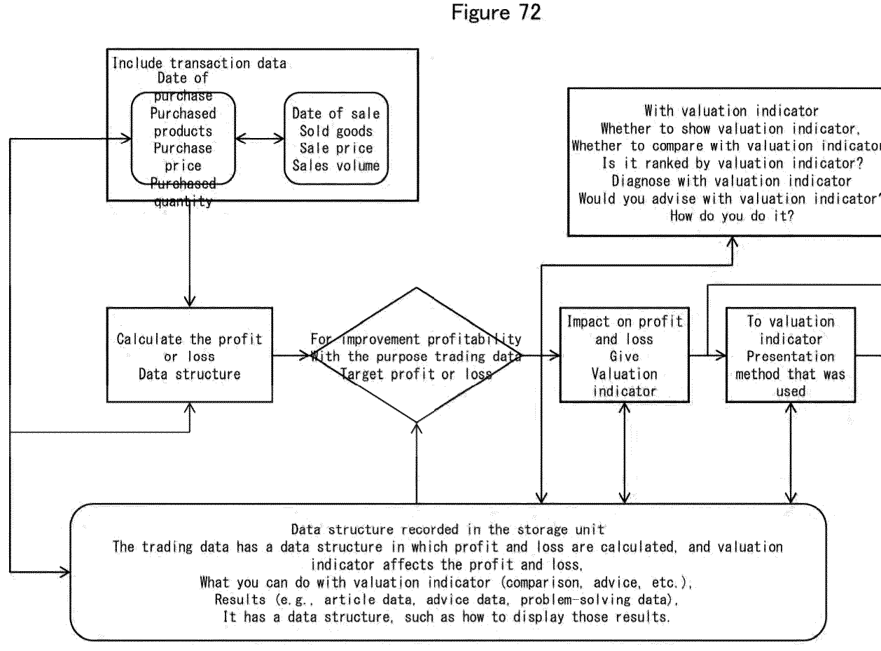

FIG. 72 is a figure showing data configuration of the information processing system according to the fourth embodiment. A characteristic of data structure recorded in the storage unit 33 is a figure indicating that trading data has a data structure in which profit and loss is calculated, and has a series of cooperative data structures, such as valuation indicators that affects profit and loss, an operation (compare, advise, etc.) that can be performed by valuation indicators, a result obtained therefrom, and a method of displaying the result thereof. Data configuration is the same not only for the problem solving system but also for the advice generation system and the article generating system.

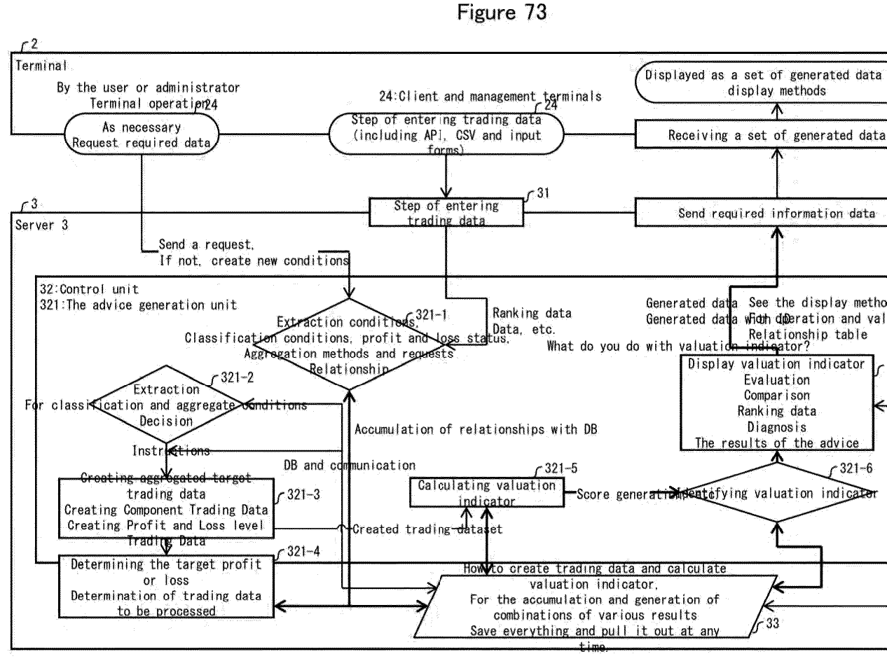

FIG. 73 is a figure indicating a look-up table method of the information processing system according to the fourth embodiment. The look-up table is a table showing the correspondence between trading data extracting conditions, categorizing conditions, profit and loss status, aggregation methods, and required data.

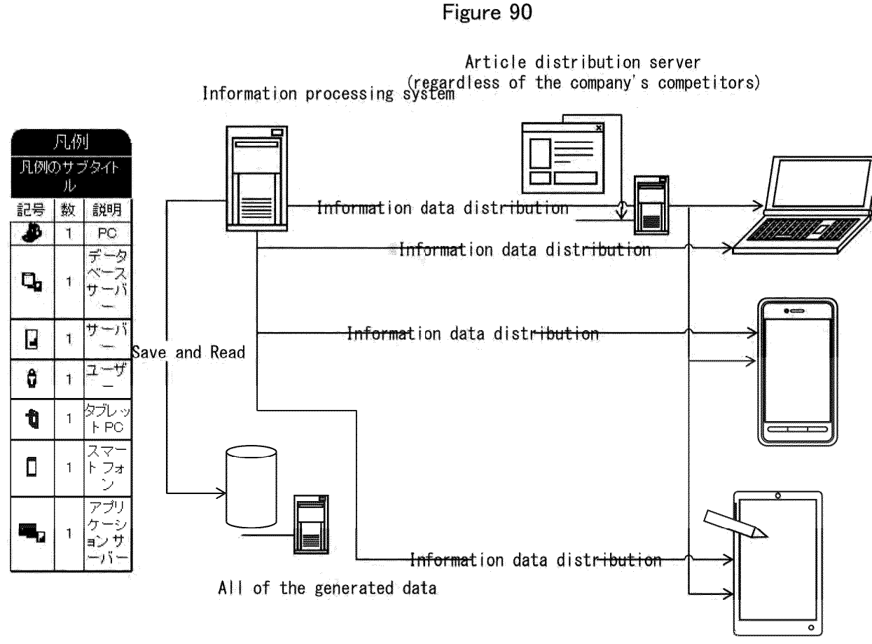

FIG. 90 is a figure indicating a network according to the fourth embodiment.

When the article data is distributed, an article distribution server (regardless of the company's own company) is installed, and the division method data generated by the information processing system is distributed as an article or processed to distribute the information data.

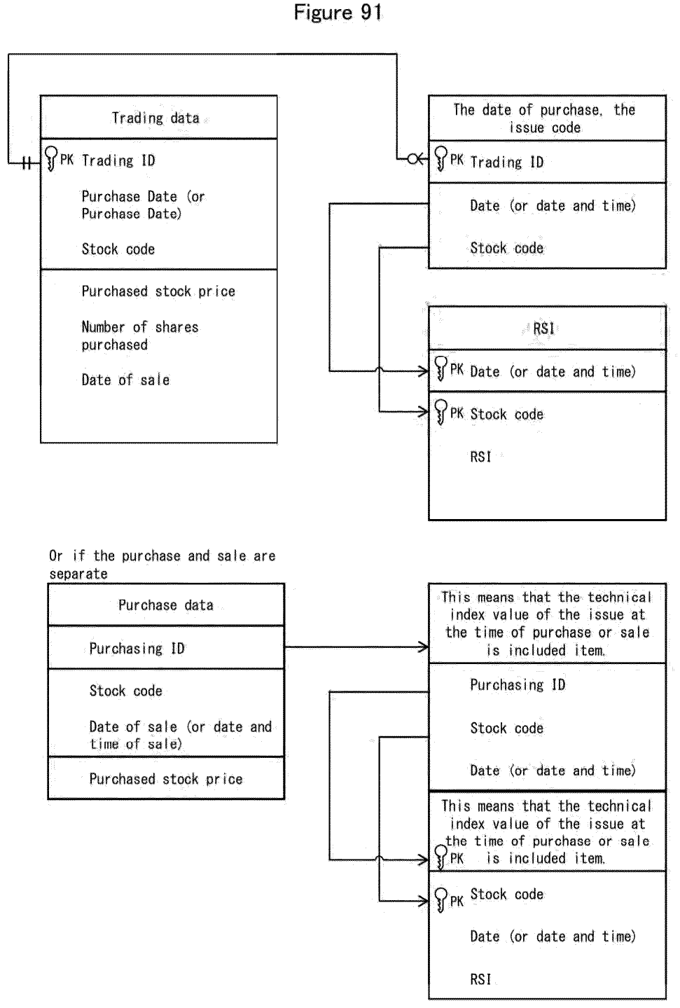

FIG. 91 is a database-related figure according to the fourth embodiment. For example, there are a method of associating a date of purchase and a stock code table with a trading ID, and a method of associating a RSI (Relative Strength Index with a stock code and a date, and a method of associating with a purchasing ID. RSI is a method of determining whether the market is over-sold or over-sold by using the price rise and the price fall in a constant period market to express the strength of price movements numerically. In addition to this method, a method of associating trading data or purchase data with technical index value in some way is defined as another table lookup method.

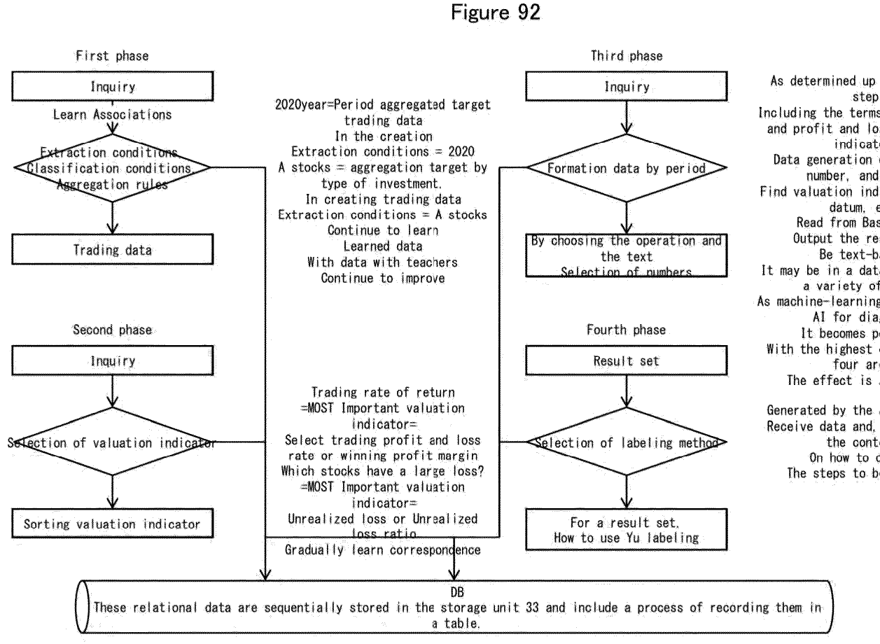

FIG. 92 Indicating the related figure of AI training according to the fourth embodiment. Figure indicates how AI is learned in every phase. In the first phase, an administrator or a user makes various inquiries to the information processing system, and learns the association of what kind of extraction condition, classification condition, and aggregate rule should be instructed to the inquiry. Specific examples are shown. In the second phase, we learn how to select valuation indicators in response to an inquiry about the information processing system. Critical: To determine valuation indicators, we learn how to change the fourteen yellow soils by valuation indicators numbers for queries, for example, by scoring. We also learn how to determine valuation indicators to be calculated and displayed for various inquiries. In the third step, the association of which result should be displayed with respect to the inquiry is learned. Learn how to associate valuation indicators action steps, such as displaying, evaluating, comparing, ranking, diagnosing, advising, and creating data, with what to do and what to do. In the fourth phase, the information processing system learns how to display the generated result set in which display method. These functions may be provided in all of the fourth phases, or any one of these functions may be provided, and any one of these functions is defined as an AI learner.

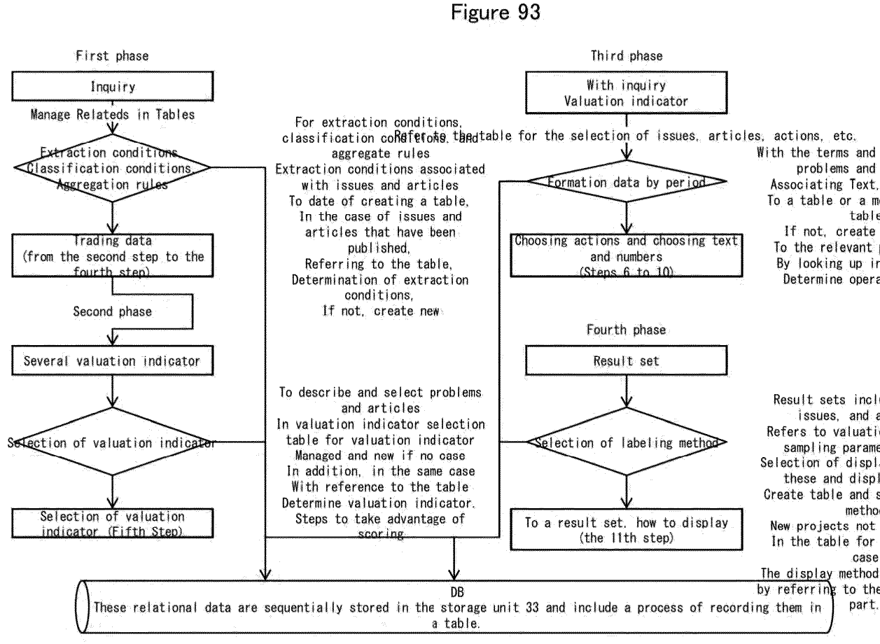

FIG. 93 is a figure showing the association of the table lookup according to the fourth embodiment. A figure that describes how tables are being referenced and what tables are needed in every phase. In response to requests for various types of information processing systems and requests for problems, an attempt to answer the question while referring to a table is defined as a table reference method. In the first phase, we aim to increase the number of inquiries that can respond to various types of inquiries by processing trading data in terms of the extraction conditions, classification conditions, and aggregation rules for inquiries, and by creating and managing a relational table of various conditions (conditions for creating target trading data) and the table. Reference is made if it has already been found, and a new association is recorded in the table if it is new. In the second phase, the table lookup method used to select valuation indicators, including the tables used to change the scoring and weighting used to select the most critical valuation indicators (see valuation indicators Selection Processing). It also includes a simpler way of choosing valuation indicators from the words of the query. In the third phase, the operation is determined by referring to the association table of which operation step and which result set is returned for the task through the operation related table. In the fourth phase, a table is defined as a display method selection table in which a method of expression, a graph, a table, a chart, an item to be an X-axis, and the like are associated with a result set. By referring to these tables, it is defined as a table reference method that the next processing is determined by the information processing system.

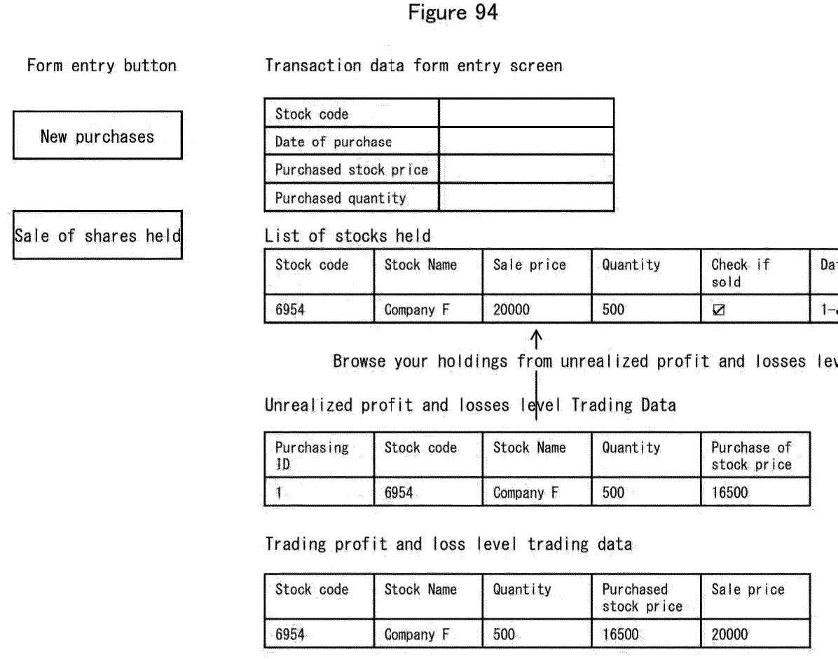

FIG. 94 is a figure indicating a trading data according to the fourth embodiment.

A figure is an example of the format in which a user or administrator enters a trading data from a form. If you are purchasing a new one, you will be presented with a window to enter four items (or more), as shown in figure above. On the other hand, when holding stock sale button is pressed, a list of holding stock is displayed, and the items to be entered are limited to the sale stock price and date of sale, as shown in the figure below, and the determination of sale is easily transmitted to the information processing system. The quantity also includes means for decreasing the unit relative to the number of shares held in a pull-down method. (For example, if the number of shares per unit is 100 stock and the number of shares per unit is 500 stock, the 500 stock 400 stock 300 stock 200 stock 100 stock is displayed in a pull-down method, and the quantity to be sold is selected.) The content of these entry forms is figure which is sent to the information processing system and indicates that various trading data are updated.

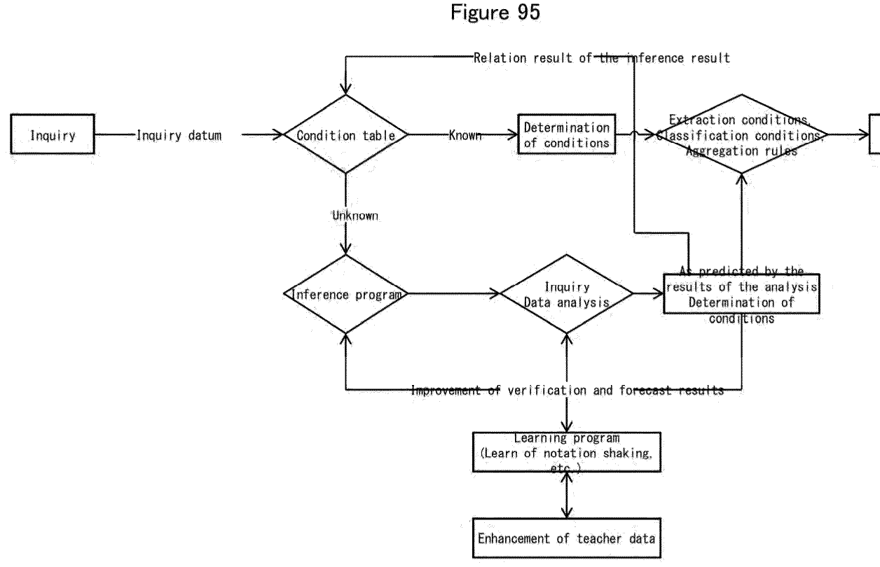

FIG. 95 is a figure first phase figure of AI training according to the fourth embodiment of the present disclosure.

It is a figure specifically how AI learned in the first phase of FIG. 92 is performed. Determine what trading data to create for the query data. When the query content is known (that is, when there is a matching query in the condition table), the condition is determined, the extraction condition is determined, and the condition is instructed to the information processing system to create a trading data. On the other hand, if it is unknown, the inference program runs, analyzes the inquiry data, and learns how to extract (or classify, aggregate, or process) trading data by referring to the teacher data. Examples of the teacher data include a table created by a lookup table method. The program will learn to make conditional decisions, and the term 2020 will measure the improvement in validation and forecast outcomes while learning associations such as creating a 2020 aggregated trading data by period.

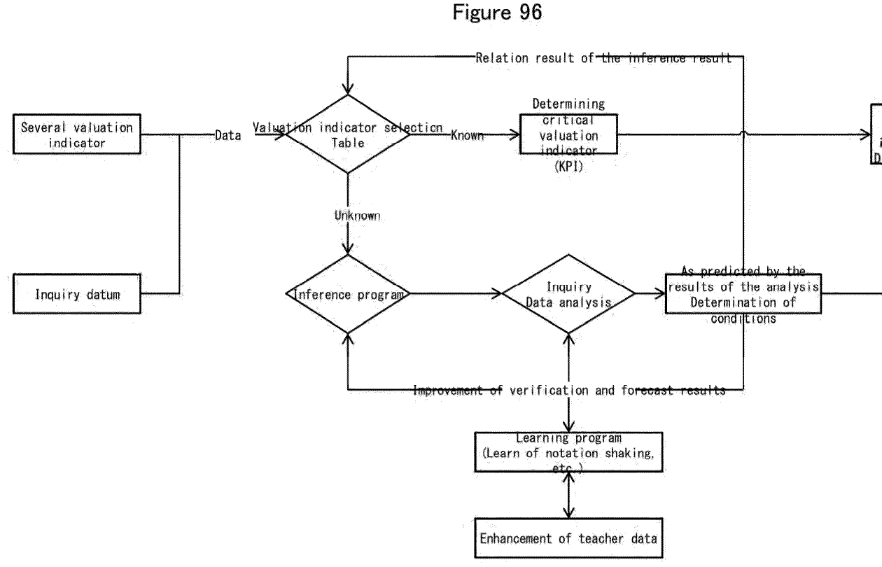

FIG. 96 is a detailed figure second phase figure of AI training according to the fourth embodiment. FIG. 96 is a figure that specifically indicates how AI training in the second phase of FIG. 92 proceeds. Query Determine which valuation indicators should be the critical valuation indicators for valuation indicators derived from data or trading data created in the first phase. If the query content is known (that is, if there is a matching query in valuation indicators selection table), the critical valuation indicators is determined and valuation indicators is instructed to the information processing system. valuation indicators is utilized in the following operation steps. On the other hand, if it is unknown, the inference program runs, analyzes the query data and the derived valuation indicators, and learns which valuation indicators is important and which valuation indicators should be important valuation indicators referring to the teacher data. Examples of the teacher data include a table created by a lookup table method. The key valuation indicators decisions are programmatically remembered, and the term trading profit and loss ratio measures the improvement in validation and forecasting while learning associations, such as creating a mean trading profit and loss ratio in trading profit and loss level trading data.

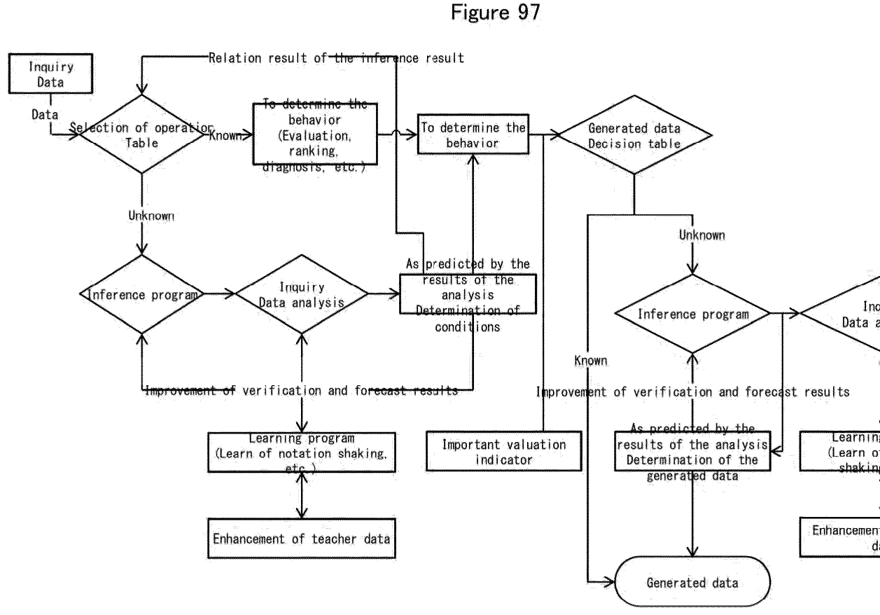

FIG. 97 is a detailed figure third phase figure of AI training according to the fourth embodiment. FIG. 97 is a figure that illustrates how AI training in the third phase of FIG. 92 will be performed. The query data determines which operation is to be performed in the operation determination table. If the inquiry content is known (that is, if there is a matching inquiry in the operation determination table), an operation is determined and the operation is instructed to the information processing system. On the other hand, if it is unknown, the inference programme runs, analyzes the inquiry data, and learns which action steps should be taken by referring to the teacher data. Examples of the teacher data include a table created by a lookup table method. Let programmatically learn how to decide what to do, and in terms of ranking and ranking, measure the improvement in validation and forecasts while learning associations such as creating a ranking data. In addition, once the operation is determined, in conjunction with the critical valuation indicators determined in the second step, it is determined in the determination table of the generation data what generation data is to be generated. For example, for the 2020 trading profit and loss ratio question, trading profit and loss ratio may be determined and sent as a generation data to the following steps. If it is known or unknown, a process similar to the determination of the operation is performed.

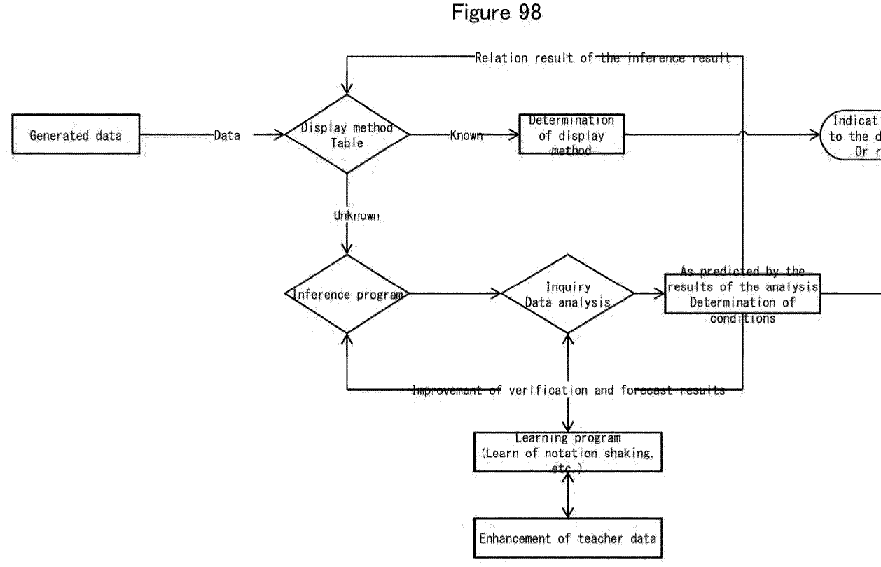

FIG. 98 is a detailed figure of AI training according to the fourth embodiment of the present disclosure, and is a fourth phase figure. FIG. 98 is a figure that illustrates how AI training in the fourth phase of FIG. 92 will be performed. Generation data generated in the third phase Determine which indication to select. If the content of the result-set is known (that is, if there is a generated data that matches in the display method table), the display method is determined and displayed. On the other hand, if it is unknown, the inference programme runs, analyzes the generation data, and learns which display method is optimal and which display method should be selected by referring to the teacher data. Examples of the teacher data include a table created by a lookup table method. The program is made to learn how to display the generated data, and to compare the key valuation indicators between Mr. A and the average value, we learn how to display the vertical bar chart, and measure the improvement in validation and forecasting.

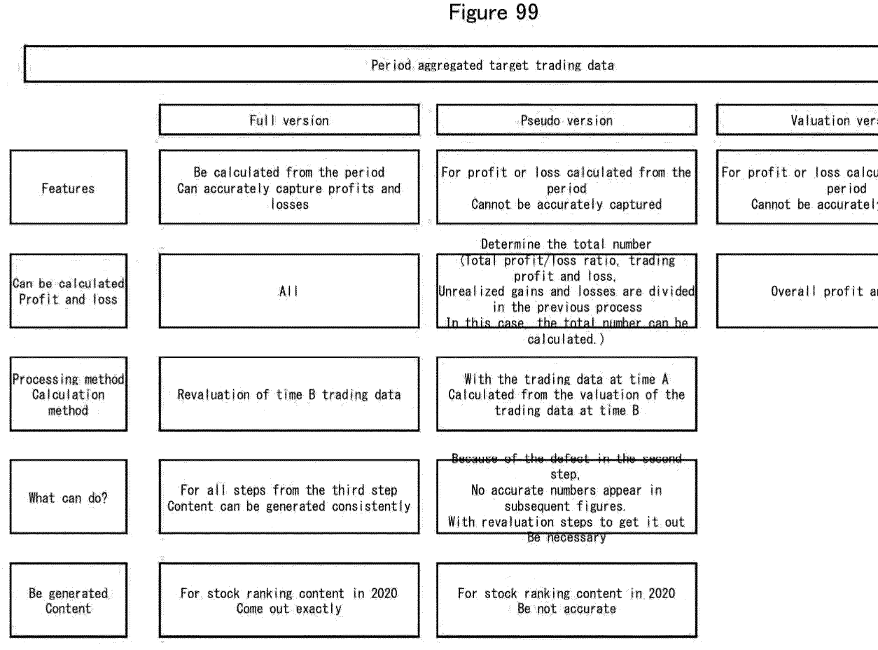

FIG. 99 is a table of data to be summarized by period according to the fourth embodiment. Three typical characteristics of aggregated trading data by period create are compared with profit and loss that can be calculated, the processing method, the calculation method, and what can be done. An appraised value version compares period such as an appraised value trend, which is common among brokerage firms, and the pseudo version is a one-step advancement technique. When the full version is compared with the pseudo version, the total number of profit and loss that can be calculated by the pseudo version can be determined by period. For example, if an appraised value at time A is 10 million yen and an appraised value at time B is 12 million yen, it can be seen that period profit and loss of AB period has increased by 2 million yen. However, if the breakdown is trading profit and loss or unrealized profit and loss, even the total number will differ. This is because AB period has a number of trading profit and loss and unrealized profit and loss swaps, from holding to sell, from purchasing to ownership. For example, in the case where A stocks were sold during AB period, if the purchase was 1000 yen prior to the A period, the stock price was 1200 yen at the A period, and the stock price was 1500 yen at the sale price, the Unrealized profit at the A period would be 200 yen (1200−1000) and the trading gains and losses would be 500 yen (1500−1000) at the B period. However, if the actual period profits and losses were not revalued to 300 yen (1500−1200) in terms of trading gains and losses, there would be no accurate period profits and losses. It is the full version that can do these entirely.

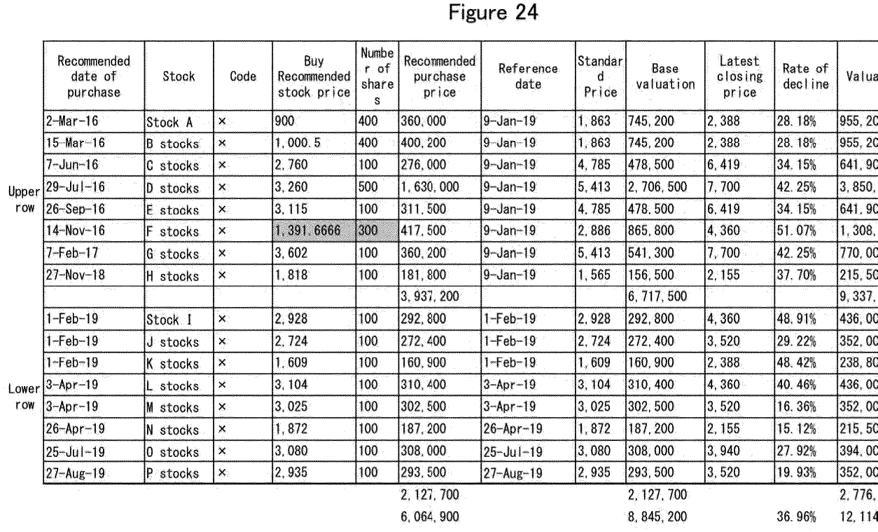

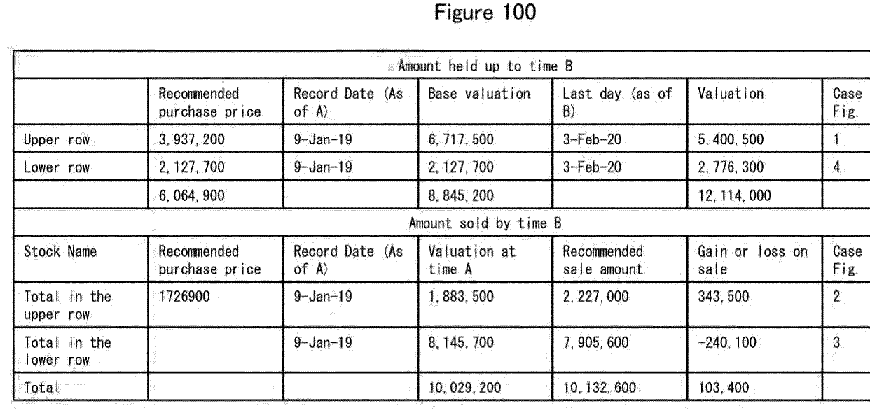

FIG. 100 is a summary figure of FIG. 24 to FIG. 26 according to the fourth embodiment. In the case where the point in time A is set as Jan. 9, 2019 and the point in time B is set as Feb. 3, 2020, the upper part of the case where the case held until the point in time B was purchased before the point in time A is changed in evaluation, and the case where the case after the point in time A is sold by the point in time B is sold, and the upper part of the case where the case was purchased before the point in time A is changed in evaluation to the point in time A, but the lower part is not necessary.

FIG. 101 is a figure of the first phase according to the fourth embodiment. In the phase of determining trading data set to be subjected to the first phase, conditions such as extraction conditions, classification conditions, and aggregation rules are determined from trading data, a aggregated target trading data is created, and a component trading data is created under various conditions based on the components of trading data, and a profit and loss level trading data is created according to the level at which the target profit and loss level is placed. This is a figure indicating that the target trading data set is created.

FIG. 102 is a figure for describing the second to fourth phases according to the fourth embodiment. In the second phase, based on the target trading data set created in the first phase, valuation indicators calculation, selection, and display steps are performed, and valuation indicators is used to display, evaluate, compare, rank, diagnose, and advise data, which are operation steps, are generated by the information processing system, and displayed to a user, an administrator, or the like in a series of figure. FIG. 101 and FIG. 102 are an overview of the system figure of the information processing system.

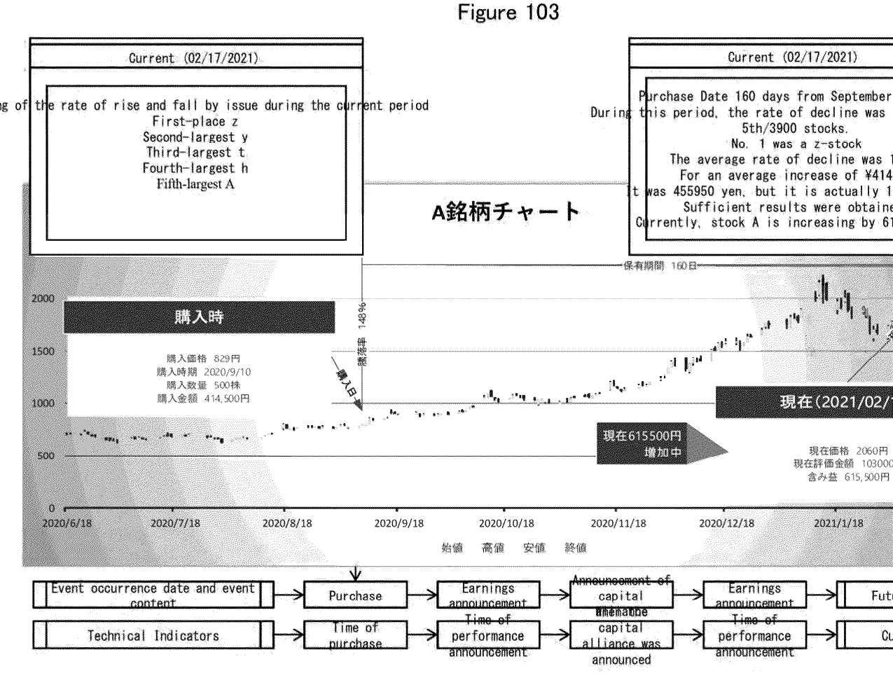

FIG. 103 is an issue selection validation chart figure according to the fourth embodiment. Issue selection validation chart figure, which is used to perform holding status evaluation from the actual date of purchase to the present. The trends of other issue in retention period can be seen at a glance, and it can be verified whether the purchasing of date of purchase was a correct answer among several choices. This is a chart that allows you to verify what happened when making better choices, what happened when averaging, etc., and to list the outcomes compared with other issue.

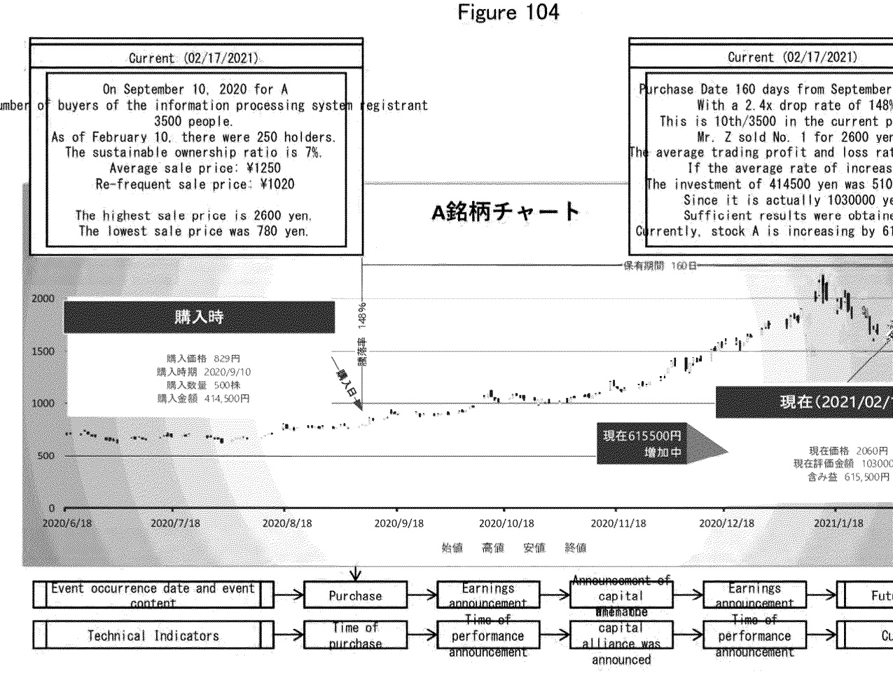

FIG. 104 is verification chart of stock purchase period according to the fourth embodiment. Figure is a validation chart of when issue was purchased. It is used to perform holding status evaluation from the actual date of purchase to the present. You can see at a glance the trends of other investor in retention period, and you will be forced to decide on whether to hold or sell date of purchase from your purchase. You can verify that you did it correctly and what investor did when you purchased the same issue on the same day. This is a chart that allows you to verify what happened when making better choices, what happened when averaging, etc., and to list the outcomes compared with other investor.

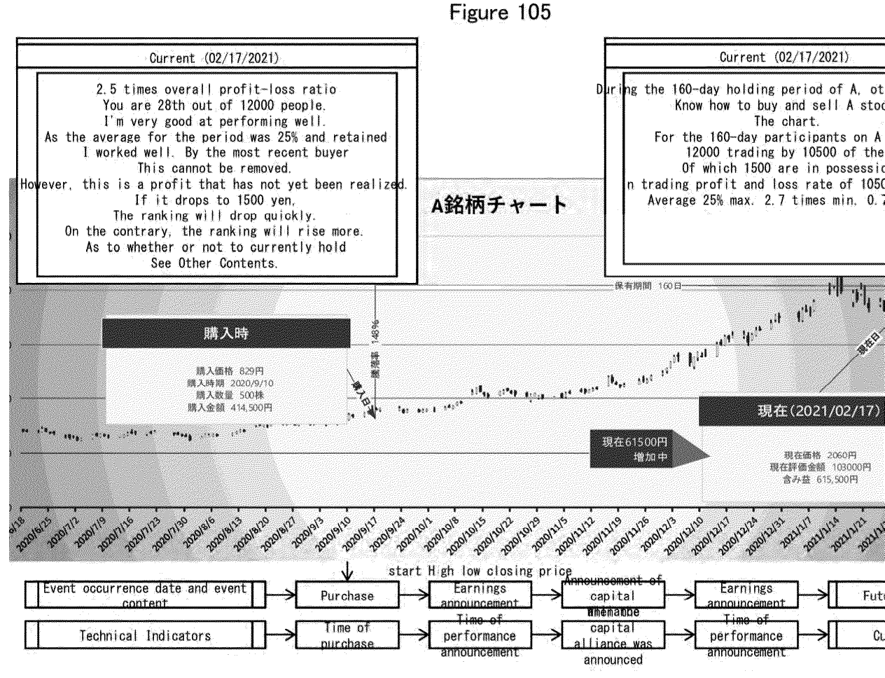

FIG. 105 is an issue investment trend chart of another investor in retention period according to the fourth embodiment. This is a chart showing the trend of retention period's other investor's issue investing in figure, and a chart showing the actual date of purchase to the present period of trading of issue. The trends of other investor in retention period can be seen at a glance, and it is possible to verify what actions investor purchased the same issue during period was doing. This is a chart that allows you to verify what happened when making better choices, what happened when averaging, etc., and to list the outcomes compared with other investor. FIG. 104 is a chart that checks the trends of investor who have purchased the same issue on the same date of purchase, but this chart is a chart that allows you to check how other investor have worked on the same issue during retention period.

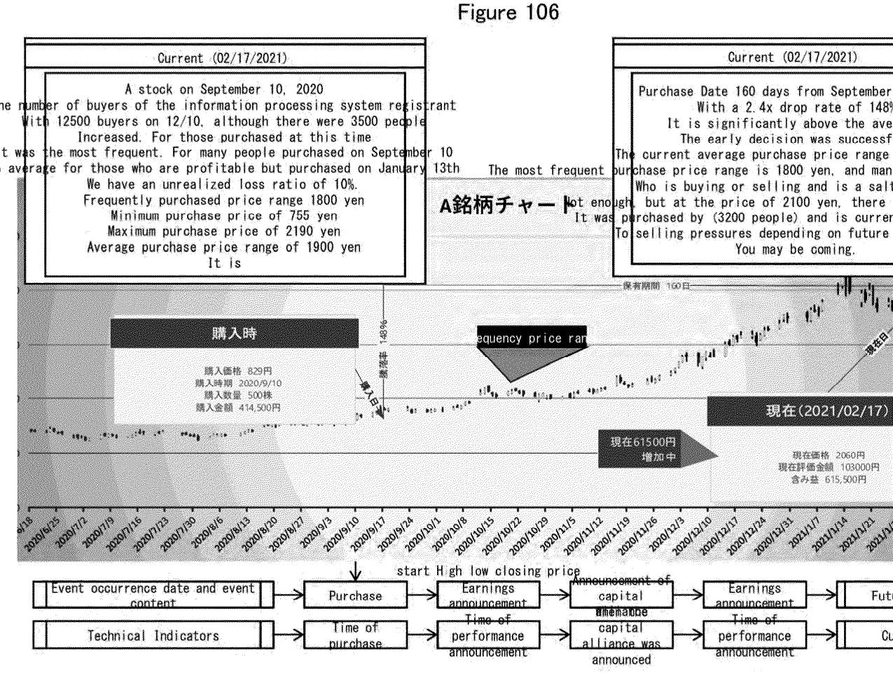

FIG. 106 is an issue investment trend chart of another investor in retention period according to the fourth embodiment. Similar to FIG. 105, the other retention period in investor show issue investing trend chart figure, and the actual date of purchase to the present period shows how issue has been investor. The trends of other investor in retention period can be seen at a glance, and it is possible to verify what actions investor purchased the same issue during period was doing. This is a chart that allows you to verify what happened when making better choices, what happened when averaging, etc., and to list the outcomes compared with other investor. FIG. 104 is a chart that checks the trends of investor who purchased the same issue on the same date of purchase, but this chart is a chart that allows you to check how other investor have worked on the same issue during retention period. FIG. 105 is communicated from a different viewpoint.

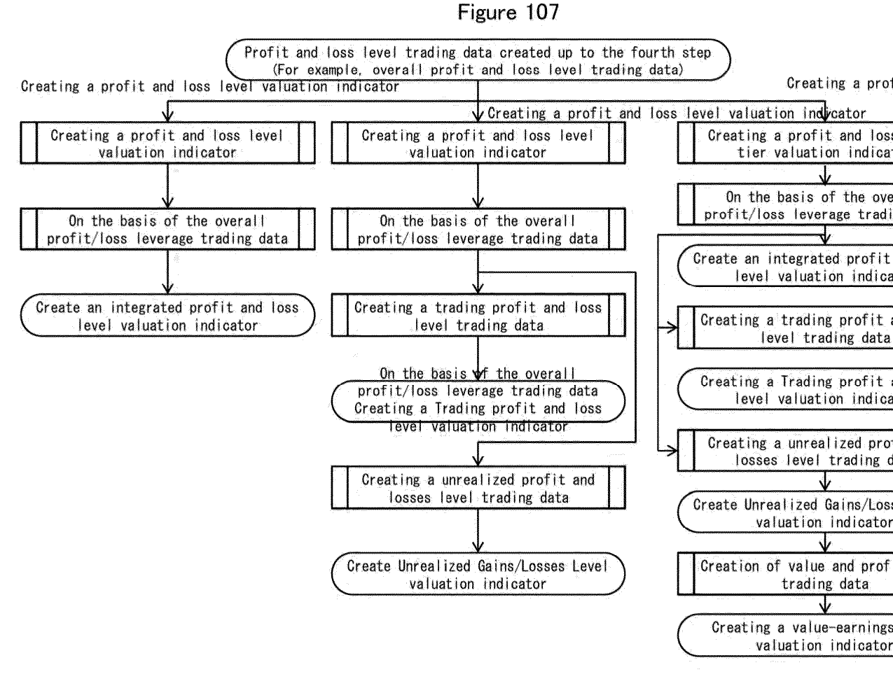

FIG. 107 is a figure describing three methods of valuation indicators calculation according to the fourth embodiment. In the step of calculating valuation indicators from profit and loss level trading data created in the fourth step, there are three schemes, and the three schemes are illustrated as figure. The more you go to the right, the more valuation indicators you get, and the more detailed valuation indicators you can calculate.

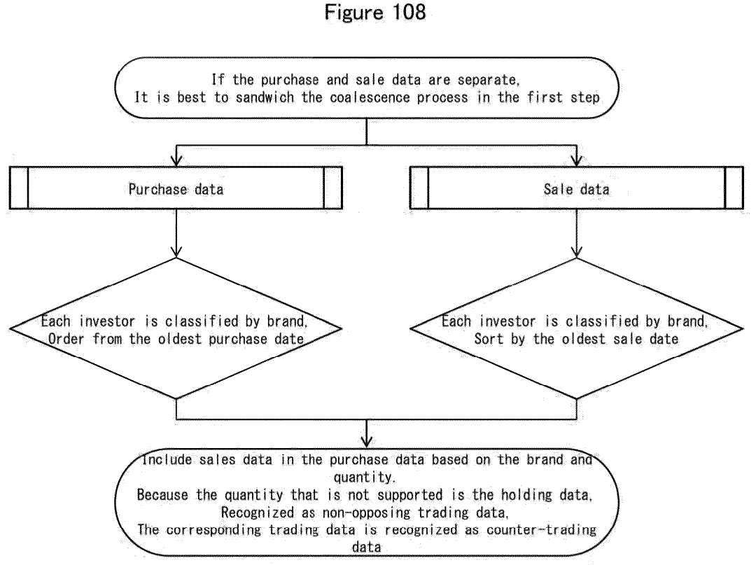

FIG. 108 is an explanatory figure of a combined table of purchase data and sell data according to the fourth embodiment. In the first step, if possible, trading data and other data obtained from the brokerage firm in the process they want to introduce are processed and shaped into a trading data that is easy to handle. This is a figure that shows a method of capturing sell data into purchase data by dividing it into purchase data and sell data once. There are many other ways to do this, but it is essential that trading be organized into a single line.

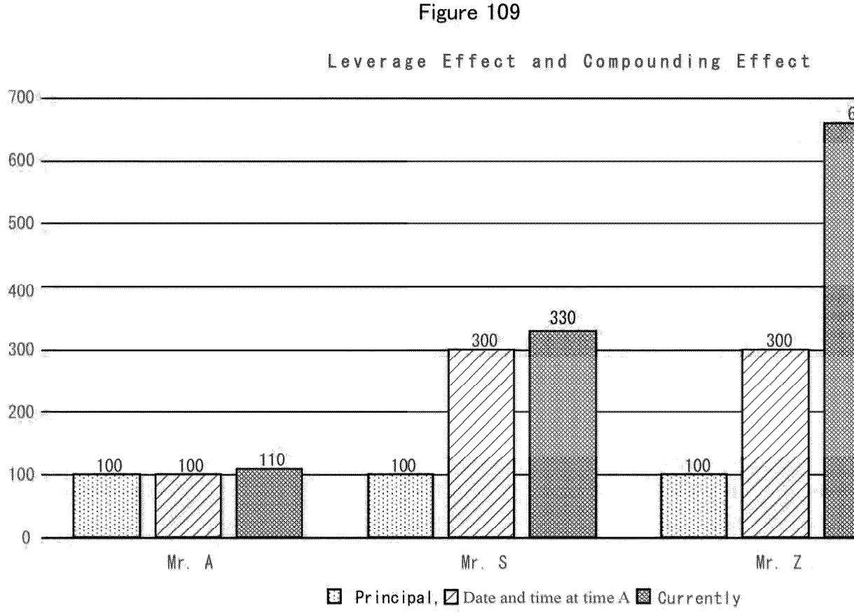

FIG. 109 is a leverage effect and a compound interest effect chart according to the fourth embodiment. This is an example of displaying a concrete example taken up by linked type holding status evaluation or the like.

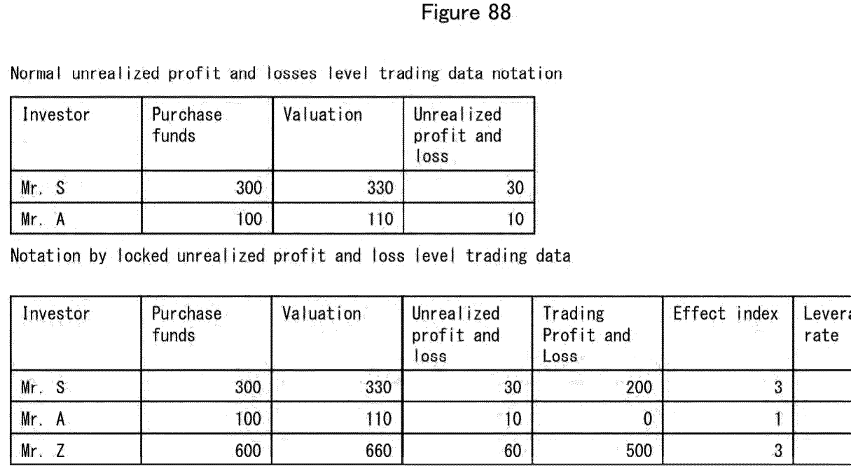

FIG. 88 is a linked type holding status evaluation notation figure according to the fourth embodiment. It is a table of embodiments described in Linked unrealized profit and loss level trading data.

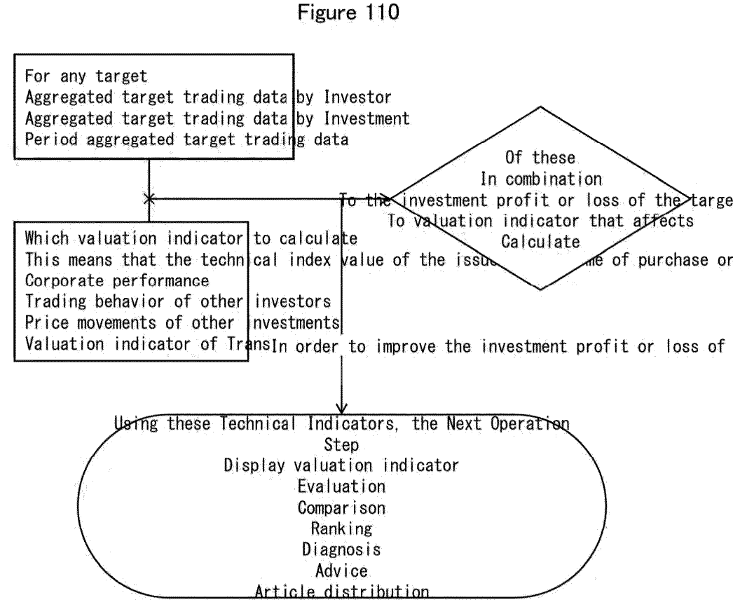

FIG. 110 is a figure of a plurality of methods for calculating valuation indicators according to the fourth embodiment. The calculation of valuation indicators has various methods of prohibition, and figure indicates that the investment target can be classified by period, investment target, or investor, or valuation indicators can be valuation indicators by trading data, or valuation indicators calculated from corporate performance or technical index value, or a combination of these methods can evaluate, compare, rank, diagnose, and advise various targets.

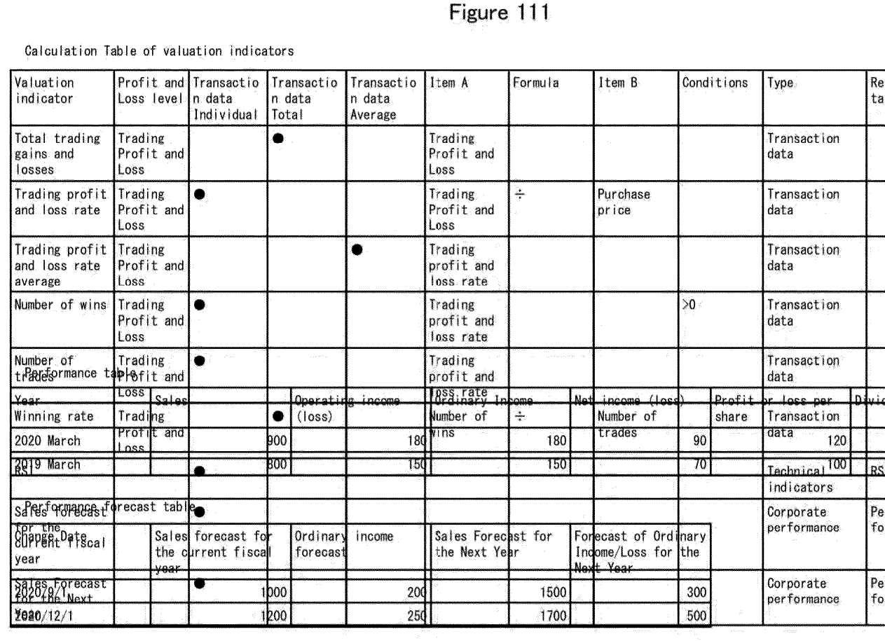

FIG. 111 is a calculation table figure of valuation indicators according to the fourth embodiment. This is figure of the table that manages the procedure for calculating valuation indicators and the procedure for calculating it, and the performance forecast table that manages it in a separate table.

### (First Step)

The first step is a step of acquiring a trading data or the like including a trading data from a brokerage firm, a user, an administrator, or the like. Usually, trading data gathered here is the next object to be processed. Of course, for securities of trading, such as brokers, there are fewer steps to obtain. Data associated with trading data includes technical indicators, tables such as stock price data, and issue data. A phase of processing into a fixed format may be included. A display phase may be included. AI (e.g., machine-learning or intelligence computation) phase may be included.

### (Defining Trading Data)

Trading data includes trading data in a narrow sense, trading data, and trading data in a broad sense, which are trading data and trading data associatable data and include data, processing data, rights data, and input data.

Trading data is an investment commodity that is determined in accordance with the sale and purchase, such as the type of data, investment commodity's date of purchase, investment commodity's purchase price, investment commodity's purchase quantity, investment commodity's date of sale, investment commodity's sale price, and investment commodity's sale quantity, and is a trading data in a narrow sense.

Opposite trading may be used to determine trading data and profit and loss for which gains or losses have been determined. Trading data whose profit and loss is not fixed is usually priced at market price or at some point in time to calculate unrealized profit or unrealized loss. trading data (trading data in a narrow sense) includes both, but in some cases, processing is required. When a certain format is used, such processing is performed. This processing may be performed at the time of creating an aggregated target trading data or the like, or may be performed at the time of obtaining a trading data.

Data (broad trading data) associated with trading data include marketplace data, processing data, rights data, entry data, and other table data.

The market data includes market prices of investment commodity, exchange rates, and the like, and the rights data includes rights data (dividends, stock splits, and the like) associated with the ownership of investment commodity. The processing data includes the purchase price of investment commodity (purchase unit price×purchase quantity), sale price, profit or loss on sale, the total value, average value, maximum value, minimum value, and the like, and refers to the ownership quantity×market price=market price of holding products, sale date of investment commodity-purchase date of investment commodity=retention period, and the like. The machining data refers to a data calculated by machining from aggregation target. The entry data is data entered by the user or administrator in the entry form. The input data includes, for example, an input data that allows a user to input a trading data in a field to be input, such as a reference medium or a reference technical index. The input data also includes an input data that allows the administrator to enter trading data associated with the input form (e.g., brokerage firm, advisory firm, course name, investor code, technical index value when the transaction is executed, etc.).

The other table data is used for data that is easier to manage when management is performed in a different table. Other table data include, for example, an investment target table, an investor table, a performance upward revision table, a technical index table, an investment type table, and the like. A separate table containing the same items as trading data items can be prepared and linked by the same items, and the data managed by the separate table can be included in aggregated target trading data items.

Then, it can be used as an extracting condition or a component (component trading data), and various applications can be expected. The relevant items in trading data are controlled, and trading data is wider, more manageable, and more obvious. In addition, all data required for management are trading data management items.

### (Define a Modified Trading Data Table Creation)

Data from brokerage firms is often purchase data and sell data, and is difficult to process afterward. The best way to create a modified trading data table is to include steps that can be handled in certain formats.

(Issues with Conventional Technology)

If each securities company imports it in a different format, it becomes extremely difficult to handle trading data. By formatting it into a fixed format, all trading data is consolidated into one format.

### (Action of Creating Modified Trading Data Table)

“There are many cases where purchase data and sale data of trading data are combined.” In this case, it is best to integrate the format by forming a table in which purchase and sale are integrated into one line through the composite table creation step of FIG. 108 (first step). Thus, the sales profit and loss can be calculated immediately. “The next step is the handling of purchase data where purchase data and sale data are not linked.” In the first step, a data has a purchase data that is not associated with the sale Unreversed trading data, which becomes Unreversed trading data and evaluates purchase data without the sale price. The correction trading data table is created by creating a table containing the purchase price and market-value, in which market-value assessment is captured (second step), reversed trading data and Unreversed trading data exist in one table, and the purchase price, the sale price, and market-value exist in reversed trading data.

### (Effect of Creation of Modified Trading Data Table)

“After going through this process, the information processing system can immediately calculate the overall profit and loss, and there is an effect that trading gains and losses or unrealized profit and losses can be easily derived for each purchase data.

### (Specific Example of the Creation of Modified Trading Data Table)

Although the format differs for each brokerage firm, the correction trading data table allows the modified market-value table to be formatted by making it a table that includes at least the issue code, date of purchase, quantity purchased, date of sale, market-value, ownership, and holding of another or purchase amount, sale amount, and trading data an appraised value processing data, as well as profit and loss (trading profit and loss for the opposite trading, which may include Unrealized profit and loss items).

### (Significance of Correction of Aggregation Target (Unreversed Trading Data))

Data taken in from the brokerage firm undergoes a process of creating a composite table of purchase data and sell data (FIG. 108)(first step), captures market-value evaluations (second step), reversed trading data and Unreversed trading data exist in one table, reversed trading data has a purchase price, sale price, and market-value, and Unreversed trading data has a table in which purchase price and market-value exist.

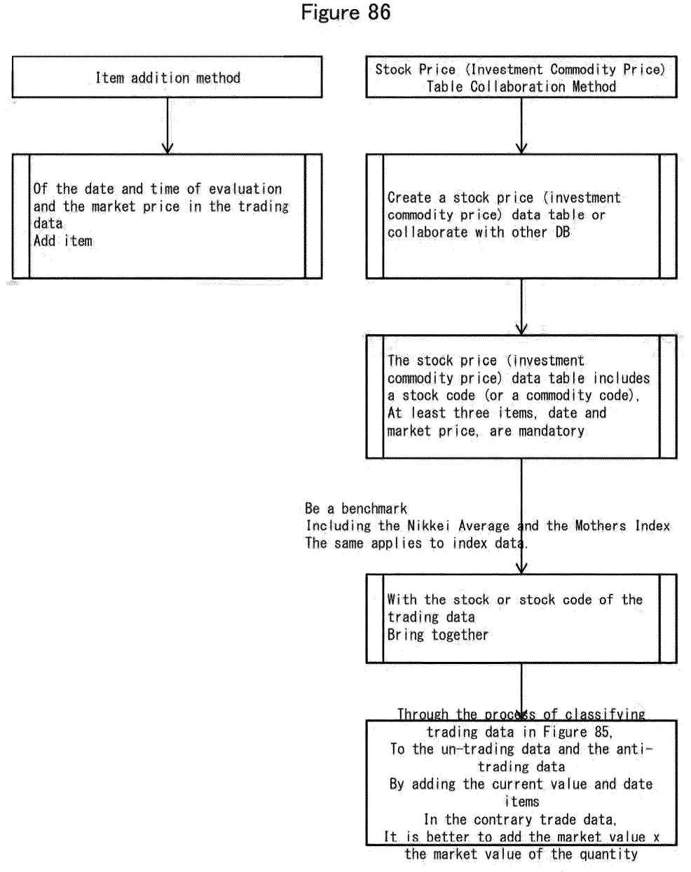

As shown in the identification of unreversed trading data and the mark-to-market valuation process (FIG. 85) and the method of capturing investment commodity prices (FIG. 86), the stock price table linkage method in FIG. 86 is the best, as shown in FIG. 85, when mark-to-market, date, and mark-to-market value are added to unreversed trading data and similar items are added to opposite trading data, they are utilized in later processes. “At this time, if the purchase data and the sale data are separated, it is best to include a step of combining the purchase data and the sale data with each other.

The Unopposed trading data (Unrealized profit and loss level trading data in a later step) refers to an investment commodity that is still in possession (or in a short position if coming from a sale). The unreversed trading data is trading data whose profit and loss have not yet been determined and is trading data whose evaluation value changes according to the trend of the market price daily, and requires processing different from that of the determined trading data. However, suppose this market price is also included in the traded data. In that case, it will be useful later (necessary in the fourth step of the profit and loss level trading data).

### (Problem of Correction of Aggregation Target (Unreversed Trading Data))

“The evaluation value of the unreversed trading data changes according to the owned quantity, but it is necessary to evaluate the unreversed trading data by the owned quantity×the market price of the investment commodity. “One of the correction steps of the aggregation target.” In addition, the trading data also includes changes in stock prices after the sale, and if they were not sold, it is possible to grasp what happened.

### (Action of Correction of Aggregation Target (Unreversed Trading Data))

Modifications can be made by creating a table that minimally includes the date and time of unreversed trading data as of A and the market price as of A or by including these two items in the trading data items. “It does not matter whether this step is performed in the acquisition step of the first step, in the creation step of the aggregated target trading data, or in the creation step of the profit and loss level trading data. The reversed trading data may also be associated with the stock price data table or included in an item of the trading data. “However, considering the future cooperation, it is better to cooperate in a separate table.

### (Effect of Correction of Aggregation Target (Unreversed Trading Data))

By adding the correction process, there is an effect that the holding status of the unreversed trading data can be known, and the holding status can be known in the process of creating the trading data. In this process, the trend after the counter-sale can also be captured so it is possible to grasp whether the sale was correct or not in detail at the fourth level of the Profit and loss level trading data.

### (Specific Example of Correction of Aggregation Target (Unreversed Trading Data))

### (Specific Example 2 Performed in Acquisition Step)

“The second step and the subsequent steps become easier to understand because they are performed with the original trading data before the creation of the aggregated target trading data.

### (Specific Example 2 Performed in Acquisition Step)

“When it is performed in the process of creating the aggregated target trading data, items of date and time (including date) and market price are added as additional items of the trading data. “Here, it may also be added to the traded data.” Linking with the stock price data table also makes it easy to link time series data and easily compare the market value after the sale with the stock price sold.

### (Specific Example of Correction of Aggregation Target (Unreversed Trading Data))

“It may be done in the step of creating profit and loss level trading data.” There is a fourth level in the creation of this profit and loss level trading data, and here, to use the market value after the sale, an item may be added to the trading data or fetched from a table.

“By making it possible to add various items such as addition of a medium, addition of a securities company, addition of a chart, addition of a technical index, and addition of a performance improvement correction to the trading data at the time of purchase or sale, there is an effect that it becomes possible to follow what kind of decision trade is successful. “It becomes one component of the component trading data, and extracting data for each medium even in the aggregated target trading data becomes possible. “It is beneficial in later steps.”

“The purpose of increasing the data associated with the trading data is to improve the user's advice on the investment method of the investment commodity, to hide hints that can solve various investment issues, and to contribute to providing useful information to the investor.

### (Significance of Adding Aggregation Target (Input Data))

“By adding input data to the trading data, the database is expanded. For example, suppose the brand purchased on February 2 is a purchase based on a quarterly report. In that case, the reference medium may be set to the quarterly report, and if the adviser is company A, the adviser item may be set to company A.

“A case in which an administrator inputs may be included. For example, market data such as a technical index RSI of 20% at the time of brand purchase may be input. “It may be automatically entered in market data.” Related data involved in these transactions take the data base by being incorporated, various effects are produced. In the first place, the data of Aggregated Target Trading Data by Investment Target is included for this purpose, and it is understood that the multilayered ranking, the component comparison process, and the like are not known only from the trading data because of this linkage. “The addition of input data results in a more robust form.”

### (Additional Problem of Aggregation Target (Input Data))

“The original data of securities companies are difficult to understand and use, which is a flaw. By increasing the number of additional items or processing the additional items, the added value of the data is further increased, and there is an effect that the amount of information that the user can recognize is increased.

### (Additional Action of Aggregation Target (Input Data))

The trading data with unrealized profit and loss and the trading profit and loss trading data may be displayed, and items may be added to the trading data. “When the trading data is inputted, additional items may be displayed and inputted. “The administrator may make the input at a later time.” For example, the technical index of the corresponding brand's date of purchase can be easily verified later and input or uploaded as additional information.

Adding items such as the brokerage firm that conducted the purchase and sale, the advisory firm used to conduct the purchase and sale, and the medium used to conduct the purchase and sale increases the added value of the data, and the effect of more information increases.

### (Effect of Adding Aggregation Target (Input Data))

“The additional data at the time of purchase or sale becomes a component of the component trading data and can be used as a reference of the aggregated target trading data. This is because data can be extracted and tabulated for each tabulation target and component.

### (Additional Specific Example of Aggregation Target (Input Data))

For example, if a reference medium is added, it can be expected that it will be possible to examine which medium has been used later for successful trading, etc. “

“Usually, the data at the time of trade include at least the date of execution, the price of execution, and the quantity of execution.” In order to find out the cause of the event, it is expected that the technical index value, the reference medium, the corporate event, and the like at that time are stored in a database, and a large effect can be expected.

### Example 1

This means that the technical index value of the issue at the time of purchase or sale is included in the data item. However, it includes a case where the user inputs the technical index value in the form, a case where the administrator inputs the technical index value in the form, and a case where the technical index value is automatically captured or automatically calculated.

In this case, for example, it is possible to compare the trading profit and loss ratio between the trading data purchased at a technical index value of RSI of 20% or less and sold at a technical index value of 80% or more and the entire trading data.

“By making it possible to add various items such as addition of a medium, addition of a securities company, addition of a chart, addition of a technical index, and addition of a performance improvement correction to the trading data at the time of purchase or sale, there is an effect that it becomes possible to follow what kind of decision trade is successful. “It becomes one component of the component trading data, and extracting data for each medium even in the aggregated target trading data becomes possible. “It is beneficial in later steps.”

### (Method for Improving the Frequency of Acquisition of Trading Data)

### (Challenges of Frequency of Acquisition of Trading Data)

“Unlike the market data and the right data, the trading data (trading data in a narrow sense) of the investment commodity is updated at different frequencies depending on the user. Scalping, day traders, and the like, which conduct transactions daily, conduct transactions frequently, and thus the frequency is high, and it is not uncommon for buy and hold investors to conduct transactions rarely and once a year. “Trading frequency varies from person to person, and everyone does not necessarily require real-time nature. On the other hand, market data needs to be real-time, such as the prices and exchange rates of investment commodities held, and the frequency needs are high and wide, such as real-time, 30-minute delay, or once-a-day or once a week. “Such market data are relatively accessible.” On the other hand, trading data requires the person who transacted the transaction to have some means of updating it.

### (Effect of Frequency of Acquisition of Trading Data)

For example, the trading data of a person who transacts in a securities company changes in real time. “As described above, there are several methods as to how and how the trading data is taken in, each of which has advantages and disadvantages. “The frequency and method may be selected according to the transaction frequency.”

For example, in the case of frequent day trading, it is suitable to capture data through API cooperation or capture by the scraping method if possible. “In the case of a user who has a low frequency and conducts transactions on an average of about once a month, the frequency of capturing market data such as stock prices is increased, and it is sufficient to capture trading data about once a month. “In this case, it can be said that the download upload method of CSV or the input form is suitable.”

“In this way, it is useful and realistic to change the method and frequency of importing buying and buying data (trading data: in the narrow sense=trading data) according to the trading frequency.”

### (Effect of Frequency of Acquiring Trading Data)

“By changing the acquisition method and frequency according to the frequency of trading while weighing the balance between security and convenience, we can achieve the effect of fulfilling both customer convenience and security risks associated with increasing frequency.

### (Specific Examples of Frequency of Acquisition of Trading Data)

For a user with a transaction frequency of several times a day or more, an API or a scrapping method update procedure may be performed. For a user who has a transaction frequency of less than once a month, an input in an input form may be promoted.

The following methods can be considered as the input form method.

### (Significance of Form Input Method (Trading Data Version))

“As mentioned earlier, updating trading data depends on the degree of security and transaction frequency.” “This form input method (trading data version) is recommended for users with low transaction frequency.”

(Issues with Conventional Methods)

“Downloading and uploading CSV poses a considerable hurdle for elderly people and people unfamiliar with PC operation.”

### (Action of Form Input Method (Trading Data Version))

As shown in FIG. 94, there is a buy button, and a sell button, a purchase form appears when the buy button is pressed, and a holding stock list appears when the sell button is pressed. “Since it is linked with the trading data, the owned brand list can be pulled from the Unrealized profit and loss level trading data. “A quantity, a stock code, and the like have already been input, and the user may record a transaction in which the F company sold for 20,000 yen per 1 later. “The user only records the price, date, and check, and the trading data can be entered. Further, this data is transmitted to the storage unit 33, is removed from the Unrealized profit and loss level trading data, is updated to the trading profit/loss revalue trading data, and the record can be confirmed later.

### (Effect of Form Input Method (Trading Data Version))

“In the case of a data radar which performs transactions many times a day, this method is difficult, but in the case of transactions at a normal level, it is possible to expect a special effect that the data can be input at a sufficient time, and when the data is input, the data of the user is immediately updated, whereby the user can feel that the ranking changes.

“After these trading data are acquired, a process of creating aggregated target trading data is performed.

“The first step is a step of creating trading data.” “The second step is a step (current step) of creating the Aggregated target trading data.” The third step is a step for creating component-specific trading data (also possible after the fourth step). The fourth step is the creation step of profit and loss level trading data (also possible after the second step). The fifth step is the calculation step of valuation indicators.

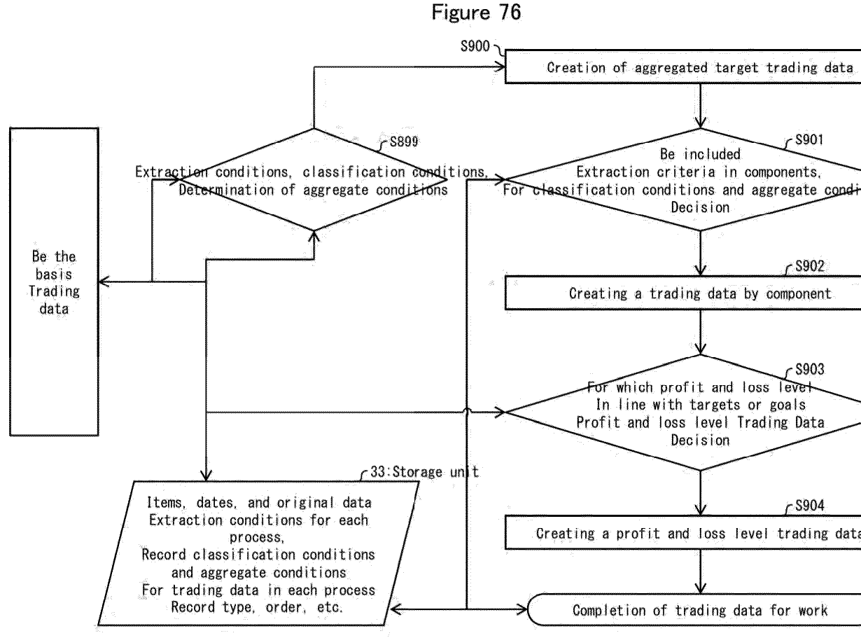

From the second step to the fourth step, the original trading data is narrowed down by creating the Aggregated target trading data, the component trading data, and the profit and loss level trading data, and the trading data to be targeted is determined in the calculation step of the valuation indicators. A schematic is shown in FIG. 101. FIG. 76 describes this process. At the beginning, the S899 step determines or indicates whether and how the information processing system in question will extract, classify, or aggregate the trading data. For example, suppose the condition is “extraction condition: investment target=stock”. In that case, the information processing system extracts only the trading data of the stock (Aggregated Target Trading Data by Investment Target).

If the condition is “extraction condition: stock code=6701”, the information processing system extracts only the trading data with the stock code 6701. “If the condition is” “extraction condition: investor=A””, the information processing system extracts only the trading data (aggregated trading data by investor) of Person A. “Extraction condition: (unreversed trading data at the time of Jan. 1, 2020 (purchase in possession (or sale in case of entry from sell)) Data), and one or both of a date of purchase and a date of sale is from Jan. 1 to Dec. 31, 2020)”, the information processing system extracts trading data in 2020 (aggregated trading data by period).

In the case of aggregated trading data by period, it is necessary to include trading data held without buying or selling in 2020, and for the amount held continuously, it is necessary to calculate only the increase or decrease in 2020. Under the above conditions, such trading data would also be included, and profit or loss would be adjusted, resulting in more precise trading data by period. “In the creation of the aggregated target trading data, there are the determination of an extraction condition, determination of a classification condition, determination of a totalization rule, and the like.

In the determination of the classification condition, if the classification aggregation condition is “investment target product=classification aggregation criterion”, if the investment target product includes, for example, a stock, a virtual currency, and an FX, a plurality of pieces of Aggregated target trading data for each Aggregated Target Trading Data by Investment Target for each of the categories are created.

From this, it is also possible to make the extraction condition “the investment object is stock”. When the classification and aggregation criterion is set to “investor type=classification and aggregation criterion”, there can be a plurality of trading data aggregated for each of the day trading types, swing trade types, and the like included in the investor type. When the classification criterion is “investor type=classification criterion”, a plurality of pieces of Aggregated target trading data for each investment type are created similarly, but the trading data is not aggregated, and only the trading table is classified.

After the creation of this aggregated trading data, the conditions for extraction, classification, and aggregation of the component trading data are determined, and the component trading data are created.

(Steps of S901 and S902) An extraction condition, a classification condition, and a totalization condition are determined based on a component included in Aggregated target trading data (generally, a management item on a database (naturally including a case of being associated with another table)).

For example, when the business type of the brand that is one of the constituent elements of the Aggregated Target Trading Data by Investment Target that collects only the trading data of the stock (extraction condition: investment object=stock) is set as the classification aggregation standard (classification aggregation standard of the constituent elements=industry type of the brand), the trading data is classified for each industry type of the brand based on the Aggregated target trading data of the stock. The aggregated constituent trading data is created.

“Data such as the sum of the purchase price and the sum of the sale price of a stock whose industry is electric is aggregated.

For example, when the Aggregated target trading data is created as “extraction condition: investment type=day trading type” and “extraction condition of component: brand type=speculative stock”, only the trading data traded in the speculative stock among the trading performed by the person of the day trading type is extracted.

In addition to the classification and aggregation criterion, the component trading data also includes a simple classification criterion that does not perform aggregation, which is similar to the Aggregated target trading data.

“When this constituent trading data is created, the next step is the creation step of the profit and loss level trading data.

“The next step is to determine the target profit and loss.” The ultimate purpose of trading is to improve profitability. There are several levels of profit and loss, such as overall profit and loss, trade profit and loss, unrealized profit and loss, winning profit, and losing loss, and this is a step for determining which profit and loss is targeted for improvement.

If Speculative issue is trading data of the previous tray type, trading profit and loss should be chosen as the target profit and loss, and Aggregated trading data by investor should have a better overall profit and loss to determine the overall power or the nature of trading data created so far.

The target profit or loss is a trading profit or loss. In that case, the trading profit and loss level trading data is created from the Aggregated target trading data or the component trading data created so far (even if the trading profit and loss level trading data is available in the previous process). In this process, the created trading data is (extraction condition: investment type=day trading type) and (component extraction condition: issue type=speculative stock) trading profit and loss level trading data=only the trading profit and loss data in which the speculative stock has been bought and sold by investors of the day trading type and the profit and loss has been determined.

“This becomes the trading data: for the underlying work in the next steps.” In all of these processes, various extraction conditions, classification conditions, classification aggregation conditions, created trading data, management items, constituent elements, final trading data, and the like are stored in the storage unit 33.

### (Step of Creating Aggregated Target Trading Data)

“In creating the Aggregated target trading data, there are cases in which the data is created manually and cases in which the data is automated.

### (Creation of Aggregated Target Trading Data)

At the time of creating the Aggregated target trading data, the information generation unit 3021 creates the aggregated trading data by period, the Aggregated trading data by investor, the Aggregated Target Trading Data by Investment Target, or the Aggregated trading data by profit and loss, or the like, Aggregated trading data by profit and loss is evaluated and the like. Then, the information generating unit 3021 may create, for example, aggregated target trading data of Person A in 2019, aggregated target trading data of Person A's brand B, and the like by combining and editing the aggregated target trading data. “Then, the information generation unit 3021 can also collectively create a plurality of scattered pieces of Aggregated target trading data. For example, the aggregated target trading data of Person A in securities company A, the aggregated target trading data of Person B in securities company B, and the aggregated target trading data of Mr. C in securities company C may be collected together to create aggregated target trading data, which may be classified based on a criterion such as a period to create new aggregated target trading data. “For example, new aggregated target trading data: can be created by combining the aggregated target trading data: of Person A's securities company A, securities company B, and securities company C into one.

“In this case, the data of investors and securities companies are also incorporated into the database items to be useful for later classification. For example, in the former case described above, various processing can be easily performed by adding data of investor A and securities company A to the Aggregated target trading data of Person A at securities company A. “The input data may be prepared from the beginning, may be added later, or may be input by a user or an administrator. “The input data may be created at the first step or may be added at the second step, the third step, or the fourth step.

“If trading data that has not been counter-traded is included, processing may be included to input the current value and the current value of the investment target at the time of evaluation. “Further, processing such as calculating a total value or calculating an average value may be included. From the third step forward, processing that is easy to handle may be included.

### (Step of Creating Aggregated Target Trading Data)

### (Significance of Creation of Aggregated Target Trading Data)

The aggregated trading data (For example, aggregated trading data called aa1) of Person A's securities company is incorporated into the database in the trading data acquisition step. The aggregated trading data (For example, aggregated trading data called aa1) of Person A's securities company is incorporated into the database in the trading data acquisition step. By continuing this process, the aggregated target trading data: (for example, the aggregated target trading data: called A1) serving as a base is created. By classifying or extracting, and tabulating the aggregated target trading data: (for example, Aggregated target trading data by period: called A1-K) based on the criteria (period, investor, investment target, etc.), the Aggregated trading data by period: (for example) can be generated.

It is possible to use the trading profit and loss level trading data, the overall profit and loss level trading data, or the Unrealized profit and loss level trading data (it is also possible to deal with a case where the trading data is already traded and the trading data of the unopposed trade are mixed or separated). In addition, input data, correct data, processed data, separate table data, and the like other than the trading data obtained from the securities company may or may not be included. “This is the same for the first and third steps and subsequent steps.”

“The aggregated trading data may or may not be extracted under a certain condition, and may or may not be aggregated.” “It may or may not be classified.” Aggregation (including calculation of a total or average value, determination of a maximum value, and the like) may be performed or not. Based on this aggregated trading data, you go through the second and subsequent steps.

### (Problem of Creation of Aggregated Target Trading Data)

The trading data plays an important role in the “what” of how to classify, evaluate, rank, compare, diagnose, and advise. By following this step of creating aggregated trading data, the target of work (the first stage of processing, extraction, and classification) is determined and various types of trading data can be handled.

### (Operation of Creating Aggregated Target Trading Data)

“How you decide what to target depends on what you want to do.” For example, if you want to create a ranking of investors overall gains and losses for 2020, you can create aggregated trading data for 2020 with aggregated trading data by period. By creating the overall profit and loss level trading data for each component and for each investor (which may be provided in the previous step), trading data can be used as the basis for ranking creation. This is possible because trading data is created for each investor that calculates the total profit/loss for 2020. If what you want to do is decided, the aggregated target trading data is decided, so the administrator may decide what you want to do, or the user may decide. In both cases, what is desired to be done may be determined by selecting a questionnaire, a list, or the like, or an answer may be automatically obtained, or a determination may be made each time.

If we wanted to create a ranking of investors overall gains and losses for 2020 as described above, this step would be to create Aggregated trading data by period for 2020. “The creation of aggregated trading data by period will be described later.

### (Effect of Creation of Aggregated Target Trading Data)

Ranking, comparison, and the like are facilitated by creating component-specific trading data for each investor, for each investment target, for each period, and the like through the creation process of not only the Aggregated target trading data of Person A in the securities company A but also the Aggregated target trading data including Person A, Person B, and Mr. C, thereby enabling a wide range of evaluation, ranking, comparison, diagnosis, advice, and the like.

### (Specific Example of Creation of Aggregated Target Trading Data)

### Example 1

If investor 2020 overall profit and loss ratio ranking is to be issued, the information processing system will compile investor total 2020 Aggregated trading data by period, create investor component trading data, aggregate each investor component trading data, create an overall profit and loss trading data, and calculate overall profit and loss ratio for each investor for each investor's 2020 investor for each overall profit and loss ratio. By ranking the overall profit and loss ratio of each investor using the overall profit and loss ratio as an axis, the overall profit and loss ratio ranking of the investor in the year 2020 can be created.

The display step is to show investors anonymously and create a table with the ranking in the first column, the name of the investor (anonymous) in the second column and the overall profit and loss ratio in the third column.

### Specific Example 2

When comparing each indicator between the average value of Investor A and the average value of the entire investor, the information processing system compiles the aggregated trading data of Investor A, creates component trading data of Investor A and the entire investor, creates trading data below the overall profit and loss level, and calculates the valuation indicator that constitutes the overall profit and loss, thereby calculating the valuation indicator that is the valuation indicator of Investor A and the average value of the entire investor. The basic data will now be taken, and the valuation indicators of Person A and the average value of the whole valuation indicators are shown by the radar chart so that the average values of the investor A and the investor can be compared at a glance. “This can also be used to provide diagnosis and advice.”

### Example 3

In order to clarify the degree of contribution of a brand to a selling and buying benefit, the information processing system creates totalization target selling and buying data of the entire investor, creates component selling and buying data for each brand, creates a benefit composition ratio item for each brand, creates selling and buying benefit data, and calculates an average trading profit margin, a selling and buying benefit amount, and a total selling and buying benefit amount as valuation indicators for each brand. Now, the basic data will be aligned. “By setting the total trading profit amount to 100% of the pie chart and displaying the trading profit amount for each brand as a percentage, it is possible to clarify the brand's contribution to the trading profit.

As in the above specific example, first, what is desired to be done is determined, which aggregated target trading data: is to be used for that purpose is determined, and if the further division is necessary, component-specific trading data is created from the aggregated target trading data: and the information processing system creates profit and loss level trading data according to the target profit and loss (or average trading profit and loss ratio (average of ROI))(may be provided in the previous step). It is to be noted that the order of creating the component specific trading data and the profit and loss level trading data may be changed.

### (Aggregated Target Trading Data by Investment Target)

It includes stocks such as Company S shares, stocks such as investment trusts, ETF bull funds, etc., stocks such as FX yen dollars, etc., virtual currency stocks, etc. Also, stocks may be grouped and aggregation targets may be divided into Speculative issue groups, blue-chip stock groups, high dividend stock groups, etc., and index investment trust groups, robot fund groups, etc., may also be aggregated targets. Further, a product, a product group, or the like may also be used as an aggregation target. “For example, the information generation unit 3021 calculates various valuation indicators by dividing the trading data for each aggregation target of the virtual currency, FX, and the stock. The Aggregated target trading data of the stock, the Aggregated target trading data of the virtual currency, and the Aggregated target trading data of the FX may be grouped and re-classified. “The purpose of compiling Aggregated Target Trading Data by Investment Target is to convey it to a wide range of investors. This is because all trading of speculative stock groups has not been successful, and it is intended to change the investment behavior of investors, such as buying and selling blue-chip stock groups. It can be said that information generated from various news events, providing various insights, and Aggregated Target Trading Data by Investment Target is information that triggers a significant change in the investment behavior of investors.

### (Investment Type-Based Aggregated Target Trading Data)

“Investment type includes investment types as defined by the type diagnosis, such as day trading type, swing trade type, short-term trading type, medium- to long-term holding type, and buy and hold investor type. “The information processing system divides the trading data for each investment type, totalizes each of the trading data, and calculates valuation indicators for various calculation targets. The information processing system can also collect the aggregated target trading data of the day trading type, the aggregated target trading data of the swing trade type, and the aggregated target trading data of the scalping type into the aggregated target trading data of the short-term trade type, and re-classify the aggregated target trading data.

As with the Aggregated Target Trading Data by Investment Target, this is another content that should be communicated to investors as a whole. “Although the information processing system generates various kinds of information, it is the information that is meaningful only after it is transmitted to a wide range of people. “It can be said that a lot of people are interested in topics such as, what kind of action did the people who day-trades take and how are they now?” A variety of impacts arise from the media's handling of this information.

### (Regarding Adviser-Based Aggregated Target Trading Data)

In trading data where the information processing system is judged based on Mr. A's investment advice, the information processing system divides trading data for each adviser (adviser provider), regardless of whether it is a person, a corporation, or an organization, such as trading data, which is judged based on the investment advice of Mr. A's investment advice, and totals them to calculate various aggregation target metrics. Aggregated target trading data of Mr. A's advice, Aggregated target trading data of Mr. B's advice, and Aggregated target trading data of Mr. A's investment advisory firm can be grouped together, that is, trading data made by the advice can be grouped together and reclassified.

### (Securities Company-Specific Aggregated Target Trading Data)

An information processing system divides trading data for each securities company executing a trade, such as trading data executing a trade in an A securities company and trading data executing a trade in a B securities company, totalizes them respectively, and calculates valuation indicators of various aggregation target. It is also possible to collectively classify the Aggregated target trading data of the A securities company, the Aggregated target trading data of the B securities company and the Aggregated target trading data of the C securities company.

### (Medium Aggregated Target Trading Data)

“The information processing system aggregates trading data for each medium by a medium to be referred to” The information processing system divides trading data by reference medium by which trading has been executed, such as trading data by which trading has been executed by referring to Twitter(registered trademark), trading data by which trading has been executed by referring to the quarterly report, trading data by referring to the business performance, trading data by referring to the chart, trading data by referring to the automatic trading tool A, etc., and aggregates each of them to calculate the valuation indicators of various aggregation target.

It is also possible to reclassify the aggregated target trading data obtained by referring to Facebook, the aggregated target trading data obtained by referring to Twitter, and the aggregated target trading data obtained by referring to Blog as a whole. As described in the description of the totalized Aggregated Target Trading Data by Investment Target, this aggregated trading data is created in order to inform many investors of what investment behavior the investor takes and what situation the investor is in. “It is also possible to create an article such as what was the result of the investment behavior with reference to Twitter.”

### (Aggregated Trading Data by Investor)

For example, if the aggregation target is investors, the information generation section 3021 aggregates trading data by investor type, such as individual investor group, institutional investor group, individual investor A, institutional investor B, investor type group focusing on short-term trading, and investors in medium- to long-term holding investor type group. “Furthermore, the valuation indicators of the trading data can be classified into various investors by calculation by the information processing system. For example, by creating a group of investors with the top 10 overall profit and loss ratios, a group of investors with the top 10 winning percentage, a group of investors with the top 10 unrealized profit and loss ratios, etc., it becomes possible to tie data to other investors when they trade because of how this group of investors would act. “It is also possible to reclassify the aggregated target trading data of Person A, the aggregated target trading data of Person B, and the aggregated target trading data of Mr. C in a lump. “The aggregated trading data by investors can also generate many articles that may be of interest to many people.” For example, titles such as the short-term selling-focused investor type group versus the medium- to long-term holding investor type group, which won in 2020, make for compelling stories. “This is one of the significance of creating the Aggregated trading data by investor.”

### (Aggregated Trading Data by Period)

“For example, if the aggregation target is a period, it is divided into annual trading data for the past 1 year, monthly trading data for 1 month, weekly trading data for 1 week, daily trading data for 1 day, 2019 trading data, and so on. “It is also possible to re-classify the aggregated target trading data of 2019, the aggregated target trading data of 2020, and the aggregated target trading data of 2021 collectively.

“This is expected to make generating articles easier, broader, and more comprehensible by creating aggregated trading data by period. “Without period management in a database, such data is difficult to guide.” This is because even if unrealized profit and losses are known now, even if they are compared with those of a year ago, people are buying and selling during that period and it becomes difficult to understand.

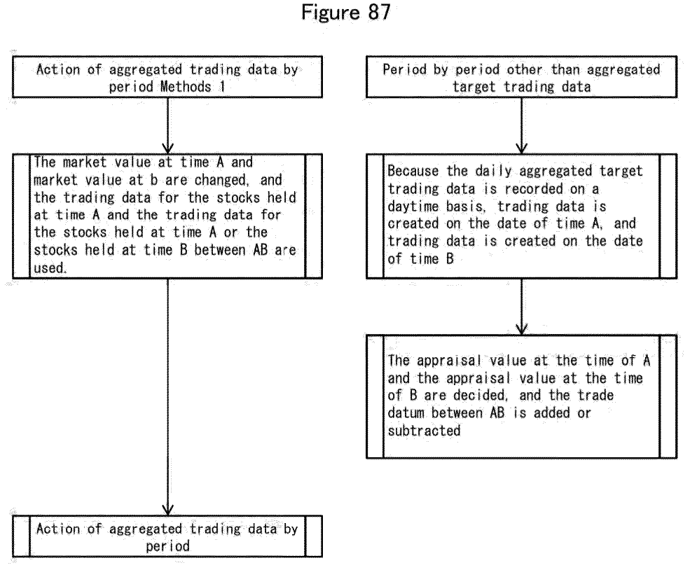

“Although there is often a time period comparison of portfolios, there are most cases where they simply compare the transition of valuation. If it is at the overall profit and loss level (that is, the appraised value level) of the subsequent process, this may be the case, but if it is after the profit and loss level, it is very important to create aggregated trading data by period. The same holds true even if the trading data at time point A and the trading data at time point B remain as time-series data (see FIG. 87).

This is because the question is how to capture complicated situations by period, such as unrealized profit and loss or trading gains and losses, when various trades are made in the AB period and the holding status changes further. “The amount of information differs markedly between the mere portfolio transition and the aggregated trading data by period.”

“It is not easy to derive it because it contains a very large mix of stock, sold brands, newly purchased brands, immediately sold brands, and still held brands, and the stock price fluctuates daily.

“However, with this method, it can be easily derived.” The fact that each period is easily obtained means that it is possible to report the situation that is sequentially changing accurately, and this is a very useful method as an article.

For example, it is possible to easily create an article such as what brand has the highest profit in this month. “One of the purposes of aggregated trading data by period is to create such current news.”

However, even with this simple theme, if it is October, if an investor who held it on October 1 sells it in October, and if there are investors who held it until the end of October and the stock price continues to rise, the investor who held it until the end of October must make a profit in October and be valued higher than the investor who sold it.

In addition, some investors trade five times in October, making more profits than they would continue to hold, while others are losing money at the end of October. “This situation is not so easy to grasp because of the complex web of stock prices, changes in holdings, and trading conditions.” In a complicated case including not only a period but also a brand, there is a special effect that the problem can be solved by using aggregated trading data by period.

“Delimiting time periods in this way seems simple, but in the case of trading data, it is very complicated.” “However, by creating aggregated trading data by period, it becomes possible to derive the data easily.

### (Definition of Aggregated Trading Data by Profit and Loss)

The creation of the trading data based on profit and loss is usually the creation of the trading data performed in the fourth step, but in some cases, it may be better to recheck the trading data based on profit and loss. “In such cases, create aggregated target trading data: by profit and loss.” In the Aggregated trading data by profit and loss, the profit and loss is the aggregation target (for example, the winning profit), whereas the profit and loss level trading data in the profit and loss level valuation indicators indicates trading data to be extracted and processed when the aggregation target (for example, unrealized loss) is evaluated by the profit and loss (for example, the inclusion loss).

Since the former is the trading data totaled by the winning profit, the winning profit of Person A and the winning profit of Person B is aggregation target. On the other hand, in the latter example, the trading data is focused only on the trading data of the winning profit of the investor A, so the trading data is extracted to evaluate the trading of the investor A. It is also possible to classify the trading data to be counted by winning profit and the trading data to be counted by losing loss in a lump and re-classify them.

### (Step of Creating Aggregated Target Trading Data)

In the step of creating the Aggregated target trading data, the information generation unit 3021 divides the aggregated trading data by period, the aggregated trading data by investor, the Aggregated Target Trading Data by Investment Target, the aggregated trading data by profit and loss, the Aggregated target trading data by investment type, the Aggregated target trading data by an adviser, the Aggregated target trading data by a securities company, the Aggregated target trading data by medium, and the like. “The division method is determined by a method of an extraction condition, a classification condition, or a totalization rule (calculation of an average value, a total value, or the like by the information processing system). By combining these, it is also possible to create a combination with the Aggregated target trading data of Person A in 2019, the Aggregated target trading data of Person A's issue A, and the like. Further, by classifying, aggregating, and extracting (all or not all) the Aggregated target trading data into constituent elements such as periods, investors, investment types, media, securities companies, and investment targets, the trading data is subdivided into constituent element trading data.

(Relationship with Old Method of Aggregated Target Trading Data: Creation Step)

“The way of understanding trading data under the old method lumps trading data together, and the new method clarifies what kind of objects are extracted for what purpose, whether they are classified or aggregated.

### (Significance of Aggregated Target Trading Data: Creation Step)

In the step of creating Aggregated target trading data for the new system, the purpose of evaluating what (aggregation target, Person A, Brand B) the trading data is to be evaluated based on which criteria (investment, investment target, period, etc.) the trading data is to be extracted and classified, how to totalize them, and whether or not totalization (various calculations such as a total value and an average value) is to be performed (all may be included or not included).

### (Problem of Aggregated Target Trading Data: Creation Step)

By performing the step of narrowing down the trading data, the evaluation target becomes clear, and the evaluation target, such as the Evaluation of trading status and holding status of the stock of company S and the Evaluation of trading status of Person A in 2019 and the purpose thereof becomes clear. Moreover, by dividing the aggregated target trading data: which is the basis of these data, by period, by investor, by investment type, by medium, by securities company, by investment target, and by other components, it becomes possible to further understand the nature of the trading data by extracting or aggregating them.

### (Operation of Aggregated Target Trading Data: Creation Step)

Decide on which criteria (Is it by investor, by object, by period, by profit or loss, or a combination of those?) to extract, classify, and aggregate trading data, and create trading data according to those criteria. Furthermore, it is possible to create component trading data by dividing the aggregated target trading data: which serves as these criteria, into components such as period, investor, investment type, medium, brokerage firm, and investment target.

### (Effects of Aggregated Target Trading Data: Creation Step)

By executing this step, there is a remarkable effect that it is possible to create various trading data for each period, for each investment object, for each profit and loss level, for each investment type, for each securities company, for each adviser, for each medium, and the like, to clarify evaluation objects, and to evaluate various objects from various viewpoints. Furthermore, by dividing Aggregated target trading data as the criterion by period, by investor, by investment type, by medium, by brokerage firm, by investment target, etc., for example, it is possible to divide the investment results of the A stocks by year or by investor, and it is possible to divide the investment results of stock by stocks, by investor, by brokerage firm, or by securities firm.

Next, the characteristics of the respective aggregated target trading data will be clarified.

### (Definition of Aggregated Trading Data by Period)

For example, if aggregation target is a period, it can be divided into trading data annually for one year, monthly trading data for one month, weekly trading data for one week, and day trading data for one day, and trading data for 2019.

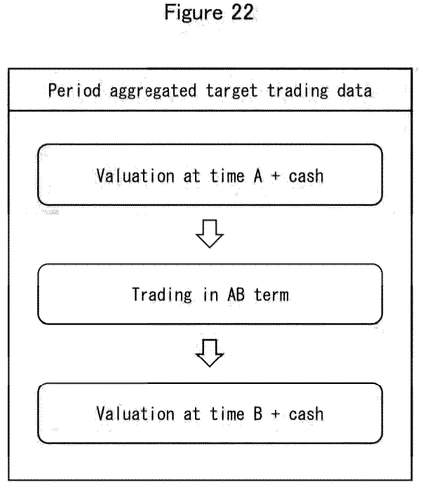

FIG. 22 is a diagram for explaining the aggregated trading data by period according to the present embodiment. “As shown in FIG. 22, when evaluating the trading status and the holding status in a certain period, it is necessary to evaluate the appraised value at time point A and the process of becoming the appraised value and the cash at time point B as a result of various trading at the time point A.

“The trading data required at this time is defined as taggregated trading data by period.” FIG. 23 shows aggregated trading data by period according to the present embodiment.

“The period-based target trading data is, for example, trading data that was traded from January to December 2020 when the year is 2020. “Several pieces of data sold between January 2020 and December 2020 are shown below.

Data held in January 2020 but sold during the period (period data), data held in January 2020 but also held in December (period data), and data purchased from January to December 2020 (period data) but data bought in November 2019 and sold in December 2019 is not period data. “Data bought in January 2021 is also not period data.” To redefine it, the annual Aggregated trading data by period for 2020 includes trading data: held in January 2020, trading data: for one year, and trading data: held in December 2020. There is also a problem of handling the deposit and withdrawal during the term, which will be described separately.

### (Old Method Concerning Aggregated Trading Data by Period)

In the old method, the date of purchase, the date of sale, etc., are explained, but there is no explanation by period. Extracting only the trading data from point A to point B makes it possible to accurately capture the buying, selling, and holding that took place during that period. “In this case, trading data processing and procedures are required. In addition, in the period comparison of investment results, there is a method in which Change in evaluation amount between the trading data at the time point A and the trading data at the time point B is represented.

### (Problem of Aggregated Trading Data by Period)

Accurate evaluation of trading data over some time requires the trading profit and loss data and the unrealized profit and loss data to be reevaluated individually (or together and simultaneously). This evaluation change procedure, the classification of held stocks and traded stocks. The fact that held stocks at time point A is also involved is complicated and one of the causes that make it difficult to understand the results of stocks.

As shown in FIG. 23, 1 is the trading data of the investment commodities purchased by time point A and held at the time point B (that is, the increment/decrement of the amount held). 2 is the trading data: for the investment commodities purchased by the time A and sold before time B (i.e., the amount that was held before, but sold during the period). 3 is trading data of investment commodity purchased later than time A and sold prior to time B (the part sold and bought or sold during the term, in a narrow sense, the term trading profit and loss). (In the narrow sense of the term, this is periodic trading gains or losses.) Reference numeral 4 denotes trading data of an investment commodity purchased after time point A and held at time point B (an increment or decrement of a newly purchased product during the period).

1 and 4 relate to Unrealized profit and loss level trading data (possessed commodity at the time point B), two relate to a commodity which has been possessed but has been sold out, and three relate to trading profit and loss level trading data (trading profit and loss level trading data at the time point B). “1 and 4 represent trading data with unrealized profit and loss (non-opposition trading data) at time B, and 2 and 3 represent trading profit and loss level trading at time B. “The following is a method of processing these data into taggregated trading data by period.”

“The information generation unit 3021 extracts (or classifies or aggregates and may or may not include) the Aggregated target trading data by period as a reference, generates the aggregated trading data by period, calculates the Trading profit and loss level valuation indicators or the unrealized profit and loss level valuation indicators from the aggregated trading data by period, and generates information on the Evaluation of trading status or the holding status for each period.

Therefore, if the Aggregated trading data by period does not appear orderly, the profit and loss level trading data, which is a subsequent process, cannot be accurately calculated by the information processing system at the second level and thereafter. In particular, this problem arises when attempting to create period data from trading data at time A and B. “A method for solving this problem is a mechanism for evaluation change by the information processing system. In other words, unless the process of aggregated trading data by period is interspersed, unrealized profit and loss and gains on sales by precise period can be captured by total figures but cannot be calculated. This is because the model must consider the fact that it becomes sales and gains data or unrealized profit and loss data. “This invention has a remarkable effect because it affects all the later processes, such as the calculation of valuation indicators and the creation of rankings.” However, there is one method for avoiding this: the trading profit and loss level trading data is first created and extracted for each period, and the Unrealized profit and loss level trading data is first created and extracted for each period. “These similar techniques will be described later.”

Then, when the period is a period from time point A to time point B, the information generation unit 3021 extracts trading data that is held at time point A or held at time point B or which is traded within the AB period, thereby creating the aggregated trading data by period.

With respect to investment commodity's trading data, Base Valuation of investment commodity shall be changed from the unit price at the time of purchase to the unit price at time A, and with respect to trading data of investment commodity of Aggregated trading data by period held at time B, the latest closing price of Base Valuation shall be changed from the unit price at the time of sale or from the current unit price to the unit price at time B.

FIG. 24 will be supplemented. FIG. 7 is a table for obtaining profit and loss in the period AB when the time point A is Jan. 9, 2019, and the time point B is Feb. 3, 2020. FIGS. 24 to 28 are diagrams related to the aggregated trading data by period and show a process of evaluation change by the information processing system.

First, the information processing system evaluates the Unrealized profit and loss level trading data by the information processing system. That is, it is this FIG. 24 that divides 1 and 4 in FIG. 23.

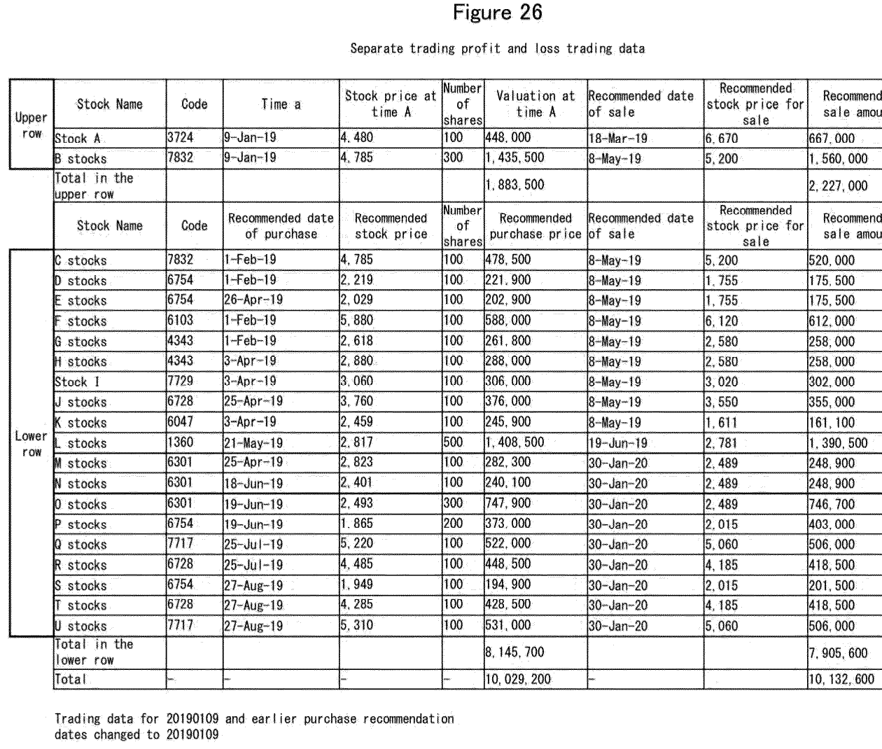

Since the explanations in the figures below are very complicated, when organized in relation to FIG. 23, the case of 1 is the upper part of FIG. 24 (the case that continued to be held), the case of 2 is the upper part of FIG. 26 (the case that was held at time A but sold between AB), the case of 3 is the case of the lower part of the middle part of FIG. 26 (the case that was completed to be sold during AB period. The simplest case), and the case of 4 is the case of the lower part of FIG. 24 (the case that was purchased during AB period and held at time B)(summarized in FIG. 100). (the simplest case), and case 4 is the bottom case in FIG. 24 (purchased in period AB and held at time B)(summarized in FIG. 100).

FIG. 24 is a diagram illustrating a specific example of the evaluation change of trading data with unrealized profit and loss according to the present embodiment. “The upper row of FIG. 24 shows the case of 1 in FIG. 23. “The lower part of FIG. 24 shows the case of 4 in FIG. 23. (Since the recommended date of purchase is before time point A (here, January 2019), the start time point is evaluated by the unit price at time point A, and the most recent closing price is time point B.))

FIG. 24 shows an extraction and processing procedure of trading data with unrealized profit and loss. “In the case in the upper part of FIG. 24, the investments held at point A should be based on the market value at point A, not the purchase price. “It is the case of 1 in FIG. 23 that the evaluation change is necessary.

“As shown in the upper table of FIG. 24, the purchase time is 3,930,000 yen, the base valuation at time A is 6,710,000 yen and the base valuation at time B is 9,330,000 yen.

As in the case of 4 in FIG. 23, the investment object which is not held at the time point A but is being held at the time point B may be set to the purchase unit price.

“As shown in the lower table of FIG. 24, also at the time of purchase, the base valuation at time A is 2,120,000 yen, and the base valuation at time B is 2,770,000 yen.

When the upper part and the lower part of FIG. 24 are combined, the period-based trading data with unrealized profit and loss is not the purchase amount of 6,060,000 yen but the time point A reference value of 8,840,000 yen, and the difference between the time point A reference value of 12,110,000 yen and the time point B reference value of 3,270,000 yen is the inclusive profit (in the AB period).

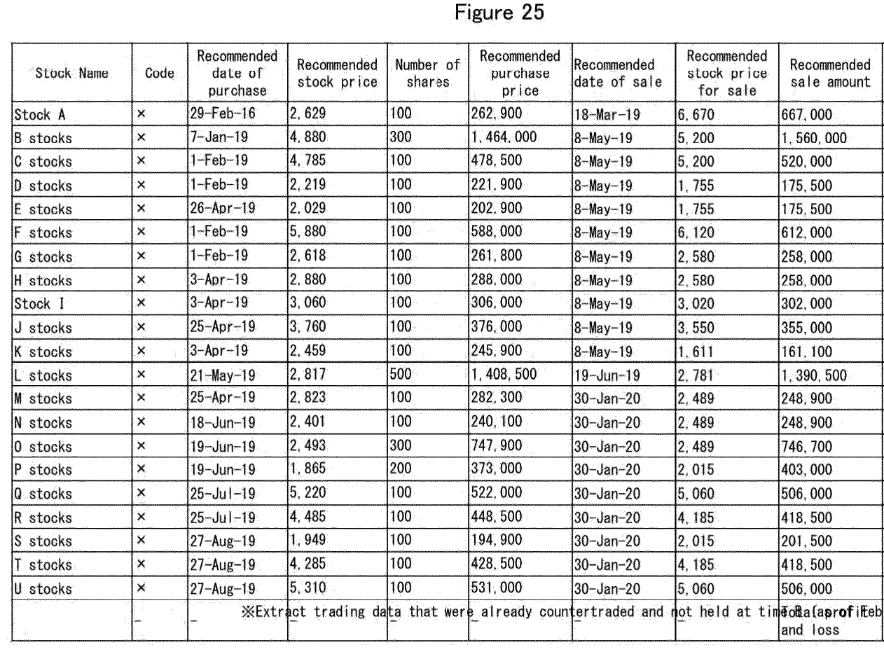

Referring to FIG. 24, in the trading data with unrealized profit and loss, the appraised value at time point A is 2,120,000 yen+6,710,000 yen=8,840,000 yen, and the appraised value at time point B is 9,330,000 yen+2,770,000 yen=12,110,000 yen. “FIG. 25 illustrates a method of processing profit and loss trading data (trading data obtained by counter-trading) into aggregated trading data by period.

FIG. 25 and FIG. 26 are diagrams showing an example of modification processing of Trading data with trading profit and loss into the one by period. In the case of trading profit and loss trading data, there are two stages: FIG. 25 and FIG. 26.

“FIG. 25 shows the extracted trading data from the period from point A to point B. “Specifically, it extracts trading data between the recommended date of sale>point A (In this case, Jan. 9, 2019) and the recommended date of sale<point B (In this case, Feb. 5, 2020), that is, the date of sale between point A and point B. In other words, it refers to trading data for which the date of sale was between Jan. 9, 2019 and Feb. 5, 2020. It refers to trading data (from which trading profit and loss trading data is extracted) for stocks that were not held as of Feb. 5, 2020, and for which trading has already been completed. “It is a specific example of trading data in 2 or 3 of FIG. 23 by period.” In FIG. 25, only the trading profit and loss level trading data is extracted, and the following processing of the evaluation change is necessary.

“FIG. 26 shows the evaluation change of the trading data extracted in FIG. 25. The upper part of FIG. 26 shows brands that are owned at time point A but not at time point B (corresponding to case 2 in FIG. 23).

“When trading gains and losses (evaluation change of buy recommendation date) are calculated at point A, 2,220,000 yen−1,880,000 yen=340,000 yen. In FIG. 26, issue A and Brand B are applicable, and in FIG. 25, issue A has a trading profit and loss of 400,000 yen (trading profit of 404100 yen from 262900 yen to 667,000 yen), but in FIG. 26, it decreases to 210,000 yen from a recommended stock price of 2629 yen (Feb. 29, 2016) to a price of 4480 yen at time A (Jan. 9, 2019 (time A)). “Stock price.” “Stock price.” “In order to measure the trading result for each period, this evaluation change is necessary.

“The lower part of FIG. 26 shows brands that are not held at the time point A or the time point B.” In case 3 of FIG. 23, the trading data does not need to be evaluation change. “When trading gains and losses are calculated as is, 7.9 million yen−8.14 million yen=−240,000 yen.

This makes it possible to evaluate the trading status, holding status, and the like from time point A to time point B.

However, it goes without saying that by dividing the trading profit and loss level trading data by period, the winning profit level trading data at the lower level, the losing loss level trading data, and the winning pattern level trading data at the lower level are also similarly divided by period. The Unrealized profit and loss level trading data is similarly divided by period. “The top overall profit and loss level trading data is similarly divided by period.

It is only because aggregated trading data by period is created in this manner that the creation of an article, such as the investor ranking in 2020, can be facilitated by affecting the subsequent steps. Although it seems to be simple that the trading data at the time point A and the trading data at the time point B cannot proceed to the subsequent step, this step is an important element for determining how important this step is and whether or not the profit and loss of the period can be correctly seen so that a substantial effect can be expected.

### (Action of Aggregated Trading Data by Period)

To evaluate the trading status and holding status from the point of time A to the point of time B, the investment target held at the point of time A among the holding target B recreates the trading data by converting the market value information at the point of time A into the purchase unit price. The investment objects held at point A are all revalued from the purchase unit price to the market value at point A, and the trading data is created by the period.

“From the trading data, an information generation unit 3021 creates the aggregated trading data by period through the following modifications.

Trading data for each period is obtained by setting the base date to A and the unit price to Aggregated target trading data at A when date of purchase in Aggregated target trading data is prior to A with trading data at B as the base point and market-value at A.

Based on the relationship between the date of purchase, the date of sale, point A and point B, the data are divided into the following four categories (see FIG. 23).
(1) (Taken together with the numbers in FIG. 23, 3) When date of purchase≥A time point (date of purchase is after A time point) and date of sale<B time point (date of sale is before B time point).

In other words, for trading data in which sales and purchases were completed during the AB period, trading data less than trading profit and loss are used for evaluation. FIG. 25 is a corresponding diagram.
(2) (when combined with the numbers in FIG. 23, 4) when date of purchase≥time point A (date of purchase is after time point A) and date of sale≥time point B (date of sale is after time point B)

In other words, for trading data purchased after A and held at B, trading data below Unrealized profit and loss are used to assess such data.
(3) (Taken together with the numbers in FIG. 23, 2) When date of purchase<A time point (date of purchase is before A time point) and date of sale<B time point (date of sale is before B time point)

In other words, the trading data held in period A but completed during the AB period is valued using trading data less than trading profit and loss.
(1) (Taken together with the numbers in FIG. 23, 3) When date of purchase≥A time point (date of purchase is after A time point) and date of sale≤B time point (date of sale is before B time point)

In other words, for trading data purchased before point A and held continuously at point B, we evaluate trading data below unrealized profits and losses.

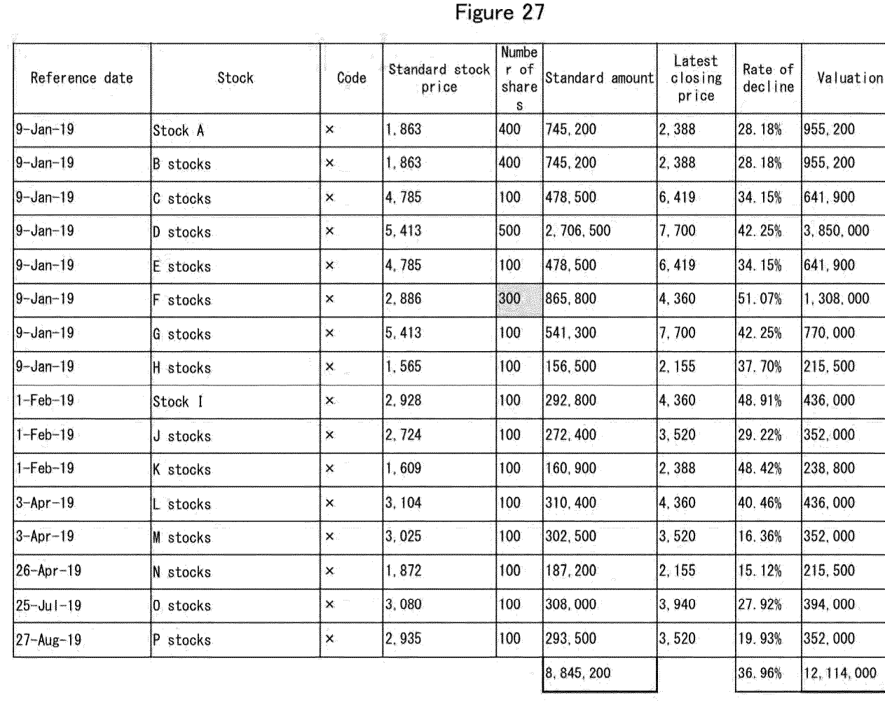

FIG. 24 of the trading data with unrealized profit and loss shows that the purchase price of 6,060,000 yen becomes 8,840,000 yen at point A appraised value and 12,110,000 yen at point B appraised value (see also FIG. 100). FIG. 27 shows a method in which only the A-time and B-time appraised value are displayed without indicating the purchase amount. “Both displays are possible.”

As described above, another feature of the Aggregated target trading data other than the evaluation change by the information processing system is that the Aggregated target trading data is grasped by being divided into the four methods. “Trading data for the AB period can be broadly divided into these four categories, and when captured by this classification, it is possible to understand how to capture the results for each period to be correct. “This four classification method is also one of the present inventions. “However, when the time point B stock price is the current value, it is sufficient to change the evaluation of the time point A stock price, but when the current time point has passed the time point B, it is also necessary to change the evaluation of the time point B. “Alternatively, the evaluation change at the time point A is performed by referring to the trading data at the time point B. In this way, trying to accurately capture period gains and losses becomes rather cumbersome.

On the other hand, for third analogous form's Aggregated trading data by period, if the difference between an appraised value at time A and an appraised value at time B is calculated as an increment or increase or decrease, and the increment or decrement of Unrealized profit and loss is expressed as A and the increment or decrement of trading profit and loss is expressed as B, then profit and loss between trading and trading profit and loss is not exact. Periodic comparisons of overall profit and loss at the first level, trading gains and unrealized profits and losses at point A, and trading gains and unrealized profits and losses at point B are generated. Still the figures subtracted are meaningless, and therefore, no period gains and losses are generated after the second level. However, in this case, it is necessary to capture stock prices in time series, and there are various disadvantages compared to the complete version. However, the calculation is simple and easy to grasp, but what is processed to be applied to the completed version from here is eventually synonymous with the aggregated target trading data (completed version). “Whether or not the method is used to create the aggregated trading data by period lies in evaluation change and four classification methods.

### (Effect of Aggregated Trading Data by Period)

By the step of creating the aggregated trading data by period, it is possible to evaluate for each period, and it is possible to more clearly evaluate the trading status and the holding status for each period of the aggregation target. In particular, by classifying into four types and separately evaluating the Unrealized profit and loss formation funds and the trading profit and loss forming the fund, there is a great effect that the holding status evaluation and the Evaluation of trading status of the aggregation target are separated.

“As shown in FIG. 27, the date of purchase, purchase unit price, and purchase price may be rewritten to the point A, point A market appraised value, and point A appraised value. As shown in FIG. 24, evaluation change may be performed by adding another item to the trading data. The relationship between the current and market values at point B, which will be discussed later, is similar. “FIG. 24 includes the recommended buy price (or purchase unit price), the reference price (or the market value at time A), and the market value at 3:00 of the most recent closing price (or B point market value, current value). “FIG. 27 includes the recommended buy price (or purchase unit price) and the market value at 2:00 of the most recent closing price (or B point market value, current value).

By the above-described operation, each profit and loss is indicated as a profit and loss for each period, and a remarkable effect that is not provided in the old system is exhibited. “This aggregated trading data by period will be very useful in conveying a situation that changes from time to time. “It can be said that this data is indispensable for creating a current event. For example, a ranking of 10 stocks that lost money this week, what ranked first in trading profits yesterday, and what made the most profit today can be easily created by this creation of aggregated trading data by period, which is one of the purposes, and to that end, it shows how to create aggregated trading data by period.

“All of these correct results are displayed from aggregated trading data by period, but in the case of a pseudo version, even if the overall profit and loss level appears, it is a false representation because defects exist after the trading profit and loss level trading data. That's because it's really trading profit and loss level trading data, but it's going into trading profit and loss level trading data at the Unrealized profit and loss level trading data, and vice versa.

However, since there are some defects, but some are partly compatible with each other, this method is also a form of taggregated trading data by period. In summary, there are four forms of aggregated trading data by period, one is a method of capturing only trade profit and loss by period (first similarity system), the second is a method of capturing overall profit and loss by Change in evaluation amount by the information processing system (second similarity system), the third is a method of first dividing into trade profit and loss and Unrealized profit and loss then dividing into period profit and loss (third similarity system), and the fourth is a complete version.

### (Handling of Cash-Receipt-and-Disbursement Data of Aggregated Trading Data by Period)

The handling of deposits and withdrawals during the AB period is also one of the complicating problems. In the case where the number of receipts and withdrawals increased from 1 million yen at the time of A to 1.2 million yen at the time of B, and even if the amount increased by 200,000 yen, the amount increased by 100,000 yen was deposited, the amount deposited must be removed to calculate the outcome. On the other hand, if 100,000 yen is dispensed, the amount is increased by 300,000 yen; that is, 100,000 yen is dispensed. “There are various methods for depositing and dispensing in this Nakabun.” What is important is to separate the increment and decrement by profit and loss of the investment during the period from the increment and decrement by the input and output. This division ensures that the increment/decrement from the pure profit and loss can be calculated.

### (Similar Form of Aggregated Target Trading Data by Period)

First analogous form: Definition of Creation and Display of Aggregated target trading data by period at the Trading Profit/Loss Level)

The Aggregated target trading data by period of the First analogous form is compared with the period by excluding only the trading data traded and bought during the period.

(Issues with Conventional Technology)

Period comparisons of investment performance are surprisingly difficult. The more data, the more difficult it is to understand. Simple and easy to understand in the example of FIG. 23 above. It is this First analogous form that we have taken only three result of AB period. If you sell the issues you hold, the stocks you are buying, or the stocks you hold, you are all ignored, and calculate only buy or sell the stocks you sell during this period. Inevitably, the actual situation cannot be captured, and since the evaluation is based only on the AB period of the trading profit and loss level trading data (only trading data bought after the point A and sold before the point B), there are quite a few omissions and the figures are not reliable.

### (First Analogous Form: Effects of Creation and Display of Aggregated Target Trading Data by Period at the Trading Profit/Loss Level)

It can be created by extracting the Trading profit and loss level trading data, and extracting only the trading data that was purchased after the point A and sold before the point B. In the explanations of FIGS. 24 to 28, only the middle row and the lower row of FIG. 26 are targeted. This results in a net income of −240000 yen for the period. The actual situation is positive at 3540000 yen, so we can see how different numbers are.

### (First Analogous Form: Effects of Creation and Presentation of Aggregated Target Trading Data by Period at the Trading Profit/Loss Level)

We don't think about the status of our holding, and it's easy and valuable to evaluate the skills of our trading. The evaluation of short-term trading, such as day trading, is simple, straightforward and easy to understand.

### (Second Similar Form: Definition of Creation and Display of Aggregated Target Trading Data by Period at the Trading Profit/Loss Level)

This type of second analogous form is a comparison of the time periods that can be displayed when the trading data is stored in time series, and the number of the total appraised value is grasped. Change in evaluation amount can be made and period comparisons can be made.

(Issues with Conventional Technology)

In the first analogous form, the results of the people they own are missing, so we cannot make an accurate decision first. If you happen to have it at time B, it will be out of the list. In contrast, the second analogous form does not fall out. It covers 1 to 4.

### (Second Similar Form: Effects of Creation and Display of Sales and Purchase Data Subject to Overall Profit and Loss Level by Period)

The Aggregated target trading data by period of the second similar form is compared using the aggregate overall profit and loss level trading data. In other words, if there is a total of the market value, the cash balance, and the trading profit and loss of the currently held stock, the current appraised value is obtained. If both the appraised value at time A and the appraised value at time B are stored in the database, they can be obtained immediately. The most common portfolios, cash balances, and valuations found by securities firms are valuation trends as the basis for period comparisons when data are stored in this method.

### (Second Similar Form: Effects of Creation and Presentation of Aggregated Target Trading Data by Period at the Overall Profit and Loss Level)

The overall picture is very easy to understand. It is easy for anyone to understand the appraisal value at a glance and compare it with the time period because it is clear at a glance how much the appraisal value has changed. From around this time of last year, the appraised value has increased or decreased by this amount in one year, or it has a clear effect at first glance.

### (Definition of Aggregated Target Trading Data by Period (Third Similar Form))

There is a method in which the trading data is first divided into the trading Profit and loss level trading data which is the second level trading, and the Unrealized profit and loss level trading data, and the trading data is divided by period at the time point B. Overall profit and loss as of B−Overall profit and loss as of A to arrive at Overall profit and loss for the period. The total figure of Unrealized profit and loss at time B and trading gains/losses at time B will be correct, so the figure will be more than divided by period at the Overall profit and loss level. However, the total numbers are consistent with each other, and this is defined as the Aggregated target trading data by period (third similar form) to be compiled.

If the trading data at time A is stored as time series data, it is obtained by adjusting the trading data at time A, the trading data at time B, and the trading of AB term. If the part of the Aggregated target trading data by period of the third similar form whose appraised value is increased or decreased among AB is divided into profit and loss, the Aggregated target trading data by period of the third similar form can be created by the information processing system. In this case, the Unrealized profit and loss at time B is summed with the Unrealized profit and loss of 1 and 4, and the sale/loss of 2 and 3 are summed with the sale/loss. Therefore, there is no defect in the total number at time B and the total profit/loss in AB term. Since we can grasp the profit and loss for the period correctly rather than the second similar form, we define this as the Aggregated target trading data by period according to the period of the third similar form.

(Issues with Conventional Technology)

Although there is a defect, the trading profit/loss and Unrealized profit and loss can be displayed separately from the Aggregated target trading data by period, and can be understood more than a simple period comparison of the appraised value.

### (Action of Aggregated Target Trading Data by Period (Second Level))

The trading data is first divided into the trading Profit and loss level trading data of the profit/loss second level trading data and the Unrealized profit and loss level trading data (first step), and the trading data at the B time point and the trading data at the A time point are used to obtain the period profit/loss (second step). The overall numbers, including the trading profit and loss at time B, the unrealized profit and loss at time B (third step), and the total profit and loss, are correct. Since the Change in evaluation amount can be captured (the fourth step), it is possible to more accurately identify the investment results in the period of the higher stage than the Overall profit and loss level (the second similar form) and the period comparison of the profit/loss (the First analogous form).

### Effects of Aggregated Target Trading Data by Period (Second Level)

The level is higher than that of the second similar form, which can be compared only in terms of total profit and loss or total asset value, and it becomes possible to capture profit and loss by period. It can be expected that Mr. A's overall profit-loss ratio in 2020 will be known, and that the investor ranking will also be able to rank the overall profit-loss increase rate in this month.

### (Specific Example)

The most problematic is the sale of a stock that had been held at time A. This changes from the Unrealized profit and loss level trading data at time A to the trading profit/loss level data at time B. In order to process the trading data at time B, if these stocks are not changed to the stock price at time A, the exact number will not be generated. Eventually, if the process of processing the aggregated target trading data is not completed, the process cannot proceed to the next process (accurate numbers do not appear).

In addition, in the third similar form, although there is no problem in the example of FIG. 23 since 1 is the Unrealized profit and loss level trading data, since the evaluation is not changed, even if there is a total number, this number does not match. Since 2 is a case of changing from the Unrealized profit and loss level trading data to the trading Profit and loss level trading data, even though there is a brand to be evaluated in the trading Profit and loss level trading data, it has not been evaluated, so that the number can be defective. 3 and 4 are accurately determined based on the B time point.

### (Definition of Aggregated Target Trading Data by Period (Complete Version))

It is possible to measure the investment performance by period most correctly among the four methods.

(Issues with Conventional Technology)

The most problematic way to measure the outcome of an investment by period is to mix the investments it owns with the investments it buys and sells, and to divide them by period, to make it difficult to understand how to capture the outcome. You can easily create a ranking of stocks. This is because it is not necessary to carry out the step of holding or not in the rate of decline or the rate of decline. On the other hand, in the case of investment results, it is difficult to compare periods. The period-specific outcome of this investment outcome is that it is very complicated, especially when it comes to big data, why the numbers do not match, and it is difficult to swallow it.

The biggest disadvantage of the third similar form is that the holdings held in the trading data at time A and the trading data at time B are greatly changed, and there are many exchanges between the Trading profit and loss level trading data and the Unrealized profit and loss level trading data because stocks that were not held at time A come in, or stocks that were sold at time A are not sold. Therefore, unless it is viewed in a manner that can be viewed in the Aggregated target trading data by period (complete version), it is not possible to accurately determine the status of Unrealized profit and loss and trading gains/losses. In other words, there is still a problem that it is not possible to properly evaluate the holding status or the trading status.

Change in evaluation amount can be more easily used to obtain Aggregated target trading data by period, and can be expected to have an effect of identifying how the amount increased. The former method is sufficient to calculate the Change in evaluation amount and the rate of increase/decrease. However, considering the subsequent process, it is very effective to prepare Aggregated target trading data by period in which the results of the issues held and the results of the traded stocks are accurately divided. Here, if the Aggregated target trading data by period is redefined, the Aggregated target trading data by period (complete version) is includes a revaluation process.

### (Action of Aggregated Target Trading Data by Period (Complete Version))

Surprisingly, the steps are simple. In the trading data at time B, the Unrealized profit and loss level trading data is divided into those purchased before time A and those purchased after time A, and the trading data at the trading Profit and loss level trading data is also divided into those held at time A and those not held at time A, and the trading data held at time A is revalued at the market value at time A, so that the Aggregated trading data by period (complete version) can be compiled. Unexpectedly, it's like a puzzle that can't be solved, and it's surprisingly easy to solve, but it's hard to understand only by trial and error.

Supplementary figures to FIG. 23 show that the number of cases 1 increase or decrease or decreased after holding, the number of cases 2 increased or decreased after selling the product in stock, the number of cases 3 increased or decreased after purely buying or selling it during the period, and the number of cases 4 increased or decreased after purchasing it. By dividing this, the reason for the increase and decrease during the period can be expected to be clear. It is more obvious than just an increase or decrease in valuation. For example, those who have increased their assets only by holding them during this period, and those who have increased their assets by buying and selling them hard during this period, must make a distinction between evaluations. However, if we attempt to capture the increase or decrease in the appraised value alone, we do not know this. If the number of recently purchased items is good, 4 will increase, if the number of stocks held before is good, 1 will increase, if the number of stocks trade is good, 3 will increase, and if the number of stocks sold during the period contributes 2 will increase, allowing more detailed evaluation. Especially, the high effect is observed in the subsequent process (advice, diagnosis, etc.). The two characteristics of this Aggregated target trading data by period (complete version) are that the period results are captured by the four classifications and revaluation.

### Effects of Aggregated Target Trading Data by Period (Complete Version))

This effect is enormous. This is because the results of the investment results are correctly understood for each period of time. This is because it cannot be derived without the concept of re-evaluation of trading data and Aggregated target trading data by period (complete edition), such as who had the highest investment results in February 2020, who won many shares in November 2020, and who won in virtual currency.

### (Specific Examples of Aggregated Target Trading Data by Period (Full Edition))

SoftBank shares can be used to divide investment results into periods and generate data needed for articles such as detailed exploration of investment results in 2020. FIG. 100 is a view summarizing FIG. 24 and FIG. 26 showing the specific example of FIG. 23.

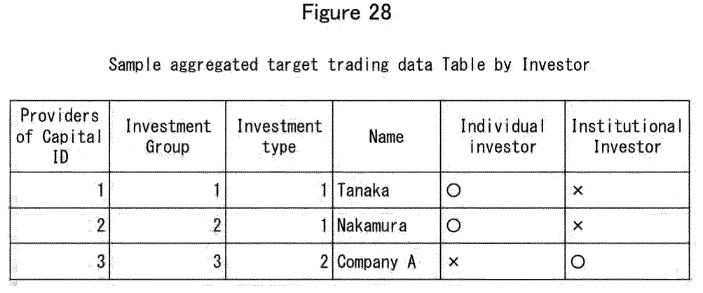

FIG. 28 is a diagram illustrating an example of a table of Aggregated target trading data by investor according to the present embodiment.

### (Definition of Trading Data Definition to be Aggregated Target Trading Data by Period of Investment Target)

FIG. 1 is a diagram showing a form of Aggregated trading data by period, and relates to Aggregated target trading data by period of Investment Target. The profit and loss by period of an investor is usually carried out by a method such as Change in evaluation amount, but the Aggregated target trading data by period of Investment Target indicates that the investment profit and loss by period of the stock A is calculated by the information processing system. In response to the question of what the investor's achievements in 2020 for A stocks were, the trading data included in the Aggregated target trading data by period of Investment Target can be used to generate content to be solved.

### (Conventional Problems)

Although the results of the trading of investments can be made quickly at the level of individuals, we do not know what the whole investor did.

### (Effects of Aggregated Target Trading Data by Period of Investment Target)

However, if this data processing system creates the aggregate target trading data by period for the investment, and if the data processing system generates this data, there is a special effect that makes the generation of the data easier. Especially, it becomes possible to generate contents such as “investment result of S company stock, whether it is in 2020” by the period, and it becomes possible to generate many article contents. In order to do so, it is necessary to first create Aggregated target trading data by period, and this creation step and then a step of extracting the trading data with the investment target as an axis are required. There is a step of calculating various valuation indicators by the information processing system in the calculation step of the profit/loss level valuation indicators by the information processing system, and a number of valuation indicators are calculated. Of course, it may be created first from the Profit and loss level trading data (in an irregular order).

### (Effects of Effects of Aggregated Target Trading Data by Period of Investment Target)

This is the first time that the actual situation of the investment results for each period of the investment target is clear. The combination of the period, the investment target, and the investment profit and loss creates a variety of content. The information processing system can consistently generate contents such as rankings and comparisons.

### (Specific Examples of Aggregated Target Trading Data by Period of Investment Target)

### Example 1

Combining investment targets with period, profit and loss, and stock price charts (setting each condition) makes it possible to create a chart in which the actual purchase price, such as the average of each investor or investor, can be plotted against the sale price at the time of sale.

### Specific Example 2

The combination of investment targets, period, profit and loss, and technical indicators enables the information processing system to calculate the most effective technical index values for the relevant period and the relevant issue, as well as to compare the various technical index values.

### Example 3

By combining investment objectives, time periods, gains/losses, and corporate performance trends, we can report on what changes in investment behavior the performance news has brought about in the stocks in question for the time period in question.

### Example 4

Combining investments with periods, gains and losses, and news stocks gives you an idea of how differences in investment behavior occur over the period and the news stocks, and what news has given the investor the most impact.

### Example 5

The combination of investments and periods, gains and losses, and events, similar to the issues' news, shows how dividend decisions and split decisions alter investment behavior.

### (Significance of Trading Data by Component of Trading Data Subject to Aggregate by Period)

There are many needs to look more closely at and analyze investment performance in 2020. It is especially useful for short-term traders to be able to see at a glance which stocks have made the most profit and which have lost the most money. Such Aggregated target trading data by period is further classified into constituent elements, and the re-tabulated trading data (or the trading data does not need to be tabulated) is defined as Trading Data by Component of Trading Data Subject to Aggregate by Period.

(Issues with Conventional Technology)

It is more obvious that the data for each period can be calculated simply because the data for each period can be obtained. However, it is convenient to combine this component-by-component trading data, such as how it was done by each stock, which stock was successful in 2020, and which stock or hypothetical currency was successful.

### (Action of Trading Data by Component of Trading Data Subject to Aggregate by Period)

When the information processing system creates the Trading Data by Component of Trading Data Subject to Aggregate by Period, the data is aggregated for each issue, which makes it very easy to understand. First, the information processing system creates Aggregated target trading data by period, then classifies the trading data into brands, and aggregates the trading data for each issue, so that the component trading data of the Aggregated target trading data by period can be created.

### (Effects of Trading Data by Component of Trading Data Subject to Aggregate by Period)

In addition to combining the period-specific and brand classifies, for example, by classifying not only the brand classifications but also the product classifications, it is possible to simplify the comparison between stock and FX investment results. In terms of corporate performance, it is possible to compare the profit-increasing brand with the profit-decreasing brand, and it is possible to easily compare the trading data purchased with a RSI of 20% or less with the trading data purchased with a RSI of 80% or more, using the classification as a technical index. A variety of data sets can be drawn from the information processing system, but the information processing system can generate a variety of contents by classifying and comparing components (e.g., stocks, stock prices associated with stocks and dates, technical indicators, corporate performance associated with stocks, etc.) included in the Trading Data by Component of Trading Data Subject to Aggregate by Period.

### (Significance of Trading Data by Component (by Technical Indicator) of Trading Data Subject to Aggregate by Period)

This paper describes that various matters can be made in the preparation of the trading data by component of the Aggregated target trading data by period. What can be said about one technical indicator? It can be used, for example, to verify the outcome of the 2020 Technical Indicators and to measure the usefulness of the Technical Indicators. Throughout 2020, RSI can be used to verify that it was more successful.

### (Effects of Trading Data by Component (by Technical Indicator) of Trading Data Subject to Aggregate by Period)

First, the information processing system creates Aggregated target trading data by period in 2020. Next, the technical index, which is one of the constituent elements, is classified by an index called RSI. When it is desired to know whether or not the purchasing timing has succeeded, it is classified by RSI at the time of purchasing. The classification may be performed in various ways, such as, for example, less than 20%, 20% or more and less than 50%, 50% or more and less than 80%, or 80% or more. When the trading data is classified and tabulated, the information processing system for 2020, which is tabulated for each RSI range, is created. Once this has been done, the same steps after the fourth step as usual are taken. It is clear at a glance which range was successfully purchased, because the ratio of sales and loss also comes out, and so on.

### Effects of Trading Data by Component (by Technical Indicator) of Trading Data Subject to Aggregate by Period

The information processing system is an information generation system that can respond to a wide variety of needs. It can be analyzed deeply, and it can generate article contents for the mass media broadly. The Trading Data by Component (by Technical Indicator) of Trading Data Subject to Aggregate by Period is valued by those who want to look deeply at the stock such as day trader from various angles. This is a form of Aggregated target trading data by period.

### (Specific Examples of Trading Data by Component (by Technical Indicator) of Trading Data Subject to Aggregate by Period)

### (Other Specific Examples by Component of Aggregated Target Trading Data by Period)

### Example 1

A form of Trading Data by Component of Trading Data Subject to Aggregate by Period, but what is the component of corporate performance, for example? If a firm's performance is classified as an upward revision or a downward revision in terms of the technical measure of the process of action described above, the investment performance of the firm's stock revised upward in 2020 can be easily compared with the investment performance revised downward in RSI. Such an effect can be realized only by the Trading Data by Component of Trading Data Subject to Aggregate by Period by the information processing system. Such information can be said to be content that is also valuable as content such as stock newspapers.

### Specific Example 2

One form of the Trading Data by Component of Trading Data Subject to Aggregate by Period is for each technical index, but is also effective, for example, in a case where it is desired to easily compare the index of the average with the success person. Successes assume that “success Investors is 2020 results are at least 30% of total profit and loss.” In this case, the information processing system first creates, by way of example, Aggregated target trading data by period in 2020. “Investment type=Successes” (the definition of successor is in advance made by investment type in a group of investors performing at least 30% of total profit in 2020). If we classify the Aggregated target trading data by period in 2020 as an investment-type component as a successor and an average, we can easily compare the performance indicators of the two by taking steps from step 4 onwards as usual.

There are no specific examples of the Trading Data by Component of Trading Data Subject to Aggregate by Period. Why this kind of data comes out is still consistent with the information processing system. In the second to fourth steps, an extraction condition, a classification condition, and an aggregate rule are determined, and a trading data set is determined. This is because the valuation indicators is calculated by the information processing system from the trading data set, and the evaluation, comparison ranking, diagnosis, and advice are performed by the valuation indicators, and all the points are in the line. The aggregated target trading data by period is only the first step.

Everything that follows is organically linked and contributes to the creation of various content.

### (Significance of Preparation of Profit and Loss Level Trading Data of Aggregated Target Trading Data by Period)

After the Aggregated target trading data by period, there are components, and there are steps to prepare Profit and loss level trading data (some steps may be omitted, and the relationship between trading data and Profit and loss level trading data by period is touched upon. The creation of this Profit and loss level trading data defines whether the 2020 profit/loss is viewed at the Overall profit and loss level, whether it is viewed at the trading profit/loss level, whether it is viewed at the Unrealized profit and loss level, and at which level.

When we measure the overall investment performance of the entire stock in 2020, the Change in evaluation amount is appropriate if we measure the Overall profit and loss level. If Mr. A's investment performance is viewed by period, this level is mostly. The change in valuation is a typical example. The next level is the second-level Trading profit and loss level trading data and the unrealized Profit and loss level trading data. In order to look at this, as mentioned in the section on trading data subject to period-based aggregation, a step of re-evaluation is necessary. This is why even if the Overall profit and loss level reveals the profit by period, it becomes unclear at the sales profit/loss level and the Unrealized profit and loss level. Therefore, the significance of the aggregated target trading data by period will be demonstrated in the fields beyond the second level of profit and loss. That is, it is difficult to generate all the valuation indicators resulting from the creation of the Aggregated target trading data by period and the trading data of the second level or later (the second level, the third level, and the like) in the profit and loss level, unless a proper process is performed. In the example of the Unrealized profit and loss level trading data by period, in order to accurately evaluate the results in 2020 at the level of unrealized profit and loss, it is necessary to separately manage the results of the issues that were held at the beginning of 2020 and the results of the stocks that were purchased during the period in 2020. Only after the time periods have been separated to this point evaluation indicators such as win/loss ratios and unrealized loss ratios, which are the next step, be calculated correctly by the information processing system, and rankings and comparisons can be made with proper consistency and measurement.

### (Problems of Existing Technology)

In properly looking at investment gains and losses by period, we often do not seem to know how to properly recognize Unrealized profit and loss and trading gains and losses. What are the outcomes of investment in 2020? If you think about what you purchased before 2020, what will happen if it rises in 2020 and you sell it, you will realize that it is not that simple to figure out which period will be profit or loss. There are many different cases, and if we do not understand this and deal with the database in order to achieve results in 2020, we will get different results. Unrealized profit and loss are current Unrealized profit and loss, which fluctuate day by day during 2020 and are complicated by buying and selling. This technical problem is solved by the concept of Aggregated target trading data by period and Profit and loss level trading data.

### (Effect of Creation of Profit and Loss Level Trading Data of Aggregated Target Trading Data by Period)

As described in the process of creation by the information processing system, it is necessary to re-evaluate the Aggregated target trading data by period. This re-evaluation is the first step. If this change of evaluation is completed, the second step is to divide it into Unrealized profit and loss level trading data and trading Profit and loss level trading data. Of course, even the opposite order is acceptable. For each period, it may be easier to evaluate them by dividing them into the data of buying and selling at the level of profit and loss and the data of buying and selling at the level of loss. In this step, the Unrealized profit and loss level trading data requires a step of replacing the stock held at time A with the stock price at time A, and the trading Profit and loss level trading data requires a step of replacing the stock held at time A with the stock price at time A.

### (Effect of Creation of Profit and Loss Level Trading Data of Aggregated Target Trading Data by Period)

By this step, the Unrealized profit and loss in AB period will correctly indicate the trend of the Unrealized profit and loss in AB period, and the gains/losses in AB period will also be correctly indicated.

Unexpectedly, the lack of such a step in securities companies is a blind spot, and the more data it contains, the more complex it is, the less visible it is, and the more accurate the period profit or loss is. Needless to say, the third level and beyond.

### (Specific Example of Creation of Profit and Loss Level Trading Data of Aggregated Target Trading Data by Period)

For example, stocks held in early 2020 continued to rise in 2020, doubling. What is the contribution made by the period? If you think that the 2020 result is doubled, then you can't assess your profit or loss correctly. Results vary greatly depending on when they have been held, and the increase in 2020 is mixed with the past. This creates an inconsistent number. The correct answer is the stock price at the beginning of 2020 minus the sold stock price in 2020 for the 2020 results; at 2×, the past results are also mixed. Normally portfolios have a valuation trend, but the reason why the valuation trend is used when valuing portfolios by period is because otherwise it would not be presented correctly. Unrealized profit and loss and trading gains/losses require a step.

### (Significance of Calculation of Aggregated Target Trading Data by Period and Valuation Indicators by the Information Processing System)

This also involves the above. At the Overall profit and loss level, the measure is generated. Change in evaluation amount, an appraised value at time A, etc. refer to this. But what is the win rate? There are various movements in AB period between the Trading profit and loss level trading data and the Unrealized profit and loss level trading data. Looking at the example above, the Unrealized profit and loss level trading data is at time A, but between AB, the trading Profit and loss level trading data is obtained, and the profit/loss is determined. This is the moment when Unrealized profit and loss are converted into trading gains or losses. The complexity of the trading data is that there are many different types of data on how to calculate the win rate. Therefore, if the Aggregated target trading data by period is not correctly calculated, the Profit and loss level trading data is only known at the first level, and the valuation indicators is also only at the first level.

### (Effects of Aggregated Trading Data by Period and Calculation of Valuation Indicators Effects of)

All are interlocked. If any one of the creation of the Aggregated target trading data, the creation of the trading data below the second profit/loss level, and the calculation by the information processing system of the various valuation indicators is missing, the trading data enters the maze. In the information processing system, each step is consistently operated in cooperation. This is why automation is easy, and various data can be generated. In this step alone, the trading Profit and loss level trading data is created by the information processing system in coordination with the Aggregated target trading data by period, and the trading Profit and loss level trading data is coordinated to generate a Trading profit and loss level valuation indicators (such as a winning ratio).

### (Effects of Aggregated Trading Data by Period and Calculation of Valuation Indicators Effects of)

The very simple question of Mr. A's investment performance in 2020 cannot be answered that the system is consistent and unrelated. Then, when the data on the sale and purchase by component is included in this data, it becomes more complicated. Consistent and interlocking means that you can answer complex requests and create a variety of content.

### (Specific Examples of Calculation of Aggregated Target Trading Data by Period and Valuation Indicators)

For example, in the case of ranking the winning profit margin by issue in January 2020, the difficulty level increases with the addition of the limitation of January 2020, and it is very difficult to accurately specify what to do if the issue is actually held or if the issue is first sold in the middle of holding. There is a special effect that it is possible to display the ranking in a consistent manner only after the procedure of creating Aggregated target trading data by period, creating component trading data, and creating Profit and loss level trading data (in this case, the third level).

### (Definition of Aggregated Trading Data by Period and Evaluation Steps Definition of)

What do you think about evaluating the results of Mr. A's stock investment in January 2020? It is to evaluate the trading situation correctly, and to evaluate the holding situation. This also increases difficulty when the period of January 2020 is added. This is not easy to evaluate because the components involved in holding at the beginning of January, the trading situation during January, and the holding situation at the end of January.

(Issues with Conventional Technology)

The easiest way to assess what happened in January is to look at the Change in evaluation amount. If you know how many assets have been increasing, you'll feel like you've gotten to know. However, this does not lead to improvements. This is because we can't see why January didn't increase, and how February would increase more. This level is the Overall profit and loss level and the first level of the profit/loss level.

### (Effects of Aggregated Trading Data by Period and Evaluation Steps Effects of)

If there is no mechanism to take a deeper look at it, it will not be improved. In the information processing system, trading data is created by the information processing system in the Aggregated target trading data by period, component-specific trading data, and Profit and loss level trading data from the second and subsequent levels, valuation indicators is calculated by the trading data, a KPI suitable for the present user is derived by further selecting the step, and the improvement proposal and evaluation are performed by these KPI, so that the evaluation based on the consistent rule can be performed on the same objective number even if anyone does.

### (Aggregated Target Trading Data by Period and Evaluation Step Effects)

Based on KPI for the users in January 2020, the evaluation of the holding status is decided, and the Evaluation of trading status is decided, so it can be expected that an unprecedented effect can be expected.

### (And Comparative Steps of Aggregated Trading Data by Period)

How can I compare Mr. A's 2020 and 2019 investment results? Prepare the trading data for Mr. A's aggregate, and prepare the trading data for each component by dividing the fiscal year into 2020 and 2019. At this time, if you do not instruct the computer to define the 2020 and 2019 definitions in the trading data, it will not be properly separated. Here, the same procedure as that of the Aggregated target trading data by period is required. A point in early 2019, B in late 2019, and a point in late 2020 are required, so if you do not use a consistent rule, you will not be able to derive it accurately. The rules for FY2019 and the rules for FY2020 are determined in accordance with the rules for aggregated target trading data by period. Through this process, the valuation indicators are calculated by the information processing systems concerned, and KPI are determined, so that appropriate comparisons can be made. The comparison of A issues with 2019 and 2020 and the comparison of day trading type are all the same. In the information generation system, various contents can be generated by an instruction to a computer that is consistent with all of these requests. For problems, actions, effects, and the like, refer to the evaluation step and the comparison step described above because they are similar.

### (And Ranking Steps of Aggregated Trading Data by Period)

The same applies to the ranking step. This step is the same procedure as the comparative step until KPI is selected, and is ranked based on KPI. For example, it is possible to rank Mr. A's investment results annually and determine which year was the best or worst in the annual ranking from 2010. This is the content that can be generated only after the steps of each step, component-specific step, and KPI are properly performed, but the generated content (such as the annual investment-ranking) itself is also defined as the content that has been subjected to the process. See the above evaluation and ranking steps for issues, actions, effects, etc.

(And Diagnostic Steps with Aggregated Trading Data by Period)

The same applies to the diagnostic step. It is also possible to look at past histories while dividing the results by period. This is derived on the basis of the aggregated target trading data by period. The evaluation step and the diagnosis step are the same as those described above for problems, refers to, effects, and the like.

### (Specific Examples of Trading Data by Component (by Technical Indicator) of Trading Data Subject to Aggregate by Period)

This refers to the categorization and aggregate of trading data subject to aggregation by period according to the technical indicators that are constituent elements. It can be used to examine what the technical indicators that were high in Mr. A's investment performance in 2020 were.

### (Definition of Aggregated Target Trading Data by Investor)

For example, if the aggregation target is an investor, the information generation unit 3021 aggregates the trading data for each investor type such as an individual investor group, an institutional investor group, an individual investor A, an institutional investor B, an investor type group focused on short-term trading, or an investor type group in a medium-to-long-term holding investor type group. In addition, valuation indicators of Aggregated target trading data for the entire investor is calculated and evaluated by the information processing system, and a group classified by the valuation indicators is defined as Aggregated target trading data by investor in the trading data evaluation classification. In short, we define the data as the aggregated trading data by investor, which is defined as the trading data evaluated by the investor, then reclassified and grouped together.

### (Relationship of Aggregated Target Trading Data by Investor to the Old Method)

The trading data according to the first embodiment does not include the item “investor”. In practice, however, there are a variety of extraction methods, such as investor groups and investment types, including investors B and C.

### (Problems of Aggregated Target Trading Data by Investor)

By dividing the trading data into individual investors, trading data can be created for each investor. The trading data by investor shows the profitability, winning rate, and unrealized profit by investor, group, and type of investment.

### (Effects of Aggregated Target Trading Data by Investor)

The trading data obtained by extracting the trading data by the investor is defined as Aggregated target trading data by investor. Specifically, the information generation unit 3021 adds the identification information of the investor to the item of the trading data according to the first embodiment, adds the item identifying the investor or the investment group, the institutional investor or the individual investor, the investment type A or B in another table, and matches the items. As a result, it is possible to generate Aggregated target trading data by investor from various perspectives. This example is an example and includes any method used to classify and aggregate investors on some datum.

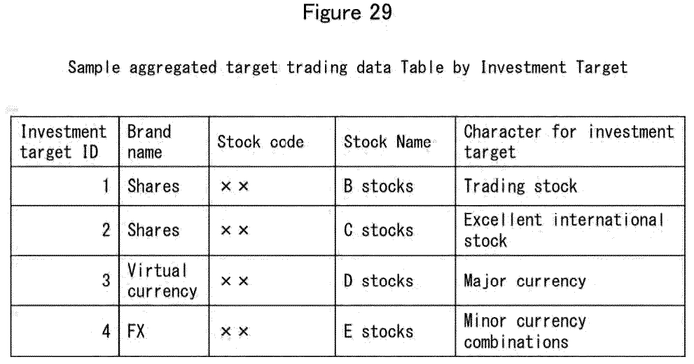

FIG. 28 and FIG. 29 are diagrams illustrating an example of a separate table of the Aggregated target trading data by investor and the Aggregated Target Trading Data by Investment Target according to the present embodiment. As shown in FIG. 29, for example, the information generation unit 3021 creates a table that displays the characteristics of each investor, such as Mr. Tanaka's dividend yield-oriented type (investment type 1) and Mr. Nakamura's short-term margin-oriented type (investment type 2) as individual investors, and makes them cooperate with each other in a database.

As a result, it is possible to derive the summary of the short-term margin type investor group (tabulated in investment type 2), and it is possible to clarify the difference in trading and the difference in profit and loss between the short-term margin type group (tabulated in investment type 2) and the dividend yield-oriented type (tabulated in investment type 1).

Such information is also valuable as an article for the media. Short-term Saya-article type versus dividend yield-based type, which won in 2020, stockholder result type versus dividend yield-based type, and differences in performance can be easily created. This is a special effect in which the investor table and the Aggregated target trading data by investor are linked by the separate table. It is possible to have such an item in the item of the trading data instead of the separate table, but it is difficult to manage it and is not recommended. However, the types included in these items are also a type of trading data for individual investors. All methods of incorporating, recounting, extracting, and classifying the attributes of the investor into the database are included in the trading data for individual investors.

It should be noted that the classification of investment types mentioned in the diagnosis by investment type may be applied here.

### (Effect of Aggregated Target Trading Data by Investor)

The effect is that each investor, each group of investors, and each type of investment really makes money, loses money, has a profit margin, and what happens this year. This is exactly the kind of information that is suitable for article distribution. The information that can be generated by the information processing system is thus diverse and can be used in various ways. In addition, by dividing investors into groups of investors and aggregating them, there is a remarkable effect that is not found in the old method, in which the difference between individual investors and institutional investors and the difference in their holdings can be found.

### (Specific Examples of Aggregated Target Trading Data by Investor)

The Aggregated target trading data by investor is also useful for the compilation of 2019 and 2020 article data for all investors, and for the compilation of article data for stock investors and virtual currency investors. These are also generated data suitable for article distribution.

The Aggregated target trading data by investor can be categorized by simply increasing the number of categories such as age and gender, such as investors emphasizing shareholder benefits, investors emphasizing dividends, foreign investors, female investors, and investors aged 65 or older. Many people are interested in such topics as people living in Tokyo, people living in rural areas, salaryman investors, OL investors, and retired investors. If this Aggregated target trading data by investor, the results can be divided into categories, and the articles about the differences between salaryman investors and retired investors and the results attract attention. It is the information processing system concerned that the verification is possible, and the creation of the Aggregated target trading data is the first step in the target.

### (Definition of Trading Data Subject to Aggregated Target Trading Data by Investor Evaluation Classification)

As mentioned above, after evaluating the trading data of investors, the trading data is classified again and grouped, and the grouping is defined as Aggregated target trading data by investor in the trading data evaluation classification.

(Issues with Conventional Technology)

There is the concept of a copy trade that mimics a good investor. Although somewhat similar, copy trades refer to positions held by other personal traders who automatically copy and hold FX positions held in real time. It is a matter of course in FX. This service is based on the concept that if there is a good person, it can be used as a reference. However, the trading data for individual investors in the trading data evaluation classification can be generated based on the index which comes out from the actual trading data in the various investor groups in order to easily classify the people who have made various trading transactions.

### (Action of Trading Data Subject to Aggregated Target Trading Data by Investor Evaluation Classification)

As a preparation procedure, first, the information processing system creates Aggregated target trading data for the entire investor, and if possible, creates a profit/loss level up to the fourth level, and calculates various valuation indicators by the information processing system. This is the first time you are ready. Suppose that we create a group with the top 10 overall profit-loss ratios. valuation indicators=overall profit-and-loss ratio, the trading data is rearranged in order of total profit-and-loss ratio, and the top ten is defined as the top ten members of the total profit-and-loss ratio. Of course, as it will be updated as needed, it will be accumulated if it is linked with the date and stored in the top 10 member table of the overall profit-loss ratio. Only the trading data of the target member is extracted, which is defined as Aggregated target trading data by investor in the trading data evaluation classification of the relevant member. This member is defined as the top 10 members of the trading data evaluation classification.

### (Effects of Aggregated Target Trading Data by Investor Evaluation Classification)

Various groups can be created by the above-described processing. This effect is enormous. This is because if the target member can be selected depending on what investor you want to be and what type of trading you want, you can use the trading performed by the member as your reference. In particular, it becomes possible to derive, from past histories, the probability that a target member will have a high probability when determining the holding status of a stock in an evaluation step or the like. It can also be used in the trading situation judgment, and in the comparison step, it is possible to give various awareness only by comparing with the evaluation value of the group.

### (Specific Examples of Aggregated Target Trading Data by Investor in Trading Data Evaluation Classification)

In addition to the above, in the diagnostic step, it is also possible to teach what is different from the tendency that is known from the various trading data of the relevant group and the tendency of Mr. A. Various service developments that meet the needs of users are conceivable.

### (Definition of Aggregated Target Trading Data by Investor by Time-Series)

As a kind of Aggregated target trading data by investor, the cooperation between the trading data of the database related diagram (see FIG. 91), the stock price data, and the stock price news can incorporate the brand news at the time of purchase into the database of the trading data by making the purchase date (or the purchase date and time) of the trading data, the brand code, and the table of the brand news with the date (or the date and time) and the brand code (see, for example, FIG. 91). This tells you what the issues that were purchased on the day they were news were sold and how profitable they were when they were sold. This is defined as the Aggregated target trading data by investor by Time-Series. The characteristic is the type of trading data including the stock price data, the technical index value, the stock news, and the like in which the relationship (for example, refer to FIG. 91) is made between the purchase data of the trading data, the sale data, the date (or the date and time), and the stock code. The trading data for time-series investments is based on investments. However, this data is centered on investors and aims to strengthen advice for investors.

(Issues with Conventional Methods)

Stock price searches, chart displays, and stock news searches are common everywhere. Various effects can be expected by linking these pieces of information with trading data.

### (Effects of Aggregated Target Trading Data by Investor by Time-Series)

In the database related diagram (see FIG. 91), the trading data associating the trading data with data such as brand news, stock prices, and technical index values exerts various effects in a subsequent process. In other words, this association is maintained even in the Profit and loss level trading data, so that not only the transition of the technical index value from the time of purchase, the transition of the issue news, and the like follow in time series, but also the relationship between the valuation indicators and the calculation by the information processing system is followed in time series. If the stock price rises, the value of the index rises, and the value of the technical index becomes overheated, it will be possible to communicate the current value of the technical index, the profit or loss from the sale of the product, and the change of the other index value.

### Effects of Aggregated Target Trading Data by Investor by Time-Series

By linking trading data with stock prices, charts, issue news, and the like, which can be generally managed in time series, the above-mentioned unprecedented effects can be demonstrated, and the generation of advice, generation of diagnosis, and quality of information provision to users can be increased as much as compared with the past, and the effects can be expected that the daily updating of the ranking display can be made easier.

### (Specific Examples of Aggregated Target Trading Data by Investor by Time-Series)

As mentioned earlier, it can be expected to have the special effect of being able to associate stock trading data with stock news, with technical indicators, or with corporate performance trends. In addition, if the information of the issue is combined with the Unrealized profit and loss level trading data, various effects can be expected, such as news of the brand held, technical index of the brand held, signing at the time of selling, signing of the purchase again, quick receipt of the presentation of the division, daily updating of the ranking, updating of the comparison result, time series display of the diagnosis result, history display of the diagnosis. It is a service that can contribute to the improvement of services to investors at various angles. It contributes to the evaluation step (which can be used to judge the retention period), the ranking step (ranking according to the holding period), the comparison step (comparison with the average value after purchase, etc.), the diagnosis step (stock holding diagnosis regarding the holding period after purchase, etc.), and the advice step (proposal of what to do based on these results).

### (Definition of Aggregated Target Trading Data by Investor at the Time of Trading)

The time of purchase or sale is an important time when the trading data changes. Information at that point is very valuable. Nevertheless, the information at this time is usually buried over time, and it is normal to continue holding without consciousness, and at some time, to contain and lose, or leave it without being aware of changes in the situation. Aggregated trading data are created to manage information at the time of trading, which is the point of importance.

(Issues with Conventional Methods)

In general, issues, technical indicators, and daily market news are numerous, and it is not easy to manage the information that is necessary for themselves. There are many pieces of information that you don't need to buy or sell, and you can't distinguish between what you need and what you don't.

### (Action of Aggregated Target Trading Data by Investor at the Time of Trading)

Point-of-sale trading data is used to link purchase data and sale data with brand news, technical index values, performance information, and the like.

Information on the investment target at the time of purchase or sell is information related to trading decisions, and the importance is much higher than the date of no trading. The following effects can be expected by combining the date of the purchase table, the issue code, and information related to the investment target, such as technical index values and news information for the date.

### Effects of Aggregated Target Trading Data by Investor at the Time of Trading

By linking the performance from the time of purchase with the judgment at the time of purchase, it will be useful to verify whether the judgment at the time of purchase was correct later, and to verify the judgment at the time of sale. At the same time, it will be possible to judge that the result has not been achieved because the judgment is made incorrectly in the same place. This trading data can be expected to have a remarkable effect that gives investors an unprecedented sense of the trading data.

### (Specific Examples of Aggregated Target Trading Data by Investor at the Time of Trading)

In addition to the examples described above, the combination of performance at the time, forecasts of performance at the meeting at that time, rating information, etc. can be useful for various verification, and it is easy to establish rules, successfully find patterns, and discover the causes of failures and the causes of success.

### (Definition of Aggregated Target Trading Data by Investor by Event Management Investor)

Although the above-described time-series investment target trading data connects the time-series data with the trading data, the event management target trading data is not a time-series data, but is a data linking information related to an event-type investment target that occurs irregularly on a specific or unspecified day with the trading data.

(Issues with Conventional Methods)

Investment-related information is diverse, but the information necessary for the investment itself is buried and cannot be distinguished. Usually, the most important information for an investor is information about the issues that are purchased. Many investors are obviously concerned about this information, but everyone has experienced noticing it for the first time in the course of the time without missing or knowing what is important, as there are still plenty of news. Event management investment target trading data solves such a problem.

### (Action of Aggregated Target Trading Data by Investor by Event Management Investor)

For example, if you buy A shares on August 1, and the stock continues to hold, it becomes a supervisory stock in the Unrealized profit and loss level trading data. Event information of the brand associated with the brand code (there are various events such as rights information such as dividends and stock splits and shareholder benefit information) may be notified before the event occurs or may be notified later, but a mechanism provided to the user by some method such as e-mail or display can be created by having the Aggregated Target Trading Data by Investment Target by Event Management. Until now, important information that has to be managed by itself is automated.

### Effects of Aggregated Target Trading Data by Investor by Event Management Investor

In addition to informing the occurrence of an event, it is possible to know the change after the occurrence of the event, and to provide information that contributes to the determination of the sale. For example, shareholder gifts can be entitled today, and unforeseen events can occur in the investments in which they are held, telling them how they are making their decisions. Although these may be possible even in a method that does not use the aggregated trading data for each event management investment target, the content generated by such a method including such a method is defined as the aggregated trading data content for each event management investment target.

### (Specific Examples of Aggregated Target Trading Data by Investor by Event Management Investor)

There are a number of events that should be managed, such as increased dividends, announcements of dividends, newspaper news, and a sharp increase in the number of Twitter deals. Since it is sufficient to manage only the investment targets owned by itself, there are few checks, and it can be said that the effect is large.

It is a service that can contribute to the improvement of services to investors at various angles. Evaluation steps (one of which can be used to judge the status of possession, and which can be used to judge the status of possession, can be issued at the time of an event in which an upward revision occurred, such as the subsequent winning rate of the issue for which an upward revision was announced), ranking steps (the ranking of the rate of decline in one month after the event in which an increase in profit was announced, etc. can also be made easily), comparison steps (it is possible to compare the results depending on the information revision range in the upward revision event), diagnosis steps (it is possible to make a diagnosis based on the results after the occurrence of the event), and advice steps (proposals on what to do based on these results).

### (Definition of Aggregated Target Trading Data by Investor by Financial Trends and Investors)

The key to achieving the benefits of stock investments is to update the company's earnings trends and capture changes. By linking the trading data with the performance of the issues held, we can quickly capture the changes in the performance of the stocks held.

### (Problems of Aggregated Target Trading Data by Investor by Performance Trend Investors)

In the conventional method, not only the stockholdings but also various information related to the performance are published every day. However, it contains a lot of information that is not necessary for itself. What is most important is the performance trend of the issues held.

### Performance Trends: Effects of Aggregated Target Trading Data by Investor

It isn't hard to grasp the performance of the issues they hold. EDINET is updated every day, and there are many ways to grasp its performance trends in real time. However, when the information processing system is connected to the trading data, a special effect is exerted. For example, by linking the Unrealized profit and loss level trading data with the holdings, the performance data is associated with the holdings. Figures such as past performance trends and future company forecasts are also related. As time passes since the time of purchase, it is difficult to manage a large number of trends related to earnings, such as announcements of revisions to earnings, announcements of earnings results, revisions to forecast figures, and so on.

### Effects of Aggregated Target Trading Data by Investment Target by Financial Results Trend

However, by using this system and Aggregated target trading data by investor's performance trends, for example, the revision of the results of A stocks purchased on August 1 (buy price: 800 yen) was revised upward on August 26 (stock price: 810 yen), and on September 5, the revision was announced and the results were announced at the same time, resulting in good results (stock price: 950 yen). Then, in the case where the profit was finally sold on October 30 and finalized at 1300 yen, it is possible to display on a chart at the time of each announcement, to inform that unrealized profit is increasing, and to immediately confirm how much the difference from the actual value of the performance has increased. In addition, in order to examine later, the stock price trend after the announcement of the upward revision can be checked at a glance, and it can be used as a material for making investment decisions, such as how much the effect on profits differs depending on the magnitude of the upward revision, how much it is better to sell from the announcement, or whether it is better to continue holding. These will enable the provision of unprecedented information.

This is a service that can contribute to the improvement of services to investors at various angles. Evaluation step (can be used to evaluate the status of holdings, and can list the performance trends and subsequent time-series data of the stocks held, as well as instantly capture and display how much the results differ depending on the range of gains or revisions. Evaluation step (can be used to evaluate the status of stock holdings, and then time series data can be displayed in a list. It is also possible to display the result immediately by incorporating the difference between the profit increase and the revised range. For example, if there is an announcement that deviates from the 30% forecast, it will be possible to inform the price movement in 10 days at the time of such announcement) Ranking step (for example, it is considered that there are various items such as the trading profit ratio ranking of the issues that have been revised upward), Comparative step (for example, it is possible to compare the actual trading win ratio of the stocks with the active stocks), Diagnostic step (based on the results after the performance announcement) Contribute to everything, including diagnosis and advice steps (suggestions on what to do based on these results).

### (Significance of Calculation of Aggregated Target Trading Data by Investor and Valuation Indicators by Information Processing System)

After the creation of the Aggregated target trading data by investor, the relationship between the Aggregated target trading data by investor and the Profit and loss level trading data is discussed, with the creation step of the Aggregated target trading data by investor being separate from the creation step of the trading data to be traded at the profit/loss level (there are omissible steps, and in any order). The definition of whether or not investor A's profit/loss is viewed at the Overall profit and loss level, whether or not it is viewed at the buying/selling profit/loss level, whether or not it is viewed at the Unrealized profit and loss level, and at what level it is viewed is the creation of Profit and loss level trading data. When measuring the investment performance of investor A as a whole, if it is measured at the Overall profit and loss level, the Change in evaluation amount is appropriate. The change in valuation is a typical example. The next level is the second-level Trading profit and loss level trading data and the unrealized Profit and loss level trading data. The trading data is divided into trading data and Unreversed trading data, and the trading data of investor A is generated, and the valuation indicators is calculated. An effective and usable valuation indicators can be calculated gradually, such as a winning ratio and a Winning profit margin.

(Issues with Conventional Technology)

In the first embodiment, the basic numerical value (basic data) is acquired from the acquired trading data for investment commodity, the valuation indicators relating to the trading profit and loss and the unrealized profit and loss is calculated from the acquired basic numerical value, the valuation indicators relating to the overall profit and loss is acquired from the calculated valuation indicators, and the information indicating the acquired valuation indicators is generated. The problem of the existing technology is that it is difficult to satisfy various demands because it is based on a calculation formula. For example, Mr. A's win rate in 2020, which brand made the highest contribution, and which brand made it difficult to meet a variety of demands. Further, in the first embodiment, since the valuation indicators is calculated from the trading data (trading data in a narrow sense), the number of valuation indicators that can be obtained is small, and there is a problem that the valuation indicators cannot be calculated only in a fixed manner.

### (Effects of Calculation of Aggregated Target Trading Data by Investor and Valuation Indicators)

On the other hand, in the fourth embodiment, the cooperation of the database is taken as an eye, and by performing the setting of various conditions in the second step to the fourth step, it is possible to change the shape of the trading data to be worked according to the purpose. In the above example, by setting the period to 2020 or by making the constituent components into issues, the trading data can be easily changed to suit the purpose, and the process of calculating the valuation indicators for the trading data that has changed according to the purpose is performed. Therefore, the valuation indicators that matches the purpose can be easily derived from the information system. Furthermore, as a result of incorporating not only trading data but also market data, problem data, and any other information related to investment profit and loss, the range of valuation indicators that can be calculated by the information processing system has widened rapidly, and it has become possible to look at targets from various angles. This is also the result of database collaboration, and this consistent collaboration system overcomes the aforementioned problems.

### (Effects of Calculation of Aggregated Target Trading Data by Investor and Valuation Indicators)

As described above, Embodiment 4 is a technological innovation in which various objects (for example, a comparison between a silver generation investor and a salaryman investor) can be handled in various forms for the purpose of an investor, and in addition, information necessary for improving the profit and loss of the target (for example, a string of business performance information, technical information, and trading data) can be incorporated into the object in addition to the trading data, and calculate of the valuation indicators by the information processing system has a special effect of widening and deepening the depth.

### (Definition of Aggregated Target Trading Data by Investment Target by Financial Results Trend)

The investment targets that are the aggregation target include stocks such as S-Corp stocks, mutual funds, ETF bull funds, stocks such as FX yen-dollar, and virtual currency stocks. The company can also group its stocks into groupings, such as outstanding stocks, high-end stocks, and high-dividend stocks. It also includes upgraded stocks, China-related stocks, index mutual fund groups, and robotics fund groups. Furthermore, products, product groups, etc. may be One of be aggregated. For example, the information generation unit 3021 divides (extracts under the extraction condition), aggregates (aggregates under the classification criterion), or aggregates (aggregates under the aggregation condition) the trading data for each aggregation target such as a virtual currency, a FX, or a stock, and creates the Aggregated Target Trading Data by Investment Target. A plurality of pieces of aggregation target area trading data may be grouped together and extracted under extraction conditions. Further, price information, technical index values, and the like, which are one of the attributes of the investment target, are also included in the components of the Aggregated target Aggregated Target Trading Data by Investment Target.

(Relationship of Aggregated Target Trading Data by Investment Target with Prior Art)

The trading data according to the first embodiment includes an item representing an investment target called a brand code. In the first embodiment, it is also specified that the code is a code for specifying the issue of the stock to be traded. However, in the first embodiment, there is no extraction, classification, or aggregation for each investment target. In addition, in general, securities companies have information that conveys the status of stocks they hold, such as portfolio information. It also contains information on stocks and stock prices. This is Mr. A's information in the trading data for each investor. The Aggregated target Aggregated Target Trading Data by Investment Target is trading data extracted and tabulated based on the information on the issue A, and is completely separate. The former is a chart of A's stock, the latter is a chart of A's stock, and the average is where many people buy, sell on average, and buy at what price range. This is a service that can only be performed using of the latter Aggregated Target Trading Data by Investment Target.

This is because the former is based on the trading data captured under the condition of investor A, and the issues in the former are one of the constituent elements, and the trading information of Mr. A is not linked. On the other hand, if the Aggregated Target Trading Data by Investment Target is compiled using A as the extraction condition, it includes the trading of Mr. A and the trading data of the other Mr. B and Mr. C, so the usage is quite different.

(Issues with Conventional Technology)

By giving the conditions for the trading data as the investment object, it is possible to create the trading data for the aggregation by the investment object. Many pieces of information on investment targets are provided as brand information. This includes financial results, charts, stocks, and news. But there is only fragmentary information about how investors buy and sell the issues and how they make money. There is a problem in that the entire image is completely unknown and is wrapped in veil. Although S Ltd. shares are rising, there is no information in the world about the situation in which the owners of S Ltd. are, and how much profits the buyers and sellers made in 2020. However, according to the information processing system, the profitability, the winning rate, the unrealized profit, and the like for each issue and each product can be found by starting from the trading data to be counted for each investment target. By linking with stocks news and charts, more information is available. When this is done in the Aggregated Target Trading Data by Investment Target, a special effect is exerted. This is a form of Aggregated target Aggregated Target Trading Data by Investment Target, and is a form in which the purchase data, the sale data, and the investment target are linked. This is more important and more effective, so we will do it later.

### (Effects of Aggregated Target Trading Data by Investment Target)

The information generation unit 3021 uses the investment target table (or the like) to extract (in the extraction process under the extraction condition) or classify (different from the classification of the subsequent constituent elements) or to aggregate (calculate the sum or the average value, or the like) the above-described aggregation target Aggregated Target Trading Data by Investment Target as a reference, creates the aggregation target Aggregated Target Trading Data by Investment Target, calculates a Trading profit and loss level valuation indicators or an Unrealized profit and loss level valuation indicators from the aggregation target Aggregated Target Trading Data by Investment Target, and generates information on the evaluation of the trading situation or the holding situation for each investment target, or the like.

The Aggregated Target Trading Data by Investment Target is obtained by extracting (or classifying or counting) the Trading data by investment target. In the trading data according to the first embodiment, the brand code is taken as an example, but it is more effective to use the brand code as the investment target code. Further, as shown in FIG. 29, in another investment object table, various investment objects can be evaluated from various viewpoints by specifying a commodity category called stock, virtual currency, or ETF, a specific brand code, and a grouping.

By creating Aggregated Target Trading Data by Investment Target, it is possible to create stocks, virtual currencies, or articles that actually make money, such as either one. Indeed, it can be used as an article for the media. In order to be able to create such an article, it is necessary to create Aggregated target Aggregated Target Trading Data by Investment Target. Ordinary trading data are managed by each investor (Aggregated target trading data by investor). We have not been able to re-aggregate by investment target across the board. If the tabulation is revised on the scale of the investment object, a large effect can be expected in which new discoveries can be seen. In addition, as mentioned above, in the case where the investment target is managed separately in a separate table, and in the case where the item of the trading data is created, the trading data is included in the Aggregated Target Trading Data by Investment Target. When an article is created using trading data by dividing an investment object into some criteria, in most cases, creation of trading data subject to aggregation by investment object is necessary. However, even if this process is not included, trading data is used to separate investment objects, and the created content is defined as trading data content subject to aggregation by investment object.

### (Effects of Aggregated Target Trading Data by Investment Target)

You'll be able to see if you're really making money, if you're losing money, if you're profitable, if you're going to make money. For example, it has the special effect of being able to know the commonality of the trading situation of stocks classified as speculative stocks, the average of the Unrealized profit and loss ratio, the tendency of individual investors to buy and sell good stocks and virtual currencies, and how many people actually buy and sell shares in S company stock are held by the information processing system.

Normally, in order to create such content, it is not possible to create the Aggregated Target Trading Data by Investment Target, but the entire content creation method in which the trading data is re-captured is defined as the trading data content to be aggregated for each investment target, with the investment target as an axis. This is an example of the trading data tabulation result by brand.

### (Specific Examples of Aggregated Target Trading Data by Investment Target)

### Example 1

For example, the information processing system can easily calculate by Aggregated Target Trading Data by Investment Target the problem of whether or not a stock purchased after announcing an upward revision of its business performance (an upward revision of its business performance when it exceeds the company's forecast value) or a downward revision of its business performance (a downward revision of its business performance when it falls below the company's forecast value) will have a profit margin or winning rate for the subsequent trading of the stock.

Prepare a data table for the issue, the date and time of the upward revision, and the upward revision rate (calculated by the information processing system based on the actual value of operating profit/forecast value of operating profit, etc.). This table and the trading data are linked by the brand (brand code) and the date (date of purchase or sale), so that the brand is linked with the date and time of improvement in performance (downward correction date in the case of downward correction) and the upward correction rate (downward correction rate).

Since the date and time of the upward revision and the purchase date and the upward revision rate are included in this Aggregated Target Trading Data by Investment Target, when the trading profit and loss data is created from the Trading data by investment target created under the extraction condition of the upward revision rate of 20% or more for one day (data purchased in one day after the upward revision), and the valuation indicators is the winning rate and the trading profit and loss rate, the winning rate and the trading profit and loss rate in the case where the brand with the upward revision of 20% or more is purchased on the first day are calculated by the information processing system.

In this way, the Aggregated Target Trading Data by Investment Target is referred to as Aggregated Target Trading Data by Investment Target, for example, by extracting investment targets (upwardly revised issues in this case) under some conditions.

### Specific Example 2

For example, if only the 10th-ranked stocks with a high upward revision rate are extracted and tabulated, it is possible to generate trading data for the top-ranked stocks with a high upward revision rate by investment target.

When the Trading profit and loss level trading data of the trading data subject to investment calculation is created (even if the Trading profit and loss level trading data can be held in the previous process), and the elapsed days of the purchasing date and the business performance upgraded date and time for each purchase data are created for one day, and the trading profit rate and the winning rate of the purchase data are totaled, the winning rate, the trading profit rate, and the unrealized profit rate when the trading profit rate are purchased on the first day after the upwardly revised 10th issue can be displayed. All of these are calculated in the database, which is the effect of the creation of Aggregated Target Trading Data by Investment Target.

When the transaction data to be counted for each investment target is created, the transaction data can be linked with various data of the investment target in this way, and the actual purchase data and the transaction data can be easily linked with the market data, the performance data, the technical index data, and the like of the investment target, and there is a special effect that the creation of a rule with a high probability of verification and success is facilitated.

### Example 3

In the case of linking with the above-described upward correction table, at least the purchase date, the purchase stock price, the purchase quantity, the date and time of the upward correction of the performance, and the upward correction rate are linked to the information of the purchase data of the issue at this time.

When the number of days elapsed from the date of purchase and the date and time of upgrading of the business performance for each purchase data is calculated by the information processing system and set to one of the database items, it is possible to create the component sales data tabulated for each number of days elapsed since the upgrading. In this way, it is possible to compare the trading data in the case of one day from the upward revision with the trading data purchased after 10 to 20 days, and to know how the winning ratio and the trading profit ratio are different. These are also calculated by the information processing system in the database. When the trading profit/loss ratio ranking is obtained by creating trading profit/loss data of the trading data and using the trading profit/loss ratio as valuation indicators, the purchase data are displayed in the order of the number of days in which the trading profit ratio is high.

As described above, the more complex processes are included in the trading data to be counted for each investment target, the more difficult it becomes to understand that the process is first sandwiched, but the process that is essential for the method of utilizing the trading data with the investment target as the starting point is the trading data to be counted for each investment target.

### Example 4

For example, it is possible to compare the Trading data by investment target of the stock (created under the extraction condition of the stock) and the trading data of the virtual currency by the investment object (created under the extraction condition of the investment object=the virtual currency) with the trading profit/loss ratio and the winning ratio in the Trading profit and loss level trading data.

### Example 5

If the trading profit-and-loss rate is used as valuation indicators in the Trading data by investment target of the stock (created under the extraction condition of the investment object=stock) and the trading profit-and-loss level trading data for each component of the stock (trading data obtained by classifying the Trading data by investment target of the stock for each issue)(it is possible to have the trading data for each previous process) and the trading profit-and-loss rate is used as valuation indicators in the trading data obtained by extracting the Trading data by investment target of the stock for each brand, the trading profit-and-loss rate for each brand is calculated by the information processing system.

This year, S shares were the best, T shares were the 50th, and so on. Such generated data can be considered article data suitable for mass media.

### Example 6

In 2019 and 2020, the most profitable brand can be used for data on stories and other articles by Aggregated Target Trading Data by Investment Target. It is also useful to prepare data on buying and selling by investor in order to compile data on issues that are currently lost by Aggregated trading data by investor.

It is very difficult to create these articles without following the step of creating trading data for individual investment targets, but it is not entirely possible to deny the creation of these articles. The principal that produces such content is defined as Aggregated Target Trading Data by Investment Target.

In addition, various articles for not only individuals but also the media and the public can be created, which is one of the characteristics of the information on the trading data for the aggregation by investment target linked with the data for the investment target.

Ordinary trading data is tabulated for each investor, and it is also a major feature of the tabulated trading data for each investor that a completely different point of view can be seen when the investor is taken as an axis. For example, the trading of S Ltd. shares yields information that has not emerged in the past, such as how much trading profit is on average, how much Unrealized profit are currently held, and how much the average unit price of the shares currently held is. One of the processes for creating these contents is the Aggregated Target Trading Data by Investment Target.

As mentioned earlier, it can be expected to have the special effect of being able to associate stock trading data with stock news, with technical indicators, or with corporate performance trends. It is often tied to the buying and selling data of investors, but it can be seen from a completely different point of view from the past when the investment target is taken as an axis. In addition, it can be expected that in the trading data to be compiled for each investment target, the average purchase price range of the issue can be known, and the price range in which many buyers are able to be known. This information is useful to investors, but it is not available in any way. The more buying and selling data is accumulated, the more unlimited the buying and selling data is likely to be, and the more spread the buying and selling data is created for each investment target.

### (Definition of Aggregated Target Trading Data by Investment Target by Time-Series)

A form of the Aggregated Target Trading Data by Investment Target is the time-series version.

(Issues with Conventional Methods)

Common chart information is formed by stock prices and time series, and it is stock news and technical indicators that appear on the screen of investors. On the other hand, in the case of Aggregated Target Trading Data by Investment Target, we can see how investors are buying and selling A issues, with A stocks as the axis. Stock A buys at a high level of technical indicators on average, sells at a low level of technical indicators, and books a lot of trading losses. As you can see from the reverse, the number of items sold is increasing when the average purchase price is approached, with the number of unrealized losses on stock A being present. Since the number of owners still does not decrease, it is possible to make decisions such as to sell them, which is an excellent effect of the trading data to be compiled for each time-series investment target.

It is quite different from the previous ideas, so that investors can obtain information that they have never learned before.

### (Effects of Aggregated Target Trading Data by Investment Target by Time-Series)

Investment prices and charts are always found on the brokerage firm's site. However, there is no information about who buys A, where sells it, and whether it is losing profits on average. This can be easily done by creating the data based on the trading data to be compiled for each investment target. By displaying the investment target on a time-series chart or the like, and displaying the actual movements of the investor on the chart in time series, it is possible to create the trading data to be tabulated for each time-series investment target.

### (Effects of Aggregated Target Trading Data by Investment Target by Time-Series)

It was reported that a special effect would be produced if the investment target was recalculated from the viewpoint of the investment target. However, by combining time-series data such as charts, it is expected that the effects would be even greater as described above.

### (Definition of Aggregated Target Trading Data by Investment Target in Separate Table)

Among the Aggregated Target Trading Data by Investment Target, it is possible to capture various data of the investment object by associating information of the investment object managed in the separate table with the investment object (issue code, etc.). Such trading data is defined as Aggregated Target Trading Data by Investment Target in Separate Table. The above action item also says “Extract the above-mentioned trading data to be tabulated for each investment object using the investment object table, etc.” As this is an important matter, it is redefined as the Aggregated Target Trading Data by Investment Target in Separate Table. However, it is also natural that each investment target is tied to the purchase or sell of the investment target. Further, as shown in FIG. 29, in another investment object table, various investment objects can be evaluated from various viewpoints by specifying a commodity category called stock, virtual currency, or ETF, a specific brand code, and a grouping. This is a form of Aggregated Target Trading Data by Investment Target. A more detailed explanation will be given below.

The trading data having a table to be linked with the Aggregated Target Trading Data by Investment Target is defined as trading data to be counted for each separate table investment object, and the Aggregated Target Trading Data by Investment Target may be only the brand code, and the brand code and the purchase date may be associated with each other, and both may have different meanings. However, these are generically defined as Aggregated Target Trading Data by Investment Target in Separate Table. Usually, unless the technical index is associated with the purchase data, the content resulting from the two connections is not born, but such content is defined as the content created through the aggregate-by-table investment target trading data, and vice versa, the content creation method resulting from the two connections is defined as the Aggregated Target Trading Data by Investment Target in Separate Table.

### (Problems of Aggregated Target Trading Data by Investment Target in Separate Table)

Conventional transaction data managed by a securities company or the like is usually managed separately from the information to be invested. By managing the information in a separate table and associating the information with a brand code or the like, the information is associated with the sales data, and various problems can be solved. By linking with the purchase data, the sale data, and the sale data, various contents are generated, and various advice and investment problems can be solved.

### (Action of Aggregated Target Trading Data by Investment Target in Separate Table)

In the separate table, there are a case where there is a relationship with the issue information, and a case where there is a relationship with the brand information and the date (purchase date). In the latter case, the investment target is determined at the time of purchase, and the investment target is sold at the time of sale. However, the information on the investment target at both times is taken in from another table by the information processing system, so that the information on the investment target at the time of purchase and the information on the investment target at the time of sale are taken in the database, so that the effect on the trading profit and loss can be expected to be clarified. The information of the above-mentioned upwardly revised issue is also taken in, and the technical index is also taken in form of the trading data to be counted in the separate table, so that it is possible to take in the buying/selling judgment of the automatic trading tool and link the information of the investment target at the time of sale at the time of purchase to various kinds of information. This is described in the section of the Aggregated Target Trading Data by Investment Target, but in the case of the investment target, the importance of the trading data is further increased, so it is shown separately. The table relationship format further strengthens the various effects of the creation of Aggregated target trading data by investment target. Of course, other than the trading data to be counted by investment object, it can be defined as trading data to be counted by separate table, and can also be used in other trading data to be counted in the same way. For example, although each type of investment is also a form of Aggregated target trading data by investor, the table relationship format of Aggregated Target Trading Data by Investment Target greatly widens the possibility.

### (Effects of Aggregated Target Trading Data by Investment Target in Separate Table)

Items were added separately because the creation of trading data can be made more attractive. In the trading data for calculation by investment object, the other data is mainly linked to the investment object, and this can be expected to have a big effect, but in this separate table method, not only the issue but also the data for purchase and the data for sale are included, and the range is widened. It is possible to manage the purchase and sale of brands separately, in addition to the buy and sale data subject to the collection of investment items, to link it with the purchase information at the time of brand purchase. It is the aggregated Target Trading Data by Investment Target in Separate Table. This is because, in order to associate with information at the time of purchase, it is necessary to associate two items: a date and a stock. It is more complex than a stock-only association. Since it is difficult or impossible unless it is made into a separate table, it is defined as the aggregated Target Trading Data by Investment Target in Separate Table. The trading data of the investment object linked to the purchase data is defined as the aggregated Target Trading Data by Investment Target in Separate Table.

We also report how to use different investment types and investment targets tables, but we define them specially because they have a wide range of applications and are more effective. By type of investment, as described in the section on Investment Type, by incorporating information managed in separate tables into trading data, investors can also analyze different angles of investments, and investments can be viewed from different angles, such as by displaying the results of speculative stocks separately from the outcomes of good stocks, or by reclassifying or reclassifying the investments. Many news articles can be expected to emerge, and there are many discoveries and awareness that have not been made before.

### (Specific Examples of Aggregated Target Trading Data by Investment Target in Separate Table)

### Example 1

In addition to the above, for example, by associating a set of brands and dates, if a separate table that manages the issue and the date and the news of the brand on that date is included, the brand news can be included in the sales data. aggregated Target Trading Data by Investment Target in Separate Table is used to examine these as the basis of investment targets. As a result, there are various types of events (e.g., performance announcements, capital increases, announcements of installments, announcements of announcements, etc.), so the effect of incorporating these information into the trading data by investment target is unknown. Stocks purchased on the announcement date of the split can be easily verified as to whether they succeed or not.

### Specific Example 2

Referencing the table of technical index values for a stock makes it easier to capture and verify the accuracy of the decision. In the Aggregated Target Trading Data by Investment Target, the meaning of incorporating this data is very large. (This is also important and deep, and is difficult to understand, so it is presented separately.)

### Example 3

Indicators such as dividend yield and PER (Price Earnings Ratio) can also be linked to the date of purchasing and the issue, so they can be incorporated. It makes it easier to see how big the profit or loss between a high-dividend brand and a non-dividend brand is. It is only possible to do so because it is the Aggregated Target Trading Data by Investment Target. This kind of information has never been found in the world, and is of great value.

For example, it is possible to compare the winning rate of a stock with a high price expectation score and a stock with a low price expectation score. This is also the content that can be generated by the information system in the Aggregated Target Trading Data by Investment Target.

### Example 5

In 2020, we can also answer questions such as how different financial stocks, high-tech stocks, and trading margins were. This content can also be said to be generated because it is the Aggregated Target Trading Data by Investment Target.

As described above, the trading data subject to the aggregate of investment targets by table can be expected to have a special effect of making the analysis of trading data more broad and deeper, and thus was explained separately.

### Example 6

It is also useful to create data for individual table relationships in order to create article data in which it is possible to use data for individual table investments as well as data for individual articles such as competitors' stock competition and stocks that were most profitable. It is also useful to create data for individual table relationships for individual table investments. These contents are all trading data contents to be aggregated for each investment target, and are only contents that can be generated from the information processing system. It is only because it is a consistent information processing system that can be easily extracted.

### (Definition of Aggregated Target Trading Data by Investment Target at the Time of Trading)

The time of purchase and sell is the time of an important decision for the investor. When you buy A, other investors want to know what they are doing, what they buy a week ago, what they buy a month ago, and so on. Such information can be distributed in the Aggregated Target Trading Data by Investment Target at the time of trading. When we look at the behavior of each investor from the viewpoint of the investment object, we find that it is a completely different viewpoint.

(Issues with Conventional Methods)

The decision to buy or sell a stock is a self-judgment, and it is a serious matter. If you hear your opinions on a bulletin board, etc., you will be concerned about someone's advice and other people's actions.

### (Effects of Aggregated Target Trading Data by Investment Target at the Time of Trading)

By plotting the behavior of investors on a chart, you can see what they are buying and selling. Even in this case, contents from various viewpoints can be considered. When the trading data is compiled into component trading data by type of investment, the investment behavior of each type of investment before and after the time of purchase can be clarified.

### (Effects of Aggregated Target Trading Data by Investment Target at the Time of Trading)

For example, day traders buy and sell a considerable amount of stocks between 900 yen and 950 yen, but mid- to long-term holders buy them at such low prices and have already made such profits, and so on. One of the special effects of the data is that what was commonplace in the investor-by-investor aggregate trading data becomes fresh information because the cut-off point is greatly changed.

### (Specific Examples of Aggregated Target Trading Data by Investment Target at the Time of Trading)

Investors in Chinese stocks can see how they are doing, whether they are U.S. stocks, and so on, from a variety of perspectives.

### (Definition of Aggregated Target Trading Data by Investment Target by Event Management)

Although the above-described time-series-investment-target trading data connects time-series data and trading data on the basis of investment targets, the event management-target trading data is not a time-series data, but is a data linking information related to an event-type investment target that occurs irregularly on a specific or unspecified day with trading data.

(Issues with Conventional Methods)

Event management by investor is also important, but it is possible to display the timing and occurrence of the event on the A stock chart from the viewpoint of how the other investor acted and what the purchasers did.

### (Action of Aggregated Target Trading Data by Investment Target by Event Management)

Make based on trading data for each investment category. By linking the timing of the events to be invested and the details of the events, it is possible to grasp how the behavior of investors has changed.

### (Effects of Aggregated Target Trading Data by Investment Target by Event Management)

It can be expected to have a special effect that the actual situation that had been covered by veil can be seen, such as how the right to benefit shareholders is moving before and after the announcement of the stock split, what happens after the split, and so on.

### (Specific Examples of Aggregated Target Trading Data by Investment Target by Event Management)

There are a number of events, including dividend increases, announcements of dividend splits, news in newspapers, and a sharp increase in the number of Twitter deals. The effect of being able to see the behavior of other investors at the time of the event can be said to be very large content.

### (Definition of Aggregated Target Trading Data by Investment Target by Financial Results Trend)

The key to achieving the benefits of stock investments is to update the trends in corporate performance and capture changes. By linking trading data and corporate performance to each other around the investment target, it is possible to quickly understand how other investors behave when the stock's performance changes.

### (Performance Trends: Aggregated Target Trading Data by Investment Target by Financial Results Trend)

In the traditional approach, performance trends are available, but in fact, the behavior of others is covered by veils. In a few hours after the announcement, a large number of people went to buy it, and those who bought it became able to get information about what they did afterwards.

### (Action of Aggregated Target Trading Data by Investment Target by Financial Results Trend)

The issues always have information on performance trends. Even if information related to a stock is linked to trading data, it is necessary to collaborate on the basis of investment targets. Then, the investor's behavior is linked, and the investor's behavior from the performance announcement becomes known.

### Effects of Aggregated Target Trading Data by Investment Target by Financial Results Trend

Those who bought immediately after the announcement of the upward revision can now indicate whether they have unrealized losses, whether they have Unrealized profit, and how many people have bought or sold.

### (Definition of Aggregated Target Trading Data by Invested Commodity)

Investments include stocks, virtual currencies, FX, mutual funds, ETF, and retailers. These investment commodities are managed by the respective accounts, and are very difficult to compare across the banks. As far as Mr. A's business results are concerned, the investor as a whole does not know which investment commodity were good or the average of which investment commodity was high in 2020. The chart shows that in 2020 this investment commodity rose. It can be said that there is no information such as how the actual trade was, how many participants were, and how it was.

(Issues with Conventional Methods)

The brokerage firm should have such data, but it is one of the information that has not been used in the world before. However, it is very meaningful from a societal point of view that investors and non-investors can confirm the trading of those who have actually traded. The reason that the mass media has not been able to take up such data until now is that there is no such information processing system. In the information processing system, such information can also be provided.

### (Effects of Aggregated Target Trading Data by Investment Commodity)

In reality, what steps should we take to extract such information? The purchase data includes a stock code. This brand code is information associated with a product. The stock code XXXX is the stock code for S, while S is a class of investment commodities. On the other hand, the hypothetical currency is a ticker symbol, BTC is a bitcoin, and in the case of an investment trust, it is a stock code, an investment trust association code, or the like. These are all linked to investment commodities, which is why the information system can be easily compared by aggregating the Trading data by investment target of the stock and the Trading data by investment target of the virtual currency. This is a form of Aggregated Target Trading Data by Investment Target.

### (Effects of Aggregated Target Trading Data by Investment Commodity)

There is no time to look at investment commodities in detail. Looking at the big picture, we can see a broader view of whether investment trusts are good now or whether stocks are good now or not. Of course, comparisons with financial instruments such as government bonds are also possible. However, it can be said that the effect is bigger for variable products. Investment trusts also do not simply hold, but buy and sell. If the actual situation can be grasped, it can be said that the effect is very high. Rather, this information is information for the mass media, but the younger women have recently purchased investment trusts, but they can produce a variety of stories, including whether the actual results have been achieved. Such content is a content that cannot be generated by the information processing system unless it is generated from the Aggregated Target Trading Data by Investment Target product, but such content is defined as the transaction data content to be aggregated for each investment target product, including other methods.

### (Specific Examples of Aggregated Target Trading Data by Investment Target Product)

There is a number of perspectives, such as whether virtual money or stocks are highly successful, whether FX investments are actually made, and whether those who actually bought investment trusts are now, and the actual status of investment commodities that have not appeared in the past is revealed.

### (Definition of Aggregated Trading Data by Investment Target Group)

Investment commodities are divided into various groups. Among the stocks, Chinese stocks, U.S. stocks, and Japanese stocks can be classified by country, and investment trusts can be distributed monthly, open, and grouped in various ways. Among Japanese stocks, there may be a kind of stock such as a maker's stock group or a good stock group. These are all defined as Aggregated Target Trading Data by Investment Target group.

(Issues with Conventional Methods)

The current status of investment in these groupings is also a black box. Those who bought the underlying stock do not know what's going on, and what's going on for those who continue to hold the best stock. These have a large impact on the world.

### (Effects of Aggregated Trading Data by Investment Target Group)

It can be solved by creating an investment target table. By associating the brand code with the group, it is possible to calculate the aggregated data in the case of the information processing system. For example, it can be simplified by extracting the aggregate trading data of all investors by using the investment target group: Chinese stock and the investment target group: Japanese stock. It is important to associate stock codes with Japanese and Chinese stocks, which are usually on the market and are available to anyone. After that, if various data are generated by the information processing system, various interesting generated data are generated.

### (Effects of Aggregated Trading Data by Investment Target Group)

U.S. equity investors do not know at all what the index is going on, but what the people who are doing are now doing is what they are doing. If the reality of these investments becomes clear, people can become interested in investment commodities and contribute significantly to the imbalance between investment and savings compared with other countries. It is useful for investors, but it is possible to derive mass media-oriented content from the trading data to be tabulated by the investment target group, which can generate a lot of articles that are interested even by those who have not done the investment commodity. Such content is content that cannot be generated by the information processing system unless it is based on the Aggregated Target Trading Data by Investment Target group, but such content is defined as trading data content to be aggregated for each investment target group, including other methods.

### (Specific Examples of Aggregated Trading Data by Investment Target Group)

A variety of stories can be generated, including the actual status of the investor's investments, the ranking of the net Unrealized profit of the Speculative issue, and the actual status of the investor in the U.S. stock-group's representative FANG.

### (Content Name)

The content generated by the aggregation target trading data for each investment target is named as the aggregation target trading data generation content for each investment target. The content generated by the period-based aggregation target trading data is named as the period-based aggregation target trading data content. The trading data for each investor is named as trading data content for each investor. Similarly, if the content is given below each name (similarly, all of the ranking names and the like) of the Aggregated target trading data, the content is defined as a name representing the generated content. Content that cites these specific examples is synonymous even if the generation method is different.

### (Definition of Aggregated Target Trading Data by Investment Target by Purchase Date)

A type of Aggregated Target Trading Data by Investment Target. If the extraction condition is that the date of purchase is Sep. 1, 2020, for example, and the issue code=9984 (SoftBank Corp.), the trading data obtained by purchasing SoftBank shares on Sep. 1, 2020 will be collected. This is defined as the trading data subject to aggregation by investment target by purchase date.

(Issues with Conventional Technology)

Little is known about what the people buying SoftBank shares are doing now. At present, it is possible to only know the approximation by the trading price, the trading volume, the balance of the margin transaction, etc.

### (Effects of Aggregated Target Trading Data by Investment Target by Purchase Date)

The information processing system creates trading data under the above-described extraction conditions, creates Overall profit and loss level, and calculates the data from the trading data using the information processing system, so that, for example, if this execution is performed on the information processing system on Dec. 1, 2020, the action of the person who purchased the SoftBank stock on Sep. 1, 2020 appears in the valuation indicators so as to be taken by the person who purchased the SoftBank stock. You can see that some still hold and have Unrealized profit, some have bought and sold many times, some have failed, and some have succeeded.

### (Effects of Aggregated Target Trading Data by Investment Target by Purchase Date)

It is a technological innovation, and it is possible to communicate the trends of other investors with respect to stockholdings when evaluating the status of stockholdings, and it is also possible to display the ranking of the stockholdings as well as compare them with the best people. This effect provides a variety of effects. As an article, various cut-out articles can be generated.

### (Specific Examples of Aggregated Target Trading Data by Investment Target)

For example, just three months after the corona shock, what did the investor do? The information processing system can generate the necessary data for articles such as day trading.

### (Definition of Aggregated Target Trading Data by Investment Target by Investment Period)

If a type of Aggregated Target Trading Data by Investment Target is the extraction condition: Purchase Date, for example, Sep. 1, 2020, and the purchase date, for example, Dec. 1, 2020, and the issue code=9984 (SoftBank Corp.), the trading data obtained by purchasing SoftBank shares between Sep. 1, 2020 and Dec. 1, 2020 are collected. This is defined as the trading data subject to aggregation by investment target by purchase period.

(Issues with Conventional Technology)

The range is wider than by the purchase date described above, and by setting the purchase period to, for example, one month or one year, the subsequent investment behavior of the stocks purchased during that period is revealed. The so-called period-specific trading data clarifies the profit and loss of the period, but the period-specific trading data can be used to identify what the investor purchased during the period is doing after the purchase in order to clarify the investor's investment behavior.

### (Effects of Aggregated Target Trading Data by Investment Target by Investment Period)

By creating Aggregated Target Trading Data by Investment Target under the above-described extraction conditions, then creating Profit and loss level trading data, and calculating various valuation indicators by the information processing system, the subsequent actions of the investment target for each purchase period are clarified.

### (Effects of Aggregated Target Trading Data by Investment Target by Investment Period)

Changes in the trading tendency of the stock can be checked every three months, etc., or the investment target can be viewed from a viewpoint that has not been seen before. It can be viewed from a variety of perspectives, such as the percentage of people who continue to hold investments after three months, or the difference in investment performance over the holding period.

### (Specific Examples of Aggregated Target Trading Data by Investment Target by Investment Period)

For example, the information processing system can generate data necessary for articles such as how the behavior of investors has changed before and after the corona shock.

### (Definition of Trading Data by Component of Aggregated Target Trading Data by Investment Target

The Aggregated Target Trading Data by Investment Target is trading data to be extracted, classified, and aggregated based on the investment target, but the Aggregated Target Trading Data by Investment Target includes constituent elements that constitute the trading data. All data affecting the investment profit and loss of the investment target such as the issue, the product name, the purchase date, the purchase price, the sale price, and the like of the investment target, brand information such as corporate information and business performance, market data such as stock price and technical index value, and rights data such as dividends and splits are defined as constituent elements, and the sale data by constituent elements of the trading data of the trading target data by which the extraction, classify, aggregation (any one or a plurality of may be used) has been re-extracted, classified, and tabulated by these constituent elements is defined as the constituent element-by-element sale data of the Aggregated Target Trading Data by Investment Target.

(Issues with Conventional Technology)

By extracting, classifying, and trading data can be created for each investment target. However, if, for example, trading data is extracted on the condition that the purchase time is September 10 and the “investment target: stock was purchased”, trading data invested in the stock can be created on September 10. This makes the September 10 stock outcomes clear at a glance, and clarifies how many people have traded and what they have done. Even this is the information that has not emerged in the world.

### (Effects of Trading Data by Component of Aggregated Target Trading Data by Investment Target)

By taking this step and classifying them by brand, it is possible to create information such as which brand is winning and which brand is winning. By extracting, classifying, and tabulating the trading data with various conditions and then extracting, classifying, and tabulating the issues and other constituent elements that are the constituent elements, the constituent-specific trading data of the trading data to be tabulated for each investment target is created by the information processing system.

### (Effects of Trading Data by Component of Aggregated Target Trading Data by Investment Target)

A variety of valuation indicators can be calculated by the information processing system by creating the component-specific sales data of the calculation target sales data for each investment target by the information processing system. In the previous example, the information processing system calculates the breakdown of stocks purchased on September 10, revealing trading behavior, holding behavior, etc. valuation indicators calculated from this data set can be used for evaluation, diagnosis, advice, compare, and ranking. For example, when the subsequent trends of the issues purchased in September are reviewed six months later, reports and articles of various trends can also be prepared by the information processing system, and they can be stored in time series.

### (Specific Examples of Trading Data by Component of Aggregated Target Trading Data by Investment Target)

### Example 1

FIG. 103 to FIG. 106 describe in detail the evaluation of trading data by component of Aggregated Target Trading Data by Investment Target. This is also a form of invention in which many findings and knowledge can be given to investors by the information processing system.

### Specific Example 2

### (Compare of Trading Data by Component of Aggregated Target Trading Data by Investment Target)

An example of a comparison of trading data by Component of Aggregated Target Trading Data by Investment Target is the average rate of increase in the number of stocks purchased on September 10 and the rate of increase in the number of stocks purchased on September 10 by investor A. ˜This is an example when comparing (investment target) with valuation indicators (calculated under the applicable conditions) for each of (constituent elements). One specific example is to compare A issues by total profit/loss ratio for each investor, and to compare stocks by trading profit/loss ratio and winning ratio for each stock.

### Example 3

### (Ranking by Trading Data by Component of Aggregated Target Trading Data by Investment Target)

Examples of the ranking of the trading data by Component of Aggregated Target Trading Data by Investment Target are the ranking of the stocks purchased on September 10 and the ranking of the trading profit/loss ratio of the stocks purchased on September 10. ˜One specific example is the ranking of the valuation indicators (calculated under the relevant conditions) in (a) to (a component of) of (an investment target), the ranking of A issues by the winning rate for each investor, and the ranking of stocks by the Unrealized profit and loss ratio and the Winning profit margin for each stock.

### Example 4

### (Diagnosis of Trading Data by Component of Aggregated Target Trading Data by Investment Target)

An example of a diagnosis based on the trading data by Component of Aggregated Target Trading Data by Investment Target is a diagnosis based on the rise rate ranking of the stocks purchased on September 10 or a diagnosis based on the trading profit/loss ratio of the stocks purchased on September 10. ˜One specific example is a diagnosis using the valuation indicators (calculated under the applicable conditions) of (Component) of (Investment Target), a diagnosis of A issues by winning rate for each investor, and a diagnosis of stocks by Unrealized profit and loss ratio and Winning profit margin for each stock.

### Example 5

### (Advice on Trading Data by Component of Aggregated Target Trading Data by Investment Target)

An example of the advice based on the trading data by Component of Aggregated Target Trading Data by Investment Target is advice on the rate of increase in the number of stocks purchased on September 10 or advice on the rate of return on trading of stocks purchased on September 10. ˜One example is advising investors to increase the winning ratio of A issues by using the index (calculated under the condition) of (Components) of (Investment Target). Another example is advising investors to increase the winning ratio of A stocks. Another example is advising stocks by showing their Unrealized profit and loss ratio and Winning profit margin.

### Example 6

### (Display of Valuation Indicators by Trading Data by Component of Aggregated Target Trading Data by Investment Target)

Examples of the display of the valuation indicators based on the trading data by Component of Aggregated Target Trading Data by Investment Target include a display of the valuation indicators of the trading profit/loss ratio of the brand purchased on September 10 or a display of the valuation indicators of the winning ratio of the brand purchased on September 10. ˜One specific example is the display of the valuation indicators (calculated under the conditions) of (a) to (a component of) of (an investment target), the presentation of the winning rate of A issues by investor, and the presentation of the Unrealized profit and loss ratio and the Winning profit margin by stocks.

(Definition of Component Trading Data in which Investors are Components of Aggregated Target Trading Data by Investment Target)

The component-specific trading data in which the investor of the trading data to be counted is used as a component is defined as the component-specific trading data in which the trading data to be counted by the investment object, for example, the trading data (trading data to be counted) extracted when the A brand is purchased on September 10 in the above example, is classified, tabulated, or extracted (including any one or a plurality of items) by the component of the investor, as the component-specific trading data in which the investor of the trading data to be counted by the investment object is used as a component.

(Issues with Conventional Technology)

How investors buy and sell investments has been wrapped in veil. Stock investors don't know at all how much profit or loss they have and how much they have Unrealized profit and loss, nor are they news. This problem can be solved by the creation of component-specific trading data that includes investors in the Aggregated Target Trading Data by Investment Target.

### (Operation of Trading Data by Component Composed of Investors in Sales and Purchase Data Subject to Investment Target)

By extracting, classifying, and tabulating the extracted condition as an investment target by an investor who is a component thereof, component-specific sales data in which the investor of the calculation target sales data for each investment target is a component is created.

### (Effects of Trading Data by Component Composed of Investors in Sales and Purchase Data Subject to Investment Target)

When this data set is created by the information processing system, the behavior of the investor for each investment object is clarified, and a special effect can be expected that the actual state of unrealized profit/loss and trading profit/loss can be seen as to how the profit is generated and how the loss is generated. Not only investor behavior, but also articles that greatly affect those who are not investing can be generated by the information processing system one after another.

### (Significance of Preparation of Profit and Loss Level Trading Data for Target Trading Data by Investment Target)

After the compilation of transaction data by investment target, there are components, and there are steps to create profit and loss level transaction data (some steps may be omitted, while others are not listed). The relationship between transaction data by investment target and profit and loss level transaction data is touched upon. It is appropriate to define whether the investment profit/loss of A issues is viewed at the overall profit/loss level, whether it is viewed at the buying/selling profit/loss level, whether it is viewed at the unrealized profit/loss level, and whether it is viewed at which level. This is the creation of the profit and loss level trading data, and if it is measured at the total profit/loss level when the investment results of the entire A stocks to be invested are measured, the transition of the valuation amount is appropriate. The change in valuation is a typical example. The next level is the second-level profit-and-loss level trading data and the unrealized profit-and-loss level trading data. The trading data is divided into trading data and non-trading data, and trading data of the A issues to be invested is created, and the valuation indicators is calculated based on the non-trading data. An effective and usable valuation indicators can be calculated gradually, such as a winning ratio and a Winning profit margin.

### (Problems of Existing Technology)

In the first embodiment, the basic numerical value (basic data) is acquired from the acquired trading data for investment commodity, the valuation indicators relating to the trading profit and loss and the unrealized profit and loss is calculated from the acquired basic numerical value, the valuation indicators relating to the overall profit and loss is acquired from the calculated valuation indicators, and the information indicating the acquired valuation indicators is generated. The problem with the existing technology is that investor A is assumed, and there is no idea of whether or not it is assumed to be viewed from the viewpoint of the investment target. This is because it is not possible to calculate it in the first embodiment, and it is possible only in the database collaboration. Since the first embodiment is based on a calculation formula, it is difficult to satisfy various demands, for example, there is no idea of whether the winning rate of the A stock in 2020 or the most successful investor of the A stock is, and the narrow view of evaluating the trading data of the A investor is a big issue. Further, in the first embodiment, since the valuation indicators is calculated from the trading data (trading data in a narrow sense), the number of valuation indicators that can be obtained is small, and there is a problem that the valuation indicators cannot be calculated only in a fixed manner.

### (Effects of Creation of Profit and Loss Level Trading Data of Aggregated Target Trading Data by Investment Target)

In the fourth embodiment, in order to overcome these problems, the most important is an epoch-making information processing system in which roles of each department are divided by database cooperation, a target trading dataset is gradually narrowed down for the purpose, and a target trading dataset is created, and various valuation indicators are calculated by the information processing system based on the trading data, so that various objects can be evaluated from various angles and the like. By setting various conditions in the second to fourth steps, it is possible to change the shape of the trading data to be worked according to the purpose. In the above example, by making the target not an investor, but an investment object, or by making the constituent elements into a fiscal year, the trading data can be easily changed to suit the purpose, and the valuation indicators can be calculated for the trading data that has changed according to this purpose. Therefore, the valuation indicators that matches the purpose can be easily derived by the information system. In addition, as the second issue enables us to incorporate not only transaction data but also all information related to the gain or loss on investment target, such as market data and technical data, the range of valuation indicators that can be calculated by the information processing system is wider, and it has become possible to view the investment targets from various perspectives. This is also the result of database collaboration, and this consistent collaboration system overcomes the aforementioned problems.

### (Effect of Preparation of Profit and Loss Level Trading Data of Aggregated Target Trading Data by Investment Target)

As described above, the fourth embodiment is an epoch-making technological innovation in which various objects (for example, a comparison between a speculative stock group and an excellent stock) can be handled in various forms in accordance with the object of the investment object, and in addition, the object can be incorporated not only with transaction data but also with information necessary for improving profit and loss due to investment of the investment object (for example, with a string of business performance information, technical information, and trading data). The calculation of the valuation indicators by the information processing system has a special effect of widening the range and deepening the depth.

### (Specific Examples of Sales Data by Component Composed of Investors in Aggregated Target Trading Data by Investment Target)

### Example 1

(Compare by Component Sales and Purchase Data with Investors as Components of Aggregated Target Trading Data by Investment Target)

An example of a comparison of trading data by component consisting of investors in trading data by investment target is to compare the trading of A issues with the trading of A stocks by investor A with the trading of A stocks by using indicators such as the profit-loss ratio and the Unrealized profit and loss ratio. ˜This is an example of the comparison of (investment target) by (investor) and by (calculated under) the valuation indicators. One specific example is to compare A issues by total profit-and-loss ratio for each investor, and to compare stocks by trading profit-and-loss ratio and winning ratio for each investor.

### Specific Example 2

(Ranking by Component Sales Data with Investors as Components of Aggregated Target Trading Data by Investment Target)

Examples of the ranking based on the trading data by component composed of the investors in the trading data for each investment target include the ranking of the profit/loss ratio by investor in the A issue and the ranking of the winning ratio by investor in the A issue. ˜One specific example is the ranking of the index (calculated under the relevant conditions) for (each investor) in (the investment target), the ranking of A issues by the winning rate for each investor, and the ranking of stocks by the Unrealized profit and loss ratio and the Winning profit margin for each investor.

### Example 3

(Evaluation by Component Sales Data with Investors as Components of Aggregated Target Trading Data by Investment Target)

FIG. 106 shows in detail the evaluation of trading data by component, which consists of investors in the trading data for individual investments. This is also a form of invention in which many findings and knowledge can be given to investors by the information processing system.

### Example 4

(Display of Valuation Indicators by Component Sales Data with Investors as Components of Trading Data Subject to Totalization by Investment Target)

An example of the display of the valuation indicators based on the component-by-component sale data consisting of the investors in the trading data for each of the investment targets is the display of the valuation indicators called the trading profit/loss ratio for each investor of the stock A, or the display of the valuation indicators called the winning ratio for each investor of the stock A. ˜One specific example is the presentation of the valuation indicators (calculated under the relevant conditions) from the ˜ (by investor) of (investment target) and the presentation of the winning rate of A issues by investor, or the aggregation of the Unrealized profit and loss ratio and the Winning profit margin by stockholder.

### Example 5

(Diagnosis by Component Sales and Purchase Data in which Investors are Components of Aggregated Target Trading Data by Investment Target)

An example of a diagnosis based on component-specific trading data consisting of investors in the trading data for each of the investments is a diagnosis using an investor ranking with a trading profit/loss ratio of A, or a diagnosis based on a trading profit/loss ratio by investor of A. ˜One specific example is the diagnosis of (for each investor) by (calculated under) the valuation indicators (for each investor), the diagnosis of A issues by the winning rate for each investor, and the diagnosis of stock results by using the Unrealized profit and loss ratio and the Winning profit margin for each investor.

### Example 6

(Advice by Component Sales Data with Investors as Components of Aggregated Target Trading Data by Investment Target)

An example of the advice based on the trading data for each component consisting of the investors in the Aggregated Target Trading Data by Investment Target is the advice on the ranking of Mr. A in the trading profit/loss ratio ranking of the stocks purchased on September 10, or the advice on the trading profit/loss ratio of the stocks purchased on September 10. ˜One example is advising investors to increase the winning ratio of A issues by using the index (calculated under the condition) of (Component) of (Investment Target). Another example is advising investors to increase the winning ratio of A stocks by showing the ratio of unrealized profit/loss and the ratio of winning profit by each investor.

(Specific Examples of Aggregate Target Trading Data by Component with the Investment Target as a Component of the Aggregated Target Trading Data by Investment Target)

### Example 1

(Compare by Aggregate Target Trading Data by Component with the Investment Target as a Component of the Aggregated Target Trading Data by Investment Target)

An example of a comparison based on aggregate target trading data by component with the investment target as a component of the aggregated target trading data by investment target is to compare trading of A issues with trading of B stocks using valuation indicators such as the profit-loss ratio and the Unrealized profit and loss ratio. ˜In the case of comparing (investment target) with the valuation indicators (calculated under the applicable conditions) for each of −(investment target), it is a specific example to compare A issues with B stocks by the overall profit-loss ratio, or to compare stocks by the trading profit-loss ratio or the winning ratio for each stock.

### Specific Example 2

(Ranking by Aggregate Target Trading Data by Component with the Investment Target as a Component of the Aggregated Target Trading Data by Investment Target)

Examples of the ranking based on the aggregate target trading data by component with the investment target as a component of the aggregated target trading data by investment target include the ranking of trading profit/loss ratio by stock issue and the ranking of winning ratio by speculative stock issue. ˜One specific example is the ranking of the valuation indicators (calculated under the relevant conditions) of (investment targets)-(for each investment target), the ranking of the issues held by individual investors by the unrealized profit rate, and the ranking of traded day traders by the winning rate.

### Example 3

(Evaluation by Aggregate Target Trading Data by Component with the Investment Target as a Component of the Aggregated Target Trading Data by Investment Target)

FIG. 103 details the evaluation of trading data by component of trading data for individual investment targets. This is also a form of invention in which many findings and knowledge can be given to investors by the information processing system.

### Example 4

(Display of Valuation Indicators by Component Sales and Purchase Data in which the Investment Target of the Sale and Purchase Data Subject to Investment Target is Component)

Examples of the display of the valuation indicators based on the aggregate target trading data by component with the investment target as a component of the aggregated target trading data by investment target include the display of the valuation indicators of the Winning profit margin for each issue of the brand held by the individual investor, and the display of the valuation indicators of the average trading profit rate for each brand of the trading brand of the short-term trading investor. ˜Indication of valuation indicators (calculated under the applicable conditions) of (investment targets)—(by investment target) One specific example is to show the winning rate of a hypothetical currency on a stock-by-stock basis, or to show the Unrealized profit and loss ratio and the Winning profit margin of a stock on a stock-by-stock basis.

### Example 5

(Diagnosis by Component Sales and Purchase Data in which the Investment Target is Component of the Target Sales and Purchase Data by Investment Target)

An example of a diagnosis based on component-specific trading data, which consists of the components of trading data for individual investment targets, is a diagnosis using the stock ranking at the trading profit/loss ratio of the stock, and a diagnosis based on the trading profit/loss ratio by investor of stock A. ˜One specific example is a diagnosis using the valuation indicators (calculated under the relevant conditions) of (investment targets)−(for each investment target), a diagnosis of stocks with a winning rate for each stock, and a diagnosis of stock results using the Unrealized profit and loss ratio and Winning profit margin for each stock.

### Example 6

(Advice by Component Sales Data with Components of Investment Target Sales Data as Components)

An example of advice based on component-specific trading data that includes the investment target of the trading data for each investment target is that the information processing system displays that many of the issues held have a negative value at the bottom of the trading profit/loss ratio ranking among the stocks, and provides advice. The information processing system offers proposals for higher stocks based on the low win rate among the stocks held, and provides advice. ˜One concrete example is providing advice by the information processing system using valuation indicators (calculated under the relevant conditions) of (investment targets)—(by investment target), showing the winning rate of stocks by stocks, and raising the winning rate, and providing advice on stocks held by the information processing system by showing the Unrealized profit and loss ratio and the Winning profit margin by stocks.

### (Definition of Aggregated Trading Data by Technical Indicators)

Technical indicators included in the aggregate include RSI, addition, addition, foot, foot suffix, and foot shape of a candle, technical indicators using a moving average line (moving average), technical indicators using a moving average line (moving average), MACD (Moving Average Convergence Divergence), RSI (Relative Strength Index), W % R (Williams % R), Bollinger Band, Sticky, cycological line, parabolic, pentagon charts, CCI (Commodity Channel Index), and technical indicators using moving average deviation rates and MFI (Money Flow Index. In addition, technical indices can be grouped into psychological line indices, oscillator-based technical indices, and trend-based technical index values. In addition, candle-footed forms and emerging additions can be included in the aggregate. In addition, chart indices are also one of the aggregate targets. For example, the information generating unit 3021 may associate a numerical value such as RSI, stocast, or the like with the purchasing data or the selling data, create the tallied trading data for which RSI is calculated by the information processing system on the basis of RSI, or further divide the numerical values by RSI range and aggregate the respective values to create the sales data for each technical index component. In addition, as shown in the trading data to be counted for each table listed above, it is easy to manage the technical index managed in the separate table by linking the trading data (which may be the purchase data or the sale data) with the date (or the date and time) and the issue with the date. This is also an example of aggregate target trading data for each technical index, and is tabulation target trading data for each table technical index.

As shown in the database related diagram (see FIG. 91), in order to connect the sales data (here, purchase data) and the technical index, it is possible to relate the date (or date and time) of the sales data, the brand code, and the date (or date and time) of the technical index value. A short-term, fast-moving technical indicator requires a date and time, but less movement during a day depends on the date and the nature of the technical indicator. By this database cooperation, the trading data and the technical index data are linked by the date and the issue, and the technical index value of the purchase date can be incorporated into the database. It is possible to verify whether or not the purchased data of RSI20% or less is successful.

(Relationship of Sales and Purchase Data Subject to Aggregate by Technical Indicator with Prior Art)

Technical indicators are often used by investors, but are not used in combination with trading data, especially transaction data. The value of the technical index can be input to the transaction data, calculated by the information processing system (including automatic and manual input), or referred to from another table that manages the technical index. The purchase data is usually composed of a purchased brand, a purchase date, a purchase market price, and the like, and at that time, the technical index value can be calculated by the information processing system. Including this technical index value in the data (later, or even immediately) enables the creation of trading data to be tabulated for each technical index.

(Issues with Aggregated Trading Data by Technical Indicators)

Technical indicators are used to make trading decisions, but by linking them to buy and sell data and managing them in a database of buy and sell data, it becomes possible to verify them later, and whether they are really good indicators, and how they can be used with confidence. Furthermore, the information processing system can be expected to have a particular advantage in that the data at the time of purchase is accumulated, and the technical index value at the time of sale is also recorded, so that if a large number of data are accumulated, the success rate at the time of purchase at RSI20% or less, the success rate at the time of sale at 80% or more, and the like can be known. Differences in results between short-term trading and medium- to long-term trading are also apparent.

### (Effects of Aggregated Trading Data by Technical Indicators)

The information generation unit 3021 includes the data of the technical index in the purchase data and the sale data. For example, an RSI index column is provided. This technical index field may be a plurality of columns, or may be a single column or may be a separate table (such as a technical index table). In the case where a single simplest RSI index field is provided, the effect is explained by RSI between the purchased data and the sold data. Purchase data is managed as purchase brand, date of purchase, time of purchase, and RSI value. If the issue, the purchase date, and the market value are determined, they are calculated by the information processing system, so they may be calculated at a later time or immediately. It can be automatic or manual.

Among the purchasing data, the success rate of combining the purchasing data with an RSI of 20% or less and the selling data with a RSI20% or more can be obtained.

### (Effects of Aggregated Trading Data by Technical Indicators)

In the example described above, only the sales data including the purchase data having RSI of 20% or less and the sale data having RSI80% or more are extracted (RSI20% or less at the time of purchase and RSI80% or more at the time of sale), thereby creating the sales data to be tabulated by the technical index.

Special effects can be expected such as that it is possible to verify whether or not the trading profit-loss ratio of the aggregated trading data is different from the trading profit-loss ratio calculated by the information processing system by aggregating the trading profit-loss ratio of the non-aggregated trading data. It can be used for judging the quality of technical indices from actual trading data. If this technical indicator is used, it can be found that the probability of success is high. By incorporating it into AI, etc., it is possible to expect that the probability of success will be expressed as a percentage, and it can be expected that various effects will be realized.

### (Specific Examples of Sales Data Subject to Aggregate by Technical Indicator)

In addition to the specific examples described above, there are the following specific examples.

### Example 1

It is possible to include the pods appearing in the candle foot in the data. By managing the shape of the candle foot in the purchased data, for example, Taiyo Line and Taiyo Line, it becomes clear whether the average of the sale and loss ratio of the issues purchased during the time of Taiyo Line. Since the amount of information becomes very large and complicated, it is more realistic to manage the information in a separate table.

### Specific Example 2

For example, if a person who has purchased in a range and sold in a range in Stocastics has a high probability of success and a high profit margin, he or she can answer that a trade that is purchased in accordance with this rule is currently the stock. If this stock is purchased in this range, the probability of success can be expressed as a percentage. In addition, it is possible to add functions such as teaching the stockholdings in a range where the probability of success in selling Stochastics is high.

### Example 3

For example, it is possible to manage data in the form of •× to determine whether or not a purchase judgment index having a first-order balance table is lit, and compare the winning ratio and the trading profit/loss ratio of trading data to be tabulated by technical index of•with trading data to be tabulated by technical index of×The use of actual trading data makes it possible to ascertain the success or failure of all technical indicators.

### Example 4

By incorporating a number of technical indicators into a database and associating them with trading data, a combination of numerical values of the technical indicators with the highest probability of success can be obtained. If the percentage is less than RSI20% and the 25-day moving-average line deviation rate is less than or equal to what percentage, then the percentage of successful purchasing can be estimated as what percentage. In such cases, the greater the amount of data, the greater the room for further table control and AI activity.

### Example 5

The aggregate of trading data to be tabulated according to the technical index is also useful for articles data such as the number of technical indices and how much profit will be generated by the technical index.

### Example 6

The method of incorporating the technical index value into the trading data in the trading data subject to aggregate by investor is called the trading data subject to aggregation by investor according to the technical index. By linking the purchase data and the sale data with the technical index value in the dimension of the investor, it is possible to show the trading behavior of other stocks recently at the time of the decision of the purchase.

### Ex. 7

The method of incorporating the technical index value into the trading data in the trading data subject to the aggregation by investment target is called the trading data subject to the aggregation by investment target according to the technical index. By linking the purchase data and the sale data of the trading data with the technical index value on the axis of the investment target, it is possible to show the trading behavior of other investors in recent years at the time of deciding the purchase of the stock A.

### (Old Method of Aggregated Trading Data by Profit and Loss)

Embodiments 1 and 2 are described with respect to valuation of various profits and losses. In the first embodiment, various profit and loss totals are acquired from the trading data. These are used in the process of calculating the valuation indicators, and are necessary in the step performed after the step of creating the sales data to be aggregated by profit and loss this time.

### (Difference Between Trading Data Subject to Aggregate by Profit and Loss and the Old Method)

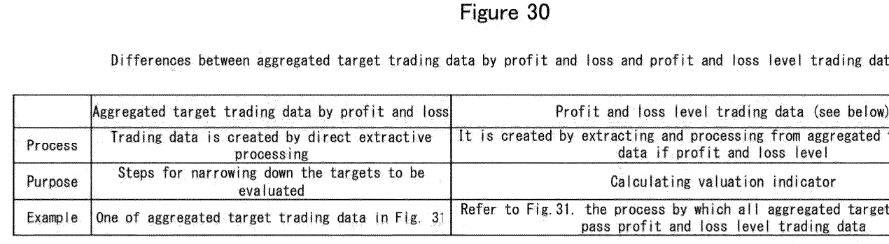

FIG. 30 is a diagram for explaining a difference between profit and loss level trading data and profit and loss level trading data according to the present embodiment.

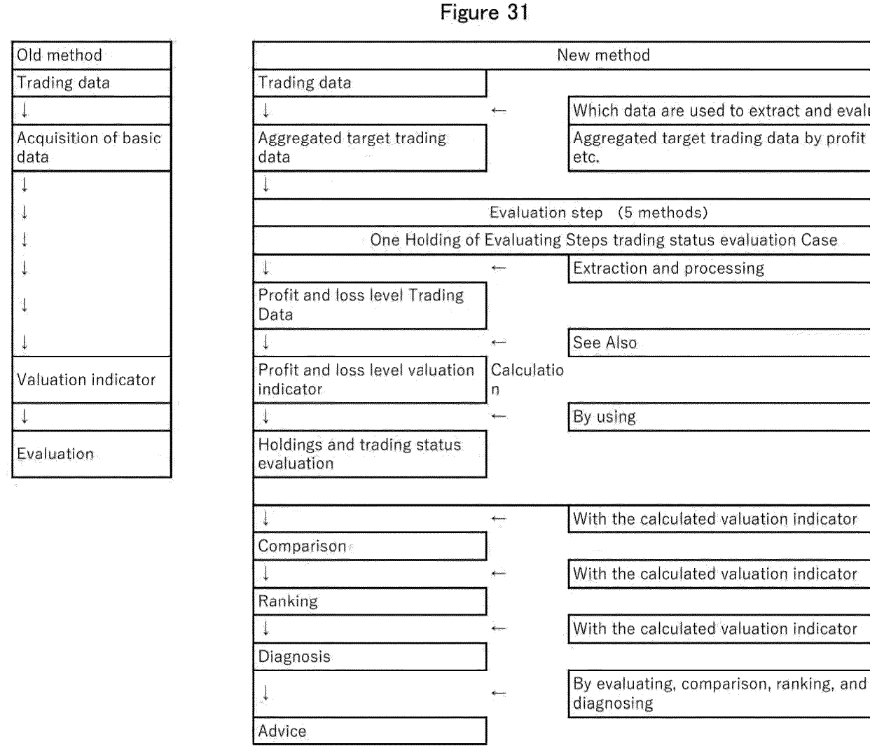

FIG. 31 is a diagram illustrating steps in which the profit-and-loss level trading data and the profit-and-loss level trading data are used.

In the step of creating the trading data to be counted by profit and loss, only the trading data determined to have been countertraded is extracted from the trading data. In extracting another transaction data from the transaction data, the transaction data is extracted with profit or loss corresponding to the purpose, and thus the extracted and processed transaction data is obtained.

### (Definition of Aggregated Trading Data by Profit and Loss)

There are various types of profit and loss calculated from trading data. In addition to Unrealized profit, unrealized losses, trading gains, and trading losses, trading gains and losses, as well as trading gains and losses, Unrealized profit and losses, and overall gains and losses are raised. For example, in the case of extracting trading data at an unrealized profit level, trading data that has not yet been traded and is profitable is defined as Aggregated target trading data by profit and loss extracted at an unrealized profit level.

### (Issues of Aggregated Trading Data by Profit and Loss)

Since the purpose of buying and selling investment commodities is mainly to improve profit and loss, it is important to extract buying and selling data based on the target profit and loss. Although the purpose of the first embodiment is to calculate valuation indicators, the purpose of the step of creating the sales data to be aggregated by profit and loss according to the present embodiment is to narrow down the target to be evaluated.

### (Action of Aggregated Trading Data by Profit and Loss)

The information generation unit 3021 extracts the Profit and loss level trading data, and creates the Aggregated target trading data by profit/loss. For example, if the aggregation target is a trading profit or loss, the information generation unit 3021 extracts only the determined trading data that has been counter traded. At this time, at the time of creating the trading data, processing is performed on the unrelated trading data and the reverse trading data, and in a case in which the trading data is associated with the current price in the table and a case in which the trading data is not associated, the trading data is slightly different. In the case where the current price is associated with the current price in the table, the current price is updated for each issue together with the update of the table data, which is easy to handle. On the other hand, in the case where the current value is managed by the item, it is difficult to manage the current value. Therefore, it is desirable that the current value is linked to the sales data subject to aggregate by profit and loss in a table form or a method close to the table form.

### (Effect of Aggregated Trading Data by Profit and Loss)

By specifying only the extracted trading data with respect to the target profit or loss, it is possible to evaluate only the trading data with the trading profit. As a result, the trading profit margin of A's stock and the trading profit margin of B's stock can be seen side by side, thus enabling appropriate valuation.

### (Issues in Automatic Transaction Data to be Aggregated)

The information required by the user is diverse. There are a variety of needs, such as a desire to rank trading profits by brand, a desire to know how much the overall profit/loss ratio of all investors is, and a desire to know what is inferior compared to a person who buys or sells to a superior.

The procedures for creating the Aggregated target trading data are different from each other. Rather than satisfying all the needs from the beginning, it is convenient to be able to create Aggregated target trading data according to the needs. This requires automation of the creation of transaction data to be aggregated.

### (The Role of Automatic Transaction Data to be Aggregated)

When a user or an administrator decides what he/she wants to know in response to his/her request, he/she decides what kind of criterion to create the transaction data to be aggregated. For example, the trading data for the period in 2020 is suitable for the target of which stocks have the highest profit margin in 2020. If it is possible to obtain what you want to know by inputting a questionnaire or an input form, or selecting an option, it is necessary to identify the transaction data to be aggregated. Alternatively, the target includes presenting a problem from the beginning, and automatically creating Aggregated target trading data corresponding to the problem.

In order to realize this problem, it is possible to automate the creation of Aggregated target trading data by determining which data is required, what aggregation method, what classification method, and what extraction method to create trading data.

In order to address the problem of the most profitable stocks in 2020, it is important to automatically compile trading data by period in 2020. You can use AI or refer to the table. The profit and loss level trading data is a winning profit level, and the target trading data is obtained by aggregating the winning profit for each issue and the winning purchase price in the component-by-component trading data and calculating the Winning profit margin.

These auto-creation can be done by using AI or by referencing tables.

When the table is referred to, in advance, it is made to correspond to which aggregate target trading data should be created or which aggregation target trading data should be created for various issues. The same applies to the following third step and subsequent steps. In the above example, the problem that the brand with the highest profit ratio in 2020 is that the table is used for the aggregate of brands and buying data for 2020, its preparation procedure, the second step is the preparation of profit level buying data, the preparation procedure, and the third step is the preparation and preparation procedure of brand-by-brand component sales data and the preparation procedure of brand-by-brand component sales data, and the calculation of the valuation indicators is the winning margin, and if these data can be referred to in a table, it is possible to automatically prepare them by a program in accordance with it. None of the steps are essential, and there are some cases where it is not necessary.

As the data structure of this table, the vertical axis has items such as the type of Aggregated target trading data, the aggregation of the Aggregated target trading data, the classification and extraction aggregation method of the trading data, the type of the profit-and-loss level trading data, the extraction method, the type of the component-specific trading data, the creation method such as whether to aggregate or extract each component, the type of the valuation indicators, the calculation method, and the like, and by setting a problem on the horizontal axis, it is possible to create the target trading data and the valuation indicators for the problem.

They can be learned to answer a variety of issues. In addition, a table may be used, and any format such as a correspondence table may be used. In addition, these items may be increased or decreased. The horizontal axis may include any one, may include a plurality, or may be another criterion. For example, if the type is determined, there is a work table of the type, and it is possible to determine what kind of processing, extraction, aggregate, and the like will be performed on the work table. This is a method for automating the type of transaction data to be created and how to be created for issues.

### (Effects of Automatic Transaction Data to be Aggregated)

It is relatively easy to decide what to do, but it is difficult to decide which aggregate trading data to use. It has a special effect that anyone can use it by deciding what they want to do and then back-calculating it to determine the necessary Aggregated target trading data and automatically creating it.

### (Specific Examples of Automatic Transaction Data Subject to Aggregation)

### Example 1

For example, the trading data for the period in 2020 is suitable for the target of which stocks have the highest profit margin in 2020.

### Specific Example 2

In the case of the best 10 issues with high trading profits in 2020, the component trading data is classified by stock in the data for trading by period in 2020.

### Example 3

If you want to know what indicators you are inferior to the average, you can accomplish this by creating (even if you have it in the previous process) the aggregate profit and loss level trading data from the component trading data of investor A and the entire investor in the total trading data for the entire investor.

### Example 4

Compared with 2020 and 2019, those with positive overall profit/loss can be achieved by using the total profit and loss level trading data in the annual component trading data in the aggregate trading data for the entire investor if they want to know whether the total profit/loss has increased or decreased.

### Example 5

If you want to know the results of those with a high win rate (70% or more) in 2020 and the results of those with a high win rate (20% or more) in 2020, you can obtain the results by compiling component trading data by investor using the trading data for each period in 2020, creating profit and loss level trading data using the information processing system concerned (even if you have it in the previous process), using the win rate and the win rate as valuation indicators, and compiling the total profit/loss ratio of Group A with a win rate of 70% or more and Group B with a win rate of 20% or more.

In order to solve various problems, by using which aggregate data, which component data is used, and which level of profit and loss data is used and which valuation indicators is used, the necessary data for sale is extracted (or classified, tabulated, processed), and the problems can be solved. Among them, the automatic preparation step of the aggregate data is the step.

After the creation of the Aggregated target trading data, the creation process of the trading data by component is performed.

The first step is a step of acquiring trading data. The second step is the step of creating transaction data to be aggregated. The third step is a step of creating the component-by-component sales data (this step), and is also possible after the fourth step. The fourth step is the creation step of profit and loss level trading data (also possible after the second step). The fifth step is the calculation step of valuation indicators.

### (Step of Creating Component Trading Data)

In the step of creating the component trading data, the information generation unit 3021 displays the Aggregated target trading data (after the creation of the profit and loss level trading data in the case where the profit and loss level trading data is first created) created in the first step by dividing or extracting the trading data by period, by investor, by investment target, by profit/loss, by investment type, by adviser, by securities company, by medium, and the like. The component trading data is defined as the component trading data in which the Aggregated target trading data (trading data through the first stage) or the profit and loss level trading data (trading data through the first and third stages) are classified and tabulated for each component.

A's trading data (aggregated trading data by investor) can be classified into component trading data by period in 2019 and 2020. In this case, component trading data for 2019 can be generated by extracting trading data for which Mr. A made an investment based on Mr. A, and then extracting trading data for 2019 by period. In the third stage, the Trading profit and loss level trading data may be obtained (in the order of the first stage, third stage, and second stage). This is defined as Mr. A's 2019 component trading data (Mr. A's 2019 Trading profit and loss level trading data in the latter case). Data for 2019 will be compiled and data for 2020 will be compiled. For example, the Trading profit and loss level trading data of Mr. A is aggregated for each issue, and is included in the definition of the component trading data such as the total value of the A brand and the total value of the B brand. This is a case where a table is added together, but a separate table is created, and the trading data of Mr. A's Trading profit and loss level trading data is further divided into the trading data of Mr. A's trading data and Mr. A's trading data of Mr. B's trading data.

The trading data for A brand is divided into component trading data for each investor, such as A, B, etc. In this case, by extracting the trading data obtained by investing the A brand on the basis of the investment target of the A brand, and further extracting only the trading data of the A brand by the investor (or the aggregate by the investor), it is possible to create the component trading data of the A brand and the B brand. Here, it is also possible to create the trading data of A for each investor by first creating the trading data of the trading profit/loss level (in this case, it is defined as the trading data of A for the trading profit/loss level). This is defined as the component trading data of Mr. A of the stock A.

It is also possible to further divide the component sales data by period, by investor, by investment type, by medium, by securities company, by investment target, etc. by component. For example, it is also possible to nest the annual aggregate of the trading data to be tabulated by Mr. A, and further classify the tabulation by brand. In this case, Mr. A's performance by brand in fiscal 2020 and the performance by brand in 2019 can be obtained. Furthermore, it is possible after the data to be aggregated (the first, second, and third steps) and after the creation of the profit and loss level trading data (the first, third, and second steps).

(Relationship of Component Sales Data Creation Step with the Old Method)

The old method of capturing trading data is to collect trading data, and the new method makes it possible to analyze the object of the work more broadly and deeply by clarifying what kind of object should be extracted for what kind of purpose. The component sales data includes components constituting the component sales data, for example, a stock, an investor, a securities company, a technical index value, or a component of the component sales data that is extracted, reclassified, or reclassified.

### (Significance of Component Sales Data Creation Step)

In the step of creating the component trading data of the new method, the purpose of extracting and aggregating the Aggregated target trading data according to the criteria (whether the trading data is by investment, whether the trading is by investment, or whether the trading is by period, etc.) and evaluating what (whether the trading data is to be aggregated, whether the trading is A or B) is more clearly defined. This process can be extracted from the transaction data to be tabulated, the profit-and-loss level transaction data can be created by the information processing system in the next step (even if it is possible in the previous step), and the profit-and-loss level transaction data can be extracted and tabulated in the same manner according to which criterion (whether the transaction is made by investment, whether the transaction is made by investment, or whether the transaction is made by period, etc.). Depending on the problem, this step itself may be omitted.

### (Problems in the Step of Creating Component Trading Data)

The step of further narrowing down the trading data subject to aggregate or the profit and loss level trading data (the process after the trading data subject to aggregation) or aggregating the trading data by component makes the nature of the subject to be evaluated clearer and makes it easier to compare and rank the trading situation of S Company shares in 2019 with the trading situation of P Company shares. Evaluation of trading data by period in 2019, as defined by the definition of trading data to be tabulated, is easy to calculate valuation indicators. However, it is easy to evaluate them by comparing the trading data (or aggregate data) of investor A with the trading data (or tabulation data) of investor B as a further breakdown in 2019, and by providing further breakdown of components such as how the profit rate calculated from trading data of stock A is compared with other stocks, and the ranking of the winning rate calculated from trading data of stock A. Compare and ranking are also easier. It is also possible to create profit and loss level trading data by the information processing system (even if it is in the previous process) from the trading data to be tabulated, and extract and tabulate the profit and loss level trading data in the same manner according to which criterion (whether it is investment-based, whether it is investment-based, or whether it is period-based).

The characteristics of the trading data can be further learned by dividing and tabulating the valuation targets (aggregate targets and profit and loss level trading data) as the basis by period, by investor, by investment type, by medium, by securities company, by investment target, and so on.

### (Operation of Component Trading Data Creation Step)

Component trading data can be created by dividing the Aggregated target trading data (or the aforementioned profit and loss level trading data) by period, investor, investment type, medium, securities company, investment target, and other components. Various combinations are possible, and by calculating the valuation indicators for each stock based on the trading data for the investment type day tray type, it becomes clear that the person of the day tray type is winning or losing in what kind of stock. By delivering this kind of information to many people, we can expect that investment behavior will change dramatically.

### (Effect of Component Trading Data Creation Step)

It is possible to calculate the winning rate and the trading profit/loss for each fiscal year of A brand by further creating the component trading data (or the profit and loss level trading data described above) by dividing the component trading data by period, by investor, by investment type, by medium, by securities company, by investment target, and the like. In 2020 and 2019, S Ltd. shares will be easier to compile articles on how much profits have been made to everyone. A plurality of valuation indicators are calculated from a plurality of cuts, which makes it easier to evaluate, and it is possible to compare each fiscal year, rank the results of each fiscal year, and provide diagnosis and advice along with the results. It is difficult to process the trading data by a method other than the database, and it is difficult to calculate the winning rate and the trading profit/loss of A issues in fiscal 2020 using the information processing system based on the trading data to be compiled by the investment target, and then calculate the winning rate and the trading profit/loss in 2019 using the information processing system. However, in this case, it is very difficult to obtain the ranking in this case. However, since it is not impossible, these methods are also included in a form of creating the component sales data here. The same applies to the component ranking and the like.

### (First Step of Automatic Creation in the Step of Aggregated Target Trading Data)

Automatically created trading data may be selected by an administrator, may be determined by a user, or may be determined by a user using a form to ask what he or she wants to do (e.g., the 2020 trading profit ranking of a stock), thereby determining Aggregated target trading data.

There are an automatic creation step of aggregate target trading data of a form input method, an automatic creation step of aggregation target trading data of a questionnaire input method, an automatic creation step of aggregation target trading data of a selection method, and an automatic creation step of aggregation target trading data of a pull-down selection method.

The creation of the Aggregated target trading data is automated depending on what is desired to be done by the administrator or the user, and what is desired to be done by the administrator or the user, such as whether to input a form, whether to input a questionnaire, whether to use a selection method, and the like. You can use AI or not. When AI is not used, the process of the type to be performed is determined in advance, and in this case, the aggregate target trading data is generated under such a calculation extraction condition, and in this case, the calculation target trading data is generated under such a calculation extraction condition.

In the case of form input or questionnaire entry, what is desired to be done is finally determined, and therefore, the Aggregated target trading data is automatically created in accordance with the determination.

In such cases, even an AI way can be learned by machine-learning or the like, and the accuracy can be improved.

(Significance of Automatic Creation in Steps after Target Trading Data)

If the task (what you want to do) is decided, not only the trading data for aggregate but also the trading data for each component can be created, and the types of profit and loss level trading data and valuation indicators are decided, and the preparation procedure is decided, so that it is possible to decide which trading data is used (type of trading data), what (profit/loss is used), and how (using which valuation indicators) to improve what.

The automatic creation of the component trading data and the automatic creation of the profit and loss level trading data are created in the same manner as the procedure for the automatic creation of the Aggregated target trading data described above. As described above, by replacing the transaction data to be aggregated describing the action, the problem, the effect, the specific example, and the like with the component-specific transaction data or the profit-and-loss level transaction data, almost automatic creation becomes possible. Differences from the trading data to be compiled are explained as needed.

Through the process of creating the three pieces of trading data, the target profit/loss ratio (average of ROI)) and the target trading data (trading data subject to aggregate (created in the first step, the second step, or the third step), component-specific trading data (created in the first step, the second step, or the third step), profit/loss-level trading data (created in the first step, the second step, or the third step), and the like are determined.

Specific examples are shown below.

### Example 1

For example, to deal with the problem of what the stocks with the highest Winning profit margin in 2020 are, the trading data, the winning profit level trading data, and the brand-specific component trading data by period in 2020 are suitable.

### Specific Example 2

In 2020, the best 10 issues with high trading profit/loss (the stocks that all aggregate) were listed in the trading data by period in 2020. The Trading profit and loss level trading data shows the component trading data by stocks, and the valuation index shows the ranking of trading profit/loss.

### Example 3

If you want to know what indicators you are inferior to the average, you can answer by creating (even if you have them in the previous process) the overall profit and loss level trading data from the aggregate trading data of investor A and the entire investor using the total trading data of investor A and the entire investor, and then calculating the valuation indicators that affects the total profit/loss.

### Example 4

Compared with 2020 and 2019, those with positive overall profit/loss can be achieved by using the total profit and loss level trading data in the annual component trading data in the aggregate trading data for the entire investor if they want to know whether the total profit/loss has increased or decreased.

### Example 5

If you want to know the results of those with a high winning rate (70% or more) in 2020, the results of those with a high Winning profit margin (20% or more) in 2020, and which one is making money, you can create component sales data for each investor using the data for trading by period in 2020, create profit and loss level trading data using the information processing system concerned (even if you have it in the previous process), use the winning rate and the Winning profit margin as valuation indicators, and compare the total profit/loss ratio of Group A with a winning rate of 70% or more and Group B with a Winning profit margin of 20% or more.

### Example 6

Component trading data can also be used for article data on popular foreign stocks and which foreign stocks are successful. It is also useful to prepare article data on several investment commodities and which investment commodities are highly successful in 2020.

### Example 7

The example shown in FIG. 101 shows the steps of evaluating investor A in stock A and the entire stock in 2019, and evaluating the selected target at which level of profit or loss. According to this diagram, various conditions can be set, and once conditions are set, it can be incorporated by looking up a table, etc.

The creation method by the trading data extraction processing at each profit/loss level is as follows.

The first step is a step of acquiring trading data. The second step is the step of creating transaction data to be aggregated. The third step is a step for creating component-specific trading data (also possible after the fourth step). The fourth step is a step of creating the profit and loss level trading data (this step) (even after the second step). The fifth step is the calculation step of valuation indicators.

### (Definition of Profit-Loss Level Trading Data Creation Step)

In the information processing system, in order to determine a target for processing the trading data, the Aggregated target trading data is created in a second step, and in a third step, the profit and loss level trading data to be extracted (or classified, aggregate, processed) by the component of the target and the target profit and loss are determined, and in a fourth step, the trading data at the profit and loss level is created. This fourth step may be performed before the creation of the transaction data to be aggregated, but in consideration of the subsequent steps, it is possible to more flexibly respond to the transaction in this order.

(Issues with Conventional Technology)

According to the first embodiment, as “the basic data is acquired from the acquired trading data and the valuation indicators is calculated by referring to the acquired basic data”, the fourth embodiment calculates the valuation indicators by referring to the basic data, and the second step, the third step, and the fourth step described above, and then calculates the valuation indicators. In the fourth embodiment, the database cooperation is assumed, and big data can be sufficiently handled. The former is based on individual trading data, and does not assume that big data will be handled. Embodiment 1 is a method of calculating valuation indicators assuming the investor A of the investor aggregation target trading data referred to in Embodiment 4, and Embodiment 4 is an invention of Embodiment 4 which is technically innovative so as to be able to handle concepts that are not assumed in Embodiment 1, such as the aggregation target trading data for each investment target and the aggregation target trading data for each period, and to calculate valuation indicators in cooperation with a database and to perform unified management and consistent management including the use of the calculated valuation indicators. This step also plays an important role. The determination of the profit and loss and the trading data to be worked on (worked trading data) are created in this step. It is a very important and indispensable process for calculating the valuation indicators from the trading data for work. However, although it is assumed that the item will be brought after the acquisition of the trading data, since the target has already been decided in the second step in the fourth step, the profit and loss level of the object can be changed according to the situation, so the application is advantageous. This is a process in which the target to be evaluated is determined (second step or third step) and the target to be evaluated is evaluated in which profit/loss (fourth step) is to be evaluated.

### (Operation of Profit-and-Loss Level Trading Data Creation Step)

By the third step, “what” decided what to evaluate. For example, “A's trading data,” “SoftBank's trading data,” and “2020's trading data for the entire stock” are determined based on the extraction conditions, classification conditions, and aggregation rules. In the fourth step, we decide which profit or loss is to be evaluated. The objective of the investment is to achieve the ultimate results of the investment, although there are many different objectives. In other words, improving investment profitability (ROI of return on investment) is one of the key objectives. There are also many types of investment gains and losses that are important objectives. The step is to determine whether the purpose is to improve profit or loss, Unrealized profit and loss, and profit or loss at which level, with the overall profit or loss being the top priority. The targeting of the four levels determines how to extract (or classify, aggregate, or process) the trading data. The method is described in detail in the following paragraphs.

### (Effect of Creation Step of Profit-Loss Level Trading Data)

Although the technology is more advanced than that of the first embodiment, the technological evolution is particularly large in that various operations are performed in the information processing system which is consistent from the database cooperation, the second step to the twelfth step, and all the steps play a certain role. In the process of determining the level of profit or loss to be covered, if the focus is to change the status of the stockholdings, it is appropriate to prepare the total profit or loss level trading data if the buying and selling data at the level of Unrealized profit and loss, whether or not the various determinations of the past trading status were wrong, and whether or not to improve, etc., are suitable for the buying and selling data at the level of profit or loss, and if you wish to receive advice, including the overall picture and those that are also buying and selling. This creation determines the types of valuation indicators that can be calculated by the information processing system in the next step. This decision is very important because it is effective in subsequent evaluations, advice, and diagnosis.

### (Specific Example of Creation Step of Profit-Loss Level Trading Data)

Various specific examples are shown below.

### (Step of Creating Profit and Loss Level Trading Data)

The profit and loss level trading data includes four levels: a first level (total profit and loss level trading data), a second level (Trading profit and loss level trading data and unrealized profit and loss level trading data), a third level (winning profit(loss) level trading data and unrealized profit (unrealized profit/loss) level trading data), and a fourth level (see below). It may be a further stage or a lower stage. What is important is that the profit and loss at a lower level than the overall profit and loss is related to the component of the total profit and loss.

As a relationship with profit or loss, the target profit or loss of the overall profit or loss level trading data is the total profit or loss (or the total profit or loss ratio). In the same manner, the Trading profit and loss level trading data is the trading profit/loss. Then, as a relationship with the trading data, the overall profit and loss level trading data is trading data including both the trading data being held and the trading data being traded, and if only the trading data being held is the unrealized profit and loss level trading data.

In addition, the counter-trading data includes a set of buying and selling data in the data, but in the non-counter trading, since there is no data of buying and selling (buying and selling data) paired with the buying data (or selling data), the price data of the paired data includes preliminary inclusion of the current value and the current value at a certain point in time. In this regard, there is a method of managing the data in a separate table (refer to FIG. 86).

In addition, the relationship “total profit/loss=trading profit/loss+unrealized profit/loss” and “trading profit/loss=winning profit+loss” is used, and the profit/loss of the lower layer becomes a component of the total profit/loss and an influential element. Hereinafter, the relationship between the second level and the third level is the same, and the relationship between the third level and the fourth level is the same. As the level of the hierarchy becomes deeper, more detailed data is obtained, and all profits and losses are linked to total profit and loss, and each component has a structure.

Therefore, if you want to increase the overall profit or loss, you can improve the profit or loss at some level (if other conditions are constant). With this structure, if the overall profit/loss is to be improved, the improvement measures can be seen by referring not only to the overall profit/loss level but also to the profit and loss level trading data of the lower layer.

### (Old Method of Overall Profit and Loss Level Trading Data)

In the first embodiment, there is a description of “acquiring trading data of an investment commodity, and . . . acquiring valuation indicators related to total profit and loss from the calculated valuation indicators”, and there is a description of processing of total profit and loss analysis. The type of valuation indicators, procedure of diagnosis, decompose formula, etc. are described.

Therefore, the information generation unit 3021 of the server 30 according to the fourth embodiment acquires the sales data of the investment commodity, creates the sales data to be tabulated by extracting (or classifying, aggregating, processing) the sales data for each criterion, creates, according to the purpose, the sales profit/loss level sales data relating to the determined profit/loss, the unrealized profit/loss level sales data relating to the undecided profit/loss, and the like, using the sales data to be tabulated, aggregates the sales profit/loss level valuation indicators for evaluating the sales profit/loss, calculates the unrealized profit/loss level valuation indicators from the unrealized profit/loss level sales data, calculates the unrealized profit/loss level valuation indicators for evaluating the unrealized profit/loss from the unrealized profit/loss level sales data, and generates the information on the evaluation of the total profit/loss of the investment commodity using the sales profit/loss level valuation indicators and the unrealized profit/loss level valuation indicators.

### (Significance of Overall Profit and Loss Level Trading Data)

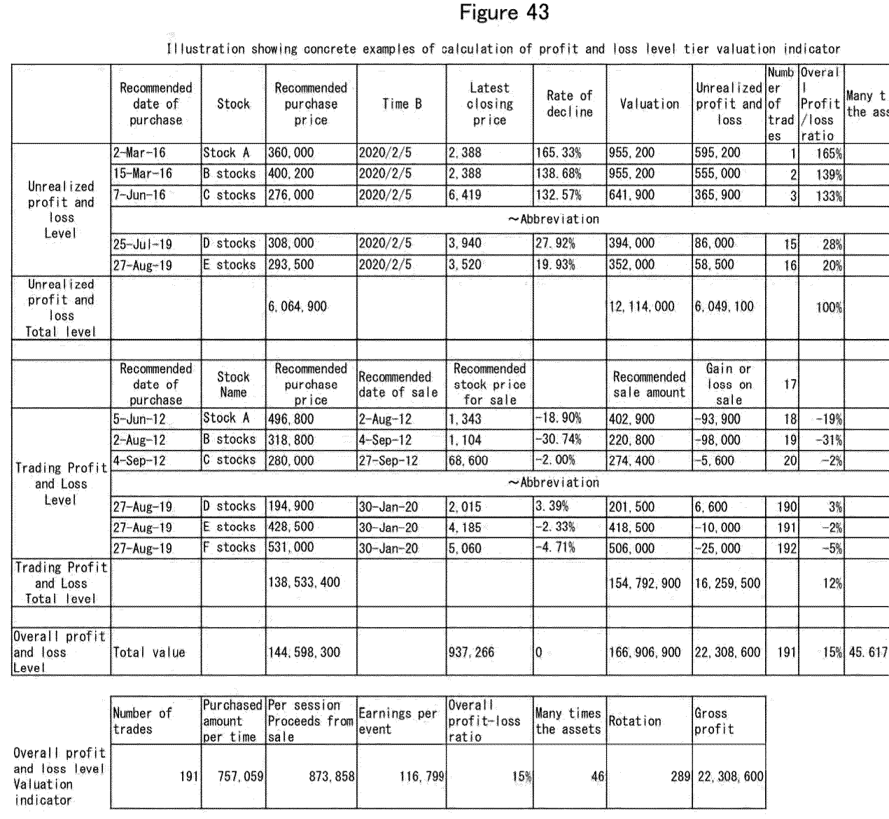

FIG. 42 is a diagram calculated by stepping on the profit and loss level trading data according to the present embodiment. FIG. 43 is a diagram illustrating a specific example of calculation of the profit and loss level stage valuation indicators according to the present embodiment.

The overall profit/loss is how much profit/loss has occurred as a result of the sale, and the sale data created based on the transaction data to be aggregated in order to evaluate the aggregate profit/loss is defined as the total profit/loss level sale data. The first level of FIG. 42 is the overall profit and loss, and the trading data is the total value of FIG. 43 at the total profit and loss level.

Overall gains and losses include gains and losses on trading in which gains and losses are determined by counter-trading and Unrealized profit and losses in holding in non-counter trading. For example, the sum amount of profit or loss obtained from an investment commodity, the total amount of profit or loss obtained by an investor, and the total amount of profit or loss in 2019. The total profit and loss level trading data includes all trading data subject to aggregate.

### (Problems of Trading Data at the Overall Profit and Loss/Loss Level)

The starting point is the principal (or the value at time A), and the question is how to evaluate the valuation of the held product at the current time (or at time B) and the cash balance as a result of buying or selling from there.

Although the above-described old method is also one approach, by processing the transaction data to be aggregated and utilizing the created total profit/loss level transaction data, the degree of generality is further increased and the basis for calculation of the valuation indicators is obtained (see FIG. 43).

The aggregate trading data includes a large number of profits and losses, and the overall profit and loss is the sum of these profits and losses. The trading data for evaluating the overall profit/loss is defined as the total profit and loss level trading data.

The total profit and loss level trading data provides an overall picture of the investment. For example, as shown in FIG. 43, a purchase amount of 144590000 yen is obtained even if the purchase amount starts with a principal amount of 0.5 million yen, and how the principal amount is rotated can be seen. The total profit-and-loss ratio is 15%, but the rotational is sufficient, and using the purchase price of ¥144590000, the company earns a total profit of ¥22.3 million. The overall profit and loss of the investment target or the sales data for evaluating the profit and loss of the investor and the total profit and loss by period are the total profit and loss level sales data.

### (Effects of Overall Profit and Loss Level Trading Data)

Processing is required to obtain trading data to evaluate overall profit and loss. The creation process varies depending on whether or not the trading data subject to aggregate is data subject to aggregation by period.

In the case where the transaction data is not subject to aggregate by period, the starting point is the principal, and as a result of buying and selling from the principal, how to evaluate the current valuation of the held product and the cash balance becomes an issue.

Since the transaction data is processed to evaluate the overall profit or loss, it is necessary to evaluate the remaining held products at the present (or the market value at the time of B) as a result of buying and selling with the principal as the principal. Therefore, the information generation unit 3021 creates the overall profit and loss level trading data by including the evaluation value at the time point B of the held product in the trading data (or may have it in the previous process). The information generation unit 3021 increases items such as an overall profit/loss ratio and a holding period by processing.

In the case of trading data subject to aggregate by period, re-evaluation is necessary. The problem is how to evaluate the valuation value of the held product and the cash balance at the start point A, and how to evaluate the current valuation value of the held product and the cash balance as a result of buying and selling from the valuation value at the start point A (or B).

The Aggregated target trading data is processed as follows.

Information generating unit 3021, the product holding at the time of A is evaluated at the time of A the unit price of purchase, by the product owned at the time of B is evaluated at the time of B the time price, to create a total profit-loss level sales data (even if you have a previous process).

Specifically, the information generation unit 3021 creates the overall profit and loss level trading data by changing the valuation of the trading data purchased before the time point A to the current value at the time point A, and changing the valuation of the products held at the time point B to the current value at the time point B.

However, there are a method of replacing the purchase date, the purchase unit price, and the purchase amount with the A time, the A time, and the A time valuation, and a method of establishing a separate item.

Further, items may be added to the overall profit and loss level trading data according to the purpose such as the total profit/loss ratio, the holding period, and the benchmark hike rate. In addition, it may be totalized for each constituent item or totaled for the whole.

### Effects of Trading Data at the Overall Profit and Loss/Loss Level

The total profit and loss level trading data is trading data for total evaluation, such as whether trading and holding by investment target, investor, or period is generating a loss as a whole or profits, and how the trading and holding is dividing the trading and holding in a certain period.

In order to evaluate whether or not the assets have increased or decreased as a result of various transactions in the past year, the number of purchased issues, the principal increase/decrease rate, and the like, the information generation unit 3021 creates the overall profit and loss level trading data (even if it may have it in the previous process).

By adding each profit-and-loss ratio as an item, the overall profit-and-loss ratio is clarified. By extracting (or classifying, aggregating, or processing) the trading data for each brand by the component item of the brand code, the composition of the total profit and loss for each brand is clarified. A summary of the overall profit and loss for each investor and type of investment can also be easily prepared.

### (What is the Overall Profit-and-Loss Level Trading Data)

The second level separates the profit-and-loss trading data from the unrealized profit-and-loss trading data, while the first level combines all the trading data included in the aggregate, including the data in which the trading is reversed and the data in possession.

### (Specific Examples of Total Profit and Loss Level Trading Data)

For example, if Mr. A is to be evaluated in 2019, it is important to evaluate how the transaction data for 2019, the valuation of the held products at the beginning of 2019, and the cash have been transformed into the trading data for the held products at the end of 2019 and the cash balance by various trading. The information generation unit 3021 creates the overall profit and loss level trading data by rewriting the year-end held issue at the market value at the beginning of the year and valuing the year-end held product at the market value at the end of the period.

Specifically, the following processing is required. Based on the valuation amount at the time B, the information generation unit 3021 evaluates the untraded trading data at the time B in order to calculate the balance (it is better to evaluate in the first step or the second step). The information generation unit 3021 adds together the un-traded data and the anti-traded data, and changes the value at the time point A when the purchase date is before the time point A (see FIG. 23 and the like).

The method of revaluation is explained in detail in the section on trading data subject to aggregate by period. There are two notation methods, as described above. Further, items such as the overall profit-loss ratio may be added.

### (Definition of 2nd Level Trading Data)

The total profit-and-loss level trading data is divided into a trading profit-and-loss level trading data in which profit and loss are determined by reverse trading, and an unrealized profit-and-loss level trading data in which profit and loss are undetermined in unrealized trading, and the profit and loss at this stage are defined as the second-level trading data (see a diagram in which a total profit and loss of 22.3 million yen in FIG. 42 is branched into a trading profit and loss of 16250000 yen and an unrealized profit and loss of 6050000 yen).

### (Old Method of 3rd Level Trading Data)

In the first embodiment, a method of calculating the trading profit and loss is described, and the valuation indicators calculation changes according to the level stage. In addition, there are indices for valuation of trading profit and loss and basic figures. Describes the types of valuation indicators, diagnosis procedures, decompose formulas, etc., but does not describe how to extract and process trading data to evaluate trading gains and losses and Unrealized profit and losses.

### (Problems of Second-Level Trading Data)

The total profit-and-loss level trading data includes a mixture of past and current results, so only the overall picture is known. We do not know which of the profits or profit and losses we hold and the profits or losses we buy or sell, whether both are profitable, whether the transactions we buy or sell are profitable or losing, and how much the average trading period is winning.

By separating the Trading profit and loss level trading data from the Trading profit and loss level trading data, the trading profit/loss and the unrealized profit/loss level Aggregated target trading data can be evaluated.

Although the old method is a decomposition method, the second-level trading data can be created by extracting and processing the trading data, and by evaluating the trading profit/loss and the unrealized profit/loss on the basis of this, different effects can be expected by taking advantage of the respective characteristics.

### (Second Level Means)

The information generation unit 3021 extracts (or classifies, aggregates, or processes) the trading profit-and-loss trading data that has already been counter traded and determined and the unfixed unrealized profit-and-loss trading data that has not been counter traded, respectively, based on the Aggregated target trading data, and creates trading data.

Hereinafter, the processing of the Aggregated target trading data by period will be described separately from the processing of the Aggregated target trading data by period.

### (Processing of Sales and Purchase Data Subject to Aggregate by Period)

The information generation unit 3021 extracts the sales data having the purchase date or the sale date during AB period or the sales data held at the B time point.

Information generating unit 3021, the buy and sell data having a date of purchase during AB period, if there is opposite trade during AB period, classified into buy and gain level buy and sell data, if it is held at the time point B, and classified into profit level buy and sell data (3 and 4 in FIG. 23).

The information generation unit 3021 performs the evaluation at the time A in the case where the purchase date is before the time A among the sale data having the sale date during AB period (2 in FIG. 23), and in the case where the sale date is before the time A, the evaluation is performed at the time A in the case where the sale date is before the time A (1 in FIG. 23), and thereafter, the evaluation is performed at the time A in the case where the sale date is before the time A (4 in FIG. 23).

The information generation unit 3021 creates profit-and-loss trading data and unrealized profit-and-loss trading data by re-evaluating the investment commodity held at time A from the purchase market price at time A (even if a separate item is set).

Specifically, the information generation unit 3021 changes the valuation of the commodity held at the time A of the trading profit and loss trading data at the time A, and changes the valuation of the commodity held at the time A of the unrealized profit and loss trading data at the time A. This is performed by calculating the profit and loss by changing the purchase price of the purchase data before the purchase date A into the market price at the time A instead of the purchase unit price.

Here, if there is trading data at time B, it is easiest to create trading data by period. (See the section on aggregated trading data by period.) For this reason, it is desirable to store the trading data in time series. Further, the information generation unit 3021 appropriately adds items such as a total trading profit/loss, a winning profit, a Winning profit margin, and a trading period to the Trading profit and loss level trading data (create FIG. 33 based on FIG. 26), or extracts, classifies, sums, and processes the items for each issue, period, and investor as a constituent item, thereby creating second-level trading data suitable for the purpose.

The information generation unit 3021 appropriately adds items such as the aggregate unrealized profit/loss, the unrealized profit/loss, the unrealized profit rate, the holding period, and the like to the unrealized profit and loss level trading data, or extracts, classifies, sums, and processes the items for each issue, period, and investor that are constituent items, thereby creating second-level trading data suited to the purpose. In addition to the above-described methods, the period-specific trading target data can be created by combining the valuation amount at the time A, the set of the traded data, the valuation amount at the time B, the set of the traded data, and the trading data of AB period. This is also one of the methods of creating the transaction data to be aggregated for each period described above (refer to four types of the section on transaction data to be aggregated).

### (Second Level Effect)

The trading profit/loss trading data and the unrealized profit/loss trading data are created by processing the trading data (in the case of a purchased product, only the sold commodity is extracted) already determined by reverse trading and the undecided trading data (in the case of a purchased commodity, the commodity that has not been sold is extracted) which has not been subjected to reverse trading.

Especially, when creating trading data to be compiled by period, trading data by component, and the like, it is often found at the second level, so that the effect is large.

In the case of each period, the calculation of the calculation formula of the old method results in a complicated calculation (it is not possible if the number of sales data is large), but according to the present embodiment, by processing the sales data, more easily, the sales profit/loss trading data and the unrealized profit/loss trading data for each period with excellenttability can be created, there is an effect of facilitating the evaluation of the period. Further, by adding items as appropriate, for example, the trading profit-loss ratio can be viewed for each trading data, so that an effect that is not in the old method can be expected.

### (Specific Examples of Second-Level Trading Data)

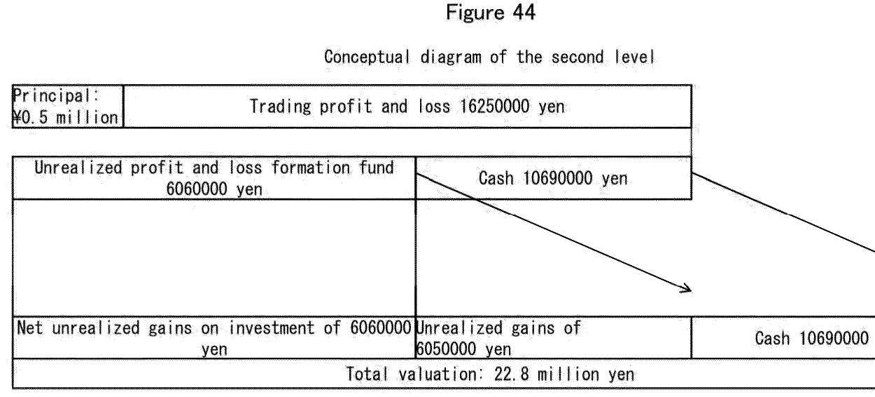

FIG. 44 is a diagram illustrating a specific example of second-level trading data according to the present embodiment. For example, in the case of the 0.5 million yen course in FIG. 44, a profit of 22.3 million yen is generated at the overall profit/loss level, but the profit/loss on sale can be decomposed into 16250000 yen and the unrealized profit/loss can be decomposed into 6050000 yen, and can be further extracted, classified, tabulated, processed, extracted, classified, tabulated, processed for each brand, or the like for various purposes.

### (What is Second-Level Trading Data)

The third level separates the trading profit level trading data from the trading loss level trading data, while the second level combines trading data in which the profit is determined by trading against the trading profit level trading data, including trading data in which the loss is determined.

### (Definition of Second Level Period Separates Aggregation Object Trading Data Definition)

Transaction data to be aggregated by period at the second level, i.e., trading profit/loss level and unrealized profit/loss level, is defined as the transaction data to be aggregated by the second level period. The difficulty of calculating the trading data by period has been touched on occasionally, but it is particularly difficult to generate profits and losses at this second level. The profit and loss at the first level can be made simple, but there is a problem that the profit and loss at the second level are not easy if the period is separated from the unrealized profit and loss. When the period is divided, it becomes very difficult to compare the past period in particular, because the trading data, which was profit or loss, becomes Unrealized profit and loss, the trading data, which was Unrealized profit and loss, becomes profit or loss, the purchase price also needs to be changed, and various operations are required.

(Issues with Conventional Technology)

In the case of portfolios in securities accounts, it is difficult to compare the portfolios by period. It is very difficult to tell what happened in 2020 and what happened this month, etc. in terms of the change in the valuation. Only the first level of total profit and loss valuation is carried out, and the change in valuation is at the mountain of the concern (the details of the trading data to be compiled by period in the trading data to be compiled) In terms of this point, the change in valuation is sufficient for investment trusts, etc., and there is little problem because it is sufficient to know what the valuation amount has become rather than the content of the frank trading. However, in the case of individual stock trading, by taking control at the second level, various problems can be solved and the actual situation becomes clear. For this reason, it is necessary for individuals who make individual stocks to compare periods in an easy-to-understand manner.

### (Effects of Effects of Second Level Period Separates Aggregation Object Trading Data)

If the information processing system first creates the Trading profit and loss level trading data and then creates the Aggregated target trading data by period, it appears at first glance that the period comparison of the trading profit/loss level can be made simple. However, it is also mentioned in the target of the trading data to be compiled by period. When the trading data are divided by period, the trading data are generated at the trading profit/loss level and the trading data are generated at the unrealized profit/loss level. This makes it difficult to accurately evaluate the profit or loss for the period. However, in order to evaluate the trading in AB period, if the information processing system is created based on the trading data at the time point B, it is only necessary to evaluate the trading data at the time point A, so that the valuation can be changed very easily. If the information processing system attempts to create the trading data for AB period with the trading data at the time point c after the time point B, the information processing system is forced to revise the trading data from the time point B to the time point C in addition to the re-valuation at the time point AB. In particular, big data may become incomprehensible. Therefore, if the first step is to create an environment that can be referenced at any time by keeping these trading data at point A and point B, the second step is to create second-level trading data at point B, the third step is to extract trading data for only AB period (purchase time<point A and sell time>point A) or purchase time>point A), and the fourth step is to perform only the change of evaluation at point A based on the trading data at point B, these issues can be solved. It seems surprisingly simple, but it is very difficult to repeat a variety of trials and errors until it is finally possible to do a simple task, to understand everything, and to drop it into a simple task for the first time.

### (Effects and Specific Examples of Sales Data Subject to Aggregate by Level 2 Period)

The ability of the information processing system to create the data to be aggregated for each period at the second level is very effective in subsequent processes, and various effects can be expected. For example, in 2020, SoftBank's average trading profit-loss ratio is? In 2020, what is the leading trading profit-loss ratio in which stocks? and other articles can be easily generated by the information processing system. It is this second level that allows us to compare the skills of buying and selling and the interests of the owners, and only when we have a 2020-year period separation and a period comparison are made, it becomes meaningful information. The ability to compare periods at the second-level profit-loss level makes it easier to rank and compare the skills of buying and selling, and to accurately compare the results of possible-to long-term investments with those of short-term trading. We can expect a variety of content to emerge. The effects of collaboration between the trading data to be compiled and the second-level trading data by period, which was the biggest obstacle to investor evaluation, are enormous.

### (Definition of Sales Data by Second-Level Component)

What do you think of creating component-by-component trading data based on second-level trading data? For example, based on the Trading profit and loss level trading data (data on which trading is completed), the trading can be verified again from various angles. The components of the transaction data to be tabulated, that is, issues, periods, technical analysis, and business performance, can be recaptured from various angles, and what kind of trading should be carried out, what is bad, and what should be improved. For example, when the trading data at the trading profit/loss level is generated from the trading data for each issue of the trading data for each trader (investor A), it becomes clear which brand the trader A won and lost in which brand.

(Issues with Conventional Technology)

The past trading history is usually buried, and the verification is not advanced. PDCA of the outcome of the investor is not running. However, when this second-level component sales data is created and utilized, various problems and findings can be seen, and a path for improvement can be seen.

### (Operation of Sales Data by Second-Level Component)

When the Trading profit and loss level trading data is divided into, for example, the most recent 0-10% group based on corporate performance, the most recent 10%-30% group, the most recent 30%-2× group, and the most recent 2× or more group based on corporate performance, it can be seen at a glance that the brands in the more than double group and the 0-10% group have been traded. By extracting (or classifying, aggregating, processing) the trading data and further extracting (or classifying, aggregating, processing) the extracted (or classifying, aggregating, processing) trading data by component, it is possible to create the trading data by component and to capture the trading data based on the business performance, etc. The same applies to the sales data at the level of Unrealized profit and loss. Now, it is possible to expect an effect of making it clear at a glance which brands all have unrealized profits and which brands have unrealized losses, and it is possible to expect an effect that a large number of various articles and data for creating attractive contents can be generated by the information processing system.

### (Effects of Sales Data by Second-Level Component)

The component-by-component sales data further divides the aggregation target sales data into components to grasp the sales data, so that the sales data can be viewed from various angles. For example, rather than answering for SoftBank shares in 2020, the ratio of trading profit to loss by type of investment in 2020 (short-term traders and medium- to long-term investors) would be more detailed and interesting for more users. This is the collaborative effect of the component trading data and the second-level profit and loss level trading data. This allows for a single, double, and deeper analysis than the trading data.

### (Specific Examples of Sales Data by Second-Level Component)

Since there is a point of view for each component, for example, it is the simplest case to aggregate Mr. A's investment results for each issue. Even in this simple case, however, we can see at a glance which securities are losing money in trading, which securities are making money, and the profit ratio is the profit ratio.

### (Definition of Trading Data Subject to Aggregation by Level 2 Investment Subject)

This second level is obtained by recalculating the Aggregated Target Trading Data by Investment Target using trading data at the trading profit/loss level. For example, if we compare a stock investment target and a virtual currency investment target at the profit-loss level, it becomes possible to compare which one has a long holding period and has a high profit rate, and whether the winning rate is, and it becomes increasingly apparent that it is not known at the first level which one has an unrealized profit. An issue can tell people who are making a profit, whether they are making a profit by buying or selling, whether they are making a profit by holding, and whether they are making a profit more.

(Issues with Conventional Technology)

For example, S Ltd. shares do not appear in the world, such as how much people buy and sell, and how much people continue to buy and hold on average, and how much Unrealized profit are held. However, this second-level trading data can be used to quickly derive an answer using the information processing system. It is important to look at the second level in order to see whether there are gains from trading or holding. The lack of visibility at the time of the overall profit and loss is rapidly expanding. When looking at total profits and losses, it is difficult to understand the results of investment commodities. This is because there is no distinction between trading and holding. In practice, however, some investments are successful in buying and selling frequently, some are successful in holding, and others are successful in buying and selling, but some are unsuccessful and others are unable to see them due to unrealized losses. It is very important to look at the investment target products at the second level in order to evaluate them correctly.

### (Effects of Sales Data by Level 2 Investment Target)

The information processing system may create the Trading profit and loss level trading data first, the trading data to be counted by the investment object may be created by the information processing system, the trading data to be counted by the investment object may be created first, and the trading data to be traded at the trading profit/loss level may be created by the information processing system.

### (Effects of Sales Data by Level 2 Investment Target)

For example, the aggregation target trading data for each investment target can be created by creating the aggregation target trading data for each investment target with “extraction condition: brand=SoftBank shares” and creating the Trading profit and loss level trading data and the unrealized profit and loss level trading data, thereby creating the aggregation target trading data for each investment target at the second level. As a result, the various valuation indicators calculated by the information processing system can calculate valuation indicators that can answer all questions of the previous SoftBank shares.

### (Specific Examples of Sales Data by Level 2 Investment Target)

Many specific examples are given. For example, it is possible to divide the winning rate of stock by brand and divide it into a high winning brand group, a low brand group, etc., to create the generated data by the information processing system. These may be added to the diagnostic materials and brand information, and can be used in a variety of ways, including ranking and compare.

### (For Each of the Second-Level Trading Data)

### (Old Method of Trading Profit-Loss Level Trading Data)

In the first embodiment, there are a method of calculating the trading profit and loss, and a description indicating that the valuation indicators calculation changes according to the level stage. In addition, there are indices for valuation of trading profit and loss and basic figures. The type of valuation indicators, procedure of diagnosis, decompose formula, etc. are described.

### (Problems of Trading Profit-Loss Level Trading Data)

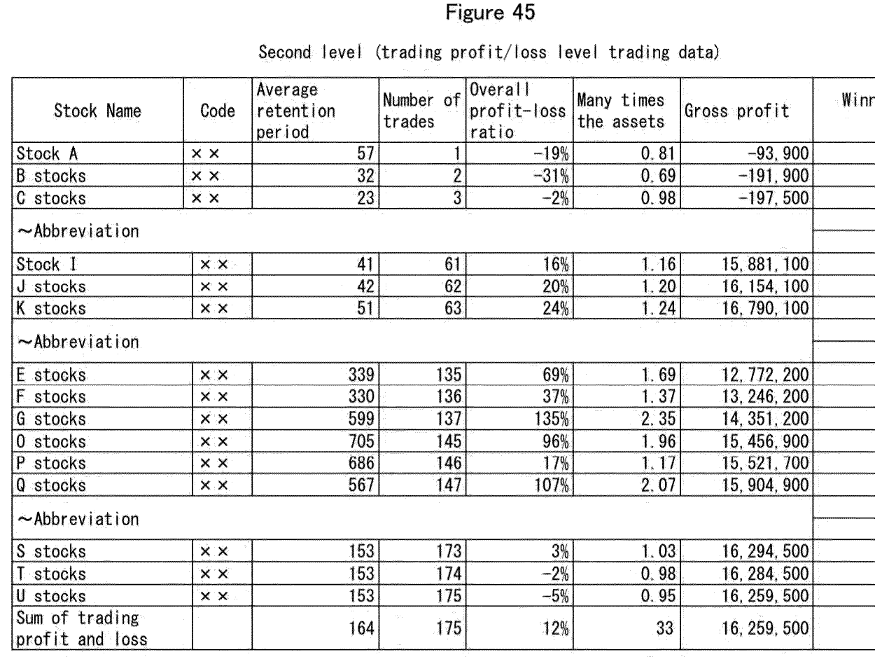

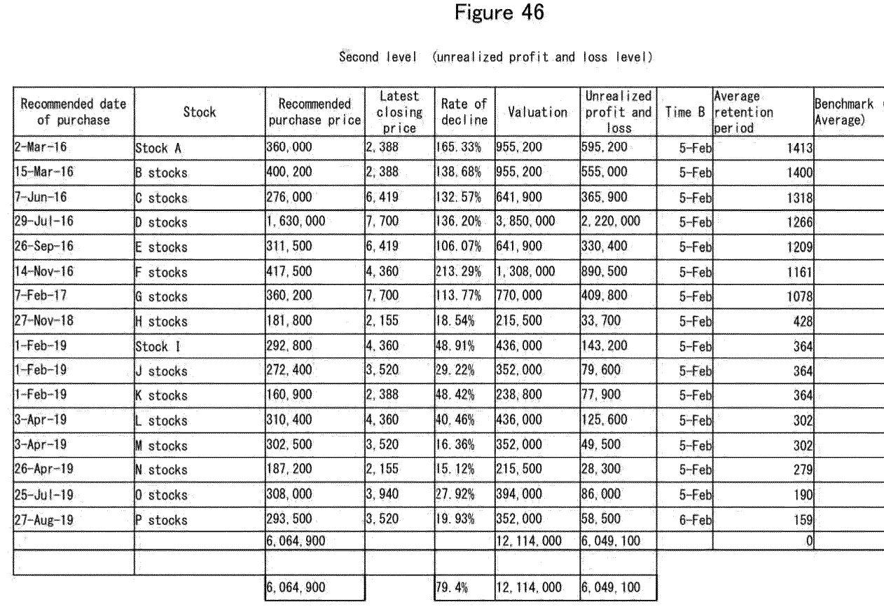

The Trading profit and loss level trading data allows evaluation of trading profit/loss. Although the old method is a decomposition method, the Trading profit and loss level trading data can be created by extracting (or classifying, aggregating, or processing) Aggregated target trading data, and the trading situation is evaluated at the trading profit/loss level to be aggregated using this as a reference. FIG. 45 is a diagram illustrating a specific example of a second level (Trading profit and loss level trading data) according to the present embodiment. FIG. 46 is a diagram illustrating a specific example of a second level (an unrealized profit/loss level) according to the present embodiment.

### (Means of Trading Profit-Loss Level Trading Data)

The information generation unit 3021 extracts and processes the trading profit and loss trading data that has already been determined by reverse trading on the basis of the trading data to be counted, and generates trading data.

The information generation unit 3021 generates the trading profit/loss trading data by changing the value of the trading target trading data for each period from the purchase market price to the market price at the time A with respect to the investment commodity held at the time A. Specifically, the products held at time A in the trading profit and loss data are revalued at the current price at time A. Further, the information generation unit 3021 calculates the number of revolutions, the number of revolutions of the trading issue, the number of revolutions of the trading brand, and the like together with the principal by totalizing the total value.

### (Effects of Trading Profit and Loss Level Trading Data)

Taking the effect of trading data by period as an example, in the case of period-specific calculation, the calculation of the conventional calculation method becomes a complicated calculation, by processing the trading data, more easily, it is possible to create the trading profit and loss level trading data by period, the effect of facilitating the evaluation of the period. Furthermore, the aggregate and evaluation of each trading data is difficult with the old method, but the Trading profit and loss level trading data is very easily possible. In addition, by linking the stock price table and the issues of the trading data in the manner shown in FIG. 86, the market price update information of the brands is renewed even with respect to the sale and purchase of the brands that have been sold one by one, so that not only the influence on the trading data at the level of Unrealized profit and loss but also the fourth level that will be given later, etc., have a special effect. Especially, if the process of creating the modified trading data table is performed in the first step, this process is further simplified.

### (From Trading Profit and Loss Level Trading Data)

The third level separates the winning profit data from the losing loss data, whereas the second level combines the winning profit data with the losing loss data, and thus is created in order to evaluate an overall view of the trading state to be aggregated in the trading data of the entire trading profit and loss.

### (Significance of Unrealized Gain/Loss Level Trading Data)

The overall profit/loss level is divided into profit/loss trading data in which profit/loss is determined by reverse trading and unrealized profit and loss level trading data in which profit/loss is determined, and unrealized profit and loss level trading data in which profit and loss level trading data is not performed in reverse trading are treated. Again, as mentioned above, it can be expected that if a table is managed by dividing the market value by a separate table, daily updates are enjoyable, time-series data can be easily acquired, and graphs such as the valuation of stocks held can be easily created. In addition, the effect is large when the creation of the Aggregated target trading data by period is timely performed on the trading data at the unrealized profit/loss level. It can be expected that the actual status of the issues held will be better understood. Although Unrealized profit and losses increased in 2019 rather than simply the amount of Unrealized profit and loss or the rate of profits or losses, in 2020, the unrealized losses increased (when compared to the end of 2019, they became unrealized losses in other cases) and the valuation of the same Unrealized profit and losses became deeply valuable, making it very effective to grasp the actual situation. Further, in addition to the stock price data, linking the stock information and the stock with the date produces various effects. In particular, when the issue information of the trading data to be counted for each investment target is linked in the brand table, the brand information and the trading data are directly linked to each other, so that it becomes easier to manage and the relationship between the trading and the brand can be deeply understood. Furthermore, in the case of stocks and dates, various effects can be produced by linking performance trends and technical indicators with purchasing data (described later). In particular, it can be expected that information on the issues held will be easily entered immediately due to the linkage of stock information and the like in this data on sales at the level of Unrealized profit and loss, and that when the trend of the stocks held changes, it will become easier to react.

### (Problems of Unrealized Profit and Loss Level Trading Data)

Unrealized profit/losses trading data can be used to evaluate Unrealized profit/losses. Existing technology is a decomposition method, but by extracting and processing trading data, it is possible to create unrealized profit and loss level trading data, and based on this, it is possible to evaluate unrealized profit/loss.

### (Means of Unrealized Profit and Loss Level Trading Data)

The information generation unit 3021 extracts (or classifies, aggregates, or processes) the unconfirmed trading data that has not yet been counter traded on the basis of the Aggregated target trading data, and creates unrealized profit and loss level trading data.

The information generation unit 3021 generates unrealized profit and loss trading data by changing the value of the investment commodity held at the time A from the purchase market value at the time A to the market value at the time A in processing in the case of the period-based aggregation target trading data.

Specifically, in the unrealized profit and loss trading data, the unit price of the held product with the purchase date before the evaluation of time A among the commodities held at the point of time B is revalued at the point of time A. In addition, items such as the Unrealized profit and loss ratio and the holding period are added to the unrealized profit and loss level trading data as appropriate, or aggregated for each issue or period, thereby creating unrealized profit and loss level trading data that suits the purpose.

### (Effects of Unrealized Gain/Loss Level Trading Data)

An example of a case where the data is aggregated for each issue of the constituent elements in the transaction data to be aggregated by period will be described. In the case of period-effect calculation, the calculation of the calculation formula of the old method results in a complicated calculation, but by processing the trading data, it is possible to more easily create unrealized profit and loss trading data for each period, to facilitate evaluation of the period, and to process the unrealized profit and loss level trading data by totaling by brand and by the date of purchase.

### (Combined Effect of Trading Data at Unrealized Profit/Loss Level and Trading Data by Component)

### 2021 Feb. 25 Additional

### (Definition of Sales Data by Component of Unrealized Profit and Loss Level Trading Data)

When the unrealized profit and loss level trading data is classified (tabulated) by the component-by-component trading data, various operations can be performed. The number of components can vary, but some specific examples are given.

### (Technical Index Values)

What would be possible if the information processing system created the data on sales and purchase at the level of Unrealized profit and loss by using the component as a technical index value in the data on sales and purchase subject to aggregate by investor? Investor A's unrealized profit-and-loss-level trading data is divided into RSI of technical indices, and RSI are divided into 20%, 20% to 50%, 50% to 80%, and 80% or more, and the trading data is divided according to the classification criteria. The investor's holdings are then categorized according to the range of RSI. At this time, you can use RSI at the time of purchase (RSI associated with the purchase) or the present value RSI (RSI associated with the present value). So far, we have created the data by component. Even so, investor A's list of stocks is displayed in categories according to the present RSI range.

### (Corporate Results)

Investor A's net unrealized profit and loss level trading data is used as a component of the most recent corporate performance of the stock held. The most recent three-month upward revision is divided into 20% or more, less, no revision, less than 20% downward revision, and 20% downward revision, and the trading data is divided according to the classification criteria. The issues held by investors are then categorized according to the most recent revision in performance.

### (Conventional Problems)

In order to manage the status of stocks held, it is important that various kinds of information are gathered there, and it is ideal that the necessary information is arranged like a dashboard instead of being separated. This can be varied by the user, with performance-oriented users needing performance-related information, and technically-oriented users helping to decide what to do with the holdings if the technical-related information is displayed in the ownership list. The above example is only a part that can be utilized when using the component-by-component sales data.

### (Effects of Sales Data by Component of Unrealized Gain/Loss Level Sales Data)

First of all, we create data on the level of Unrealized profit and losses. After that, it is assumed that the extraction-condition investor is investor A, and the trading data to be counted by investor. Of course, the other way around is fine. Then, when the component-specific aggregation target trading data is set as the classification criterion: RSI, the trading data is classified by RSI. RSI classification tables are prepared, connected by relationships, and tabulated or classified according to the above classification criteria.

### (Effects of Sales Data by Component of Unrealized Profit/Loss Level Sales Data

When the component-specific sales data is used in this way, the information necessary for the investor's judgment is displayed on one screen. Though it is necessary to be a component of trading data, information related to issues (corporate performance, various events, themes), information related to dates and brands (technical index values, etc.), valuation indicators, etc. can all be incorporated by this mechanism, and it becomes possible to collectively manage the necessary information of the brands held by the dashboard. The combination of this component-by-component trading data and the unrealized profit-loss level trading data has many possibilities.

### (Specific Examples of Sales Data by Component of Unrealized Profit and Loss Level Trading Data)

There are still many concrete examples. The theme of the stock market is a topic that individual investors like. It is also possible to list issues that have the same theme as the stocks they hold, and to rank which stocks have risen the most during this holding period. This information can be provided only because the information processing system can acquire the information in a consistent flow from the second step. Further steps can be taken to derive the probability of success for this theme.

### (Unrealized Profit/Losses Level Trading Data)

The third level divides the unrealized profit data and the unrealized loss data, while the second level combines the unrealized profit data and the unrealized loss data. Therefore, the valuation indicators for the entire unrealized profit and loss are calculated to evaluate the overall state of possession to be tabulated.

### (Significance of Linked Unrealized Gain/Loss Level Trading Data)

Unrealized profit/losses-level trading data deals with trading data that are not counter traded, but in the case of interlocking evaluation, by introducing the concept of Unrealized profit/losses-forming funds, which is the basis of Unrealized profit/losses-level trading data, it becomes a model that includes this principle and a cash ratio (any one of them).

### (Definition of Unrealized Profit/Losses Formation Funds)

Net Unrealized profit and losses are, as the name implies, funds that are used to form Unrealized profit and losses.

The amount of increase in the current total valuation from the principal is expressed as follows: total valuation=principal+gross profit. On the other hand, if the total valuation is recalled to be the current balance, it will be net Unrealized profit and loss+cash+Unrealized profit and loss. In the simplest example, if you invest 100% of Mr. S's principal (1 million yen) and the price of the stock has risen by 10%, the total valuation amount is 1 million yen+0.1 million yen=1.1 million yen, and the total profit amount is 0.1 million yen and the principal amount is 1 million yen. On the other hand, because 100% of net Unrealized profit/losses are generated, net Unrealized profit/losses are 1 million yen and 0.1 million yen.

Next, assuming that the stock held by Mr. S continued to rise and became three times, if we look at the case where the profit was fixed, the valuation amount would be ¥1 million+¥2 million=¥3 million, and the total profit would be ¥2 million and the principal would be ¥1 million. (See FIG. 109) On the other hand, the Unrealized profit/losses formation fund is 0 because it was sold, the cash is 3 million yen, and it is 0 because it does not hold Unrealized profit/losses.

Next, if Mr. S spends 100% of the 3 million yen to buy the A issue and the A issue rose 10%, the total valuation amount would be 3 million yen+0.3 million yen=3.3 million yen, and the total profit would be 2.3 million yen and the principal would be 1 million yen. On the other hand, because 100% of funds are invested, Unrealized profit/losses are 3 million yen and Unrealized profit/losses are 0.3 million yen (see FIGS. 109 and 88).

On the other hand, even for the first time at the same price of 1 million yen, even if Mr. A, who has not yet made a profit, purchases the same issue of A at the same time, the total valuation amount is 1 million yen+0.1 million yen=1.1 million yen, and the total profit amount is 0.1 million yen and the principal amount is 1 million yen. On the other hand, because 100% of net Unrealized profit/losses are generated, net Unrealized profit/losses are 1 million yen and 0.1 million yen. At the same time, starting with the principal amount of 1 million yen, even if the entire amount of the principal is invested at the same time, Mr. S holds an Unrealized profit and loss of 0.3 million yen with an Unrealized profit and loss formation fund of 3 million yen, while Mr. A only has an Unrealized profit and loss of 100,000 yen with an Unrealized profit and loss formation fund of 1 million yen (see FIG. 109). Mr. S has a compounding effect, so even if the same 10% increase is made, it will increase by 0.3 million yen, and in terms of the principal, it will increase by 30%. On the other hand, Mr. A is still increasing by only 10% from the principal, because the compounding effect is not effective. Here, the concept of net Unrealized profit/losses generating funds is effective. There is nothing else to increase in the snowman-style because of this increase in net unrealized profit-generating funds. In the comparison between Mr. A and Mr. S, the difference between ¥1 million and ¥3 million was made at some point, so the latter became more and more dominant.

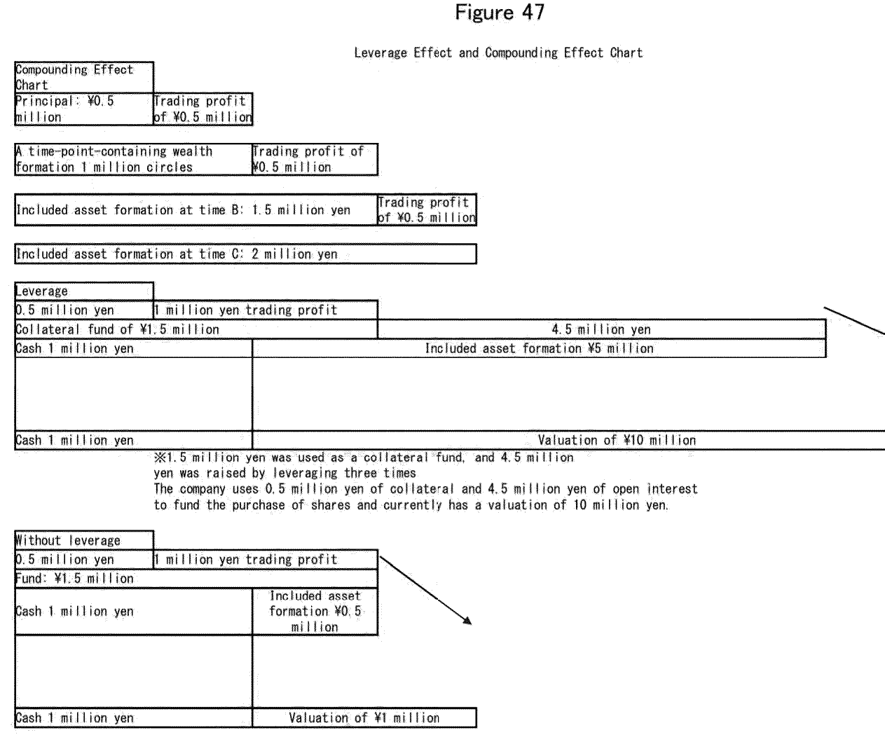

FIG. 47 is a diagram illustrating a compounded interest effect diagram, leverage, and a non-leveraged example according to the present embodiment.

Principal+trading gains and losses-cash=net Unrealized profit and losses

Or

(Principal+trading profit or loss-cash)×leverage rate(purchase price/credit collateral,generally3.3times for securities companies,up to25times for FX, and 2times for virtual currencies),depending on the timing)=unrealized profit and loss formation fund

The former is the case of non-leveraged cash transactions.

The latter is a leveraged margin transaction.

For example, if the principal starts at ¥500,000 and the initial trading profit is ¥1 million, in the case of a cash transaction, if ¥1 million of the fund that has become ¥1.5 million is left as cash, if the fund for forming Unrealized profit/losses is doubled at ¥500,000, then ¥500,000 will become Unrealized profit and the valuation amount will be ¥2 million (see the figure without leverage in FIG. 47).

On the other hand, in the case of leveraging, even if the trading profit of 1 million yen is the same, even if the collateral fund is 1.5 million yen and the cash of 1 million yen is left in the same way, the total fund of 5 million yen, which is 4.5 million yen, which is three times the collateral fund of 1.5 million yen, and the cash of 0.5 million yen, becomes the unrealized profit and loss formation fund, and if the trading profit is double, 11 million yen (1 million yen in cash, 5 million yen in unrealized profit and loss formation fund, 5 million yen in unrealized profit and loss formation fund) becomes the valuation amount (see the leveraged figure in FIG. 47).

Net Unrealized profit/losses are increased as profits become more definite, and increased as leverage increases. The more money we invest in the whole without leaving the money, the more money we can add to the profit and loss formation. Therefore, Unrealized profit/losses are influenced by principal, gains/losses on sales, leverage ratios, and cash ratios.

In the case of the interlocked unrealized profit and loss level trading data, the inclusion of such a concept allows the inclusion of the compound interest effect, the leverage effect, and the cash ratio, thus enabling the evaluation to be dramatically upgraded compared with the previous method.

### (Problems of Linked Unrealized Profit/Losses Level Trading Data)

Unrealized profit and losses level trading data enables the creation of Unrealized profit and losses level trading data through the extraction and processing of trading data, which enables the valuation of Unrealized profit and losses on the basis of the data. However, Unrealized profit/losses are largely influenced by gains/losses on sales, cash ratios, leverage effects, and other factors. Although the old method was different from the past buying and selling results, the linked unrealized profit/loss level buying and selling data is linked to the past buying and selling, leveraging effects, and so on. Therefore, it is possible to make an evaluation more realistic, resulting in a remarkable effect.

### (Means of Linked Unrealized Profit/Losses Level Trading Data)

As explained in the definition of the unrealized profit and loss formation fund, unrealized profit and loss formation fund+cash+unrealized profit and loss=total valuation amount=principal+gross profit (trading profit and loss+unrealized profit and loss), and unrealized profit and loss formation fund=principal+trading profit and loss-cash. Therefore, in the case of interlocking unrealized profit and loss formation funds, it is important to add the principal, profit or loss on sale, and cash to the items in the unrealized profit and loss table. These figures are incorporated into the Unrealized profit/losses model by placing a constant value (the value at that time) for each transaction data or by placing these amounts in the total value column. In addition, by adding Unrealized profit/losses generating capital/principal=compounding effect to the item, it becomes one of the important valuation indicators. In the case of Mr. A and Mr. S, Mr. A's compounding effect index is 1 million yen/1 million yen, and Mr. 1, S's compounding effect index is 3 million yen/1 million yen, which is 3 yen (see FIGS. 109 and 88), and the compounding effect is properly incorporated into the table, which makes it possible to add to the valuation indicators and also to the evaluation of the holding status, and also provides the trading data that is sufficiently powerful in steps such as comparison. The trading data thus created is defined as interlocking unrealized profit and loss level trading data.

The information generation unit 3021 processes the unrealized profit-and-loss level trading data to generate interlocked unrealized profit-and-loss level trading data (even if it has been brought to the previous step).

Since the sum purchase amount of unrealized profit and loss level trading data is “principal+profit/loss-cash”, when three items are added and leveraged, in addition, the total purchase amount of leverage rate, open interest, and cash is added to create interlocked unrealized profit and loss level trading data by the information processing system (it is possible to have it in the previous process).

While Unrealized profit/losses do not increase, when Unrealized profit/losses are realized, cash increases/decreases and sales gains/losses also increase/decrease. Accordingly, the realization of Unrealized profit and loss results in interlocked Unrealized profit and loss level trading data incorporating an interlocked type in which the trading profit or loss increases or decreases and the cash increases or decreases.

With this mechanism, past gains or losses on trading can form the current Unrealized profit and loss, and the current Unrealized profit and loss can become trading data incorporating the relationship that will generate future gains or losses on trading (see the effect interest diagram in FIG. 47).

In the case of leverage, the funds for the formation of Unrealized profit and losses on the building and the cash are added to the funds for the formation of Unrealized profit and losses on the building and the cash are added to the funds for the formation of Unrealized profit and losses on the building.

### (Effects of Locked Unrealized Gain/Loss Level Trading Data)

By creating unrealized profit and loss level trading data of an interlocking type, it is possible to easily calculate the cash ratio, the trading profit/loss ratio, the Unrealized profit and loss ratio, the opportunity loss of cash, and the like, and the level of evaluation of the unrealized profit and loss level trading data is improved.

Cash ratio=Cash/Net trading gains/losses+Unrealized profit/losses+Principal

Trading profit/loss ratio=Trading profit/loss/(Trading profit/loss+Unrealized profit/loss+Principal)

Unrealized profit/losses ratio=Unrealized profit/losses/(Trading gains/losses+Unrealized profit/losses+Principal)

Composite effect index=Unrealized profit/losses generating capital/principal.

### (Effects of Locked Unrealized Gain/Loss Level Trading Data)

In the normal Unrealized profit/losses level trading data, the gains/losses on trading are not in the model and are out of control. However, the model of the interlocking unrealized profit and loss level trading data can be expected to have a special effect in that trading profit/loss, cash, compounded interest effect index, and principal are incorporated into the model so that the current situation can be accurately grasped. In the trading table for Mr. S, the principal amount of 1 million yen, the profit or loss of 2 million yen, and the compounded interest effect index of 3 are added, so that the number of valuation indicators that can be managed increases. In the evaluation step, the effect that these valuation indicators can be used to evaluate the current situation can be expected to be an unknown effect. The difference is clear, even if one is to grasp the current status of Mr. A and Mr. S. According to the valuation indicators calculated from ordinary Unrealized profit/losses trading data, the current situation is grasped only by the difference in the amount of investment between Mr. A, which is a 10% increase in the amount of investment of Company A and a 1 million yen investment, which is 1.1 million yen, and Mr. S, which is a 3 million yen investment, which is a 10% increase in the amount of investment, which is 3.3 million yen. On the other hand, in the case of the interlocked unrealized profit and loss level trading data, Mr. A, who is holding 10% of A and has 1.1 million yen in 1 million yen in investment, has no compounding effect yet, and he/she has not achieved any trading prize. On the other hand, Mr. S, who is holding 10% of A and 3 million yen in investment, has started with a principal of 10,000,000 yen, and has already recorded a past profit of 200,000 yen, and the compounding effect index has reached 3, the difference can be clarified. While the current situation has originally come from past accumulation, the conventional unrealized profit and loss level trading data does not grasp this past accumulation, while the fact that the results of past accumulation are incorporated into the interlocked unrealized profit and loss level trading data has a significant effect on subsequent processes. This is an innovative invention for grasping the current status of investments, since the portfolio of ordinary current status grasps does not have this concept, and it is managed by the ordinary unrealized profit and loss level trading data.

Furthermore, in the case of margin trading, (principal+profit or loss-cash)×leverage ratio will be added to the model. The addition of leverage rates to one of the items further increases the compounding effect index. For example, if the leverage ratio is 1, the compounding effect index is 3 in the previous example of Mr. S. However, assuming that Mr. Z multiplied the leverage by 2, the net Unrealized profit/losses formation fund is 6 million yen, which is 2 times the net Unrealized profit/losses. 10% of 6 million yen is 0.6 million yen. A is 0.1 million yen, S is 0.3 million yen, and Z is 0.6 million yen. This is the result of a leverage factor of 2 and a compounding effect index of 6 (refer to FIGS. 109 and 88). The leverage effect is also an unknown effect of adding to the item, which reveals the principle of the telegraph and the actual state of the compounding effect.

By adding open interest in credit to the valuation, we can see the current level of Unrealized profit and losses on margin transactions. In general, there are announcements about the write-down rate and the quantity of open interest, but the actual situation of open interest in credit is covered by veil, and the benefits of this information are very large. The information on open interest is information that even securities firms use nervous information, which is difficult for investors to see in the world. However, the information on open interest is only available, and the data on the level of Unrealized profit and losses linked to the open interest is useful for grasping investors' realities dramatically.

### (Specific Examples of Linked Unrealized Gain/Loss Level Trading Data)

By incorporating the concept of Unrealized profit and losses-generating funds, the current trading is linked to the past trading, and the reality of the trading in which profits are profitable can be better understood. This leverage effect, which contributes to the investment disparity, and the compounding effect, which increases in the snowfall pattern, are difficult to understand even in ordinary portfolio information, and are also contributors to the investment disparity, so the creation of linked unrealized profit and loss level trading data is significant.

### (Specific Examples of Linked Unrealized Gain/Loss Level Trading Data)

The evaluation step also details this point.

### (Unrealized Profit/Losses Level Trading Data)

The third level divides the unrealized profit and loss data, while the second level combines the unrealized profit and loss data and the unrealized profit and loss data. Therefore, valuation indicators for the entire unrealized profit and loss is calculated to evaluate the overall status of the holding subject to aggregate.

### (Old Method of 3rd Level Trading Data)

In the first embodiment, a method of calculating valuation indicators of a Winning profit margin, an evaluation of a winning profit, valuation indicators calculation, a decomposition formula, and an evaluation of a Winning profit margin (unrealized profit rate) are described. However, the types of valuation indicators, diagnosis procedures, decompose formulas, etc. are described.

### (Definition of 2nd Level Trading Data)

The Trading profit and loss level trading data and the Trading profit and loss level trading data do not differ from each other in the case of winning or losing, and are trading data for grasping the entire trading and holding status (see FIGS. 45 and 46).

On the other hand, the third-level trading data is trading data in which a winning profit is generated and trading data in which a trading loss is generated are divided, and there are a case of the determined profit data (winning profit trading data) and a case of the undetermined profit (unrealized profit trading data). The same applies to losses.

### (Problems of Second-Level Trading Data)

In the old method, for example, there is a method of capturing the winning profit by decomposition, and in particular, the third-level trading data is more suitable for capturing the winning profit by the period and for viewing the trading data by the trading data in detail.

### (Effects of 3rd Level Trading Data)

The information generation unit 3021 extracts, from the second-level trading data, trading data satisfying “buying and selling value (or market price value at time A)<selling value (or current value at time B)” and trading data satisfying “buying and selling value (or current value at time A)≥selling value (or current value at time B)”, respectively, from the second-level trading data, and processes the extracted trading data to generate third-level trading data.

The information generation unit 3021 creates third-level trading data by revaluating the period-specific trading target trading data from the purchase market price to the A market price in the case of the A-time holding investment commodity, and from the sale market price to the B market price in the case of the B-time holding investment commodity.

Specifically, the information generating unit 3021, the purchase date evaluates the unit price of the product before the time A at the time A, the sale date by re-evaluating the unit price of the product after the time B at the time B, to create a third level sales data. Further, the information generation unit 3021 adds items such as Winning profit margins, performs aggregation of constituent elements such as aggregation for each product, and processes and creates third-level trading data suitable for the purpose.

### Effects of 4th Level Trading Data

For example, if we evaluate trading that won in 2019 and earned profits, if the unit price is used as a reference, investment commodities purchased at low market prices in 2012 are highly evaluated. This is inconvenient when you want to divide the valuations by period. Therefore, the market value at time A (beginning of 2019) can be used to accurately assess the results in 2019, which is effective in accurately assessing the winning profits in 2019. Further, by appropriately adding items such as Winning profit margin to the third-level trading data, it is also possible to evaluate for each trading data, by performing aggregate for each component, winning profit It also has a special effect that it is possible to evaluate for each component.

### (Winning Profit Level Trading Data, Loss Level Trading Data)

The winning profit level trading data refers to winning profit (fixed profit) level trading data obtained by extracting the Trading profit and loss level trading data on the condition that the trading value is “trading value<trading value or A time point<trading value (realized profit level)”, or winning profit (undecided profit) level trading data obtained by extracting the Trading profit and loss level trading data on the condition that “buying value<B time point (or present value) or A time point<B time point (or present value)(unrealized profit level)”.

The loss-level trading data is the opposite (replacing < with ≥ in the explanation of the winning-profit-level trading data).

The fourth level classifies the trading data into three categories: buy and sell prices, and market value after sale. On the other hand, at the winning profit level, all the data satisfying “buy price<sell price” are combined. At the winning-profit level, the profit-definite data are not relevant, either significantly down or up after the sale. At the fourth level, on the other hand, an evaluation of what happened after the sale is added. valuation indicators for the overall fixed profit are calculated and evaluated.

### (Profit Level Trading Data Issues)

In the old method, for example, there is a method of capturing winning profit by a decomposition formula, but the generation of winning profit level trading data is more suitable for capturing the winning profit level trading data by a period or finely viewing the trading data.

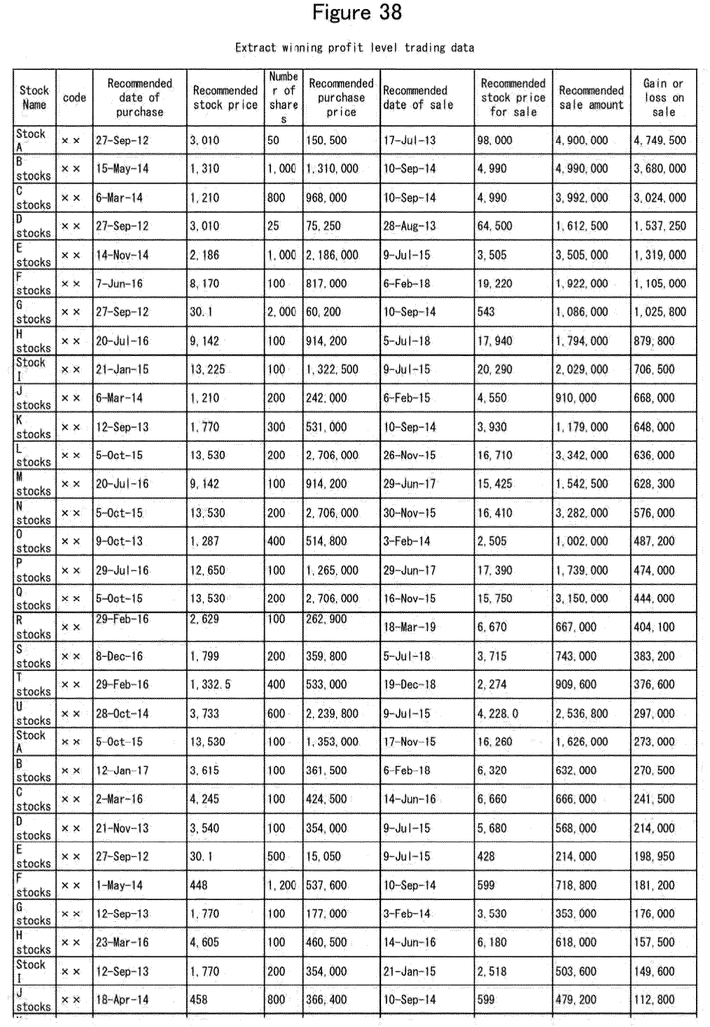

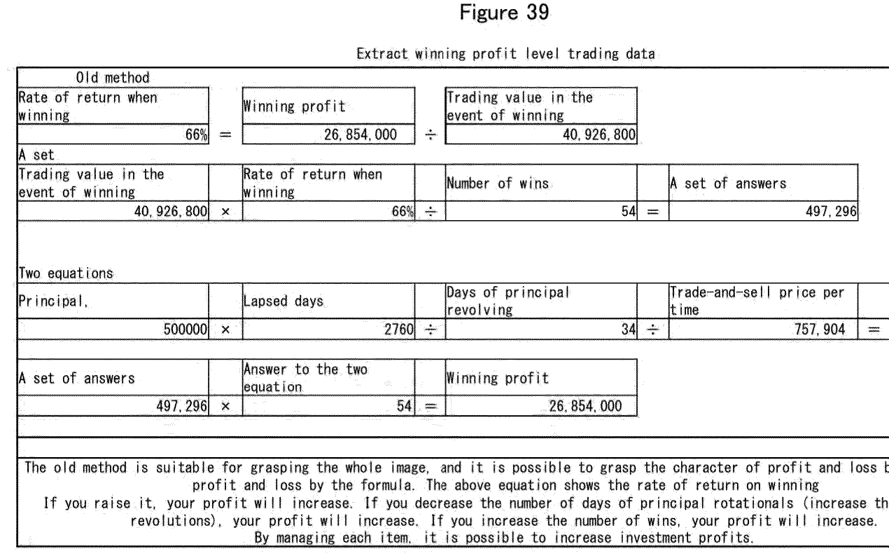

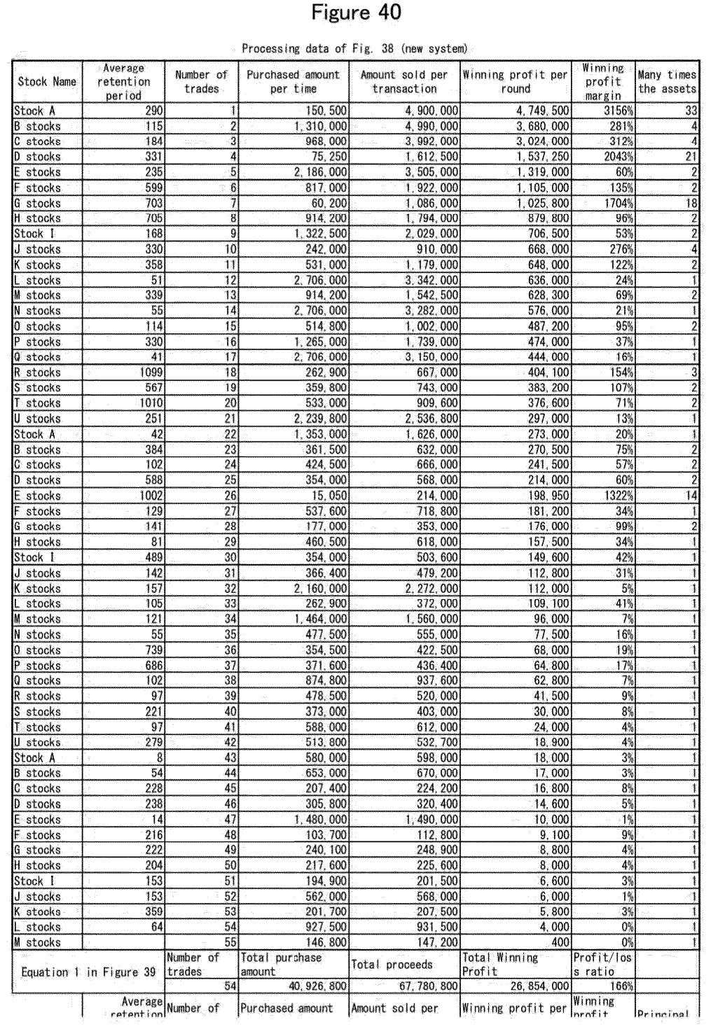

For example, as shown in FIGS. 38 and 40, it is possible to extract the winning profit level trading data, and arrange the winning profit level trading data in descending order of contribution, arrange the trading period, the trading profit and loss, and the purchase amount by the profit ratio of the annualized rate, or show the profit composition ratio for each issue, and indicate the brand having a high profit contribution. As can be seen from the comparison of FIGS. 38, 39, and 40, FIG. 39 is suitable for grasping the overall picture, but FIGS. 38 and 40 have the effect that detailed data for each stock and investor can be evaluated.

The difference between the old method and the new method is not only the winning profit level trading data but also the loss level trading data, the unrealized profit and loss level trading data, the Trading profit and loss level trading data, the overall profit and loss level trading data, and the trading data of the fourth level. The difference between the old method and the new method is clear at all levels from the first level to the fourth level.

### (Means of Winning Profit Level Trading Data)

The information generation unit 3021 extracts only the trading data satisfying “a buying/selling value (or a current value at the time point A)<a selling value” from the trading data at the trading profit/loss level on the basis of the trading data to be counted, processes the data, and creates the trading data at the winning/profit level.

The information generation unit 3021 extracts, with respect to the period-specific aggregation target trading data, trading data whose purchase date or sale date is within AB period from the aggregation target trading data, and extracts trading data that is a purchase date prior to the point A and sold in AB period, or that is a purchase after the point A and sold prior to the point B. The purchase date prior to time A and the sale date of the sale during AB term is reclassified to the market value at time A.

The information generation unit 3021 further adds items such as a Winning profit margin and a trading period to the trading data, and generates the trading data by totaling, period totaling, profit rate range totaling, and the like for each issue. The information generation unit 3021 creates the winning profit level trading data by changing the value of the investment commodity held at time A from the purchase market value to the market value at time A. Specifically, the information generation unit 3021 creates the winning profit level trading data by revaluating the unit price of the held commodity of which the purchase date is before the time point A among the trading commodities at the time point A by the current price.

### (Effects of Trading Data at Winning Profit Level)

For example, if we evaluate trading that won in 2019 and earned profits, if the unit price is used as a reference, investment commodities purchased at low market prices in 2012 are highly evaluated. If it is desired to divide the valuation by period, this is inconvenient. Therefore, it is possible to accurately grasp the results in 2019 by changing the value at time A (at the beginning of 2019), so that it is possible to accurately evaluate the winning profit in 2019. Further, by appropriately adding items such as Winning profit margin to the winning profit level trading data, it is also possible to evaluate for each trading data, by performing aggregate for each component, winning profit it is also possible to evaluate for each component that can be performed.

### (Old Method of Unrealized Gain/Loss Level Trading Data)

In the first embodiment, a method of calculating valuation indicators of a Winning profit margin (unrealized profit rate) is described.

### (Definition of Unrealized Gain/Loss Level Trading Data)

Unrealized gain/loss level trading data is not divided between winning and losing, and it is trading data for grasping an overall picture of the holding status. The third-level trading data is trading data obtained by dividing the trading data that produced the winning profit and the trading data that produced the losing loss. The trading data obtained by aggregating profits in the case of undetermined (unrealized profit/loss trading data) is the trading data at the winning profit (unrealized profit or unrealized profit) level. The trading data obtained by aggregating losses in the case of undetermined (unrealized profit/loss trading data) is trading data at the loss (unrealized loss or unrealized loss) level.

### (Problems of Unrealized Gain Level Trading Data)

In the old method, for example, although the calculation of the unrealized profit ratio is shown in the first embodiment, this unrealized profit level trading data is more suitable in order to exert effects such as capturing winning profit (unrealized profit) in periods, finely looking up trading data, and performing aggregation for each component.

### (Effects of Unrealized Gain Level Trading Data)

The information generation unit 3021 extracts only the trading data satisfying “the purchase value<the current value at the time point B (or the current value)” from the undecided trading data which has not yet been counter traded based on the trading data to be counted, and processes the extracted trading data to create the trading data at the level of Unrealized profit and loss (even if the trading data has been held in the previous step).

The information generation unit 3021 creates unrealized profit and loss level trading data with respect to the period-specific trading target data by changing the market value from the purchase market value of the investment commodity held at the time A to the market value at the time A from the trading data described above (even if the trading data has been held in the previous process).

Specifically, the information generation unit 3021 creates unrealized profit and loss level trading data by revaluating the unit price of the held product of which the purchase date is before the evaluation of time A in the held commodity at the point of time A (or may have it in the previous step). In addition, items such as holding period and unrealized profit rate are added, and processing such as stock aggregation, period aggregation, and profit rate range aggregation is performed, and unrealized profit range trading data is created.

### Effects of Unrealized Gain Level Trading Data

For example, in the case of evaluating the holdings of products that gained Unrealized profit in 2019, investment commodities purchased at low market prices in 2012 are highly evaluated based on the unit purchase price. If it is desired to divide the valuation by period, this is inconvenient. Therefore, it is possible to accurately grasp the results in 2019 by re-valuing the value at time A (at the beginning of 2019), and it is effective to accurately evaluate the Unrealized profit from holding in 2019. This is one of the effects of the creation of trading data to be compiled by period, and the actual status of the issues held can be seen. Rather than just the amount of unrealized profit or the number of percent of unrealized profit, the evaluation of the same unrealized profit, such as the rate of increase in unrealized profit in 2019 and the rate of increase in unrealized profit in 2020, can be deeply evaluated, and it is highly effective to grasp the actual situation.

### (What is Winning Profit (Unrealized Profit or Unrealized Profit) Level Trading Data, and Losing Loss (Unrealized Loss or Unrealized Loss) Level Trading Data)

The winning profit (unrealized profit or unrealized profit) level data is the winning profit (unrealized profit) level trading data obtained by extracting unrealized profit/loss trading data on the condition that “buying value<B time point market value or A time point market value<B time point market value (unrealized profit level)”. The loss level is the inverse of the winning profit level (replacing< with >).

The fourth-level trading data is classified into two categories: buying value (or A-time market value) and B-time market value, buying value (or A-time market value) times the market value of the benchmark hike rate. In the winning profit (unrealized profit) level trading data, all the data satisfying “buying value (or A-time market value)<present value (or B-time market value)” are aggregated.

At the third level, the profitable data may or may not be better or worse than the benchmark. At the fourth level, on the other hand, there is an evaluation of what is more likely than this benchmark. A measure of the overall unrealized profit is calculated and evaluated.

### (What is Winning Profit (Unrealized Profit or Unrealized Profit) Level Trading Data)

The third level separates the trading data at the winning profit (unrealized profit or unrealized profit) level and the trading data at the losing loss (unrealized loss or unrealized loss) level, while the fourth level adds an indicator of whether or not data with the same unrealized profit exceeds the benchmark. At this level, a measure of overall Unrealized profit is calculated and evaluated, regardless of whether the benchmark is exceeded or not.

### (Old Method of Locked Unrealized Gain/Loss Level Trading Data)

Compared with the above-mentioned sales data at the level of Unrealized profit and loss, the following items are added to the sales data and processed. Add, as appropriate, one or more of cash and Unrealized profit/losses, principal, gains/losses on sales, and, in the case of leverage, leverage ratio, Unrealized profit/losses on building, Unrealized profit/losses on building, net Unrealized profit/losses on spot building, and net unrealized losses on spot building.

### (Definition of Unrealized Gain/Loss Level Trading Data)

The above-mentioned unrealized profit and loss level trading data includes items such as trading profit/loss, cash, and principal, and the unrealized profit/loss formation fund is generated as a result of past trading. It is the interlocked unrealized profit and loss level trading data that adds items that connect the past and the present and the future in which the present unrealized profit/loss serves to form future trading profit/loss.

### (Problems of Linked Unrealized Profit/Losses Level Trading Data)

Unrealized profit/losses level trading data does not take into account past trading results or situations in which the company does not contribute to Unrealized profit or cash, which results in a separate evaluation from other situations. However, in practice, past gains and losses on trading transactions have a significant impact on current Unrealized profit and losses, and it is necessary to evaluate the Unrealized profit and losses, including funds for the formation of Unrealized profit and losses.

(Effects of Locked Unrealized Gain/Loss Level Trading Data) Create the following items in the unrealized profit and loss level trading data. That is, an interlocking type item is added to the total amount action.

### (Definition of Linked Type Items)

The interlocking type item is an item that interlocks Unrealized profit and loss with trading profit or loss. Trading gains and losses are the result of past trading, and Unrealized profit and losses are the current gains and losses. Unrealized profit and losses have led to historical results and future gains and losses. Items that serve to link past results with future trading gains and losses are defined as interlocking items. Linked items include cash, cash ratio, unrealized loss formation funds, unrealized gain formation funds, trading gains and losses, principal, leverage ratio, open interest, unrealized gain formation open interest, and unrealized loss formation open interest.

The more profits are traded, the more Unrealized profit/losses are generated, and the more Unrealized profit/losses are generated. The higher the cash ratio, the lower the net Unrealized profit/losses and the higher the Unrealized profit/losses. Increases in leverage magnification and increases in open interest will increase Unrealized profit and losses. Therefore, these are also interlocked items. Items having such a relationship are defined as interlocking type items.

### (Effects of Locked Unrealized Gain/Loss Level Trading Data)

By adding interlocking items to the unrealized profit and loss level trading data, it is possible to measure effects such as compound interest effect and leverage effect by linking past trading and current unrealized profit/loss formation and future trading profit/loss, and it can also be expected to be effective in ranking evaluation, diagnosis, comparison, ranking, etc.

### (Specific Examples of Linked Unrealized Gain/Loss Level Trading Data)

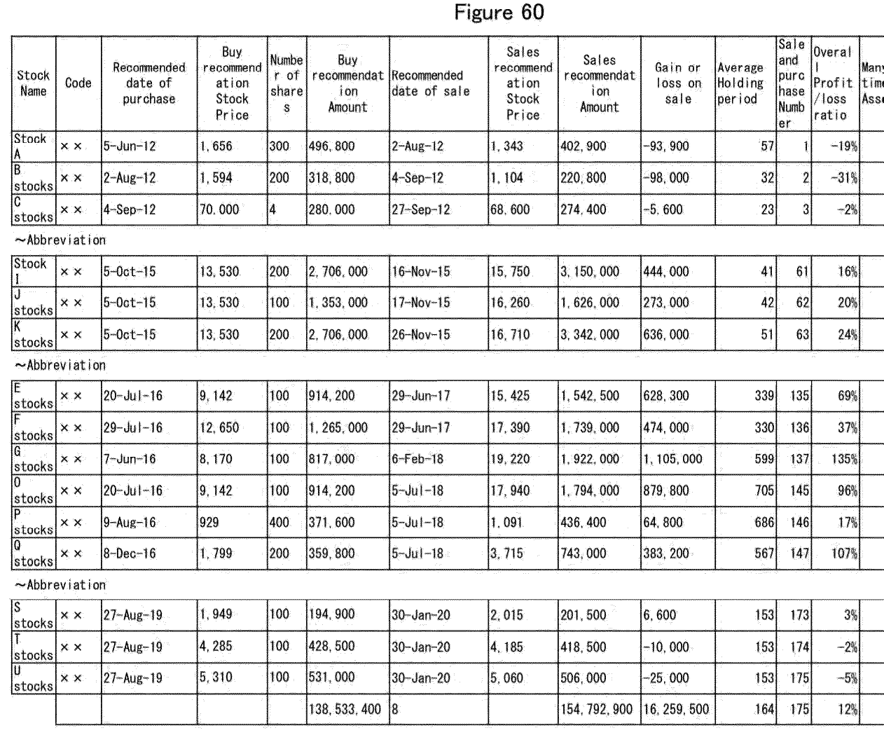

FIG. 60 is a diagram illustrating a specific example of interlocking-type unrealized profit and loss level trading data according to the present embodiment. As shown in the lower part of FIG. 60, for example, there is a breakdown of what type of trading of 16250000 yen in profit or loss from trading has been conducted in an interlocked manner, such as 175 trading times and 92911 yen in profit or loss from trading per trading. For example, if the buy and sell loss increases from ¥92911 to ¥0.1 million and the buy and sell count increases to 180, the buy and sell loss will be ¥18 million and the sum of the money and the capital for profit and loss formation will increase from ¥16250000 to ¥18 million, respectively.

### (What is Winning Profit (Unrealized Profit or Unrealized Profit) Level Trading Data and Losing Loss (Unrealized Loss or Unrealized Loss) Level Trading Data)

The winning profit (unrealized profit or unrealized profit) level is winning profit (unrealized profit) level trading data obtained by extracting unrealized profit/loss trading data on the condition that “buying value<B time point market value or A time point market value<B time point market value (unrealized profit level)”. The loss level is the inverse of the winning profit level (replacing< with ≥).

### (Former Method of Fourth-Level Trading Data Creation Process)

In the first embodiment, the basic numerical value, the valuation indicators, and the decomposition formula are described for the winning pattern, and the pattern classification of the held product is described.

### (Significance of Creation of 4th Level Trading Data)

At the fourth level, an evaluation of what happened after the sale or what it was compared to the benchmark is added.

The information generation unit 3021 adds the market price after sale to the winning profit level trading data and the losing loss level trading data as a trading data item (including the table system of FIG. 86), and creates the winning pattern level trading data classified by the vertical relationship of the buying value, the selling value, and the selling current price, and the losing pattern level trading data.

The information generation unit 3021 further adds the benchmark corresponding current price (including the table system of FIG. 86) to the unrealized profit level trading data and the unrealized loss level trading data as a trading data item, and divides the pattern by the positional relationship of the purchase value (or A current price), the current value (or B current price), and the benchmark fall rate×the purchase value (or A current price), thereby creating the unrealized profit pattern level trading data and the unrealized loss pattern level trading data.

### (Problems of Second-Level Trading Data)

At the third level, only the full picture of fixed profits and losses, unrealized profits and unrealized loss data is known. Further, by creating trading data in which patterns are classified, more detailed information such as a winning pattern of trading and a winning pattern of a held product can be obtained.

In addition, the old method emphasizes the calculation of the valuation indicators rather than the creation of the fourth-level trading data. By clarifying the process of creating the fourth-level trading data, it is easy to compare the situation of individual issues with other brands, and it is possible to make a wider evaluation more convenient for application.

In particular, in the fourth level stage, the data becomes finer, and it tends to be difficult to understand in the enumeration of numbers. For example, by simply displaying a list of the trading data of the winning pattern 1, it is possible to obtain various kinds of information such as how to win the issue. Especially effective for the trading data to be compiled by period.

### (Means of 4th Level Trading Data)

The information generation unit 3021 extracts only the trading data that has already been traded and determined from the trading data to be totaled, further extracts the data of “buying value (or A time point current value)<selling value, or buying value (or A time point current value)≥selling value” in the data, and further adds the sold current value to the trading data item, classifies the buying value (or A time point current value), the selling value, and the position relationship of the sold current value into three patterns, and creates the winning (or losing) pattern level trading data for each pattern.

The information generation unit 3021 extracts only the unconfirmed trading data that has not yet been counter traded from the aggregate target trading data, further extracts data satisfying “buy value<current value (or current value at time B) or buy value≥current value (or current value at time B)” in the data, and further classifies the benchmark corresponding current value into two patterns in the positional relationship between the benchmark current value and the selling value in addition to the trading data item (including the table method of FIG. 86), and creates the unrealized profit (or unrealized loss) pattern level trading data.

### Effects of 4th Level Trading Data

By evaluating each of the three patterns of winning profit(loss) data in the traded data, the determined profit(loss) of the target of the aggregate is generated from which pattern, which is the degree, the average holding period, and the profit rate (loss rate), information of the winning pattern is known.

By evaluating two patterns of unrealized gains (unrealized losses) data in the unfixed data, it is possible to obtain detailed information on unrealized gains (unrealized losses) on the target of the aggregate, which is derived from which pattern, to what extent, the average holding period is, and the unrealized profit/loss ratio is.

In addition, the creation of winning pattern trading data, which was not revealed by the old method, has the effect of being able to individually know in detail what kind of trading the winning pattern is.

For example, the addition of an index of what happened after the sale of A issues when the stock is finalized and an index of whether the stock is better or worse than the benchmark when the stock is undetermined possibles a deeper analysis.

### (Old Method of Process for Creating Winning Pattern Level Trading Data)

Embodiment 1 describes a winning pattern in a winning profit decomposition formula and shows a specific example of evaluation. That is, a basic numerical value, valuation indicators, and a decomposition formula of the profit of the winning pattern are described.

### (Problems of Winning Pattern Level Trading Data)

In the old system, component decomposition formula of winning pattern, valuation indicators, basic numerical value, etc. are mainly carried out, and the preparation process of winning pattern level trading data is not mentioned. The problem with the process of creating winning pattern level trading data is solved. The winning profit obtained by investing for each target of aggregate shows only an overall picture of winning profit trading data.

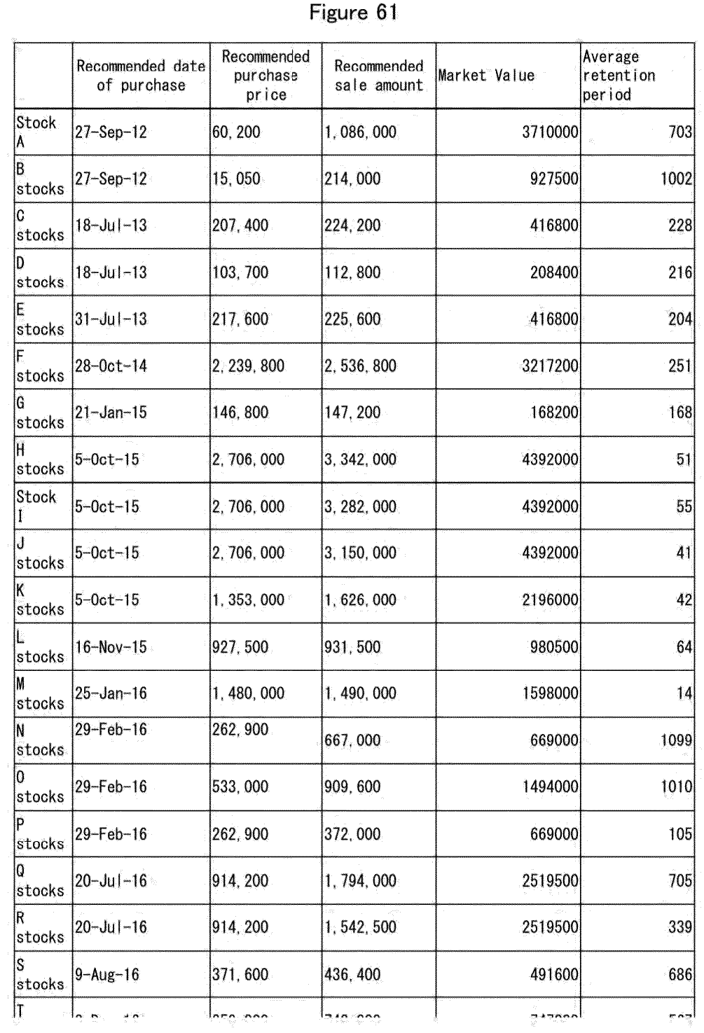

FIG. 61 is a diagram illustrating a specific example of the trading data at the winning pattern 1 level according to the present embodiment. In the present embodiment, there are three patterns in the profitable profit trading data according to the price movement after the sale, and the trading data for each pattern is created.

### (Means for Creating Winning Pattern Level Trading Data)

The information generation unit 3021 extracts trading data that has already been counter traded and determined from the totaling target trading data, extracts data satisfying the “buying value (or A-time current price)<selling value” from the data, extracts the market value after the sale in three patterns according to the buying value (or A-time current price), the selling value, and the vertical relationship of the sold market value in addition to the trading data item (including the table method), and creates the processed trading data as the winning pattern level trading data.

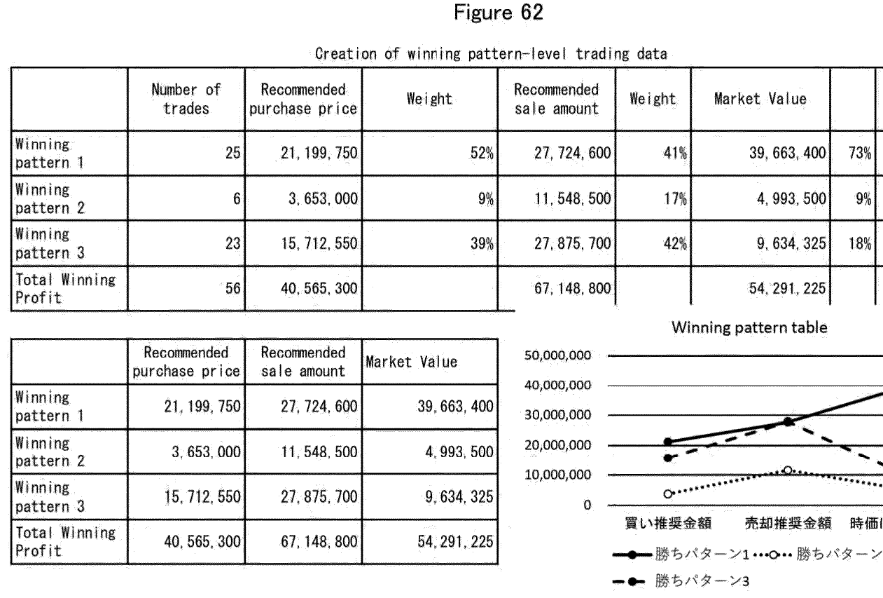

FIG. 62 is a figure illustrating an exemplary pattern winning according to the present embodiment.

### (Effect of Winning Pattern Level Trading Data)

By extracting (or classifying, aggregating, or processing) the trading data of each of the three patterns of winning profit trading data in the trading data, the winning profit of the aggregation target is generated from which pattern, and it is possible to know information such as how much, how the average holding period is, and how the average holding period is divided in a certain period, and to grasp a winning pattern more detailed than the old method, such as which brand has a high profit contribution degree. By adding a winning profit ratio, a trading period, and the like to the trading data item and adding a brand, a period, and the like to the aggregate data, it is possible to create winning pattern level trading data according to the purpose.

### (Significance of Winning Pattern Level Trading Data)

Through the process of creating the winning pattern level trading data, by adding the winning pattern trading data to the decomposition formula, valuation indicators, etc. of the old system, it also exerts a great effect on diagnostic ability and advice. A deeper analysis is possible.

### (Definition of Fair Value Corresponding to Benchmark)

The benchmark corresponding current value is calculated by “benchmark fall rate×(buy value or current value at A) (including the table method of FIG. 86)”. The benchmark hike rate represents a hike rate based on the benchmark value at the purchase date or the point of A.

### (Definition of Market Value at Time B)

The starting point for each period is defined as A time point, and the current price at A time point is defined as A time point, and the valuation at A time point is defined as A time point value (in the case of the table method in FIG. 86, the stock price and the trading data are always linked to each other and are also stored in DB of the storage unit 33, so that the current price at A time point includes a method that can be linked by date).

### (Definition of Market Value of B)

A time point that becomes an end point for each period is defined as a B time point, a current price at the B time point is defined as a B time point, and an appraisal value at the B time point is defined as a B time point appraisal value (in the case of the table method of FIG. 86, since the stock price and the trading data are always linked and stored in DB of the storage unit 33, the B time point market value includes a method that can be linked by a date).

### (Old Method for Creating Unrealized Gain/Loss Pattern Level Trading Data)

In the first embodiment, the purchase price, the product evaluation price, and the benchmark evaluation price are calculated, and the comprehensive evaluation of the held product is performed. Next, there are descriptions about the rate of products falling and the rate of benchmark falling. There is also a description of the pattern of the held product. In addition, there is a description of a history of calculating a ratio of a purchase price and a product evaluation price for each pattern.

### (Problems to Create Trading Data at the Level of Unrealized Gain/Loss Patterns)

Unrealized gains/losses are only an overview of unrealized gains/losses-level trading data. There are two patterns, depending on whether the profitable unrealized gains are higher or lower than the benchmark-based market value. In addition, in the old method, although the ratio for each pattern is described, there is no description or suggestion in the preparation method for extracting and processing trading data. Problems are solved by the process of creating unrealized profit pattern level trading data.

### (Means for Creating Unrealized Profit-Loss Pattern Level Trading Data)

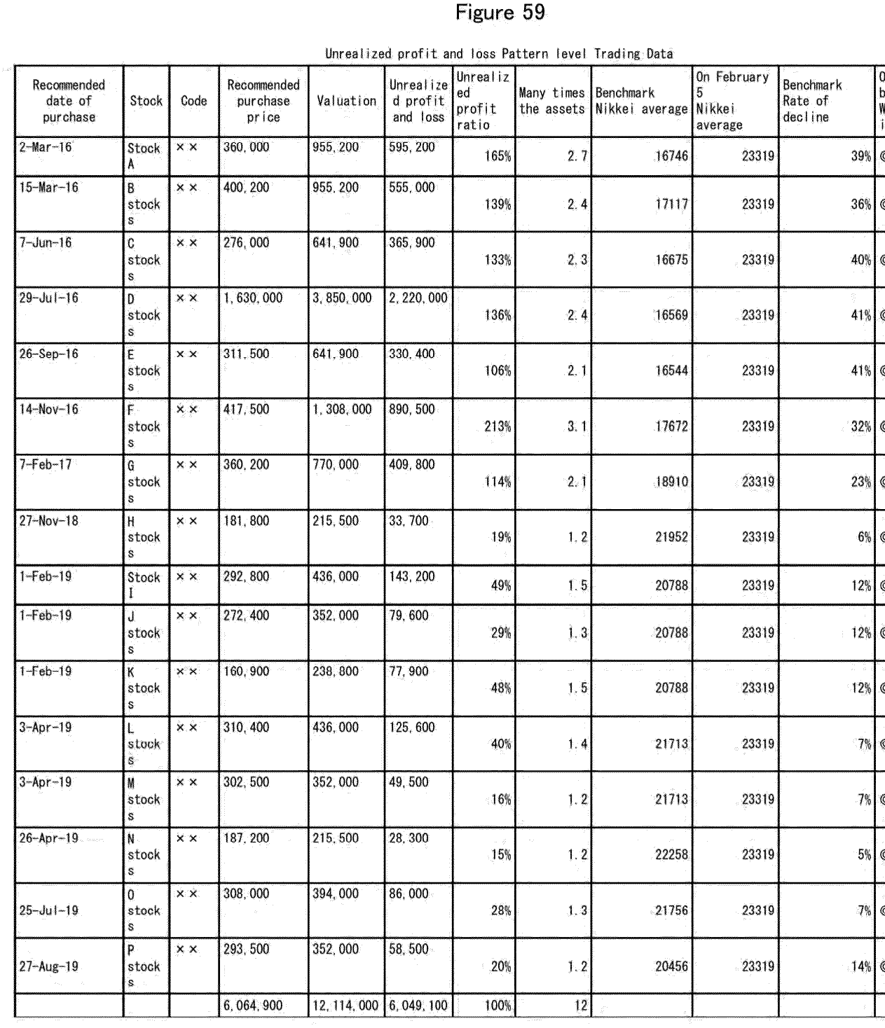

The information generation unit 3021 extracts unconfirmed trading data that has not been counter traded from the totaling target trading data, further extracts data satisfying “purchase value<current value (or B-time current value)” in the data, and further adds the benchmark-corresponding current value to the trading data item, classifies the benchmark-corresponding current value into two patterns by the positional relationship between the benchmark-corresponding current value and the current value (or B-current value), extracts the data, and appropriately processes the extracted data to create the unrealized profit/loss pattern level trading data. FIG. 59 is a diagram illustrating an example of unrealized profit/loss pattern level trading data according to the present embodiment.

### (Effects of Unrealized Gain/Loss Pattern Level Trading Data)

By evaluating each of the two patterns of unrealized gains data in the unconfirmed trading data, it is possible to obtain detailed information on the unrealized gains, including which patterns the unrealized gains are generated, how much they are, how long the average holding period is, and whether they are better or worse than the benchmark.

Further, in the old method, there is a description that the sum purchase price or the product evaluation price is calculated for each of the four patterns, the ratio of the amount of each pattern to the total of the four patterns is calculated, and the ratio of each pattern or the like is calculated, but there is no description regarding the creation of the unrealized profit/loss pattern level trading data. By creating the data for trading at the level of the unrealized profit/loss pattern, the details of each pattern are clarified, and the special effect is also given to diagnostic ability, advice, etc.

By adding the winning profit rate and the holding period to the trading data item, and adding the issue, the purchase time, and the like to the aggregate data, it is possible to create the unrealized profit pattern level trading data according to the purpose.

### (Significance of Unrealized Gain/Loss Pattern Level Trading Data)

The fourth level classifies unrealized profit and loss data into two categories according to the relationship between the purchase price, the current value, and the benchmark-corresponding current value, and whether they are above or below the benchmark-corresponding current value. In the stock example, in the case of a success case, there are many cases where “buy price<fair value corresponding to benchmark<present value”, and it is possible to evaluate that the stock is held with a correct answer continuously. The effect is that the list of stocks that exceeded these benchmarks is clear at a glance. A deeper analysis is possible.

### (Old Method for Creating Trading Data at the Level of Unrealized Profit-Loss Pattern)

The information generation unit 3021 creates the interlocking-type unrealized profit-and-loss pattern-level trading data by adding an interlocking-type item at the time of creating the unrealized profit-and-loss pattern-level trading data.

### (Problems for Creating Trading Data at the Level of Unrealized Profit-Loss Pattern)

The unrealized profit/loss pattern level trading data is scattered data that does not include the result of past trading and is not linked to the trading profit or loss. By adding an interlocking item to the unrealized profit/loss pattern level trading data, the unrealized profit/loss pattern and the trading profit/loss are linked, and the funds are increased or decreased in the trading profit/loss starting from the principal, and the funds for forming unrealized profit/loss excluding unused cash are increased or decreased. Among them, the unrealized gains/losses generating funds form unrealized gains/losses and generate unrealized gains/losses that exceed the benchmark. It is important that leverage, such as margin trading, further increases funding capacity and increases or decreases unrealized profit-generating funds, and that these evaluations be added.

### (Means for Creating Locked Unrealized Gain/Loss Pattern Level Trading Data)

The information generation unit 3021 adds an interlocking type item to the unrealized profit-and-loss pattern level trading data, and thereby creates the interlocking type unrealized profit-and-loss pattern level trading data.

### (Effects of Locked Unrealized Gain/Loss Pattern Level Trading Data)

For example, the share of net unrealized gains and losses in net unrealized gains and losses pattern above the benchmark can be used to more accurately determine the current position.

For example, in the case of 80 percent, the current holdings can be regarded as good, since 80 percent of the current holdings of investment products are composed of unrealized gains, of which unrealized gains formation funds account for more than the benchmark. However, if the cash ratio is too high, opportunity losses are incurred, and discounts need to be considered.

Conversely, if net unrealized gains/losses are 80 percent below the benchmark, there is considerable room for improvement and evaluation is low. Especially when the holding period is long, the valuation loss of the investment product is in a salted state and the fund is not active. The lower the cash ratio, the more room for improvement.

### (Significance of Linked Unrealized Gain/Loss Pattern Level Trading Data)

The formation of unrealized gains/losses is a barometer of whether or not the current investment product is working well. If the current investment product is bad even if the past is good, the current investment product needs to be improved.

Conversely, if there are abundant current unrealized gains, even if the past is bad, these unrealized gains will turn into trading profits, the amount of funds will increase, and the amount of funds will become the next unrealized profit formation fund.

Since this linkage is extremely important in achieving the results of investment products, it is meaningful to prepare interlocked unrealized profit pattern level trading data. Unrealized profit/loss pattern level trading data can be created in a similar manner.

### (Automation Step for Creating Profit-Loss Level Trading Data)

In order to determine whether the company is looking for profit or loss, whether it is looking for unrealized profit or loss, or whether it is looking for comprehensive profit or loss, it determines the profit or loss level trading data according to the request.

If only the trading data obtained by trading is extracted from the trading data to be aggregated or the trading data by component, the trading data at the trading profit level is extracted, and if only the winning trade is extracted, the trading data at the winning profit level is obtained.

Each of the most important gains or losses is a trade gain or loss (or a trading profit or loss ratio) in the former case and a winning profit (or a winning profit or loss ratio) in the latter case. These indicators are the most important because they are the overall result of the trading data.

Valuation indicators are the most important factors affecting profit and loss. In other words, when the valuation indicators increase or decrease, the above-mentioned trading profit or loss and winning profit, which are the overall result, increase or decrease.

The next step is to actually calculate the valuation indicators. The calculated valuation indicators is important because it is utilized for comparison, evaluation, ranking, diagnosis, advice, etc. according to the purpose.

### (Valuation Indicators Calculation Step (Fifth Step))

The first step—The acquisition step of trading data
Second Step: Creation Step of Target Trading Data
3rd step—Creation step of sale and purchase data by component (even after the 4th step is good)
The fourth step—The creation step of a profit-and-loss level trading data (even after the second step is good)
The fifth step is to calculate, select and display the valuation indicators with the property that it is linked to the target profit and loss calculated from the trade data extracted (or classified, aggregated, processed) up to the fourth step in the step of creating the profit and loss level valuation indicators (the current step).

### (Definition of Profit and Loss/Loss Level Valuation Indicators Create Step)

The step of creating the profit-and-loss level valuation indicators is a step of creating valuation indicators for evaluating the sales data based on the sales data created in the step of creating the profit-and-loss level sales data.

### (Types of Valuation Indicators for Profit-Loss Level Trading Data)

The types of valuation indicators obtained from profit and loss level trading data include valuation indicators (winning rate, profit rate, etc.) obtained from narrow sense trading data, valuation indicators obtained from stock company performance data (earnings forecast, upward revision rate, etc.), valuation indicators obtained from technical indicators used for forecasting future price movements (RSI, etc.), valuation indicators obtained from other investors' trading data (average trading prices of other investors who purchased the same stock on the same purchase date, etc.), valuation indicators obtained from other trading data of investment targets (when other investment targets are purchased on the same purchase date, trading profit/loss ratio of the other investment targets, etc.).

### (Conventional Technology)

In the first embodiment, a process of acquiring a profit-and-loss total from the sales data and calculating valuation indicators with reference to the profit-and-loss total is shown.

This paper presents valuation indicators calculation process of acquiring basic data from trading data and calculating valuation indicators with reference to the basic data.

This is part of the metric obtained from the trading data in a narrow sense in the previous type.

### (Problems in the Profit and Loss/Loss Level Valuation Indicators Create Step)

In order to evaluate the trading data, it is necessary to create valuation indicators, and in order to evaluate the trading data, it is important to evaluate the trading data (transaction data) in a narrow sense first, but there are several methods for creating valuation indicators of the trading data (transaction data) in a narrow sense, and Embodiment 1 shows a part thereof.

Trading Data in a Narrow Sense is Direct Trading Data, but Other Indicators are Also Important to Properly Evaluate Trading Data.

For example, by adding the trading data of other investors, the trading data of other investment targets, the technical index of the investment target, the performance data of the issue company, and the like as valuation indicators, it is possible to create various valuation indicators more versatility.

### (Action of the Profit-Loss Level Valuation Indicators Create Step)

The information generation unit 3021 creates valuation indicators necessary in the process from the first step to the fourth step.

For example, in the case of a technical index of a stock to be invested, it is possible to utilize the technical index at the time of purchase by storing the technical index value at the time of purchase in addition to the stock price, the purchase date, and the number of shares to be purchased at the time of purchase of the investment target. Performance data is also stored in the same way as the technical index value.

With respect to the transaction data of the other investor, the information generation unit 3021 calculates valuation indicators from the purchase data of the other investor that matches the same brand on the same date as the purchase date. With respect to the trading data of the other investment target, the information generation unit 3021 calculates valuation indicators from, for example, the purchasing data of the other investment target having the same date as the purchase date.

### (Effects of the Profit and Loss/Loss Level Valuation Indicators Create Step)

In order to evaluate the trading data, it is necessary to prepare valuation indicators. In order to evaluate the trading data, in addition to the trading data in a narrow sense (transaction data), valuation indicators obtained from the performance data of the companies to be invested, the trading data of other investors, the technical indices to be invested, the trading data of other investments, and the like are added to the valuation indicators of the trading data, so that the trading data can be evaluated more in depth in many ways.

### (Specific Examples of Profit and Loss/Loss Level Valuation Indicators Create Step)

[Valuation Indicators from Performance Data for Investments]

For example, if the initial forecast for operating profit is 100, the first revised value 110 is used as the initial forecast, and the first revised value of the initial forecast is used as a reference, and the first revised value and the revised value 110 are used as the valuation indicators of the performance data. For example, the same applies to the case of the second correction value 130 (2 and 130) and the third correction value 150 (3 and 130). By way of example only, this will incorporate performance data metrics into the assessment of an investment.

[Indicators Obtained from Trading Data of Other Investors]

The metrics derived from the trading data of other investors in the investment are also important metrics for evaluating the trading data of the investor in question. For example, if an investor buys a stock on the same day and then continues to hold and sells it twice, investor A sells it 1.2 times, then investor A's valuation incorporates the concept of opportunity loss rather than a mere 1.2 times the valuation, possible it to evaluate it more deeply and multilaterally than other investors.

[Valuation Indicators Obtained from the Technical Index of the Investment Target]

The index obtained from the technical index of the investment target is also an important index for evaluating the trading data of the investment target of the investor.

For example, if you buy a stock at RSI20 percent and sell it at RSI80 percent, and then sell a stock at 1.5 times the price, you can tell you that RSI is going to buy it again when it drops 20 percent. In addition, if RSI of the investment is 10%, it is easy to calculate the rate of decline at the time when the historical RSI is 10%, and then three months later. It is increased by 15% on average, and it is possible to display a success probability of 80%. The ability to display these metrics at the timing of the purchase can be very useful information for investors.

This is because it is very difficult to manage such numbers conventionally, and it is not actually managed.

[Valuation Indicators Obtained from Trading Data of Other Investments]

An index obtained from trading data of other investments is also an important index for evaluating trading data of the investor.

For example, if issues were twice as wide during the trading period, but b stocks stopped at 1.2 times, the valuation of b stocks would be more deep and multifaceted because it would add a perspective of how to compare with other investments rather than just 1.2 times. If you choose a stock, the price is doubled. It is possible to add various valuation indicators such as an average value and a maximum value width.

### (Significance of Preparation of Valuation Indicators for Transaction Data)

Trading data is defined as trading data in a narrow sense. The transaction data is data related to direct trading. The information generation unit 3021 creates a series of valuation indicators derived from transaction data such as purchase data (purchase date, purchase unit price, purchase number) and sale data (sale date, sale unit price, sale number) of the investment commodity.

(Issues with Conventional Technology)

In the first embodiment, {(winning rate×winning trade purchase price×winning profit ratio/winning number)+(losing rate×losing trade purchase price×losing loss ratio/losing number)}×principal×number of days elapsed/Turnover period of the principal/purchase price per one time=trading profit and loss is mentioned, but the overall profit and loss is not mentioned. Furthermore, the calculation method 1, the calculation method 8, and the like are not mentioned. valuation indicators for various transaction data can be calculated at each profit and loss level, whether overall profit or loss, sales profit or loss, or unrealized profit or loss.

### (Effect of Preparation of Valuation Indicators for Transaction Data)

There are a number of methods, and the valuation indicators of the transaction data is calculated by, for example, the following formula. Expressions are obtained by decomposing the overall profit and loss, trading profit and loss, and unrealized profit and loss, which are objectives, using various evaluation indicators. Thus, various valuation indicators can be calculated.

$$\\ \begin{matrix} & [ Calculation method 1 ( including turnover rate of winning trade losing trade ) ]\end{matrix}$$

$$\\ Overall profit and loss = \{ \begin{matrix}( win rate \times Winning trade purchase price \times Winning profit ratio / \\ ( \begin{matrix}principal \times elapsed days / \\ number of The winning trade turnover period of the principal / \\ Purchase price per winning trade\end{matrix} ) + \\ ( \begin{matrix}lose rate \times \\ purchase amount of lose trade \times Losing loss ratio / \\ ( \begin{matrix}principal \times elapsed days / number of lose trade days / \\ purchase amount per lose trade\end{matrix} )\end{matrix} )\end{matrix} \} \times principal \times elapsed days / number of principal days / number of days of principal revolution / purchase amount per time$$

$$\\ \begin{matrix} & [ Calculation Method 2 ]\end{matrix}$$

$$\\ Overall profit / loss = \{ \begin{matrix}( win rate \times purchase price of winning trade \times win rate / win count ) + \\ ( lose rate \times purchase price of losing trade \times loss rate / loss count )\end{matrix} \} \times principal \times number of days elapsed \div number of days of revolution of principal / purchase price per 1$$

$$\\ \begin{matrix} & Calculation Method 3\end{matrix}$$

$$\\ Total profit / loss = \{ \begin{matrix}( win rate \times win profit / win count ) + \\ ( loss rate \times loss / loss count )\end{matrix} \} \times principal \times elapsed days \div number of days of principal rotation / purchase price per 1 time$$

$$\\ \begin{matrix} & [ Calculation method 4 ]\end{matrix}$$

$$\\ Total profit / loss = \{ \begin{matrix}( win rate \times win profit per round ) + \\ ( loss rate \times loss per round )\end{matrix} \} \times principal \times number of days elapsed \div number of days of rotation of principal / purchase price per time$$

$$\\ \begin{matrix} & Calculation Method 5\end{matrix}$$

$$\\ Total profit and loss = revenue per revenue \times principal \times number of days elapsed / number of days of revolution of principal / purchase price per purchase$$

$$\\ \begin{matrix} & [ Calculation method 6 ]\end{matrix}$$

$$\\ Total profit and loss = revenue per revenue \times principal \times number of days elapsed / number of days of revolution of principal / purchase price per purchase$$

$$\\ \begin{matrix} & Calculation Method 7\end{matrix}$$

$$\\ Total profit / loss = revenue per transaction \times number of transactions$$

$$\\ \begin{matrix} & Calculation Method 8\end{matrix}$$

$$\\ Overall profit / loss = \{ \begin{matrix}( win rate \times win profit per transaction ) + \\ ( loss rate \times loss per transaction )\end{matrix} \} \times number of transactions$$

### (Effect of Preparation of Valuation Indicators for Transaction Data)

By calculating the various valuation indicators of transaction data, it becomes possible to understand how various profits and losses have been created. What happened in FY2020, and the period of 2019, such as?, also clarifies the differences in the status of the data on the buy and sell and sell, and the differences between the a and b brands and the buy and sell data that have already been bought and purchased. The transaction data that is handled is the transaction data extracted from the first step through the fourth step.

### (Specific Examples of Preparation of Valuation Indicators for Transaction Data)

For example, even if the overall profit-loss ratio in 2020 was the same at 10% when comparing the indicators of Mr. A and Mr. B, the difference between Mr. A and Mr. B's trading becomes clear by decomposing them based on the above formula.

Mr. A has a 50% win rate, but the winning profit rate is higher than the losing loss rate, and the rotational is effective. However, Mr. B has a 70% win rate, but the loss rate of the losing has increased, and it can be seen in detail.

### (Display of Creation of Valuation Indicators for Technical Indicator Values)

### (Significance of Establishment of Valuation Indicators for Technical Indicator Values)

It is possible to display the technical index value at the time of purchase of the stock held, display the technical index value during holding, and display the technical index value at the time of purchase and sale for the stock to be sold.

(Issues with Conventional Technology)

The technical index value at the time of normal purchase or sell needs to be managed by the user, is cumbersome, complicated, and can be managed by a limited number of persons.

Among a number of technical indicators, it is possible to determine which indicators to use, and store the technical index values at the time of purchase, holding, and sell in a database, so that they can be extracted at any time. In order to be stored in the database regardless of whether it is conscious or not, it is also possible to verify the traded data from the technical index side at a later time.

The display unit 23 of the terminal 2 directly manages the display of the technical index value at the time of purchase, sale, and holding. Therefore, it is possible to automatically issue a warning or notification when a similar index value is achieved in a past success case. It can be used for management of data in the middle of trading, verification and prediction of data that has been traded, and the like.

### (Effect of Preparation of Valuation Indicators for Technical Indicator Values)

In post-purchase management, past success cases can be used to determine the extent of the technical index value, and can be prepared for sale in advance, or can be sold at the current level to show the percentage of success in the technical index value by referring to the past history.

In the case of management before purchase, it is possible to display a purchase zone or display a success probability in the case of purchase.

Therefore, it is possible to contribute to a purchase decision and a sale decision. In order to realize this, it is important that data such as the technical index value at the time of purchase, the technical index value at the time of sale, the transition after sale, the profit and loss on sale, and the profit and loss ratio on sale are stored in a database and can be extracted and utilized at any time.

### (Specific Examples of Preparation of Valuation Indicators for Technical Indicator Values)

At the target of purchase, it is possible to add a function of notifying that a stock that has been sold in the past reaches a predetermined technical index value, or to register a stock that has reached a certain value in terms of a technical index in a list of stocks to be purchased.

When holding the stock, the technical index value changes while the price of the stock being held fluctuates every day. Therefore, it is possible to display the probability of success when selling the stock by referring to the past history, or to display the zone where the probability of success of the stock is high.

At the time of sale, the technical index value at the time of sale can be checked, and the subsequent transition can be recorded in the database to verify whether or not the timing of sale is correct.

### (Definition of Preparation of Valuation Indicators for Performance Data)

It is possible to display the performance data (forecast value or actual result value) at the time of purchase of the holding issue, display the performance data in the middle of holding, and display the performance data at the time of purchase and sale for the trading brand.

(Issues with Conventional Technology)

Traditionally, performance data at the time of purchase or sell needs to be managed by the user, which is cumbersome, cumbersome, and limited to those who can manage it.

### (Effect of Preparation of Valuation Indicators for Performance Data)

In a number of performance data, it is possible to determine which data to use, store performance data at the time of purchase, holding, and sell in a database, and draw it at any time. In order to be stored in the database, whether conscious or not, it is also possible at a later time to verify the traded data from the performance data.

Performance data can be displayed and managed directly when purchased, sold, or held. Therefore, it is possible to provide a warning or a notification automatically when a similar index value in the past is achieved. It can be used for management of data in the middle of trading, verification and prediction of data that has been traded, and the like.

For example, if the expected sales increase by 20%, the degree of impact on the stock price (e.g., the immediately preceding stock price and the immediately following stock price, and the rate of decline in the first month after announcement) can be stored in a database and withdrawn at any time when necessary. As a result, the display unit 23 of the terminal 2 displays the movement of the stock price at the time of the upward correction in the past and the movement of the stock price at the time of the upward correction in the past and the movement of the stock price at the time of the similar upward correction in the other brands as the comparison target. This makes it possible to make it useful for the next investment action, and makes it possible to use it as a reference for how to buy and sell.

### (Effect of Preparation of Valuation Indicators for Performance Data)

In post-purchase management, past success cases can be used to determine the extent of the performance data and how it changed and prepare for sale in advance.

In the case of management before purchase, it is possible to display a purchase zone or display a success probability in the case of purchase.

According to the above, it is possible to contribute to a purchase decision and a sale decision. In order to realize this, it is important that data such as earnings data at the time of purchase (including forecasts and actual results), earnings data at the time of sale, transition after sale, profit and loss on sale, profit and loss ratio on sale, etc. are stored in a database and can be extracted at any time.

### (Specific Examples of Preparation of Valuation Indicators for Performance Data)

As an example of the reference at the time of purchase, for example, in the previous example, when the sales increase by 20%, it is possible to clarify the relationship between the stock price immediately before the stock price and the stock price increase rate of the stock that has been revised, such as the average number of percent increase in the price for the next three months after the stock price increase, and thus it is possible to contribute to the judgment at the time of purchase.

For example, if the forecasts for the performance of the stockholdings are improved and 10% sales are revised upward compared to the initial forecasts, the company can immediately refer to the subsequent price movements when the other 10% sales are revised upward, thus contributing to the investment behavior of holding the stockholdings.

An example of a reference at the time of sale is that, for example, if the forecast for the performance of the stock in question deteriorates and sales are revised downward by 10% compared to the initial forecast, it is possible to immediately refer to the subsequent price movements in the case where other 10% sales are revised downward, so that it is possible to contribute to the investment action of determining the sale of the stock.

### (Definition of Preparation of Valuation Indicators for Other Investment Data)

It is possible to display the trading data of the other investment object at the time of purchase of the holding stock, display the trading data of the other investment object in the middle of holding, and display the trading status of the other investment object at the time of purchase and sale with respect to the trading stock.

(Issues with Conventional Technology)

Traditionally, the trading status of other investments at the time of purchase or sale could not be normally ascertained.

### (Effect of Preparation of Valuation Indicators for Other Investment Target Data)

In the trading data of other investments, which data to use is determined, and the trading data of other investments at the time of purchase, holding, and sell are stored in a database, and can be extracted at any time. It is stored in the database, whether or not it is conscious, so that it is possible later to verify the traded data and verify how it was compared to other investments.

It is possible to display and manage the sales data of other investments directly at the time of purchase, sale, or holding.

Therefore, it is possible to give warnings and notifications when the average sale price of other investments is automatically reached. It can be used for management of data in the middle of trading, verification and prediction of data that has been traded, and the like.

### (Effect of Preparation of Valuation Indicators for Other Investment Data)

Post-purchase management allows past success cases to identify the extent to which the gains or losses on other investments have been, and to prepare for sale in advance.

In the case of management before purchase, it is possible to display a purchase zone or display purchase information of another investment target.

It can contribute to the decision to buy or sell. In order to realize this, it is important to store in a database data such as purchase information of another investment object at the time of purchase, sale information of another investment object at the time of sale, transition after sale, profit and loss on sale, and profit-and-loss ratio of sale, and can be withdrawn at any time.

### (Specific Examples of Preparation of Valuation Indicators for Other Investment Data)

### (Definition of Preparation of Valuation Indicators for Other Investor Data)

It is possible to display the trading data of the issues of the other investors at the time of purchase of the held securities, display the trading data of the securities of the other investors in the middle of holding, and display the trading status of the securities of the other investors at the time of purchase and sale with respect to the trading securities.

(Issues with Conventional Technology)

Traditionally, the trading status of the issue by other investors at the time of purchase or sale was usually not available.

### (Effect of Preparation of Valuation Indicators for Other Investor Data)

In the trading data of the stock of another investor, it is possible to decide which data to use, and to store the trading data of the stock of another investor at the time of purchase, holding, and selling in a database, so that it can be extracted at any time. It is stored in the database, either conscious or not, so that it is later possible to verify the traded data and verify what it was compared to other investors.

The display unit 23 of the terminal 2 can directly manage the display of the sales data of the issue of another investor at the time of purchase, sale, and holding.

Therefore, it is possible to give warnings and notifications when the average sale price of the stock of another investor is automatically reached. It can be used for management of data in the middle of trading, verification and prediction of data that has been traded, and the like.

### (Effect of Preparation of Valuation Indicators for Other Investor Data)

In post-purchase management, past success cases allow other investors to know how much the stock was sold and prepare for sale in advance.

In the case of management before purchase, it is possible to display a purchase zone or display purchase information of a corresponding stock of another investor.

It can contribute to the decision to buy or sell. In order to achieve this, it is important to store in a database data such as the purchase information of another investor at the time of purchase, the sale information of another investor at the time of sale, the transition after sale, the profit and loss on sale, the profit and loss ratio on sale, and so on, and can be withdrawn at any time.

This time, in this fifth step, there are calculation process of valuation indicators, selection process, and display process.

The valuation indicators creation step includes a calculation process, a selection process, and a display process, and there are three calculation processes as follows.

### (Valuation Indicators Calculation Step)

In the following three steps of calculating profit and loss level indicators,
(1) Calculation of profit-and-loss level indicators
(2) Calculation of valuation indicators by profit and loss level
(3) Calculation of profit-and-loss level valuation indicators
There are three methods, all of which are collectively referred to as a step of calculating a profit/loss level valuation indicator (fifth step).

### (Difference Between Calculation of Profit-and-Loss Level Valuation Indicators and Trading Data by Profit and Loss)

The information generation unit 3021 extracts (or classifies, aggregates, or processes) the transaction data to be aggregated, creates the transaction data at the profit/loss level, and calculates the profit/loss level valuation indicators. The step of calculating the target-and-loss level valuation indicators is a step performed after creating the transaction data to be aggregated and the component transaction data, and the purpose is different from the transaction data to be aggregated by profit and loss as described above.

As shown in FIG. 31, the profit-and-loss aggregation target trading data of the new method is a kind of aggregation target trading data, and, for example, trading data is extracted on the basis of winning profit, and the profit-and-loss aggregation target trading data is evaluated in an evaluation step. We will take steps to separate and evaluate the trading data to be compiled by the type of profit or loss, such as loss or profit or loss.

On the other hand, the profit and loss level trading data is trading data for processing (or classifying, aggregating, extracting) the aggregated trading data in order to calculate valuation indicators on the basis of profit/loss in a process in which all the aggregation target trading data (profit/loss aggregation target trading data, investor aggregation target trading data, investment target aggregation target trading data, and the like) passes.

The profit and loss level trading data in the profit and loss level valuation indicators is processed (or classified, aggregated, extracted) to calculate valuation indicators in order to evaluate the calculation target (for example, investor A) in profit and loss (for example, unrealized loss), while the profit and loss aggregation target trading data by profit and loss (for example, winning profit and loss) is the calculation target.

The former is the trading data compiled by winning profit, so both the winning profit of Mr. A and the winning profit of Mr. B are covered. On the other hand, the latter is trading data narrowed down only to trading data of winning profit to be tabulated, and is trading data processed (or classified, tabulated, extracted) in order to calculate valuation indicators for evaluating trading of the aggregate target.

Three types are exemplified in the step of calculating the valuation indicators according to the profit/loss level.

### (Relationship Between the Calculation Step of the Profit-and-Loss Level Valuation Indicators and the Old Method)

In the first embodiment, a process of acquiring a profit-and-loss total from the sales data and calculating valuation indicators with reference to the profit-and-loss total is shown. Specific valuation indicators of specific example are shown. This paper presents valuation indicators calculation process of acquiring basic data from trading data and calculating valuation indicators with reference to the basic data.

FIG. 38 and FIG. 40 are diagrams illustrating an example of calculation of valuation indicators according to the present embodiment. FIG. 39 is a diagram illustrating extraction of winning-profit level data according to the present embodiment.

The step of calculating the profit-and-loss level valuation indicators is different from the step of extracting (or classifying, aggregating, or processing) the trading data to be aggregated and the component trading data and creating the profit-and-loss level trading data by the information processing system, and calculating the valuation indicators using the valuation indicators calculation table or the like based on the trading data.

The relationship between the old system and the present embodiment will be described.

In the old method, acquiring the sum trading profit and loss from the trading data is the step of acquiring the basic data. The old method obtains the sum trading profit and loss and decomposes it to calculate valuation indicators. That is, the old method calculates valuation indicators by referring to the sum profit and loss from trading. This method is based on the assumption that the trading data of investor A is used, and the valuation indicators is calculated using the formula.

In the present embodiment, the information generation unit 3021 extracts (or classifies, tabulates, and processes) the transaction target transaction data, extracts (or classifies, tabulates, and processes) the transaction data further in the step of the component-specific transaction data, creates (or even holds) the profit-and-loss level transaction data as a target, and calculates valuation indicators using valuation indicators calculation table or the like based on the transaction data. That is, the information generation unit 3021 is an epoch-making system in that the valuation indicators are calculated based on the cooperative work of the series of cooperated computers, and that the points of cooperation are not different from each other.

The former decomposes the total trading profit and loss and calculates the valuation indicators by its constituent elements. Since the latter calculates the valuation indicators from the trading data through a series of work processes, it is possible to increase the number of management items as described later, and it is possible to incorporate not only performance data and technical data but also all items that affect the investor's investment performance, such as trends of other investors and price movements of other investments (described later). The former is an example of FIG. 39 (calculate of valuation indicators by decomposition of a mathematical expression). The latter is an example of FIG. 40 (calculate of valuation indicators from trading data).

The former is a decomposition approach. The latter is a database approach of trading data. The approach also differs in the calculation of the same index.

For example, even in the calculation of the valuation indicators of Mr. A's winning profit rate (66% of the profit in the case of winning in FIG. 39), the former is obtained by obtaining the total value of the winning profit (26850000 yen in FIG. 39) and dividing by the total value of the trading price that produced the winning profit (40920000 yen in FIG. 39). On the other hand, in the latter case, the trading data is gradually narrowed down to the winning profit trading data in the second step, the third step, and the fourth step, and is calculated from the trading data using valuation indicators calculation table or the like (see FIGS. 39, 40, and 111).

Various items can be handled, and various extraction conditions and classification conditions can be handled, because the calculation of the valuation indicators can now be calculated in a series of flows by this database cooperation technology. By adding these metrics to the items next to the trading data, a series of operations can all be performed on the database in the subsequent process, and the meaning of the connection is large, and the technological level greatly changed by this.

Of course, as shown in FIG. 40, it is not necessary to add the item “winning profit rate” to the winning profit trading data, but when the item is added, there is a merit that the winning profit rate for each trade becomes clear. It is also envisioned that items such as other valuation indicators and basic data may be added to the sales data and processed. In addition, as shown in FIG. 40, it is possible to easily display the aggregate of each component and the aggregation of the whole.

(Issues with Conventional Technology)

The old method is, for example, an approach of decomposing the aggregate trading profit and loss as in the first embodiment when the total trading profit and loss is evaluated, whereas in the present embodiment, only the trading data whose trading profit and loss is determined is extracted (or classified, totaled, processed) and various valuation indicators are calculated by the information processing system for the trading data. Specifically, when the evaluation of the winning profit total is performed, the difference between the calculation of the valuation indicators of the winning profit total by the decomposition formula as shown in FIG. 39 and the calculation of the valuation indicators by the trading data of the winning profit total as shown in FIG. 40 becomes clear.

In the example of the step of trading profit and loss, the trading profit and loss level trading data is used to evaluate the trading profit and loss. The trading profit and loss level trading data is created (or may be brought to the previous process) by adding processing based on the trading data extracted (or classified, tabulated, processed) from the trading data to be tabulated. The valuation indicators can be calculated by the information processing system on an ad hoc basis based on the transaction data. For example, when the winning profit is evaluated as shown in FIG. 40, the winning profit level trading data is used. Based on the winning profit trading data, the valuation indicators can be calculated on an ad hoc basis. Then, it becomes a structure that is easy to process in the database.

### (Action of Calculation Step of Profit-Loss Level Valuation Indicators)

The information generation unit 3021 extracts (or classifies, tabulates, and processes) the sales data corresponding to the target profit and loss by the information processing system based on the sales data to be tabulated and the sales data by component created in the sales data creation step to be tabulated, performs processing according to the level, and calculates valuation indicators in the information processing system from the profit and loss level sales data.

### (Effect of Calculation Step of Profit-Loss Level Valuation Indicators)

Since various valuation indicators can be calculated by the information processing system in a form determined by using valuation indicators calculation table or the like, it is easy to automate and can be calculated by anyone. Because the database is all linked together, the effects of incorporating various items related to investment profit and loss as valuation indicators, such as technical index values and corporate performance data linking management items with trading data, behavior of the same issues of other investors, and trends of other stocks on the same purchase date, are remarkable. Further, by performing a series of steps of creation of trading data to be aggregated, creation of trading data by component, and creation of trading data at a profit/loss level, by narrowing down trading data to be worked on, if an instruction for how to evaluate what is given to the information processing system, the effect that it becomes possible to handle various types of trading data produces an unknown effect. The transaction data to be aggregated for each period and the transaction data to be aggregated for each investment target are examples.

Further, compared with the prior art, by creating profit and loss level trading data, valuation indicators for each trading can also be calculated, and extraction (or classification, aggregate, processing) of items is also possible, and the application range of the cut-out is widened.

### (Specific Example of Calculation Step of Profit-Loss Level Valuation Indicators)

Explanation is provided separately below.

There are the following three types of calculation steps of the profit/loss level valuation indicators.
(1) Calculation of profit-and-loss level indicators
(2) Calculation of valuation indicators by profit and loss level
(3) Calculation of profit-and-loss level valuation indicators

Refer to the explanatory diagram (FIG. 107) of the calculation step of the valuation indicators.

### (Definition of Calculation of Profit-Loss Level Indicators)

There are various types of profit and loss calculated from trading data. For example, in the case of an unrealized profit, trading data is extracted (or classified, tabulated, processed) at an unrealized profit level. In this case, it is defined as the calculation of the profit/loss level valuation indicators (in this example, unrealized profit) that the sales data created in the fourth step is extracted, and the items such as the inclusive profit rate and the number of days elapsed are added, and the inclusive profit level sales data is created by the information processing system, and the valuation indicators is calculated based on the sales data.

(Issues with Conventional Technology)

In the case of the conventional calculation method, the step of creating the trading data is not performed. Through the creation step, the technology clarified the target to be evaluated and clarified the profit and loss to be targeted. Since the purpose of buying and selling of investment products is mainly to improve profit and loss, the buying and selling data is extracted (or classified, tabulated, processed) based on the profit and loss to be targeted, and the valuation indicators is calculated based on the buying and selling data, and by using it, the target of the aggregate is evaluated and compared, and the flow of the series is all connected, and it is advanced to the next step.

### (Effect of Calculation of Profit-Loss Level Valuation Indicators)

The information generation unit 3021 extracts (or classifies, tabulates, and processes) the transaction data at the profit/loss level based on the transaction data to be aggregated created by the information processing system in the transaction data creation step to create the transaction data at the profit/loss level, and calculates a profit/loss level valuation indicator in the information processing system based on the transaction data at the profit/loss level.

### (Effect of Calculation of Profit-Loss Level Valuation Indicators)

By calculating the valuation indicators based on the extracted (or classified, tabulated, processed) sales data for the target profit or loss, it is possible to calculate an appropriate valuation indicators for the profit or loss to be tabulated.

### (Specific Examples of Calculation of Profit-Loss Level Valuation Indicators)

When calculating the trading profit/loss level valuation indicators, the information generation unit 3021 extracts (or classifies, aggregates, or processes) only the trading data whose profit or loss is determined from the trading data to be aggregated, adds items such as the trading profit/loss ratio, the number of days held by the trading issue, and the win/loss level valuation indicators. For example, the information generation unit 3021 extracts (or classifies, aggregates, or processes) only the trading data for which the trading data of Mr. A has been determined, and calculates a trading profit/loss level valuation indicators such as a winning ratio, a trading profit/loss ratio, and a trading frequency obtained from the extracted trading data.

### (Definition of Calculation of Valuation Indicators by Profit and Loss Level)

There are various types of profit and loss calculated from trading data, for example, when trading data is extracted (or classified, tabulated, processed) by the information processing system at the unrealized profit level, extracting (or classified, tabulated, processed) trading data that has not yet been traded and is profitable, and when trading profit is profitable, extracting (or classified, tabulated, processed) trading data that has already been traded and is profitable by the profit level is defined as calculating the profit and loss level valuation indicators.

### (Problems of Calculation of Valuation Indicators by Profit and Loss Level)

In the calculation of the profit/loss level valuation indicators by the information processing system, a plurality of valuation indicators are assumed to be calculated for one profit/loss level, but in the calculation of the profit/loss level valuation indicators, a plurality of valuation indicators are assumed to be calculated by the information processing system for each of a plurality of profit/loss levels (refer to an explanatory diagram (FIG. 107) of the calculation step of the valuation indicators).

### (Effect of Calculation of Valuation Indicators by Profit and Loss Level)

The information generation unit 3021 extracts the sales data by the profit/loss level in the information processing system based on the sales data to be aggregated and the component sales data created in the sales data creation step to be aggregated, creates the sales data by profit/loss level, and calculates the valuation indicators by the profit/loss level in the information processing system using the sales data.

### (Effect of Calculation of Valuation Indicators by Profit and Loss Level)

In the trading data at the trading profit/loss level and the trading data at the unrealized profit level, the calculated valuation indicators is also different, and the target profit/loss is also different. Therefore, by classifying the two and calculating the valuation indicators separately, a plurality of profit-and-loss level trading data is created, and it is possible to improve the level of evaluation and the like of the aggregation target. In the case of calculating the profit and loss level valuation indicators described above, the sales profit and loss level trading data is targeted for the sales profit and loss level trading data, whereas in the calculation of the profit and loss level valuation indicators, in addition to the sales profit and loss level trading data, for creating a plurality of profit and loss level trading data such as creating unrealized profit and loss level trading data, the valuation indicators is also widely calculated, there is an effect that it is possible to further deepen the operation step after the sixth step.

### (Specific Examples of Calculation of Valuation Indicators by Profit and Loss Level)

For example, winning profit trading data is extracted from Mr. A's trading data (winning profit (bid price (or market price at time A)<offer price) of confirmed trades), processed, and valuation indicators such as the winning profit ratio are calculated with the relevant trading data. Then, the unrealized loss rate is calculated by extracting the unrealized loss trading data from Mr. A's trading data (extracting trading data in which the bid price (or market value at time A)>market value at time B among unsettled trades), and the valuation index is calculated for each level of profit and loss, which is the step of calculating valuation index by level. Since all of the trading data created up to the fourth step can be created, the processing by the computer is in a short time.

(Relationship with Prior Art for Calculation of Profit-Level Stage Valuation Indicators)

Even in the old method, in the first embodiment, the calculation of the valuation indicators varies according to the level of profit and loss (degree of detail), and since the valuation indicators changes, the evaluation is also performed stepwise. Further, in the first embodiment, the calculation formula of the degree of detail 5 is displayed using various valuation indicators corresponding to the degree of detail as an evaluation target.

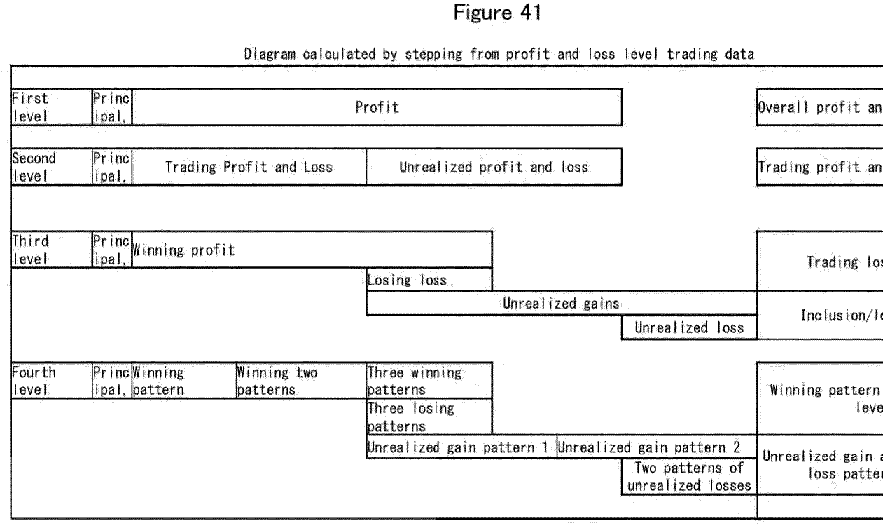

In the old method, the approach method is represented by a calculation formula, and the valuation indicators is calculated by decomposing the winning profit sum into components as shown in FIG. 39, for example. On the other hand, the profit/loss level valuation indicators in the new method is calculated by stepping on the stage from the profit and loss level trading data as shown in FIG. 41 (refer to the explanatory diagram (FIG. 107) of the calculation step of the valuation indicators). For example, the trading profit level trading data is generated, the trading profit level trading data is extracted, and the trading profit level trading data is further divided into three types by the trading pattern level trading data.

Further, in the calculation of the valuation indicators for each profit/loss level, a plurality of sales data for a plurality of profits and losses are generated, and a plurality of valuation indicators are calculated. This profit-and-loss level valuation indicators is a step-by-step technique in which the profit-and-loss level is evaluated in a stepwise manner, and by gradually referring to deep and detailed valuation indicators, the target of the aggregate can be evaluated in a stepwise manner.

### (Definition of Calculation of Profit-Loss Level Indicators)

### (Profit-Loss Level Indicators)

FIG. 41 is a figure illustrating profit-and-loss level index according to the present embodiment. The information generation unit 3021 extracts (or classifies, tabulates, and processes) the trading data based on whether the trading data is being traded in opposition (second level), extracts (or classifies, tabulates, and processes) the trading data based on whether the trading data is profitable (third level), and further extracts the trading data based on the pattern (fourth level). The trading data is processed and created by a method of extracting (or classifying, aggregating, or processing) the trading data in a stepwise manner, and each valuation indicators is calculated. However, the above-described example is merely an example, and may be divided into two stages, three stages, a second level, or another division method.

### (Problems for Calculating Profit and Loss Level Indicators)

In the calculation of the profit/loss level valuation indicators, the valuation indicators was calculated for each profit/loss level, but in the profit/loss level valuation indicators, the sales data by profit/loss is extracted (or classified, tabulated, processed) for each level such as the first level, the second level, and the third level, and the valuation indicators is calculated for each stage by the information processing system. As a result, the valuation indicators is calculated by the information processing system by sequentially calculating the detailed valuation indicators instead of the variations.

### (Effect of Calculation of Profit-Loss Level Indicators)

The information generation unit 3021 extracts (or classifies, tabulates, and processes) the sales data for each profit and loss level based on the sales data for aggregate created in the aggregation target sales data creation step to create the sales data for each profit and loss level in stages, and calculates the valuation indicators for each profit and loss level in the information processing system for each stage.

### (Effect of Calculation of Profit-Loss Level Indicators)

In evaluating the trading situation, the number of valuation indicators increases as the trading profit/loss level at the first level proceeds to the trading profit/loss level at the second level, the winning profit level at the third level, and the winning pattern level at the fourth level, and the valuation indicators narrowed down in detail are calculated by the information processing system, so that fine valuation indicators can be calculated in stages.

The importance level is higher for the upper level and lower for the lower level, while the level is higher for the overview and the overview, and the lower for the lower level, the detailed part is known. For example, it is possible to compare trading data of winning trades with trading data of losing trades, and compare changes in corporate performance and changes in technical indicators between the two trading data.

### (Specific Examples of Calculation of Profit-Loss Level Indicators)

FIG. 42 is a diagram illustrating a specific example of calculation by the information processing system of the profit and loss level stage valuation indicators according to the present embodiment. FIG. 42 is an example of a total profit of 22890000 yen with a principal of 0.5 million yen.

At the first level, the overall profit was 22890000 yen, but at the level of trading profit and loss, 16230000 yen, at the winning profit, 26850000 yen, and at the losing loss, 10470000 yen, the actual state of profit and loss becomes clear.

For example, it can be seen that FIGS. 39 and 40 refer to the third winning profit level of FIG. 42 and only evaluate a portion of the total.

By calculating the respective valuation indicators, the winning profit margin of 67% and the losing loss ratio of −11% are gradually clarified, so that it is possible to accurately grasp the overall view of the trading data to be tabulated and each portion.

In the case where the total profit/loss becomes 22890000 yen at 0.5 million yen, the total profit/loss trading data is created by the information processing system at the first level, the decided trading data and the undetermined trading data are divided, the decided trading data is further divided into the winning profit trading data and the lost trading data, the undetermined trading data is further divided into the inclusive profit trading data and the inclusive loss trading data, and is further divided into the pattern. As a result, a plurality of useful valuation indicators are calculated in each transaction data by the information processing system. After the stage, the actual state of profit and loss will become clear. By calculating the respective valuation indicators, the winning profit margin of 67%, the losing loss margin of −11%, the unrealized profit margin of 88%, the unrealized loss margin of −5%, etc. are gradually clarified. As a result, it is possible to accurately capture the entire trading data and the component trading data to be tabulated and the respective portions by the information processing system (see FIG. 107 for an explanation view of the calculation step of the valuation indicators).

Among the calculation steps of the valuation indicators by the information processing system, there are a calculation process, a selection determination process, and a display process.

### (Significance of Evaluation Indicator Calculation Process)

The basis for the calculation of the valuation indicators by the information processing system is the trading data extracted (or classified, tabulated, processed) in the process up to the fourth step. The data necessary for the task is included in the created transaction data in accordance with the task, and the valuation indicators calculated by the information processing system based on the data is also valuation indicators derived in accordance with the task.

For example, in 2020, the winning ratio of trading by A issues and the share of trading profit of A stocks are the data for trading by component of each stock in the period-based trading data for 2020, and are the valuation indicators that can be derived only from trading profit and loss level trading data. Everything is linked. This is why valuation indicators capable of solving the problem is calculated by the information processing system. Further, the valuation indicators such as the winning rate are valuation indicators derived from the transaction data, but the items necessary for the evaluation target are selected as the management items in the transaction data. For example, in the case of a brand, a technical index value, a corporate performance, or such an index is also a kind of valuation indicators, and is valuation indicators that can be utilized in subsequent operation steps.

What is particularly important, for example, is that the technical index managed therein is not merely a technical index value, but is a technical index value managed in association with purchase data or the like, or is performance data. Compared with the case where the product is linked to the brand information, the technical index value moves while the product is held after the purchase, and when the sell signal lights up, a warning is generated, or information that has been scattered up to now is connected. There is a lot of different information that can be used and managed by the connection between brand information and purchased information. In this regard, because it is difficult to understand, the issues that are managed (held) by themselves are automatically linked to technical indicators, candle feet, chart data, and so on. For example, if RSI index of the stocks held exceeds 80%, the signals are very easy to be generated when the constriction line is formed by the candle feet. It can be shown in a chart that you see every day, and it can be represented in a dashboard that looks like the technical indicators of today's stocks, and it can be used in various ways by linking them with buying and selling data. For example, if you buy a stock where you feel overheated at the time of purchase, you can issue a warning sign and prompt you to lose early. In addition, being able to manage means that the technical data is stored in a form linked to the sales data. This will become a great weapon later. In other words, investor A records that he or she is buying and selling at the time of this technical index value. Therefore, he or she can use a warning sign to prompt a loss cut or to discourage profit determination when a similar failure occurs due to a combination of failures. This is one of the major features of the information processing system that can incorporate not only technical index values but also various items related to investment profit and loss, such as corporate performance data, behavior of the same brand of other investors, and trends of other brands on the same purchase date, as valuation indicators.

(Issues with Conventional Technology)

The valuation indicators are also mentioned in the first embodiment, and various valuation indicators are also described. However, these metrics are derived from trading data in a narrow sense. Basically, the winning/losing rate and the profit ratio are calculated based on the valuation indicators derived from the narrow-sense sales data such as the purchase date, the issue, the purchase price, the sale date, the sale price, and the transaction quantity. However, in the fourth embodiment, in addition to these valuation indicators, it is possible to incorporate various items related to investment profit and loss as valuation indicators, such as a chart, a technical index, a trend of corporate performance, a behavior of the same brand of another investor, and a trend of another brand on the same purchase date, which can be linked to a set of the brand and the date of purchase and the date of sale. This is a very possible technological innovation that can be used to change trading behavior and advice. Although these information are generally information, they are not linked to purchasing information. Relationships with purchasing information are the first to link purchasing stocks with these information, which in turn has special implications. The combination of information on the technical index value, corporate information, and the behavior of the same investor and the trend of the other stocks on the same purchase date and the purchase information makes it possible for such information to be used in the management after purchase in an exhaustive manner, and it is possible to confirm when a trade or purchase is completed later, or to keep these records, so that points and weaknesses that are always stumbling can be determined. It is a technological innovation that has an enormous impact on dramatically expanding and deepening advice and diagnostic capabilities. In addition, although there are a variety of valuation indicators, the probability of winning a stock for Mr. A can be calculated relatively easily using the information-processing system. However, in the case of the problem that the probability of winning a deal for the A brand of the Daily Tray Investment Type Group in 2020 is how much?%, it is necessary to appropriately derive it from the database. In addition, it is essential and impossible to manage RSI and RSI at the time of sale of A issues in the 2020 day trading Investment Type Group, since it is not necessary to cooperate with the data base. In the fourth embodiment, since consistent cooperation is performed, when the management item is added to the management item in the first step, the management is performed in this step in the fifth step, and is also managed in the advice in the tenth step, so that it is possible to provide the advice by the information processing system using these indices.

### (Operation of Evaluation Indicator Calculation Process)

The acquisition and sale data for which the investment type is a day tray is used to generate the acquisition and sale data for each period, and the acquisition and sale data for each period of the day tray type group in 2020 is generated by the information processing system under the condition that the acquisition and sale data for each period of the day tray type group in 2020 is used to generate the acquisition and sale data at the level of profit or loss (even if it is carried in the previous process), the issue creates the component sale data for the brand A, extracts the number of transactions and the number of wins from the acquisition data, and the winning rate is derived, and is calculated by the information processing system. In addition, RSI of A issues in the 2020 day trading Investment Type Group when purchased is managed as one of the constituent elements at the time of creation of the trading data (included in one item of the trading data), and can be immediately derived when the information processing system is needed. Corporate performance is similar to the behavior of other investors in the same brand and the behavior of other brands in the same purchase date. These are not merely RSI or corporate performance, the behavior of the same brand of other investors, the behavior of other brands on the same purchase date, or the like, but are one of the valuation indicators that have the purpose of calculating valuation indicators associated with the investment profit or loss, which is the purpose of the trades data set, by the information processing system.

To explain what it means that RSI at the time of purchase will be managed, we assume that the stock price at the time of stock A is 500 yen and RSI is 20% on May 1. After that, we assume that the stock price was 550 yen and RSI was 50% on June 1. These numbers can be managed by individuals, but unless they like stocks, they cannot be managed and are very cumbersome. While other technical index values are vast, the usual person does not know what to choose. So it is best to leave this to the computer. RSI at the time of purchasing is managed, and the movement of RSI corresponding to the price movement from there on a daily basis can be captured, which also determines RSI at the time of sale. It is very important that such information be recorded on a daily basis. The most important reason for linking with the purchase data is that the data can be recorded in this database, and advice and diagnosis using it later become possible, and each function is dramatically improved.

### (Effect of Evaluation Indicator Calculation Process)

Up to the fourth step, the target trading data is determined, and the valuation indicators required to solve the problem can be calculated by the information processing system for the valuation indicators derived from the profit/loss (or the average trading profit/loss ratio (the average of ROI)) that is the overall outcome of the trading data, and the information processing system calculates the valuation indicators that is in line with the problem and that is broad and deep in depth. In addition, RSI and corporate performance at the time of the purchase of A issues of day trading Goop in 2020, behavior of the same stocks of other investors, and trends of other stocks on the same purchase date are also linked to the transaction data, so it can be used in a variety of ways. Therefore, RSI that was 20% at the time of purchasing can be managed to be 40%, 50%, and so on, as the stock price is updated on a daily basis. It is also recorded in the data base that about 50% of the stock was sold (the stock price rose by 10%), but then the stock price rose further, reaching RSI80 percentage point and the stock price rose by 40%, eventually losing large profits. These data later become the property of investors, the rules of success and the rules of failure, and the technological innovation that can greatly contribute to the visualization of investments.

### (Specific Examples of the Valuation Indicators Calculation Process)

### Example 1

The technical index RSI is 20% or less of the purchase data, and the problem of whether the winning rate, the profit rate, and the stock composition ratio of the trading profit of the trading data for which the counter-trading was performed is the stock composition ratio. First, the trading data with a purchase time RSI of 20% or less is extracted from the trading data to be tabulated, the trading profit/loss data is created, and the component trading data tabulated for each brand is created by the information processing system, and the total value of the trading profit and the composition ratio of each brand, the number of trading transactions, the number of trading data of the winning, and the profit rate of the trading data of the winning are calculated. This is a step of calculating valuation indicators that is very difficult or impossible to calculate without cooperation with a database.

### Specific Example 2

For the problem of comparing the winning rate, the winning profit rate, and the trading profit/loss ratio between the person who buys and sells with the holding period of 5 days or less and the person who buys and sells with the holding period of 120 days or more, the information processing system creates trading profit and loss level trading data by the information processing system, adds the holding period item of the sale date from the purchase date to the database as processed data by the information processing system, and compares the winning rate, the profit rate, and the trading profit/loss ratio of each of the trading data with the holding period of 5 days or less and the trading data with the holding period of 120 days or more.

### Example 3

Twitter can be used to create article data on the characteristics of buyers and sellers by using Mediums-specific trading data, which are extracted in the “Media: Quarterly Report” and then compared with the indices of all investors.

### Example 4

In Example 2, short-term trading traders and medium- to long-term investors can win rather than win as article data.

### Example 5

Exemplary 1 can be used as an RSI that is well known as a technical indicator, and as a story about the win rate.

### Example 6

The trading behavior of the same stock of other investors after the same purchase date can be one of the metrics.

### Example 7

Ranking of the rate of decline of other stocks on the same purchase date and compare with other stocks during the holding period can be one of the valuation indicators.

### (Definition of Valuation Indicators)

Valuation indicators are indicators for evaluating (or comparing, ranking, diagnosis, advice, etc.) a subject (investor in the case of an investor, investor in the case of a subject), and the components affecting the subject's investment profit and loss are defined as valuation indicators.

(Issues with Conventional Technology)

In the first embodiment, the valuation indicators is an index calculated from transaction data (trading data in a narrow sense), for example, as an example of a turnover force, a winning profit rate, a loss rate, a trading profit/loss, a rise/fall rate of a holding stock, a principal increase/decrease rate, and the like, and is mainly an element that has a direct influence on trading profit/loss. These metrics are certainly important, but there were other factors affecting investment profit and loss, so there was a problem that they were not covered. For example, the timing of trade or selling an investment. A change in timing alone can result in a loss or profit. This is not included in the previous metrics. The purpose of the valuation indicators calculation is to calculate valuation indicators for appropriately evaluating the object and improving the target investment profit and loss. Incorporating factors that influence the investment profit or loss that is the objective enables appropriate valuation and increases the ability to make proposals and diagnoses to improve the investment profit or loss. The components affecting investment profit and loss include changes in the timing of trading and fundamentals of the investment, the behavior of other investors, and the price movements of other investments. By adding these indices to the model of the information processing system as valuation indicators, it is possible to more appropriately evaluate the target or the like.

### (Effects of Valuation Indicators)

Up to the fourth step, target trading data is determined by the information processing system, and various valuation indicators are calculated from the trading data by the information processing system. For example, in the case of the trading profit-loss ratio, the trading profit-loss ratio of each trading is determined by the investment profit-loss/purchase amount of each trading, and the average trading profit-loss ratio in the trading data is obtained by obtaining the average value. For example, if RSI value at the time of purchase is determined at the time of purchase and the stock is being held, RSI value of the stock on the current date is managed in the data base, and therefore, the value is updated and recorded in the information processing system every day. If RSI value at the time of purchasing is 40% and the present RSI value is 80%, it is managed as one of the valuation indicators in the information processing system. If RSI exceeds 80%, a warning signal or the like can be generated. There are other metrics for calculation. These calculation procedures can be managed in a unified manner by managing them in a calculation table or the like. In the above example, the information processing system calculates various valuation indicators based on the determination that the trading profit/loss ratio=the investment profit/loss of each trade/the purchase amount of each trade=(the sale amount−the purchase amount)/the purchase unit price×the purchase amount and the average trading profit/loss ratio of the trading data=the average value of the trading profit/loss ratio of the trading data.

### (Effect of Valuation Indicators)

Exemplary RSI such as those mentioned above provide the benefits not conceivable in the case of embodiment 1. By incorporating charts, technical index values, other investor's investment behavior, and other movements in the value of other investments into the valuation indicators of the information processing system, the merits of adding valuation indicators for the timing of trading to the management of the information processing system and placing a factor that significantly affects the investment performance of the investment target, such as a change in fundamentals of the investment target, such as business performance, in the management of the information processing system are unknown. Simply displaying charts, displaying technical indicator values, and displaying corporate performance requires investors to make their own decisions. However, the technical meaning that these valuation indicators can be associated with the trading data in the information processing system has an extremely large effect. The addition of technical indicators, corporate performance values, and trading indicators is a technological innovation that has a significant impact on a set of actions, such as investor evaluations, valuations of investments, advice and diagnostic skills, compares, and rankings.

### (Example 2 of Valuation Indicators)

One of RSI mentioned above is the technical significance incorporated in the valuation indicators of the information processing system. Any technical index value can be incorporated, meaning that the technical index value at the time of purchase and the technical index value during holding, at the time of sale, and after sale are accumulated along with these buying and selling actions. While ordinary investors are not aware of this, this means that the information processing system allows investors to read the tendency of buying and selling of investors, the usual pattern of investors, and so on by recording these figures at the time of purchase or sale, without being conscious of the information processing system. This is a very innovative technology in the investment world. Those that cannot normally be managed can now be managed and used in a variety of ways.

### (Example 2 of Valuation Indicators)

Corporate performance is similar. The fundamental changes must be influenced by trading, but this is also quite difficult. There is a quarterly settlement of accounts, and changes in the fundamentals of the enterprise, such as revisions during the period, are daily events, and it is necessary to have a considerable experience and know-how in terms of when and what impact it will have. However, in the information processing system, these changes in corporate performance can also be incorporated into valuation indicators, and the fourth embodiment has evolved so that they can be utilized for evaluation, advice, diagnosis, and the like. For example, in the current fiscal year (for example, if the current fiscal year is September 2020, for a company with a fiscal year ending March 2021, for a company with a fiscal year ending March 2021), the company's sales forecast figures can be incorporated into one of the valuation indicators. In September, 100 billion yen was revised upward in December, and 120 billion yen was revised upward in March, and 140 billion yen was revised upward in March. In May, the actual figures were shown and 150 billion yen. So far, we have to manage the purchased issues by ourselves. However, this means that this change can be incorporated as one of the valuation indicators in the information processing system. This year's sales forecast at the time of purchase is ¥100 billion, and with the passage of time, as well as the market value evaluation, this year's sales forecast is also added as valuation indicators. Therefore, it is updated to ¥120 billion in December, updated to ¥140 billion in March, and updated to ¥150 billion in May. Daily update information is also updated, and the history of the past is also accumulated as needed. This is very innovative, and it means that investors can leave the information processing system to some extent to be troublesome, such as technical analysis and checking of corporate performance trends.

### (Example 3 of Valuation Indicators)

The behavior of other investors is another factor that has a significant impact on investment profits and losses. For example, suppose that there is a stock with a current stock price of 800 yen, and that other investors had purchased 850 yen a month ago. This is called selling pressure, and it is common in the market that the closer to 800 yen to 830 yen and 850 yen, the more pressure they want to sell, and the price movement stops. Until now, this was left to the individual's judgment, again symbolizing the difficulty of stocks. This is a typical example that is affected by investment gains and losses as well as by the behavior of other investors. In the information processing system, when a brand is purchased, the brand, the purchase date, the purchase price, and the like are recorded, and at the same time, the behavior of other investors is recorded. It also means that the past purchase history of the purchased issue is taken, and it means that the investor's behavior in the past as well as the investor's behavior in the past of the purchased issue is known. Therefore, the fact that such a selling pressure is around 850 yen is one of the characteristics of the information processing system that it is possible to sufficiently predict. Since the trading data is recorded in the recording section as trading data to be compiled by investor, it has the flexibility to add such information of the purchased brand as valuation indicators. The method of grasping this information processing system may be set so as to go to the past purchase history of the issue at the time of purchase. Specifically, it is necessary to indicate whether there is a price range in which many trading prices are collected in the past month in a price range higher than the current stock price of the stock. It is also possible to create and manage a sell pressure zone table for each issue. In this case, it is possible to manage the table as valuation indicators and refer to the table, so that the zone can be recognized and displayed in the information processing system immediately.

### (Specific Examples of Valuation Indicators 4)

In addition, the price movements of other stocks are one of the major components affecting investment profit and loss. The inflow of funds into the market is limited to a certain extent. In particular, funds circulate, and stock A is sold, and stock B is bought with the sold funds. The funds are traded in the market on a daily basis. Thus, rather than having to manage even the issues they own, the trends in stocks they do not own and the overall market trends always affect investment profits and losses. The trend of other stocks also includes information such as the fact that the information processing system takes information at the back, so this trend can be managed, and the stocks in question are up by 10%, but B stocks purchased by other investors in the same period are up by 30%, and the trend of the stocks that have risen most since the date of purchase can be traced. This is one of the functions added to the information processing system as a result of the merger of trading data and market data, like RSI value.

(Method of Linking Technical Indicators, Etc. And Trading Data)

There are two broad methods for linking technical indicators, corporate performance, and trading data. One is to associate with stock information, which is often used to manage stocks in particular, and when clicking on a stockholding, the stocks are linked with charts, technical indicators, corporate performance, stock news, and so on. This is the first method, which is usually common. The second method refers to a method in which the stock and date (such as the date of purchase, the date of sale, the date during the holding period, and the date and time after the sale) are linked to the trading data in some way. One method is the method of FIG. 91, but other methods that are dated with the issue fall into this category. For example, how does the difference arise when the issue is attached to the day of purchase and when it is attached to the brand? If it is associated with a brand, as described above, when the brand is clicked, information about the brand is output. On the other hand, when the stock is linked to the purchase date, RSI value of the purchase date of the stock, the output of the business performance on the purchase date, and the display can be made, and when the date is updated, RSI value of the holding date and the business performance can be expressed with the update of the date. This term refers to the method by which the forecast of sales of the company on the purchase date is managed, the forecast of sales of the company on the sale date in the current fiscal year, the forecast of sales of the company during the holding period in the current fiscal year, and so on. If it is associated with the issue information, it should be displayed as information on the brand, and if it is associated with the brand, the date, and the trading data, it should be displayed as personalized information (information transmitted only to investor A). Investor B, who purchased the same stock on different dates, shows a different indication. Here, this method is defined as a method (personalization method) in which a stock, a date, and trading data are associated with each other.

### (Significance of Calculation of Valuation Indicators for Technical Indicator Values)

Technical indicators are commonly used in the stock market. There are many kinds of technical index values, such as determination of whether the stock price is heated, determination of the time of purchase, and determination by automatic trading.

(Issues with Conventional Technology)

Even if we know that these technical index values are important, management is very difficult, there are too many types, and we don't know which one to use, and there are many people who can't use them, and they can't use them, or they can't use them if everyone can use them, so many people don't use them because of their difficulty and difficulty in managing them. Stocks have also become one of the biggest causes of difficulty. However, such a field is the appearance of computers, and it is a good material for making machine learning and gradually increasing accuracy by recording on computers every day. However, this time, it does not go deep, and it is a technical index that can be used by anyone, even if the management after the purchase, the possession, and the sale is carried out using the technical index as one material. However, the association of the same technical indicators differs significantly from the association of dates and stocks to the presentation of stocks. Technical index values are often displayed in association with this issue. Technical indicators and corporate performance can also be viewed on the stock chart on the management screen. This information is related to a brand, and the problems of the prior art are that even if a technical index value or the like is posted, each person must manage the information, and a very normal person cannot manage the information. When the technical indicators are displayed on the management screen with the issues they hold, they are not personalized because they are not tied to their own purchases, even if they have information. However, if it is linked to the purchase date and the sale date, it can be used for advice and diagnosis based on the timing of the purchase and the sale, and it can be used for comparison, ranking, evaluation, and the like. They are quite different in function, function, and effect from those associated with purchases or sell.

### (Effect of Calculation of Valuation Indicators for Technical Indicator Values)

It is important to make the technical index value to be a control item in the first step as a preparation stage. Any technical index can be used, but this is RSI. When a brand is purchased, the purchase date and the brand are determined, so a RSI table that manages the purchase date and the brand RSI is prepared, and if it is associated with the sale data, the data of this table can be captured (refer to the database related diagram (FIG. 91))(not limited to this method, and includes all cases where the brand and the purchase date (or the sale date) are associated with the value of the technical index). As a result, the linkage between the trading data and RSI is completed, and as one of the valuation indicators of the fifth step, the daily RSI of each issue can be managed as the valuation indicators. By linking the purchase date with the issue, RSI after 10 days from the purchase date can also be managed. RSI is managed at the time of the sale, and the same applies after the sale. The history of RSI from buying to selling is also managed for each issue. In other words, this is an image in which one important valuation indicators increases.

### (Effect of Calculation of Valuation Indicators for Technical Indicator Values)

What will change when this RSI can be managed? First, RSI to sell after purchasing is controlled on a daily basis. This kind of management must be a stock-lover. Common investors are not aware of this. However, if the daily RSI is to be tracked on a computer, it is easy to issue a warning signal by the information processing system when it is generally said to be over 80%. Furthermore, even after the sale, when the RSI, which had risen to 80% at the time of sale, drops below 20%, the RSI is managed by the relevant information processing system, so that it is possible to say, “The RSI of stock A, which I sold recently, has dropped below 20%. It may be time for you to purchase again. The information processing system can also display such messages as “It may be time for you to buy again. Users are too complicated to manage, but it must be very convenient if the computer emits a hazard signal or a purchase signal. Further, these pieces of information are sequentially stored in a computer. There are some successes and some failures, but even those learn to work with learning effects. It is a technological innovation that is highly likely to make further progress by linking with AI technologies. The more data is accumulated, the more accurate the decision can be communicated, and the more the potential is expanded by simply linking the data at the time of purchase. By associating RSI control table and the trading data control table with issues and dates (database-related diagram (FIG. 91))(not limited to this method, but also including cases where the brands and the date of purchase (or the date of sale) and the value of the technical index are associated with each other), the valuation indicators of the information processing system is dramatically increased, and the ability to give advice and the ability to evaluate is rapidly increased. Looking more closely at the effects of each aspect of trading, we look at the following.

### (Specific Examples of Calculation of Valuation Indicators for Technical Indicator Values)

See examples of RSI in the text.

### Example 1

In the case of buying and selling data by investor, it is possible to raise awareness of the technical indicators when buying and selling them at the time of buying, and to offer advice on the early sale of loss-cuts, etc. and, in the case of buying at the timing of buying with a high probability of success, offer advice on buying or comparing with other stocks and offer selection of brand replacement.

### Specific Example 2

In the case of trading data for individual investment targets, if the index gradually becomes overheated during holding, it can be expected to have an effect such as advice on sale or partial sale or displaying comparative data or ranking data for other investment targets with the index being cheap. In the case of sale, it is possible to add functions such as watching the price movement after sale with the information processing system and notifying that the technical index has become overheated.

### (Significance of Calculation of Valuation Indicators for Corporate Performance)

Corporate performance can be said to be information that is sticky to issues, and the more it is said to be information about stocks, the more trends in corporate performance are posted together. However, these pieces of information are enormous and difficult to manage. It is often used as a decision-making material for what to buy at the time of purchase.

(Issues with Conventional Technology)

Firms that have achieved positive results relative to their forecasts, for example, attract attention and buy. The opposite is true. It is also common practice to buy and sell on the basis of such information. However, when used to manage stockholdings, their use changes dramatically. This is possible by linking with the purchase data. Normal corporate performance is provided as one of the stock information. Even if it is posted in the information of the stock, it is carried out with the string with the brand information. The association of the same firm performance differs greatly from the association of dates and stocks to the presentation of stocks. Corporate performance is often shown in association with this issue. In addition to the stock charts, the company's performance can also be viewed on the management screen. This information is related to the issue, and the problems of the conventional technology are that even if the business performance and the like are posted, each person must manage the information, and it is difficult for a very normal person to manage the information. If the company's performance is displayed on the management screen along with the stockholdings, they are not personalized because they are not tied to their own purchases, even if they have information. However, if it is linked to the purchase date and the sale date, it can be used for advice and diagnosis based on the timing of the purchase and the sale, and it can be used for comparison, ranking, evaluation, and the like. They are quite different in function, function, and effect from those associated with purchases or sell. What is the effect of a database of relationships between the date of purchase, the issue code, and the corporate performance of the issue code?

### (Effect of Calculation of Valuation Indicators of Corporate Performance)

First, a separate table is prepared. In the business performance table, the table includes at least one of a date, a brand code, and a business performance, and it is ideal that the business performance can manage a sales forecast value, a sales result, an operating profit forecast value, an operating profit result value, and the like every year and every quarter (the table below the valuation indicators calculation table (FIG. 111) is an example). For example, in the case of a quarterly settlement, the first quarter is 10 billion yen, and if this is an actual value, this data is linked with the date, and it is managed as the sales amount of the latest quarterly settlement. As of May 1, it was 10 billion yen, of which the actual value for the second quarter comes out. If the second-quarter revenue is 12 billion yen on August 1, the sales amount for the most recent quarterly settlement will be updated.

As a result, if the purchase date is May 1, the latest quarterly financial results can be captured by the information processing system in August 1. In other words, the data of the purchase data and the business performance are linked, and it becomes one of the important valuation indicators for measuring the investment result. The trend in corporate performance also has a large impact on stock prices and is a matter to manage. For busy investors, however, it is difficult to manage it, and it is common for busy investors to be unaware that the business has been sold or the situation has changed due to a deterioration in business performance. By linking these pieces of information, changes in corporate performance from the purchase date are updated as needed, linked to the purchase data. If, after purchasing on May 1, the Company announces its earnings forecasts, it manages the date and range of revisions. If, for example, the Company announces revisions to its earnings forecasts that clearly show the difference between the forecasts and actual results, the date and range of revisions will be managed by the information processing system. This implication is important, not just a frequent corporate performance announcement.

### (Effect of Calculation of Valuation Indicators for Corporate Performance)

One of the important implications is the ability to accurately catch changes in the company's performance from the time of purchase to the time of sale. Normally, such a change cannot be made unless it is always watched. However, this watch is left to the information processing system, and it becomes possible to judge that, among a number of stocks held, which stocks require attention, and which stocks do not need to be closely watched at present. What is important is that business performance and trading data are linked as one of the valuation indicators, so it is possible to examine, for example, whether there is a difference in the winning rate between buying and selling of issues with an increase in sales and profits and buying of issues with a decrease in sales and profits, and whether the trading profit/loss ratio is higher. Both stocks can be compared, and advice and diagnostic capabilities can be expected to improve dramatically. For example, when a company's performance falls badly or when a change occurs in the forecast number, the information processing system can judge the meaning of the change (in this case, by creating a table in which rules such as such display are determined) and display it. Thus, the system exhibits special effects. For example, if a downward revision of corporate performance is announced and the stock price is significantly lowered after the decision to sell, the information processing system can read the fact that the decision to sell was correct and highly valued, and these can be added to one of the evaluations. As a characteristic of the top 10 issues with a total profit/loss ratio in 2020, it is possible to display the trends in corporate performance together, and it can be expected that the effect will be such that it is important to look at the valuation indicators of corporate performance by referring to any number. In any case, it is an invention that provides an unprecedented effect, for example.

### (Specific Examples of Calculation of Valuation Indicators for Corporate Performance)

If we manage each business performance revision date, revision range, revision rate, sales, and operating profit, we can associate this with buying and selling data and calculate and display the highest winning rate by the information processing system if we buy it when the date elapses after the upward revision.

### Example 1

In the case of trading data subject to aggregate by investor, at the time of purchase, PER and dividend yield at the time of future announcement schedules and purchase of the stock concerned are automatically calculated and displayed or stored. The information processing system can monitor changes in the company's performance after the purchase, and can manage all of the information processing system's notifications, schedule of changes, date of changes, and timing of changes. At the time of the sale, the stock price is sold because of the deterioration in business performance, and the stock price is significantly lowered. The company also believes that the technical index is cheap, and provides information such as comparison at the time of purchase. It can also be expected that it is possible to evaluate and diagnose the correctness of the sale.

### Specific Example 2

In the case of trading data for each type of investment, when the company is purchasing, it displays the forecast sales and recurring profit on the screen at the time of purchase. When the company holds the forecast, it reports the change in the forecast number at a glance. When the company sells the company, it records the forecast of the current earnings and so on. When the company changes the forecast, it can add a function to notify the change.

### (Significance of Calculation of Valuation Indicators for Trends of Other Investors)

In the case of the trading data subject to aggregate by investor, the information is extracted as “extraction condition: investor=investor A”, but in practice, information of other investors such as investor B is also processed and accumulated by the information processing system. It is easy to extract investors who have the same purchase date with the same brand. In one aspect of the information processing system database technology, it is easy to extract buying and selling data of the same purchase date with the same brand if the extraction condition is “extraction condition: brand=the brand” AND “purchase date=the purchase date” in the buying and selling data of the same purchase date with the buying and selling data of each investor, and it is easy to present the information by the information processing system. From the sales data, it is possible to separate and display the sale date and the percentage of the trading data that continues to be held, the trading data that has already been held and the trading data that has already been countertraded, and it is possible to calculate the average value, the mode value, the average profit rate of the trading data that is being traded, and so on.

(Issues with Conventional Technology)

I want to see how I buy and sell the issues I bought, but I have never had a technique. Well, I don't know what I bought on the same day. But there is not as much information meaningful to investors. I bought it on the same day, but it has crashed. In fact, most of the people who bought it on the same day are already sold out, but they are too busy to sell. The situation is known. Of course, not everyone is right, and there is a possibility of a sudden rise afterwards, so it is impossible to decide whether it is good or bad, but at least it is very meaningful to be able to check and understand the trends of other investors.

### (Effect of Calculation of Valuation Indicators for Trends of Other Investors)

Under the above conditions, by selecting “Sampling conditions: brand=relevant brand” AND “Purchase date=relevant purchase date”, it is possible to easily extract data on the same brand and on the same purchase date with the information processing system. When various valuation indicators are calculated for the trading data set by a procedure such as normal trading data, valuation indicators derived from the trading data sets of the purchasers of the same brand and the same purchase date are calculated, and by using the valuation indicators, it is possible to easily display the comparison with other products, the order of the purchasers, and the like.

### (Effect of Calculation of Valuation Indicators for Trends of Other Investors)

Other investors can be limited to the issue, the purchase date, the holding period of the issue, or the sale date of the issue.

### Example 1

In the case of trading data by investor, information such as the number of shares purchased by other investors at the time of purchase, the average purchasing unit price, what reference was made to the purchasing unit price, what type of investors purchased, and what type of investors purchased can also be grasped by the information processing system, and in the case of holding the information processing system, the number of persons who gradually sell the shares is increasing and the ownership ratio is decreasing, and it is also possible to confirm how the group of persons who buy and sell the shares is moving. At the time of sale, it is possible to confirm whether the firm's own profit was earlier or later than the other people, whether the profit rate is higher than the average, when the highest person sold, etc., and after the sale, it is possible to confirm how much the result of the relevant stock was after the sale, and so on.

### Specific Example 2

In the case of the trading data to be counted for each investment target, the total participants at the time of purchase know how much of the total trading price is processed by the information processing system, and the like. At the time of holding, the investor at the time of the whole is sold and the ownership ratio is what, and at the time of the sale, the ratio of the current owner and the profit and loss determinant, the average trading profit and loss ratio, the winning ratio, and the like are displayed in the data extracted only on the purchase date of the relevant brand.

### (Significance of Calculation of Valuation Indicators for Trends in Other Investments)

In the case of the trading data to be counted by investment object, the information is extracted as “extraction condition: investment object=investment object A”, but in practice, information on other investment objects such as investment object B is also processed by the information processing system and accumulated. Extracting other investment targets purchased on the same purchase date is one of the superior aspects of the database technology of the information processing system that can be easily performed. In this case, if the extraction is performed with the “extraction condition: purchase date=the purchase date” in the trading data to be aggregated for each investment target, the trading data on the same purchase date can be extracted, and the information can be easily presented in the information processing system. From the sales data, it is possible to separate and display the sale date and the percentage of the trading data that continues to be held, the trading data that has already been held and the trading data that has already been countertraded, and it is possible to calculate the average value, the mode value, the average profit rate of the trading data that is being traded, and so on.

(Issues with Conventional Technology)

I want to see how I buy and sell the issues I bought, but I have never had a technique. I don't know what other investors buy and sell on the same day. But there is not as much information meaningful to investors. I bought it on the same day, but it has crashed. However, people who purchased other stocks are increasingly increasing unrealized profits. Of course, not everyone is right, and there may be a sudden fall afterwards, so it is impossible to decide whether it is good or bad, but at least, it is very meaningful to be able to check and understand the trends of other investments.

### (Effect of Calculation of Valuation Indicators for Trends in Other Investments)

If extraction is performed under the above conditions under “extraction condition: purchase date=the purchase date”, the information processing system can easily extract purchase and sale data of purchases of other investment targets on the same purchase date. When various valuation indicators are calculated for the trading data set by a procedure such as normal trading data, valuation indicators derived from the trading data sets of other investment targets of the purchaser on the same purchase date are calculated, and by using the valuation indicators, compare with other products and their ranking can be easily displayed.

### (Effect of Calculation of Valuation Indicators for Trends in Other Investments)

Other investments can be limited to the date of purchase, limited to the holding period of the issue, limited to the date of sale of the issue, or used in a variety of ways.

### Example 1

In the case of trading data by investor, information such as how many shares were purchased for other investments and how many participants were invested compared to other investments can also be grasped by the information processing system at the time of purchase. At the time of holding, the number of those who gradually sell other investments is increasing and the percentage of those who hold such investments is decreasing. However, it is also possible for the information processing system to confirm that the group of those who buy and sell to the superior has purchased the issues at the same time. At the time of the sale, it is possible to confirm whether the stock's profit is fixed earlier or later than the other investment targets, whether the profit rate is higher than the average, and the highest person can confirm when and when the investment targets have been sold, and after the sale, it is possible to confirm how much the stock's performance was compared to the other issues.

### Specific Example 2

In the case of the trading data for each investment target, it is possible to determine whether there are more participants or less participants than other investment targets at the time of purchase, how much is the ratio to the trading price, whether the investment target differs from the trading trend of the other investment target in terms of winning rate, average holding period, and winning profit rate, etc. at the time of holding, and, eventually, how the rate of rise and fall during the holding period of the issue was compared with the other issues at the time of sale, and how the ranking was.

### (Significance of Calculation Table of Valuation Indicators)

When the calculation table of the valuation indicators is created, the management becomes easy, the list can be displayed, the instruction in the information processing system becomes clear, and the definition is also clear. valuation indicators included in this valuation indicators are limited to valuation indicators that satisfy the following conditions. Valuation indicators that is valuation indicators that affects the investment profit or loss of the target and that is a management item from the first step to the fourth step or is an item of a separate table associated with the sales data is valuation indicators that can be managed in the calculation table.

(Issues with Conventional Technology)

In Embodiment 1, which is the prior art, the formula is displayed, but there is no concept of this calculation table. By creating a table, it is possible to centrally manage and increase the valuation indicators, and it is easy to manage, and the instruction in the information processing system becomes clear, and there is an advantage that it is easy to automate.

### (Operation of Calculation Table of Valuation Indicators)

Although illustrated in FIG. 111 of the valuation indicators, for example, the valuation indicators of the sum trading profit/loss is valuation indicators calculated from the trading profit and loss level trading data, and the trading profit/loss ratio is calculated as a total value of the trading data, and the trading profit/loss ratio is calculated from the trading profit and loss level trading data in the same manner, but is not a total value but is calculated from the individual trading data, and the formula is also shown, and the trading profit/loss ratio average is calculated from the trading profit/loss and the purchase money amount, and the trading profit/loss ratio average is calculated from the trading data individually. This fiscal year's sales forecast is based on the business forecast table, date, and brand code, and is incorporated into sales data to capture changes in sales forecasts after the purchase date. By creating such a calculation table of valuation indicators, it is possible to determine a calculation method of various valuation indicators, and it is possible to perform unified management.

### (Effect of Calculation Table of Valuation Indicators)

If the valuation indicators is determined by accurately defining the calculation method of the valuation indicators, it is always calculated by the same calculation method. Conversely, since the calculation method is determined here, the valuation indicators can be calculated from the sales data of any complicated extraction condition. By determining the calculation method in the information processing system, the definition of the valuation indicators is also clearly defined, and the effect of the calculation of the valuation indicators on the profit and loss is also clarified. For example, a continuous increase in the forecast value will have a positive effect on the profit and loss, while a series of downward adjustments will have a negative effect. Of course, it is not possible to say in general, but it is also difficult for stocks, but it is good for table management to be able to gradually increase the components affecting investment profit and loss.

### (Specific Example of Calculation Table of Evaluation Indicator)

An example is shown in FIG. 111, but the present invention is not limited thereto.

### (Significance of Calculation of Valuation Indicators for Selling Data Subject to Tabulation by Investment Target)

The trading data to be counted for each investment object is the trading data created by the information processing system in the second step, and the creation of the profit and loss level trading data in the information processing system from the trading data (irrespective of the order) and the calculation of the valuation indicators from the trading data are defined as the calculation of the valuation indicators of the trading data to be counted for each investment object.

### (Technical Issues)

For example, S1 and S2 stock prices are being traded, and the investors they currently hold do not know how many shares they are buying at the average price, how much the average is buying and buying, and what the buyers and sellers have done. This is valuation indicators based on the idea of converting trading data managed for each investor into trading data managed for each investment target, the idea of further converting the trading data into profit and loss level trading data, and the process of calculating valuation indicators that affects the trading profit/loss calculated from the trading data set by the information processing system. In order to calculate the valuation indicators, the information processing system that is linked to the information processing system can be used for the first time, and when a trouble occurs somewhere, a number far from the target valuation indicators comes out. To solve the problems that investors really need, it is the calculation of the valuation indicators of the trading data to be tabulated by investment target.

### (Effects of Calculation of Valuation Indicators for Trading Data Subject to Tabulation by Investment Target)

As described above, the information processing system can create a trading data set ready to calculate an important valuation indicators only after the steps of the second to fourth steps. When the execution process is described, the target is determined by setting the sales data to “extraction condition: brand code=9984”, the profit/loss level sales data is created based on the sales data, and the valuation indicators is calculated from the sales data. The target object is determined, the target profit/loss is determined, and the valuation indicators is determined, so that the valuation indicators of the investment object is determined. Another characteristic of the index is that, since not only transaction data but also market data, corporate performance data, etc. and transaction data are linked, the effects of linking the purchase data of S Company shares with corporate performance and charts are remarkable. The trading data set is the trading data set created to capture the trading trends of the previous SoftBank shares, and is the trading data set created through the process of the information processing system in particular in order to raise the trading profit or loss in the SoftBank shares. As the valuation indicators calculated by the information processing system from there, it is possible to generate a large number of valuation indicators according to this purpose by the information processing system.

In the trading data for each investment object, “extraction condition: investment object=A brand”, the extracted trading data for each investment object is created by the information processing system including the total profit and loss level trading data, the second level trading data, the third level trading data, and the fourth level trading data. Further, with respect to each piece of trading data, necessary valuation indicators such as a win/loss rate, a profit/loss rate, an elapsed number of days, a number of turnover days, an unrealized profit/loss rate, an overall profit/loss rate, and the like are calculated and stored in the information processing system at various profit and loss level trading data. When this is executed in cooperation with a computer, today's numbers appear in a moment, and different numbers come out tomorrow, and if you buy or sell, it will be corrected and it will change complicatedly. It is a technique in which the cooperation of this database can be made, and the meaning is big. It is a technology with a much wider possibility. Technological advances have been made in particular in that instructions are issued in a consistent rule from the acquisition of trading data to the calculation of valuation indicators, the instructions are executed, various valuation indicators that are factors that drive the target profit and loss can be calculated, and the consistency in which actual operations (display of valuation indicators, display of advice, etc.) are performed using the calculated valuation indicators is maintained. Due to this consistency, it is possible to have more management items in the sales data, and the calculation of the valuation indicators has a large technical meaning that various kinds of information in a form linked to the sales data can be used. For example, it is a typical example (see FIG. 105 and the like) that the sales data of other brands purchased at the same time associated with the purchase date and the brand code are associated with each other, and thus it has never been possible to realize this. This is a technological innovation that dramatically improves the ability of investors to advise, diagnosis, and understand investment targets.

### (Effect of Calculation of Valuation Indicators for Selling Data Subject to Tabulation by Investment Target)

This effect is enormous, and it is an invention with sufficient social impact. There is an impact that it becomes clear how investors win and lose not only S1 issues but also stocks, and how much profit is generated by the owner and trader (the investor who buys and sells frequently), how much profit is generated by the ownership, how the stock is sold and sold, and how the loser is lost.

In addition, linking charts, technical indicators, corporate performance information, and transaction data of investment targets is significant, and it is a technology that generates various technological innovations. The realization of this technology is generated by the cooperation of databases called the cooperation by the information processing system, which is the division of roles. For example, FIG. 103 to FIG. 106 are meaningful contents generated by this innovation. In the first embodiment, the calculation of the valuation indicators related to the sales data is mainly performed, but in the fourth embodiment of the information processing system, more items can be provided in the sales data, and for example, the technical index value, the corporate performance, the investor's behavior other than the stock, the actual condition of the purchase of the other stock on the same day, and the like can be cited only by the information associated with the purchase date and the stock code. This is information that cannot be managed without the database cooperation technology, and can only be realized in the fourth embodiment. The linkage between such information and trading data has an unknown effect, as it is possible to understand how other investors are taking actions depending on the trends in corporate performance and technical index values after purchasing, and how they will change in the case of other stocks. In addition, it is possible to change the advice and change the diagnosis, and it is possible to refer to the sale and holding status of the same stocks of other investors and people on the same purchase date. Even with advice to the same investor, the most evolving cause of Embodiment 4 is this database collaboration that is not comparable to Embodiment 1. In addition, the implications of this deepening of the investment portfolio and the implications associated with actual investment behavior that is not known in technical indicators or corporate performance are very large.

### (Specific Examples of Calculation of Valuation Indicators for Target Trading Data by Investment Target)

In addition to the examples set forth above, numerous other examples are set forth in this specification.

### (Definition of Calculation of Valuation Indicators by Component Trading Data of Trading Data Subject to Tabulation by Investment Target)

The method further includes a step of extracting, classifying, and aggregating items (components) managed by the aggregation target trading data for each investment target according to the calculation based on the above-described aggregation target trading data for each investment target, and a step of calculating the items (components) by the information processing system.

(Issues with Conventional Technology)

It is not possible to calculate the valuation indicators of the trading data to be aggregated by the above-mentioned investment target. For example, the ranking of the investment performance of S1 shares by investor, the ranking of the investment performance of each stock, and the investment performance of S2 shares are compared with those of S1 shares, and other items (components) that are further controlled. If the method does not include the process of extracting, classifying, and aggregating the items in the information processing system, the necessary valuation indicators cannot be calculated. In some cases, the same purpose can be achieved even if the extraction conditions are increased in the process of creating trading data to be compiled. For example, if S1 shares and A investors are selected, the trading data for Mr. A's S1 shares is used, but if this process is interposed, the trading data for Mr. A's shares is compared side by side with the trading data for Mr. B's and the trading data for Mr. B's shares, and the data set is easy to process when ranking. Further, by increasing the number of management items, various types of valuation indicators can be calculated.

### (Effect of Calculation of Valuation Indicators by Component Trading Data of Trading Data Subject to Tabulation by Investment Target)

Various valuation indicators are calculated by the information processing system for the trading data set created through the step of creating the trading data to be counted for each investment target, the step of creating the component trading data, and the step of creating the profit and loss level trading data.

### (Effect of Calculation of Valuation Indicators by Component Sales Data of Trading Data Subject to Tabulation by Investment Target)

Beyond the calculation of the valuation indicators for the trading data to be compiled by investment target, the investment behavior for the investment target from various perspectives is as follows. There is an effect that can be revealed. In addition to S1 stocks mentioned above, it is also possible to compare, rank, and give various impacts to stocks, virtual currencies, FX, and individual investment behaviors in terms of win rates, investment profitability, and the like.

### (Specific Examples of Calculation of Valuation Indicators by Component Sales Data of Trading Data Subject to Tabulation by Investment Target)

This also cites a number of examples in the specification.

### (Example 1 (Repeated)

In the case of the trading data for each investment target, it is possible to determine whether there are more participants or less participants than other investment targets at the time of purchase, how much is the ratio to the trading price, whether the investment target differs from the trading trend of the other investment target in terms of winning rate, average holding period, and winning profit rate, etc. at the time of holding, and, eventually, how the rate of rise and fall during the holding period of the issue was compared with the other issues at the time of sale, and how the ranking was.

### (Definition of Calculation of Valuation Indicators by Component (Investor) Trading Data of Trading Data Subject to Tabulation by Investment Target)

For example, information on stock prices, such as charts and technical indicators, is available in infinite numbers, but actual investment behavior is covered by veils. Behind the rise in the chart is the investor's behavior. In order to grasp the investor's investment behavior, a process of extracting, classifying, and tabulating the information processing system based on the investor managed by the information processing system in the trading data for each investor is defined as the calculation of the valuation indicators based on the trading data for each investor in the trading data for each investor.

(Issues with Conventional Technology)

In S1's stocks, we don't know how institutional investors, foreign investors, margin trading and cash trading are being traded and how they are now held. The significance of this kind of information coming into the world is great.

### (Effects of Calculation of Valuation Indicators Based on Trading Data of Components (Investors) of Trading Data Subject to Tabulation by Investment Target)

Based on the trading data to be aggregated for each investment object created in the second step, the trading data extracted, classified, and aggregated for each investor is further subjected to a step of creating the profit and loss level trading data, and various valuation indicators are calculated by the information processing system based on the created trading data.

### (Effects of Calculation of Valuation Indicators Based on Trading Data of Components (Investors) of Trading Data Subject to Tabulation by Investment Target)

The valuation indicators calculated in the process in the information processing system can be expected to have a special effect of clarifying the behavior of the investor with respect to the investment target. For example, speculative behaviors such as the speculative behavior of a speculative stock can lead to a situation in which it is not known who is buying or selling in what way. Investors' anxieties and feelings can be discouraged in the way that information that encourages buying and selling is distributed by methods such as Twitter and bulletin boards. People buying speculative stocks have a big impact on what they are doing, how many are winning and losing, and how they are doing, and how they change their investment behavior. It is an advantage of the present invention that the loss of society due to speculative action is also revealed.

### ((Specific Examples of Calculation of Valuation Indicators Based on Trading Data of Components (Investors) of Trading Data Subject to Tabulation by Investment Target))

Specific examples are also given in various places in the specification.

### (Definition of Calculation of Valuation Indicators by Component (Investment Target) of Trading Data Subject to Tabulation by Investment Target)

Information on investment products, such as stocks, FX, and virtual currencies, includes infinite numbers of information on price movements, such as charts and technical indicators, but actual investment behavior is covered by veil. Behind the rise in the chart is always the investor's behavior, which varies from stock to stock. It is very meaningful for those who have not made investments to know how each stock's investment behavior differs among several issues.

(Issues with Conventional Technology)

Among the issues, there are stocks that have too much dangerous speculative behavior, and stocks that have risen steadily over time and are less vulnerable. These appear in charts and price movements, but are very unknown to the public. That's because the figures and figures that go up look the same. This obscuration is a factor that keeps investments away, and it is a factor that cannot clarify the difference between gambling and investments.

### (Effects of Calculation of Valuation Indicators by Component (Investment Target) of Trading Data Subject to Tabulation by Investment Target)

According to the calculation of the valuation indicators based on the component (investment object) sales data of the calculation target sales data for each investment object, it is possible to clarify the investment behavior of each issue which has been surrounded by such veil so far. As described below, in the calculation process, it is possible to create the aggregation target trading data according to the upper concept of the investment target, extract, classify, and aggregate the aggregation target trading data according to the investment target of the lower concept of the investment target, create the profit and loss level trading data by the information processing system, and calculate the valuation indicators based on the created non-trading data or the like. The investment behavior of the target investment is revealed.

### (Effects of Calculation of Valuation Indicators by Component (Investment Target) of Trading Data Subject to Tabulation by Investment Target)

This has the effect of clarifying the investment behavior of each issue (lower concept) of the company (upper concept).

### (Specific Examples of Calculation of Valuation Indicators by Component (Investment Target) of Trading Data Subject to Tabulation by Investment Target)

When stock-by-stock investing behavior is revealed, people buying and selling T shares have shown that their profits have not risen despite the rise in the Nikkei average, or that the entire stock has fallen sharply, but in September they see whether the stock is all making profits.

### (Definition of Calculation of Valuation Indicators Based on Trading Data Subject to Aggregate by Investor)

The calculation of the valuation indicators based on the trading data subject to aggregate by investor is the problem of how to calculate the valuation indicators from the trading data of Mr. A. This is the simplest and easiest to use for diagnosing and advising on the trading data of Investor A, as described in detail in Embodiment 1. Investor A is a measure of how he or she has won, lost, and what's going on now. Many findings are obtained by calculating various evaluation axes and various valuation indicators as in the first embodiment.

(Issues with Conventional Technology)

However, in the first embodiment, many descriptions are divided into the calculation formula of the valuation indicators, what kind of diagnosis can be made by the valuation indicators that can be obtained there, and what kind of advice can be given. According to the cooperation of the database, a series of instructions such as an instruction of conditions such as extraction from acquisition of sales data, an instruction of a classification and a tabulation processing rule, and calculation of valuation indicators that affects profit and loss as a target are not clarified, and there is a technical problem that application is difficult to make. The information processing system is a technology that is overwhelmingly technically superior in terms of systematizing all of how to calculate and utilize valuation indicators automatically by giving instructions to the information processing system through such cooperation, and which can also be applied to solve many investment issues. There are a number of technical advantages over the first embodiment, but the two most important ones are mentioned here. As the first point mentioned earlier, in Embodiment 4, the components affecting investor's profit and loss through database collaboration include not only the trading data such as the winning rate, but also the evaluation of the trading timing, changes in corporate performance, that is, changes in fundamentals, behavior of the same brand of other investors, and trends of other brands on the same purchase date, etc., in the valuation indicators of the information processing system, so that these valuation indicators can be used to improve investment profit and loss.

### (Effects of Calculation of Valuation Indicators Based on Trading Data Subject to Aggregate by Investor)

The profit-and-loss level trading data of the fourth step is created based on the trading data (created in the second step) to be counted by investors extracted by “extraction condition: investor=Mr. A” in the trading data to be counted by investors. In the profit and loss level trading data, the first level (total profit/loss) trading data, the second level trading data, the third level trading data, and the fourth level trading data are respectively created by the information processing system. Further, with respect to each piece of trading data, necessary valuation indicators such as a win-loss, a profit-loss rate, an elapsed number of days, a number of turnover days, an unrealized profit-loss rate, and an overall profit-loss rate are calculated and stored by the information processing system according to various profit-loss level trading data. Computer collaboration and execution will result in today's numbers emerging in a short time, different numbers coming tomorrow, and, if you buy or sell, will result in a complicated change. Updating them every day, while changing situations, is a technique that enables the collaboration of this database, and its meaning is large. This is a technique that has a much wider possibility than a technique such as the one described in the first embodiment, in which a simple calculation formula is used. Technological advances have been made in particular in that, for example, instructions are issued in a consistent rule from the acquisition of sales data to the calculation of valuation indicators, the instructions are executed, various valuation indicators that are factors that drive the target profit and loss can be calculated, and the consistency in which actual operations (display of valuation indicators, display of advice, etc.) are performed using the calculated valuation indicators is maintained. Due to this consistency, it is possible to have more management items in the sales data, and the calculation of the valuation indicators has a large technical meaning that various kinds of information in a form linked to the sales data can be used. For example, it is a typical example that trading data of an investor who has purchased the same brand at the same time associated with the purchase date and the brand code is associated with each other (see FIG. 105 and the like), and it is not possible to realize this in the first embodiment. This is a technological innovation that dramatically improves the ability of investors to provide advice and diagnostics.

### (Effect of Calculation of Valuation Indicators Based on Trading Data Subject to Aggregate by Investor)

In the first embodiment, the calculation of the valuation indicators related to the trading data is mainly performed, but in the fourth embodiment of the information processing system, the trading data can have more items, and for example, the technical index value, the corporate performance, the same brand of another investor, the purchase of the same day, and the like can be cited only by the information associated with the purchase date and the brand code. This is information that cannot be managed without the database cooperation technology, and can only be realized in the fourth embodiment. The linkage between such information and buying and selling data has an unknown effect, as it is possible to change the advice or change the diagnosis depending on the trend of the company's performance after the purchase, the trend of the technical index value, the behavior of the same issues of other investors, the trend of other stocks on the same purchase date, and so on, and it is possible to refer to the sale and holding status of the same stocks of other investors and people on the same purchase date. Even if advice is given to the same investor, in the fourth embodiment, the most advanced cause that is not comparable to the first embodiment is database cooperation by the information processing system.

### (Specific Examples of Calculation of Valuation Indicators Based on Trading Data Subject to Aggregate by Investor)

In addition to the specific examples described above, it is possible to instruct the information processing system to watch the brand after the sale and notify the information processing system that a certain technical index value is to be reached, or to store in the storage unit 33 every time the profit is determined, such as how much the profit/loss ratio was among those who purchased the same brand on the same day when their actual sale is determined and the profit is determined, so that it is possible to issue a total generator, and advice and diagnosis that are not conceivable in the first embodiment become possible.

### (Example 1 (Repeated)

In the case of trading data by investor, information such as how many shares were purchased for other investment targets and whether the participants in the investment target were compared with other investment targets can also be grasped in the information processing system, and in the case of holding the information processing system, the number of persons who gradually sell other investment targets is increasing and the proportion of those who hold the data is decreasing. However, the information processing system can also confirm that the investment target has a high yield and that the group of those who buy and sell the products to the superior has purchased the issues at the same time. At the time of the sale, it is possible to confirm when the stock's profit is determined, whether it was earlier or later than the other investment targets, whether the profit rate is higher than the average, and the highest person can confirm when and when the investment targets were sold, and after the sale, it is possible to confirm how much the stock's performance was compared to the other issues.

### (Definition of Calculation of Valuation Indicators by Component (Investment Target) of Trading Data Subject to Aggregate by Investor)

The component (investment object) trading data of the trading data by investor means trading data of the issue traded by investor A, and the valuation indicators is calculated for each brand.

(Issues with Conventional Technology)

Even if you untie an account in the securities company of investor A, it's hard to understand which stocks have won and which stocks have lost. What you can see is that you can view the status of the issues you hold (portfolio browsing). The trading situation is particularly difficult to understand and understandable. For example, you can download CSV and manage it by yourself.

### (Effects of Calculation of Valuation Indicators by Component of Sales and Purchase Data by Investor (Investment Target)

This problem can be solved quickly by using the information processing system. The information processing system instructs the information processing system to create a sales data set without aggregating the components by classifying the extraction conditions into “Investor=A” by the transaction target transaction data by the investor, and calculates various valuation indicators by the information processing system for each transaction data of the transaction data set by instructing the information processing system to create the transaction profit/loss level transaction data, and then calculates various valuation indicators by the information processing system, and this is the transaction data of the issue that the investor A has traded, and the valuation indicators are calculated by the information processing system for each transaction.

### (Effects of Calculation of Valuation Indicators by Component of Sales and Purchase Data by Investor (Investment Target)

The valuation indicators is valuation indicators derived by cooperation in a database, and the valuation indicators alone can be used in various ways. By calculating the average for each issue using the information processing system, the amount of investment per issue, the amount of sale per issue, the amount of profit or loss per issue, and the average ROI are calculated by the information processing system, and a large number of key indicators are derived to understand the characteristics of the sale and purchase of investor A, how he or she is winning, and how he or she is losing. This invention is similar to the valuation indicators of the first embodiment, but the information processing system has greatly advanced technology in that the target valuation indicators can be calculated by explicitly instructing the information processing system to perform various extraction conditions, aggregate rules, and classification criteria in database cooperation.

### (Specific Examples of Calculation of Valuation Indicators by Component (Investment Target) of Trading Data Subject to Aggregate by Investor)

Here, the information processing system may display the calculated various valuation indicators as they are, proceed to the comparison step, proceed to the ranking step, use the ranking for comparison with other investors, use the ranking and ranking of the issue traded by the investor A, generate a diagnosis result report using the valuation indicators in the information processing system, or present advice based on the results.

### (Definition of Calculation of Valuation Indicators for Trading Data Subject to Excellent Investor Group Aggregation)

For example, we define the group of outstanding investors as the top 30 overall profit-and-loss ratio over the last year. The calculation of various valuation indicators of the group of excellent investors is defined as the calculation of the valuation indicators of the trading data subject to aggregate of the group of excellent investors.

(Issues with Conventional Technology)

In FX and elsewhere, there are copy trades for outstanding traders, but there are many stocks and options, and it is difficult to invest in stocks that have various types of investment. Copy trades themselves tend to compete for short-term results, and even if they do so in a short period of time, they are no longer available. However, there is a group of outstanding investors with outstanding performance, and the trading data should have many points to learn. It is not just a copy, but a profit that tells the best investors what to buy or sell, what to buy or sell, and so on.

### (Effect of Calculation of Valuation Indicators for Trading Data Subject to Excellent Investor Group Aggregation)

Create trading data for each investor identified in the information processing system by period for the last year. Create the first-level profit-and-loss level trading data and calculate the overall profit-and-loss ratio. If you set up a program to update it every day, you will find the top 30 group of investors in the overall profit/loss ranking that will be updated every day. By calculating various valuation indicators with the investor as the top 30 in the overall profit-and-loss ratio ranking, it is possible to calculate the valuation indicators of the trading data to be aggregated for the excellent investor group.

### (Effect of Calculation of Valuation Indicators for Trading Data Subject to Excellent Investor Group Aggregation)

The ability of a group of successful investors to be renewed every day makes sense not only for short-term success, but also for the buying and selling of a group of successful investors throughout the year. For example, on the charts shown in FIGS. 103 to 106, it is possible to display the top 10 issues handled by the excellent investor group during the holding period of the issue, the top 10 issues purchased on the purchase date, and the like. It is also possible to check the history of what the outstanding investor group has done, including the sale and purchase of the issue for other periods. By referring to these points, it is meaningful to see how to make improvements.

### (Specific Examples of Calculation of Valuation Indicators for Trading Data Subject to Excellent Investor Group Aggregation)

In addition to the top 30 total profit-loss ratio for the last year mentioned above, the top 20 total profit-loss ratio for the same investment type and the top 10 total profit-loss ratio for the last 1 year can be classified, and it is also possible for the information processing system to classify an excellent investor group according to various criteria. Instead of an investor who is temporarily ranked in the past, the information processing system may classify it as a high-ranking regular group that is always ranked high. If it is possible to classify the index, the calculation of the index can be done by following the same procedure, and the index can be used as a group of excellent investors valuation indicators, can be used for comparison, can be used for evaluation of the investor, can be used for diagnosis, advice, etc. Of course, it is also possible to provide articles such as “What is the key to the success of the top 10 outstanding scores in corona trouble?”

### (Significance of Calculation of Valuation Indicators for Trading Data Subject to Average Investor Group Aggregation)

Not only the best investors, but the average appearance of the entire investor is somewhat convenient.

(Issues with Conventional Technology)

The average appearance of the investor as a whole is not known. In the past year, investors traded, and the average was rising. But in reality, we don't know what the investment outcome was. Even this average figure is now black-boxed. In this way, we do not feel how to go in a better direction, and we are doing investments in the clouds, and some investors, such as bulletin boards and tweeters, are working on the behavior.

### (Effect of Calculation of Valuation Indicators for Sales Data Subject to Average Investor Group Aggregation)

In this information processing system, at a minimum, the total profit-loss ratio for each investor in the past year, the latest 1 month, the latest 3 years, and other necessary indicators are updated every day, so that the average value can be immediately calculated. What is important is to determine which valuation indicators (e.g., overall profit/loss ratio) will be updated on a daily basis for each investor (e.g., for the last year), and on what basis, and to make this routine, so that it will not be difficult for the relevant information processing system to produce an average value. The average of the investor groups is the same.

### (Effect of Calculation of Valuation Indicators for Sales Data Subject to Average Investor Group Aggregation)

Some investors are medium- to long-term investors and others are good at buying and selling short-term investors. Some investors know the average of the investors' overall portfolios, and others know the average of the investors' portfolios by type of investment. This makes it possible to compare the average with the average, the position of the investors themselves, the inferiority of the investors, and the superiority of the investors. Even if excellent investors appear in magazines and other media, the average appearance is not quite apparent. As a result, the benefits of the average picture are the basic picture, even if we diagnose where the average is superior or inferior to the average, and the overall picture of the investor, which has been a black box up to now, is an unknown benefit.

### (Specific Examples of Calculation of Valuation Indicators for Trading Data Subject to Average Investor Group Aggregation)

This includes the average of short-term trading types, the average of medium- to long-term investors, and the average of shareholder benefit investors.

### (Definition of Calculation Definition of Index by Aggregated Trading Data by Period)

There are four types of trading data to be compiled by period, and only the completed version can correctly capture the valuation indicators. The fact that the liver of the completed version is a re-evaluation is described in detail in the column for the preparation of the trading data to be compiled by period. It is meaningful to be able to grasp the valuation indicators for each period. In general, in the transition of a certain valuation amount, it is common to show the rate of increase or decrease of the valuation amount by visualizing the valuation amount by chart, or to show the valuation amount at a certain point in time as a detailed screen.

### (Prior Technical Problems)

As mentioned in the section on trading data by period, it is difficult to report the 2020 investment results without accurately capturing the dynamically changing trading data by continuing holding or buying or selling. Of course, the number for the total valuation is easy to capture, but it is very hard to understand because it is labyrinthine from there. For this reason, the period comparison of securities companies is also about the evolution of the valuation. However, as a precaution, there are cases where an approximate value is obtained by other methods (similar form 1, etc. (refer to trading data subject to aggregate by period)). This is the case when day traders, etc. buy and sell frequently. Day traders do not have to consider holding (only those traded during the period, so the approximate value is given). Therefore, the period-specific profit/loss is near even in the similar form 1. Although it is not accurate, there is no error enough to make a mistake in judgment, and it is okay. However, the macro number of general investments and various investors is far from the actual situation. Usually, an investment instrument is meaningless unless some have such frequent trading and others continue to hold it, and they are included in the trading data. However, when the information processing system captures the information by period, it is dramatically increased that it is known, and the number of valuation indicators is also the opening of cloud mud.

### (Effects of Calculation Effects of Index by Aggregated Trading Data by Period)

Taking the case where the transaction status of Mr. A in 2020 is grasped by the aggregate target trading data by period (completed version) as an example, an order for an evaluation change is issued to the information processing system, starting from the transaction data at time B, starting on Jan. 1, 2020 at time A and Dec. 31, 2020 at time B. The valuation indicators is calculated by setting the “extraction condition: investor=A” and issuing an instruction to create the trading data in the trading profit and loss level trading data, and issuing an instruction to calculate various valuation indicators from the trading data set to the information processing system. This is the simplest case of calculation of the valuation indicators based on the period-specific trading data, but the more the conditions are added, the more complicated the conditions are set, and the principle does not change. Thus, in 2020, Ms. A's average trade and loss rate and Ms. 2020, Ms. A has conducted various transactions, but in the end, Ms. A's results in 2020 were lost, earned, earned, and earned a return on the amount purchased (the amount of ROI) was averaged, bought and sold, how many days the average holdings were, and how the winning rate was averaged. On the other hand, the information processing system derived various metrics, such as the number of times the technical indicators decided to buy and sell when the value was set. If we limit the period to 2020, even these simple numbers will not really come out. Even if it appears, it is based on other methods (such as Similar Form 1) in the trading data for each period. This is okay because if you buy or sell frequently, such as day traders, you don't have to take into account your holdings (because you only buy or sell them during the period, so you get an approximate value). Therefore, the profit or loss by period will be nearer, so it's okay. However, the more general investments and macro numbers that have various investors, the farther away from the actual situation. However, when the information processing system captures the information by the period, it is dramatically increased that it is known, and the number of valuation indicators is also the opening of cloud mud.

### (Effects of Calculation Effects of Index by Aggregated Trading Data by Period)

It is possible to calculate an index which is not comparable to the one which can only show the valuation transition of the example of the securities company in time series, and by this, the valuation, advice, diagnosis, etc. to the investor are also dramatically improved. Everything is the result of the technological innovation which started from the re-evaluation of the trading data (full edition) to be tabulated by period. In the case of the pseudo form 1, if the purchase date is Jan. 1, 2020 or later and the sale date is Dec. 31, 2020, a pseudo value may be generated. If the trader's valuation is sufficient, this may also be a case. In practice, however, it is not a number that represents an accurate period profit or loss. Simply speaking, the company purchased it in December 2020 and held it until January 2021, but the stock has tripled. Such a case would leak at all. Because many of these leaks occur, the use of these leaks cannot be properly evaluated. Individual investors may be sufficient to see the result of their traders, but in the world of various investors it is a very unusual view. On the other hand, after the correct evaluation is changed with the period-based tabulation target trading data (complete version) by the information processing system, all the calculated valuation indicators are accurately numbered through subsequent processes such as the profit and loss level trading data, and the correct period investment profit/loss and the correct valuation indicators can be calculated by the information processing system. This is very important to affect the evaluation, ranking, comparison, diagnosis, advice, and so on, which are the subsequent steps. The wrong numbers can be wrong no matter how far they are, and the evaluation can be wrong, and the advice can be wrong. For example, in the previous example, this process is very important because it results in the holding of a three-fold stock that is not valued at all and that the time period is considerably worse than the average.

### (Specific Examples of Aggregate of Valuation Indicators Based on Trading Data Subject to Calculate by Period)

In this specification, many concrete examples of the valuation indicators based on the trading data for each period are given. However, the information processing system can immediately prepare article data such as “This is the top 10 issues with the trading profit/loss ratio in August!” and “Which was the result of the investment in 2020? Day traders versus medium- and long-term investors.” There are many other ways of thinking.

There are three methods (e.g., profit/loss level sales data) for calculating the valuation indicators, but there may be a step of determining which valuation indicators is important and which valuation indicators is less important among the valuation indicators calculated by the information processing system from this step. However, it is not essential. This is because, up to the fourth step, the trading data is fairly narrowed down, so that not a large number of valuation indicators can be obtained, and the importance can be easily judged to some extent.

### (Definition of Valuation Indicators Selection and Judgment Process)

Several valuation indicators are calculated by the information processing system using only the overall profit/loss level valuation indicators. These are valuation indicators calculated by the information processing system from trading data (trading data in a narrow sense=trading data), but for example, rights data, corporate performance data, investment type data, technical index values, etc., which are trading data in a wide sense, are also included in the trading data created up to the fourth step as necessary, and are calculated by the information processing system from these. For example, valuation indicators such as valuation indicators calculated from corporate performance data, valuation indicators calculated from rights data linked to issues, purchase dates, and the like from divided rights data, and the like can also be calculated. However, this process involves the step of selecting which metrics are important and which are useful for improving the target profit or loss. Rather than just expanding the index, it is the process that has already been narrowed down to the index needed to improve profit and loss (from the second to fifth steps), and then decides on the more important index.

### (Problems in the Valuation Indicators Selection and Judgment Process)

In the first embodiment, many examples are shown regarding calculation of valuation indicators and valuation indicators used in advice, diagnosis, and the like. It is easier to use and understand if you answered that which valuation indicators is important from a number of valuation indicators, for Mr. A, this valuation indicators for Mr. B, and this valuation indicators for Mr. A are the most important valuation indicators that have a large impact on profit and loss. In the fourth embodiment, it is reported that the profit/loss level valuation indicators is calculated by the information processing system by three methods. In the same way, the process of selecting and judging the valuation indicators is explained here again, since there were some expressions that were not easy to understand.

### (Operation of Evaluation Indicator Selection and Judgment Process)

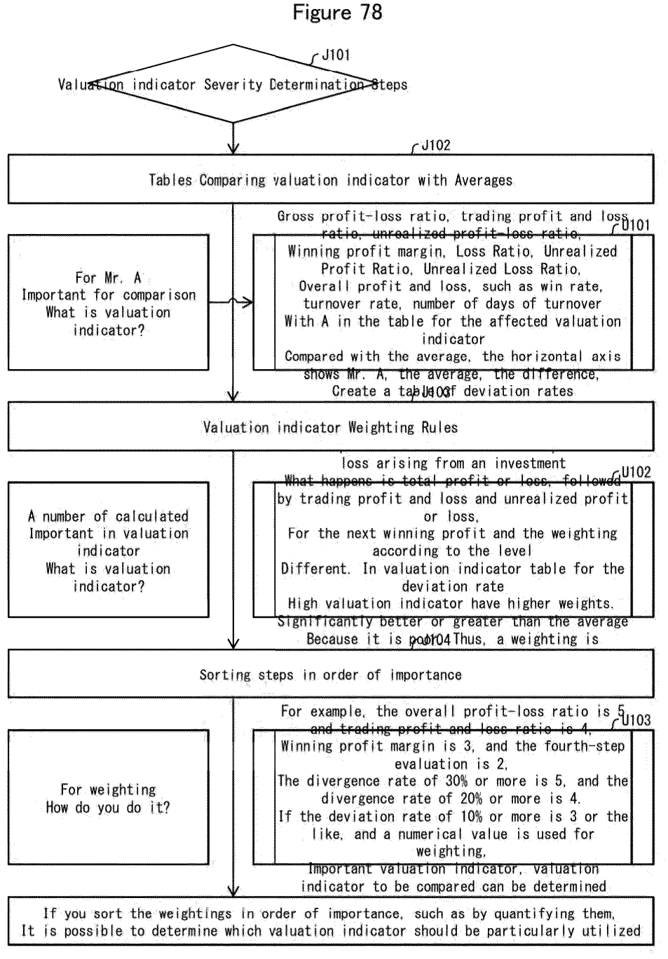

The process of determining the selection of the valuation indicators will be described with reference to FIG. 78. Regarding the valuation indicators importance determination step (J101), first, the information processing system instructs to create a V3 of a comparison table with an average of valuation indicators in order to know what valuation indicators are important to compare for Mr. A (J102). By creating a comparative table of valuation indicators including a deviation rate from the average, valuation indicators that deviates from the average is identified (U101). Then, the weighting of the valuation indicators is changed by the weighting rules (J103) of the valuation indicators in order to know what the important valuation indicators are in the several calculated valuation indicators. valuation indicators with a high divergence rate in U101 change the weighting of the average and the profit/loss level by, for example, increasing the weighting of the valuation indicators, and increasing the weighting of the profit/loss level higher than the profit/loss level (U102). Specifically, a table such as a V2 is referred to by the information processing system, and weighting is executed by increasing the scores of the respective valuation indicators or the like (U102). Determine the ranking of which metrics are of particular importance, such as by quantifying the outcome of the weighting performed and sorting in order of importance (J104), (U103), etc.

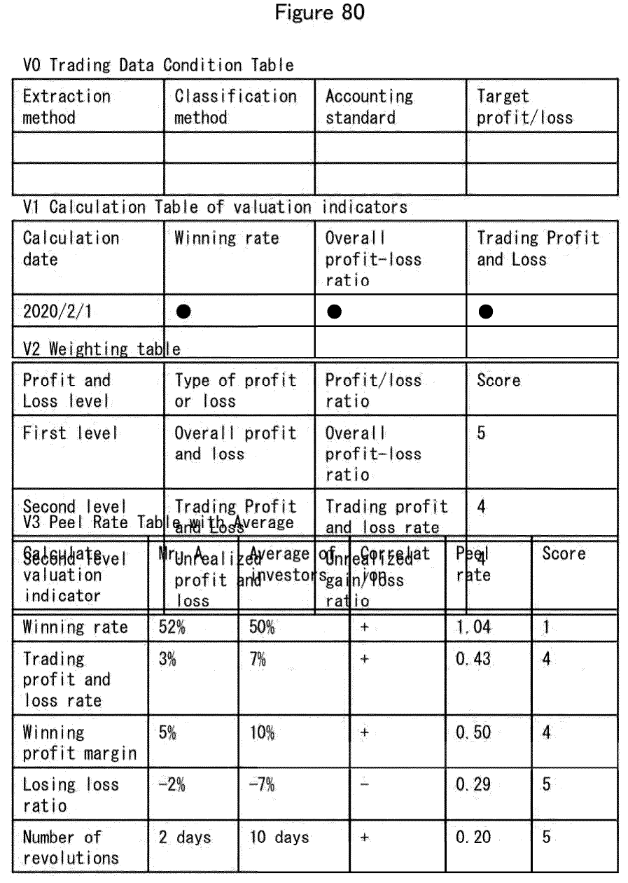

In the valuation indicators calculation table (V1) of FIG. 80, target trading data (extraction conditions and the like) is determined up to the fourth step, and the target profit/loss is determined, so that the valuation indicators that can be calculated by the information processing system is determined.

(V1-1) Among the many valuation indicators in the valuation indicators calculation table of Vi in the deviation rate weighting table (V3) between the profit/loss-level weighting table (V2) and the mean value, which valuation indicators is the most important valuation indicators (KPI) is determined.

In V2, the first-level total profit and loss includes both the trading data and the trading data that have not yet been traded, which is a very comprehensive indicator, and the weighting is set to be the highest (5 in the table example). At the second level, the trading profit/loss level is the data to confirm the trading data. At the unrealized profit/loss level, the data is still held for trading. Therefore, the score is one step lower than the total profit/loss level. However, because Unrealized profit and loss are data currently held and Trading profit and loss are past trading, there are cases in which it is better to increase the weight currently held. The example of the score is merely an example, and is determined by trial and error.

V2 differs between the case of Investor A and the case of Investment Issue A, so we will explain it separately. In the case of Investor A, there are various comparisons, such as the average of the entire investor and the average of Investment Type A, but this is explained by using the comparison with the entire investor, which is the basis. valuation indicators of Investor A compares the valuation indicators with the valuation indicators of the average, and Mr. A indicates how far the measure deviates from the average. However, it should be noted that because of the improvement in profit and loss, there are valuation indicators that has a positive effect on profit and loss and valuation indicators that has a negative effect on profit and loss. In the former, the higher the divergence rate, the higher the result of Mr. A, and the higher the negative divergence rate, the higher the result of Mr. A. It is necessary to adjust the score accordingly. It is expressed as plus and minus in the correlation index item.

In the case of an investment target, valuation indicators (e.g., Trading profit and loss ratio) calculated by the information processing system from the transaction data is also important, but valuation indicators calculated by the information processing system from the market data is also increased in importance. This is because there are many data that greatly affect the profit and loss of the investment target. For example, if a company's earnings exceed its forecasts, it may be expected that the unrealized profit ratio of the holder will increase and the overall profit/loss will increase. In this situation, the valuation indicators of Issue A should include this index, and it should be shown that this index is of importance as a KPI. Such a viewpoint is particularly important in the trading data created by the trading data by investment target.

For example, when compiling Aggregated trading data by investment target of the Issue A, if it is captured in the upward correction table as described above, the upward correction date, the upward correction rate, and the like are associated with the brand, and are also associated with the Issue A. If there was an upward revision yesterday, the date and the upward revision rate become one of the data items of the trading data to be aggregated for each investment target of the issue A. From there, the items also exist in the profit and loss level trading data calculated by the information processing system, and the upward revision rate of the issue A can be used as the valuation indicators even when the calculation is performed by the information processing system of the valuation indicators, and the flow can be made to the valuation indicators calculation table. If the upward revision rate is high, the importance for the stock becomes very high, and if the weighting is also large, KPI of the stock A is the most important upward revision rate, the second is the unrealized profit rate, and the third is the technical indicator RSI.

The items to be managed in the first step of the buying and selling data acquisition step, the second step of creating the buying and selling data to be aggregated, and the like can all be included in the calculation step by the information processing system of the valuation indicators. Scores for upgraded stocks are set to be higher as the date is nearest, and higher as the upgrading rate is higher, in the weighting table of V5 other metrics.

With this weighting, the results of the diagnosis, which is the subsequent process, can be expressed as follows: “The upward revision rate announced after the purchase date was very high, so the unrealized profit rate is now as high as 30%, and the overall investment profit/loss is being raised.” It is because everything is linked, that it is a diagnosis that can be made and that it becomes advice. If KPI, it is possible to further emphasize and communicate.

Of course, there are positive correlations and negative correlations that were also V3, and there are cases where it is better to compare with the averages, or issues that were announced and stocks that were not announced, such as the upward revision. Here, the trading data created from the trading data to be aggregated for each investment target and each investor is described, but the same can be applied to the trading data to be aggregated for each period, other trading data to be aggregated, component trading data, and the like. In the case of trading data subject to aggregate by period, a little supplement shall be provided. The 2020 index and average are compared to the 10-year average for the entire investor, and the 2020 index is used in the evaluation process to determine which index was more important.

### (Effect of Evaluation Indicator Selection and Judgment Process)

In many ways, it is not known which metrics to look at, even if multiple metrics are available. For example, human dogs may have a variety of values. However, the importance of careful attention to these values is indicated. Doctors also inform them that they should be careful not to eat food for the first time.

In the first embodiment, the importance is conveyed by referring to a table on a text basis, but this is sufficient if the pattern is limited. However, as the number of cases increases, it is required to be able to cope with various patterns. After the process, it is advantageous to digitize and centrally manage which of the several valuation indicators calculated by the information processing system is important.

In particular, when management is performed using a set of several valuation indicators and dates, the convenience is further increased, for example, when management is performed using a table of 5 valuation indicators with an importance level of up to 5 for each date and investor, the valuation indicators are stored in the storage unit 33. It can be used instantly to measure KPI of Mr. Z, who has been selling and selling in the same way, by matching several sets of metrics at similar levels.

Such data is recorded as learned data. The more data there is, the more accurate KPI is, the more it is expected to be. These are changes over time, and Mr. A's KPI also changes. The accumulation of historical data shows how KPI and the current KPI have changed six months ago, and that the first-level KPI of Mr. A's KPI may change from the trading profit rate to the unrealized profit rate. Therefore, we can expect a particular benefit that makes it easier to capture the changes. Of course, if the information processing system determines that it is important for the investor A, the information processing system may display the change in the investment result in the skin by, for example, displaying the transition by charting them on a dashboard at all times, or it is very effective.

### (Specific Examples of Evaluation Indicator Selection and Judgment Process)

### Example 1

This is a specific example of trading data to be aggregated by investor. For example, Mr. A's KPI changes in 2020 and 2019 are examples.

### Specific Example 2

This is a specific example of trading data to be aggregated for each investment target. For example, what are the key technical indicators that are strongly related to profit and loss in the A-brand technical indicator?

### Example 3

This is a specific example of trading data to be aggregated by period. For example, what is the change in KPI in the first and second half of 2020?

### Example 4

In the first and second half of 2020, the profitability criteria can be used as story data, as if they had changed.

### Example 5

In addition to the previous upward revisions, there are stocks and investors whose technical indicators are KPI. For example, it can be expected that stock A is compatible with the technical index value Stochastic, and that the purchase data purchased when Stochastic exceeds 20% in the upward direction wins with a very high probability.

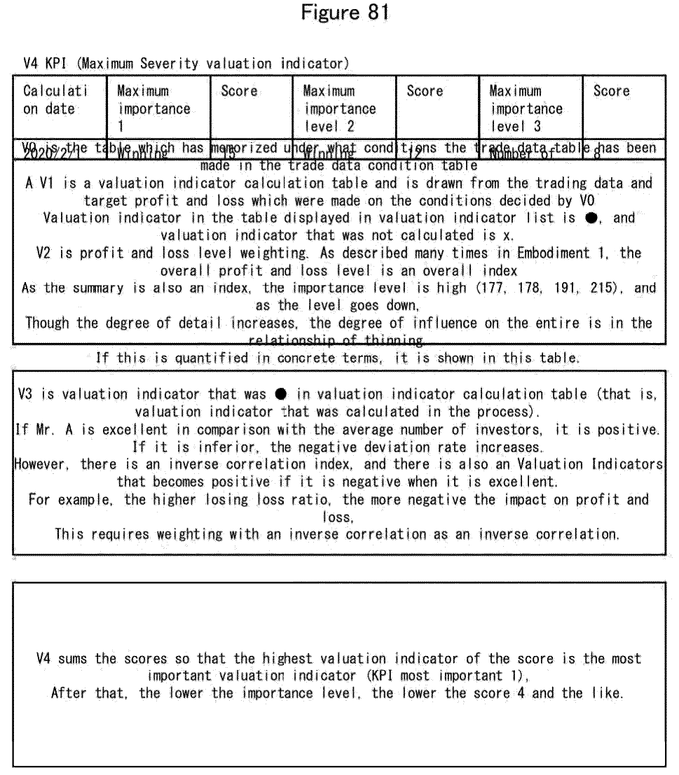

### (Explanation of FIGS. 80 and 81)

In FIG. 80 and FIG. 81, V0 is a table that stores the conditions under which the trading data table has been created in the trading data condition table.

V1 is valuation indicators calculation table, which is a table displaying a list of valuation indicators derived from the sales data and the target profit and loss created on the basis of V0. The valuation indicators calculated by the information processing system is •, and the valuation indicators not calculated by the information processing system is ×.

V2 is a profit-level weighting. As communicated many times in the first embodiment, since the overall profit/loss level is an index that is combined with the total index (sales profit/loss+unrealized profit/loss), the importance level is high (177, 178, 191, 215). As the level goes down, the degree of detail increases, but the degree of influence on the whole decreases. If this is quantified in concrete terms, it is shown in this table. Although it is an obvious theory, it is clarified by quantification.

V3 compares the valuation indicators • in the valuation indicators calculation table (that is, the valuation indicators calculated by the information processing system in the process concerned) with the average of A and investors. If A is excellent, the positive and negative deviations will be larger if A is inferior. However, there is an inverse correlation index, and there is also valuation indicators that becomes positive if it is negative when it is excellent. For example, the higher the loss rate or the like, the more negative the profit or loss is, and this is an index that has a negative influence, and it is necessary to weighting by an inverse correlation as an inverse correlation.

In V4, the importance index becomes lower as the importance index becomes lower, with the highest valuation indicators of the importance index being the highest valuation indicators (KPI highest importance rank 1). In the first embodiment as well, the valuation indicators is important, and in particular, the importance is changed by a human, depending on the time. By storing these tables in the storage unit 33, the change in KPI of Mr. A and the numbers of other valuation indicators are also stored, and it is possible to immediately output whether or not the improvement is attempted from KPI of one year ago.

### (Specific Example 1 of the Valuation Indicators Selection and Judgment Process)

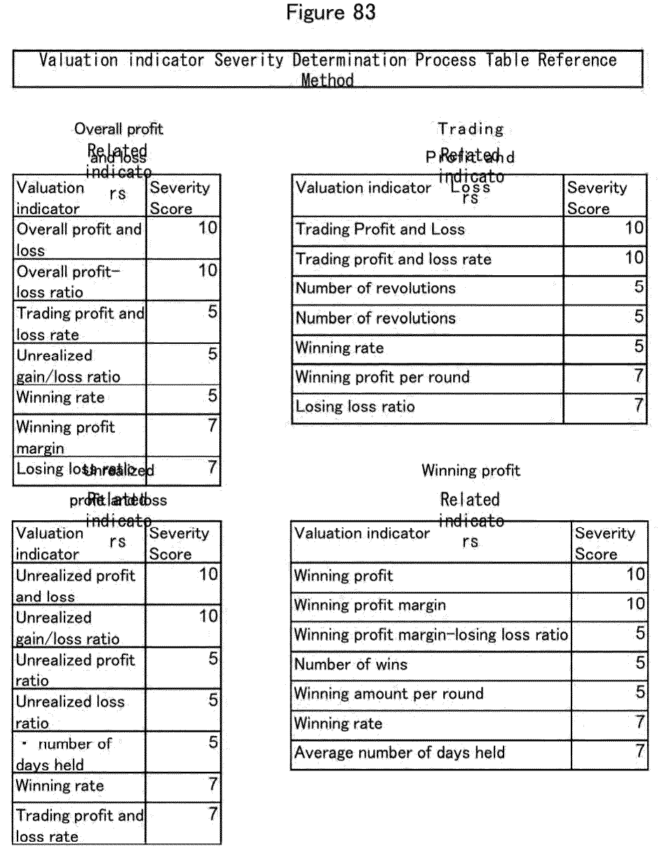

In addition to the above scoring methods, various methods can be used. For example, if the importance score table of the profit/loss and the related valuation indicators is created, if the target profit/loss is determined, the important valuation indicators is immediately determined. The accuracy is increased by adding and innovating the importance score table at any time (see FIG. 83).

The display method is similar to the display steps of the respective steps (see the respective display steps such as radar charts for comparison on average).

### (Definition of Presentation Method of Valuation Indicators)

Examples of the display method of the valuation indicators include figures, tables, numerical data, graphs, charts, and text. Displays such as comparison and ranking are also included in these display methods. In addition, the generated data can be used as article data.

### (Problems in the Method of Presenting Valuation Indicators)

It is difficult to understand what it means by simply displaying the numerical data of the valuation indicators. Reading data may require familiarity and may not understand the intent. In the case of article data, it is even more.

### (Effects of Presentation Methods of Valuation Indicators)

The information generation unit 3021 calculates various valuation indicators, and processing is necessary to display them in an easy-to-understand manner. For example, in the example of the creation of a graph, when valuation indicators derived from component sales data is used, a graph created with a component on the horizontal axis and valuation indicators calculated on the vertical axis can be easily understood at a glance, and compare and ranking can also be visually understood.

### (Effect of Presentation Method of Valuation Indicators)

By greatly changing the display method depending on the combination of the valuation indicators, the aggregate target, the target, and the like, there is an effect that the understanding is advanced at a glance for the user.

### (Specific Examples of Display Methods of Valuation Indicators)

For example, in the case of the valuation indicators calculated from the component sales data for each fiscal year based on the aggregation target sales data of Mr. A, the trading profit/loss in 2016, the trading profit/loss in 2017, and the trading profit/loss in 2018 are displayed in a graph by the information generation unit 3021. The transition is also easier to understand, and it is effective to improve understanding at a glance. For example, when the information generation unit 3021 calculates the valuation index for each investment target by calculating the valuation index for the period-by-period trading target trading data of 2020, and displays the trading profit/loss of the stock and FX trading profit/loss and the trading profit/loss of the virtual currency in 2020, the horizontal axis is used as the investment target, and the vertical axis is used as the trading profit/loss amount, so that it is clear at a glance which investment target was profitable in 2020. An effect that cannot be obtained simply by listing numbers can be demonstrated. For example, in the case of a valuation index calculated from component trading data for each investor based on trading data subject to the aggregate of A issues. A's bid and ask prices, trading profits and losses, B's bid and ask prices, trading profits and losses, C's bid and ask prices, and trading profits and losses are displayed on a chart. The transition is also easier to understand, and it is effective to improve understanding at a glance. For example, in the case of the valuation indicators calculated from the unrealized profit or loss of the trading data to be aggregated for the A issue, the purchase price and the unrealized profit or loss of the A issue are displayed on a chart. The present situation is also easy to understand, and it is effective to improve understanding at a glance. Of course, the above-mentioned valuation indicators of all investors can be distributed as news articles, and can be easily understood.

For example, in the case of component trading data by investment type of the trading data subject to aggregate in 2020, the case where the winning profit, which is a component of the trading profit or loss, is evaluated. When the horizontal axis is used as the bar graph and the vertical axis is used as the winning profit, the investor can see at a glance that the winning profit in 2020 is considerably blurred, and that there are people who earn money and people who do not earn money even if they buy the same stock. These stories are useful as news stories, and in 2020 the winning stocks are useful as story data.

### (Specific Examples of Display Methods of Valuation Indicators)

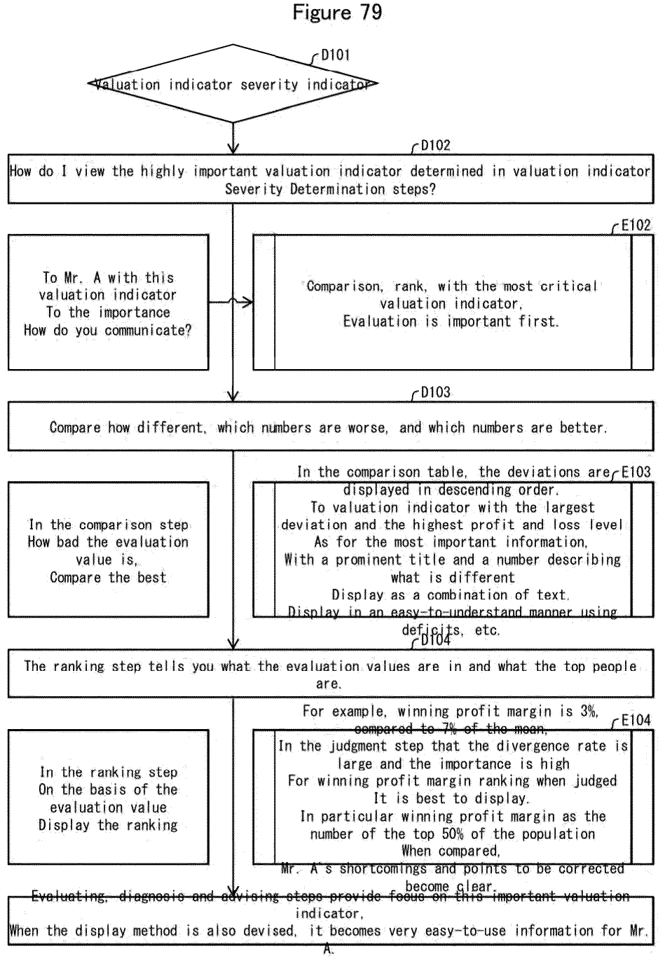

FIG. 79 illustrates a process of displaying the importance level of the valuation indicators. This step is a step of determining how to display the highly important valuation indicators determined in the previous importance determination step in D101. D102 is the question of how to use a high-importance index. It is displayed by comparing, ranking, and evaluating. D103 is a comparative step. In comparison with usage and averaging, a high-divergence index is highly likely to be buying and selling with characteristics different from those of others. Therefore, it is conspicuous. D104 is a ranking step. By clarifying the differences from others and ranking the bad points and the good points, it is possible to grasp the degree of bad and the degree of good. In addition, in evaluation steps, diagnosis steps, and advice steps as well, important valuation indicators can be used to highlight differences and characteristics from others, which can contribute to the improvement of future investment results.

### (Significance of Calculation and Display Step of Valuation Indicators)

For example, for the question of what the valuation indicators affects Mr. A's trading profit or loss is calculated, the trading level trading data of Mr. A is extracted and tabulated, and the winning ratio, the loss ratio, and the like are calculated together with the trading profit or loss. At this time, the winning ratio can be automatically calculated by the trading level trading data, but it is easier to obtain the winning profit ratio by creating the winning level trading data. Then, the necessary valuation indicators are calculated, but there is a problem with how to communicate these valuation indicators by Mr. A. Among investors, knowledge, experience, and know-how are diverse, and display terminals are also diverse. No matter how good a number, a good result, or a content to be improved, it is difficult to understand or understand. The display step is arranged to solve such a problem.

### (Problems of Calculation and Display Step of Valuation Indicators)

Which metrics affect the target profit or loss depends largely on the way in which the transaction is conducted. The relationship between profit and loss and metrics is complex and interrelated. The higher the winning rate, the lower the winning profit rate, the higher the inclusion loss rate, and various correlations. However, all of these metrics have a significant impact on the overall profit and loss of the target.

If the target profit or loss to be improved is determined and the target is determined, the necessary valuation indicators is determined. In this step, the necessary valuation indicators is calculated from the trading data obtained in the previous step and the profit and loss, and how the calculated valuation indicators is displayed to the user.

### (Operation of Calculation and Display Step of Evaluation Indicator)

Even in the calculation of the same valuation indicators, if the valuation indicators and the display corresponding to the problem are displayed, it is easy to understand, and the present state can be grasped, but if the display method is difficult to understand, the user is not told. In order to display in an easy-to-understand manner, it is necessary to display the meaning of the valuation indicators provided in accordance with the problem in question and the valuation indicators in question.

### (Effect of Calculation and Display Step of Evaluation Indicator)

In a simple list of valuation indicators, it is difficult for a user to understand, and it is difficult to determine how to change the valuation indicators. For example, for a single win rate, simply expressing a 60% win rate does not sound like anything, but for today's users, the KPI (most important evaluation indicator) is the win rate and the losing-loss rate, and the KPI is “Your current win rate is 60%, with a winning profit rate of 7% and a losing loss rate of 8%, and since the losing loss rate exceeds the winning profit rate, your assets are not increasing very much. Therefore, your assets are not increasing. Winning percentage is important, but why not look at holding the losing loss rate to 5%? Your profit will increase by 500,000 yen per year. If the wording is like “the user's situation,” the wording will match the user's situation, the improvement measures will be visible, and it will be clear how to take action. The expression method varies greatly. In this step, the essential information suitable for each user is output by using the most important valuation indicators obtained in the selection step, rather than the enumeration of data, which has a great effect on the investor. For investors, there is a dramatic change in investment behavior.

### (Specific Example of Calculation and Display Step of Valuation Indicators)

### Example 1

The chart display is excellent for displaying various valuation indicators of the trading data to be aggregated for each investment target. The chart display is also very easy to understand, including the technical index values of trading data and valuation indicators of performance data for individual investors.

### Specific Example 2

For example, in 2020, the winning ratio of trading by A issues and the share of trading profit of A stocks are the data for trading by component of each stock in the period-based trading data for 2020, and are the valuation indicators that can be derived only from trading profit and loss level trading data.

In 2020, it is necessary to properly derive from the database the question of what percentage of trading wins by A issues in the day trading Investment Type Group. Such data is highly news-sensitive and can be said to be one of the data that can be distributed as an article.

As shown in FIGS. 101 and 102, if various conditions are added in FIG. 101, a data set according to the purpose is created, the necessary valuation indicators is calculated, and the valuation indicators according to the purpose is calculated, so that various conditions and various forms of valuation indicators can be easily displayed in this step. This process is merely one step in FIG. 102, but since the valuation indicators has been determined by a series of collaborations, it is possible to display the valuation indicators in many forms described in this specification.

### (Definition of Valuation Indicators Calculation Chart Display Step)

Among the indices listed in the calculation of the valuation indicators, the chart display is particularly excellent for the valuation indicators corresponding to the purchase date, sale date, and holding period of the issue. As illustrated in FIGS. 103 to 106, the display can be performed at a glance in an easy-to-understand manner. It means that the charts that are familiar to the public are displayed together with their own situations, differences from others, and the situation of other stocks.

(Issues with Conventional Technology)

Chart representations are familiar to those interested in investment products in a highly familiar manner. However, the majority of cases are not personalized, and it is common for anyone to see the same chart in the same brand, and there are very few or no personalized chart displays tailored to an individual. In particular, there is no chart in which a determination material is shown as to whether or not the determination of the purchase is correct, or trends of other brands during the holding period or the same period are displayed in a list according to the trade (FIG. 103 to FIG. 106 are merely examples).

### (Operation of Calculation Chart Display Step of Valuation Indicators)

In this information processing system, it is possible to display a personalized chart for individual individuals. The purpose of the chart is to display on the chart various valuation indicators (for example, valuation indicators including at least one of changes in the technical index value after purchase, changes in the business performance after purchase, behavior of other investors after purchase, and trends of other brands after purchase) as well as the purchase date and purchase price of investor A. The purpose of the chart is to display on the chart valuation indicators that have an impact on investor's profit and loss, thereby contributing to various decisions.

### (Effect of Calculation Chart Display Step of Valuation Indicators)

By displaying a chart according to the situation of the individual and the situation of the brand, it is possible for investor A to display a chart according to his or her own situation, and to centrally manage the financial situation and rights situation of the investment product and the technical index that cannot be managed by himself/herself, and as one of the judgment materials, it is possible to see the judgment contents of the information processing system concerned, and it is expected to have a special effect that it is possible to see the trends of other investors that contribute to the investment judgment.

### (Specific Example of Calculation Chart Display Step of Valuation Indicators)

FIGS. 103 through 106 are examples of patterns that can be considered, including changes in corporate performance and changes in technical indicators. Here, for example, technical index values, corporate performance, and charts are displayed together wherever they are, but they are linked to purchasing data, so they capture changes after purchasing, as well as present examples of trading with similar technical index values in the past, and then provide information such as what trades were successful, whether they were successful, whether they were unsuccessful, and, for a better success, how they should have done, so that they can display personalized charts tailored to individual individuals. The definition of personalization is not only to display a different chart for an individual, but also to provide information tailored to the individual's buying and selling for the purpose of how to improve the individual's investment profit and loss. The definition of valuation indicators is limited to valuation indicators that have an impact on investment profit or loss. This is based on the assumption that information that does not conform to the purpose is classified into categories, and that the valuation indicators that conform to the valuation indicators and whether they affect investment profit or loss are displayed on a chart.

(Definition of Personalized Charts that Evolve in Steps)

A personalized chart for each investor is defined as a personalized chart. First, a large premise is a chart linked to the trading data, and for example, a case linked to the unrealized profit and loss level trading data of the second profit and loss level trading data is assumed. In other words, a chart is defined as a chart that is linked to a holding stock and displays valuation indicators that affects the investment profit or loss due to the relationship between the purchase date, the sale date, and the holding period. This is because if the purchase date and the purchase price are not determined, the investment profit/loss will not start, so it is assumed that the purchase date and the purchase price are displayed or managed. This is different from what is known as a comparison between the valuation of the overall profit and loss level and the valuation of investment trusts.

(Issues with Conventional Technology)

For example, if the prior art is to select a similar investment trust, for example, a comparison of the rate of increase in valuation and the rate of increase in investment trusts, a comparison with the Nikkei Average, this is the overall profit/loss level, and the first level is the profit/loss level. Even if you know the whole picture, you cannot drop it individually, so you can't deny it. It seems almost impossible to take further steps to evaluate investors' investments in more detail. At the profit-and-loss level, this is the minimum requirement for charts that are personalized in the second and subsequent levels and used in the profit-and-loss-level trading data and the unrealized profit-and-loss-level trading data. Other assumptions include a tie between the issue and the purchase date (or purchase price) and the presentation of an index that affects investment profit or loss. The chart of the stock held or already sold (or the stock to be purchased) based on such assumptions is a personalized chart.

### (Action of a Personalized Chart Evolving Stepwise)

Personalized charts evolve gradually. For example, in the case of a personalized chart of shares held, it is defined as the eighth level that, as the first level, it indicates or manages the purchase price and the purchase time by displaying or managing the purchase price and the purchase time, the third level that displays the current value, the third level that displays the current value, the fourth level that displays the calculation and display of the valuation indicators based on the transaction data such as the current value hike rate and the holding period, the fifth level that extracts the similar trading data from its own past trading and display it, the sixth level that displays the trading behavior of the same brand of other investors at the same time, the seventh level that displays the hike rate of the same investment target at the same time, the seventh level that captures the change in business performance and the change in the technical index value after purchase, and provides information that contributes to investment profit and loss. The gradual evolution level is shown in stages, but it is only one of the examples, and it is not necessarily the form in which the above stage evolves more. This paper presents one step to make it easy to understand how much the chart is personalized.

### (Effects of a Personalized Chart Evolving Stepwise)

Personalized charts produce a variety of effects. It is a chart that changes according to its own situation, and these pieces of information are sequentially accumulated in a database. This means that after the holding is sold, the trading data remains as a history, and the data is transferred to the trading profit and loss level trading data. As the information at the fifth level, it can now be used as part of the information on the issues it holds. This effect also has a significant effect. This means that past failures and successful experiences can be referenced at any time, depending on the current situation, and can be used to judge the issues currently held. Thus, a truly personalized chart refers to the fifth and subsequent levels. The upgrade from here is the true bone apex.

(Example of a Personalized Chart that Evolves Stepwise)

FIGS. 103 to 106 are one specific example.

### (Operation of Valuation Indicators Calculation Step)

Based on 2020 as a sampling condition, the aggregates for trading in the day-tray type group by period is prepared in 2020, and trading data at the trading profit/loss level is prepared (even if the trading profit/loss level data is available in the previous process). The trading data for the A-brand component is prepared, the number of trades and the number of wins are derived from the trading data, and the winning rate is derived.

When machine learning is performed, the process of machine learning is performed on the trading data determined as a problem, a necessary valuation indicators, and an application (a ranking, a comparison, a diagnosis, an evaluation, or an advice). Neither teacher with teacher data nor without teacher data are possible. By inputting a case like the above example, it becomes possible to learn and answer various problems.

### (New Method of Calculation Display Step of AI Machine-Learning Valuation Indicators)

The steps of selecting AI machine-learning metrics are performed through the following processes.

### (Significance of Valuation Indicators Automatic Selection Process)

The automatic creation step of the aggregate target trading data is one step of the automatic creation process of trading data, but the process of automating the identification of the valuation indicators to be calculated by the information processing system after the creation of the component-specific trading data and the creation of the profit-and-loss level trading data and determining the target trading data is the process.

### (Problems of the Valuation Indicators Automatic Selection Process)

For users and administrators, the problems required at the time change. It is convenient to be able to automatically create trading data and valuation indicators according to the necessary issues. As described in the specific example of the automatic creation step of the trading data to be aggregated, if the problem is determined, the trading data to be aggregated is determined, the trading data by component is determined, the trading data at the profit/loss level is determined, and valuation indicators that can be calculated by the information processing system is also determined. The task is achieved by determining the purpose of whether to evaluate, compare, rank, diagnose, or advise according to the task.

It may be done in AI, programmatically, or it may be referred to in a table.

### (Action of the Automatic Selection Process of Valuation Indicators)

If there is a problem, the above-described trading data to be aggregated is determined, and if it is necessary to classify and aggregate the trading data to be aggregated on a certain basis, the component-specific trading data is created, and if it is not necessary, the target proceeds to the creation of the profit and loss level trading data in the fourth step (the order may be changed).

Since the profit-and-loss level of which profit-and-loss (or the average profit-and-loss ratio (the average of ROI)) is to be improved is determined at the time of the problem, the sales-and-purchase data is created at the profit-and-loss level, and various valuation indicators affecting the profit-and-loss level are calculated based on the profit-and-loss level sales data, whereby the underlying sales data and valuation indicators can be automatically created.

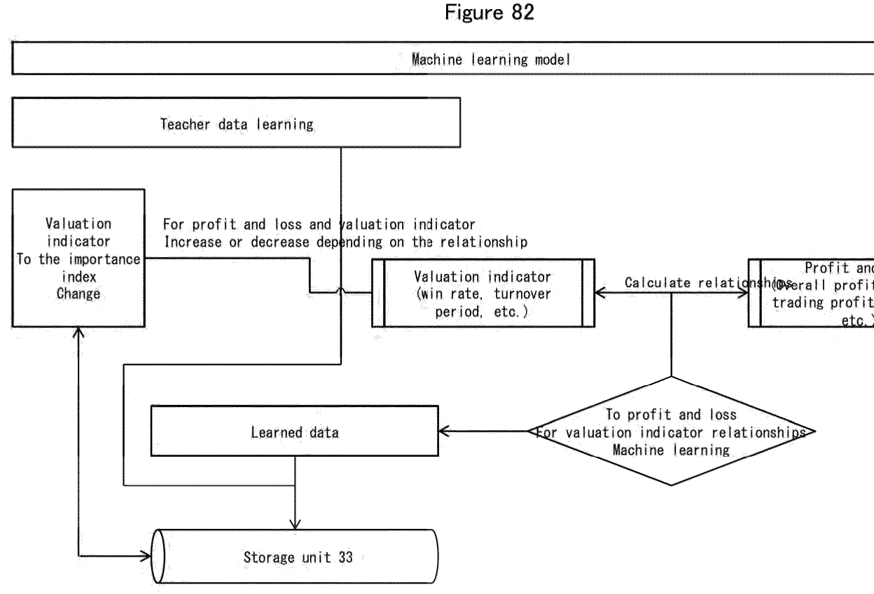

Machine learning using AI allows machine learning of valuation indicators that affect profit and loss, and causes various patterns to be remembered, and accumulates learned data. In this set of valuation indicators, if this number is used, it will be possible to make the best judgment to improve the valuation indicators in order to improve profit and loss. The better the database, the more opportunities to learn the relationship between the set of metrics and profit and loss, and the more effective the learning effect can be expected. There is also an unprecedented finding (see FIG. 82).

### (Effects of the Valuation Indicators Automatic Selection Process)

It is easy for anyone to present the visible problem of what they want to know. If this problem is determined, since the necessary trading data and the necessary valuation indicators are calculated by the information processing system, a special effect can be expected for both the user and the administrator. The valuation indicators calculated by the information processing system may be used in the following steps (evaluation step and subsequent steps).

### (Specific Examples of the Automatic Selection Process of Valuation Indicators)

Except as mentioned in the automatic creation step of the transaction data to be aggregated, there are the following specific examples.

### Example 1

In the case of some issues, the issues with the highest average trading profit ratio in the quarterly trading by using the quarterly report can be achieved by creating trading data for each reference medium, extracting and specifying the quarterly report by using the reference medium, creating component trading data for each brand in the trading data, and calculating a ranking table based on the trading profit ratio in the trading profit and loss level trading data by using the information processing system. Such a process may be machine-learned to be achieved by an AI, or a look-up table of a combination of a problem and the process may be created to automate the process. In the form and questionnaire, it is possible to make automation and manualization even by the method of choosing by reference medium=quarterly report, target profit/loss=trading profit, what do you want to know?=question form such as brand, and pull-down when issuing the problem. Of course, such data is one of the information that is desired not only by individuals but also by the media.

### Specific Example 2

The average trading profit ratio of the brands purchased when the 25-day moving average line divergence rate of the technical index exceeds-20%? For the problem, it is achieved by preparing trading data subject to tabulation by technical index, making the technical index=25-day moving average line divergence rate, further extracting the extracted trading data with 25-day moving average line divergence rate minus 20% or less of trading data subject to trading data, preparing trading profit level trading data of the trading data, and calculating the average value of the valuation indicators=trading profit rate by the information processing system.

### (Significance of Presentation of Valuation Indicators for Selling Data Subject to Aggregation by Investment Target)

For example, the sum of profits and losses from the trading of S1 shares, the average trading profit and loss ratio, the average number of days of holding, the winning ratio, the unrealized profit ratio, and the like are indices of the valuation indicators of the trading data to be compiled for each investment target.

### (Technical Issues)

These numbers have not been found in the world. This is because all the investment behavior of the investment target was covered by veil.

### (Action of Presentation of Valuation Indicators for Trading Data Subject to Tabulation by Investment Target)

The information processing system creates trading data to be aggregated for each investment target (extraction, classify, and aggregation based on the investment target), creates profit and loss level trading data (regardless of the order), and displays valuation indicators derived by the information processing system from the trading data set. It is possible to calculate and display numerical values of the target valuation indicators for the first time by cooperating a series of flows of extracting the sales data on the basis of the investment target in the information processing system, creating the profit/loss level sales data capable of calculating the target profit/loss in the information processing system, making a related element related to the profit/loss from the sales data set as valuation indicators, and displaying the valuation indicators calculated from the information system.

### (Effects of Presentation of Valuation Indicators for Selling Data Subject to Tabulation by Investment Target)

In October, for example, the sum of the lost stations in September due to the trading of S1 shares will be able to grasp the decline, and (in this case, we need a period-effect conception) it will be possible to examine how those who are skillfully buying and selling S1 shares are doing, what their way is wrong, and so on. It can be expected that the actual condition of the black box will be clarified.

### (Example of Presentation of Valuation Indicators for Trading Data Subject to Aggregation by Investment Target)

S1 stock prices are held on average for a number of days, and how often they buy and sell, and how often they buy and sell at what price, so that you can see how much unrealized gains are currently.

### (Definition of Presentation of Valuation Indicators by Component Trading Data of Trading Data Subject to Aggregation by Investment Target)

The date on which S1 shares were purchased is one component. When the trading data to be invested in S1 company stock is created by the information processing system (extraction condition: investment object=S1 Co., Ltd.) and the trading data is further extracted at the purchase date=September 10, a trading data set in which SoftBank shares are purchased can be created on September 10, and profit and loss level trading data is created depending on which profit and loss of the trading data set is targeted (even in the previous process), valuation indicators that affects profit and loss is calculated by the information processing system with the trading data, and the valuation indicators is displayed by the component trading data of the trading data to be aggregated by the investment object.

### (Conventional Problems)

For example, in the case of S1 shares, the majority of shareholders purchased on September 10th usually reported total trading volume and trading value. If the daily trading price is 10 billion yen, it is sold for 10 billion yen. But I don't know any more. It's not all the information about who was selling, how they were buying or selling, and how many people who bought and sold today. But as an investment, if you know what you're doing, you'll see how to improve, how you're losing money, and so on. Especially, if the actual situation of buying and selling is clarified in the existence of the speculative stock, it will be lost, and the right investment action will be possible. The purpose of the information processing system is to eliminate the obstacles to savings and investment by clarifying the actual situation so as not to repeat erroneous investment behavior.

### (Action of Presentation of Valuation Indicators Based on Component Trading Data of Trading Data Subject to Tabulation by Investment Target)

I mentioned how to create the index in the definition, but the most important thing is to display the index, but it is only possible to display the index in a series of flows. It is the display of this metric that can be achieved in concert with a coherent computer and software, rather than a separate one.

### (Effect of Presentation of Valuation Indicators Based on Component Trading Data of Trading Data Subject to Tabulation by Investment Target)

For example, if we assume that the trading price of 10 billion yen for S1 in the previous example covers all trading in the information processing system, it should be equal to the sum of the purchase price and the sale price. Originally, a variety of other metrics could be calculated and displayed, including, for example, the sum of trading profits and losses, the sum of unrealized gains and losses today, the sum of losses in the case of winning or losing trades, the loss rate, and the sum of profits in the case of winning trades. The social impact of these indications and the effect on investors are unknown. It's not hard to imagine that it's a source of articles and news from different perspectives.

### (Specific Example of Presentation of Valuation Indicators Based on Component Sales Data of Sales Data Subject to Aggregation by Investment Target)

As described in the specification, for example, by extracting only September 10 purchasers of S1 shares and creating trading profit/loss data, investors who purchased S1 shares on September 10 can grasp how much they sold, how much they held, and how much the average profit of those who sold was.

### (Definition of Presentation of Valuation Indicators Based on Trading Data by Investor in Trading Data Subject to Tabulation by Investment Target)

The display of the valuation indicators based on the trading data by investor of the trading data for each investment object means, for example, that the trading data for the investment object of S1Co., Ltd. (not S1 stock or A stock) is extracted, classified and tabulated with the investor as a reference, and the created trading data is generated at a target profit/loss level, and based on the trading data set, valuation indicators that affects the target profit/loss is calculated by the information processing system, and the calculated valuation indicators is displayed.

(Issues with Conventional Technology)

In the previous example, I told you that the trading price of S1 shares was 10 billion yen, so I don't know anything about it, but one of these is the process that the investor can understand from the perspective of the investor. For example, investor A buys for 3900 yen and sells for 4500 yen, investor B buys for 4600 yen and sells for 4500 yen, or it is extracted by each investor or investor to grasp the actual situation.

### (Specific Examples of Presentation of Valuation Indicators Based on Trading Data by Investor in Trading Data Subject to Tabulation by Investment Subject)

The trading data subject to investment aggregate is extracted, classified, and tabulated on the basis of the investor, and the created trading data is created at a target profit/loss level, and based on the trading data set, valuation indicators having an effect on the target profit/loss is calculated by the information processing system, and the calculated valuation indicators is displayed. If the trading data is classified for each investor, for S1 company stock, the investor A is in this way, the investor B is in this way, and the investor B is in the extraction, and if the trading data is classified by the investor A, the trading data is the number of investors A. However, it is important to be aware that the numbers will be easier to see if they are compiled, but there will be indicators that have not been compiled.

### (Specific Examples of Presentation of Valuation Indicators Based on Trading Data by Investor in Trading Data Subject to Tabulation by Investment Subject)

Which investor has the highest average trading profit/loss ratio for S1 shares, and the key to the number-one investor in S1 shares is something that can be used to create the original article. In addition, it is possible to compare the average trading style of S1 shares with the top-level trading style.

### (Definition of Presentation of Valuation Indicators by Component (Investment Target) of Trading Data Subject to Tabulation by Investment Target)

For the sake of clarity, we will explain in the case of S1 again that the starting point for our steps is that S1 shares are the components of the stocks that are superior to S1 stocks. If you want to know what position S1 shares are in a stock, it is useful to display the valuation indicators based on the component (investment target) sales data of the trading data for each investment target.

(Issues with Conventional Technology)

Assuming that S1 shares represent a trading value of 10 billion yen a day, shares, which are the dominant concepts, are funded at 2 trillion yen a day or several trillion yen a day. This situation is also surrounded by veils, and the Tokyo Stock Exchange and other companies report on trading trends by investor, but the situation is not quite clear. In addition to S1 shares, many other shares are traded every day, so a day alone is enormous. However, when the actual situation of one of S1 stocks becomes clear, the whole picture becomes clear. This is precisely the display of the valuation indicators based on the component (investment object) sales data of the trading data to be aggregated by investment object.

### (Effects of Presentation of Valuation Indicators by Component (Investment Target) of Sale Data Subject to Tabulation by Investment Target)

It is this process that the top-level shares are converted into trading data to be counted according to the subject of investment. First, the key points are extracted from S1 company's shares, and when the components are compared with other shares, the shares are classified, the target profit/loss level is determined, the profit and loss level trading data is created by the information processing system, the valuation indicators that affects the target profit/loss is calculated by the information processing system from the non-trading data, and the calculated valuation indicators is displayed by the information processing system. Among the stocks, S1 shares have a 7 percent weight of trading earnings, followed by T shares, with a second weight, with a 3 percent weight of unrealized earnings, and a slightly higher turnover rate than the average, and shorter than the average number of days held.

### (Effects of Presentation of Valuation Indicators by Component (Investment Target) of Sale Data Subject to Tabulation by Investment Target)

S1's shares are clearly positioned within the stock as a whole, and, to a large extent, it has the particular advantage of displaying the data set needed to produce the story, such as the attractiveness of ETF, virtual money, and FX, compared to other mutual funds. All of these inventions are inventions capable of creating a way to solve social issues such as investment and savings problems and the 20 million yen problem by utilizing data that existed in the world but have not been utilized.

### (Specific Examples of Presentation of Valuation Indicators by Component (Investment Target) of Trading Data Subject to Tabulation by Investment Target)

The characteristics of the trading of S1 shares in the stock and the nature of the investments, such as which results have been improved in 2020 compared to the investments of shares, mutual funds, ETF, and virtual currencies, which were made in 2019, which investments are more likely to succeed in trading, and which failures are made by those who have failed.

### (Definition of Trading Data Below Trading Profit Level)

The trading data below the trading profit/loss level indicates the trading data at each of the following levels required to evaluate the trading.
(1) Second-level trading profit-loss level trading data
(2) Third-level winning (or losing) level trading data
(3) Fourth-level winning (or losing) pattern-level trading data

When the purpose is to improve sales and loss, we can make various things possible by preparing sales and purchase data below the level of sales profit and loss, and by carrying out the evaluation process, diagnostic process, advice process, comparison process, ranking process, etc.

### (Definition of Trading Data Below Unrealized Gains/Losses Level)

The trading data below the unrealized profit/loss level indicates the trading data at each of the following levels necessary for evaluating the holding status of the investment target.
(1) Second-level unrealized profit and loss level trading data
(2) Third-level unrealized gain (or loss) level trading data
(3) Fourth-level unrealized profit (or loss) pattern-level trading data

If the purpose is to improve the profit and loss, etc., it will be possible to do various things by preparing sales and purchase data below the profit and loss level, and by carrying out the evaluation process, diagnostic process, advice process, comparison process, ranking process, etc.

The terminal 2 presents the information generated by the information generation unit 3021 to the user. Note that each time data is exchanged, the data is exchanged with the storage unit 33, and various types of data are accumulated.

Further, the information generation unit 3021 may calculate valuation indicators with reference to the transaction data, compare and rank the investor with reference to the calculated valuation indicators, and generate information indicating the comparison result and ranking of the investor as valuation indicators. The comparison here refers to the comparison of the valuation indicators of the investor with the valuation indicators of other investors, the average value of the valuation indicators, etc.

### (Processing Overview of the Information Presentation System 10)

FIG. 3 can be referred to as a diagram illustrating an outline of processing of the information presentation system 10 according to the present embodiment. An outline of processing of the information presentation system 10 will be described with reference to FIG. 3.

### (Step S301)

In the terminal 2 (which may be a user terminal or an administrator terminal), the control unit 22 acquires transaction data of an investment product from the operation acceptance unit 24 or the like, and transmits the transaction data to the server 3 by the communication unit 21. As illustrated in FIG. 2, the generated data is also stored in the storage unit 33. Details of the trading data will be described separately.

### (Step S302)

In the server 3, the control unit 32 receives the trading data from the terminal 2 by the communication unit 31. The information generation unit 3021 calculates valuation indicators from the trading data. The control unit 32 transmits the calculated valuation indicators to the terminal 2 (which can be a user terminal or an administrator terminal) as an evaluation result by the communication unit 31. As illustrated in FIG. 2, the generated data is also stored in the storage unit 33. Details of the valuation indicators will be described separately.

### (Step S303)

In the terminal 2, the control unit 22 receives the evaluation result from the server 3 by the communication unit 21, and causes the display unit 23 to display the evaluation result. As illustrated in FIG. 2, the generated data is also stored in the storage unit 33.

### (Step S304)

In the server 3, the information generation unit 3021 diagnoses the tendency of the user to buy or sell from the valuation indicators calculated in the step S302. The control unit 32 transmits the diagnosed tendency of buying and selling to the terminal 2 as a diagnosis result by the communication unit 31. As illustrated in FIG. 2, the generated data is also stored in the storage unit 33.

### (Step S305)

In the terminal 2, the control unit 22 receives the diagnosis result from the server 3 by the communication unit 21, and displays the diagnosis result on the display unit 23 (which can be a user or an administrator). As illustrated in FIG. 2, the generated data is also stored in the storage unit 33.

### (Step S306)

In the servers 3, the information generation unit 3021 compares and ranks the investors from the valuation indicators calculated in the step-wise S302. The control unit 32 transmits the comparison data and the ranking data of the investor to the terminal 2 (which can be a user terminal or an administrator terminal) by the communication unit 31. As illustrated in FIG. 2, the generated data is also stored in the storage unit 33.

### (Step S307)

In the terminal 2, the control unit 22 receives the comparison data and the ranking data of the investor from the server 3 by the communication unit 21, and causes the display unit 23 to display the comparison and the ranking of the investor. As illustrated in FIG. 2, the generated data is also stored in the storage unit 33.

### (Step S308)

In the server 3, the information generation unit 3021 generates advice on the sale and purchase of the investment commodity by referring to the trading data for investment commodity, the valuation indicators, the user trading trend, the comparison data of the investor, the ranking data, and the like. The control unit 32 transmits the generated advice to the terminal 2 by the communication unit 31. As illustrated in FIG. 2, the generated data is also stored in the storage unit 33.

### (Step S309)

In the terminal 2, the control unit 22 receives, from the server 3 by the communication unit 21, advice on the sale and purchase of the investment commodity, and causes the display unit 23 to display the advice. As illustrated in FIG. 2, the generated data is also stored in the storage unit 33.

Note that, in the server 3, the determination of various conditions, the calculation of the target profit and loss, the calculation of the valuation indicators, the selection of the valuation indicators, the storage in DB such as the scoring, the ranking data, the creation of the diagnostic data, and the storage in DB, which are performed by referring to the trading data to be evaluated, are executed by, for example, batch-processing. DB is set, for example, in the storage unit 33 of the server 3.

In DB, the series of data is accumulated for each user, and can be displayed in response to a request by the user, or the entire data can be extracted in response to a request by the administrator. These calculated generated data can be distributed as article distribution, or can be sold.

### (Definition of Profit/Loss Level)

For the profit-and-loss level, the overall profit-and-loss level is defined as the first level, the unrealized profit-and-loss level, and the trading profit-and-loss level are defined as the second level, the unrealized profit-and-loss level, the winning profit-and-loss level, and the losing loss level are defined as the third level. Fourth-level definitions are inclusive profits above the benchmark, inclusive gains below the benchmark, inclusive losses above the benchmark, inclusive losses below the benchmark, winning patterns 1 to 3, and losing patterns 1 to 3. As described above, there are four levels of profit and loss.

Note that this level division is merely an example, and a part may be used, or another index may be defined. The winning patterns 1 to 3 and the losing patterns 1 to 3 have been described in the first embodiment and FIG. 9.

### (Definition of Profit-Loss Level Trading Data)

Regarding the profit and loss level trading data, the profit/loss divided by each level includes the trading data that is the source of the profit/loss. For example, the second-level trading profit or loss is based on trading data in which the reverse trading is performed, and the unrealized profit or loss is based on trading data in which the reverse trading is not performed. The third-level winning profit is based on the trading data of the trading value<the trading value among the trading data traded in opposition.

For example, in the case of profit or loss, the traded profit or loss is based on the traded trading data, and the unrealized profit or loss is based on the unrealized profit or loss trading data. The trading profit and losing data is divided into trading profit data of winning (trading price<trading price) profit, loss (trading price>=trading price) loss trading data, and the like. As described above, the division of the trading data by profit and loss is an important process for calculating the valuation indicators by the postoperative profit and loss level evaluation by the information processing system.

(Definition of valuation indicators by Profit and Loss Level) Separate the profit-and-loss levels, separate the trading data accordingly, and define it as the profit-and-loss data by level. Then, the valuation indicators calculated by the information processing system based on the level-based profit-and-loss sales data is defined as the level-based profit-and-loss valuation indicators.

### (Definition of Profit-Loss Level Indicators)

The profit/loss level valuation indicators is valuation indicators calculated based on the profit and loss level trading data. For example, the valuation indicators based on the trading data (trading profit or loss) in which the reverse trading is performed is the trading profit/loss ratio. Further, valuation indicators based on trading data (winning profit) of winning profit is a winning profit ratio.

### (Collection and Processing)

Aggregation refers to aggregation or processing, or both. Among the valuation indicators calculated by the information processing system from the trading data, there are valuation indicators that are not calculated when tabulation is performed, and valuation indicators that are generated only when the trading data set is processed as it is. For example, the trading profit/loss ratio and the like are the latter, the total purchase amount is the former, and the necessary valuation indicators is calculated by the information processing system according to the situation.

### (Definition of Components)

The component indicates an element included in the transaction data to be aggregated. For example, if the trading data of Mr. A's investment products is included in the aggregate, the components may be virtual currency, FX, stocks, etc., or a particular stock may be included in the stock. Investors, types of investments, and groups of investments are also included in the component. When stocks are counted, investors, stocks, targets, etc. are also included in the component.

### (Profit-Loss Level Indicators)

The information generation unit 3021 looks at the trading data in the overall profit and loss (the first level), extracts the trading data according to whether or not the trading is reversed (the second level), extracts the trading data according to whether or not the profit is generated (the third level), and further extracts the trading data according to the pattern (the fourth level). As described above, the information generation unit 3021 processes and recreates the trading data by a method of extracting the trading data in a stepwise manner, and calculates each valuation indicators. Note that this is merely an example, and may be performed in two stages or three stages, may be performed from the second level, or may be divided in other ways.

### (Definition of Market Value at Time B)

For each period, the starting point is defined as point A (the first time point), the current value at point A is defined as the current value at point A, and the value at point A is defined as the current value at point A.

### (Definition of Market Value at Time B)

For each period, the end point is defined as point B (second time), the market value at point B is defined as the market value at point B, and the value at point B is defined as the market value at point B.

### (Definition of Fair Value Corresponding to Benchmark)

The fair value corresponding to the benchmark is calculated by the benchmark hike rate×(the buy value or the fair value at time A). The benchmark hike rate indicates the hike rate based on the benchmark value at the purchase date or the point of A.

### (Definition of Target)

Aggregate covers the criteria, such as investment targets, investors, periods, and profits and losses. For example, if the aggregate target is an investor, the calculation target of the trading data includes not only individual investor groups, institutional investor groups, individual investor A, institutional investor B, etc., but also investor types such as investor type groups with a focus on short-term trading and investor type groups with a medium- to long-term holding investor type group. If the target of aggregate is an investment target, each issue, each brand group, each product, and each product group shall be included in the aggregation target. If the target to be tabulated is a period, aggregate will be performed every year, May, one year, and one week in 2018. Profits and losses included in the aggregate shall include sales and purchase, loss and total loss. If the target of the aggregate is an investment target, the target of the calculation is for each issue such as A, or the target of the calculation is for each product such as stock and FX. In addition, if the target of the aggregate is an adviser, each adviser such as the adviser A and the adviser company A can be the subject of the aggregation. It is also possible to include the securities companies in use in the aggregate, and the aggregation is performed for each securities company A and the securities company B. Media can also be counted. The reference media can also be tabulated by media such as quarterly reports, personal blogs, and twitter. It is also possible to summarize the aggregate targets that are scattered.

### (Definition of Target Trading Data)

The trading data is divided into investment targets, investors, periods, profit and loss, investment types, advisors, securities companies, and media, and the divided trading data is defined as trading data to be aggregated. It is also possible to collectively classify and re-classify the trading data subject to aggregate, which are scattered.

### (Definition of Component Sales Data)

The aggregated trading data or the profit and loss level trading data described above is divided into components such as an investment target, an investor, a period, a profit/loss, an investment type, an adviser, a securities company, a medium, and a technical index value, and the divided trading data is defined as component trading data. The component includes an input item added in the first step or the second step that indicates an item that can be managed by the database, and indicates a table item (including a related item) of the transaction data.

### (Investment Targets)

It includes stocks such as Company S shares, stocks such as investment trusts, ETF bull funds, etc., stocks such as FX yen dollars, etc., virtual currency stocks, etc. Also, stocks may be grouped and aggregation targets may be divided into Speculative issue groups, blue-chip stock groups, high dividend stock groups, etc., and index investment trust groups, robot fund groups, etc., may also be aggregated targets. Furthermore, products, product groups, etc. may be One of be aggregated. For example, the information generation unit 3021 divides trading data for each aggregation target such as virtual currency, FX, and stocks, and calculates various valuation indicators.

### (Investors)

For example, if the aggregate target is an investor, the aggregation target is trading data for each investor type such as an individual investor group, an institutional investor group, an individual investor A, an institutional investor B, an investor type group with a focus on short-term trading, and an investor type group with a medium- to long-term holding investor type group.

### (Period)

For example, the period is divided into annual trading data for one year, monthly data for one month, weekly trading data for one week, daily trading data for one day, trading data for 2019, and the like.

### (Profit and Loss)

For example, in the case of profit and loss, the trading profit and loss of the counter-trading is divided into trading data, unrealized profit and loss of the non-trading is divided into trading profit and loss data, trading profit data of winning (trading value<trading value) profit, trading loss data of losing (trading value>=trading value), and the like in the trading profit and loss data. Separating trading data by profit and loss is an important process for calculating valuation indicators by the information processing system in the profit and loss level evaluation described later.

### (What Generated Data can be Generated)

There are various types of generated data generated by the information generation system (information generating apparatus). A number of specific examples are given, but for example, one of them is article data. The data generated by the advice generating unit 321 includes various valuation indicators derived from the trading data, and the comparison data, ranking data, diagnostic data, evaluation data, and advice data using these include many data that are useful as news articles as well. The generated system includes, but is not limited to, issue resolution data, ranking data, comparison data, evaluation data, advice data, and the like in addition to article distribution data.

Investment issues cover a wide range. As we have seen, various investment issues will be solved in conjunction with trading data. This information generation system is a system capable of generating advice for investment and, if reversed, generating data capable of solving investment problems. Mr. A's advice of raising the winning rate and raising the winning profit rate is that Mr. A's investment challenge is raising the winning profit rate, and in order to raise the winning profit rate, the same process of doing this is reversed. Therefore, the advice generation system can be used as it is for a system that solves the investment problem.

The sixth step and the eleventh step are defined as operation steps. Up to the fifth step, the following has been decided. Up to the fourth step, the target trading data is determined, the target profit/loss, the valuation indicators calculated by the information processing system, and the selection thereof. In order to improve the target profit and loss, what is done using the valuation indicators calculated by the information processing system is the operation step after the sixth step. Steps from the sixth step onward are whether to evaluate the valuation indicators (this step), whether to compare the valuation indicators with the comparative object, whether to rank the valuation indicators as an axis, whether to diagnose using the valuation indicators, whether to advise using the valuation indicators, whether to display using the valuation indicators, and what to do for the target profit/loss.

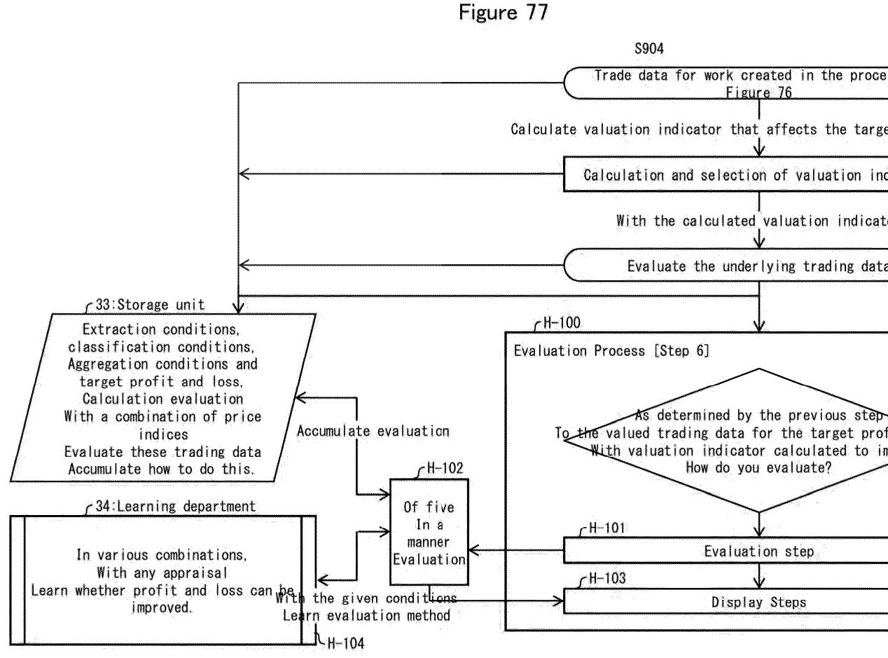

First, the sixth step evaluation process (H-100 in FIG. 77) is divided into an evaluation step (H-101) and a display step (H-103). This is the problem of how to evaluate and display the valuation indicators calculated by the information processing system in order to improve the target profit and loss.

For example, in order to improve trading profit and loss, we evaluate what kind of trading has been carried out by using the numbers of the valuation indicators such as the winning rate, the winning profit rate, and the loss rate. If the index improves, trading profit and loss will also improve.

### (Definition of Evaluation Method)

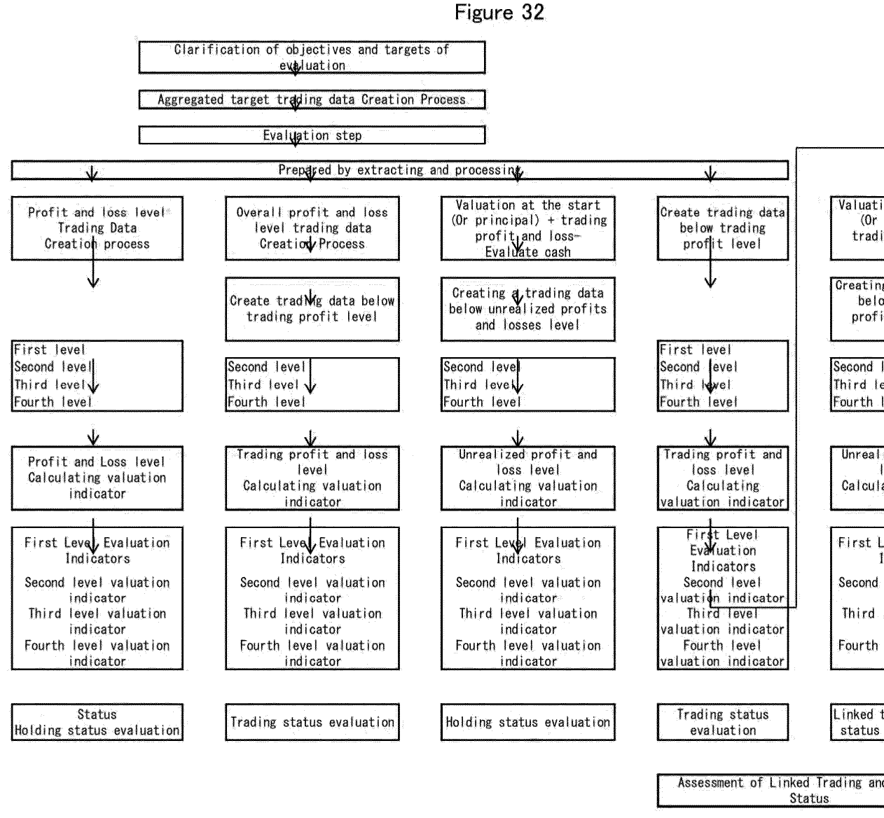

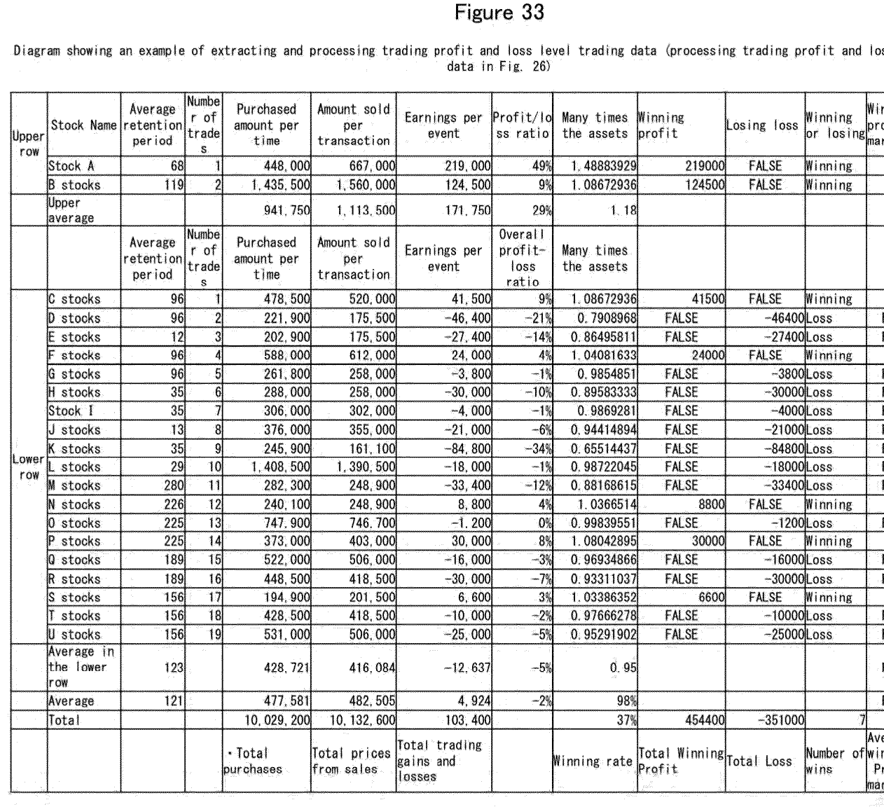

FIG. 32 is a diagram illustrating a procedure of an evaluation method according to the present embodiment. As shown in FIG. 32, there are the following five evaluation methods for evaluating the calculation target using the aggregate profit/loss level valuation indicators.
(1) Evaluation of trading conditions
(2) Evaluation of trading and holding status
(3) Evaluation of holding status
(4) Assessment of interlocked holding status
(5) Assessment of Linked Trading and Holding Status

These evaluation methods can be similarly applied to evaluation using trading data for aggregation by period, evaluation using trading data for aggregation by investment target, and the like.

The evaluation process is performed through the following process.

The first step is a step of acquiring trading data. The second step is the step of creating transaction data to be aggregated. The third step is a step of creating the component-by-component sale data. The fourth step is a step of creating profit and loss level trading data. The fifth step is a step of calculating and selecting valuation indicators. The sixth step (this step) is an evaluation process (divided into an evaluation step and a display step).

Based on the valuation indicators calculated by the information processing system, the trading status and the holding status of the target are evaluated by any of the evaluation methods described in (1) to (5) below. In addition, the evaluation may be displayed in an appropriate display method in this step, or may be performed in the eleventh step. Tables, pie charts, components, bar charts, radar charts, etc.

When the terms (old method of the evaluation process) are arranged, as shown in FIG. 77, the evaluation process for performing the evaluation is divided into an evaluation step and a display step. Hereinafter, an evaluation process will be described (H-100 of FIG. 77).

### (Old Method in the Evaluation Process)

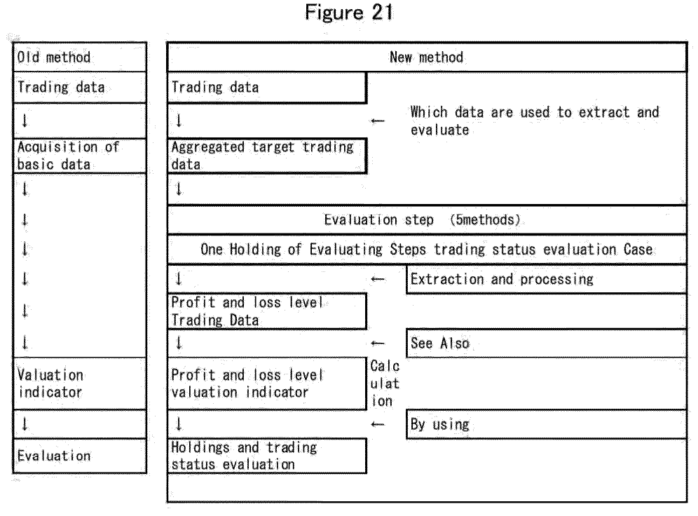

FIG. 21 is a diagram illustrating a comparison of methods of an evaluation process according to the present embodiment. In the old method of the evaluation process, the advice generation unit 321 acquires the basic data from the trading data, and calculates valuation indicators from the basic data to evaluate the trading of the investment product. For example, the advice generation unit 321 acquires a profit-and-loss total from the sales data, and calculates valuation indicators by referring to the profit-and-loss total. Further, the advice generation unit 321 calculates valuation indicators according to the level of profit and loss. In the old method, calculation of valuation indicators and presentation of a decomposition formula of each profit and loss are performed.

### (Assessment Process Issues)

In the new method of the evaluation process according to the present embodiment, a process is presented in which trading data is extracted (or classified, tabulated, processed) in a number of stages, and then trading and holding of a target to be tabulated are evaluated.

The old method and the new method will be described in comparison. First, the former acquires the basic data from the acquired trading data for investment commodity, whereas the latter creation process of the trading data to be aggregated is to extract (or classify, aggregate, or process) the trading data with the purpose of creating (valuation indicators) in order to evaluate the aggregation target. Further, the process of creating the profit-and-loss level trading data of the latter is a process of further extracting and processing the trading data to be aggregated according to the profit-and-loss level, and creating a plurality of various types of trading data. Then, since various types of transaction data extracted (or classified, totaled, processed) are used as a base, the period-based transaction data, the investment-subject transaction data, and the like are created. Through the process of the second step and the third step (or the second step) of creating the trading data to be aggregated and creating the component trading data and the fourth step, the trading data to be worked and the profit and loss to be targeted are determined. In the fifth step, it is determined which valuation indicators is calculated and selected by the information processing system. It is possible to evaluate the trading data to be evaluated using the trading data to be processed and the profit and loss to be targeted and the valuation indicators calculated and selected by the information processing system. Evaluations can be identified at a glance by displaying these evaluations using appropriate labeling methods. One evaluation step of the operation step is not just a list of numbers, but may include displaying such that they are displayed in a suitable display manner (which may be summarized in the eleventh step).

By the cooperation in the database, the usage spreads, and the valuation indicators also spreads, and it is possible to carry out the deep evaluation.

### (Effect of Evaluation Process)

In the aggregate target trading data creation process, the information generation unit 3021 creates period-based aggregation target trading data, investor-based aggregation target trading data, and the like. The information generation unit 3021 further processes and extracts each piece of trading data to be tabulated. In the process of creating the profit-and-loss level trading data (from the first level to the fourth level), the profit-and-loss level trading data is created based on the trading data to be aggregated. The trading data to be evaluated in the sixth step is determined by the aggregate target trading data in the second step, the component trading data in the third step, and the profit and loss level trading data in the fourth step (see FIG. 77). However, in this process, the profit and loss level trading data may be created only at the first level, or only at the second level. The second level is the creation of the trading profit and loss level trading data of the trading data to be aggregated (or the component trading data). In the valuation indicators calculation process, the information generation unit 3021 calculates valuation indicators for evaluating the calculated profit and loss from the profit and loss level trading data. Here, as described in the above process, the information processing system calculates the sum profit/loss ratio, the overall profit/loss ratio, and the valuation indicators such as the current evaluation value calculated by the information processing system from the transaction data at the first level of the total profit/loss level, or the valuation indicators such as the total transaction profit/loss value and the average transaction profit/loss ratio calculated by the information processing system from the second level transaction profit/loss level transaction data, and the like. According to these levels, the valuation indicators calculated by the information processing system changes, and the amount also changes. Further, in the process of evaluating the holding and trading of the aggregation target, the information generation unit 3021 performs an evaluation on the holding and trading using the calculated valuation indicators. For example, Mr. A's first-level valuation index, the overall profit and loss, and the principal and the current valuation amount, are used to evaluate the status of holding and trading. The same applies to the third level as well, for example, in which the trading situation is evaluated from the valuation indicators of the total amount of trading profit and loss at the second level calculated by the information processing system from the trading data (trading data subject to aggregate) of the issue A.

The process of the second step, third step, is to determine what type of trading data is to be included in the trading data. The fourth step in assessing the trading data at what profit or loss level determines which trading data will be assessed to improve which profit or loss. Further, by calculating valuation indicators constituting the profit and loss by the information processing system, valuation indicators that influences the result of the profit and loss is calculated by the information processing system. The buying and selling situation and the holding situation of the evaluation target are evaluated with reference to the valuation indicators calculated by the information processing system. These assessments are presented in an appropriate manner. This series of flow sets the target evaluation object, the target profit and loss, and the valuation indicators related to the target profit and loss, and a system of evaluating and displaying the target profit and loss by the valuation indicators of the target profit and loss.

### (Significance of Evaluation Process)

The evaluation process includes a process of creating trading data to be aggregated, a process of creating trading data at a profit/loss level, and a process of evaluating trading and holding of trading data to be aggregated through a process of calculating valuation indicators using the trading data.

As described above, there are six steps from the acquisition of the first-step trading data to the evaluation of the sixth-step trading data. However, the order may be reversed or the evaluation may be performed in a non-step manner. The omission is also included in this process. The same applies to the case where the problem solving step is interposed.

### (Effect of Evaluation Process)

Compared with the old method, the new method of the evaluation process has a much wider range (spread to data on trading by period or data on trading subject to investment), deeper depth (divided and linked in valuation between holding and trading, valuation at the level of profit and loss, etc.), wider expression range (display step and display step of the 11th step), and the process of evaluating from various aspects has been clarified consistently when the evaluation object is decided. For example, in order to evaluate Mr. A's trading profit and loss in 2019, Mr. A's trading data is prepared, and Mr. A's trading data for each fiscal year is prepared using the fiscal year as a component. As a result, the trading data of Mr. A for FY2018, FY2019, and FY2020 will be created (from the second step to the third step). To evaluate trading gains and losses, trade data below the trading profit/loss level shall be prepared for each of Mr. A's FY2018, FY2019, and FY2020. Of these, the amount of trading profit/loss (total value) of Mr. A in FY2019 is determined by creating trading profit and loss level trading data for FY2019. For example, if it is 1 million yen, this 1 million yen is the amount earned in various trades in FY2020.

The goal of increasing Mr. A's trading profit of 1 million yen in FY2020 in FY2021 was decided (from the second step to the fourth step) How to evaluate the trading profit of 1 million yen in FY2020 (trading data for work (FIG. 76, FIG. 77)) is the reason why Mr. A earned this 1 million yen at the next stage, and the information processing system calculates various valuation indicators, including the principal (valuation amount at the beginning of 2020), the valuation amount at the end of 2020, the number of trading transactions, the winning rate, the winning profit, and the loss of loss, which are the reasons for generating trading profits (decompose elements, constituent elements, and related elements) using the information processing system (Step 5). Based on the valuation indicators calculated by the information processing system, Mr. A's trading situation in 2020 is evaluated (the sixth step), and Mr. A's trading profit of 1 million yen in 2020 can be calculated by the information processing system from the trading profit data of Mr. A's trading profit in 2020 (valuation indicators such as trading profit of Mr. A's trading profit of 0.1 million yen) as well. Therefore, among the trading profits of 1 million yen, valuation indicators such as Mr. A's trading profit of 0.1 million yen and B's trading profit of 0.2 million yen can also be calculated by the information processing system. In order to display the valuation indicators calculated by the information processing system in an easy-to-understand manner, a pie chart is suitable. This process is a display process.

### (Specific Evaluation Process of Specific Example)

For example, the trading data of Mr. A in 2019 is used as the trading data to be compiled by period, and four stages of profit and loss level trading data are created, and various valuation indicators are calculated by the information processing system. This allows Mr. A to evaluate various aspects of the 2019 trading and the resulting year-end assets in 2019.

For example, if four stages of profit-and-loss level trading data are created using trading data of S Ltd. shares in 2019 as period-based trading data and various valuation indicators are calculated using the information processing system, it is possible to evaluate the aggregate profit and loss of S Ltd. shares in 2019, the trading profit and loss, and the resulting unrealized profit and loss at the end of 2019 from various aspects.

For example, when we evaluate the winning profit of Mr. A's investment products, we find that the stock is winning, but the hypothetical currency and the investment trust do not have a definite profit. If we evaluate M's shares by investor, we can evaluate how many investors are holding. That is, there is a special effect that the prior art does not have.

As shown in FIGS. 101 and 102, if various conditions are added in FIG. 101, a data set according to the purpose is created, the necessary valuation indicators is calculated, and the valuation indicators according to the purpose is calculated, so that various objects can be easily evaluated by various conditions and various types of valuation indicators even in this step. This process is just one step in FIG. 102, but since the target and the valuation indicators have been determined in a series of collaborations, it is possible to evaluate the object in many forms described in this specification.

For example, in order to evaluate the trading profit and loss in 2020 for A issues, the trading data for A stocks is compiled (the trading data for A stocks, such as A, B, and C, are compiled together to extract only the trading data for A stocks), and the component trading data for A stocks is compiled using the fiscal as a component. As a result, trading data for the A issues in FY2018, FY2019, and FY2020 are generated (from the second step to the third step). To evaluate trading gains and losses, trade data below the trading profit/loss level will be prepared for each of the A issues in fiscal 2018, fiscal 2019, and fiscal 2020. Among them, the amount of trading profit and loss (total value) of A stock in fiscal 2020 is determined by preparing trading profit and loss level trading data for fiscal 2020. For example, if it is 50 million yen, this 50 million yen is the amount earned from various trades in FY2020 for the A issue.

In fiscal 2020, the profit and loss of 50 million yen on sale and purchase of A stock was decided (from the first step to the third step). The next step is how to evaluate the profit and loss. This is the reason why the company earned 50 million yen, and the information processing system calculates the decomposition factors, components, and various valuation indicators that are related elements, such as the number of trades, the winning rate, the winning profit, and the loss on sale and purchase, which are the reasons for generating the profit (the fourth step).

This is a process of evaluating the trading status of A issues in 2020 using the valuation indicators calculated by the information processing system. Furthermore, based on the above-mentioned transaction data of stock A in 2020, if we use the investor as a component, we can divide stock A in 2020 into trade data for Mr. A and trade data for Mr. B, and so on. By using profit and loss as trading profit and loss and turning the number of trades into valuation indicators, it is effective to make clear at a glance who earned the most and how he earned it.

In 2020, the pie chart is suitable for clearly displaying who earned the trading profit of A holding. The most earned person chooses an appropriate expression method, such as the number of trades, the number of days held, the winning profit rate, and the loss rate, which is superior to the average, using the hexagon of each valuation indicators (the number of trades, the number of days held, and the loss rate).

The combination of the trading data to be aggregated and the component trading data determines the trading data to be targeted. In the third step, the target profit or loss is determined. In the fourth step, valuation indicators that affects the profit or loss is calculated by the information processing system. Various evaluations are performed using the valuation indicators calculated by the information processing system. In the sixth step, the expression of the evaluation is shown.

### (Definition of Transaction Data Evaluation Method)

There are a number of methods for evaluating transaction data (narrow sense defined trading data) from the viewpoint of which profit/loss level to evaluate, and from which mathematical function to evaluate. The profit-and-loss level measures are discussed in detail in the section on profit-and-loss levels.

Here, it will be described which mathematical formula is used to evaluate. By calculating a value represented by an expression such as a function based on a value associated with a variable or the like, it is possible to evaluate transaction data (trading data in a narrow sense).

Here are the mathematical expressions used to evaluate transaction data and the case of the overall profit/loss level.

Overall profit and loss={(win rate×Winning trade purchase price×Winning profit ratio/(principal×elapsed days/number of The winning trade turnover period of the principal/Purchase price per winning trade)+(lose rate×purchase amount of lose trade×Losing loss ratio/(principal×elapsed days/number of lose trade days/purchase amount per lose trade))}×principal×elapsed days/number of principal days/number of days of principal revolution/purchase amount per time [Calculation method1(including turnover of winning trades and losing trades)]

Overall profit/loss={(win rate×purchase price of winning trade×win rate/win count)+(lose rate×purchase price of losing trade×loss rate/loss count)}×principal×number of days elapsed÷number of days of revolution of principal/purchase price per1 [Calculation Method 2]

Total profit/loss={(win rate×win profit/win count)+(loss rate×loss/loss count)}×principal×elapsed days÷number of days of principal rotation/purchase price per 1 time Calculation Method 3

Total profit/loss={(win rate×win profit per round)+(loss rate×loss per round)}×principal×number of days elapsed÷number of days of rotation of principal/purchase price per time [Calculation method 4]

Total profit and loss=revenue per revenue×principal×number of days elapsed/number of days of revolution of principal/purchase price per purchase Calculation Method 5

Total profit and loss=revenue per revenue×principal×number of days elapsed/number of days of revolution of principal/purchase price per purchase [Calculation method 6]

Total profit/loss=revenue per transaction×number of transactions Calculation Method 7

Overall profit/loss={(win rate×win profit per transaction)+(loss rate×loss per transaction)}×number of transactions Calculation Method 8

As described above, by calculating the overall profit and loss and calculating the respective valuation indicators, multifaceted evaluation becomes possible.

Here,

Number of days of principal revolution=number of days elapsed/number of revolutions

Or

Number of days of principal revolving=number of days elapsed/principal×purchase price

Is used.

An index indicating how many days it takes to rotate one revolution is here:

Principal winning trade turnover days=elapsed days/winning trade turnover times

Or

Principal winning trade days=elapsed days/principal×winning trade purchase price

The information generation unit 3021 determines whether there is a difference between the number of rotation days in the case of the winning trade and the number of rotation days in the case of the losing trade. The characteristics of the winning investor are usually high winning profitability, and the number of days of turnover tends to be longer than that of the losing trades, so they are indicators for confirming that.

Purchase price per transaction=Purchase price/Number of transactions

Is used.

Purchase price per winning trade=winning trade purchase price/number of wins

Loss trading is also the same as above.

In the case of total profit/loss, the total profit/loss ratio is the total profit/loss/principal, and is obtained by expressing the formulas obtained by dividing the formulas by the principal.

In addition, in the case of total profit and loss in AB term, the investment products purchased before the time A and held at the time A need to be revalued at the time A.

In addition, when defined as the valuation value at AB period of the overall profit-and-loss/A period=the total profit-and-loss ratio of AB period, the total profit-and-loss ratio of each year becomes clear.

In addition, the same mathematical expressions can be used not only for the overall profit/loss level but also for the sales profit/loss level and the unrealized profit/loss level.

(Issues with Conventional Technology)

For example, conventionally, when evaluating the overall profit/loss level, the evaluation target is not divided into winning trades and losing trades, and the evaluation target is usually the transition of the evaluation value (=principal+total profit/loss), the increase/decrease rate of the evaluation value, and the like. However, this made it very difficult to understand where is bad and where is good, and it was rather unknown.

Overall profits and losses can be assessed by dividing them into winning trades and losing trades. However, at the trading profit/loss level, the first form of the evaluation is divided into winning trades and losing trades, but in the formula, it is a function of the calculation method 2. Here, it is proposed that the calculation can be performed by a wider method.

### (Effect of Evaluation of Transaction Data)

The granularity varies depending on which of the above seven levels of formula is used to separate winning and losing trades at the overall profit/loss level. These formulas decompose the overall profit and loss and the total profit-loss ratio. The transaction data can be evaluated by calculating various valuation indicators obtained therefrom. Of course, the type of transaction data is defined by the trading data to be aggregated and the component trading data. For example, it is possible to evaluate, from various angles, transaction data (trading data in a narrow sense) defined by the period-based trading data to be aggregated, the trading data to be invested, and the like.

### (Effect of Evaluation of Transaction Data)

By systematizing the calculation of the valuation indicators of the transaction data as described above, it is possible to calculate various valuation indicators by a combination of the profit/loss level and the evaluation method by the calculation formula, and to evaluate the transaction data. The various transaction data extracted by the transaction data to be aggregated and the component transaction data can be calculated by various formulas at various profit and loss levels. The effect of evaluating using the calculated valuation indicators becomes remarkable, for example, by period or by investment target, and results in an unprecedented effect. For example, those with high performance in 2020 had a high winning margin, and the average number of winning trades held was three months, but the average number of losing trades held was one week.

### [Example 4 of Evaluation of Transaction Data]

By evaluating the aggregate profit/loss level of the trading data for each period, the factors that won and lost each year can be clarified.

### [Example 4 of Evaluation of Transaction Data]

By evaluating the trading profit/loss level of the trading data to be aggregated for each investment target, the winning trade and the losing trade of the relevant stock can be compared, so that the winning manner and the losing pattern can be grasped and the probability of winning can be increased.

### [Example 3 of Evaluation of Transaction Data]

When evaluating the transaction data of Investor A, it is possible to accurately grasp the current status and the past situation at the total profit/loss level by dividing it into winning trades and losing trades at the total profit/loss level, and then dividing it into winning trades and losing trades at the sales profit/loss level and the unrealized profit/loss level, thereby enabling a more detailed breakdown as well as an overall picture at the total profit/loss level.

### [Example 4 of Evaluation of Transaction Data]

The results of 2020 and 2019 for stocks can be assessed from a variety of perspectives, such as a comparison of the win rate and the losing trade.

(Relationship between Evaluation of Transaction Data and Profit/Loss Level valuation indicators)

Evaluation of transaction data is to express profit/loss or the profit/loss ratio as a function, and profit/loss, which is the purpose of transaction data, is to express the increase/decrease by various factors as a function.

Objective gains and losses are classified into the first level of total gains and losses, the second level of trading gains and losses, unrealized gains and losses, the third level of winning gains and losses, loss losses, unrealized gains and losses, and so on.

The meaning of the first-level winning trade is a concept including counter-traded trading data and non-counter-trading data, and the winning rate also includes both.

On the other hand, the meaning of the second level is evaluated by dividing the winning trade and the losing trade, where the countertrading data is the countertrading data and the non-trading data is the non-countertrading data. The former is the past result, and the latter is the present progress.

When the profit and loss level trading data is determined, the target profit and loss level trading data is determined, and the transaction data can be evaluated.

### (Significance of Evaluation of Technical Index Values)

The information generation unit 3021 adds a technical index value as valuation indicators. As a result, the evaluation of the sales data can also be evaluated from the viewpoint of the technical index value. Since the technical index value at the time of purchase, the technical index value at the time of trade, and the technical index value at the time of possession can be managed, the technical index value at the time of success and the technical index value at the time of failure can also be managed, and the tendency of sale and sale can be evaluated from the aspect of the technical index value.

(Issues with Conventional Technology)

Trading and the technical index value are managed separately, and it has been impossible to manage the trading tendency from the viewpoint of the technical index of the investor A, the trading tendency from the viewpoint of the technical index of the investor B, and the investment performance in a unified manner.

### (Effect of Evaluation of Technical Indicator Values)

The information generation unit 3021 adds a technical index value to the various valuation indicators of the trading data. As a result, the technical index value of the investment target at the time of purchase and the technical index value of the investment target at the time of sale are managed together in the transaction history data. With regard to the investment target products that are being held, the technical index value corresponding to the market value is managed according to the transition of the market value on a daily basis, and it can always be managed. This makes it possible to accurately display and notify a danger signal or the like.

### (Effect of Evaluation of Technical Indicator Values)

It is possible to manage the value of the technical index along with the price of the stock at the time of purchase, the number of stocks, the stocks, and the date, and it is also possible to manage the value at the time of sale or holding.

It is easy to manage the transition of the technical index value from the purchase of the success trade of the excellent person to the sale, the tendency of the technical index at the time of the purchase of the excellent person, the tendency of the technical index at the time of the sale, etc.

### (Specific Example of Evaluation of Technical Index Values)

In spite of frequent trading, Mr. A's average technical index RSI at the time of purchasing is 80%, and the average RSI at the time of sale is 75%, and the winning rate is 50%, the profit-winning rate is 4%, and the loss-loss rate is −5%. This can be explained in detail by adding the technical index value to the index obtained from the transaction data.

### (Definition of Evaluation of Performance Data)

Performance data of the investment target (enterprise) is added as valuation indicators of the trading data. As a result, the evaluation of the transaction data can be evaluated from the viewpoint of the performance data to be invested. Since the performance data at the time of purchase, the performance data at the time of sale, and the performance data at the time of possession can be managed, the performance data at the time of success and the performance data at the time of failure can also be managed, and the tendency of trading and the evaluation of trading can be made from the aspect of the performance data.

(Issues with Conventional Technology)

The trading and investment performance data are managed separately, and it has not been possible to manage the trading trend from the viewpoint of the performance data of investments of investors A, the trading trend from the viewpoint of the performance data of investments of investors B, and the investment performance in a unified manner.

### (Effects of Evaluation of Performance Data)

Since the performance data of the investment target is included in the various valuation indicators of the trading data, the performance data of the investment target at the time of purchase and the performance data of the investment target at the time of sale are managed together in the trading history data. With respect to the Invested Products in possession, the Performance Data of the Invested Products will be managed and can always be managed. This makes it possible to accurately display and notify a danger signal or the like.

### (Effect of Evaluation of Performance Data)

It is possible to manage the performance data of the investment target together with the stock price, the number of shares, the issue, and the date at the time of purchase, and it is also possible to manage the performance data of the investment target at the time of sale or holding.

This makes it possible to easily manage changes in the performance data of the investment target from the purchase of the success trade of the outstanding person to the sale, trends in the performance data of the investment target at the time of the purchase of the outstanding person, trends in the performance data of the investment target at the time of the sale, and the like.

### (Specific Example of Evaluation of Performance Data)

The buying timing of the outstanding performers is often the first upward revision of the forecast value in the performance data of the investment target, and the selling timing of the outstanding performers is the first downward revision of the forecast value in the performance data of the investment target, and the performance data of the investment target is included together with the transaction data such as the buying/buying price, the number of purchases, and the date of the sale. By linking the performance data of the investment object with the transaction data, the habit of the investor, the success pattern of the investment object, etc. can be discovered.

### (Definition of Evaluation of Other Investment Data)

By adding trading data of another investment target as valuation indicators, the evaluation of the trading data can also be evaluated from the viewpoint of trading data of another investment target.

Since the trading data of the other investment object at the time of purchase, the trading data of the other investment object at the time of sale, and the trading data of the other investment object at the time of holding can be managed, it is possible to manage the trading data of the other investment object at the time of success, the trading data of the other investment object at the time of failure, and the like, it is possible to evaluate the trading tendency and the trading from the aspect of the trading data of the other investment object.

(Issues with Conventional Technology)

The trends of other investments usually need to be managed by themselves, but it is very cumbersome to know what the other investments produce in comparison to the investments they have purchased. The majority of cases are unable to manage other investments.

### (Effects of Evaluation of Other Investment Data)

At the time of purchase, we were able to select other investments, and if we were to select other investments, what would have been the result is one of the important information.

For example, if one month has passed since the time of the purchase of the A stocks on the TSE, the average of all the stocks on the TSE portion is a 5% increase, but the management is such that the A stocks are up 10% and the top stocks are up 30% for the B stocks.

### (Effect of Evaluation of Other Investment Data)

Recognizing that there was a better choice makes it possible to make the following lessons, to determine whether it was better than the average, and to compete and manage the skills of picking stocks.

### (Specific Examples of Evaluation of Other Investment Data)

In the 3-month 7% increase in trading data for investment product A, the average for the entire period was above the average because of the 5% increase, but the Z stocks were significantly above the 50% increase and ranked 500 out of the 2100 stocks on the TSE First Section. The addition of this kind of information adds an evaluation that is deeper than the evaluation of a mere 7% increase, and that is more in comparison with the others.

### (Definition of Evaluation of Other Investor Data)

By adding trading data of other investors as valuation indicators, the evaluation of the trading data can also be evaluated from the viewpoint of comparison with trading data of other investors.

Since the trading data of other investors at the time of purchase, the trading data of other investors at the time of sale, and the trading data of other investors at the time of holding can be managed, the trading data of other investors at the time of success and the trading data of other investors at the time of failure can also be managed, and the trading tendency and the trading evaluation of the trading can be made compared with the trading data of other investors.

(Issues with Conventional Technology)

Other investors usually have no reason to know, but it is difficult to know what other investors are doing compared to what they have sold or bought. However, this information is very useful if it can be used as a reference. In the past, it was not possible to know what other investors are doing while they are doing investment.

### (Effects of Evaluation of Other Investor Data)

One of the most important information is how other investors, as well as other investors, were willing to buy A when they bought A, and how they subsequently sold it.

For example, if one month has elapsed from the time of the purchase of a holding A on the TSE, under the data management, 100 people purchased the stock at the same time, but half of the shares were held after one month, and half of the shares were sold. Information such as the average value of the selling prices and how the owner will do in the future will become very important information.

To ascertain this, it is necessary to extract trading data having the same brand and purchase date. Even so, it is simple, but it has not provided such information so far.

### (Effects of Evaluation of Other Investor Data)

For the investment, the information on the purchased issue is more important than the information on the other issues. In particular, it is very important for investors who have purchased the same stock at the same time to decide what action they subsequently took, and it is useful to decide whether to sell or hold the stock. Especially, if the trading behavior of the excellent person is known afterwards, it is still more.

### (Examples of Evaluation of Other Investor Data)

From a large number of trading data, trading data that matches the purchase date is extracted, and the trading status and trading status of the trading data, trading status by type of investor, average profit/loss ratio, average holding period, average purchase quantity, and maximum price range of the trading data are found, which is very useful information for the buyer of the stock. Comparisons between the purchase date and the holding period, such as whether or not the stock had a larger price range than other investors with the same stock, can be used to evaluate the skills of buying and selling compared to other investors. Compared to a simple profit-and-loss ratio, a deeper evaluation is possible.

### (New Method of AI Machine-Learning Evaluation Process)

AI machine-learning assessment process is performed through the following process.

The second step is a process of creating trading data to be aggregated. The third step is the creation of component trading data (which may be omitted). The fourth step is a process of creating a profit/loss level valuation indicator (calculation of the target valuation indicators by the information processing system using three methods). By this third stage, the target profit and loss and the target trading data are determined. Extraction conditions, classification conditions, and aggregate conditions for trading data are also determined.

In the fifth step, valuation indicators that is a constituent element of the target profit or loss (such as total profit or loss or trades profit or loss) determined in the third step is calculated by the information processing system (can be omitted). The fourth stage may be included in the third stage or may be a separate stage.

By the fourth stage, the target profit/loss, target trading data (data structures created under various conditions), and valuation indicators that are variables are determined.

In the sixth step, in the evaluation process, machine learning is performed on the basis of the valuation indicators calculated by the information processing system, and the trading situation, the holding situation, and the like of the target are evaluated by an evaluation method in which an optimum solution is found (evaluation step).

It is the display step of this evaluation that the evaluation which is the optimum solution is displayed in an appropriate display method. Examples include tables, pie charts, constituent elements, ranking displays, comparison displays, and the like (see FIG. 77).

### (Assessment Process Issues)

In the evaluation process described above, there is a problem that there are many options for making it easy for anyone to use which trading data is used to determine which profit or loss is evaluated and which valuation indicators is used to evaluate.

In order to maximize the target profit and loss by taking a step from the evaluation process described above, the evaluation process evolves into an evaluation process by AI learning using machine learning by adding a process of storing the valuation indicators as a variable, a process of finding an optimum solution, and a process of displaying it.

By using trading data to determine the target profit or loss, we can learn which metrics to improve, and how to improve the valuation. We can learn that the valuation is inferior to other trading data. By displaying this learned outcome, AI pricing process will allow AI to find the optimal solution.

### (Effect of Evaluation Process)

In addition to the evaluation process described above, if the target trading data and the target profit or loss are decided, it will be possible to carry out transactions that bring them closer to the optimal solution by displaying how to learn which benchmarks should be optimized and how to change the changing benchmarks and benchmarks in order to improve and optimize the target profit or loss.

### (Significance of Evaluation Process)

In addition to the evaluation process described above, changing the metrics adds a process to learn how profits and losses change. There are a storage unit that stores the data, valuation indicators that is a variable, a target profit or loss, target trading data (trading data to be aggregated, component trading data extraction conditions, classification conditions, and aggregation conditions), a learning unit, and other methods, software, device, database structures, and learning methods that constitute a configuration.

### (Effect of AI Assessment Process)

By adding an AI process in addition to the evaluation process described above, it is possible to perform machine-learning on how to evaluate the target trading data.

### (Specific Evaluation Process of Specific Example)

### Example A

For example, if you want to improve Mr. A's overall profit and loss, you can create the trading data for Mr. A's aggregate, create the trading data for the overall profit and loss level (even if you have it in the previous process), use the valuation indicators that is a component of the overall profit and loss as a variable, and optimize with Mr. A's overall profit and loss as a target. In order to optimize, you can learn how to improve which valuation indicators. If the goal is to change the winning rate from the current 50% to 60% and change the winning profit rate from the current 4% to 5%, the trading profit of 1 million yen will increase with an 80% probability in one year. For example, some patterns are displayed, and a combination with a high probability and a large degree of change is targeted.

### Example B

For example, when it is desired to improve the trading profit/loss of the A brand, the trading profit/loss data of the A brand is collected by creating the trading data for the aggregate of the A brand and targeting the trading profit and loss level trading data. The information processing system calculates various valuation indicators that affect the trading profit/loss level data of the A issue, learns the effect of these various combinations on the trading profit and loss, learns the holding period of the A issue, the trading profit ratio, the trading profit ratio and the average holding period of the person who makes the maximum trading profit, and the like, learns the tendency of the person who makes the minimum trading loss to buy or sell, and when the person who makes the maximum trading profit buys the A issue, it is a specific example to display that the probability of successful purchase is high or the probability of successful sale is high when the person who makes the maximum trading profit buys the A issue.

### Example C

For A who is buying and selling using Twitter, the overall buying and selling data for the entire investor is created for each reference medium, and the aggregate profit and loss level buying and selling data is created for each reference medium (even if it has been brought to the previous process), which reference medium learns what kind of result, memorizes, and in the buying and selling using Twitter, the winning profit rate tends to be low, and the loss rate tends to be large, and the result is difficult to improve. In the buying and selling using the quarterly report, the winning profit rate is high, and it is easy to improve the result than Twitter, and it is also an example of how to improve which valuation indicators by combining valuation indicators.

### Example D

Based on the investment object table of the category of stocks of the vendor stock, stable growth stocks, and high growth stocks, the trading data by investment object is prepared, and the overall profit and loss level trading data is prepared, and the difference in each valuation indicators is learned. In the case where A is a stock in the category of the servant stock, by displaying information about the stock, it is possible to display what kind of cautionary note is required when purchasing A, and the number of people who have increased losses and greatly reduced funds.

### Example E

When preparing the trading data for aggregate by group A investors with high results with A, preparing a comprehensive profit and loss table, learning Mr. A's various valuation indicators, learning the various valuation indicators of group A, and evaluating the status of A's possession, group A can display the status of possession in this way, etc.

### (Definition of Evaluation Method)

FIG. 31 illustrates a difference between the overall images of the steps of the old method and the new method, and in the new method, the information generation unit 3021 creates the evaluation step after finishing the step of creating the transaction data to be aggregated.

FIG. 32 is a flowchart illustrating a method of evaluating a trading situation and a holding situation according to the present embodiment. There are the following five methods for evaluating an aggregate target by using the profit/loss level valuation indicators calculated by the information processing system based on the aggregation target trading data.
(1) Evaluation of Trading and Holding Status
(2) Evaluation of trading conditions
(3) Evaluation of holding status
(4) Assessment of interlocked holding status
(5) Assessment of Linked Trading and Holding Status

All of these can be similarly applied to evaluations using trading data to be aggregated for each period and evaluations using trading data to be aggregated for each investment target.

### (Old Method of Evaluation Step)

The trading profit and loss according to the first embodiment is an example of an axis for evaluating where the trading is problematic and where the trading is good. The principal increase/decrease rate according to the first embodiment is an example of an evaluation axis for performing and evaluating a comprehensive evaluation by combining the trading situation and the holding situation.

As described in the first embodiment, the evaluation axis is used as a starting point for evaluating the trading data. For example, the winning rate of return is given as an example of an evaluation axis, and is calculated by the information processing system from winning data obtained by classifying the traded data by “profit amount per winning/trading price per winning”. These valuation indicators are calculated by a formula of “total profit amount/number of wins”.

On the other hand, in the present embodiment, it is calculated by the information processing system from the trading profit and loss level trading data including the trading profit/loss ratio, the trading profit/loss amount per one time, and the like that are extracted (or classified, totaled, processed).

FIG. 33 is a diagram (processing the trading profit and loss level trading data of FIG. 26) illustrating an example in which the trading profit and loss level trading data according to the present embodiment is extracted (or classified, aggregate, processed). As can be seen from the comparison between FIG. 26 and FIG. 33, the period-based trading data created in FIG. 26 can be used as it is.

According to this method, as shown in FIG. 33, if the process of extracting (or classifying, aggregating, processing) the trading data to be aggregated by period in FIG. 26 is performed, it is possible to simplify the evaluation by period, and if the process of extracting (or classifying, aggregating, processing) the trading data to be aggregated by investment target is performed, it is possible to simplify the evaluation by investment target. In the old system, for example, it is difficult to calculate by the information processing system for each period of the A time point and the B time point. With the new system, all the data can be managed by the database, so that the individual numerical values and the sum numerical values can be freely processed and utilized.

### (Issues in the Steps of Evaluation to be Aggregated)

The problem of the old method is that it is impossible to make detailed evaluations by period, by investment target, or by valuing shares of Investor A in 2019. The evaluation process takes the following steps: Through the process of the second step (or the first step) of creating the trading data to be aggregated and creating the component trading data, the trading data to be worked is determined. In the fourth step and the fifth step, which valuation indicators is targeted is determined. It is possible to evaluate the target by using the trading data of the determined work target and the target valuation indicators (sixth step). By displaying these evaluations by an appropriate display method, the evaluation can be understood at a glance. It is not a mere enumeration of numbers, but is displayed in a suitable manner.

The evaluation step refers to the step of performing an evaluation in the evaluation process (see FIG. 77).

### (Effects of the Steps for Evaluation to be Aggregated)

The information generation unit 3021 calculates a profit/loss level valuation indicator by converting the trading data into the trading data for aggregate and further processing and extracting the trading data into the trading data for profit/loss level, and performs evaluation of the aggregation target using the valuation indicators. When the trading data is converted into the trading data to be aggregated, the purpose and the aggregation target are determined, and further, the trading data in accordance with the purpose is created by processing and extracting the profit-and-loss level trading data, whereby the valuation indicators is also simply calculated by the information processing system.

The first and second stages of the process are used to determine the data of trading. The third stage in which the buy and sell data are valued at what level of profit or loss determines which level of profit or loss the buy and sell data is valued at. Further, by calculating valuation indicators constituting the profit and loss by the information processing system, valuation indicators influencing the result of the profit and loss is calculated by the information processing system. With reference to the valuation indicators calculated by the information processing system, the buying and selling situation and the holding situation of the evaluation target are evaluated. This step is an evaluation step. These evaluations are displayed in an appropriate display method (display step). Depending on the series of flows, a target evaluation object, a target profit/loss, and valuation indicators related to the target profit/loss are determined and evaluated and displayed according to the valuation indicators of the target profit/loss of the evaluation object.

### (Effects of the Steps for Evaluation to be Aggregated)

By extracting (or classifying, aggregating, processing) buying and selling data by period, investment target, investor, and profit/loss level, buying and selling data according to the purpose is extracted (or classifying, aggregating, processing), and valuation indicators can be easily calculated by the information processing system, and a list can be displayed, which contributes to evaluation of the aggregation target. For example, in order to evaluate Mr. A's trading profit and loss in 2019, Mr. A's trading data is prepared, and Mr. A's trading data is prepared by using the fiscal as a component. As a result, the trading data of Mr. A for FY2018, FY2019, and FY2020 will be created (from the second step to the third step). To evaluate trading gains and losses, trade data below the trading profit/loss level shall be prepared for each of Mr. A's FY2018, FY2019, and FY2020. Of these, the amount of trading profit/loss (total value) of Mr. A in FY2019 is determined by creating trading profit and loss level trading data for FY2019. For example, if it is 1 million yen, this 1 million yen is the amount earned by various trade and selling in fiscal 2019. Mr. A's target of 1 million yen in buying and selling profit in fiscal 2019 is decided (from the second step to the fourth step), and how will it be linked to the improvement? This is the reason why he earned this 1 million yen in the next stage, and the decomposition factors, components, and various valuation indicators that are related elements, such as the principal (valuation amount in the beginning of 2019), the valuation amount at the end of 2020, the number of times of buying and selling, the winning rate, the winning profit, and the loss on trading profit, which are the reasons for generating the profit, are calculated by the information processing system (the fifth step). With the valuation indicators calculated by the information processing system, Mr. A's trading situation in 2019 is evaluated (the evaluation step in the sixth step), and Mr. A's trading profit of 1 million yen in 2019 can also be calculated by the information processing system from the trading profit data of Mr. A's trading profit in 2019. Therefore, among the trading profit of 1 million yen, the valuation indicators such as Mr. A's trading profit of 0.1 million yen and Mr. B's trading profit of 0.2 million yen can also be calculated by the information processing system, and by this evaluation, the trading situation becomes clear.

The trading profit of 1 million yen is performed in 10 trades, the winning rate is 60%, the winning profit is 1.3 million yen, the loss is 0.3 million yen, various valuation indicators can be calculated by the information processing system, it is possible to evaluate the trading profit of 1 million yen of Mr. A in 2019 by these valuation indicators (this step). At this time, these numbers may be enumerated, or these numbers and text may be combined into a sentence to be transmitted.

### (Specific Evaluation Step Specific Example)

The step-by-step valuation step allows for a variety of evaluations, such as the holding performance of Mr. A's entire stock in 2019, the evaluation of the current position of S's shares (such as how much they are buying on average), whether or not all of the trading stocks A, which rose significantly in 2019, were profitable or damaged, and how many of the people they have now.

For example, in order to evaluate the trading profit and loss in 2020 for A issues, the trading data for A stocks is compiled (the trading data for A stocks are compiled together with the trading data for A stocks, such as A, B, and C), and the trading data for A stocks is compiled using the fiscal as a component. As a result, trading data for the A issues in FY2018, FY2019, and FY2020 are generated (from the second step to the fourth step). To evaluate trading gains and losses, trade data below the trading profit/loss level will be prepared for each of the A issues in fiscal 2018, fiscal 2019, and fiscal 2020. Of these, the amount of trading profit/loss (total value) of A stock in FY2020 is determined by creating trading profit and loss level trading data for FY2020 (even if it can have it in the previous process). For example, if it is 50 million yen, this 50 million yen is the amount earned from various trades in FY2020 for the A issue.

In FY2020, A's trading profit of 50 million yen and evaluation target were decided (from the second step to the fifth step). How do you evaluate it? is the reason for earning this 50 million yen in the next step. The information processing system calculates the decomposition factors, components, and various valuation indicators that are related elements that generated trading profits, such as the number of trading transactions, the winning rate, the winning profit, and the loss on winning, using the information processing system (step 5). This is a process of evaluating the trading situation of the stock A in 2020 using these valuation indicators calculated by the information processing system (this step).

In this step, it is a step of bridging which valuation indicators to use and what expression to express. In order to accurately express the trading profit and loss of A issues in 2019, it is important to use which benchmark and determine what kind of expression to use. This is done in the fourth to sixth stages, but how to express the profit and loss easily to the user is done in this process.

It may be expressed in a sentence, a list of numbers, a graph such as a pie chart, a bar chart, or a chart, or may be expressed in a table.

For a stock's trading profit, a chart is suitable. When a brand is extracted or classified based on trading data or component trading data by investment target, the expression of the chart is accurate.

The price movement of A issues in the previous fiscal year of 2020 is expressed by a stock price chart, the buy/buy time is plotted, and the sell time is plotted (expressed by a point, an asterisk, or the like), and the average can be visually expressed as a display that the stock was bought and sold here.

Furthermore, based on the above-mentioned transaction data of stock A in 2020, if we use the investor as a component, we can divide stock A in 2020 into trade data for Mr. A and trade data for Mr. B, and so on. By using profit and loss as trading profit and loss and turning the number of trades into valuation indicators, it is effective to make clear at a glance who earned the most and how he earned it.

In 2020, A's trading profit is best represented by a pie chart to clearly show who earned the profit. The sixth stage process is that the earner chooses the right way to express the profit, such as the number of trades, the number of days held, the winning margin, the loss rate, and so on, in a hexagon, and which number is better than the average.

The combination of the trading data to be aggregated and the component trading data determines the trading data to be targeted. In the fourth step, the target profit or loss is determined. In the fifth step, valuation indicators that affects the profit or loss is calculated by the information processing system. The evaluation step of the sixth step is to perform various evaluations using the valuation indicators calculated by the information processing system. The display step of the sixth step is how to display the evaluation.

### (Definition of Evaluation of Trading Status and Holding Status)

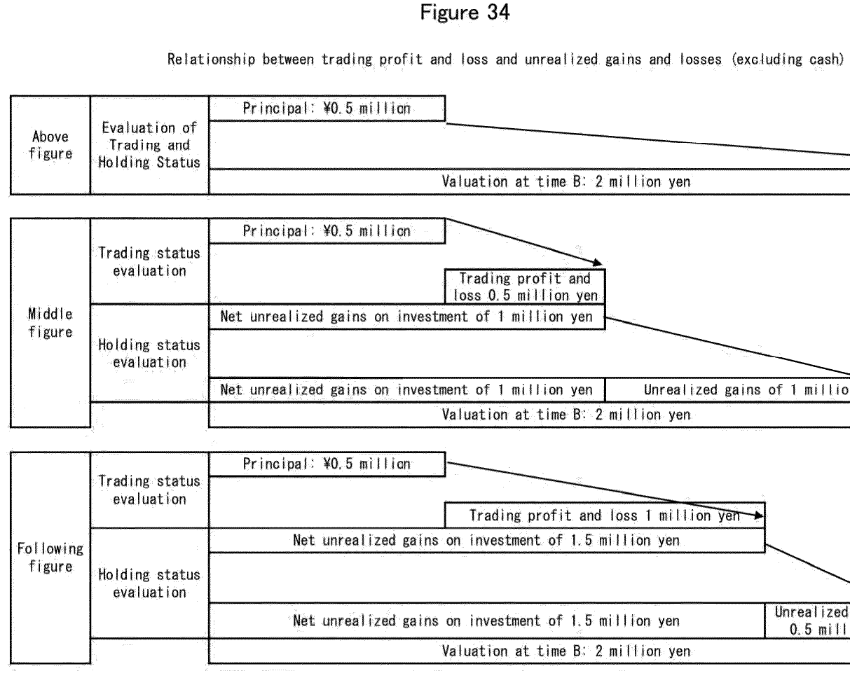

The step of evaluating the trading situation and the holding situation on the left-most side of FIG. 32 is the simplest because the step of evaluating the trading situation and the holding situation is not divided. That is, the step refers to an evaluation in which trading and holding are not divided, as shown in the top row of FIG. 34. FIG. 34 is a diagram for explaining how to separate the holding status evaluation and the trading status evaluation according to the present embodiment.

Based on the transaction data to be tabulated created in the transaction data creation step for aggregate, the information processing system creates the profit/loss level transaction data (even if it has been brought to the previous process), calculates the valuation indicators through the calculation step of the profit/loss level valuation indicators, and evaluates the holding status and the transaction status using the valuation indicators is defined as the holding status and the transaction status evaluation.

### (Problems for Evaluation of Trading Status and Holding Status)

In order to evaluate the aggregate target based on the aggregation target trading data, the profit and loss level trading data is extracted and created, a profit and loss level valuation indicators is calculated, and the trading status and the holding status of the aggregation target are evaluated using the profit and loss level valuation indicators.

In the old method, valuation indicators is calculated by numerical data. In the new method, valuation indicators is calculated based on the processed trading data. In the new method, for example, items such as a winning profit rate, a winning profit amount, and a trading period are added to the winning profit trading data, so that the valuation indicators can be easily calculated.

### (Effect of Evaluation of Trading Status and Holding Status)

The information generation unit 3021 extracts and processes the profit-and-loss level trading data based on the generated trading data to be counted through the step of creating the trading data to be counted, calculates valuation indicators through the step of calculating the profit-and-loss level valuation indicators, and evaluates the trading status and the holding status using the valuation indicators.

### (Effect of Evaluation of Trading Status and Holding Status)

By evaluating the holding status and trading status of the aggregate target, it is possible to evaluate the aggregation target.

### (Definition of Evaluation of Trading Status)

The step of evaluating the second trading situation from the left in FIG. 32 will be described. Based on the transaction data to be aggregated created in the process of creating the transaction data to be aggregated, the transaction data below the trading profit/loss level is extracted and created, the valuation indicators is calculated through the step of calculating the profit/loss level valuation indicators, and the transaction status is evaluated using the valuation indicators is defined as the transaction status evaluation.

### (Old Method)

As illustrated in the first embodiment, the advice generation unit 321 calculates valuation indicators such as a total trading profit/loss from the trading data.

### (Problems for Evaluation of Trading Status)

The second flow from the left in FIG. 32 is a diagram illustrating a procedure of the transaction status evaluation according to the present embodiment. The information generation unit 3021 evaluates the status of the aggregation target using the calculated valuation indicators.

Opposite trading has been conducted in the past, and the trading situation becomes the settled trading data. Various valuation gains and losses are calculated on the basis of the determined trading data, and the trading status of the target of the aggregate is evaluated using the valuation index. First, by evaluating the trading situation, it is possible to grasp the past results properly. In addition, since the past results create the current holding status, it is possible to evaluate them in time series by separately evaluating them.

### (Means of Evaluation of Trading Status)

As illustrated in the second flow from the left in FIG. 32, the information generation unit 3021 extracts and processes the trading data below the trading profit/loss level based on the trading data to be tabulated, generates the trading data, calculates valuation indicators through the step of calculating the profit/loss level valuation indicators, and evaluates the trading situation using the valuation indicators.

That is, the information generation unit 3021 of the server 30 acquires the trading data for investment commodity, creates the trading target trading data in which the trading data is aggregated for each criterion, creates the trading profit and loss level trading data related to the determined profit/loss using the trading target trading data, calculates the trading profit/loss level valuation indicators for evaluating the trading profit/loss from the trading profit and loss level trading data, and generates the information on the evaluation of the trading profit/loss of the investment commodity using the trading profit/loss level valuation indicators.

### (Effect of Evaluation of Trading Status)

By dividing the evaluation of the trading situation into the valuation by the holding situation, the valuation can be divided into the valuation by the holding and the valuation by the buying and selling, and the valuation which narrows the target becomes possible.

### (Specific Example of Evaluation of Trading Status)

In response to the aggregate of trading data for a variety of targets, such as A's trading status evaluation in 2019, August 2019's trading status evaluation of shares, the trading status evaluation of virtual currencies, the trading status evaluation of ETF by individual investors, and the trading status evaluation of investment trusts by individual investors in 2019, the trading status of various targets can be evaluated. This evaluation has the effect of knowing the situation of buying and selling differently than the actual price movement. In addition, it is possible to determine the actual state of useless rotational trading and whether or not trading is a justifiable reason.

### (Definition of Evaluation of Holding Status)

The third holding status evaluation step from the left in FIG. 32 will be described. Based on the trading data to be tabulated, trading data below the unrealized profit/loss level is extracted and created, and through the step of calculating the profit/loss level valuation indicators, the valuation indicators is calculated, and the holding status of the target to be tabulated is evaluated using the valuation indicators, which is defined as the holding status evaluation of the subject trading data.

### (Problems for Evaluation of Holding Status)

Holding that has not been countertraded consists of pending trading data that is currently in progress. Various valuation gains and losses are calculated based on the unconfirmed trading data, and the holding status of the target of the aggregate is evaluated using the valuation index. The untraded trading data are currently bound funds. It is necessary to separately evaluate the funds that are traded against each other in various ways.

### (Means of Evaluation of Holding Status)

The information generation unit 3021 extracts and processes the trading data below the trading profit/loss level based on the aggregate target trading data created by the creation step of the aggregation target trading data, calculates valuation indicators through the calculation step of the profit/loss level valuation indicators, and evaluates the holding status of the aggregation target using the valuation indicators.

That is, the information generation unit 3021 of the server 30 acquires the sales data of the investment commodity, creates the total target sales data in which the sales data is totaled for each criterion, creates the unrealized profit and loss level sales data related to the undetermined profit and loss using the total target sales data (even if it has been brought to the previous process), calculates an unrealized profit and loss level valuation indicators for evaluating the unrealized profit and loss from the unrealized profit and loss level sales data, and generates the information on the evaluation of the unrealized profit and loss of the investment commodity using the unrealized profit and loss level valuation indicators.

### (Effect of Evaluation of Holding Status)

By evaluating the holding status separately from the trading status, the evaluation can be divided into the evaluation based on the holding and the evaluation based on the buying and selling, and the evaluation can be more targeted.

### (Specific Examples of Holding Status Evaluation)

As shown in the top view of FIG. 34, when evaluating profit and loss data in which the principal is 0.5 million yen and the current evaluation amount is increased to 2 million yen, the information generation unit 3021 performs the evaluation of the sales profit and loss of 0.5 million yen and the evaluation of the unrealized profit and loss of 1 million yen separately as shown in the central view.

Gains and losses are fixed funds, and unrealized gains and losses are ongoing funds that fluctuate from day to day.

Conversely, as shown in the lower drawing of FIG. 34, even if the information generation unit 3021 increases from 0.5 million yen to 2 million yen, the selling profit/loss is 1 million yen and the holding profit/loss is 0.5 million yen, so that the meanings of the central drawing and the lower drawing are different from each other.

The valuation of trading conditions is carried out by valuation of trading gains and losses, and the valuation of holding conditions is carried out by valuation of unrealized gains and losses. This becomes clearer by incorporating the concept of net unrealized gains/losses-generating funds as an intermediary. The following are specific examples of funds for asset formation.

### (Significance Based on “Valuation at Start (or Principal)+Gain/Loss on Sale-Cash”=Unrealized Gain/Loss Fund)

In FIG. 32, the first step in the third holding status evaluation from the left is “Start valuation (or principal)+Gain/Loss on Sale-Cash valuation.”

The significance based on the starting valuation value (or principal)+trading profit or loss-cash, which also appears in the linked valuation, is to calculate the funds (unrealized profit or loss formation funds) that form unrealized profit or loss by the information processing system.

The middle and bottom example of FIG. 34 shows a simple case that does not include cash. The central diagram shows the case of 1 million yen in net unrealized gains/losses. The following figure shows the case of 1.5 million yen in net unrealized gain/loss formation fund. The central figure shows a higher evaluation of current unrealized profit formation. This is evident from the comparison of unrealized gains-making funds with current appraised values.

So what is the case including cash?

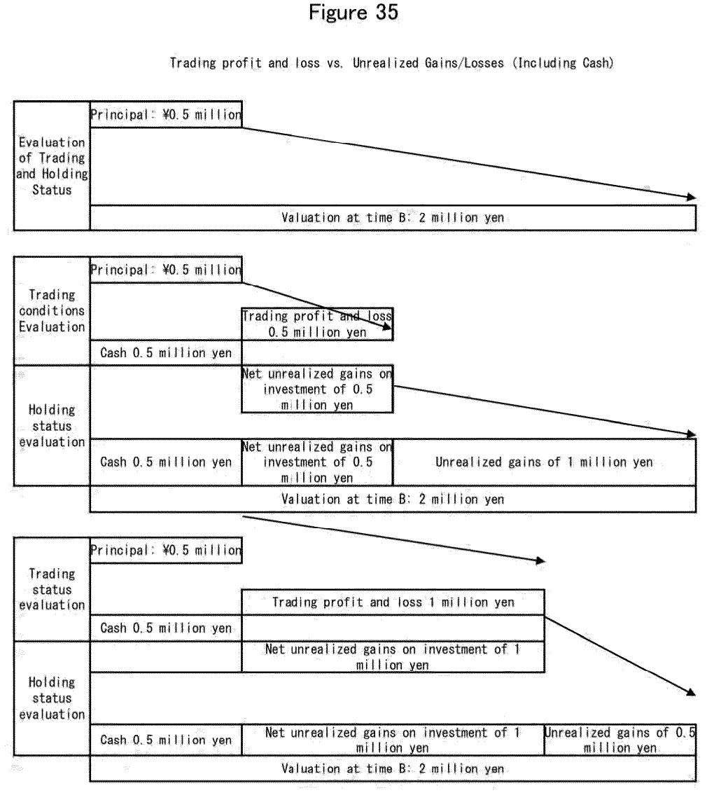

FIG. 35 is a diagram illustrating a relationship (including cash) between sales profit and loss and unrealized profit and loss according to the present embodiment. FIG. 35 shows the same result that 0.5 million yen is 2 million yen. FIG. 34, however, shows the case where 1 million yen is used for the fund to generate unrealized gains. The central diagram of FIG. 35 shows a case in which the net unrealized gain formation fund is 0.5 million yen. The former is 1 million yen, which is 2 million yen (double), and the latter is 0.5 million yen, which is 1.5 million yen (triple), indicating that the latter is superior in unrealized profit formation performance.

The latter was able to generate the same unrealized gains despite leaving cash. Thus, the valuation of unrealized gains and losses is better suited to models that include principal, gains and losses, and cash, allowing for a correct valuation.

Here, the principal is also replaced with the valuation value at time A. The principal is the principal (the principal's capital) that is invested in from the cash in hand. However, if the principal is evaluated from time A by period, the principal is evaluated at time A.

### (Net Unrealized Gains/Losses and Net Unrealized Gains/Losses in the Case of Sales Data by Period)

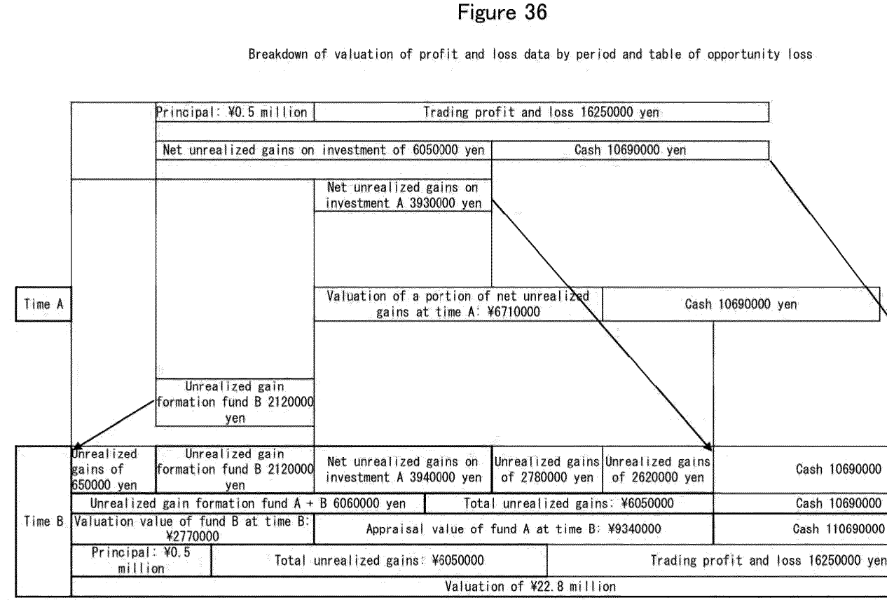

Net unrealized gains and losses are an important factor in assessing holding status. FIG. 36 is a diagram for explaining a breakdown of the valuation amount and an opportunity loss of the period-based profit and loss trading data according to the present embodiment.

In the term-based trading data, 6050000 yen of net unrealized gain/loss formation fund is divided into funds that continue to be held from time A (A3930000 yen of net unrealized gain formation fund) and funds that continue to be held at time B (B2120000 yen of net unrealized gain formation fund) purchased during AB term.

The net unrealized gains/losses are derived from the net unrealized gains/losses fund A and the net unrealized gains/losses fund B in FIG. 36.

The funds held from time A consist of unrealized gains and losses (in FIG. 36, ¥6710000 to ¥3930000=¥2780000) from time A. Therefore, the current inclusion and loss can be divided into three categories: the inclusion and loss before A (¥2780000 in FIG. 36), the inclusion and loss after A (¥2620000 in FIG. 36), and the inclusion and loss held at B (¥650000 in FIG. 36) purchased during AB term.

By evaluating the unrealized profit and loss formation funds that have been formed by each period, it is possible to evaluate each period, and thus it is possible to construct a more detailed evaluation model.

The valuation of trading profit and loss has already been completed based on the valuation of trading conditions, and this is the historical data. On the other hand, unrealized gains and losses as a result of the investment of unrealized gains and losses (as a result of increases and decreases in trading gains and losses) are funds that fluctuate on a daily basis with funds that have not yet been determined.

Cash and net unrealized gains/losses need to be evaluated separately from unrealized gains/losses. Cash is a product that does not produce profit or loss, and unrealized profit or loss is invested in a product that produces profit or loss, so another evaluation is necessary. Unrealized gains/losses level trading data will be valued except for cash, while an evaluation process will be required to leave the data in cash.

### (Calculate of a Cash Index (a Cash Level Index))

Cash does not generate profit or loss. That is why cash is valued by introducing the concept of opportunity loss. Opportunity losses represent fictional gains that were not profit by not having made a certain decision. The opportunity loss is calculated by the information processing system by multiplying the cash by the unrealized profit/loss ratio.

FIG. 36 is a diagram illustrating an example of a breakdown of an evaluation value of profit and loss data by period and a table of opportunity losses according to the present embodiment.

As shown in FIG. 36, cash of 10690000 yen may have increased by a factor of 2 if it was appropriated for the purchase fund (because of an unrealized profit of 6050000 yen and an unrealized profit of 6050000 yen and an appraised value of 12.1 million yen). 10690000 yen (=10690000 yen×100%) is calculated as the opportunity loss. It would be an opportunity loss that would have gained unrealized gains if invested without leaving cash. These are the information to be considered comprehensively in the holding status evaluation.

The first important step is how to evaluate this net unrealized gain-generating fund. In other words, it is the process of how to evaluate the investment products that are currently purchased. To put it flat, the process is how to evaluate the purchased stocks. This is referred to as the valuation process of the fund for the formation of profit and loss pictures. What information is associated with investment products in the information processing system? The investment commodity held is the purchased commodity. This includes the date of purchase, the issue purchased, the price purchased, and the like as transaction data, and if input in the input step, the reference medium (quarterly reports, twitter, etc.) at the time of purchase, the technical index value, corporate performance information, event information, brand information, brand news, and the like are linked (with a link in the step of creating the transaction data to be tabulated). Furthermore, since these pieces of information are linked after the purchase (because the date and the technical index value are related as well as the date of purchase, the time series information is stored in a separate table), a procedure for using all of these pieces of information is in place when evaluating the possession status. Therefore, the evaluation of the holding status is divided into a process of evaluating the unrealized profit and loss formation fund and a process of evaluating the past progress of the purchased product.

### (Significance of the Evaluation Process of Funds for Unrealized Gains and Losses)

Though it is difficult to say, the key points are the evaluation of purchased products and the evaluation of purchased brands. This includes evaluation of the purchased product itself and evaluation of the purchase time of the purchased product. Evaluation of the purchased product itself is how to evaluate whether the stock selection was correct, whether it was incorrect, or whether it was. The latter is the process of evaluating whether the timing of the purchase was correct.

(Issues with Conventional Technology)

The concept of evaluating whether the selection of the purchased product was correct is not very common. This is because I don't know how to evaluate. There are 3900 Japanese stocks alone, and there are very many options. From among them, the step of selecting is performed. You choose from a number of options, but if you don't evaluate whether it's wrong, you'll make a similar mistake. That's why this assessment process is becoming crucial, and if we can evaluate it correctly, PDCA will run around and optimize it.

### (Action of the Evaluation Process of Unrealized Gain/Loss Formation Funds)

To begin with, if we are limited to choosing Japanese stocks, how should we evaluate whether the selection of 3900 stocks was correct? In the information processing system, it is possible. This is because the data of the purchased commodity at the time of purchase and the various time series data are linked, and the various kinds of information on the purchased date are changed and fluctuated with the fluctuation of the stock price, but the stock price, the technical index value, the stock news, the business performance, and the like thereafter can be tracked in time series. In addition, this is true for other stocks. In other words, we can see how all 3900 issues have changed since the time they were purchased.

### (Effects of the Evaluation Process of Unrealized Gain/Loss Formation Funds)

When information is extracted for the sake of clarity, the historical history of the stock A at the time of purchase is shown in the chart. This is usually common information. At the same time, there is stock price information of 3900 issues on the back side, and information from the point of purchase can be extracted. We will first exploit this mechanism to determine whether the selection of A is correct. In addition, since the selection of the purchased products is related to the rate of soaring, the number of other brands, the average, and not only the stock price but also the company's performance, the changes in the company's performance after the purchase can be tracked. On the back, 3900 issues are all right.

In other words, the evaluation of the stock price hike rate after the purchase and the evaluation of the target company's performance by the change of the stock price hike rate after the purchase (it can be seen whether the selection of the issues with the increasing profit trend or the selection of the stocks with the decreasing profit trend, etc.) This means that all the elements are linked by the factors that determine the stock price and the time series data. However, if it becomes too complicated, it becomes difficult to understand, so first we evaluate the selection by comparing the simplest stock price data. If the rise and fall rate from purchase to the present is 2.5 times at 160 days, we are sufficiently pleased and satisfied if we are normal. However, in this information processing system, it is possible to evaluate whether or not the choice is optimal. In fact, the best result in the last five months was that it was three times that of Z stocks (ranked first in the 160-day period ranking), and on average, it was up by 10% during this period, and the choice of A stocks was in the fifth place among them, so it can be displayed. The stock selection verification chart (FIG. 103) defines this as the stock selection evaluation process (or the stock selection verification chart) of the fund for generating a profit or loss, and the process of evaluating whether or not the selection of the time is correct in the same way is defined as the purchase time evaluation process stock purchase verification chart (FIG. 104). This purchase date assessment is only 160 days in duration, and it is free to choose a purchase date. This is very different from a year ago, and it is unlikely to be extended because other stocks are constrained by funds. This 160-day period was 160 days, when the option at the time of purchase was free, because the stock was held in cash and it was possible to buy the stock at a better timing because the stock was held in A. It was 2.5 times as large as it would have been if it had been purchased 160 days ago, but if it had been 100 days ago, it would actually be a 30% gain. That is, the purchase time was 160 days ago, which means that the selection was almost the best. As a result, there are two types of asset formation fund evaluation processes: the stock selection evaluation process and the stock purchase time evaluation process. By evaluating these processes, it is possible to correctly evaluate whether or not the selection was correct and whether or not the purchase time was correct. This is the effect of the integrated processing by the information processing system. This is done for each holding. Since stocks are purchased at different times, it is correct to evaluate stocks that were held for one year in the order of the rate of decline for one year. Both the average and the top stocks change.

### (Specific Examples of the Unrealized Gain/Loss Formation Fund Evaluation Process)

### Examination Chart of Stock Selection (FIG. 103)

As illustrated in FIG. 103, the answer that the number of A stocks is the highest among those who purchased A stocks on September 10 is given. There are many options to buy on September 10. There are 3900 options for Japanese stocks alone. This is an epoch-making tool that can verify whether the choice of A among these stocks was right or wrong.

(Issues with Conventional Technology)

In the past, it was only necessary to judge whether or not the correct answer was obtained from the issue that was bought by determining whether or not profits were generated or losses were generated. This is because I didn't know how to evaluate it. There is a test of how this is compared with the Nikkei Average. But there are so many options for buying and selling individual stocks, and there are also options for buying and buying them every day (there is a freedom to change over immediately after selling). What is important in determining whether the purchased stocks were correct is what the other stocks were. It's a matter of choice, so of course. However, there is no system in the world to verify this. Why?

### (Effects of the Stock Selection Verification Chart (FIG. 103))

It was hard to derive from the vast amount of information. However, this can be simplified by utilizing the information processing system under certain rules. The procedure is based on the trading data for each type of investment on February 17, where “extraction conditions: investment products=shares, purchase date=September 10, and component trading data: issues.” This results in a summary of the stocks purchased on September 10 of the basic set of stocks. Later, if the information processing system is made to calculate valuation indicators of the hike rate by comparing the stock price on September 10 with the stock price on February 17, which is the base date, then the ranking of the hike rate of the other stocks in the holding period will appear in a short period of time, and if the selection is other than the selection of the relevant stocks, it is possible to actually experience what the result was.

### Effects of the Stock Selection Verification Chart (FIG. 103)

This also has an enormous effect. Stock selection is a long-standing problem for investors. At this point, the answer can be easily derived: what is the best choice? Of course, holding is not the only choice. In the previous example, the choice of holding for 160 days is the fifth place, but other investors have a glass of people who sell, replace other stocks, make a profit, and buy and sell in 160 days. Therefore, not only the stock selection verification chart, but also the information that big data such as buy and sell data can be displayed is deep when looking at it from various angles. Nevertheless, the invention relating to this selection can be said to be an epoch-making invention that breaks down a corner thereof.

### (Example of Verification Chart of Brand Selection (FIG. 103))

It is the stocks that make very large gaps in investment when they are purchased at the same time. Now that you have the right way to know how open it is, and if you have made a failed choice, that will really come out in numbers, so you have an incentive to improve it. As PDCA begins to run around, the impact on investors is not known.

### (Significance of Verification Chart of Brand Purchase Timing (FIG. 104))

As illustrated in FIG. 104, the stock price chart of the stock A includes information on the participants of the stock A. In particular, the chart shows how other investors who purchased A issues at the same time (here, September 10) took investments. 3500 investors (i.e., those who bought A issues on September 10) were aware of this information-processing system. Some investors have taken what they have done, some have sold it in a day, and some have held it for 160 days. We define the charts that can be seen at a glance as verification charts for when the issues were purchased.

(Issues with Conventional Technology)

In a typical stock price chart, there is information about the stock, but there is no information about those who are buying or selling the stock. The only way to learn about this is to collect fragmented information, such as bulletin boards and personal blogs. I don't know the actual investment behavior. However, the information processing system has a structure in which information on this issue and information on investors' trading are linked to the trading data of investors at the time of the purchase of the issue in an organic manner. This is an epoch-making technology that allows the investors who purchased the stock on September 10 of the stock A to understand their subsequent investment behavior.

### (Actions of Verification Chart of Brand Purchase Timing (FIG. 104))

In the information processing system, first, the extraction condition is set in the trading data to be counted for each investment target, and the extraction condition is set in “issue: A brand, purchase time: September 10”, and the constituent elements are counted for each investor. When the profit and loss level trading data is the overall profit and loss level trading data, a basic trading data set is created by the information processing system. If valuation indicators is made into a sale date, a holding period, a quantity sold, and a purchase price in the sale dataset concerned, the sale day, the holding period, the quantity sold, the purchase price for every investor totaled by the persons who purchased the issue A in September 10 are computed by the information processing system concerned, and the purchase amount, the sale amount, profit and loss, and the sale data without a sale day are made into the sale data in possession, and if a profit is computed by the information processing system concerned by the purchase amount of the investor under possession, the purchase quantity, the purchase unit price, and the market price of February 17, it will be based on these valuation indicators, it will become September 10 The information processing system can easily derive data from 3500 individuals who purchased A, 250 of which did not sell and formed unrealized gains, and the remaining 3250 individuals sold at an average selling price of 1250 yen, a mode price of 1050 yen, and a maximum selling price of 2300 yen. Since information sold at 2600 yen can be easily derived by the information processing system, the first-ranked Z can easily derive a verification chart of such a stock purchase timing by the information processing system.

### (Effects of Verification Chart of Brand Purchase Timing (FIG. 104))

It is worrying how other investors are buying and selling. So there is no way to know how investors who purchased the issues they bought in the same way as they bought them on the day they bought them. In this information processing system, it is an epoch-making system that can be seen, and it is a chart that enables investors to verify their investment behavior.

### (Example of Verification Chart of Brand Purchase Timing (FIG. 104))

In the information processing system, this can be done for all stocks, and the time of purchase can be changed. In the application, it is also natural that everyone is doing what is happening now with stocks that have already been sold and not held. It can be used for all investment targets that can be grasped by the trading data for each investment target, such as the entire stock and the entire virtual currency.

### (Significance of the Stock Investment Trend Chart for Other Investors (FIG. 105))

As shown in FIG. 105, the answer “You are the most important among those who bought stock A on September 10” comes out. In the information processing system, the number of persons who purchased the A brand on September 10 is 3500, and the number of persons who were processed by the information processing system remains in the storage unit 33. Utilizing that information, the actual trading records of those who bought the stock on September 10 are tabulated. This is why these numbers are calculated by the information processing system.

(Issues with Conventional Technology)

People who buy the same issues on the same day are very concerned about what investment behavior they have followed. However, in the prior art, it is very unknown. This information is not found in the world.

### (Effects of the Stock Investment Trend Chart of Other Investors (FIG. 106))

However, why can this number be calculated in the information processing system? First, the date of purchase is September 10, and the purchased stock is A, which is a simple and basic dataset. However, the components need to be investors, and they need to be tabulated. Then, the profit and loss level trading data is the first level trading data. If this is instructed to the information processing system, it is easy later. When ranked by the overall profit/loss ratio, the information processing system immediately calculates the first place and the fifth place. Since it is linked by the purchase date and the set of brands, it can also be put out in the chart. As seen in the table set, once the table set has been made to remember such conditions, the information processing system automatically calculates and stores this ranking every day. Naturally, the ranking will also change. This kind of visualization is necessary to make investments more sophisticated. Of course, all of the dates are possible for not only A, but also all of the issues.

### Effects of the Stock Investment Trend Chart for Other Investors (FIG. 105)

It has an enormous effect. For investors, they can see how people who have done the same things as those they chose have actually done, and they can examine how they are different from those who are successful. In fact, the visualization of investments can be said to be a major advance in technology. Especially, the linkage between the trading data to be aggregated and the component trading data is important, and this is a service that cannot be realized without this, and this is all a service derived from the consistency of the processing of the information processing system.

### (Example of Another Investor's Stock Investment Trend Chart (FIG. 105))

It can be used on all purchase dates for all stocks, so you can use it in many ways. When stocks go down, you can see what everyone is doing. Especially, the person who is good and always good is the target.

If you know how (see the Grouping section) is moving, it's very helpful.

### (Definitions of Other Investors' Stock Investment Trend Charts (FIG. 106))

This is a chart that shows how other investors have bought and sold A issues during the 160-day holding period of A stocks. Of the 12000 individuals who have sold A brands for 160 days in total, 80% of them are sold or purchased by the information processing system. They are not owned at present, and the average profit/loss ratio is 25%.

(Issues with Conventional Technology)

The behavior of information investors during the holding period for the same brand is now completely unlikely to be taken by other investors. It's because I'm worried about how I'm buying and selling stocks that I own, so I'm glad to see them on Twitter, bulletin boards, and so on. In this information system, it is possible to draw out the trends of other investors. This is one of them.

### (Effects of the Stock Investment Trend Chart of Other Investors (FIG. 106))

First, the extraction condition is set as “brand=A brand, purchase date=2020 Sep. 10 to 2021 Feb. 17” in the period-specific trading object data, and the component-specific trading data totaled for each investor is instructed to the information processing system (including automatic, administrator, and user input form), and a basic trading data set is created by the information processing system in the total profit and loss level trading data. If the valuation indicators is the date of sale, the quantity sold, the quantity purchased, and the purchase price in the transaction data set, the date of sale, the quantity sold, and the purchase price for each type of shareholder that was aggregated by those who purchased the issue A between 2020 Sep. 10 and 2021 Feb. 17 are calculated from the relevant information processing system, from which the amount purchased, the amount sold, the profit and loss, and the transaction data without the sale date are the transaction data held, and the amount purchased, the purchase quantity, the purchase unit price, and the current price of 2021 Feb. 17 are calculated using the relevant information processing system. Based on these metrics, the information processing system can easily derive data from 12000 users who purchased A issues from September 10 to February 17, of which 1500 have not yet sold, formed unrealized gains, and the remaining 10500 sold, with an average purchase price of 1550 yen, an average sale price of 1750 yen, and a mode purchase price range of 1600 yen. The information processing system can easily derive information that is sold at 790 yen for the first place T and sold at 2350 yen, so the information processing system can easily derive a verification chart of such a stock purchase timing.

### Effects of the Stock Investment Trend Chart for Other Investors (FIG. 105)

There are a large number of data that are derived for the first time in the information processing system, but this data is one of them. For investors, the period of holding A is the time when the funds were bound for the holding period. During that period, some people are doing good trading, while others are buying and failing at high altitudes. When this information comes out, it is inventions that lead to the visualization of investors and the dramatic change in investment behavior. In the information processing system, it is also possible to automate them, calculate them by form input, and display methods can also be displayed on a chart in such an easy-to-understand manner.

### (Example of Another Investor's Stock Investment Trend Chart (FIG. 105))

Since it is possible at all times of all of the issues, for example, it is possible to display the text as shown on the left of FIG. 106 in the information processing system, since all of these numbers are numbers derived from the database, if the text corresponding to the number is prepared (table set method), it is possible to display in the information processing system immediately.

### (Definition and Issues of Automatic Assessment of Holding Status)

In the holding status, there is a stock holding status (purchase data of investment products) (in the case of entering from selling, selling data). This transaction data includes the distinction of the issue (brand of the investment product), the unit price of the purchase, and the purchase date. Usually, these stocks are traded on the market, and are the transaction data of the result of selecting the stocks among the various stocks that can be purchased. If you choose different issues, your evaluation of your current holdings changes dramatically. That is, the market prices thereafter show different details depending on the issue. If the holdings are different, the valuation of the holdings will change depending on how they change. For example, assuming that A issues were purchased in May 2020 and held at the end of 2020, the market value of A stocks at the end of 2020 increased by 20%, which is reflected in the current holding situation. However, if the stock is S, the market value at the end of 2020 is 50 percent higher, and if the stock is Z, the market value at the end of 2020 is-20 percent. Assuming that the stock is A, the stock is not the optimal choice, so the evaluation is reduced, and this is reflected in the automatic evaluation step of the holding status.

### (Effect of Automatic Evaluation of Holding Status)

How will the above evaluation be realized? In addition to the selection of the stock A at the time of purchase, there were a variety of options. There are 3900 options for Japanese stocks. When you create a stock price table for these stocks, the horizontal axis shows the stocks, the vertical axis shows the dates, and the crosses show the day's stock price (from the low price of the stock on that day to the high price, either open or close, or other stock prices). Then, for issue A, we can refer to 500 yen in May 2020 and 600 yen at the end of 2020. Ranking the price of A stock prices and . . . 3900 stocks, and then looking for the rate of decline, we can rank the rate of decline. For example, if the top-ranking issues were the S stocks mentioned above, they might have enjoyed a 50% rise. Just changing the issues you purchase will change the performance in this case. This can be added to the evaluation. Among the 3900 issues, A stocks can be expressed in the order of 520, and in the case of the best choice, unrealized gains/possibles increase by this amount, and the overall profit/loss can be expressed in this amount.

It is possible to change the issues, but it is also possible to change the timing of the same stocks. For example, if the purchase of A was May 2020, but in July 2020 it would be higher and the profits would be weaker, it would be possible to evaluate this if there were a previous table. On Jul. 1, 2020, the profit margin of 550 yen was reduced by 50 yen, which is one of the benefits of early purchase. These evaluations are defined as the automatic evaluation of the holding status.

### (Effect of Automatic Evaluation of Holding Status)

In the case of investment products, if there is a market, there are many alternatives, and it is usual for investment results to change dramatically simply by changing issues. In addition, since there is a freedom to purchase at any time, the timing is also one of the options. It is possible to evaluate the selection of a stock, evaluate the timing, and evaluate the combination of both. For example, in the above-mentioned case, if the stock is S, not A, then it is possible to know whether the profit has changed, whether it is average, whether the selection at this time is correct or failed, why it is failed, and where to improve next.

### (Examples of Automatic Evaluation of Holding Status)

### Example 1

The information processing system displays, for example, the degree of improvement in profitability in the case of the best case (the selection of the S brand in the above description).

### Specific Example 2

The information processing system displays the difference in the amount of unrealized losses when the average case (the average fall rate of 3900 issues in the above description) is applied.

### Example 3

The information processing system displays the rank of the selection of the A brand out of the 3900 brand options.

### Example 4

The information processing system clarifies the difference between the technical indices at the time of purchase of the A and S issues, and asks the user to make the following.

### Example 5

At the time of the purchase decision, the information processing system displays the current status of the people who purchased the S brand by the group unit (such as the group of people who still hold the S brand) and indicates what the brand that the group currently holds is.

### Example 6

The information processing system indicates how much profit or loss is rising if all of the stocks in stock A are the best case (the stocks in stock B are the best stocks in July 2019).

### Example 7

The information processing system displays whether or not the case of the specific example 6 is an average case, how much order the user selects, whether or not the user makes a good judgment, and whether or not the user makes a bad judgment.

### Example 8

The information processing system indicates how much the profit/loss has changed when the best purchase time is selected and when the best selection is made by shifting the purchase time later. The information processing system displays the technical index value at that time and the technical index value at the time of actual purchase.

### (Automatic Evaluation of Trading Status)

The procedures for the automatic evaluation of the holding status are the same, and the evaluation at the time of sale as well as at the time of purchase is also added. However, the evaluation is based on the automatic evaluation of the holding status. Provided, however, that points specifically related to the automatic evaluation of the trading situation shall be added at any time.

### (Evaluation of Holding Status and Linking of Stock Information)

The process of evaluating the holding status is the valuation of the issues held, and has a role to link the current situation and the future, which are the result of past trading, and the future will change by changing the current situation. The trading results (trading data), which are the result of past trading, are linked to the issues currently held (held product data), and evaluation from both sides is important.

The issues currently held (held product data) are linked to charts, technical indicators, and business performance in the data for trading to be compiled, and are managed in the data for trading. From the trading data to the evaluation step up to this point, the date at the time of purchase and the purchased brand are linked. Therefore, the held products used in this holding status evaluation are also linked to technical index values, charts, and performance at the time of purchase, and they are updated daily to produce time-series data. In the process of creating trading data to be compiled, the trading data and the held product data are fully linked together, and they are also powerful in evaluating the holding status. The valuation indicators based on the trading data and the various indices based on the held product data are combined to exert a special effect.

This point will be described below.

At the stage of the trading data to be tabulated, the stock code and the technical index value are linked in the relationship between the purchased product and the purchase date. In addition, daily updates are made to the technical index values, daily updates are made, and stock price data is also updated. From the purchased stock price, the market price changes gradually and is refined every day. As a result, in the holding status evaluation screen, the change in the unrealized profit or loss and the association of the information on the held product are made, and when the link of the held product is clicked, the issue information and the brand news are linked.

As such, it is common information, but it is important that the diagnosis results of past trading data, comparison with other investors and stocks, ranking results, etc. are linked, and the information on purchased products and the results of past trading history and the current holding status form the present, and the important decision must be made whether or not the future will change.

In other words, the evaluation of the holding status must contribute to this. Subsequent diagnoses and advice are similar. First, it is important to evaluate the current situation.

Automated assessment of the ownership status of a firm is to capture information from other firms and compare it with other firms to provide new information to investors. It can be said that the provision of information is unique to the information processing system that can be performed because the purchase data and the brand information are linked.

### (Significance of Warning Signal Occurrence by Valuation Indicators)

The status of stocks varies from time to time. It is common for me to have overlooked something that was going down or that I didn't know because I was busy. These are watched and a warning signal is generated, and the information processing system is linked to purchase data, past failure profits, and the meaning of the warning signal is more particularly effective. Not only technical indicators, but also technical indicators can be used to improve problems in past trading histories and points that have not worked well. Therefore, it is possible to send warning signals by using the lessons learned from past failed cases. For example, it is possible to repeatedly make a mistaken judgment, and to issue warning signals when the pattern is visited again. For example, if you want to buy or sell 5 percent, but the historical trading data show that the average margin is small and the investor has been selling at a 5 percent rise, it would be very convenient to add the ability to tell what those stocks were after this 5 percent rise. In the past when we have sold stocks at a 5% rise,” he said, “the trend has been for the 5% rise to turn into a 15% rise if held for three weeks afterward. What shall we do this time? If it becomes possible to display the information as shown in “1.”, past history can also be utilized, and this information will be useful for decision making in buying and selling. Of course, since there are many real problems and histories different from those in the past, it is prohibited to judge only by this, but as one of the information, the information is provided only by the information processing system.

(Issues with Conventional Technology)

If a warning signal is associated with the stock price data, the same warning signal should be delivered to the person who holds it. However, the warning signal of the system is also associated with the past trading history, and the warning signal can be transmitted in combination with the information.

The technical indicators for brokerage firms, too, have the ability to signal and deliver e-mails, but they are generally not. They differ greatly.

### (Effect of Warning Signal Generation by the Evaluation Indicator)

The warning signal of the technical indicator is simple, and the information processing system can easily generate a warning signal when RSI of the purchased product becomes 80% or more, for example. In a further step, how do I use the past trading history to give a warning signal? In the valuation indicators calculated by the information processing system, which is the number of the fifth step, the average number of trading days and the average winning profit ratio are recorded daily. Referring to this, the average holding period of the investor is calculated by the information processing system, and it is easy for the information processing system to present it. If you sell the stock on average for three days and the turnover rate is higher, the average number of days to hold is 3 days. The average winning profit rate is 2%. If you hold the stock on 8 days instead of 3 days, the average has changed from 2% to 6%. If this situation can be communicated, it becomes a decision-making material. If the information is held on 8 days instead of 3 days, the result has changed because the information winning system that follows the change in the market value after the sale can easily be derived.

### (Effect of Warning Signal Generation by the Evaluation Indicator)

Of course, it is not possible to take all the warning signals generated from the past trading history. It is because it is usual that the movement is different from the past. However, it is possible to provide one powerful decision-making material. In addition, this information is provided only to the investor, and is a very valuable information because it combines the past trading data with the current holding status.

### (Examples of Warning Signals Generated by Valuation Indicators)

The key is KPI warning signal determined in the fifth step. In addition, since there are many valuation indicators calculated by the information processing system, they are appropriately selected.

In addition, KPI calculated by the information processing system from Mr. A's trading data is displayed in addition to the holding status assessment. KPI items are added to the evaluation of the status of the held product, and the actual profits are also managed, and whether the product is improving or not is deteriorating is communicated to the user, and when the held product falls below the purchase price, the improvement of the inclusion loss rate is urgently required to be reminded to the user, etc. to support the performance improvement.

### (Significance of Evaluation Using Trading Data Subject to Tabulation by Investment Target)

One of the information related to the holding status evaluation is a holding product. In the above example, the generated data generated by the information processing system is shown with a string of the held product and the purchase date, but the information processing system is also linked with various kinds of information, and one of the information processing systems is the trading data to be counted for each investment target. If the issues held are linked to the trading data to be counted for each investment target, it is possible to use the trading data to be counted for each investment target.

(Issues with Conventional Methods)

Traditionally, information about a held product is often linked to brand information. It is tied to corporate performance, charts, earnings forecasts, corporate overview, and brand news. How does this differ from what is tied to the trading data subject to aggregation by type of investment?

### (Effects of Evaluation Using Trading Data Subject to Tabulation by Investment Target)

This can be done by linking the “extraction conditions: issues=stocks held” in the trading data for each investment target and this information to the stocks held in the evaluation of the holding status. This makes it possible to extract all the information that appears in the trading data subject to aggregation for each investment target. In addition to corporate performance and charts, it is also possible to obtain a more detailed picture of the stock's status during the holding period by identifying the stock's win rate and how other investors are doing, whether investors purchased during the same period still hold the stock, whether the stock is superior or inferior to the average, and the trading data by period.

### (Effects of Evaluation Using Trading Data Subject to Tabulation by Investment Target)

Unlike just brand information, this makes a variety of judgement materials available. As a result of linking the behavior of other investors, the trading history of the investors, and the trends of other stocks in the period in question, information can be provided only by the information processing system with various withdrawals. All of this is a coherent, coordinated system, which can be said to have the effect.

### (Specific Example of Evaluation Using Trading Data Subject to Tabulation by Investment Target)

In addition to the above, all of the cases listed in the trading data subject to aggregate by investment target and the trading data subject to aggregation by period can be withdrawn here.

### (Definition of Assessment of Linked Holding Status)

The fifth flow from the left in FIG. 32 is the interlocked holding status evaluation, which is performed after the fourth trading status evaluation from the left. Assessment of interlocked holding status is defined as assessment of interlocked holding status because it is not separate from valuation of trading profit or loss but is interlocking.

In evaluating the holding status based on the trading data subject to aggregate, it is defined as an interlocking holding status evaluation of the trading data subject to aggregation that the trading data below the unrealized profit/loss level is processed, extracted, created, the valuation indicators is calculated by the information processing system in the valuation indicators calculation step, and the holding status of the trading data subject to aggregation is evaluated by integrating the valuation indicators and the trading profit/loss and cash.

### (Problems for Evaluation of Linked Holding Status)

As can be seen from the breakdown of the valuation value of 2 million yen at time B in FIGS. 34 and 35, the trading situation (the fourth trading situation valuation from the left in FIG. 32) where the counter-trading was conducted is the trading situation valuation that was conducted in the past at time B, and consists of the settled trading data. In addition, the upper and middle figures in FIG. 34 and the lower figure both have different implications, although the fund of 0.5 million yen is 2 million yen. Regarding the figure, the trading profit and loss is 0.5 million yen, the fund for forming the unrealized profit and loss is 1 million yen, and the unrealized profit and loss is 1 million yen. On the other hand, with respect to the following figure, trading profit/loss is ¥1 million, unrealized profit/loss formation fund is ¥1.5 million, and unrealized profit/loss is ¥0.5 million. The figure below shows that the results are better than the figure in the middle, although the figure below shows the difference in contents. In this simple example, the following figure shows that the evaluation of trading conditions is high, and the middle figure shows that the evaluation of holding conditions is high. The buying and selling situation is a historical accumulation, and the current holding situation is a simple diagram showing that it stands on the accumulation. In other words, in order to evaluate the holding status, it is essential to evaluate the trading status, which is linked to the evaluation of the linked holding status.

There is a change in the trading situation, and as a result, the profit-and-loss portion of the trading profit-and-loss portion increases or decreases the unrealized profit-and-loss formation fund, and the current holding situation of the target of the aggregate is established on the basis of the principal+profit-and-loss (case in FIG. 34)-cash (case in FIG. 35)(unrealized profit-and-loss composition fund). In the holding status evaluation (third from the left in FIG. 32) of the trading data to be aggregated, the trading status evaluation is arranged in parallel with the trading status evaluation, and the past trading and the currently ongoing holding status are processed side by side. On the other hand, in the linked holding status evaluation, it is possible to evaluate the ongoing holding status affected by the outcome of the trading status and the cash ratio. This difference is attributable to the difference that the former is the unrealized profit and loss level trading data and the latter is the interlocked unrealized profit and loss level trading data. In the former case, cash and trading gains and losses are not included in the trading data. In the latter case, cash and trading gains and losses are included in the trading data, and leverage effects and compounded interest effect indices are also included in the model (see the section on interlocking unrealized gains and losses level trading data). It is the cooperation which increases the control items in the interlocked unrealized profit and loss level trading data in the preparation stage of this trading data that can grasp the present holding status more accurately than the second stage. Normal portfolio analysis and lists of stocks held by securities companies are all the former, and the latter technology reflects the contribution of past gains and losses and the compounding effect. This is a very important technique for assessing the status of possession. It will now be described.

### (Effect of Evaluation of Linked Holding Status)

The concept of interlocked unrealized profit and loss level trading data is essential in explaining the interlocked holding status assessment. The model described in this section is easy to understand and will be reproduced. The simplest example will be described. Assuming that Mr. S's principal (1 million yen) has been invested 100% and has continued to rise and is tripled, if we look at the case where the profit is fixed here, the valuation amount is 1 million yen+2 million yen=3 million yen, and the total profit amount is 2 million yen and the principal amount is 1 million yen. On the other hand, the profit and loss formation fund is 0 because it was sold, and the money is 3 million yen, and it is 0 because it does not hold the profit and loss.

Next, if Mr. S spends 100% of the 3 million yen to buy the A issue and the A issue rose 10%, the total valuation amount would be 3 million yen+0.3 million yen=3.3 million yen, and the total profit would be 2.3 million yen and the principal would be 1 million yen. On the other hand, since the fund for the formation of unrealized gains/losses is 100%, the fund is 3 million yen and the unrealized gains/losses are 0.3 million yen (see S in FIG. 108).

On the other hand, even for the first time at the same price of 1 million yen, even if Mr. A, who has not yet made a profit, purchases the same issue of A at the same time, the total valuation amount is 1 million yen+0.1 million yen=1.1 million yen, and the total profit amount is 0.1 million yen and the principal amount is 1 million yen. On the other hand, since the fund for the formation of unrealized gains/losses is invested 100%, it is 1 million yen and the unrealized gains/losses are 0.1 million yen. At the same time, starting with the principal amount of 1 million yen, even if the entire amount of the principal is invested at the same time, Mr. S holds an Unrealized profit and loss of 0.3 million yen with an Unrealized profit and loss formation fund of 3 million yen, while Mr. A only has an Unrealized profit and loss of 100,000 yen with an Unrealized profit and loss formation fund of 1 million yen (see FIG. 109). Mr. S has a compounding effect, so even if the same 10% increase is made, it will increase by 0.3 million yen, and in terms of the principal, it will increase by 30%. On the other hand, Mr. A is still increasing only 10% from the principal (see Mr. S and Mr. A in FIG. 109). This is because the compounding effect is not effective. Here, the concept of net Unrealized profit/losses generating funds is effective. There is nothing else to increase in the snowman-style because of this increase in net unrealized profit-generating funds. In the comparison between Mr. A and Mr. S, the difference between ¥1 million and ¥3 million was made at some point, so the latter became more and more dominant.

Furthermore, in the case of margin trading, (principal+profit or loss-cash)×leverage ratio will be added to the model. The addition of leverage rates to one of the items further increases the compounding effect index. For example, if the leverage ratio is 1, the compounding effect index is 3 in the previous example of Mr. S. However, assuming that Mr. Z multiplied the leverage by 2, the net Unrealized profit/losses formation fund is 6 million yen, which is 2 times the net Unrealized profit/losses. 10% of 6 million yen is 0.6 million yen (see Mr. Z in FIG. 109). The same increase in the number of A issues would result in A being 0.1 million yen, S being 0.3 million yen, and Z being 0.6 million yen (see FIGS. 109 and 88). A 10 percent increase in the same A stock would be more obvious because Mr. S had a compounding effect, and Mr. Z had a double leveraging effect and a double compounding effect, and these models would need to be introduced to evaluate the current holding status. This is the result of a leverage factor of 2 and a compounding effect index of 6. When this leverage effect is also added to the item, the effect of clarifying the principle of the lever and the actual state of the compounding effect is not known (for example, the difference in the notation as shown in FIG. 88 is an example).

The information generation unit 3021 extracts (or classifies, aggregates, and processes) the transaction data below the interlocking-type unrealized profit/loss level based on the transaction data to be aggregated and the component transaction data created in the creation step of the transaction data to be aggregated, creates the transaction data, calculates valuation indicators in the valuation indicators calculation step, and evaluates the holding status of the transaction target by integrating the valuation indicators and the transaction profit/loss and the cash.

### (Effect of Evaluation of Linked Holding Status)

The unrealized profit/loss formation fund is “the amount obtained by subtracting cash from the principal amount” when the start point starts with cash, and is “the principal amount+the profit or loss on trading-the cash” when the start point starts with the principal amount for a certain period of time (see the middle row of FIG. 35).

The unrealized profit/loss generating fund is based on the principal and the amount obtained by subtracting the remaining cash from the trading profit/loss from the start point, and indicates the purchase amount at the start point of the currently held investment product. This initial purchase price is better compared to the present for the evaluation of the holding status.

As shown in FIG. 36, this net unrealized profit-loss formation fund can be seen from various aspects, starting from the principal plus the profit or loss on sale (JPY 16250000) from the start point minus the cash (JPY 10690000) (the upper part of FIG. 36, JPY 0.5 million+¥16250000−10690000=JPY 6050000).

Unrealized gain/loss formation fund=purchase amount of the current held product after the time A+purchase amount of the current held product from before the time A (middle 6050000 yen=3930000 yen+2120000 yen in FIG. 36)

Inclusion-in-gain funding+Inclusion-in-loss+Current assessment amount (Lower 2770000 Yen (2120000 Yen+650000 Yen)+9330000 Yen (3930000 Yen+2780000 Yen+2620000 Yen)+10690000 Yen=22.79 million Yen in FIG. 36)

(Principal+cash+unrealized gains and losses+current valuation amount(¥0.5million+¥16250000−¥10690000)+¥6050000(¥650000+¥2780000+¥2620000)+¥10690000=¥22800000)

In the above equation, the right term is the current situation, and the left term is the profit accumulated from the start. Unrealized gains/losses formation funds are held as a result of trading conditions, and can be evaluated in a time-series manner with respect to unrealized gains/losses formation funds based on the results of past trading conditions and the evaluation of the current holding conditions.

Unrealized gains and losses on valuation of holding status may vary depending on the status of trading gains and losses. In addition, since the effects of keeping cash in effect also arise, it is possible to evaluate the status of interlocked holdings more highly.

In addition, in the interlocked unrealized profit and loss level trading data, leverage effects and compounded interest effect indices have been added as management items (see the section on interlocked unrealized profit and loss level trading data), and the actual status of holding status can be clarified.

### (Specific Example of Evaluation of Linked Holding Status)

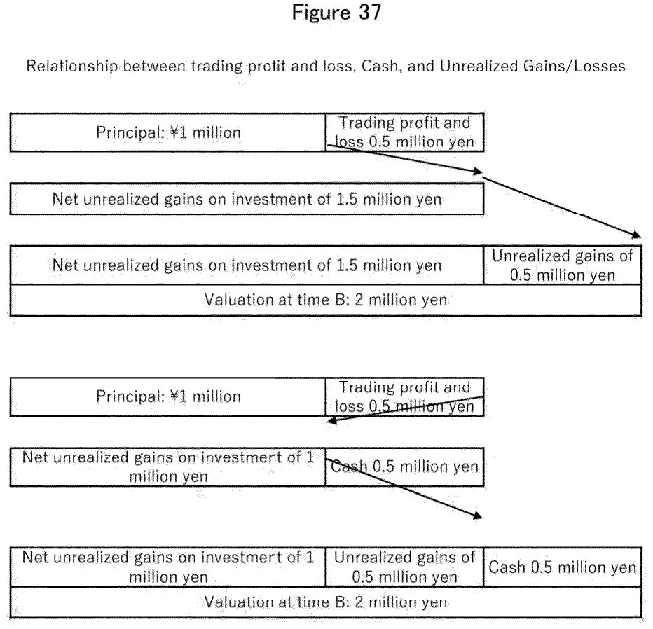

FIG. 37 is a diagram illustrating an example of evaluation of the interlock-type holding status according to the present embodiment. The information generation unit 3021, when evaluating the trading data whose principal is 1 million yen and whose current valuation amount (valuation amount at the time of B) is increased to 2 million yen, evaluates the trading profit and loss of 0.5 million yen, in which 1 million yen is determined as profit at 1.5 million yen, and evaluates the valuation of the current unrealized profit and loss of 0.5 million yen, which results in increasing the unrealized profit and loss formation fund of 1.5 million yen, which is the increased fund, to 2 million yen, separately. The effect of including the compounded interest effect in the valuation model is large, clarifying that the formation of unrealized profit or loss comes from the result of trading profit or loss.

On the other hand, in the lower part, when the principal is 1 million yen and the current valuation amount (valuation amount at B) is increased to 2 million yen, the result is the valuation of sales profit and loss of 500,000 yen, in which 1 million yen is determined as profit at 1.5 million yen, the valuation of 1,000,000 yen in unrealized profit and loss formation fund is increased to 1,500,000 yen, and the unrealized profit and loss is increased to 5,000,000 yen, and the remaining cash is 500,000 yen.

Including all cases, profit is 0.5 million yen, sales profit is 0.5 million yen, valuation amount is 2 million yen, and revenue is 1 million yen. This is a concrete example in which the ownership situation evaluation (the former is the profit formation including Y 0.5 million yen with the fund of ¥1.5 million yen and the latter is the profit formation including Y 0.5 million yen with the fund of ¥1 million) changes depending on whether the cash is sandwiched or not.

The same applies to linkage-type comparison, linkage-type ranking, linkage-type diagnosis, and linkage-type advice of transaction data to be aggregated.

### (Definition of Linked Evaluation)

When the buying and selling situation and the holding situation are evaluated based on the buying and selling situation and the holding situation, in 11, the buying and selling data below the buying and selling profit level is extracted (or classified, aggregate, processed), the valuation indicators is calculated in the valuation indicators calculation step, the buying and selling situation of the totaling target is evaluated, and the buying and selling data below the linked unrealized profit and loss level is extracted (or classified, totaled, processed), and the valuation indicators is calculated in the valuation indicators calculation step by the information processing system, and the holding situation of the totaling object is evaluated based on the valuation indicators, the profit and loss on sale, the cash, the leverage effect, the compounded effect index, and the like, which is defined as the linked evaluation of the buying and selling data to be totaled. Note that it is also essential to understand the data on the level of unrealized gains and losses linked to the valuation of the holding status linked to each other. See these sections as well.

### (Net Unrealized Gain/Loss Formation Fund)

FIG. 36 is a diagram illustrating an example of an interlocking evaluation of transaction data to be aggregated according to the present embodiment. The unrealized gain/loss formation fund is the stock price at the time of purchase (the purchase price of the currently held stock). As shown in FIG. 36,

6050000yen(net unrealized gains/losses)=¥3930000(Unrealized gain-loss formation fundA)+¥2120000(Unrealized gain-loss formation fundB)

3270000yen(Increased unrealized profit fromA)=2.62million yen(=933−671)+650,000yen(=277−212)

### (Problems of Linked Evaluation)

The trading situation in which counter-trading has been conducted consists of trading data that has been conducted and determined in the past. As a result, gains/losses on trading increased or decreased from the initial valuation, and the current holding status is established based on the “initial valuation+gains/losses on trading-cash.” In the method of evaluating trading data subject to aggregate of the old method, the past trading status and the currently ongoing holding status are processed side by side.

### (Effect of Interlocking Evaluation)

The information generation unit 3021 generates the trade data below the trade profit and loss level extracted (or classified, aggregate, processed) based on the trade data to be counted, and the component trade data created in the trade data creation step, calculates the trade data below the trade profit and loss level extracted (or classified, totaled, processed), calculates the valuation indicators by the information processing system in the valuation indicators calculation step, evaluates the trade situation to be counted, and refers to the trade data below the interlocked unrealized profit and loss level based on the trade data to be counted, calculates the valuation indicators by the information processing system in the valuation indicators calculation step, and evaluates the holding situation of the target to be counted by integrating the valuation indicators, the cash, the trade situation evaluation, the leverage effect, the compounded effect index, and the like.

### (Effects of Linked Evaluation)

Evaluation of past trading conditions and of current holding conditions datum on the resulting funds can be made in time series. To evaluate the holding status, not only the valuation of unrealized gains and losses, but also the status of the trading gains and losses from which the unrealized gains and losses were generated, and the cash status, leverage rate, and compounding effect index, etc., are highly related to the current status. These are not separate, but interlocking, so that interlocking evaluation can be performed more highly.

### (Unrealized Gains and Losses Vary Depending on the Status of Trading Gains and Losses and the Status of Cash.)

The present valuation can be seen from various aspects. FIG. 36 is a diagram illustrating the configuration. The valuation of ¥22.8 million is viewed from the viewpoint of principal and profit (1) and the current holding status (2)

### Case of Assessment of Current Holding Status at Start of Principal

(1) 22.8 million yen (current valuation)=0.5 million yen (principal)+16250000 yen (gains and losses)+6050000 yen (unrealized gains and losses)
(2) 22.8 million yen (current valuation)=6050000 yen (fund for formation of unrealized gains and losses)+6040000 yen (unrealized gains and losses)+10690000 yen (cash)
(3) 22.8 million yen (current value)=45.6 times the principal (0.5 million yen)

Therefore, it is necessary to evaluate not only unrealized gains and losses, but also how many times the principal is, how much cash is left, how much gains and losses are valued, and how the gains and losses are related to unrealized gains and losses. In other words, in order to evaluate the current investment status, principal, gains/losses on trading, cash, and unrealized gains/losses are influenced. Therefore, these models must be incorporated.

### (Specific Example of Linked Evaluation)

When valuing trading data whose principal is 1 million yen and whose current valuation value is increased to 2 million yen, the valuation of trading profit/loss of 0.5 million yen, in which 1 million yen is determined as profit at 1.5 million yen, and the valuation of current unrealized profit/loss of 0.5 million yen, in which the increased fund of 1.5 million yen is increased to 2 million yen as a result of trading profit/loss, are divided, and the effect of including the compounded interest effect in the valuation model is large by clarifying that the formation of unrealized profit/loss comes from the result of trading profit/loss.

On the other hand, when the value of the company changed from 1 million yen to 0.9 million yen, the buying and selling profit/loss decreased from 1 million yen to 0.8 million yen at 0.2 million yen. However, if the profit/loss on holding 0.8 million yen is plus 0.1 million yen, it is possible to evaluate that the holding status is improving.

### (Specific Example of Linked Evaluation)

In the valuation process of FIG. 36, there are 16290000 yen in profit/loss on sale and 0.5 million yen in principal generated by the purchase amount of 6050000 yen and 11690000 yen in cash, and this profit/loss on sale is generated, so there is a valuation of the current holding status.

This is a valuation model that explains the compounding effect. This is discussed in detail in the interlocked unrealized gains/losses level trading data. By calculating the valuation indicators based on the interlocking unrealized profit and loss level trading data and grasping the current life status, the present evaluation can be appropriately performed.

### (Evaluation Display Step)

After the evaluation step of the evaluation process, it is called the display step of the evaluation.

By the sixth step, how and what to evaluate is determined, and therefore, the step of displaying the evaluation so as to be easy for anyone to understand is the display step.

### (Prior Art of Evaluation Display Step)

A simple list of valuation indicators is not easy for anyone to understand, but requires reading, habituation, and the power of others. However, in this step, in order to display in an easy-to-understand manner what to evaluate and what evaluation results have been obtained, it is necessary to select a display method according to valuation indicators and what to evaluate.

### (Definition of Evaluation Display Step)

In the evaluation display step, it is necessary to select an appropriate display according to the type and number of valuation indicators and according to the method of evaluation according to the target.

For example, the representation of a graph depends on the vertical and horizontal axes, a pie chart, a bar chart, and a line chart. The table and the horizontal axis also show different figures depending on the vertical axis and the abscissa, and the figures handled such as composition ratio, numerical value, average value, and total value are also different. In addition to display representations such as graphs and tables, textual representations may be used. In this case, it is important to display a combination of text and numbers. By appropriately linking the meaning of the numbers and the text, a persuasive expression is possible. Of course, these may be presented to the investor, or they may be presented as news or as expressions for an unspecified number. They need to change the text, the graph, and the bar graph according to the obtained evaluation result up to the evaluation process of the sixth step, and this step is used as the display step.

(Issues with Conventional Technology)

No matter how good an evaluation is, even if a bad evaluation is made, it is difficult to understand if the display is not made properly, and it becomes impossible to improve or move in a good direction by using the evaluation. This is the final step in the evaluation process, but with this display being appropriate, it is possible to appropriately understand the evaluation of the evaluation target, and to take steps for the next improvement.

### (Effects of the Steps for Indication of the Evaluation to be Aggregated)

By the step of the fifth stage of the evaluation process, the evaluation object is decided, and with what purpose and how to evaluate it is decided, and the trading situation and holding situation are evaluated by various valuation indicators calculated by the information processing system. At this time, the type of the transaction data to be aggregated, the type of the component transaction data, the type of the profit and loss, the number of the valuation indicators, and the like are determined, and the target is evaluated using these. There are various kinds of information, and the step which decides how to use which number and how to display by what display method based on the obtained information is the display step of the evaluation.

### (Effects of the Steps for Indication of the Evaluation to be Aggregated)

By displaying the evaluation in an easy-to-understand manner for the user viewing the display, the steps up to the sixth step are utilized, and a heterogeneous effect is exhibited.

### (Specific Example of Evaluation Display Step)

For example, in order to evaluate the trading profit and loss in 2020 for A issues, the trading data for A stocks is compiled (the trading data for A stocks, such as A, B, and C, are compiled together to extract only the trading data for A stocks), and the component trading data for A stocks is compiled using the fiscal as a component. As a result, trading data for the A issues in FY2018, FY2019, and FY2020 are generated (from the second step to the third step). To evaluate trading gains and losses, trade data below the trading profit/loss level will be prepared for each of the A issues in fiscal 2018, fiscal 2019, and fiscal 2020. Of these, the amount of trading profit/loss (total value) of A stock in FY2020 is determined by creating trading profit and loss level trading data for FY2020 (even if it can have it in the previous process). For example, if it is 50 million yen, this 50 million yen is the amount earned from various trades in FY2020 for the A issue.

In FY2020, A's trading profit of 50 million yen was evaluated (from the second step to the fourth step), and how to evaluate it is the next step, and the reason for earning this 50 million yen. The information processing system calculates, by the information processing system, decomposition elements, constituent elements, and various valuation indicators that are related elements, such as the number of trading times, the winning rate, the winning profit, and the loss, which are constituent elements, which are the reasons for generating the trading profit (fifth step). This is a process of evaluating the trading situation of the stock A in 2020 using these valuation indicators calculated by the information processing system (this step).

These steps are the bridging steps of which metrics to use and what to express. For example, in order to accurately express the trading profit and loss of A issues in 2019, it is important to decide which benchmark to use and what kind of expression to use. The fourth to sixth steps are performed, but how to make a user-friendly representation is performed in the display step of the evaluation process.

It may be expressed in a sentence, a list of numbers, a graph such as a pie chart, a bar chart, or a chart, or may be expressed in a table.

### (Specific Exemplary the Specific Example)

For a stock's trading profit, a chart is suitable.

The price movement of A issues in the previous fiscal year of 2020 is expressed by a stock price chart, the buy/buy time is plotted, and the sell time is plotted (expressed by a point, an asterisk, or the like), and the average can be visually expressed as a display that the stock was bought and sold here.

### (Specific Exemplary the Specific Example)

The price of A stocks in the previous fiscal year of 2020 is represented by a stock price chart, and the price of A stocks purchased at the lowest price is plotted, the average price is plotted, only the buying and selling of the stock is displayed, the buying and selling data of the average and the maximum price range is expressed in red, the range of the buying and selling advice is displayed for each adviser, and the average buying and selling range is displayed by changing the color for each securities company.

For example, when the unrealized gains and losses on A issues at the end of 2020 are displayed on a chart, the current value at the end of the year is 670 yen, the purchase price of A is 500 yen, the purchase price of B is 550 yen, the average purchase price is 600 yen, the purchase price of the highest price is 670 yen, the minimum purchase price is 480 yen, and the average holding period is 3 months. It is a very easy-to-see and easy-to-understand display method. In this case, the trading data to be aggregated is A stock in 2020, the component trading data is for each investor, the profit and loss is unrealized profit and loss, and the valuation index is unrealized profit and loss, the purchase price, the holding period, the average holding period, and so on. To evaluate this, the above chart is a clear and easy-to-understand display method.

### Specific Example 2

For example, if we use the trading data of A in 2020 as a basis and make investors as components, we can divide A in 2020 into trading data of A and trading data of B. By using profit and loss as trading profit and loss, and using the number of trades as a valuation index, we can make it clear at a glance who earned the most and how they earned.

The sixth-stage process is that the pie chart is suitable for a clear indication of who earned the trading profit of A in 2020, and the earner chooses an appropriate expression method, such as the number of trades, the number of days held, the rate of winning profit, the rate of loss, and so on, for each trader, and the average number for each investor, and which investor's number is better than the average.

The information processing system determines target trading data by a combination of the aggregate target trading data and the component trading data. The third step is to determine the target profit or loss. In the fourth stage, valuation indicators that affects the profit or loss is calculated by the information processing system. Various evaluations are performed using the valuation indicators calculated by the information processing system. The sixth stage is how to express the evaluation.

### Example 3

For example, if the evaluation process is a combination of trading data for which the period of each fiscal year is used as the component trading data, the aggregate profit and overall is used as the profit and loss level, and the valuation indicators is used as the evaluation value, the line graph format is used, and the horizontal axis is used as the year and the vertical axis is used as the evaluation value, so that the transition of the evaluation value every other year is clear and easy to understand.

### Example 4

The pie chart is easy to understand by calculating the composition ratio. The pie chart makes it easy to understand who gained the trading profit of the A issue, and the pie chart makes it easy to understand the trading profit of the A issue.

### Example 5

In the stacked bar graph, for example, the following case is known and the display method is used.

In order to evaluate the trading situation by creating the component trading data for each fiscal year with Mr. A's trading data, making profit and loss a winning profit, and making the valuation indicators a winning profit, the winning profit for each fiscal year is required by further creating the component trading data for each issue.

Along with the winning profits in 2020, 2019, and 2018 being made, for example, the composition of winning profits in 2020 is 30% for A stocks, 40% for B stocks, 20% for C stocks, and 10% for others. In 2019, D stocks accounted for 70% of the total, while other stocks accounted for 30%. The horizontal axis represents the fiscal, the vertical axis represents the profit, and the ratio of the profit to the stock, so that this can be expressed.

### Example 6

This is the sixth step, in which the percentages are displayed to express changes in the composition of the composition in an easy-to-understand manner, and the hexagonal graphs are used to express which valuation indicators are strong and weak, etc., and each evaluation target and valuation indicators is used separately.

### Example 7

In addition, in the case of trading data for investments, it is important to use charts in order to express them in an easy-to-understand manner. In this example, the fiscal and month and day are plotted on the horizontal axis, the stock price (four prices, closing prices, etc.) is taken on the vertical axis, the purchase date of the stock is plotted on the basis of the stock price chart, and the sale date is plotted to show how much the trading profit and the price range can be obtained. It is possible to clearly indicate at a glance whether it has been successfully bought or sold.

### Example 8

For example, in the case of evaluating the overall profit and loss by investment type, using investment type data as component sales data, the aggregate profit and loss ratio, the total loss and total loss composition ratio, and the valuation indicators, the total loss and loss by investment type of stock is 300 million yen, the day-tray type is 10 million yen, the swing-trade type is 50 million yen, and the middle- and long-term type is 200 million yen, which makes the horizontal bar graph one of the easy-to-understand expressions.

### Example 9

A's trading data is evaluated at each profit/loss level, and when A's evaluation is performed using aggregate profit/loss, trading profit/loss, unrealized profit/loss, trading profit/loss, loss, etc. as valuation indicators, it is suitable as one easy-to-understand expression method such as a bellows-type graph or a waterfall type.

### Text Example 10

For example, if you capture upwardly revised issues (issues with earnings that exceed forecasts) by EDINET or other means, and when any issue is a major update with sales of 50% from ¥10 billion to ¥15 billion, you might want to automatically distribute such texts to the users who own them (e.g., the Company announced a major upwardly revised forecast from ¥10 billion to ¥15 billion on November 10 at 15:00). (e.g., news) could be a mechanism for automatic distribution. This is an applied version of the automatic evaluation of the possession status. Of course, the same is true not only for the owner but also for distribution to everyone as news.

### Text Example 11: A Specific Example of Holding Status Evaluation

For example, the frequency of brand renewal of Twitter can be incorporated into the trading data, and a brand (brand renewal frequency increase) in which the attention of the individual investor has rapidly increased can be communicated to the user holding the brand.

### Text Example 12: A Specific Example of Holding Status Evaluation

When the technical index indicates that the stockholdings have a sense of overheating and are likely to fall, the stockholdings can be displayed with text data on the user terminal saying, “The stockholdings have a very high RSI of the technical index, and the rate of deviation from the 25-day moving-average line exceeds the percentage.” It is also possible to display text data on the user terminal that says This is also a form of holding status evaluation. Of course, the present invention includes not only a specific user but also a case where the information is distributed to everyone as news.

### Text Example 13: A Specific Example of Holding Status Evaluation

When rights information is updated (rights data in the trading data is updated) that a stock split is to take place in a stock you own, you will receive a notice stating “When” and “Name of stock” of the stock split has been announced. The content is the announcement of the scheduled date of the split and the two splits. After the “Scheduled Split Date,” the shares will be ex-rights and the number of shares will change from the “number of shares held” to the “number of shares split. The terminal can also display an indication of “I am a member of the group”.

### Text Specific Example 14: A Specific Example of a Holding Status Assessment

Special convenience is created for the holder by displaying a table that compares the technical measure of the entire virtual currency with the technical measure of the entire stock for the user holding the stock. This is because the holding status and the information on the investment target are linked. This is an example in which various kinds of information can be displayed on the terminal by linking the sales data with the brand information.

### Text Example 15: A Specific Example of Trading Status Evaluation

The holding status evaluation is an indication to be performed on the holding issue, and the trading status evaluation is an indication to be performed on the trading issue. For example, “Sold stocks may now, once again, be a buying opportunity. The moving average divergence is −20%, and other indicators are also showing a series of buy signals. I suggest you give it some consideration. It is possible to display text such as”. This is a specific example of the trade situation evaluation. It is also possible to provide information because information on the issue is linked to the trading situation (trading data on what was sold and when).

### Text Example 16

As a concrete example of the buying and selling situation evaluation, if there is a user who has a problem of increasing the winning profit ratio as valuation indicators and the winning profit ratio changes from 5% to 10%, in the case of AI in which the estimation that the buying and selling profit amount increases in a period of 1 million yen, a function of notifying the brand currently purchased by the user who has earned the winning profit ratio in the already sold brand can be added.

### (Old Method in the Comparison Process)

The comparison and ranking of the investor may be performed with reference to the valuation indicators calculated in the first embodiment, and information indicating the comparison and ranking of the investor may be generated as the valuation indicators. The comparison here refers to the comparison between the valuation indicators of the investor and the average value of the valuation indicators and the valuation indicators of the other investor.

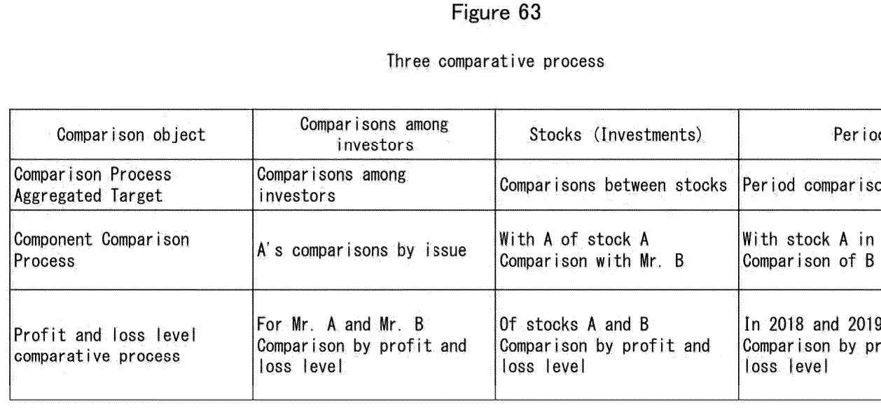

The new scheme has three comparison processes (aggregate comparison process, component comparison process, and profit/loss level comparison process) (see FIG. 63). FIG. 63 is a diagram illustrating three comparison processes according to the present embodiment.

### (Definition of Comparison Process)

The comparison process is performed through the following process, but the second step and the sixth step may be omitted.

The first step is a step of acquiring trading data. The second step is the step of creating transaction data to be aggregated. The third step is a step of creating the component-by-component sale data. The fourth step is a step of creating profit and loss level trading data. The fifth step is a step of calculating and selecting valuation indicators by the information processing system. The sixth step is an evaluation process (divided into an evaluation step and a display step). The seventh step is a comparison process (divided into a comparison of aggregated target trading data and a comparison of aggregated target trading data). The comparison process defines the comparison of the calculated metrics (alone or in combination) with an average or other aggregate or component.

The comparison process requires a comparison to be made, a comparison to be made, an index to compare, a profit or loss to be compared to improve which profit or loss, and a criterion to compare. It is important to determine these. When comparing the trading data of A and B, in the second step from the first step to the fifth step, the trading data of A and the trading data of B are classified into the trading data of A and the trading data of B, and in the fourth step, the respective trading profit and loss level trading data is created (even if it is carried in the previous step), and by calculating the valuation indicators which is an influencing element of the trading profit/loss respectively by the information processing system concerned, the comparison object is determined, the valuation indicators to be compared is determined, and it is determined that the trading profit/loss is improved, and all the above-mentioned conditions are compared by the criteria of A and B. The determination of these conditions is recorded in the storage unit 33 each time. By recording various comparison objects and various comparison methods, it becomes possible to use for AI and machine-learning. The comparison process consists of two comparisons of the aggregated trading data and the comparison of trading data by component depending on what is to be compared. Comparison between A and B is the former. Comparison between A and B is also the former. References to the Seasonal Report and Twitter is also the former. However, it is possible to compare the fiscal among the trades of A, compare the issues, compare the advisors, and compare the purchase data of RSI20% or less with the purchase data of moving-average line deviation rate of minus 20% or less using the technical index. For the entire investor, it is possible to compare the components only if they are the target of the aggregate and if they are the buying and selling of Mr. A. The deeper the valuation indicators is, the more the number of valuation indicators becomes, and the finer comparison is possible (comparison of profit/loss level valuation indicators). As described above, in the comparison process, there is a comparison object (what is compared with what), there is valuation indicators to be compared (at which level to be compared), which profit/loss is to be compared to be improved (which profit/loss is compared as an improvement target), and a condition (extraction condition in the transaction data to be aggregated or the like) on which the comparison is to be performed based on what criterion is required, and the comparison data (comparison object, extraction condition, and the like) generated in the comparison process is stored in the storage unit 33.

### (Problems of Comparison Process)

For investors, it is difficult to compare what is better than others, and where it is worse than the best-performing investors.

### (Action of Comparative Process)

Comparison is facilitated by following the process as shown in the definition of the comparison process. When comparing A's 2019 trading gains and losses with the 2020 trading gains and losses, a component comparison is appropriate to use the component trading data. To compare the aggregate gains and losses on A and B's shares, compare the trading data. What to compare with determines whether to use the Aggregate Comparison Process or the Component Comparison Process. When compared with the average, it is possible to compare the aggregate value with that of Mr. A in the component trading data, and the person who has the highest performance can calculate, show, and compare the maximum value of the valuation indicators by the information processing system.

### (Effect of Comparison Process)

In this comparison process, various objects can be compared using various metrics, and it is possible for the user to make a way to improve.

### (Specific Example of Comparison Process)

Comparison of the profits and losses of A and B, comparison of the winning profits of A and B in fiscal 2019 and 2020, comparison of the frequency of trading of A securities company and B securities company, comparison of the profit-loss ratio based on the advice of adviser a and adviser b, comparison of the transaction based on the quarterly report and the transaction based on Twitter from various perspectives, and comparison of the frequency of trading of A and B issues, the profit-loss ratio, the winning ratio, etc., can be considered from various viewpoints.

As shown in FIGS. 101 and 102, if various conditions are added in FIG. 101, a data set according to the purpose is created, the necessary valuation indicators is calculated, and the valuation indicators according to the purpose is calculated, so that it is possible to easily compare various conditions and various forms of valuation indicators in this step. This process is just one step in FIG. 102, but since the valuation indicators have been determined through a series of collaborations, it is possible to compare the many types of valuation indicators described in this specification and compare the many objects.

### (New Method of AI Machine-Learning Comparison Process)

AI machine-learning comparing process is performed through the following process.

The second step is a process of creating trading data to be aggregated. The third step is a process for creating component trading data (which can be omitted). The fourth step is a process of creating a profit/loss level valuation indicator (calculation of the target valuation indicators by the information processing system using three methods).

Up to this fourth step, the target profit and loss and the target trading data are determined.

In the fifth step, valuation indicators that is a constituent element of the target profit or loss (such as total profit or loss or trading profit or loss) determined in the fourth step is calculated. The fourth step may be included in the third step, or may be another step (may be omitted). Up to this fifth step, a target profit/loss, target trading data (data structure), and valuation indicators that is a variable are determined.

In the sixth step, the valuation indicators calculated by the information processing system is used as a comparison target, and a comparison target is determined by a comparison method in which a target comparison target is good, what is easy to understand, and which valuation indicators is compared among the comparison targets, and a machine learning is performed, and an optimum solution is found.

In the seventh step, how to compare these optimal solutions, the target to be compared, is displayed in an appropriate manner. Examples of the display method include an element, a ranking display, a comparison display, and a text comparison display.

### (Problems of Comparison Process)

In the comparison process described above, there are many choices to determine which comparisons are used, which profits and losses are compared, and which metrics are used. Therefore, there is a problem that there are a lot of options to decide, while anyone should make it easy to handle.

In order to maximize the target profit and loss, the comparison process evolves into a comparison process by AI learning using machine learning by adding a process of storing the valuation indicators as a variable, a process of finding an optimum solution, and a process of displaying the valuation indicators as a variable.

If the target profit or loss is determined by using the trading data, the optimum is learned by comparing which comparison object with which valuation indicators, and the inferior point is learned by comparing with the trading data of the comparison object. By displaying this learned outcome, AI compare process will allow AI to find the optimal solution.

### (Action of the AI Comparison Process)

In addition to the comparison process described above, if the target trading data and the target profit and loss are determined, in order to improve and optimize the target profit and loss, it is possible to carry out transactions that approach the optimal solution by displaying how to change the valuation indicators and the valuation indicators by learning which valuation indicators should be compared with which valuation indicators.

### (Significance of AI Comparison Process)

In addition to the comparison process described above, changing the metrics adds a process to learn how profits and losses change. There are a storage unit 33 that stores the same, valuation indicators that is a variable, a target profit or loss, target trading data (trading data to be aggregated and component trading data), a learning unit 34, and other methods, software, devices, database structures, and learning methods that have configurations.

### (Effect of AI Comparison Process)

By adding an AI process in addition to the above-described comparison process, it is possible to perform machine-learning on how to compare target trading data.

### (Specific Examples of the AI Comparison Process)

### Example A

For example, if you want to improve Mr. A's overall profit and loss, you can create the transaction data for Mr. A's total profit and loss level, create the transaction data for the total profit and loss level (even if you have it in the previous process), use the valuation indicators that is a component of the total profit and loss as a variable, and to optimize with the goal of improving Mr. A's overall profit and loss, you will learn which comparison object and which valuation indicators should be compared and which valuation indicators should be compared. “Mr. GA is the best candidate for comparisons, with GA's winning rate as the target, changing the winning rate from the current 50% to 60%, and changing the winning profit rate from the current 4% to 5%. In one year, the trading profit of 1 million yen will increase with an 80% chance,” suggesting that a number of patterns are displayed, with a high probability and a large degree of change as the target. Mr. ZZ also has different indicators, and the loss rate is similar, but the winning margin is as high as 20%, so it can be improved by learning how to buy and sell, how to hold long in the event of a win, and how to hold different issues.

### Example B

For example, when it is desired to improve the trading profit/loss of the A brand, the trading profit/loss data of the A brand is collected by creating the trading data for the aggregate of the A brand and targeting the trading profit and loss level trading data. The information processing system calculates various valuation indicators that affect the trading profit/loss level data of the A brand. The information processing system learns the effects of these various combinations on the trading profit and loss, and learns about the holding period of the A brand, the trading profit ratio, the trading profit ratio of the person who makes the maximum trading profit, the average holding period, the tendency of the person who makes the minimum trading loss, and the tendency of the person who makes the minimum trading loss to buy and sell, and the tendency of RA who makes the maximum trading profit. However, compared with XA who makes the maximum trading profit, it can be expected that the information on how to improve the buying method, the holding period, the selling method, the frequency, etc. and how to improve the A brand.

### Example C

For Mr. A, who is buying and selling using Twitter, we create component trading data for the entire investor by reference medium (even if it has been brought to the previous process), create aggregate profit and loss level trading data, and learn what kind of reference medium is the outcome, and store it. In buying and selling using Twitter, the profit-to-profit ratio tends to be low, and the loss-to-loss ratio tends to be large, and the results are difficult to improve. By learning the method using the quarterly report, the method of the result actor, the method of the chart actor, and the profit and loss indicators, and FA who buys and sells using Twitter, AI tells A that the performance actor is excellent as a comparative object, and it is possible to lead to the direction that the direction will change as much as possible by comparing with FA.

### Example D

Based on the trading data for each investment target based on the categories of stocks in the vendor stock category and the investment target tables of stable growth stocks and high growth stocks, the overall profit and loss level trading data is prepared, and the differences in the valuation indicators of the various investment targets of the various stocks are learned. If you get the learning results and the stock A is in the speculative category, HAS of the high-growth stocks will be the best comparator, and the winning and winning margins of the targets of HAS stocks will be higher than those of the stock A, and there is a presentation that gives you insight into the selection of stocks.

### Example E

When preparing the trading data for aggregate by group A investors with high results with A, preparing a total profit and loss table, learning the various valuation indicators of A, learning the various valuation indicators of A group, and evaluating the holding status of A group, if it is A group, the holding status can be changed in this way, and so on.

### (How to Generate Learning for AI Compare)

### (Purpose)

In which comparison object and which valuation indicators can be compared, it is learned whether the profit and loss which is the target can be improved.

### (Steps of how to Generate Learning for AI Compare Process)

The method includes a step of determining which profit/loss is to be improved, a step of calculating valuation indicators constituting the profit/loss by the information processing system, a step of calculating profit/loss that varies depending on a combination by a combination of the underlying sales data and the valuation indicators calculated by the information processing system, and a step of learning what kind of combination is to find an optimum solution. Compared with Mr. A and Mr. B, the index does not differ significantly and the frequency is different. Therefore, it is judged that the comparison object is not superior. In Mr. A and Mr. Z, the trading frequency is the same level, but the winning rate and the profit rate are high, and the comparison object is similar, but the overall profit and loss have a large opening, and it is optimal as a comparison object. In particular, by comparing the winning rate and the winning profit rate and further deepening them, various findings can be obtained. This is the optimal solution of the comparison object.

In order to raise Mr. A's overall profit-loss ratio, the theme is which comparison object should be used as a reference. Learn whether it is optimal or not to compare the overall profit-loss ratio of Mr. B, the values of the various valuation indicators that make up it, Mr. C's total profit-loss ratio, the values of the various valuation indicators that make up it, Mr. ZTT's total profit-loss ratio, and the values of the various valuation indicators that make up it. In particular, ZA can be expected to be most suitable as a comparative object, and by referring to the trading methods, issues, trading periods, etc., it can be expected that the path to the improvement will be clarified.

Even if there is not much discovery in the comparison between A and B, there are many commonalities in the comparison between A and ZA, and AI can judge that there are possible suggestions in the learning generation step of this AI comparison process.

### (Definition of Comparison Process to be Aggregated)

The information generation unit 3021 generates information on the comparison of the transaction status or the holding status between the data by comparing the transaction profit/loss level valuation indicators or the unrealized profit/loss level valuation indicators between the standards (for example, between the investment targets).

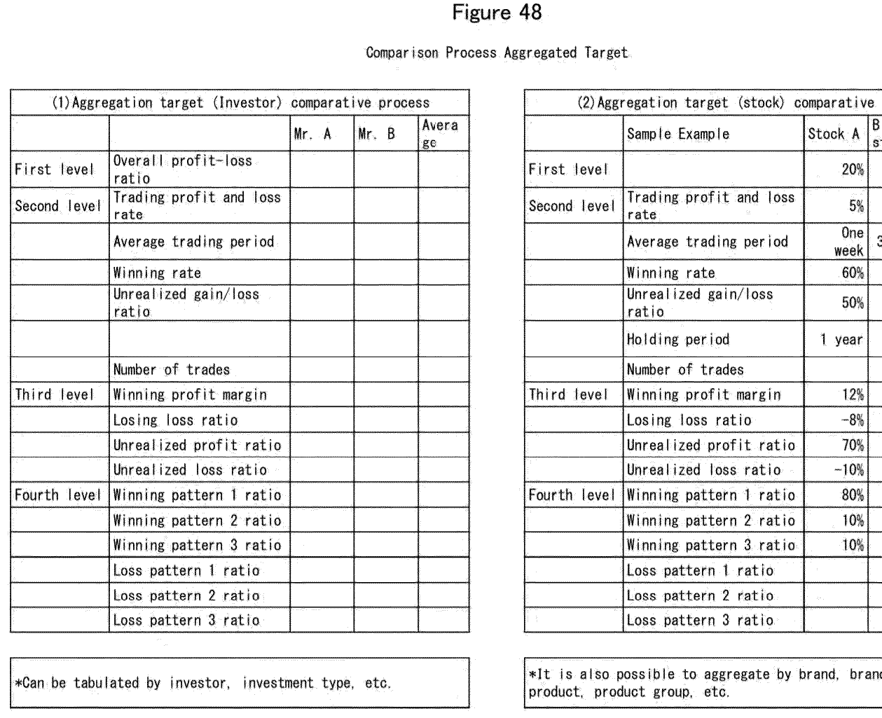

FIG. 48 is a figure illustrating an exemplary compilation comparison process according to the present embodiment. Depending on which target and what to compare, there will be a difference. Comparison between valuation indicators to be tabulated is a comparison process to be tabulated. Comparison between components is a component comparison process. Comparison using a profit/loss level valuation indicator is defined as a comparison of profit/loss level valuation indicators.

There are comparison of profit/loss level valuation indicators for aggregate and comparison of component profit/loss level valuation indicators.

First, the aggregate target comparison process will be described. The information generation unit 3021 calculates valuation indicators based on the aggregate target trading data, and compares the aggregation target with another aggregation target, an average, or the like using the valuation indicators. The comparison is to calculate various valuation indicators from the aggregate target trading data, and to compare the calculation target using the valuation indicators and the like obtained therefrom.

Comparison of the aggregate targets includes comparison using technical indicators, performance indicators, etc., but by comparing the tabulation targets using the valuation indicators obtained from the tabulation target trading data, it is effective in clarifying the differences in the trading conditions and holding conditions of the tabulation targets.

### (Specific Examples of Comparison Process Subject to Aggregation)

For example, when we compare the profit-loss ratio of A issues with the average, we can better understand the situation of A stocks.

As shown in FIG. 48, for example, when the profit margins of investor A and investor B are compared as shown in FIG. 48(1), there is an effect that the difference between buying and selling of both is clear.

Investor A has a 10% winning margin and Investor B has a 50% winning margin. Investor A has a short trading period of 20 days and earnings are fast. Investor B, on the other hand, can see that the trading period is as long as 75 days on average, and the profit determination is slow and large.

In addition, investor A has won 50 percent, which is a repetition of wins and losses. It settles in a short period of time, settles profit and loss quickly, and is an investment style that emphasizes the win rate. On the other hand, investor B has a low victory rate of 30%, but the profit margin at the time of victory is overwhelmingly high, indicating that the loss rate is suppressed.

The high number of winning patterns 1 implies a forward-looking investment and is evidence that security selection is not wrong. Conversely, the majority of winning patterns 3 come from the fact that the selection of stocks is wrong, and that they are trying to cover them in buying and selling. Also, as shown in FIG. 48(1), Mr. B compares each investor with a higher overall profit-loss ratio than the average and a higher profit.

Comparison of investment products for each aggregation target has an entirely new effect by comparing the aggregation target with other aggregation targets, averages, and the like using valuation indicators obtained from the trading data. The items to be tabulated include issues, groups of issues, products, groups of products, investors, and types of investments.

For example, it is possible to compare the unrealized profit-loss ratio between a product called a virtual currency and an investment product called a stock. Comparison of the aggregate targets by the valuation indicators has the effect of enabling comparison.

### (The Role of Comparison Process to be Aggregated)

The information generation unit 3021 calculates valuation indicators based on the aggregate target trading data, and displays a comparison result of the aggregation target using the valuation indicators.

### (Effects of Comparison Process to be Calculated)

The situation can be compared based on the comparison result of the aggregate object using various valuation indicators.

### (Specific Examples of Comparison Process Subject to Aggregation)

For example, as shown in (2) of FIG. 48, it is an example to provide a comparison result that the trading profit/loss ratio of the stock A is higher than that of the stock B.

Stock A has a high rate of unrealized gains/losses, and many of them continue to hold unrealized gains/losses. On the other hand, many B stocks report unrealized losses with an unrealized profit/loss ratio of −5%, and even if they hold them for six months, many do not have results. In particular, the unrealized profit ratio of A issues is extremely high at 70%, and it can be seen that the unrealized profit is significantly higher than that of those with an unrealized loss of −10%. For those who are willing to buy or sell stocks such as A in the short run, it is also useful to choose to hold stocks by experiencing the high unrealized gains of those who continue to hold stocks, and it is an opportunity to change the way they buy or sell stocks.

Comparison of the holding period of a person who has formed an unrealized gain and the holding period of a person who has formed an unrealized loss reveals more clearly. Every time the level falls (e.g., from the second level to the third level), more detailed comparisons can be made, allowing comparisons of investor and holding holdings and trading conditions to be made.

Of course, such comparison data between A brand and B brand is one of articles distribution data useful as an article. In this case, the article distribution data can be immediately utilized as the article data by extracting the article distribution data from the database by a process similar to the generation process.

### (Definition of Component Comparison Process)

A component comparison process is defined to compare the component-by-component metrics obtained from the transaction data to be tabulated. Comparison by constituent elements can be performed by extracting and processing the aggregates from the trading data to be tabulated, and comparing the data to be tabulated and each constituent element on the basis of various valuation indicators calculated from the created trading data for constituent elements.

### (Problems of Component Comparison Process)

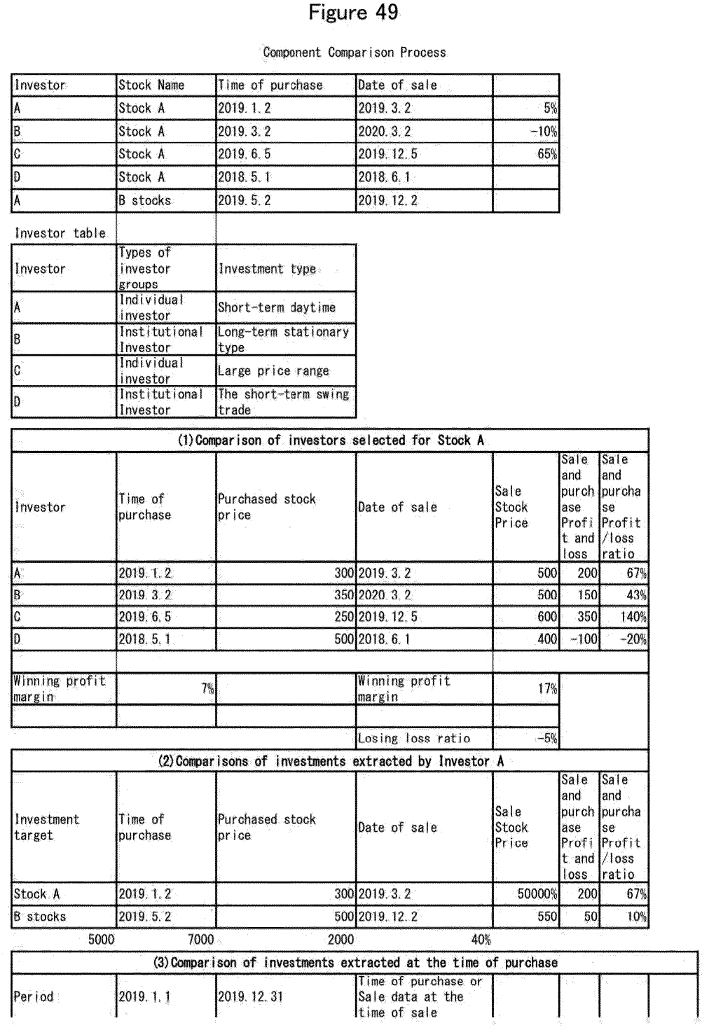

As shown in FIG. 49, in the comparison process, comparisons are made for each aggregate target, comparisons of valuation indicators between investors, comparisons of valuation indicators between stocks, comparisons of periods, and the like. In the component comparison process, it is possible to compare the trading status (example of (2) in FIG. 49) and the holding status of A and B. Comparison between A's 2019 and 2018 and between A's 2018 and B's 2019 is also possible. It is also possible to compare the trading situation of Mr. A's stock and virtual currency with the trading situation of Mr. B's stock and virtual currency.

### (Operation of Component Comparison Process)

The information generation unit 3021 creates the trading data to be aggregated, and creates the component trading data extracted and processed by the component. The information generation unit 3021 extracts, processes, and creates profit and loss level trading data from the component trading data, calculates a profit/loss level valuation indicator based on the trading data, and compares the valuation indicators for each component to be tabulated. This allows the components to be compared.

### (Specific Example of Component Comparison Process)

In the comparison process, a comparison is performed for each aggregation target. Although the comparison of the valuation indicators of A and B, the comparison of the valuation indicators of A and B, and the like (an example of (2) of FIG. 48), the information generation unit 3021 calculates the valuation indicators by dividing the aggregation target trading data of A into the component trading data of A-stock and the component trading data of B-stock (FIG. 49, (2)). For example, as illustrated in (1) of FIG. 49, the information generation unit 3021 divides the trading data to be counted for the A-brand stock into a constituent institutional investor group and a constituent individual investor group, and calculates valuation indicators. As shown in the type classification of [Embodiment 3], the comparison may be performed for each type. A process of comparing each component with the calculated valuation indicators is defined as a component comparison process.

### (Effect of Component Comparison Process)

By grasping trading data from multiple perspectives, such as trading data by investor and trading data by investment target, a deeper analysis is possible. For example, it is an example to divide Mr. A's trading data to be aggregated into stock component trading data and virtual currency component trading data, calculate valuation indicators respectively, and compare them with the calculated valuation indicators.

A good example is to compare Mr. A's trading data with the 2020 and 2019 profit and losses level indicators.

In addition, it is a good example to calculate and compare the trading data of A issues by dividing the trading data of the constituent components into the short-term trading-oriented investor type A and the medium-term trading-oriented investor type B.

We compare the data collected by Mr. A, which is divided into the component sales data of A brand stocks and the component sales data of B brand stocks. The aggregate trading data for the A issues is divided into an institutional investor group, which is a component, and an individual investor group, which is a component, to calculate and compare valuation indicators.

In addition, by combining (1) of FIG. 49 with the investor table, the aggregate trading data of the shares is divided into an institutional investor group as a constituent element and an individual investor group as a constituent element, and valuation indicators is calculated, and compared with the trading situation of each of the above constituent elements of the stock A. It is also possible in the component comparison process to compare the components for each aggregation target.

### (Definition of the Profit and Loss Level Index Comparison Process)

A profit/loss level valuation indicator is calculated from the transaction data to be aggregated, and the aggregate target or component is compared with other calculation targets, other components, averages, and the like by the valuation indicators. The comparison is to calculate a profit/loss level valuation indicator from the transaction data to be tabulated, and compare the aggregate target or the constituent elements using the valuation indicators obtained there. (FIG. 48 compares trading data for totalization with a profit-and-loss level valuation indicators)

### (Problems of the Profit and Loss/Loss Level Valuation Indicators Comparison Process)

Comparison of aggregate targets includes comparison using technical indicators, performance indicators, etc., and the above-mentioned comparison process. By comparing the calculation targets and components using the profit and loss indicators by level obtained from the calculation target trading data, it is possible to make multifaceted and multifaceted compares, and it has a special effect.

### (Specific Examples of the Profit-Loss Level Valuation Indicators Comparison Process)

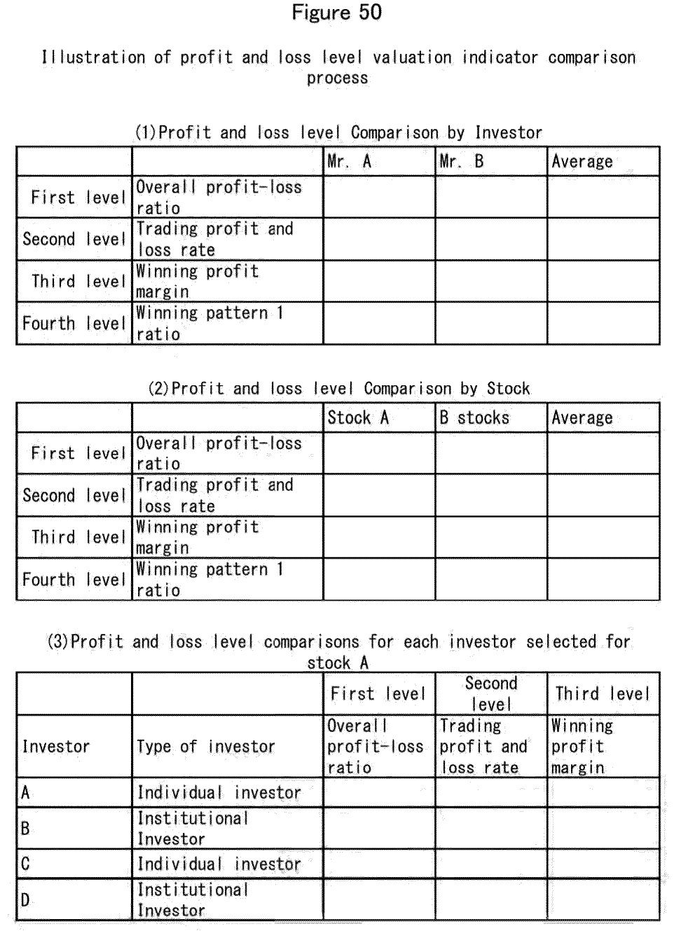

For example, when comparing the profit and loss of A and B, the difference is further highlighted by comparing them by level, such as the overall profit and loss level, the unrealized profit level, and the winning pattern level. When comparing the differences between Mr. A and Mr. B, and comparing the differences between this month and last month, the differences become more pronounced (see FIG. 50(4)).

Of these, the data that can be used as the article distribution data is, of course, comparison data for A and B stocks, and it is also useful as the article distribution data if it is data of all investors, even if the difference between this month and last month.

For example, a comparison of stocks in which a large number of people have unrealized losses and stocks in which short-term trading is highly profitable, and a clarification of profits and losses can have a major impact on how stocks are purchased and sold. In this case as well, it is mentioned as one of data for article distribution. Some examples below are similar.

For example, if we compare the level of unrealized gains/losses on A issues with the average profit/loss ratio on trading profit/loss levels, we can better understand the holding status and trading status of A stocks.

For example, by comparing the average winning profit margin of a good stock group with the winning profit margin of an A stock belonging to a good stock group, the characteristics of the A stock are further clarified.

For example, the difference between buying and selling and holding of investor A and investor B can be clarified by comparing the winning profit ratio, the loss ratio, and the unrealized profit/loss ratio.

For example, it is possible to compare the trading content and the holding state of a product called a virtual currency with an investment product called a stock. Comparison of aggregate targets with profit-and-loss level indicators has the effect of enabling multidimensional and multilayered compares. Furthermore, it is also possible to compare the respective constituent elements of the aggregate target, and to compare the respective constituent elements of the aggregation target.

As shown in FIGS. 48 to 50, the comparison of the investment products for each aggregation target or each component has an entirely new effect, for example, by comparing the aggregation target or the component with another aggregation target or other component, an average, or the like using the profit/loss level valuation indicators. For example, by comparing the unrealized loss ratio, trading frequency, trading profit ratio, and the like, it becomes possible to further grasp the target of the aggregate, the trading situation of the constituent elements, and the holding situation.

### (Effects of the Profit and Loss Level Index Comparison Process)

The information generation unit 3021 calculates a profit/loss level valuation indicator based on the aggregate target trading data, and displays a comparison result of the aggregation target or the constituent elements using the valuation indicators.

### (Effects of the Profit and Loss Level Index Comparison Process)

Based on the results of comparisons using various indicators at each profit/loss level, it is possible to compare the status of the market where the target of the aggregate is handled, the current owner, and the trading are conducted.

In addition, by comparing the items to be tabulated, the status of components held, and the status of trading using the profit/loss level valuation indicators, it is possible to compare the items to be tabulated and the status of components.

### (Specific Examples of the Profit-Loss Level Valuation Indicators Comparison Process)

For example, it is an example to provide a comparative result that stock A has a higher trading profit ratio, a higher unrealized profit ratio, and a higher short-term trading profit ratio than stock B. In this case as well, it is mentioned as one of data for article distribution. This is because it is the information that many investors need.

Mr. A has a higher-than-average trading profit rate and a higher-than-average unrealized profit rate. In particular, long-term issues have increased unrealized gains, and short-term trading yields are ranked fifth and significantly higher than the average. and so on, and comparisons are made on an investor-by-investor basis.

As described above, the aggregation target comparison process, the component comparison process, and the profit/loss level comparison process have been described, but these processes have the effect that a more detailed comparison result is obtained when the first level comparison to the fourth level comparison process is performed as described below.

### (Problems of Third-Level Comparison Process)

Comparison of aggregate targets or components includes comparison using technical indices, performance indices, and the like, and the above comparison. However, by further extracting the aggregation target trading data and calculating the valuation indicators in order to evaluate the overall profit and loss, a better comparison can be made to the aggregation target or component.

### (Means of the 3rd Level Comparison Process)

The information generation unit 3021 calculates various valuation indicators in order to evaluate the aggregate profit and loss of the aggregation target trading data, and compares the trading status holding status of the aggregation target or the constituent elements using the valuation indicators. This solves the problem.

### (Effect of Second-Level Comparison Process)

By comparing the status of the target or component using various indicators of aggregate profit and loss, it is possible to grasp the status of how the subject or component is handled in the market, and in the past year, whether the total loss is generated, whether the profit is generated, and how much the profit is. Comparison of these valuation indicators by the target or component highlights the trading characteristics of the target or component, and clarifies the results of comparison of the target or component with the various valuation indicators. Any trading of the target or component may be performed, and the holding status, trading status, and the like of the subject or component may be determined.

### (Specific Example of Third-Level Comparison Process)

For example, the overall profit/loss of A issues is +20% during this six-month period, and it is possible to understand A stocks more deeply by comparing them with B stocks by using the average purchase price, average profit amount, purchase amount, etc. In this case as well, it is mentioned as one of data for article distribution. This is because it is the information that many investors need. The difference between S1 shares and S2 shares can be very valuable if it is an article about something.

For example, for B stocks, the overall profit/loss is negative 5%, and the average purchase price and average loss are compared. Comparisons at the overall profit/loss level can be used to compare the overall profit/loss resulting from the trading or holding of the aggregate or component. Since the aggregate profit and loss includes both the trading data in the possession and the trading data, the total profit and loss status of the aggregation target or component is grasped, and the valuation indicators is calculated and compared, so that the overall view of the trading of the aggregation target or component can be grasped.

### (Second Level Comparison Process)

The metrics used at the trading profit/loss level include a trading profit/loss ratio, a purchase price, a sale price, an average trading period, an average buying/selling price, an average selling price, a trading quantity, and a winning ratio.

### (Problems of Third-Level Comparison Process)

Comparison of the aggregate profit or loss of an investment product includes the fixed profit traded and the unfixed profit, and therefore only the total comparison is possible. The comparison result obtained from the valuation indicators for the trading profit or loss can compare what kind of trading such as average trading price and trading price, and what kind of trading result is obtained, in addition to the winning ratio, trading profit-loss ratio, trading period, etc. which were not known by the overall profit or loss.

### (Means of the 3rd Level Comparison Process)

The information generation unit 3021 calculates various valuation indicators in order to evaluate the trading profit and loss of the trading data aggregated for each aggregation target or component, and compares the trading situation of the aggregation target or component using the valuation indicators.

### (Effect of Second-Level Comparison Process)

By comparing the status of the target or component using various valuation indicators of trading profit and loss, the trading status such as the average profit margin and holding period can be found as to how the target or component is handled in the market. Comparison of these valuation indicators by the target or component highlights the trading characteristics of the target or component, and clarifies the results of comparison of the target or component with the various valuation indicators. It is possible to determine what trading nature the target or component has.

### (Specific Example of Second-Level Comparison Process)

For example, stock A has a 5% trading profit-loss ratio, but the average holding period is one week with a high turnover force and a 60% win rate. On the other hand, for B stocks, the trading profit/loss ratio is negative 5%, the average holding period is 3 weeks, and the winning rate is 40%. Such comparisons are made at the trading profit level for each issue and for each valuation indicators. In order to compare the traded data, it is possible to grasp the trading situation of the issue, and it becomes possible to compare the stocks with a strong short-term trading orientation with the stocks with a long medium- to long-term holding period, and it becomes possible to know the stocks with a short-term trading orientation, the stocks with a medium- to long-term holding orientation, etc. through comparison results, etc. In this case as well, it is mentioned as one of data for article distribution. This is because it is the information that many investors need.

### (Problems of the Second Level (Unrealized Gains/Losses) Comparison Process)

At the overall profit/loss level, the state of holding and the state of trade and selling are mixed, so the state of holding and the state of buying and selling are not known in detail. Evaluation of the level of unrealized profit/loss shows the rate of unrealized profit/loss, the average holding period, the average purchase price, and the average profit amount.

### (Means of the 3rd Level Comparison Process)

The information generation unit 3021 calculates various valuation indicators in order to evaluate the unrealized profit or loss of the unsold trading data aggregated for each aggregation target or component, and compares the possession status of the aggregation target or component using the valuation indicators.

### (Effect of Second-Level Comparison Process)

Comparison of the status of possession of the target or component using various indicators of unrealized profit or loss indicates the status of possession of the subject or component, such as the status of possession of the subject or component. For example, the following comparison is possible.

Stock A has an average unrealized profit ratio of 50% (1.5 times), while Stock B has an average unrealized loss ratio of 5%, which can be compared with a smaller stock. The former has a one-year holding period, and the latter has a half-year average holding period, allowing comparisons at the second level of the various benchmarks. At this level of unrealized gains or losses, the status of holding the target or component can be compared.

### (Problems of the Second Level (Linked Unrealized Gains/Losses) Comparison Process)

The unrealized gains/losses comparison process described above compares unrealized gains/losses in different ways, rather than in conjunction with trading gains/losses. In practice, however, unrealized gains and losses are generated in conjunction with historical realized gains and losses, taking into account the effects of compounding and leveraging. Adding interlocking items to compare items results in an interlocking unrealized profit/loss comparison process, enabling a higher level of comparison.

### (Second Level (Interlocking Unrealized Profit/Loss Level) Comparison Process)

The information generation unit 3021 compares the unrealized profit/loss level comparison process with the interlocked items.

Effects of the Second Level Comparison Process (Linked Unrealized Gains/Losses Level)

For example, there is a problem of how to evaluate people who have made a lot of profits in the past and have made a lot of losses in the past and those who have made a lot of losses in the past, but now have a lot of unrealized gains.

Simply valuing at the unrealized profit/loss level, the latter is good, and the former is low. In reality, however, the present valuation needs to be high because the former is in a state in which the funds for the formation of unrealized gains/losses are sufficiently increased by increasing a large amount of profit and loss from the principal. Conversely, if the latter falls short of the principal amount and the situation improves a little, it will be inferior in comparison with the former.

Because unrealized gains and losses are linked to historical trading gains and losses, they can be compared at a higher level than historical gains and losses. Significance of Third-Level Comparison Process (Comparison of Winning Profit Level Indicators)

In the third level comparison, the information generation unit 3021 calculates valuation indicators at a winning trade level and a losing trade level (which is evaluated by dividing the winning profit and the losing loss from the already-traded data), and compares the valuation indicators with each other for each aggregation target or component.

### (Problems of Third-Level Comparison Process)

The second level of trading and unrealized gains/losses lacks an important factor in comparing winning and losing margins because of the mix of winning and losing.

### (Means of the 3rd Level Comparison Process)

The information generation unit 3021 calculates various valuation indicators for evaluating the trading profit and the trading loss from the trading data tabulated for each aggregation target or component, and compares the trading situation of the aggregation target or component using the valuation indicators.

### (Effect of Third-Level Comparison Process)

By using various valuation indicators such as trading profit and trading loss, the trading situation is compared by calculating the winning profit ratio and loss ratio of the target or component, and so on. Thus, the trading situation can be seen, such as how much profit is increased when the target or component wins and how much loss is suppressed when the target or component loses.

### (Specific Example of Third-Level Comparison Process)

For example, for the winning trades of A issues, the average buying price is ¥4000, the average selling price is ¥4500, the average profit margin is 12%, and the average holding period is 2 weeks. On the other hand, the average buying price for A issues is ¥4800, the average selling price is ¥4500, the average loss rate is −8%, and the average holding period is 5 days. In this case as well, if it is the number of the entire stock A, it can be cited as one of the data for article distribution. This is because it is the information that many investors need. On the other hand, in the case of A stock of a particular investor, Mr. A, this information is useful for solving the problem of raising Mr. A's investment results.

The server 30 causes the display unit 23 of the terminal 2 to display such a comparison result. The information generation unit 3021 separately extracts winning trades and losing trades from the traded data, calculates respective valuation indicators, and compares the valuation indicators using the valuation indicators. This makes it possible to evaluate the trading situation more deeply based on the profitability of the winning trades and the loss ratio of the losing trades of each stock, and provides a more detailed picture of the trading situation.

Significance of the 3rd Level (Unrealized Gain Level Indicator and Unrealized Loss Level Indicator) Comparison Process

The information generation unit 3021 calculates valuation indicators by dividing the unrealized loss level and the unrealized profit level, and compares the valuation indicators.

### (Third Level (Unrealized Gains and Losses) Comparison Process Issues)

At the second level of profit/loss and unrealized profit/loss, there is a mix of profit/loss outweighing unrealized profit/loss, so there is no important factor in comparing the unrealized profit ratio, the unrealized loss ratio, and the respective holding periods.

### (Third Level (Included and Loss) Means of Comparative Process)

The information generation unit 3021 calculates various valuation indicators in order to evaluate the unrealized loss and the unrealized profit of the sales data aggregated for each aggregation target or component, and compares the holding status of the aggregation target or component using the valuation indicators.

### Effects of the Third Level (Unrealized Gains and Losses) Comparison Process

The holding status can be compared by calculating the unrealized profit/loss ratio and the unrealized profit/loss ratio of the target or component using various valuation indicators such as unrealized profit and loss. Holding status such as how much unrealized gains and losses are reduced for the target or component can be seen.

### (Example of the Third Level (Unrealized Gains and Losses) Comparison Process)

For example, 80% of the holders of A stocks have unrealized gains, and the average unrealized gains is 70%. On the other hand, among the holders of B stocks, only 20% of the holders have unrealized gains, and the unrealized gains rate is 10%. Such comparison results can be provided to the user.

Among the holders of A issues, 20% of the holders have unrealized losses, and the ratio of unrealized losses is kept to-10%. On the other hand, those with unrealized losses on B stocks accounted for 80% of the holders, and the unrealized loss ratio was-3%. In this way, it is possible to grasp the purchase status and unrealized profit/loss status of the issues held, and it is possible to obtain comparison results such as how many people have unrealized profit. In this case as well, the numbers of the A stock and the B stock as a whole can be cited as one of the data for article distribution. This is because it is the information that many investors need. In fact, you can see which stocks are most profitable, so let's be a very valuable article. For example, if you know the actual situation in which everyone actually suffers an unrealized loss, a source stock that is popular with individual investors will not be able to make a hand, so it will become a necessary news for society.

### (Significance of Third Level Comparison Process (Linked Unrealized Gain Level Indicator and Linked Unrealized Loss Level Indicator)

The information generation unit 3021 separately compares the interlocking-type unrealized profit level valuation indicators and the interlocking-type unrealized profit level valuation indicators.

### (Problems of the 3rd Level Comparison Process (Unrealized Gains and Losses Linked to Unrealized Gains)

Comparison of unrealized profit levels by adding interlocked items enables the valuation of unrealized profit-generating funds of the principal that generates unrealized profit to be compared in conjunction with trading profit and loss, and allows the significant effects of investment products, such as leverage effects and compounding effects, to be compared without omission.

### Third Level (Means of Comparison Process: Unrealized Gains and Losses Linked)

The information generation unit 3021 compares the unrealized profit level comparison process and the unrealized profit level comparison process by adding an interlocked item.

### (Effects of the Third Level (Unrealized Profit and Unrealized Loss Linked to Unrealized Profit) Comparison Process)

The information generation unit 3021 calculates an interlocking-type unrealized profit level valuation indicators and an interlocking-type unrealized profit level valuation indicators from the interlocking-type unrealized profit level trading data and the interlocking-type unrealized profit level trading data, and compares the interlocking-type unrealized profit level valuation indicators using the valuation indicators.

For example, there is a question of how to evaluate people who have made a lot of profits in the past and currently have a small amount of unrealized profits, and those who have made a lot of losses in the past but now have a lot of unrealized profits.

Simply assessing at the unrealized profit level, the latter is better, and the former is lower. In reality, however, the present valuation of the former should be high because it is a state in which a large amount of profit is generated from the principal and the funds for generating unrealized gains are sufficiently increased. On the other hand, in the latter case, if the principal is greatly interrupted and the amount of unrealized profit-forming funds appears to be small to the extent that the situation is improving a little, it is inferior to the former case.

Unrealized gains/losses are linked to historical trading gains/losses, rather than variances, thus enabling higher-level comparisons of linked unrealized gains/losses.

### (A Specific Example of the Third Level (Linked Unrealized Gains and Losses) Comparison Process)

For example, among the holders of A stocks, 80% of the stocks hold funds to generate unrealized gains. The average unrealized profit ratio is 70%, and the average trading profit ratio is 20%. As a result, many investors are not good at buying and selling.

On the other hand, among the holders of B stocks, only 20% of the holders have unrealized gains and losses, and the ratio of unrealized gains and losses is 10%. Such a comparison result can be provided to the user.

### (Fourth Level Comparison Process (Significance of Comparison of Winning Pattern Level Indicators)

The information generation unit 3021 performs comparison using a winning pattern analysis and a losing pattern analysis having different characteristics even at the same winning trade and the same losing trade at the fourth level of the profit/loss level.

### (Assignments for the 4th Level Comparison Process)

Comparison of the profit margin of each component or the target of aggregate of investment products gives a fair degree of detail in holding and trading, but further comparison with the market value after the sale enables a more detailed comparison.

### (Means of the Fourth-Level Comparison Process)

The information generation unit 3021 calculates various valuation indicators from the aggregate target trading data in order to evaluate the winning pattern and the losing pattern, and compares the trading status of the aggregation target or the constituent elements using the valuation indicators.

### (Effects of the Fourth Level Comparison Process)

By comparing the winning pattern and the losing pattern of the target or component using various valuation indicators of the trading profit and loss, it is possible to compare the trading of the target or component after the target or component has been sold, and whether or not the selling is correct.

### (Specific Examples of the Fourth Level Comparison Process)

For example, for A issues, 80% of winning pattern 1(buying price<selling price<current price) is sold, the remaining 10% is pattern 2, and 10% is pattern 3 with a very high proportion of pattern 1, so that it is possible to display a comparison result that stable trading profit can be obtained. Pattern 1 is “buy price<sell price<current price”, and if the winning pattern of Pattern 1 has a high weight, it can be said that short-term trading is easy to be stable. In this case as well, if it is the number of the entire stock A, it can be cited as one of the data for article distribution. This is because it is the information that many investors need. An article such as “This is a stock that can easily be traded in the short term!” is an article with a high degree of attention.

Especially, the issues that win in winning pattern 1 and have a high profit margin can be said to be the flourishing stocks of short-term trading. On the other hand, in the pattern analysis of B stocks, the loss pattern accounts for a large portion, and the pattern of “buy price>sell price>current price”, which is the loss pattern 3, accounts for 80% of the loss pattern, and there are a large number of people who are losing trades. In this way, the comparison result and the like can be expressed.

I sold it on a loss-cut basis immediately after buying it, but the loss rate is kept to −2%, and the loss-cut is frequently done in the loss pattern 3, but the loss is suppressed, and the comparison result can be displayed.

### (Significance of the Fourth Level (Pattern Analysis of Unrealized Gains and Losses) Comparison Process)

The information generation unit 3021 performs diagnosis at the fourth level of the profit/loss level by comparing the unrealized profit rate with the benchmark rise rate, and comparing the unrealized profit rate with the benchmark fall rate, which are different in character even in the same unrealized profit level.

### (Problems of the Fourth Level (Pattern Analysis of Unrealized Gains and Losses) Diagnostic Process)

Although the diagnosis of the inclusion profit rate for each component and the like can be used to grasp the state of possession in a fairly detailed manner, it is possible to make a more detailed comparison by further comparing the benchmark decline rate, increase rate, unrealized profit rate, and unrealized loss rate.

### (Fourth Level (Pattern Analysis of Unrealized Gains and Losses) Comparison Process Means)

The information generation unit 3021 calculates various valuation indicators in order to evaluate the unrealized loss rate and the unrealized profit rate of the transaction target data, and compares the holding status of the aggregation target or the constituent elements using the valuation indicators.

### Effects of the Fourth Level (Pattern Analysis of Unrealized Gains and Losses) Comparison

### Process

By comparing the status of unrealized gains and losses and the status of unrealized losses on the target or component using various indicators of unrealized losses and unrealized gains and losses, it is possible to compare the status of possession, such as the movement of the subject or component relative to the average, and whether or not the correct answer was possessed.

### (Fourth Level (Pattern Analysis of Unrealized Gains and Losses) Comparison Process Means)

The information generation unit 3021 calculates various valuation indicators in order to evaluate the unrealized loss and the unrealized profit of the aggregated holding data, and diagnoses the holding status of the aggregation target or the constituent element using the valuation indicators.

### (Effects of the Fourth Level (Pattern Analysis of Unrealized Gains and Losses) Diagnostic Process)

By comparing the status of the target or component using various valuation indicators such as unrealized losses and unrealized gains, the status of the target or component can be found, such as whether the target or component is held. On the other hand, if the unrealized gains are higher or lower than the benchmark, the same unrealized gains are significantly different, and if the holdings that form unrealized gains are significantly higher than the benchmark, the issues that form unrealized gains are highly valued. On the other hand, if the stocks that form unrealized gains are significantly lower than the benchmark, the stocks that form unrealized losses are low.

### (Example of the Fourth Level (Pattern Analysis of Unrealized Gains and Losses) Comparison Process)

For example, with respect to A issues, unrealized gains are held at returns well above the Nikkei average, with a benchmark outcome of 50 percent, and holding and purchasing of A stocks outweigh the Nikkei average. On the other hand, in the analysis of the pattern of unrealized gains and losses on B stocks, unrealized losses were recorded, and losses below the Nikkei average were recorded. The rate of decline below the benchmark was 1%, almost the same as the Nikkei average. Therefore, it can be said that there are few stocks to hold. For stocks that are above the benchmark, there are more stocks that are above the benchmark, and there is an effect that can be used to judge whether stocks that are well below the benchmark should be reviewed.

### (Specific Example of Comparison Process)

### Example 1

Comparing the metrics of day-trading type and swing-trading type by investment type is an example. In this case as well, this is one of the data candidates for article distribution. This is because it is the information that many investors need. On the other hand, in the case of A stock of a particular investor named “Mr. A”, this information is useful for solving the problem of raising Mr. A's investment results.

### Specific Example 2

An example is the comparison of the index of the stock whose trading profit is recorded with the stock whose trading loss is recorded in the investment type=day tray type. In this case as well, it is mentioned as one of data for article distribution. This is because it is the information that many investors need. On the other hand, in the case of A stock of a particular investor named “Mr. A”, this information is useful for solving the problem of raising Mr. A's investment results.

### Example 3

One example is to compare the trade frequency and rate of the daily type with the trade frequency and rate of the medium- and long-term holding type, using issue A as the extraction condition. In this case as well, if it is the number of the entire stock A, it can be cited as one of the data for article distribution. This is because it is the information that many investors need.

### Example 4

This is exemplified by whether the index is superior by comparing the trading data with a 50% or less RSI at the time of purchasing and the trading data with a 50% or less, using the issue=A as the extraction criterion and the component as the technical index. In this case as well, if it is the number of the entire stock A, it can be cited as one of the data for article distribution. This is because it is the information that many investors need.

### Example 5

An example is to compare trading data of a stock type with trading data of a stock type and a stock type with trading data of a high-quality stock, and to calculate and compare valuation indicators by the information processing system. In this case as well, it is mentioned as one of data for article distribution. This is because it is the information that many investors need.

### Example 6

Based on the trading data for 2020 and 2019 by period, it is possible to compare trading data and valuation indicators as the classification criterion=A, and to compare the degree of change in the outcome of the A stock target on the period. In this case as well, if it is the number of the entire stock A, it can be cited as one of the data for article distribution. This is because it is the information that many investors need.

The display step of how to display such information may be incorporated into the comparison process, or it may be summarized in step 11. In this case, for example, in the example in Example 6, the information processing system can generate information that shows the trading results in 2020 and the trading results in 2019 for the information on Issue A, or it can inform the user holding Issue A of the investment results in 2020 by saying, “This is to inform you of the investment results of Issue A in 2020. The trading profit/loss ratio and win ratio for 2019 and 2020 for A stocks were good on average, 30% and 70%, respectively, in 2019, but they all fell in 2020, falling to −10% and −15%, respectively. Generating text information such as “text” by such information processing system is one example.

This comparison process is performed in the following manner. For example, we will explain what steps investor A takes when he or she wants to look at what the outcome of his or her investment is relative to the average. Create the transaction data to be aggregated for Investor A and the transaction data to be aggregated for the average of investors. The next step is to create each of the overall profit and loss revalue trading data. As the next step, valuation indicators that affects each of the overall profit and loss is calculated by the information processing system. Here, there is a step of weighting the valuation indicators and determining which valuation indicators to compare with is more accurate. Then, a table comparing the average of the investor A and the average of the investors is created by the valuation indicators, and is displayed through the display step. In this step, there is a problem of how to judge whether it is appropriate to compare the weighting of the valuation indicators with which valuation indicators.

In the step of determining the weighting of the valuation indicators and which valuation indicators are to be compared, a large number of valuation indicators are calculated by the information processing system. At the overall profit/loss level, the rotational indices vary from trading profit/loss, number of trades, winning profit ratio, loss ratio, unrealized profit ratio, unrealized loss ratio, and so on. However, the overall profit/loss structure is as follows: Trading profit/loss (=winning profit+loss) plus unrealized profit/loss (unrealized profit+loss). The profit/loss in the upper layer is more important, and the profit/loss in the lower layer is less important. However, when the difference or the deviation rate (with the average) compared with the average is calculated by the information processing system, a number that is higher than the average and a figure that is lower than the average appear. There are two types of benchmarks: one with a large deviation rate and the other with a low deviation rate. In this case, in comparison with the average, the weighting of the upper layer is increased, the weighting of the valuation indicators having a large deviation rate from the average is increased, and conversely, the weighting is decreased in the lower layer, and the weighting is decreased in the index having a low deviation rate, so that it is possible to determine which valuation indicators can be displayed more accurately by comparing the weighting.

By incorporating this step (valuation indicators determination step), it is possible to solve which valuation indicators can be displayed in an easy-to-understand manner by comparing the valuation indicators among many valuation indicators.

(Definition of Comparison by Component Sales and Purchase Data with Components of Investment Target Sales and Purchase Data)

An example of a comparison using the information processing system based on aggregate target trading data by component with the investment target as a component of the aggregated target trading data by investment target is used is to compare trading of A issues with trading of B stocks using valuation indicators such as the trading profit-loss ratio and the unrealized profit-loss ratio. ˜An example is a case where (investment target) is compared with valuation indicators (calculated by the information processing system under the condition) for each of −(investment target). One concrete example is to compare A issues with B stocks by the information processing system, and to compare stocks by stock trading profit/loss ratio and winning ratio by stock in the information processing system.

(Effects of Comparison by Aggregate Target Trading Data by Component with the Investment Target as a Component of the Aggregated Target Trading Data by Investment Target)

The information processing system processes an investment target under conditions such as an extraction condition, a classification condition, and a aggregation rule based on the aggregation target trading data, extracts, classifies, or aggregates the investment target according to the investment target, and compares the trading data based on the trading data further processed at the profit/loss level with valuation indicators calculated by the information processing system. As a result, it is possible to compare the information processing system with the information processing system based on the aggregate target trading data by component with the investment target as a component of the aggregated target trading data by investment target is used as a component. The comparison may be made by comparing the trading data of A and B in the stock, or by comparing the stock with the winning ratio by stock.

(Effects of Comparison by Aggregate Target Trading Data by Component with the Investment Target as a Component of the Aggregated Target Trading Data by Investment Target)

This is a comparison by the information processing system based on the sales and purchase data of the actual issue, and it is effective that a multilateral comparison is possible so that the comparison is not compared with a common brand comparison. For example, among stocks, the winning rate of stock A in September is as low as 15% (average is 49%) compared to the average, and it is possible to express that stocks A in the stock holding are fairly struggling with. It can be said that the information processing system is a content that is unique to a comparison based on the component-specific trading data in which the component-specific trading data is used as a component of the trading data to be counted by the investment object.

(Specific Example of Comparison by Aggregate Target Trading Data by Component with the Investment Target as a Component of the Aggregated Target Trading Data by Investment Target)

One specific example is to compare the valuation indicators of the trading profit-loss ratio, the winning ratio, the winning profit ratio, the unrealized loss ratio, and the like by the information processing system by comparing the valuation indicators of the trading stock group and the excellent stock group among the stocks, and display the comparison result.

(Definition of Comparison by Component Sales and Purchase Data with Investors as Components of Trading Data Subject to Tabulation by Investment Target)

An example of a comparison based on component-specific trading data that includes investors in the trading data for each of the investment targets is to compare the trading of A with the trading of B using valuation indicators such as the profit-loss ratio and the unrealized profit-loss ratio calculated by the information processing system. ˜valuation indicators (calculated by the information processing system under the conditions) may be compared by the information processing system for (investment target) by (investor). One concrete example is to compare shares with A and B in the information processing system at the overall profit-and-loss ratio, and to compare shares with each investor in the information processing system at the profit-and-loss ratio and the win ratio.

(Effects of Comparison by Component Sales Data with Investors as Components of Trading Data Subject to Tabulation by Investment Subject)

Based on the transaction data to be aggregated, the information processing system narrows down the investment target by the extraction condition, classification condition, or aggregation rule, and further extracts, classifies, or aggregates the transaction data for each investor, and compares the transaction data with the valuation indicators calculated by the information processing system based on the target transaction data further processed at the profit/loss level. As a result, it is possible to make a comparison based on the component-by-component sale data in which the investor is a component of the trading data to be counted according to the investment object. The comparison may be a comparison of the trading data between A and the average in the trading of shares, or a comparison of shares with each investor at the winning rate.

(Effects of Comparison by Component Sales Data with Investors as Components of Trading Data Subject to Tabulation by Investment Target)

The comparison by the information processing system based on the sales and purchase data of the actual issue has an effect of possible a concrete and unprecedented comparison. For example, in the 2020 trading of shares, it is possible to express that “Mr. A has a higher index than the average, and this index is inferior.”

(Specific Example of Comparison by Component Sales Data with Investors as Components of Trading Data Subject to Tabulation by Investment Subject)

A specific example is to compare the valuation indicators of the excellent investor group with the poor-performing investor group, calculate the trading profit/loss ratio, the winning profit ratio, the unrealized loss ratio, and the like by the information processing system, and display the comparison result.

It is possible to compare the valuation indicators for the following periods in a manner similar to the above specific examples.

### Example 3 of Comparison by Period

Comparing AB term index with CD term index can be performed in the same manner as in the above embodiment.

### Example 4 of Comparison by Period

It is possible to compare AB term index for the investment target A with AB term index for the investment target B in the same manner as in the above embodiment.

### (Significance of Ranking Process)

The information generation unit 3021 calculates a profit/loss level valuation indicator from the transaction data to be counted, and ranks the profit/loss level valuation indicators based on the profit/loss level valuation indicators. The ranking process is to calculate a profit-and-loss level valuation indicators from the transaction data to be tabulated by the information processing system and rank using the profit-and-loss level valuation indicators obtained therefrom. The ranking process is divided into a component ranking, an aggregation target ranking, and a multi-layer ranking depending on what is ranked. The ranking process is from the first level to the fourth level depending on the type of the profit/loss level valuation indicators used as the basis of the ranking.

### Definition of Ranking Step

The first step is a step of acquiring trading data. It is also the buying and selling data creation phase. The second step is the step of creating transaction data to be aggregated. The third step is a step of creating the component-by-component sale data. The fourth step is a step of creating profit and loss level trading data. The fifth step is a step of calculating and selecting valuation indicators by the information processing system. The operation phase is a phase of “what to do” using the valuation indicators extracted and selected in the fifth step, and regardless of the order relationship with other steps.

The sixth step is an evaluation step. The seventh step is a comparison step with. In the eighth step, (which is the current step), ranking of another aggregation target or component based on the valuation indicators (which may be a single or a plurality of valuation indicators) calculated by the information processing system is defined as a ranking process.

### (Problems of the Ranking Process)

It is currently difficult for investors to know the ranking status, such as how many people are ranked in the rank, how much is the profit or loss from trading, how much is the rate of increase in the valuation value relative to the principal, how much is the stock, and what is the virtual currency. News is not distributed in the world as to how the actual trading situation of this month was, whether the actual trading situation of this year was all profitable, and whether it was impaired. In terms of stock information, stock information and performance trends are seen. There are few distributions of information based on actual trading, and there is often a gap in information such as blog distribution of individuals, and there is often a lack of accuracy or a partial view.

### (Effect of Ranking Process)

Ranking is facilitated by following the process as shown in the definition of the ranking process. If you rank each year of A's trading profit or loss, the component ranking is appropriate because it uses the component trading data. When the overall profit and loss of Mr. A's shares are ranked in the order of the investors, they are ranked in the trading data subject to aggregate. Determine whether the aggregation target ranking process is used and whether the component ranking process is used, depending on which index is ranked in which target. In order to assign a multi-faceted ranking of investors, it is possible to rank multiple valuation indicators of Mr. A in the trading data to be tabulated, and the success rate (winning rate) of the actual trading of the issue can be determined by creating the trading data to be tabulated by the component trading data for each brand, using the winning rate as valuation indicators in the trading data at the trading profit/loss level, and ranking the brand based on the winning rate.

It can also be used in an automatic article distribution system. For example, the information processing system can automatically generate articles such as the 2020 stock trading margin ranking, the current unrealized profit rate ranking, the 2020 upward revision trading profit ranking, the current purchase stock ranking, and the most earned stock ranking this week. The second step, the third step, the fourth step, and the fifth step are updated on a daily basis when the data is created with the new updated data under the same conditions. Such information can be acquired at any time by being stored in the storage unit 33 on a daily basis, and can also be used for comparison with past data, a graph of time-series data, and the like.

### (Effect of Ranking Process)

In this ranking process, various objects can be ranked using various metrics, and for the user, it is necessary to show how to raise the ranking and how to improve it. The news story also has the effect of showing whether the stocks that have not appeared in the past are really profitable and how much the losing people are losing.

### (Specific Example of Ranking Process)

A's ranking of profits and losses, A's ranking of profits and losses, the frequency of trading by securities companies, the ranking of profits and losses based on advice from adviser a, the ranking of profits and losses on trading based on advice from adviser a, the ranking of profits and losses to win in order to know which media were the most profitable in 2020, and the ranking of wins in 2020. If this is the whole number, it will be mentioned as one of the data for article distribution. This is because it is the information that many investors need. As described below, the ranking, the component ranking, and the multi-layer ranking are selected depending on which valuation indicators is ranked among which targets and which object ranking is presented. As long as the ranking of investors is appropriate, the ranking of investors is appropriate for each target of aggregate, the ranking of investors A by year is appropriate for the component ranking, and the ranking of multiple-tiered investors is appropriate for the ranking of investors A by issues with unrealized losses, and the ranking of stocks with high profits in short-term trading.

Articles of high interest include the Technical Chart Success Rate Ranking, the Firm Loss Ranking, this month's top-level earnings margin ranking, the People who lost the news (Unrealized Losses Ratio) ranking, and the People who earned the news (Unrealized Losses Ratio) ranking. Highly news lettered articles include the 2020 win rate ranking and the month's trading margin ranking. All of these articles can be generated by using the ranking process.

As shown in FIGS. 101 and 102, if various conditions are added in FIG. 101, a data set according to the purpose is created, the necessary valuation indicators is calculated, and the valuation indicators according to the purpose is calculated, so that various conditions and various forms of valuation indicators can be easily ranked and displayed in this step. This process is just one step in FIG. 102, but since the valuation indicators have been determined through a series of collaborations, the ranking of many types of valuation indicators and the ranking of many objects described in this specification are possible.

### (Definition and Type of Valuation Indicators Ranking)

Ranking is defined as the ranking of valuation indicators, which is obtained by calculating various calculated valuation indicators for each investor or each investment target, rearranging the valuation indicators, and ranking them.

### (Conventional Problems)

The ranking of stocks, one of the investments, includes market capitalization ranking, trading value ranking, PER ranking, and recurring profit growth rate ranking. However, these rankings are not rankings associated with actual trading data. It is quite different from ranking metrics calculated from actual trading data.

### (Issues of Valuation Indicators Ranking)

For example, there are various rankings for investments, as described above, but they are not linked to actual trading data. Therefore, it is not clear whether or not the performances of individuals who purchased stocks with lower PER are good. The ranking of investors can also be based on the actual trading data, and can be used to identify the position of the investor, the average, and the like, and to show how to improve the ranking.

### (Effect of Valuation Indicators Ranking)

There is an index ranking by the number of indices. Examples of the types include an investor ranking based on valuation indicators of trading data (transaction data) in a narrow sense, and an investment target ranking based on a performance valuation indicator of an investment target and valuation indicators of a technical index of an investment target.

An investor ranking can be created by determining the index to be ranked, calculating the index for each investor, and ranking the index. By calculating and ranking each investment target, an investment target ranking can be created.

### (Effect of Valuation Indicators Ranking)

It is possible to see the average image of investors, how top-level investors work, their position, and what needs to be improved, and it is expected that this will greatly contribute to the effect of investors' investment behavior. The investment target ranking greatly contributes to the selection of the investment target and the trading decision of the investment target. It can be expected that a suddenly rising and shocking target stock will actually have an effect that reveals the fact that most people are suffering a large loss.

### (Specific Example of Valuation Indicators Ranking)

A specific example of the valuation indicators ranking will be described below.
(1) Ranking of the rate of decline during the holding period
(2) Trading Data Rating (Integrated Profit/Loss Ratio) Ranking
(3) Revision Rate Ranking
(4) Technical Indicator Ranking

### (Definition of Ranking of Rate of Fluctuation During Holding Period)

When the purchase time of the investment target product is set as A time point and the sale time point (or the current time point during the holding period) is set as B time point, and the valuation price at that time point is set as A time point and B time point price, the hike rate of the investment target product can be expressed as the price at B time point/A time point.

The information generation unit 3021 calculates the B-time point price and the A-time point price of the investment target product and the investment target product that can be replaced, ranks the investment target product with reference to the B-time point price/A time point price, and obtains the hike rate ranking of the investment target product. This is defined as the ranking of the rate of decline during the holding period.

### (Conventional Technology)

The monthly rate ranking and the daily rate ranking are highly noticeable. However, it is most important for an investor that funds are constrained by the subject product during the holding period of the subject product. Therefore, in order to determine whether or not the investment target product has been selected during the holding period, the ranking of the rate of decline during the holding period is important.

The higher the hike rate ranking, the better the selection of the target product, and the lower the hike rate ranking, the more appropriate the selection, the better performance.

### (Problems of Ranking the Collision Rate During the Holding Period)

Ranking the rate of increase and decrease in the monthly (weekly, daily) rate is the main ranking. It is important to know how much the increase from the date of purchase and how much the increase from the date of purchase was when A issues were purchased in cash, for example, 0.5 million yen, and how much the increase was when other stocks were purchased, compared to the stocks with the highest rate of increase and the average rate of increase.

### (Effect of Ranking of Boost Rate During Holding Period)

By determining the time point A and the time point B, the rate of decline of the investment target product is determined, and the rate of decline of the substitutable investment target product (opening price, closing price, etc.) is also determined, so that the rate of decline of the investment target product can be ranked. The definition of an alternative investment instrument can be limited to stocks, limited to the TSE, limited to the minimum purchase amount, or a variety of limitations.

### (Effects of Ranking the Rate of Collision During the Holding Period)

A special effect can be expected in that it is possible to verify whether or not the selection among a number of investment targets is correct. For example, a comparison with an average value, a comparison with the highest ranking, and a number of stocks in a certain number of stocks clarifies the position of a person's skill in choosing.

### (Examples of Ranking of Rate of Fluctuation During Holding Period)

It is OK if the stock price and date are determined.

For example, taking company F as an example, if the price goes from 829 yen on Sep. 10, 2020 to 2060 yen on Feb. 17, 2021, the rate of return is 2.48 times and the RSI is 50%. Information Generation Section 3021 finds the top 10 percent of return, NO1, and the average from Sep. 10, 2020 to Feb. 17, 2021. Company F then informs the user of the number. In addition, NO1 issues tell you which stocks are experiencing a factor in the rate of soaring.

### (Definition of Overall Profit-Loss Ratio (Transaction Datvaluation Indicators) Ranking)

When evaluating the overall loss rate during AB of A investors, we define the total loss rate ranking as the ranking of the number and the number of individuals in the ranking as compared to the total loss rate during the period of other investors. Similarly, a trading profit-loss ratio is defined as a trading profit-loss ratio ranking. Similar rankings can be defined for all metrics derived from transaction data.

### (Conventional Technology)

Even if investor A understands the outcome of AB, there is no way to know the position of other investors in the whole, and how they are.

### (Overall Profit/Loss Rate (Transaction Datvaluation Indicators) Ranking Problems)

Even if you can compare your performance with the overall market (e.g., the Nikkei Average), there is no way to know what it was like compared to other investors, so investors are deceived by rumors and demeanor information and suffer losses sometime. It is a big challenge for all investors to be able to identify and improve their positions by comparing and ranking the average and outcomes of the best investors with objective indicators.

### (Effects of Ranking Overall Profit/Loss Ratio (Transaction Datvaluation Indicators))

First, the duration of AB is determined. For the overall profit-loss ratio ranking, either the total profit-loss ratio is calculated using the period-specific trading data of investor A during AB period, or the total profit-loss ratio is calculated by calculating the valuation amount at time A and the valuation amount at time B (the valuation amount at time-A at time B)/the valuation amount at time A (the case where cash receipt and disbursement is 0). Other investors obtain ranking data by calculating and ranking the overall profit-loss ratio in the same manner. Considering that it is easy to calculate other metrics such as other profit-loss ratios, it is desirable to calculate the former.

### Effects of Ranking Overall Profit/Loss Ratio (Transaction Datvaluation Indicators)

In the overall profit-loss ranking, by ranking the overall profit-loss ratio over AB horizon, you can see the overall degree of your position, how much the first person achieves, and how much the average is lower or higher than the mean.

### (Specific Example of Ranking of Overall Profit/Loss Rate (Transaction Datvaluation Indicators))

For example, from Sep. 10, 2020, to Feb. 17, 2021, you can compare your performance by telling you how well the overall return NO1 of investors and the top 10 perform. It is possible to compare the performance obtained by buying and selling not only a single stock but also a variety of stocks.

Valuation indicators obtained from trading data (transaction data) in a narrow sense such as a trading profit/loss ratio, an unrealized profit/loss ratio, a winning ratio, and a winning profit ratio as well as a trading profit/loss ratio can obtain ranking data by a procedure similar to an overall profit/loss ratio. By changing only the valuation indicators for calculating the definition of the overall profit-loss ratio ranking and the problem, the profit-loss ratio ranking, the winning ratio ranking, the unrealized profit-loss ratio ranking, and the like can be created by the above-described procedure, and they can be named by their respective names.

### (Definition of Revision Rate Ranking of Performance Forecast)

For example, in the case of Japanese stocks, we will focus on sales and recurring profit forecasts for the current fiscal year. Based on May 2020, we assume, as an example, a case in which the company announces the initial sales forecast for the fiscal year ended March 2021 and ordinary profit as well as the results for the fiscal year ended March 2020 in May 2020.

We define as a revision of our forecast that the forecast will be revised before the actual results for the fiscal year ended March 2021, which will be announced in May 2021, with the initial forecast's sales and ordinary profit taken as 100.

The revision rate of the earnings forecast is defined as the 30% revision rate when the initial forecast sales is 100 and the 30% upward revision is made. At the time of purchase, it is possible to manage whether there is a difference in performance between the purchase of a stock after the announcement of the correction rate of 30% and the purchase of a stock after the announcement of the correction rate of 10%.

### (Conventional Technology)

Although there are upgrading rates, there are current situations in which it is not possible to verify the cases in which the probability of success is high in the case of an actual purchase.

### (Issues in Revision Rate Ranking of Performance Forecast)

In the case of upward revisions, the higher the revision rate, the more attention is paid to it. In the end, however, the higher the revision rate, the more often it is to suffer from a large loss. This is evidence that the relationship between the high correction rate and the trading history and stock prices has not been examined. It is easy to create a short-circuited idea of simply buying a stock with a high correction rate and selling a stock with a negative correction rate.

### (Effects of Revision Rate Ranking of Performance Forecast)

The quality of information is enhanced by taking into consideration not only the revision rate of the earnings forecast, but also information such as the number of revisions, the number of months before revisions, and the forecast for the next fiscal year. The relationship between these information and the information on stock prices and trading data can be clarified by adding information such as not only the correction rate but also the number of adjustments, if it is the expected value in the fiscal year ending March 2021, whether it is a correction in September 2020 six months before, or whether it is a correction in July eight months before, and how the expected value in the fiscal year ending March 2022 is compared with the fiscal year ending March 2021.

By managing each issue in a database, the correction rate can be easily ranked. By managing the initial sales and ordinary profit for this period and whether this period is FY03/2021 or June 2021, as well as the timing and expected revisions for the revised period, these numbers can be managed in the database and the ranking can be easily displayed.

When a stock is purchased, it is useful for making a purchase decision by presenting a number of revisions, some month before revisions, the order of revision rates, and the like.

### (Effects of Revision Rate Ranking of Forecast)

Higher revisions to earnings forecasts make stocks more difficult, not because they have a high probability of success (purchase, profitable), but because they have a low probability of success, and because the relationship between performance and probability of success is not simple.

For example, the revisions made 10 months and earlier in the first 10 percent upward revision are likely to have a higher probability of success than the revisions made in the first month waiting for a 40 percent upward revision of the fourth initial forecast. This can be expected to have the effect of possible verification based on actual trading and stock prices, thereby enabling the search for rules with a high probability of success.

### (Specific Example of Revision Rate Ranking of Performance Forecast)

In addition to the upward revision rate ranking, management items can be ranked several times, several months ago, or compared with the forecasts for the next fiscal year. It also helps clarify the relationship between a firm's performance and its stock prices and actual trading data.

For example, the upwardly revised rate ranking, the earnings growth rate ranking, the revised number of times ranking, the first revised rate ranking, and the early revised ranking from the current fiscal year's forecast can be considered.

As of Sep. 10, 2020, for example, the numbers for Company F are shown in the following two figures.

After that, the increase was corrected in February, and the results were announced in May. The details are as follows.

Actual numbers for the 2020 March fiscal year (actual figures for the previous fiscal year)
Sales 81,613
Operating income 6012
Ordinary income: 4263
Net income 1784
Earnings per share of 48.1
   Dividend 26
(First amendment on Aug. 14, 2020, announced)
   Fiscal year ending Mar. 31, 2021
Sales 85,000 (4.15%)
Operating income 6,500 (8.1%)
Ordinary income 5,500(29%)
Net income 1,500 (−16%)
Earnings per share
Dividend 24 (−7.7%)
(Revised for the second time on Dec. 10, 2021, announced)
   As of February 10
Sales 89,000 (4.7% vs. forecast) (9% vs. previous year)
Operating income 9000(38% vs. forecast) (49% vs. previous year)
Ordinary income 8000(45% vs. forecast) (87% vs. previous year)
Net income 7000 (4.67 times the forecast) (3.9 times)
Earnings per share 188.3 (4.67 times the forecast) (3.91 times)
Dividend 26
(The actual value is announced on 2021 May 14 of the announcement)
Sales: 91,312 (up 2.5% year on year) (up 11% year on year)
Operating income 9640 (+7% YoY) (60%)
Ordinary income 8227 (+2% YoY) (92%)
Net income 8280 (up 18% from forecast) (4.6 times)
Earnings per share 222.9 (up 18% from forecast) (4.6 times)
Dividend 26

### (New Method of AI Machine Learning Ranking Process)

AI machine learning comparison process is also performed through the following process, and the ranking process shows which trading data (extraction conditions, classification conditions, and aggregate conditions) is used to create and display the valuation indicators as the basis in the ranking process.

The second step is a process of creating trading data to be aggregated. The third step is to create (omit) component trading data. The fourth step is a process of creating a profit/loss level valuation indicator (calculation of the target valuation indicators by the information processing system using three methods). Up to this fourth step, the target profit and loss and the target trading data are determined. That is, the trading data set is identified by extracting, classifying, and aggregating the trading data.

In the fifth step, a component of the target profit/loss (such as total profit/loss or trading profit/loss) determined in the fourth step and valuation indicators that is a relational element are calculated.

Up to this fifth step, a target profit/loss, target trading data (data structure), and valuation indicators that is a variable are determined. Therefore, if what is to be done in the operation step is decided later, the conditions of automation such as generation of advice (evaluation, comparison, ranking, diagnosis, advice) by the information processing system, generation of an article (issue news, investor news, evaluation article, comparison article, ranking news, diagnosis article, advice article), generation of an article for solving an investment problem, and the like are prepared. In this step, a ranked article is generated and displayed by the information processing system based on a given trading data set, a target profit and loss, and valuation indicators calculated by the information processing system.

The eighth step is a generation process by the information processing system, and a ranking target is determined by a ranking method in which a target ranking target is good on the basis of valuation indicators (which may be a single or a plurality of valuation indicators) calculated by the information processing system, what is easy to understand, and how to rank which valuation indicators among several ranking targets are ranked, and an optimal solution is found. It can also be used to distribute articles, and it can also be used as an article that is valuable to individual investors. It is also possible to automatically generate a news article as a mass media by the information processing system in order to solve a specific problem of an individual investor. In the former case and in the latter case, the requirements are different, but if the extraction conditions and classification conditions are changed, the valuation indicators is changed, and the valuation indicators which becomes the ranking target and the base axis is changed depending on what is required, both demands can be met.

The second step (display process) of the eighth step displays how to rank the ranking objects that are the optimal solutions in an appropriate display method. Examples include a table, a pie chart, a component ranking display, and a ranking display.

### (Problems of the Ranking Process)

The ranking of investment products is based on technical indicators, performance indicators, and the like, but by ranking using profit/loss level indicators obtained from the trading data subject to aggregate, the ranking of investment products has an entirely different effect depending on the ranking of trading of investment products by actual investors. Since the problems facing investors differ from the issues facing the media, it is important for investors to consider their ranking indices and whether their ranking has been raised. News articles are important to the media. It can also be used in collaboration with stocks or for anyone who has lost stocks due to a corona disaster. The advice generation system and the information processing system can generate articles such as the profit amount ranking in 2020 and the “SoftBank as the top trading profit ratio ranking for stocks” as well. This article has not been published before because it was not published by a brokerage firm that had trading data. Though there are privacy problems, it is sufficient news to convey the whole picture anonymously.

### (Effect of Ranking Process)

The information generation unit 3021 calculates various profit and loss valuation indicators based on the aggregate target trading data, and displays the aggregation target and the ranking result of the constituent elements on the display unit 23 of the terminal 2 on the basis of the profit and loss valuation indicators. Ranking results are obtained by aggregating and ranking various profit and loss level valuation indicators for each aggregation target and component.

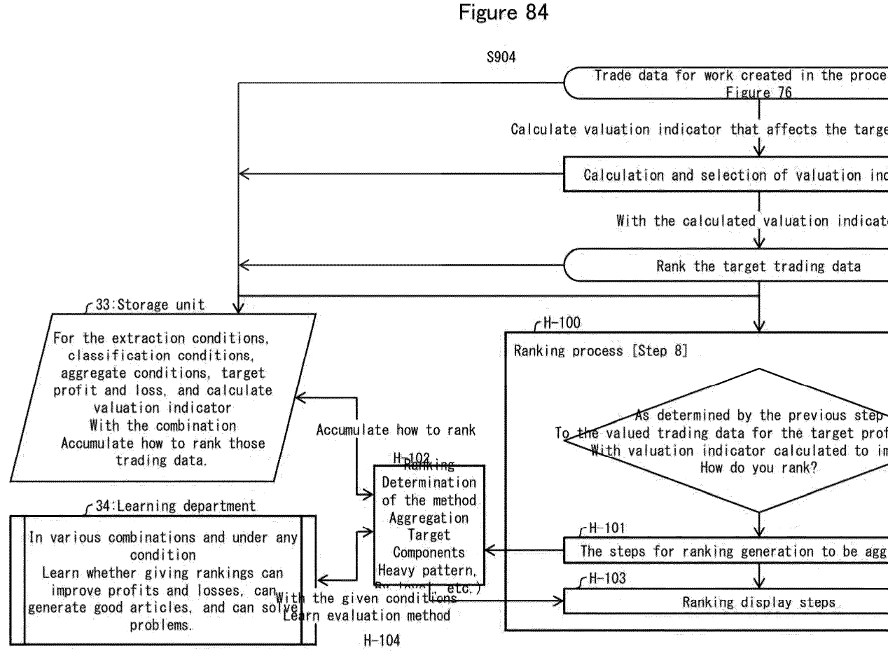

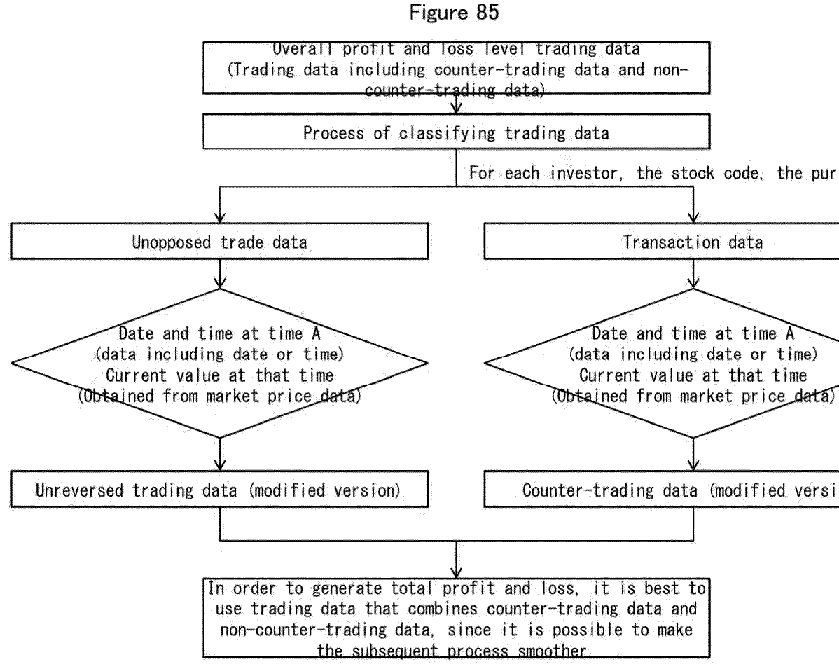

The generation and display step (see FIG. 84) and the fifth step of the ranking article by the information processing system are the same as the evaluation step and the comparison step. Since the valuation indicators, the trading dataset, the target profit/loss, and the like are determined, it is the relevant step to determine, based on which valuation indicators, the ranking result is generated and displayed by the information processing system. The target of generating the ranking result in the information processing system and which valuation indicators is to be used are first what is ranked in the problem solving system and the article generating system, and in the advice generating system, what is problematic in this trading data, and how to improve it. Further, in the case of use as an article generation system, how to generate a ranked article having a high number of accesses and a high degree of attention by the information processing system is first.

### (Effect of Ranking Process)

Based on the ranking results of the various profit-and-loss level valuation indicators at each profit-and-loss level, it is possible to confirm the status of the current owner and the ranking of the transaction. For investors, it can be expected that there is a problem with their own buying and selling, and the need to solve it, and whether their overall profit/loss ranking has risen or fallen today. For the mass media, it can be expected that the information processing system will be able to generate articles that are likely to attract attention from the buying and selling data linked to today's news. These effects can be expected in the system consistency of FIG. 84.

### (Specific Example of Ranking Process)

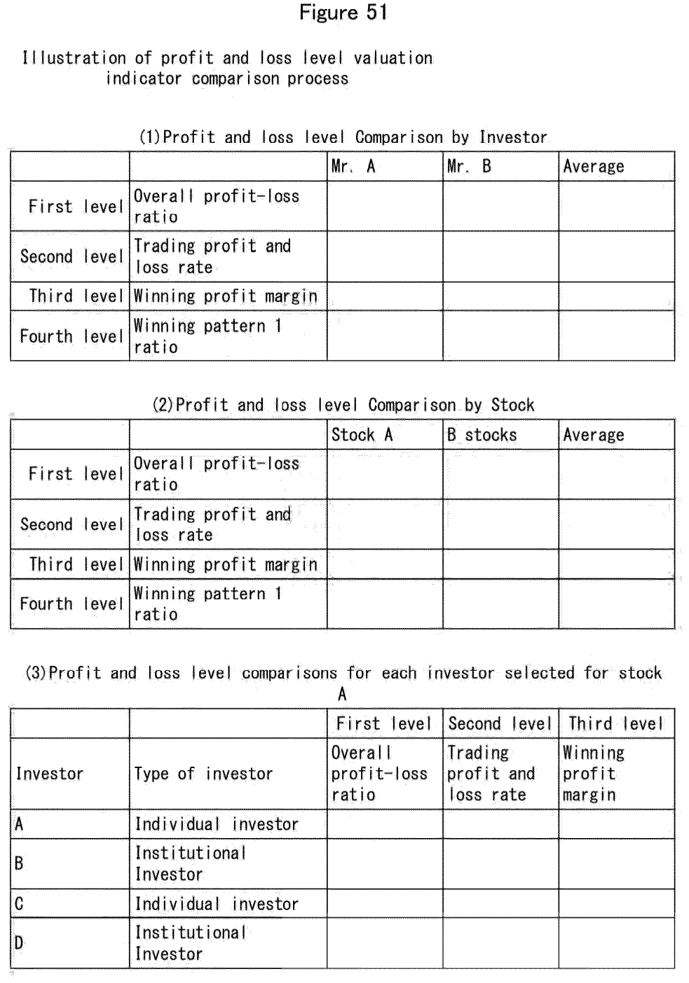

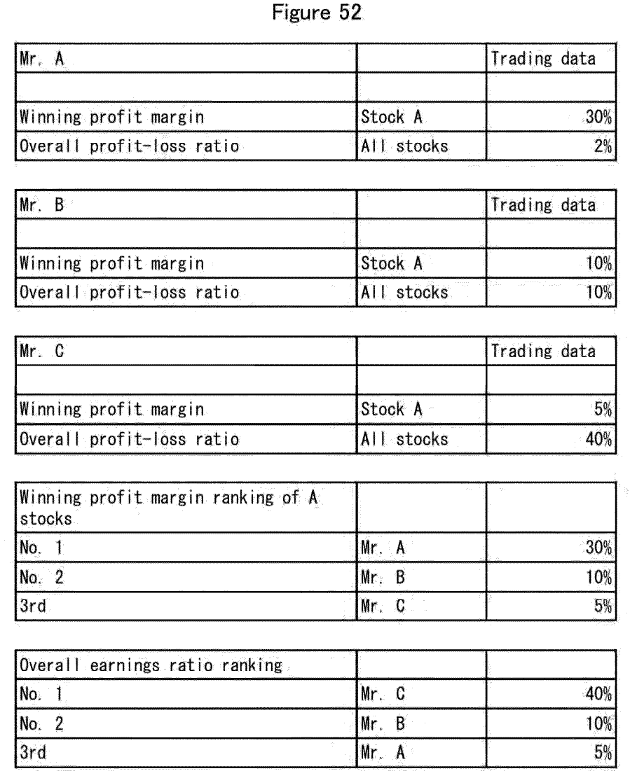

FIG. 51 and FIG. 52 are diagrams illustrating a specific example of ranking according to the present embodiment. For example, an example is a period ranking in which stock trading data (trading data subject to aggregate) is aggregated for each period (component) and arranged in descending order of the overall profit-loss ratio. An example is the ranking of investors in descending order of winning profitability based on winning profitability.

The rankings are classified into an aggregation target ranking, a component ranking, and a multi-layer ranking depending on what (a stock, an investor, etc.) is ranked. The ranking can range from a first-level metric ranking to a fourth-level metric ranking, depending on what (e.g., overall profit-loss ratio, winning profit ratio, etc.) is based on. These ranking data are stored by the administrator and stored as a database, and can be extracted at any time, and the date and time and the data are associated with each other, so that it is possible to prepare time-series data and compare last year with this year. It is valuable both as the article data and as the advice history of the individual to confirm whether the problem has been solved.

### (Significance of Component Ranking Process)

The information generation unit 3021 calculates a profit/loss level valuation indicator from the transaction data to be counted, and ranks the constituent elements based on the profit/loss level valuation indicators. The component ranking is to calculate a profit-and-loss level valuation indicators by the information processing system, and totalize the profit-and-loss level valuation indicators and the like obtained therefrom by the constituent elements to perform the ranking.

### (Problems of Component Ranking Process)

The ranking of investment products is based on technical indicators, performance indicators, etc., but by using profit-and-loss indicators to aggregate and rank them by components, they have completely different effects depending on the ranking of trading of investment products, etc. by actual investors.

### (Action of Component Ranking Process)

The information generation unit 3021 calculates various profit and loss valuation indicators based on the aggregate target trading data, and based on the profit and loss valuation indicators, aggregates the constituent elements that are one element of the aggregation target trading data and causes the display unit 23 of the terminal 2 to display the ranking result. The various profit-and-loss level valuation indicators to be tabulated are the profit-and-loss level valuation indicators for each component, which are tabulated for each component and ranked.

### Effects of Component Ranking Process

Using various profit and loss level valuation indicators at each profit and loss level, it is possible to confirm the ranking of each component in the aggregate target based on the results of the aggregation by the component subject to the aggregation, etc., and the current owner can confirm the ranking of the current status of the sale and purchase.

### (Example of Component Ranking Process)

FIG. 52 is a diagram illustrating a specific example of component ranking according to the present embodiment. For example, an example is a ranking of stocks that are compiled for each issue (component) and sorted in descending order of inclusion and loss, and a ranking of stocks that are sorted in descending order of profits that are highly profitable in short-term trading, based on stock trading data (trading data subject to aggregate). This is an example of the ranking of the issues (components) in the order of the higher unrealized profit ratio based on the unrealized profit ratio in the trading data (trading data to be tabulated) of Mr. A (which is a relatively media article). This is an example of an article for individual advice (content) and an investor's winning profit ratio ranking with A issues as a component. For the media, it is possible to rank each investor if the component is an investor, and to rank the number of trades of a person who traded on Twitter if the medium is different from each other, by using the trading data (extraction condition: brand) of the brand with news, and it is also possible to rank the brand traded by a person who achieved high performance this month. Why these articles can be generated by the information processing system is in system consistency.

### (Significance of the Multilayer Ranking Process)

The information generation unit 3021 calculates a profit/loss level valuation indicator based on the aggregate target trading data, and ranks each component B with a certain component A as an axis based on the profit/loss level valuation indicators. The use of two or more components makes it a stratified form.

### (Problems of the Multilayer Ranking Process)

The ranking of investment products includes the ranking based on technical indicators, performance indicators, and the like, and the ranking process described above. However, by using the profit/loss level valuation indicators obtained from the trading data, the ranking of each component B with a certain component A as an axis has an entirely different effect.

### (Effect of Multilayer Ranking Process)

The information generation unit 3021 calculates various profit and loss level valuation indicators based on the aggregate target trading data, and displays the ranking result for each component B on the display unit 23 of the terminal 2 with the component A as an axis, based on the profit and loss level valuation indicators. The ranking result is obtained by ranking each component B with component A as an axis.

### (Effects of the Multilayer Ranking Process)

By using various profit-and-loss level valuation indicators at each profit-and-loss level, the ranking results for each component can be shown with the component subject to the aggregate as the axis. In this case, when a component A is used as the axis in the aggregation target, it is possible to confirm the ranking of the component B, the current owner, and the status of the sale and purchase.

For the media, it is possible to rank the winning rate of investors who have been buying and selling on Twitter, if the component A is classified as an investor and the component B is classified as a medium in the trading data (extraction conditions: brand), and if the component A is classified as an investor, the component B is classified as an investor, the component B is classified as a brand, the profit/loss ratio is classified as a trading profit/loss ratio (extraction conditions:trading profit/loss ratio>20%) in this month (aggregate data by period=extraction conditions=this month). Why these articles can be generated by the information processing system is consistent with the advice generation system.

### (Specific Example of Multilayer Ranking Process)

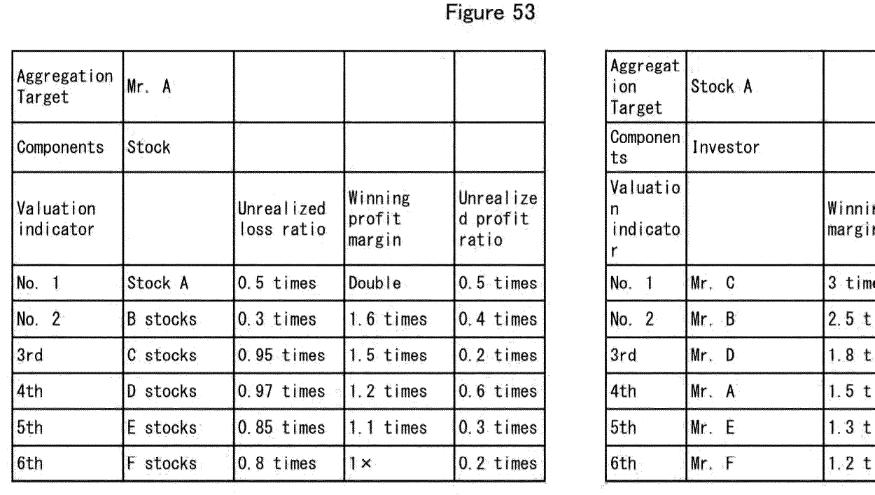

For example, FIG. 53 is a diagram illustrating a specific example of the layered ranking. When the unrealized profit/loss ratio is tabulated and ranked with investors and stocks as constituents, it becomes clear that Mr. A, who has the most unrealized losses, is identified and which stocks have unrealized losses.

When the aggregate profit-loss ratio is tabulated and the investor and the fiscal year are used as components, the ranking of the overall profit-loss ratio in 2019, the ranking of the total profit-loss ratio in 2018, and the like become clear. If it is a stock, the stock ranking can be displayed.

FIG. 53 also shows an example of ranking of A's stocks and fiscal years as components.

For example, based on the trading data to be compiled as shares, A (Component A) is used as the axis to compile data for each issue (Component B), and the target by issue that Mr. A has an unrealized loss, and the ranking of issues that are highly profitable in short-term trading are examples. Clarifying the position of the component in Mr. A's profit and loss has the effect of having a large impact on the buying and selling of the component to be aggregated.

Clarifying the position of a component in the profit or loss under aggregation has the effect of having a large impact on the buying or selling method of the component under aggregation. Although two components are exemplified, the same applies to three or more components.

### (Issues in Each Ranking to be Aggregated)

The information generation unit 3021 performs ranking within the standard (for example, for each investment target) using the trading profit/loss level valuation indicators or the unrealized profit/loss level valuation indicators to generate information regarding the ranking of the trading situation or the holding situation within the standard.

The ranking of each aggregate target enables more detailed analysis. It is possible to further improve the layered ranking display in which constituent elements are aggregated with the constituent elements as an axis. A multi-layered ranking is derived from one aggregated trading data, while a ranking for each aggregated trading data is derived from a plurality of aggregated trading data. Ranking by using a plurality of pieces of transaction data to be aggregated, which are aggregated from various viewpoints, enables a more multifaceted ranking.

### (Definition of Ranking by Target)

The component in the trading data to be aggregated is the same as the multi-layered ranking, but the aggregation target trading data is re-aggregated with the component as the axis, and the ranking to be created is defined as the ranking for each aggregation target.

### (Effects of Each Ranking to be Aggregated)

It has the effect of being able to learn more deeply by ranking the targets to be aggregated by the profit/loss level valuation indicators with a certain component as the axis.

### (Specific Examples of Each Ranking Subject to Aggregation)

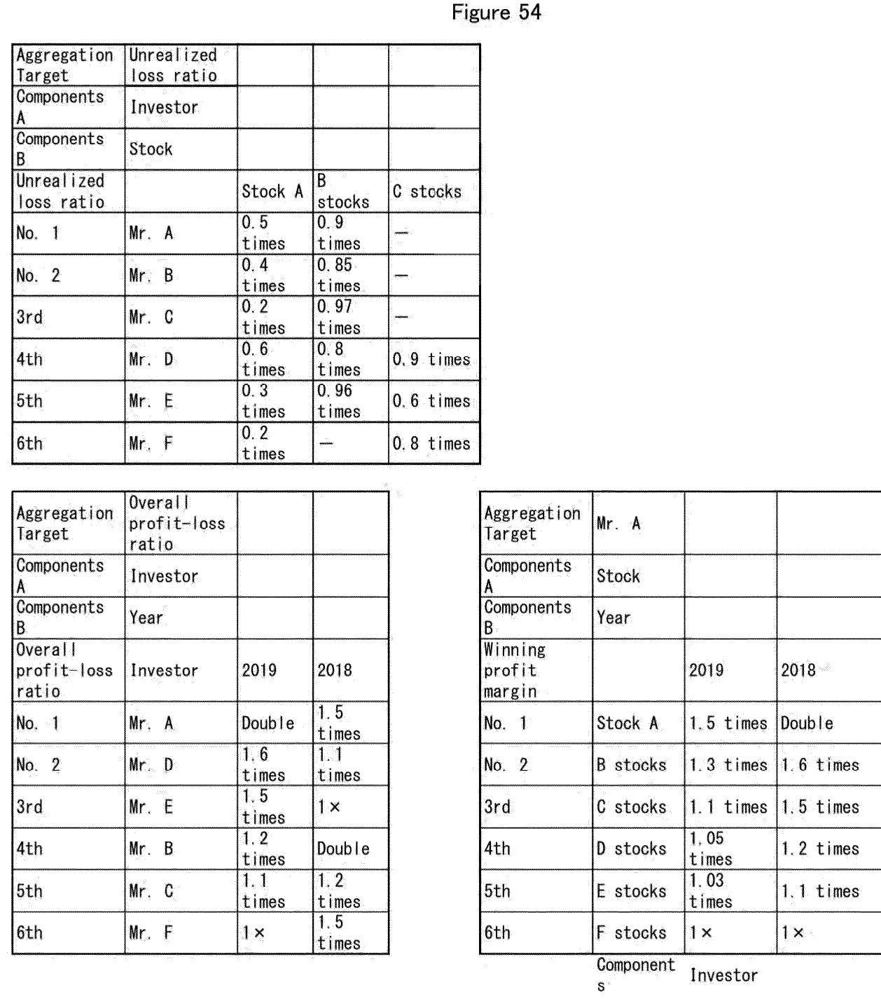

FIG. 54 is a diagram illustrating a specific example of each ranking for each aggregation target according to the present embodiment. The profit-and-loss level valuation indicators is calculated by the information processing system, and the profit-and-loss level valuation indicators are totalized for each totalization target and ranked. If the trading data for A, B, and C are ranked in order of trading profit ratio, the trading profit ratio can be higher in order of C, B, and A. By aggregating each issue (subject to aggregation), it is possible to display the brand ranking with respect to the profit/loss level valuation indicators (for example, the unrealized loss ratio). There are also multiple rankings in which stocks with large unrealized loss ratios become clear at a glance. These are rather media-oriented articles.

By using an investor as a component and using a profit/loss level indicator as an unrealized profit rate, the ranking of the investor's unrealized profit rate can be displayed in the order of the issues. For example, if the trading data for Mr. A's investment products are tabulated, there are Mr. B and Mr. C, and the hypothetical currency, FX, stocks, etc. are the main components of the trading data. Thus, we can see who is the most profitable investor in stocks across the board.

On the other hand, when the issues are used as the axis, the stocks A in Mr. A's virtual currency and C in the stocks that Mr. C has bought and sold are ranked in the same ranking, and the stocks A in Mr. A's virtual currency are ranked in the same ranking, which is an example. Investors, investment types, and investment groups are also components. If stocks are counted, investors, stocks, targets, and so on can also be a dimension. They can be used for individual investors or as media, administrator information, or investment information news.

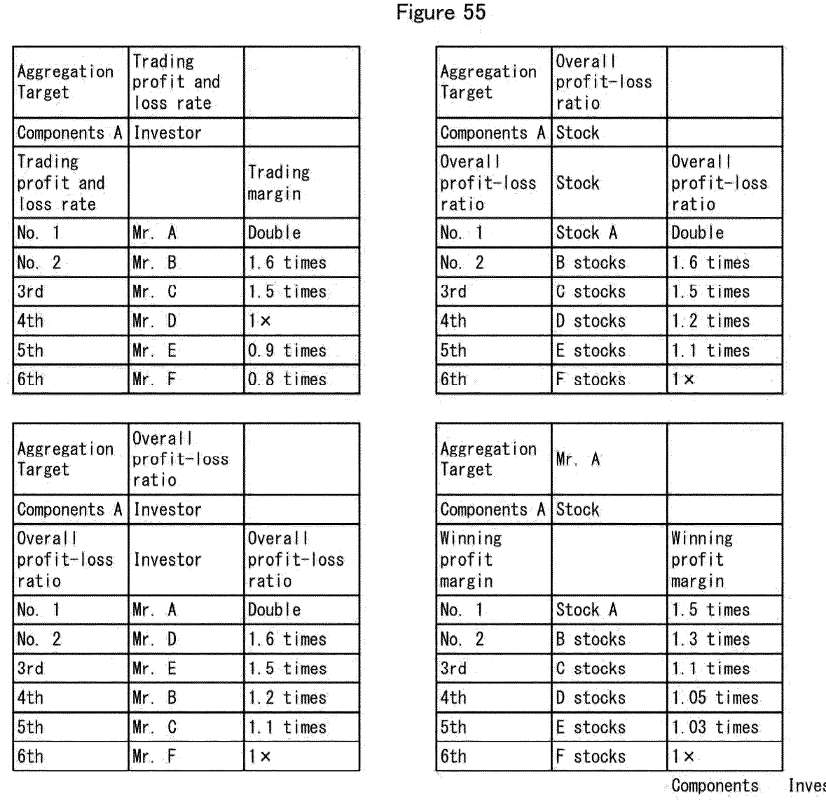

FIG. 55 is a diagram illustrating a specific example of each ranking for each aggregation target according to the present embodiment. For example, by dividing the aggregate target of the excellent stock group and the tabulation target of the high-payments group into the winning margin ranking by the component of the date range, the high-payments group was the highest in 2018. For example, investor A's hypothetical currency is ranked first in the 2019 winning margin ranking for each investor, while investor B's stock A can be ranked second. It can also be used to survey the actual situation of Japanese investors and conduct surveys.

By determining the axis of the aggregate target and the aggregation target to be ranked, it is possible to confirm the state of the multi-dimensional and multi-layered aggregation target. It is defined as the aggregate target type ranking that a plurality of aggregation target trading data are ranked for each aggregation target by using the component as an axis in each profit/loss level valuation indicators.

Three types of ranking processes are explained so far: the ranking process, the multi-layer ranking process, and the aggregation target ranking process. The ranking is the ranking by which datum. The criterion is a profit/loss level valuation indicator, and a component ranking process and a multi-layer ranking process (a plurality of components) are used when the components are ranked, and an aggregate target ranking process is used when the aggregation target is ranked. These are structural differences, but the next level ranking divides profit and loss level indicators by level.

### (Significance of Level Ranking)

Level ranking refers to ranking based on transaction data to be aggregated, calculating profit and loss level valuation indicators for each profit and loss, and ranking based on those profit and loss level valuation indicators. Multilayered rankings can also utilize level rankings, and level rankings can be applied to aggregation-target rankings as well. For this reason, in the multi-layer ranking, the calculation process of the profit/loss level valuation indicators is also included in the aggregation target ranking, and the same process is performed in order to calculate the calculation process by the information processing system of the profit/loss level valuation indicators for each profit/loss level.

Hereinafter, the normal level ranking will be described except in a case where there is a special effect.

### (Level Ranking Problems)

For example, with regard to the ranking of the trading profit and loss ratio for each component target to aggregate, the ranking such as the unrealized profit ratio of the component, etc. is not taken into consideration. The information processing system calculates a profit/loss level valuation indicator according to the profit/loss level from the total profit/loss status to the detailed profit/loss status, and ranks the result, thereby enabling multifaceted and multi-step ranking.

### (Need for Level Ranking)

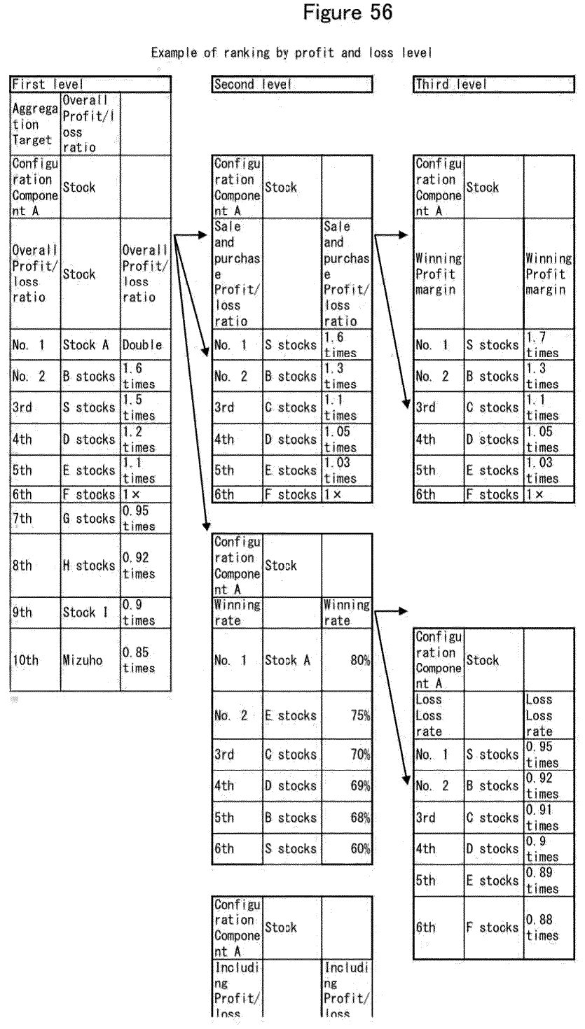

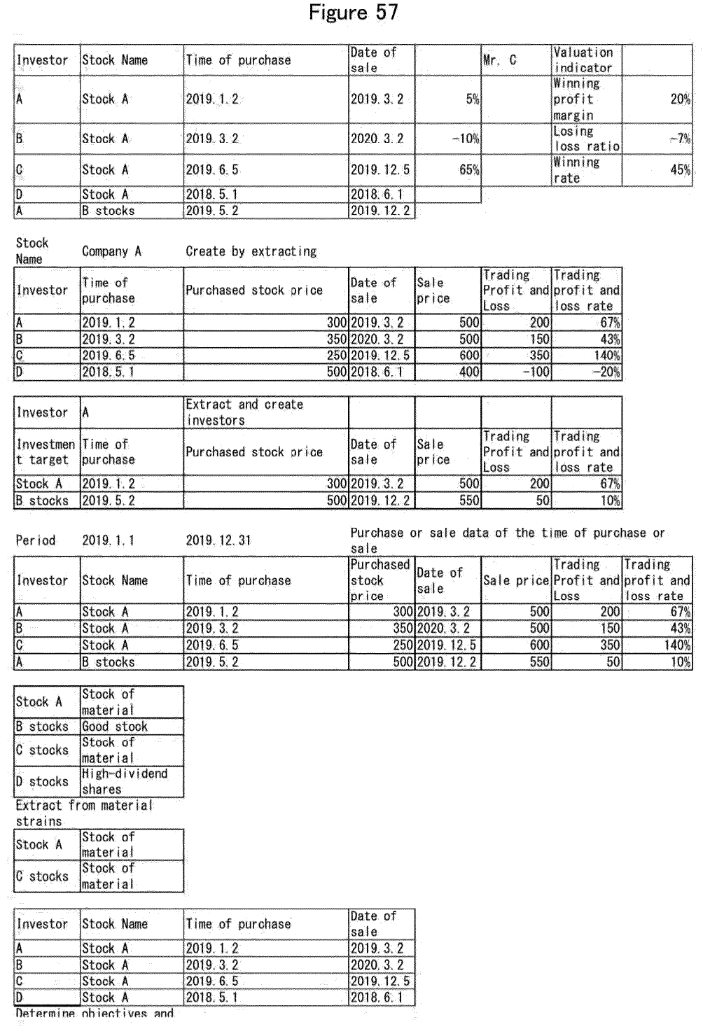

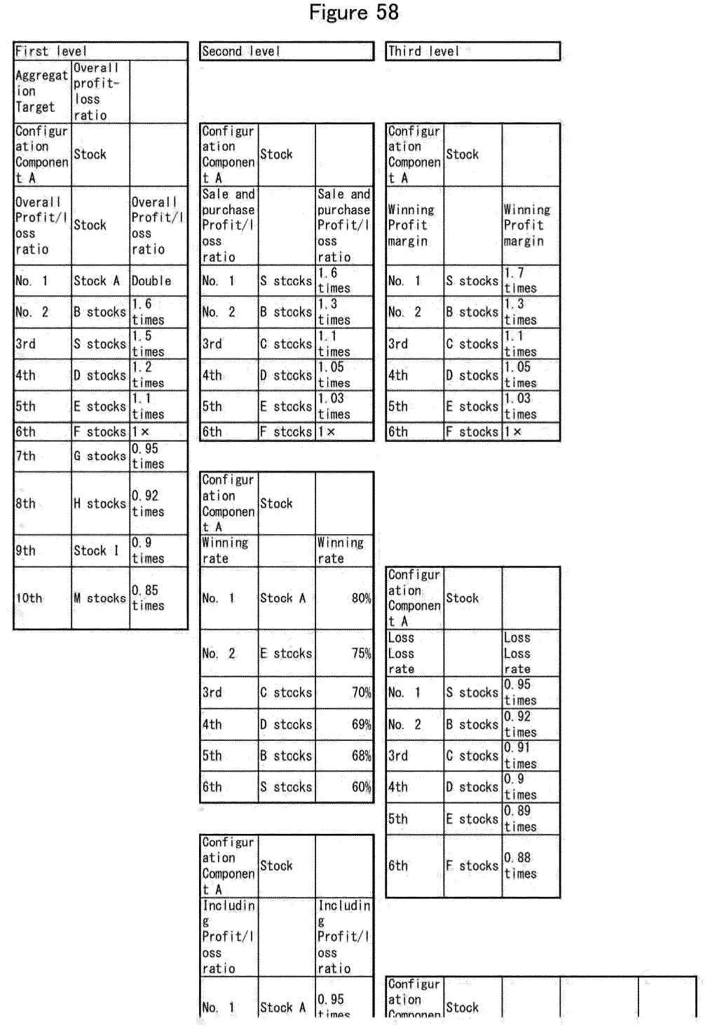

FIG. 56 is a figure illustrating earnings level ranking according to the present embodiment. The profit-and-loss level is divided into four stages according to how it is divided and how it is captured.

For example, the overall outcome of A's investment is the profit and loss at the total profit level (first level), and the profit and loss at the winning level (third level) is the only trade that has already been traded.

In the case of the total profit/loss level, the overall profit/loss ratio ranking is, for example, the comprehensive shallow ranking, i.e., the third place for the S issue and the second place for the B issue. In this case, it is only vague to know which is the outcome of the stock.

As for the second-level winning rate, it is gradually found that the S issue is 6th and the B issue is 5th, and when the S issue is ranked at the third-level winning profit rate, it is found that the S issue is first in the winning profit rate ranking, and the B issue is second in the winning profit rate, and the profit rate is high when the S issue wins. In addition, since the S issue is 1st and the B issue is 2nd in the unrealized loss rate, it is also found that the stock will suffer an unrealized loss if it continues to hold because the value is intense. Thus, it is possible to deeply understand the target of the aggregate. These are more detailed, but they are very valuable information for investors, large investors, hedge funds, and so on.

In comparison with investors, for example, Mr. A's investment results are comprehensively represented by profit and loss at the overall profit level, and profit and loss at the winning trade among the traded trades.

At the total profit/loss level, the overall earnings ratio ranking is, for example, 3 for Mr. A and 10 for Mr. B. On the other hand, when ranked by the third-level winning profit rate, Mr. A is in the fifth place in the winning profit rate ranking, Mr. B is in the first place in the winning rate, Mr. A is in the first place in the winning rate, Mr. B is in the 10th place in the winning rate, etc., and it becomes possible to deeply understand the aggregate object. These information will also become more detailed, but they will become very valuable information for investors, large investors, hedge funds, and other investors in order to achieve investment results.

On the other hand, M stocks rank at a deeper level of profit and loss, such as 3rd place for loss rate and 100 places for winning margin, so that more detailed ranking is possible, and how they win, where weak, and so on. Such information is good for stock magazines, stock newspapers, stock blogs, and so on.

The same is true for all rankings, including stock rankings, investor rankings, type-of-investment rankings, product rankings, and the ranking display of target stock A and group A. These may be one of the necessary information for larger media. Needless to say, the same applies to the component ranking, the multi-layer ranking, and the aggregation target ranking.

### (Action of Level Ranking)

To perform level ranking, follow the procedure below. That is, the information generation unit 3021 performs the overall ranking display by the calculation of the profit and losing level valuation indicators of the total profit and loss, the ranking display by the profit and loss level valuation indicators of the unrealized profit and loss level of the second level, the ranking display such as the profit rate of the win at the level divided into the win and loss of the third level, and the ranking display with the benchmark evaluation value and the like taking into consideration the market value and the benchmark increase and decrease rate after the sale at the fourth level, and the fine ranking display becomes possible for each level.

Even a single stock has a variety of trading methods and is practiced. This diverse set of trading data cannot be accurately ranked unless it is viewed in a multifaceted and multi-phased manner based on the results of various profits and losses. These are used not only for ordinary rankings, but also for component rankings, multi-layered rankings, aggregate-targeted rankings, and the like.

### (Effect of Level Ranking)

The multi-level, multi-step ranking display of the trading data to be compiled is effective in accurately grasping the holding status and trading status of the aggregate target. Since a large number of profit-and-loss level valuation indicators at each level are calculated by the information processing system by the level comparison, component ranking, multi-layer ranking, and aggregate-target ranking, which enable a finer and deeper ranking display in a wide range, are also ranked by the level-based profit-and-loss valuation indicators, thereby achieving more effects.

### (Definition of First Level Ranking)

The first level ranking is a ranking using a total profit-and-loss level valuation indicators used at the total profit-and-loss level.

### (Problems of First-Level Ranking)

The ranking of the targets (e.g., shares) is generally based on technical indicators, performance indicators, etc., but it is not clear what the actual results were. There is no overall picture of whether the stock price is rising but there are many investors who lose money, or whether the investor who actually bought or sold the stock is profitable or not.

### (First-Level Ranking Means)

The information generation unit 3021 calculates various comprehensive profit and loss level valuation indicators for evaluating the aggregate profit and loss of the aggregation target trading data, and ranks the comprehensive profit and loss level valuation indicators for the aggregation target using the comprehensive profit and loss level valuation indicators.

### (Effect of First-Level Ranking)

Ranking the target or component of a total profit/loss using various comprehensive profit/loss level indicators indicates how the subject or component of the total profit/loss is handled in the market, and the ranking of the subject or component in the total loss, profit, profit, and the like can be determined in this year.

Ranking and displaying the aggregate target or component in these comprehensive profit and loss level valuation indicators highlights the trading characteristics of the aggregation target or component and clarifies the ranking results of the aggregation target or component in the various comprehensive profit and loss level valuation indicators. Any trading of the target or component is conducted, and the ranking of the subject or component can be confirmed.

### (Example of First Level Ranking)

For example, A issues have 1.5 times overall profit and loss and rank third. On the other hand, B stocks can be expressed as having an overall profit/loss of 0.85 times and ranking of 10th. For example, in 2019, Mr. A's overall profit-loss ratio was 30% and ranked 10th, and Mr. B's overall profit-loss ratio was 10% and ranked 120.

Ranking (ranking) these comprehensive profit-and-loss level valuation indicators for each such aggregation target or component highlights the trading characteristics of the aggregation target or component and clarifies the ranking of the aggregation target or component in the various comprehensive profit-and-loss level valuation indicators. It is possible to determine the trading characteristics of the target or component. By ranking at the aggregate profit/loss level, it is possible to rank what kind of total profit/loss is caused by the sale or purchase of the target or component.

Since the aggregate profit/loss includes both the trading data in the possession and the trading data, the total profit/loss status of the aggregation target or the component is grasped, and the total profit/loss level valuation indicators is calculated by the information processing system and ranked, so that the overall view of the trading of the aggregation target or the component is known.

### (Second-Level Ranking Problems)

The ranking of the overall profit/loss included in the aggregate of investment products includes the fixed profit traded and the unfixed profit, and therefore only the total ranking can be displayed. The ranking display result obtained from the trading profit/loss level valuation indicators for the trading profit/loss can display, by ranking, what kind of trading is performed, such as a winning ratio, a trading profit/loss ratio, and a trading period which are not known in the overall profit/loss, and what kind of result is obtained.

### (Second Level Ranking Means)

The information generation unit 3021 calculates various trading profit/loss level valuation indicators in order to evaluate the trading profit/loss of the trading data to be aggregated, and ranks and displays the trading status of the aggregation target or the constituent elements using the trading profit/loss level valuation indicators.

### (Effect of Second-Level Ranking)

By using various trading profit and loss level valuation indicators, unrealized profit and loss level valuation indicators for unrealized profit and loss, and the like, ranking and displaying the target or component of such aggregation target or component in the market, the trading situation can be determined by comparing the average trading profit/loss ratio ranking, Retention period ranking, winning ratio ranking, and unrealized profit and loss ratio ranking with other items.

Ranking and displaying the target or component of the aggregate at these levels of profit or loss (or unrealized profit or loss) highlights the trading and holding characteristics of the subject or component, and clarifies the results of the ranking and display at the various levels of profit or loss (or unrealized profit or loss) of the subject or component. It is possible to determine the trading characteristics and holding status of the target or component.

### (Example of Second Level Ranking)

Issues with S stocks had the 1st place in trading profit-loss ratio, 60% in winning ratio, 6th place in unrealized profit-loss ratio, and 5th place. On the other hand, in the B brand, the ranking display for each trading profit/loss (or unrealized profit/loss) level valuation indicators is performed at the trading profit/loss (or unrealized profit/loss) level, in which the trading profit/loss ratio is second, the winning ratio is fifth, and the unrealized profit/loss ratio is 250. In order to display the ranking from the traded data, it is possible to grasp the trading status of the target or component, and it is possible to display the ranking of whether the stock is a stock with a strong short-term trading orientation or a stock with a long medium-term holding period.

### (Problems of Trading Profit Level Valuation Indicators Ranking)

The ranking of the overall profit/loss included in the aggregate of investment products includes the fixed profit traded and the unfixed profit, and therefore only the total ranking can be displayed. The ranking display result obtained from the trading profit/loss level valuation indicators for the trading profit/loss can be ranked and displayed as what kind of trading is performed, such as a winning ratio, a trading profit/loss ratio, and a trading period which are not known in the overall profit/loss, and what kind of result is obtained.

### (Means of Ranking of Trading Profit/Loss Level Valuation Indicators)

The information generation unit 3021 calculates various trading profit/loss level valuation indicators in order to evaluate the trading profit/loss of the trading data to be aggregated, and ranks and displays the trading status of the aggregation target or the constituent elements using the trading profit/loss level valuation indicators.

### (Effect of Trading Profit Level Valuation Indicators Ranking)

By ranking and displaying the target or component of trading profit or loss using various profit-and-loss level valuation indicators, the trading situation can be seen in comparison with other indicators regarding how the target or component of trading profit or loss is handled in the market, the average trading profit/loss ratio ranking, the holding period ranking, and the winning ratio ranking.

Ranking and displaying the target or component in these profit-and-loss level indicators highlights the trading characteristics of the subject or component and clarifies the results of the ranking and displaying of the subject or component in the various profit-and-loss level indicators. It is possible to determine the trading characteristics of the target or component.

### (Specific Examples of Trading Profit Level Valuation Indicators Ranking)

Stock A ranks 100 in profit-and-loss ratio, and 80% in winning ratio, which ranks first. On the other hand, B stocks ranked second in the trading profit/loss ratio and fifth in the winning ratio. Such a ranking indication for each aggregation target or each component is performed at the trading profit/loss level. For the media, for example, which stocks were ranked first in October, and which stocks were ranked first in November. These stocks are regularly generated by the information processing system and updated as needed, so they are accepted as valuable information for investors. In order to display the ranking from the traded data, it is possible to grasp the trading status of the target or component, and it is possible to display the ranking of whether the stock is a stock with a strong short-term trading orientation or a stock with a long holding period in the medium to long term.

### (Problems of Ranking of Unrealized Gain/Loss Level Valuation Indicators)

In terms of unrealized gains and losses, the state of holding and the state of buying and selling are mixed at the overall profit/loss level, so the state of holding and the state of buying and selling are not known in detail. By evaluating the unrealized profit/loss level, we can see the unrealized profit/loss ratio, the average holding period, the average purchase price, and the average profit amount.

### (Means of Ranking Unrealized Gain/Loss Level Valuation Indicators)

The information generation unit 3021 calculates various unrealized profit/loss level valuation indicators in order to evaluate the unrealized profit/loss of the unsold data aggregated for each aggregation target, and ranks and displays the holding status of the aggregation target or the constituent element by using the unrealized profit/loss level valuation indicators.

### (Effect of Ranking of Unrealized Gain/Loss Level Valuation Indicators)

By ranking and displaying the status of ownership of the target or component using various unrealized profit/loss level indicators for unrealized profit or loss, the ownership status of the target or component can be determined.

### (Specific Examples of Ranking of Unrealized Gain/Loss Level Valuation Indicators)

For example, the following ranking display becomes possible.

Stock A ranks first in terms of the percentage of persons with unrealized gains, and the average unrealized gains rate is 50% (1.5 times) and first. On the other hand, for stock B, the number of persons with unrealized losses is 100, and the average unrealized loss ratio is 0.92 times that of the second, and the ranking display results of various unrealized profit/loss level valuation indicators can be displayed.

In addition, Mr. A has a low unrealized profit/loss ratio of negative, ranks 300, and is able to display that he has too much unrealized losses compared to others. These are accepted as valuable information for investors because they can be generated by the information processing system on a regular basis and are updated as needed, for example, in October, which stocks were ranked first in the unrealized profit ratio, and in November, which stocks were ranked first in the unrealized loss ratio. As a result, it is expected that the overall picture of the issues held and the situation will be reflected in the grain difference.

At this level of unrealized profit or loss, the status of the aggregation target or component being held can be ranked. This has the effect that it is possible to grasp the status of the target of the aggregate or the status of holding of the constituent elements as a whole.

### (Third-Level Valuation Indicators Ranking Problems)

The ranking of the investment products relative to the second level target by the aggregate includes winning and losing profits, so that only the total profit/loss ranking and unrealized profit/loss ranking can be displayed.

As the ranking display result obtained from the winning profit level valuation indicators for the winning profit, how the winning profit, the winning profit ratio, the trading price of the winning, the trading period of the winning, and the like which are not known in the trading profit or loss can be ranked and displayed.

### (Means for Ranking Benefit Level Valuation Indicators)

The information generation unit 3021 calculates various winning profit level valuation indicators in order to evaluate the winning profit of the aggregate target trading data, and ranks and displays the trading status of the totaling target or the constituent elements using the winning profit level valuation indicators.

### (Effect of Ranking Benefit Level Valuation Indicators)

By using various winning profit level indicators and other indicators, the target or component is ranked and displayed, and the trading situation is known in comparison with other items such as how the target or component is handled in the market, average winning profit rate ranking, annual winning profit rate ranking, and winning profit ranking.

Ranking and displaying the target or component in the winning profit level valuation indicators highlights the trading characteristics of the subject or component, and clarifies the results of the ranking and displaying of the subject or component in the various winning profit level valuation indicators. It is possible to determine what kind of winning the target or component has been made.

### (Specific Examples of Ranking of Winning Profit Level Valuation Indicators)

Issue A has a win benefit rate of 100, while Brand B has a win benefit level of ranking display for each aggregated object or component such that the win benefit rate ranks second, and the win benefit level metrics. In order to display the ranking from the trading and winning profit recording data, it is possible to grasp the winning direction of the target or component, and it is possible to display the ranking of the winning or winning stocks or the like. These are noteworthy as news articles for the media, for example, because they are regularly generated and updated as needed by the information processing system, such as what issues were won by many investors in 2020 and what issues were largely lost. Investors can accept this information as valuable information because they can see at a glance which stocks are more likely to win and which are more likely to lose.

### (Example of Second Level Ranking)

An example will be described in which a winning trade and a losing trade, that is, a winning profit and a losing loss are separately evaluated from the already-traded data. For example, for winning trades, stock A has 30th place in winning profit, while stock B has 2nd place in winning profit. On the other hand, in the case of losing trades, stock A has an average buy price of 4800 yen and an average sell price of 4500 yen, and the average holding period is 5 days, and the company is forced to cut losses. On the other hand, the losing trade of B stocks was 165 yen, and the average was 157 yen, and the average holding period was 7 days, and the loss was cut. As a result of dividing the traded data into a winning trade and a losing trade and calculating a respective winning profit (or loss) level valuation indicators, it is possible to compare each of the winning trades between the aggregate targets, the comparison between the components, and the aggregation targets (or components) of the losing trades, so that highly meaningful information for each aggregation target (or component) can be obtained for the trader.

The information generation unit 3021 calculates an unrealized profit (or loss) level valuation indicator by dividing the unrealized profit and loss and the unrealized profit, and compares the unrealized profit (or loss) level valuation indicators. For example, A stock with unrealized gains is 80 percent of the holder, with an average profit margin of 70 percent, and an average holding period of one year. On the other hand, only 20% of the shareholders have unrealized gains on B shares, with an average purchase price of ¥150, a profit margin of 10%, and a one-year holding period. Holders of stock A with unrealized losses account for 20%, with an average bid price of ¥5500, an unrealized loss ratio of −10%, and a holding period of six months.

For example, the winning trades of A issues have an average buying price of 4000 yen and a selling price of 4500 yen, and the average profit margin is 12%, which can be expressed as ranking 10 and ranking 100 in the average holding period of 2 weeks.

On the other hand, with respect to the defeat trade, A issues buy at an average price of ¥4800 and sell at an average price of ¥4500, and the loss rate of the defeat trade is negative 8%, ranking No. 1, the average holding period is 5 days, and ranking No. 50 is used.

The information generation unit 3021 divides the traded data into a winning trade and a losing trade, calculates respective winning profit (or loss) level valuation indicators, and performs ranking using the winning profit (or loss) level valuation indicators. It enables the profitability ranking of the winning trades and the loss ratio ranking of the losing trades, so that the average trading period ranking can be shortened and stocks with high average trading profitability can be easily extracted. This will give the trader a very meaningful stock-by-stock information and a strong winning-profit-level index.

The information generating unit 3021 calculates an unrealized gain (or unrealized loss) level valuation indicator by dividing unrealized loss and unrealized gain, and ranks those unrealized gain (or unrealized loss) level valuation indicators.

For example, of the holders of A issues, 80% of the holders recorded unrealized gains, 3rd place in unrealized gains wattling, and 70% of the average unrealized gains ranked first in unrealized gains. On the other hand, only 20% of the shareholders have unrealized gains on B stocks, ranking 250 for unrealized gains on waiting-taking, and ranking 150 for unrealized gains on 10%.

Regarding unrealized losses, on the other hand, the percentage of the holders of stock A with unrealized losses is 20% of the holders, the first ranking (the lower the ranking, the higher the ranking), and the unrealized loss ratio is held to negative 8%. The unrealized loss ratio ranking is 25th. On the other hand, B stocks with unrealized losses account for 80% of the owners, ranking 250 for unrealized losses waiting, only 3% for unrealized losses, and ranking seventh for unrealized losses (the lower the number, the higher the number).

It is effective to obtain information that has not been known in the past, such as the purchase status of the issues held, the status of unrealized gains/losses, and the number of people who have unrealized gains/losses, the ranking of the stocks being ranked, the rate of unrealized gains/losses being higher than other stocks, and the number of stocks being higher. In other words, it is possible to grasp the purchase status and the unrealized profit/loss status of the items to be counted (or components) and obtain information that has not been known to the public, such as how many people have unrealized profits and how much they have purchased and how much they have purchased compared with others.

### (Specific Examples of 4th Level Rankings)

The information generation unit 3021 performs ranking using winning pattern analysis and losing pattern analysis having different characteristics even in the same winning trade at the fourth level. For example, stock A has 80% trading in winning pattern 1 (buy price<sell price<current price), 1 in winning pattern 1 weight, 10% remaining in pattern 2, and 250, 10% pattern 3, and 260 in waiting ranking. Pattern 1 is “buy price<sell price<current value”, so if the weight of the winning pattern of pattern 1 is high, it can be said that stable short-term trading can be easily performed.

Especially, an aggregation target with a high winning profit rate in winning pattern 1 can be said to be a flourishing stock for short-term trading.

On the other hand, in the pattern analysis of B stocks, the lose pattern accounts for the majority, and the pattern of “buy price>sell price>current value”, which is the lose pattern 3, accounts for 80% of the lose pattern, and the lose pattern of 3-way trunking is ranked first, and the number of the losers is very large.

The company sold loss cuts as soon as it bought it, but the loss rate was kept to −2%, and the loss rate ranked in Loss Pattern 3 was five (the lowest) and the loss was frequently cut. However, the loss was suppressed.

### (Ranking Using Unrealized Gain Pattern Level Indicators)

On the other hand, whether unrealized gains are either higher or lower than the benchmark is a significant difference in the implications of the same unrealized gain. Stocks that generate unrealized gains significantly above the benchmark are highly valued, whereas those that generate unrealized losses significantly below the benchmark are undervalued.

For example, stock A has a return significantly above the Nikkei Average over unrealized profits, with a benchmark overtake of 50 percent, a benchmark overtake ranking of third, and stock A's holdings and purchases exceed the Nikkei Average.

On the other hand, in the analysis of the pattern of unrealized gains and losses on B stocks, unrealized losses were recorded, and losses below the Nikkei average were recorded. The benchmark drop rate was 1%, which was almost the same as the Nikkei average. Therefore, it can be said that there was little evidence of ownership.

Even if the target of aggregate exceeds the benchmark, the target of aggregation (or component) is higher than the target of aggregation (or component), and there is an effect of determining the target of aggregation (or component) which is significantly lower than the benchmark should be reviewed. This paper shows an example of ranking display using winning pattern analysis and losing pattern analysis at profit/loss level.

For example, 80% of A stocks are traded in the winning pattern 1 (buying price<selling price<current price), the remaining 10% is pattern 2, and 10% is pattern 3. Pattern 1 is that even after selling at “bid price<offer price<current price”, the stock price is stable and can afford to buy and sell. It is an aggregate target (or component) suitable for short-term trading. On the other hand, the pattern analysis of B shares shows that losing patterns dominate, with losing pattern 3, the “bid price>offer price>current price” pattern, accounting for 80% of the losing patterns. I sold it on a loss-cut basis immediately after buying it, but it is now down, and the pattern that I was better to sell than to keep holding it accounts for a lot.

By using winning pattern analysis and losing pattern analysis in this way, you can see whether you are winning with the same winning trade or finally winning with an aggregation target (or component) that loses profits if you don't sell immediately.

In Pattern 2, cases such as “trade price<current value<sell price” and “current value<buy price<sell price” can have a big effect, such as that the target (or component) of the selection may be bad, although the trading skills may win.

### (Ranking Using Unrealized Gain Pattern Level Indicators)

On the other hand, whether unrealized gains are higher or lower than the benchmark in terms of the rate of increase in the aggregate (or component) in which they are held differs significantly from the benchmark in terms of the same unrealized gains.

For example, stock A has a return significantly above the Nikkei average for unrealized gains, and holding and purchasing stock A has a result that exceeds the Nikkei average.

On the other hand, in the analysis of the pattern of unrealized gains and losses on stocks B, unrealized losses were recorded, which was significantly lower than the Nikkei average. At the moment, there are incorrect choices, but there are dividends, so we need to consider them as well.

Even if they have the same unrealized gains and losses, if they exceed the benchmark, the selection of the target (or component) is correct. Below the benchmark, a strategy can be developed that requires a review of the aggregate targets (or components) in possession.

The information generation unit 3021 calculates a winning pattern level valuation indicator and ranks the issues by the winning pattern level valuation indicators. For example, A issues are ranked third in terms of trading profitability, and B stocks are ranked 100.

The profit-and-loss level is divided into stages, and the ranking of the relevant issues is made based on various profit-and-loss indicators of the trading data at the target profit-and-loss level.

Specific examples of rankings at each level are as follows.

### (Ranking by Issue Using First-Level Integrated Profit and Loss Level Indicators)

In order to compare the traded data, it is possible to grasp the trading situation of the issue, and it becomes possible to rank the issue with a strong short-term trading orientation or the issue with a long medium- to long-term holding period, and it becomes possible to know the issue with a short-term trading orientation, the issue with a medium- to long-term holding, etc. in the ranking situation.

For example, the following ranking can be performed for unrealized profit or loss. Stock A has an average unrealized profit ratio of 50% (1.5 times), a ranking of seventh, a holding period of one year or more, and a holding period ranking of 10. Only 20% of stocks hold unrealized losses, and a ranking of seventh, an average loss of 5%, and an unrealized loss rate ranking of 150.

On the other hand, the majority of B stocks held unrealized losses (70%), ranking 250, and average unrealized losses (5%) are small, but ranking 200 and holding period on average rank 150, with 80% of those still holding unrealized losses as purchased stocks, ranking 300, and so on. It is also possible for the media to provide information that, although B is a well-known and highly dividend-paying stock, it is actually losing its ownership by so many people, or, conversely, A is a non-dividend-paying and unnoticed stock, but those who make real investments have very large unrealized gains. Investors can generate a lot of meaningful information.

### (Ranking by Issue Using Second-Level Profit-Loss Indicators)

At this level of unrealized gains or losses, the status of the issues in question can be ranked. This has the effect of being able to ascertain which stocks have a large unrealized profit rate and which stocks have a large unrealized loss rate.

### (Ranking Using the Third-Level Winning Profit Level Index for Each Issue)

In the third level of ranking, the information generation unit 3021 calculates a winning profit level valuation indicators at a level at which the winning trade and the losing trade, that is, the winning profit level valuation indicators is evaluated by dividing the sold data into the winning profit and the losing loss, and ranks the winning profit level valuation indicators for each issue. The following multi-level ranking process and the aggregation target level ranking are also calculated by the information processing system in the level ranking process.

### (Significance of Component Ranking)

If a stock is included in the aggregate, the stock or investor becomes its component (component included in the aggregation). A component ranking is obtained by ranking the winning profit ratio of each stock in each stock. Aggregating by component includes aggregating with A issues, aggregating with a certain period, aggregating with an investor group, and aggregating with a stock group. When an investor is included in the aggregate, the components include stocks and targets. Then, it is totaled by the products A, B, and the like. When the products are included in the aggregate, the components are stocks, FX, virtual currencies, mutual funds, etc., and it is known which products have the highest profit/loss ratio.

For example, among the issues that are components of stocks, the ranking of the trading profit ratio of A stocks is high, the ranking of the stocks with higher trading profit ratio is high, and the ranking of the unrealized profit ratio is good. Thus, the position of A stocks in the holding status and the trading status with other stocks can be better understood. For example, in the ranking of A issues in the winning profit ratio ranking of the aggregate stock group, the characteristics of A stocks are more obvious. For example, looking at the ranking order of winning profit ratio and the ranking order of losing loss ratio of Investor A and Investor B included in the trading data to be compiled, it is effective to clarify the difference in trading and holding between the two. For example, it is possible to compare the winning profit ratio ranking of each issue of the product called virtual currency with the winning profit ratio ranking of each brand of the investment product called stock.

By checking the ranking of each profit and loss valuation indicators to be tabulated, it is possible to check the status of a multifaceted and multi-layered aggregate target. For example, in the case of stocks, stock A is ranked as high in terms of stock sales margin, ranked 10th, with high profit margin, ranked 20th, and high in terms of short-term sales margin, ranked 15th, as an example.

In the context of the aggregate, Component A's stock results are higher than the average, with a higher transaction margin of 20, a higher unrealized gain of 30, and a higher return. In particular, long-term issues have increased unrealized gains, and short-term trading yields are ranked fifth and significantly higher than the average.

As described above, each profit and loss measure of the investor is ranked. For example, by ranking the unrealized loss ratio, trading frequency, and trading profit ratio for each investor, it becomes possible to grasp the trading situation of investor A, the holding situation, and the situation of the investor.

### (What is the Component to be Tabulated and the Component to be the Axis.)

If a stock is included in the aggregate, the stock or investor becomes its component (component included in the aggregation). Among them, a ranking of each investor is required with respect to the stock, and conversely, a ranking of each stock is required with respect to the investor. Although it is envisioned that two components may be used, three or more components may be used.

Each stock's winning profit rate comprises the winning profit rate of each stock, and each stock's winning profit rate is subdivided by the winning profit rate of each investor, and the ranking is obtained by ranking the winning profit rate of each investor. It is possible to create rankings in a multilayered manner. Investors can determine which are the components of a target, commodity, etc. and which are ranked based on which.

When the products are included in the aggregate, the components are stocks, FX, virtual transitions, mutual funds, etc., and it is known which stocks have the highest profit-and-loss ratio around the hypothetical currency.

### (Components)

A constituent element is defined as an element included in trading data to be tabulated. For example, when the trading data of Mr. A's investment products is included in the aggregate, the hypothetical currency, FX, stock, and the like become the core of the component, and the stock becomes the component of the component. Conversely, on the stock axis, the stock A in virtual currency and the stock B in stock are ranked in the same ranking, and it is also an example that the stock A in virtual currency is the best ranking among the issues with high winning profit margins. Investors, investment types, and investment groups are also components.

If stocks are counted, investors, stocks, targets, and so on can also be a dimension. For example, among the issues that are constituents of stocks, the ranking of the trading profit ratio of A stocks is ranked by how many, and the ranking of A and B, which constitute the trading profit ratio of A stocks, can be displayed in a multi-layer manner to indicate that A is the most profitable person in this stock.

For example, A is the highest profit margin ranking for the best stock group, but it can be ranked as the highest in 2018 if it is divided by the component of the date range.

For example, if the winning profit ratio of investor A included in the transaction data to be tabulated is divided by product, the stock is the highest, and the second is the ranking of the investment trust or the like.

For example, it is possible to rank A in the hypothetical currency as the top stock in the winning profit rate ranking for each stock, and A in the stock as the second place, based on the period of 2019.

By determining the axis of the aggregate target and the component to be ranked, it is possible to check the state of the multi-dimensional and multi-layered aggregation target. For example, stock A is ranked 10th among the shares in terms of trading profitability, and Mr. A is ranked 1st among the shares.

The result of the shares of component A is higher than the average, and the ranking is 20th. Among them, it is possible to express that the trading profit ratio of A issues is the highest and contributes. For example, the ranking of unrealized loss ratio, trading frequency, trading profit ratio, and so on can be carried out for each issue with the investor as the axis, so that the status of the investor, such as trading status and holding status of investor A, can be grasped more.

### (Issues in the AI Ranking Process)

In the above-described ranking process, there is a problem that there are many options to decide which ranking target is used, which profit/loss is used, and which valuation indicators is used to rank. In order to make it easy for anyone to handle it, it is also necessary to select it.

In order to maximize the target profit and loss by taking a step forward from the above-described ranking process, the ranking process evolves into a ranking process by AI learning using machine learning by adding a process of storing the valuation indicators as a variable, a process of finding an optimum solution, and a process of displaying the valuation indicators.

By using the trading data to determine the target profit or loss, we can learn which ranking target and which valuation indicators can be ranked to facilitate changes in the behavior of investors in an easy-to-understand manner, and the optimum, and learn the inferior points in comparison with the trading data in the ranking target. By displaying this learned outcome, AI ranking process will allow AI to find the optimal solution.

As a news article, it is desirable to automatically generate a popular ranking article in an access situation. It is necessary to consider privacy, and it is desired to operate while strict rules are established, since a strange article is generated by the information processing system when access is duplicated. In the case of the automatic distribution of ranked articles using the trading data, if the trading data is updated in one day, the news-like articles are generated by the information processing system because the news-like articles become new information as needed. In today's news, those who hold this possible can automatically generate articles such as how they acted by the information processing system. In the trading data to be counted according to the investments, a trading set in which the target profit or loss is traded yesterday and the trading set in which the issue is traded yesterday is identified with “extraction condition: brand=the brand” as AND condition of “period=today”. If the valuation indicators is set to the number of trades, the ranking of the number of trades, the ranking of the earner (there is a problem in the composites) by the amount of trading profit, and the like can be achieved. When the news is distributed, the news distribution can be used as a trigger to create a mechanism in which these articles can be automatically generated by the information processing system.

### (Action of the AI Ranking Process)

In addition to the ranking process described above, if the target trading data and the target profit or loss are determined, in order to improve the target profit or loss and optimize the target profit or loss, it is possible to carry out a transaction that approaches the optimum solution by displaying valuation indicators that learns and changes which valuation indicators should be ranked optimally, and how to change the valuation indicators. If the number of accesses to the article is added to the data item, the article can be automatically distributed according to the number of accesses.

### (Significance of AI Ranking Process)

In addition to the ranking process described above, changing the metrics adds a process to learn how profits and losses change. A method, software, device, database structure, and learning method that constitute a storage unit that stores the same, valuation indicators that is a variable, a target profit or loss, target trading data (trading data to be aggregated or component trading data), a learning unit, and the like are subject to the invention.

### (Effectiveness of the AI Ranking Process)

By adding an AI process in addition to the ranking process described above, it is possible to perform machine-learning on how to rank target trading data.

### (Specific Examples of AI Ranking Process)

### Example A

For example, in order to improve Mr. A's overall profit and loss, Mr. A's trading data to be aggregated is created, and the total profit and loss level trading data is created (even if it is in the previous process), and the valuation indicators that is a component of the total profit and loss is used as a variable. To optimize Mr. A's overall profit and loss with the goal of improving the target, Mr. A's ranking target and which valuation indicators should be ranked, and which valuation indicators should be ranked, will be learned. If the winning profit rate is optimal as a ranking target and the winning profit rate is changed from the current 4% to 20% with the target of buying and selling of the first-largest winning profit rate, a number of patterns such as an increase in the trading profit of 1 million yen in one year with an 80% probability are displayed, and a combination with a high probability and a large degree of change is set as an example.

### Example B

For example, when it is desired to improve the trading profit and loss of the A brand, the trading profit and loss data of the A brand is collected for each investor by creating the trading data of the components for each investor and targeting the trading profit and loss level trading data of the A brand. Various valuation indicators affecting the trading profit and loss level trading data of the issue A are calculated by the information processing system, and the effects of these various combinations on trading profit/loss are learned. In addition, by learning the holding period of A, the trading profit margin ratio, the trading profit ratio of the person who makes the maximum trading profit, the average holding period, and so on, the persons in the top ranking of A's trading profit and loss are given the suggestion to raise the ranking by showing what kind of trading is being carried out, which valuation indicators is strong, and how it is different from the valuation indicators of the user.

### (Learning of AI Ranking and Generating by the Information Processing System)

### (Purpose)

In which ranking object, if it is ranked based on which valuation indicators, it is learned whether the profit and loss which is the target can be improved.

### (Steps of AI Ranking Process Learning Generation Methods)

There are a step of determining which profit/loss is to be improved, a step of calculating valuation indicators constituting the profit/loss by the information processing system, and a calculation step of calculating a changing profit/loss by a combination of the ranking target, the underlying sales data, and the valuation indicators calculated by the information processing system.

In order to learn what kinds of combinations are to find the optimal solution and which valuation indicators are used to rank them to determine the most likely to be improved, and in order to raise Mr. A's overall profit/loss ratio, we will learn which ranking target should be used as a reference. In this way, we will learn whether each of Mr. B's overall profit/loss ratio and the values of the various valuation indicators that make up it, Mr. C's overall profit/loss ratio and the values of the various valuation indicators that make up it, and Mr. ZTT's overall profit/loss ratio and the values of the various valuation indicators that make up it, is the best or best. Among them, ZA can be expected to be best ranked, and by referring to their trading methods, issues, trading periods, and so on, the way to improve can be clarified.

AI compare process's learn generation steps allow AI to judge that there are a variety of suggestions in the winning-rate ranking, even if there is not much discovery, in the winning-rate ranking.

(Definition of Ranking by Aggregate Target Trading Data by Component with the Investment Target as a Component of the Aggregated Target Trading Data by Investment Target)

An example of the ranking using the information processing system based on the aggregate target trading data by component with the investment target as a component of the aggregated target trading data by investment target is the ranking of stocks in terms of valuation indices such as the profit-loss ratio and the unrealized profit-loss ratio. ˜An example is a case where (investment target) is ranked by the valuation indicators (calculated by the information processing system under the condition) according to −(investment target). One concrete example is that the information processing system ranks stocks by the overall profit/loss ratio for each investment product such as stock and virtual currency, and the information processing system ranks stocks by stock trading profit/loss ratio or winning ratio.

(Effects of Ranking by Aggregate Target Trading Data by Component with the Investment Target as a Component of the Aggregated Target Trading Data by Investment Target)

By processing the investment object in the information processing system based on the transaction data to be counted under conditions such as extraction conditions, classification conditions, or aggregation rules, and further extracting, classifying, or aggregating the investment object according to the investment object, based on the transaction data further processed at the profit-and-loss level, by performing the ranking by the valuation indicators calculated by the information processing system, the ranking in the information processing system by the component-by-component transaction data in which the investment object of the transaction data to be counted by the investment object is used as a component becomes possible. The ranking target may be the ranking of the trading data for each stock in the stock, or the ranking of the stock group by the winning ratio.

(Effects of Ranking by Aggregate Target Trading Data by Component with the Investment Target as a Component of the Aggregated Target Trading Data by Investment Target)

The ranking by the information processing system based on the sales and purchase data of the actual issue is effective in that it is possible to make a multifaceted compare so as not to be compared with the common brand ranking. For example, it can be expressed as follows: “Of the issues, A stocks in stock holdings have a low winning rate of 15% in September, and the winning rate ranking is 3500 out of 3900 stocks, which is a fairly difficult stock.” It can be said that the content is unique to the ranking based on the component-by-component sale data in which the component-by-component sale data investment target of the investment target sale data by the information processing system is used as a component.

(Specific Examples of Ranking by Aggregate Target Trading Data by Component with the Investment Target as a Component of the Aggregated Target Trading Data by Investment Target)

Among stocks, one specific example is to rank each of the valuation (Definition indicators of the stock group, calculate the trading profit/loss ratio, the winning profit ratio, the unrealized loss ratio, and the like by the information processing system, and display the ranking result. of Ranking by Component Sales and Purchase Data in which Investors are Components of Sales and Purchase Data Subject to Tabulation by Investment Subject)

An example of the ranking based on the component-by-component trading data in which the investors of the trading data to be aggregated by the investment object are included is that the trading of the investor is ranked by the valuation indicators such as the trading profit/loss ratio and the unrealized profit/loss ratio calculated by the information processing system in question in the trading of the A issue. ˜It is also an example of a case where (investment target) is ranked by the information processing system using valuation indicators (calculated by the information processing system under the condition) for each of −(investor). One specific example is to rank shares in the information processing system at the overall profit/loss ratio of the investor in the trading of A issues, or to rank shares in the information processing system at the profit/loss ratio or the winning ratio for each investor.

(Effects of Ranking by Component Sales Data with Investors as Components of Trading Data Subject to Tabulation by Investment Subject)

By narrowing down an investment target by an extraction condition, a classification condition, or a aggregation rule in the information processing system based on the aggregation target trading data, and further extracting, classifying, or aggregating the trading data for each investor, based on the target trading data further processed at the profit/loss level, and performing ranking by valuation indicators calculated by the information processing system, it is possible to rank the trading data for each component including the investor of the aggregation target trading data for each investment target as a component. The ranking target may be the ranking of the profit-loss ratio of the investor in the trading of the name A, or the ranking of the stock by the winning ratio of the investor.

(Effects of Ranking by Component Sales Data with Investors as Components of Trading Data Subject to Tabulation by Investment Subject)

The ranking by the information processing system based on the sales and purchase data of the actual issue has an effect of possible a concrete and unprecedented ranking. For example, in 2020, Mr. A was ranked 100 out of 15000 shares, and Mr. A was able to express the ranking of 900 in this ranking.

(Specific Examples of Ranking by Component Sales Data with Investors as Components of Trading Data Subject to Totalization by Investment Target)

One specific example is to create an investment group divided into groups, such as a group of outstanding investors, a group of middle-performing investors, and a group of poor-performing investors, rank them by valuation indicators, calculate the trading profit/loss ratio, the winning profit ratio, the unrealized loss ratio, and the like by the information processing system, and display the ranking result.

The first step is the step of acquiring trading data, followed by a trading data creation phase. The second step is the step of creating transaction data to be aggregated. The third step is a step of creating the component-by-component sale data. The fourth step is a step of creating profit and loss level trading data. The fifth step is a calculation selection step of the valuation indicators by the information processing system. The operation phase is a phase of “what to do” using the valuation indicators extracted and selected in the fifth step, and regardless of the order relationship with other steps.

The sixth step is an evaluation step. The seventh step is a comparison step with. The eighth step is a ranking step. The ninth step is the present step, and it is defined as the diagnosis step that the evaluation step, the ranking step, and the comparison step are comprehensively judged and diagnosed. The diagnosis display process is defined as displaying the contents diagnosed in the diagnosis step in a diagnosis report, a table, a graph, or the like.

### (Diagnosis)

The term comes from the doctor's examination of the patient to determine the condition, which is determined by looking at where the metrics are faulty.

### (Problems of the Diagnostic Process)

For investors, it is difficult to compare what is better than other investors, and where is it worse than the best-performing investors?, and it is difficult to judge where there are defects and where profits and losses are not improving.

### (Effect of Diagnostic Process)

Diagnosis is facilitated by following the process as shown in the definition of a diagnostic process. Through the comparison process, the ranking process, and the evaluation process, it is possible to clarify the known defect and determine which valuation indicators is worse than the others. In order to clarify the defect, there is a method in which, in comparison with the average value of the valuation indicators, the valuation indicators which is lower than the average is limited, the ranking based on the valuation indicators is determined, and in particular, the valuation indicators which is inferior to the other is identified.

### (Effect of Diagnostic Process)

In this diagnostic process, we can see which metrics should be targeted and improved.

### (Specific Example of the Diagnostic Process)

In the diagnosis result of Mr. A, each valuation indicators is calculated by the information processing system, an average value of each of the valuation indicators is calculated by the information processing system, a deviation rate from the average value is calculated, and valuation indicators having a large negative deviation rate (inferior to the average value) is specified as valuation indicators having a large room for improvement.

### (New Method of AI Machine Learning Diagnostic Process)

AI machine-learning comparing process is performed through the following process.

The first step is the process of creating trading data to be aggregated. The second step is the creation of component trading data (which may be omitted). The third step is the process of creating a profit-and-loss level measure (three methods are used to calculate the target measure). By this third stage, the target profit and loss and the target trading data are determined.

In the fourth stage, valuation indicators that affects the target profit or loss (such as total profit or loss or trading profit or loss) determined in the third stage is calculated by the information processing system. The fourth stage may be included in the third stage or may be a separate stage (optional). By the fourth stage, the target profit/loss, the target trading data (data structure), and the valuation indicators that is a variable are determined.

In the fifth stage, the comparison step, the ranking step, and the evaluation step are performed on the sales data, the target profit and loss, and the valuation indicators calculated by the information processing system. The sixth step is to learn and memorize these results and identify which metrics to focus on in order to improve the target profit or loss. The seventh stage is a display step of creating a report, a table, a graph, and the like which summarize the results of the diagnosis.

### (Problems of AI Diagnostic Process)

In the above-described diagnosis process, there is a problem that there are many options to use which ranking target to compare with whom, which profit/loss is to be diagnosed, and which valuation indicators to be used.

In order to maximize the target profit and loss (the target decided in the third step) from the above-mentioned diagnostic process, the diagnostic process evolves into a diagnostic process based on AI learning using machine learning by adding a process of finding an optimal solution by using valuation indicators as a variable, a target profit and loss which changes when a variable is changed, a process of storing those when a variable is changed, an efficient variable to be changed, and a process of displaying the optimal solution.

By using trading data to determine the target profit or loss, we can learn which diagnostic results are best and what is worse than other trading data. By displaying this learned outcome, AI diagnostics process will allow AI to search for the optimal solution.

### (Effect of AI Diagnostic Process)

In addition to the diagnostic process described above, if the target trading data and the target profit or loss are determined, in order to improve the target profit or loss and optimize the target profit or loss, it is possible to carry out transactions that bring them closer to the optimal solution by displaying how to change the valuation indicators and the valuation indicators that learn and change what to optimize which evaluation object should be improved.

### (Significance of the AI Diagnostic Process)

In addition to the diagnostic process described above, changing the metrics adds a process to learn how profits and losses change. A method, software, device, database structure, and learning method that constitute a storage unit that stores the same, valuation indicators that is a variable, a target profit or loss, target trading data (trading data to be aggregated or component trading data), a learning unit, and the like are subject to the invention.

### (Effect of AI Diagnostic Process)

By adding an AI process in addition to the above-described diagnostic process, it is possible to perform machine-learning on how to diagnose target trading data.

### (Examples of AI Diagnostic Processing)

### Example A

For example, in order to improve Mr. A's overall profit and loss, Mr. A's trading data to be aggregated is created, and the total profit and loss level trading data is created (even if it has been brought to the previous process), and the valuation indicators, which is the component affecting the total profit and loss, is used as a variable. In order to optimize Mr. A's overall profit and loss with the goal of improving, Mr. A's valuation indicators is learned which valuation indicators should be improved and which valuation indicators should be optimized. It can be diagnosed that the winning profit rate is optimal as a diagnosis target, and that it must be changed from the selection of the issue in order to do so. Since the average trading profit ratio is higher for Y than for A, and the winning profit ratio is also higher, it may be necessary to prompt the selection of such a stock. A high-margin stock ranking may also be presented as a result display.

If it is judged that it is optimal to target for improvement in the unrealized loss ratio, it is an example of how many patterns such as providing the diagnosis result that it is important to change the current possession status are displayed, and aiming for a combination with a high probability and a large degree of change.

### Example B

For example, when it is desired to improve the trading profit and loss of the A brand, the trading profit and loss data of the A brand is collected for each investor by creating the trading data of the components for each investor and targeting the trading profit and loss level trading data of the A brand. The information processing system calculates various valuation indicators affecting the trading profit and loss level trading data of the A issue. The information processing system learns the effects of these various combinations on trading profit/loss, and learns the holding period of the A issue, the trading profit ratio, the trading profit ratio and the average holding period of the person who makes the maximum trading profit, etc., and provides diagnosis results including how to improve the numbers among several indices, compare, and ranking.

### (How to Generate Learning for AI Diagnostics)

### (Purpose)

Learn which valuation indicators can be improved to improve the target profit or loss.

### (Steps of AI Diagnostic Process-Learning Generation Methods)

The following are the themes: A step which decides which profit and loss are to be improved; A step which calculates valuation indicators which has an influence on the profit and loss by the information processing system concerned; A step which calculates the profit and loss which changes according to the combination of the underlying sales data and the valuation indicators calculated by the information processing system concerned; A step which learns what kind of combination is to find the optimal solution; A judges what kind of diagnosis is to make the greatest room for improvement; and A's overall profit and loss ratio is to be presented, and it learns whether the diagnosis result is optimal.

### (Significance of Diagnostic Process)

The information generation unit 3021 calculates valuation indicators from the aggregate target trading data, diagnoses the totalization target with the valuation indicators, and displays a report of the diagnosis result on the display unit 23 of the terminal 2. Diagnosis is a process that uses profit and loss level valuation indicators to grasp the status of holding and trade/selling targets and to obtain useful information for advice.

### (Problems of the Diagnostic Process)

Diagnosis of investment products is based on technical indicators, performance indicators, etc. Diagnosis using profit/loss level valuation indicators has completely different effects.

For example, a variety of diagnostic results will be obtained for stocks and investors, including stocks that are heavily profitable by many people, stocks that are well profitable by short-term trading, stocks that are rapidly increasing by people who have unrealized losses, and how to make the winning pattern stronger. The same applies to the diagnosis result of the investor, the diagnosis result of the virtual currency, and the like, and various constituent elements and the aggregate target are diagnosed as the diagnosis target from the calculation target trading data. As a result of various trading, it is a diagnosis result of the diagnosis object which appears, and since these are derived from the analysis result of the trading data first, the diagnosis result comes out from the result of the actual trading.

### (Means of Diagnostic Process)

In the information presentation system 10, the information generation unit 3021 calculates a profit/loss level valuation indicator and causes the display unit 23 of the terminal 2 to display a diagnosis result of the holding status and the trading status of the aggregation target using the valuation indicators.

### (Effect of Diagnostic Process)

The information generation unit 3021 uses the profit/loss level valuation indicators to diagnose the holding status and the trading status of the aggregation target or the component. The information generator 3021, for example, says, “A stock has a high trading profit ratio and a high unrealized profit ratio, and many people are making a profit. In particular, the longer the holding period, the larger the unrealized profit, and the relatively higher the profit rate of short-term trading. and other diagnostic results for each issue. Information Generator 3021 says, “Mr. A has a high trading profit margin and a high unrealized profit margin, and his profits are increasing. Especially in stocks with long holding periods, unrealized profits are growing, and profit margins on short-term trading are relatively high. and other diagnostic results for each investor.

The diagnosis process is a process for comprehensively judging the trading situation and the holding situation to be tabulated by using a plurality of profit/loss level valuation indicators, etc., to grasp good points and bad points, and to improve the points by advising the bad points. There are a variety of diagnostic targets, including not only investors and stocks, but also products, stocks, types of investors, and groups of investors.

### (Specific Example of the Diagnostic Process)

As shown in FIGS. 101 and 102, if various conditions are added in FIG. 101, a data set according to the purpose is created, the necessary valuation indicators is calculated, and the valuation indicators according to the purpose is calculated, so that the target can be easily diagnosed with various conditions and various forms of valuation indicators even in this step. This process is only one step shown in FIG. 102, but since the evaluation target and the valuation indicators have been determined in a series of cooperation, the evaluation target described in this specification can be diagnosed with many forms of valuation indicators.

### (Significance of the Level Stage Diagnostic Process)

The profit/loss level is divided into levels, and a multistage diagnosis can be performed by performing a diagnosis of the aggregation target or the constituent element based on various profit/loss level valuation indicators of the sales data at the target profit/loss level. Diagnosis at this profit-and-loss level allows for a more gradual and deeper diagnosis.

### (Problems of the Level Stage Diagnostic Process)

For example, in the diagnosis of the trading profit/loss level valuation indicators of the aggregate target or the component, the diagnosis of the aggregation target or the holding status of the component or the like is not performed. By calculating valuation indicators according to the profit-and-loss level from the overall profit-and-loss status to the detailed profit-and-loss status by the information processing system concerned and performing diagnosis, multifaceted and multistage diagnosis becomes possible.

### (Need for Level Stage Diagnostic Process)

For example, the diagnosis of A issues based on the overall profit/loss level is a shallow diagnosis in which, for example, the average profit/loss ratio is 50% and many people are making profits. On the other hand, if we examine it to the fourth level, 30% of all shares of stock A have unrealized gains, many of which have been held for more than one year. Investors who frequently trade and make profits also have high turnover, and the one-year rate of return is more than 50%.

### (Action of the Level Stage Diagnostic Process)

Level staging is performed in the following procedure. That is, the information generation unit 3021 performs a comprehensive diagnosis by calculating the comprehensive profit/loss level valuation indicators, and performs a wide diagnosis to a fine diagnosis, such as a diagnosis based on the second level of unrealized profit/loss and the trading profit level valuation indicators, and a diagnosis based on the third level of winning profit and loss levels. There are various methods of buying and selling, and they are practiced even in one tabulation target. This diverse set of trading data cannot be accurately diagnosed unless it is viewed in a multifaceted and multi-step manner based on the results of various profits and losses.

### (Effects of the Level Stage Diagnostic Process)

By performing multifaceted and multi-effect diagnosis on trading data compiled for each compilation target, it is possible to accurately grasp the status of possession and trading of the compilation target. The level stage diagnosis enables a finer and deeper diagnosis in a wide range because a large number of profit/loss level valuation indicators at each level are calculated by the information processing system.

### (Summary of Diagnostic Report Generated by the Information Processing System Automatically)

A diagnosis system generated by the information processing system is summarized in the previous results. The content is displayed in such a way that a list of various results, comparative results, ranking results, and the like presented by the holding status evaluation, including various methods of creating trading data such as various extraction conditions, target profit and loss, various valuation indicators, KPI, and the like, can be displayed.

(Issues with Conventional Methods)

In the third embodiment, there is a description of the automatic generation in the report of the comprehensive diagnosis. In the information processing system, since all information is linked with a database, data linked with each other can be easily extracted, and there are numerical data, text data, and table and graph data.

### (Action of Diagnostic Report Automatically Generated by the Information Processing System)

For example, Investor A's 2020 Diagnostic Report is generated in the following manner: Extraction conditions: 2020, as investor=investor A, target profit/loss=total profit/loss, and the target trading data is specified by the period-based trading data. From there, valuation indicators related to the overall profit and loss are calculated by the various information processing systems. KPI is determined from the valuation indicators calculated by the various information processing apparatuses. These information may or may not be submitted to the results report, but such a system is running behind. Then, the results of the evaluation of the holding status (various information on the issues held) and the results of the evaluation of the trading status become the core, and the report is formed. Compare and ranking reports are added to complete the diagnostic report. These are all carried out in cooperation system rather than discrete, what later in a problem how to display, which may be carried out in the display step, it may be carried out here. All the numerical data and the text are arranged at appropriate places, and a diagnosis report generated by the information processing system is automatically generated.

### (Effect of Diagnostic System Generated by the Information Processing System Automatically)

The compilation up to now will be output in this report. Of course, since the amount of information is enormous and it becomes a report that is difficult to read unless it is selected, a mechanism that can be automatically generated by the information processing system while controlling selection is desired. For the user, it is convenient for the administrator to immediately grasp Mr. A's status in 2020, and for Mr. A to have such a list of reports. The data generated by these information processing systems is updated every day, so that the contents of today's and tomorrow's reports change dynamically. By recording the daily data in the storage unit 33, it is possible to easily compare the current diagnosis report of the diagnosis report of one month ago, and the diagnosis report generated by the information processing system is a service unique to the information system that can be formed in conjunction with a consistent system in a highly convenient automatic manner.

### (Specific Example of a Diagnostic System Generated by the Information Processing System Automatically)

In addition to Mr. A's diagnostic report, a diagnostic report for A's brand, a diagnostic report for the date tray type, a diagnostic report for investment products in 2020, a diagnostic report for buying and selling using technical indicators, and a diagnostic report for each brand in 2020. If you change the various conditions, the number of diagnostic reports will be automatically generated by the information processing system, so if you wish to create a huge number of diagnostic reports, you can create a huge amount of diagnostic reports. In reality, indispensable items are selected, and the report is automatically generated.

(Definition of Diagnosis by Aggregate Target Trading Data by Component with the Investment Target as a Component of the Aggregated Target Trading Data by Investment Target)

An example of a diagnosis using the information processing system based on aggregate target trading data by component with the investment target as a component of the aggregated target trading data by investment target is used as a component is to diagnose shares by brand using valuation indicators such as a trading profit-loss ratio and an unrealized profit-loss ratio. ˜The case where (investment target) is diagnosed by the valuation indicators (calculated by the information processing system according to the applicable conditions) for each (investment target). One concrete example is that the information processing system diagnoses issues with an overall profit/loss ratio for each investment product such as stocks and virtual currencies, and the information processing system diagnoses stocks with a trading profit/loss ratio and a winning ratio for each brand.

(Effects of Diagnosis by Aggregate Target Trading Data by Component with the Investment Target as a Component of the Aggregated Target Trading Data by Investment Target)

By processing an investment object in the information processing system by the extraction condition, the classification condition, or the condition such as the aggregation rule based on the aggregation object trading data, and further extracting, classifying, or aggregating according to the investment object, based on the trading data further processed at the profit-and-loss level, and performing diagnosis by the valuation indicators calculated by the information processing system, it is possible to perform diagnosis in the information processing system by the component-by-component trading data in which the investment object of the aggregation object trading data by the investment object is a component. The ranking target may be a diagnosis of trading data for each stock in the stock, or the stock may be diagnosed with a winning ratio for the stock group.

(Effects of Diagnosis by Aggregate Target Trading Data by Component with the Investment Target as a Component of the Aggregated Target Trading Data by Investment Target)

It is effective that the diagnosis by the information processing system based on the sales and purchase data of the actual issue can be made so diversified that the diagnosis is not compared with the common brand diagnosis. For example, among the issues, the win rate for holding A in September was low at 15%, and the win rate ranking was 3500 out of 3900 stocks, all of which were struggling. On the other hand, stock Z had a high win rate of 80% in September, which makes it possible to express the situation in a way that it is possible to compete for a superior at this time. It can be said that the content can be said to be a diagnosis based on the component-specific trading data in which the component is the component-specific trading data in which the investment-target trading data in the investment-target trading data by the information processing system is used.

(Specific Examples of Diagnosis by Aggregate Target Trading Data by Component with the Investment Target as a Component of the Aggregated Target Trading Data by Investment Target)

Among stocks, one specific example is to diagnose each valuation indicators of a stock group, calculate a trading profit/loss ratio, a winning profit ratio, an inclusion loss ratio, and the like by the information processing system, and display a diagnosis result for each stock group.

(Definition of Diagnosis by Component-by-Component Sales Data in which Investors are Components of Trading Data Subject to Tabulation by Investment Target)

An example of the diagnosis based on the component-by-component trading data including the investors in the trading data to be aggregated according to the investment object is to diagnose the trading of the investor of the A brand by the valuation indicators such as the trading profit/loss ratio and the unrealized profit/loss ratio calculated by the information processing system. ˜An example is a case where (an investment target) is diagnosed by the information processing system using valuation indicators (calculated by the information processing system according to the condition) separately from (the investor). One specific example is to diagnose shares by the information processing system based on the overall profit/loss ratio of each investor of the A issue, or to diagnose shares by the information processing system based on the profit/loss ratio and the win ratio for each investor.

(Actions of Diagnosis by Component-by-Component Sales Data with Investors as Components of Trading Data Subject to Tabulation by Investment Target)

The information processing system narrows down the investment target by an extraction condition, a classification condition, or an aggregate rule based on the aggregation target trading data, and further extracts, classifies, or aggregates the trading data for each investor, and performs diagnosis using the valuation indicators calculated by the information processing system based on the target trading data further processed at the profit/loss level. As a result, it is possible to perform diagnosis using the component-specific sales data in which the investor of the transaction data to be counted by the investment object is used as a component. It may be a diagnosis of the profit-loss ratio of the investor in the trading of the stock A, or it may be a diagnosis of the stock by the winning ratio of the investor.

(Effects of Diagnosis by Component Sales Data with Investors as Components of Trading Data Subject to Tabulation by Investment Target)

It is effective that the diagnosis by the information processing system based on the sales and purchase data of the actual issue becomes concrete and an unprecedented diagnosis becomes possible. For example, in 2020, Mr. A was ranked 100 out of 15000 shares, and the profit margin was ranked 900, indicating that the profit margin was overwhelmingly higher than the average, but it is often possible to miss the determination of profit.

(Specific Examples of Diagnosis by Component Sales Data with Investors as Components of Trading Data Subject to Tabulation by Investment Target)

One specific example is to create an investment group that is divided into a group of outstanding investors, a group of medium-performing investors, and a group of poor-performing investors, diagnose the group with valuation indicators, calculate the trading profit/loss ratio, the winning profit ratio, and the unrealized loss ratio using the information processing system, and display the diagnosis result.

The first step is the step of acquiring trading data, followed by a trading data creation phase. The second step is the step of creating transaction data to be aggregated. The third step is a step of creating the component-by-component sale data. The fourth step is a step of creating profit and loss level trading data. The fifth step is a calculation selection step of the valuation indicators by the information processing system. The operation phase is a phase of “what to do” using the valuation indicators extracted and selected in the fifth step, regardless of the order relationship with other steps.

The sixth step is an evaluation step. The seventh step is a comparison step with. The eighth step is a ranking step. The ninth step is a diagnostic step. The tenth step is an advice step, and the eleventh step is a display step.

### (Significance of Advice Process)

In the information presentation system 10, the information generation unit 3021 computes the profit/loss level valuation indicators from the aggregate target sales data, and displays the advice result based on the diagnosis result, the ranking result, the comparison result, and the like using the valuation indicators on the display unit 23 of the terminal 2. The advice is to display the advice result using the evaluation result, ranking result, comparison result, diagnosis result, etc. using the profit/loss level valuation indicators, etc. as the judgment material. Components of the trading data include dates, issues (groups), products (groups), investors, investor types, investor groups, and so on.

### (Advice Process Challenges)

Advice for each component or subject to aggregate of investment products is advised by technical indicators, performance indicators, etc. However, advice for each component or subject to aggregation based on the results of diagnosis, ranking results, comparison results, evaluation results, etc. of the relevant aggregation subject or component using the valuation indicators obtained from the sales data has completely different effects.

### (Advice Process Means)

In the information presentation system 10, the information generation unit 3021 displays the advice result on the display unit 23 of the terminal 2 based on the diagnosis result using the profit/loss level valuation indicators, the ranking result, the comparison result, the evaluation result, or the like.

### (Effect of Advice Process)

The information generating unit 3021 displays the results of advice from the audit results, ranking results, comparison results, evaluation results, etc. of the holding status or trading status of the target or component in question using the profit and loss level valuation indicators. By giving advice based on the diagnostic results, ranking results, comparison results, evaluation results, etc., it is possible to display advice that matches the status of the target or component in question.

### (Specific Example of Advice Process)

For example, “A stock has a high trading profit ratio and ranks 5th in the ranking, and has a high unrealized profit ratio and ranks 3rd in the ranking, with many people making a profit. In particular, the longer the holding period, the larger the unrealized profit, and the relatively higher the profit rate of short-term trading. Provide advice to Mr. A based on the results of diagnoses, rankings, and comparisons, such as

Mr. A's trading situation for stock A is not profitable, with a low trading profit margin and a low unrealized profit margin. Compared to others, it is clearly inferior, and there is much room for improvement. First of all, with regard to A-issue stocks, it is recommended to go for the push, and even if the stock rises, do not easily take profits and continue to hold it for a little longer. Display the results of the advice with the information generating unit 3021 provides advice based on the diagnosis result, the ranking result, the comparison result, and the like for each investor or investment object.

As shown in FIGS. 101 and 102, if various conditions are added in FIG. 101, a data set according to the purpose is created, the necessary valuation indicators is calculated, and the valuation indicators according to the purpose is calculated, so that the target can be easily advised by various conditions and various forms of valuation indicators even in this step. This process is just one step in FIG. 102, but since the evaluation target and the valuation indicators have been determined through a series of collaborations, the evaluation target described in this specification can be advised by many forms of valuation indicators.

### (New Method of AI Machine Learning Advisory Process)

AI machine-learning comparison process is performed through the following process.

The first step is the process of creating trading data to be aggregated. The second step is the creation of component trading data (which may be omitted). The third step is the process of creating a profit-and-loss level measure (three methods are used to calculate the target measure). By this third stage, the target profit and loss and the target trading data are determined.

In the fourth stage, valuation indicators that is a component of the target profit/loss (such as total profit/loss or trading profit/loss) determined in the third stage is calculated. The fourth stage may be included in the third stage or may be a separate stage (optional). By the fourth stage, the target profit/loss, the target trading data (data structure), and the valuation indicators that is a variable are determined.

In the fifth stage, it is defined as a diagnosis step that the evaluation step, the ranking step, and the comparison step are comprehensively judged and diagnosed. In the sixth step, it is the advice step that the valuation indicators to be improved is identified in the diagnosis step, and in fact, the change of the trading behavior of the user is promoted by showing the result when the valuation indicators is improved.

The sixth stage is the seventh stage in which the advice result which is the optimal solution is displayed in an appropriate display method. Examples include a table, a pie chart, a component ranking display, and a ranking display.

### (AI Advice Process Challenges)

In the above-mentioned advice process, there is a problem in that there are many options to decide which targets to be tabulated, which profit and loss are to be used, and which valuation indicators is to be used to advise.

Advice processes evolve into AI learning-based advice processes using machine learning by adding a process of storing valuation indicators as a variable, a process of finding an optimal solution, and a process of displaying the valuation indicators in order to maximize the target profit and loss, one step ahead of the advice process described above.

By using trading data to determine the target profit or loss, we can learn which advice results are best, and what is worse than other trading data. By displaying this learned outcome, AI diagnostics process will allow AI to search for the optimal solution.

### (Actions of AI Advice Process)

In addition to the advice process described above, if the target trading data and the target profit or loss are determined, in order to improve the target profit or loss and optimize the target profit or loss, it is possible to carry out transactions that bring the optimal solution closer to the optimal solution by displaying how to change the valuation indicators and the valuation indicators that learn and change the optimal evaluation object.

### (Significance of Advice Process)

In addition to the advice process described above, changing metrics adds a process to learn how profits and losses change. The present invention is directed to a method, software, device, database structure, and learning method that are components of a storage unit that stores the same, valuation indicators that is a variable, a target profit or loss, target trading data (trading data to be aggregated or component trading data), a learning unit, and the like.

### (Effect of Advice Process)

In addition to the above-mentioned advice process, AI process is added, and the machine-learning is performed to determine how the optimal solution is to advise the target transaction data.

### (Specific Example of Advice Process)

### Example A

For example, if we want to improve Mr. A's overall profit and loss, we will create the trading data for Mr. A's aggregate and buying/selling data for the overall profit and loss level (even if you have it in the previous process), use the valuation indicators that is a component of the overall profit and loss as a variable, and in order to optimize with the goal of improving Mr. A's overall profit and loss, we will learn which aggregation target and which valuation indicators should be improved, and which valuation indicators should be improved. Increasing the difference between the winning margin and the losing loss rate is the best diagnostic target, and changing the difference between the winning margin and the losing loss rate from the current 2% to 30% with the goal of buying and selling the first largest winning margin and losing loss will increase the trading profit of 1 million yen with an 80% probability in one year. At 10%, the trading profit of 0.3 million yen increases with a 70% probability. By changing the target number, for example, it is possible to show how much the target profit or loss changes.

### Example B

For example, when it is desired to improve the trading profit and loss of the A brand, the trading profit and loss data of the A brand is collected for each investor by creating the trading data of the components for each investor and targeting the trading profit and loss level trading data of the A brand. The information processing system calculates various valuation indicators that affect the trading profit and loss level trading data of the A issue, learns the effect of these various combinations on the trading profit/loss, and learns the holding period of the A issue, the trading profit ratio, the trading profit ratio of the person who makes the maximum trading profit, the average holding period, and so on. If many of the people who win the A issue have purchased them most recently and continue to hold them at present, this can be judged and the success rate of holding the A issue can be indicated by the probability.

### (How to Generate Learning for AI Advice)

### (Purpose)

Learn which valuation indicators can be improved to improve the target profit or loss.

### (Steps in How to Generate a Learn AI Advisory Process)

A procedure for creating trading data to be aggregated and component trading data, a step of determining which profit or loss is to be improved, a step of calculating valuation indicators constituting the profit or loss by the information processing system, a calculation step of calculating a changing profit or loss by a combination of the original trading data and the valuation indicators calculated by the information processing system, and a combination to find an optimum solution are learned.

In order to judge what kind of advice is most likely to improve and to raise Mr. A's overall profit/loss ratio, the theme is which advice results should be presented, and it is learned whether or not the advice results are optimal. ZE with a higher overall profit/loss ratio can learn why they are higher, compare them with A, review their holdings, and rank stocks with a higher win rate or high profit rate. This can indicate that they are holding stocks with a lower average win rate or stocks with a higher loss rate, and provide advice on how to review their holdings.

(Definition of Advice by Aggregate Target Trading Data by Component with the Investment Target as a Component of the Aggregated Target Trading Data by Investment Target)

An example of advice based on component-specific trading data that includes the investment target of the trading data for each investment target is as follows: the information processing system provides advice on the trading status and profit/loss status of other high-performing stocks, while displaying that many of the stocks in the ranking of trading profit/loss are ranked as 3500 out of 3900 stocks, and that many of the people in the ranking of trading profit/loss are posted negative, or the information processing system offers advice on proposals for higher-ranking stocks based on the low win rate of the stocks held. ˜One specific example is the provision of advice using valuation indicators (calculated under the applicable conditions) of (investment target)−(by investment target) and the provision of advice by the information processing system to increase the winning rate by showing the winning rate of stocks, and the provision of advice by the information processing system for holding stocks by showing the unrealized profit/loss ratio and the winning profit ratio by stocks.

(Issues with Conventional Technology)

Traditional investment advice includes FP's advice on the composition of stocks, advice on asset formation by investment advisers, advice on stocks, and advice on the sale and purchase of investment trusts and stocks by securities companies. Many of these are based on intuition, knowledge, and experience, and the gender is strong, and the difference is very large depending on the person. Computer-based advice is high-level and difficult. In recent years, robot advisors and the like have become popular, and advice by robots has emerged. The advice provided by the information processing system is, for example, what is different from such advice, advice that has never been given based on trading data, and advice that is given from a variety of viewpoints in order to provide advice that is conducted by using not only the trading data but also the trading data conducted by many investors as knowledge.

(Effects of Aggregate Target Trading Data by Component with the Investment Target as a Component of the Aggregated Target Trading Data by Investment Target)

How does the information processing system actually provide advice functions? The information processing system generates various data such as a comparison, a ranking, a display of valuation indicators, a diagnosis, and the like on a daily basis from an evaluation of an investment target. Not only investments, but also the results of comparisons, rankings, indicators, diagnoses, etc. are generated every day from investor evaluations. Each transaction moves and the information processing system generates different data. These data are recorded in the recording unit 33, and various advice data can be generated. When investor A decides to make an investment with a high probability of failing, the information processing system can calculate that the probability of failing is low by the information processing system and teach the information on the display screen of investor A, or the information processing system can determine and teach that the issues held by the holdings all have failed, and that there are a large number of people who want to sell even if they return, because the stocks have a large amount of pressure to sell.

(Effects of Aggregate Target Trading Data by Component with the Investment Target as a Component of the Aggregated Target Trading Data by Investment Target)

Most of the advice on investment products to date is personal or robotic, and most of them provide portfolios such as ETF tailored to users' investment experiences and investment styles. Robotic advisors on trading individual stocks are more difficult than ETF portfolio advice. Because there are more choices, prices are more intense, and the investment gap is wider than ever. In particular, the advice of buying and selling using the trading data, which is a dynamic concept, is not a portfolio that is a static concept, but a service that takes one step or two steps ahead. Specific examples of the generation of the advice data are described in various places, and all of them generate advice data that is unique to the information processing system.

(Specific Examples of Aggregate Target Trading Data by Component with the Investment Target as a Component of the Aggregated Target Trading Data by Investment Target)

Regarding the evaluation, advice data has been fitted in FIGS. 103 to 106, and many specific examples have been mentioned in comparison, ranking, concrete examples, and diagnosis. These are various types of data for advising investors to finally make better investments, and can be used for advising because of the data generated by the information processing system to guide investors to better investments.

(Advice by Component Aggregate Target Trading Data by Component with the Investment Target as a Component of the Aggregated Target Trading Data by Investment Target)
(Issues with Conventional Technology)

An example of the advice based on component-specific trading data, which includes investors in the trading data by investment target, is the advice on the ranking of A in the trading profit/loss ratio ranking of the stocks purchased on September 10, and the advice on the trading profit/loss ratio of the stocks purchased on September 10. ˜The advice using the valuation indicators (calculated under the applicable conditions) in (the investment target)—(component) is an example. One example is to advise investors to increase the winning rate of A issues, and to advise stocks by showing the unrealized profit-loss ratio and the winning profit ratio for each investor.

The first step is the step of acquiring trading data, followed by a trading data creation phase. The second step is the step of creating transaction data to be aggregated. The third step is a step of creating the component-by-component sale data. The fourth step is a step of creating profit and loss level trading data. The fifth step is a calculation selection step of valuation indicators by the information processing system. The operation phase is a phase of “what to do” using the valuation indicators extracted and selected in the fifth step, and regardless of the order relationship with other steps.

The sixth step is an evaluation step. The seventh step is a comparison step with. The eighth step is a ranking step. The ninth step is a diagnostic step. The tenth step is an advice step. The eleventh step is a display step (this step).

### (Significance of the Steps for Display to be Aggregated)

For example, in response to the question of what is the calculation of the valuation indicators that affects the trading profit and loss of Mr. A, the trading level trading data of Mr. A is extracted and tabulated, and the winning rate, the winning rate, the loss rate, and the like are calculated together with the trading profit and loss by the information processing system. At this time, the winning ratio can be automatically calculated by the trading level trading data, but it is easier to obtain the winning profit ratio by creating the winning level trading data. Then, the necessary valuation indicators is calculated by the information processing system, but there is a problem in the display method of how to communicate these valuation indicators of Mr. A. Among investors, there are various types of knowledge, experience, and know-how, and display terminals. No matter how good a number, a good result, or a content to be improved, it is difficult to understand or understand. The display step is arranged to solve such a problem.

### (Issues in the Steps of Display to be Aggregated)

In this step, the valuation indicators and the resolution result calculated by the information processing system are displayed on what kind of the user.

### (Effects of the Steps for Display to be Aggregated)

Even if the calculation is performed by the information processing system of the same valuation indicators, it is required to display the problem, the valuation indicators, the news, and the like in accordance with how the resolution result can be solved in an easy-to-understand manner if the valuation indicators and the display corresponding to the problem are displayed.

For this purpose, there are two methods of making tables and machine-learning using AI. The method of creating and referencing a table can be solved by creating a correspondence table for different expressions by a problem, valuation indicators, an extraction condition, a classification method, an aggregation method, and the like. These correspondence functions may be machine-learned and learned in AI to select the optimal presentation methods.

### (Effects of the Steps for Display to be Aggregated)

It is very troublesome to select and express various display methods each time. However, the table lookup method can deal with various cases. For the problems of A, for the problems of radar charts and B, for the problems of graphs and C, it is possible to expect a special effect that various display methods become possible by setting items on the horizontal axis, items on the vertical axis, objects, and the like, for example, as valuation indicators and fiscal years.

### (Specific Display Step Specific Example)

### Example 1

For example, in displaying the win rate for trade A in 2020, the win rate for stock A in 2020 was percent, not just the win rate for stock A in 2020, and the highest win rate for stock Z in 2020. The ranking of the winning rate of A issues was 530. As shown in the figure above, it is easy to understand when a specific number is entered in the text.

In this case, in the case of the combination of the fiscal, the brand, and the winning ratio, the winning ratio of the xx year and xx brand was xx % in the text display, and the highest winning ratio of the xx year was xxx % and xx brand. The text should be matched and calculated separately to derive the highest winning stocks in FY2020.

### Specific Example 2

To show the ratio of trading profit to total trading profit for A issues in 2020 (for each investor), the trading data for each investment target extracted for A stocks is created, the trading data for each investor component is created, and the trading data at the trading profit/loss level is created (even if the trading data is available in the previous process), and valuation indicators are derived. However, even if the ratio of trading profit to total trading profit for A issues is shown as 2% for Investor A and 3% for Investor B, it is not a meaningful result.

However, users are very pleased that the calculated composition ratio of trades profit of A brand in 2020 was 20%, and that of B brand was 15%, and that of 20 brands in 2020, the ratio of sales loss was high was G brand, and that of 20% became negative, and that they pulled the foot in the pie chart. In order to make such a representation possible, it is possible to derive, by looking at a table, whether or not the ratio of trading profit to total trading profit of xx of x years is the same as the ratio of trading profit to total trading loss of other stocks, and to display them in a pie chart. Of course, if machine-learning is performed in AI, a more complicated process can be performed.

### Example 3

In aggregate target trading data by issue. The stock price chart is suitable for the display method, and it is an excellent display method to express the actual sale and purchase of Mr. A by the stock price chart. To solve the problem of knowing the profit-loss ratio by investor of A stocks, it is possible to display the stock price chart of A stocks and plot the purchase price, the sale price, and the set and profit and loss of each investor, and display the data.

### Example 4

As shown in FIGS. 101 and 102, if various conditions are added in FIG. 101, a data set according to the purpose is created, the necessary valuation indicators can be calculated, and the valuation indicators according to the purpose is calculated, so that various conditions and various forms of valuation indicators can be easily displayed in this step in various expressions. This process is just one step in FIG. 102, but since the evaluation target and the valuation indicators have been determined through a series of collaborations, the evaluation target described in this specification can be displayed by a number of display methods using a number of valuation indicators in many forms.

### (Significance of Display of Trading Data Linked Chart)

Regarding the trading data linkage chart, the usual stock price chart is associated with stock information. There are charts that have the function of presenting corporate performance, technical indicators, event information, etc. However, there are no charts that together present information about various trades in conjunction with the trading data. The trading data refers to general information about the purchased brand, such as the purchase date, the purchased brand, the holding period, the sale date, and the market price of the held brand.

### (Conventional Problems)

Conventional chart display is biased toward brand information, and a method of interlocking with brand information is mainly used.

### (Operation of Display of Trading Data Linked Chart)

In comparison, the trading data linkage chart indicates not only the purchase date and the purchased brand but also the overall method of displaying information associated with the holding period, the price hike rate after the purchase of the held brand, and the like on the chart. If the holding period is, for example, 20 days have elapsed, the price movements 20 days after the purchase date and 20 days have elapsed since the purchase date are the current stock price movements. However, this trading data linkage chart shows the ranking of the rate of change in the current stock price movements during the period when other stocks are purchased. It is also a form of this trading data linkage chart that shows the price movements of other stocks on the same theme from the purchase date during the holding period, and the trading data linkage chart shows the average holding period of other investors who purchased the same stocks at the same timing during the period, and the information linked to the trading data.

### (Effect of Display of Trading Data Linked Chart)

In general, information related to issue information is corporate performance, or stock price information is displayed together with brand information. However, information related to trading data is information related to various valuation indicators, such as holding period and winning rate. When these pieces of information can be displayed on the stock price chart, the user can display that the user has failed based on the behavior of other investors or the trading tendency to buy or sell, so that the user can provide unprecedented information, such as displaying that the winning rate is poor.

### (Example of Display of Trading Data Linked Chart)

In addition to the above, there are methods shown in FIGS. 103 to 106 based on the current stock holdings.

The first step is the step of acquiring trading data, followed by a trading data creation phase. The second step is the step of creating transaction data to be aggregated. The third step is a step of creating the component-by-component sale data. The fourth step is a step of creating profit and loss level trading data. The fifth step is a calculation selection step of the valuation indicators by the information processing system. The operation phase is a phase of “what to do” using the valuation indicators extracted and selected in the fifth step, and regardless of the order relationship with other steps.

The sixth step is an evaluation step. The seventh step is a comparison step with. The eighth step is a ranking step. The ninth step is a diagnostic step. The tenth step is an advice step. The eleventh step is a display step. The twelfth step is an automatic article generation step (this step).

### (Definition of Automatic Article Generation Step)

The information processing system generates various types of information. Advice data and diagnostic data are useful when individual investors use individual trading data, but because the system handles trading data, various other information is generated. How individual investors buy and sell is often taken up as a success case in magazines. However, some information is biased, and it is the fact that most of the cases of success and failures and the average appearance are not found in the world that appears in the world. Among the information generated by the information processing system, the ranking information, the data of the valuation indicators generated by the information processing system from the trading data to be counted for each period, the trading data to be counted for the investment target, and the like include a large number of information that can be used for distribution of various articles. It is apparent from the description of the above embodiments. From the viewpoint of this article distribution system (article data generation system), the article automatic generation step of the twelfth step is taken.

(Issues with Conventional Technology)

Regarding an automatic article generation system, a document automatically generated in accordance with the announcement of settlement of accounts, such as JP-A-2020-157142, is described in which the contents of an article automatically generated with respect to the announced settlement of accounts, etc. are focused on characteristic matters included in the announcement content. This is an article generation system which automatically generates the contents of an automatically generated article with respect to the published article by focusing on characteristic matters included in the content of the presentation based on the settlement information, stock price information, settlement information, and the like. The main purpose of this system is to catch up with the announcement of corporate performance quickly, and to automatically generate articles that can appeal to the high level of attention by automatically focusing on the characteristics of stocks that have a large upward revision range (the size of the divergence rate between forecasts and actual results (10, 13) and a large divergence rate between forecasts and past figures (14) and other companies (15)).

(72), (73) also describes the profitability of corporate performance. However, this article generation system does not mention any transaction data. This technology focuses on revisions and announcements of corporate performance, which are highly likely to have a large impact on stock prices. It is possible to automatically generate articles based on the announcement of corporate performance announcements. However, this prior art has a major problem. This is because after a company's earnings announcement, it is not clear how investors will take investments and how performance announcements will have an impact on investors' investments. It is the information processing system that can generate an article on how the investment action has been taken based on the actual investment action. Needless to say, this is not limited to the announcement of business results, such as an upward revision.

### (Effects of the Steps for Automatic Article Generation to be Aggregated)

In the information processing system, for example, in September 2020, the best 10 issues with the highest trading profit ratio (stocks that made a profit in actual trading behavior) were able to distribute articles such as what? automatically. This is a technology that goes ahead of the prior art, and is an epoch-making information processing system that can report and distribute investor's investment behavior after announcement of business performance. In this distribution, a series of cooperation is important, such as creation of trading data by technology of trading data to be aggregated by period, creation of trading data by component, confirmation of trading data set by creation of trading data at profit/loss level, and calculate of valuation indicators. Of course, the valuation indicators is automatically generated as a numerical value generated from the information processing system, and the generated data can be used for display and also for article distribution.

To explain how to realize the above flow, first, the information processing system issues an instruction to create tabulated trading data by period in September 2020 of the profit-and-loss level trading data, extracts the brands with the component brands and the performance announcement without the performance announcement (the event is used as a component item and managed by a check item without the performance announcement) using the component trading data, calculates valuation indicators such as trading profit for each trading data, calculates an average trading profit rate for each brand, and displays the average trading profit rate in a ranked manner. It is a technology in which everything is working together and one step and two steps have been advanced.

### (Effects of the Steps for Automatic Article Generation to be Aggregated)

The announcement of corporate performance has an impact on the stock price, but if it goes too far, the investment behavior will be disrupted. In other words, funds are concentrated on the day before and on the day when the performance is likely to be revised upward, and investments aimed at revising upward will be flowed in, and those that may be revised downward will be sold at a glance, which is one of the causes for the upside of stock prices. It is proceeding in a direction different from the assumptions at that time, which encourages speculative acts. This is largely because the actual investment behavior is still invisible. Because they are invisible, they fall into doubt, and there are speculative actions and investment actions that do not bear sight. According to the information processing system, it is expected that the actual investment action will be visualized, and that such speculative action will be resolved. Eventually, the difference between investment and speculation is that while speculation advances gambling and only some users can use it, investment makes it possible for many people to participate with peace of mind, and it is a technology and invention that can contribute to strengthening investment flows from savings.

### (Example of Automatic Article Generation Step)

The most recently announced stocks in September 2020 with the highest trading margin (mean ROI), such as the Best 10 stocks, can be automatically generated by changing parameters even if the timing changes. This is a technique that can be avoided because the technology of the transaction target data by period is effective. Without the aggregate target trading data by period (completed version), the correct data is not released, and valuation indicators called the trading profit/loss ratio (average) is generated by the information processing system through a series of collaborations. In addition, in the description, many concrete examples of the generation of the article data are also given.

As shown in FIGS. 101 and 102, if various conditions are added in FIG. 101, a data set according to the purpose is created, the necessary valuation indicators is calculated, and the valuation indicators according to the purpose is calculated, so that various articles data can be easily generated by various conditions and various forms of valuation indicators in the step. This process is just one step in FIG. 102, but since the evaluation target and the valuation indicators have been determined in a series of collaborations, it is possible to generate a large number of articles of the evaluation target described in this specification using a large number of types of valuation indicators.

### (Manage Articles in the Generated Data Management Table)

By creating the generated data management table, the generated data can be managed in a unified manner from how the generated data has been created to how the generated data has been displayed and how it has been used. The generated data management table includes at least a generated data ID and a distribution method (including management in a separate table), and the data generated by the information processing system can be managed not only how the data is displayed but also how the generated data is accessed from the marketplace and how the popularity has become. For example, the information processing system can generate generation data such as valuation indicators of the entire investor, a comparison between the investor of the stock and the investor of the virtual currency, and an analysis of the current status of the U.S. stock investor.

### (How to Use the System as a Problem Solving System)

(Definition of a system for solving problems)

The information processing system is an information processing system that inputs trading data and generates various kinds of information as described above through the process of the second step to the twelfth step. This process is a process for generating data such as advice. On the other hand, it is a system that can solve various investment issues.

The tasks required by this question vary from question to question. If the trading profit/loss ratio is used, the trading data is generated from the trading data, the trading profit/loss ratio of each trading data is calculated, and the average trading profit/loss ratio is calculated.

The part that derives various results from the trading data is rich in calculation and display of evaluation and valuation indicators, compare, ranking, diagnosis, advice, and the like in the examples of the first embodiment and the fourth embodiment just described. These are, on the contrary, answers that come out when queried. For example, when Mr. A generated information that Mr. A won 52% in 2020, and Mr. A and the administrator inquired about Mr. A's winning rate in 2020, the use of the latter would be wider.

If the question is decided, the answer is decided. If the answer is decided, the question is how to get to the answer if you work from the buy and sell data. When the answer is decided, the information processing system is further enhanced by accumulating and incorporating the part in which the work is decided in the storage unit first. That is, by simply inquiring in the first step from the first step to the twelfth step described above, the information processing system starts running for a result and generates information, thereby providing a more convenient information processing system. On a daily basis, ranking data, comparison data, evaluation data, diagnosis data, advice data, valuation indicators data, and the like are generated by the information processing system. These generated data can be utilized in response to requests from an administrator, a user, and a user as well as an input person of the trading data. When an investor seeks advice, answers and generates advice can be used when a user (including an administrator) wants to resolve an investment challenge. If the administrator generates a blogging story, it can be handled by extracting the ranking tables from DB. Needless to say, the same applies to the creation of news articles.

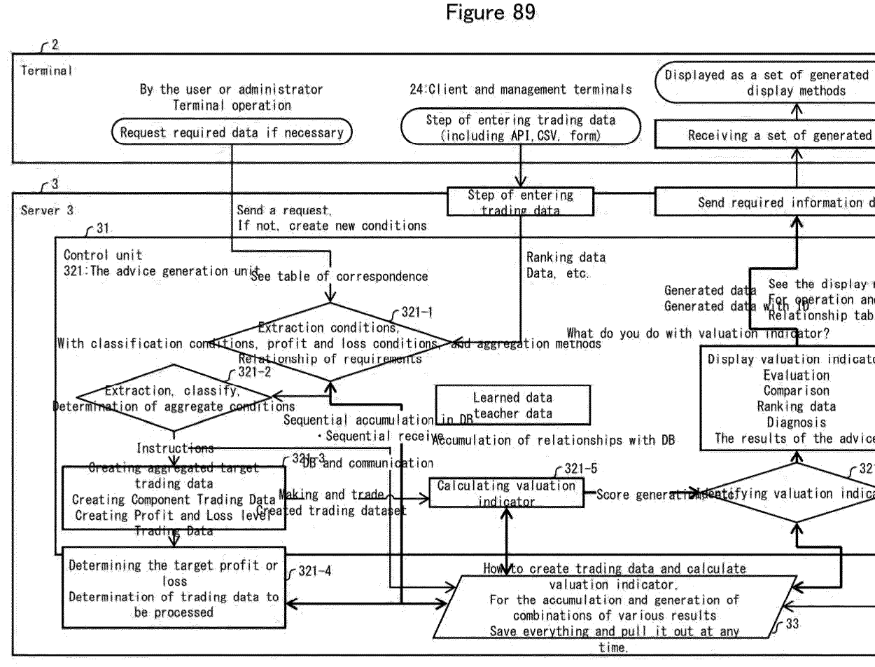

FIG. 89 is a diagram illustrating a table reference system of an information processing process according to Embodiment 4 of the present invention. As shown in FIG. 89, starting from the input of trading data and the transmission of request data (whether the administrator or the user is allowed), data is generated through various generation processes, and the result is received and displayed. The generation system follows the eleven steps described herein. The user (including the administrator) can receive multifaceted advice on his/her own trading by inputting the trading data. As shown in FIG. 89, it is possible to expect the weaknesses, management, and improvement of itself, while managing compares, rankings, and the like with other companies based on their own trading data. It is a function of the problem solving system of the information processing system that necessary data can be extracted when necessary and various advice can be received.

(Issues with Conventional Technology)

In response to a request from a user, how should an answer be derived? In response to a question from an administrator or a user, what kind of work is to be performed, how should an instruction be sent to an information processing system, and what percentage of the above-mentioned win rate is, the trading profit and loss level trading data is extracted, and if the number of winning trades (the number of times the trading profit is generated) is divided by the number of times of trading, it can be calculated by the information processing system. This question has already been solved in Embodiment 1. However, in the case of general users, the level of skills varies as compared with the case of administrative users. Therefore, the problem of the user interface which enables the query to be easily made becomes important. If the storage unit 33 stores the winning ratio, the work of how the winning ratio is calculated can be performed immediately by referring to the table in the information processing system. As various valuation indicators are calculated and various evaluations, compares, rankings, diagnosis, and advice are performed, the calculation procedure, the diagnosis result, the advice result, and the like are recorded in the storage unit 33, and conversely, when a question is asked to calculate the valuation indicators, the procedure can be easily extracted from the storage unit 33. That is, in the first embodiment as well as the fourth embodiment, the combination of the question and the answer is stored in the storage unit 33 as needed. In the above example, by extracting the trading profit and loss level trading data and dividing the number of winning trades (the number of trades with trading profit) by the number of trades, the winning ratio can be calculated. This is the relationship between the work (calculation work such as the number of winning trades) and the result (calculation of the winning rate). The answer to how to calculate the winning rate is to calculate the number of winning trades. Therefore, if the information processing system refers to the combination of the work and the result, it is possible to guide what kind of work should be performed as the combination table of the result and the work. In addition to the combination work-result table, automation by AI using the storage unit 33 is also included. By learning that such a result is generated from the work, it is learned that this work is performed in order to produce this result.

### (Action of the Problem Solving System)

The idea of this problem work combination table is the reversal of the problem that can be solved by the work. Incorporation into the step of solving the problem due to the existence of the work makes it possible to incorporate into the step of solving the problem due to the existence of the necessary work. If there is a table that combines the above-described problem of how many percent of the winning rate, the creation of the trading profit and loss level trading data, which is the work, and the calculation of the number of winning trades/the number of trading transactions, this problem can be solved immediately by the information processing system. In other words, if an inquiry is made to the information processing system at any time, the work that can be extracted is known, and thus it can be derived. This is because the information processing system can understand that if the information processing system performs the operations (calculation and extraction operations) of calculating the trading profit level trading data and the number of winning trades and calculating the number of times of trading, the problem of knowing the winning ratio can be solved. Creating a table that summarizes the work and results table will more clearly define the relationship between the task and the work (see FIG. 91).

### (Database Generation Process)

At the time of generating the advice, at the time of generating the article, at the time of requesting the data, and also at the time of requesting the data, the relationship is stored in the table 321-1 in the generated generation process under a certain condition with respect to the transaction data at that time. Extraction conditions for trading data, classification conditions, aggregate rules, procedures for creating trading data, target profit/loss, valuation indicators, operations (diagnosis, etc.) in the operation step, generated contents, numerical data, and the like are sequentially recorded. For the same request, the same step is required, but the stock price and trading data are updated one by one, so the data is updated. These update data are also sequentially accumulated. Since this step is carried out both when the advice is generated by badge processing or the like and when the requested data is generated, the generation of the data is DB advanced under various conditions as the time elapses and the use is made. Next, when the same problem or the requested article is requested, the table data is retrieved from the storage unit and the determined rule is executed even if the rule is not newly created. If the learning function is added here, the machine learning proceeds, and it becomes possible to answer various complicated requests. Automation advances through reinforcement learning, etc. Since the operation in the server is the same step, the learning proceeds in the same way.

### (Effects of the Problem Solving System)

Embodiments 1 and 4 specify a number of investment issues and a method of solving the investment issues. The calculation of various valuation indicators is also the same. An information processing system that takes an inquiry first, determines how to process buy and sell data from an inquiry held by a user, and resolves the inquiry is effective in that it is easy for anyone to understand. Compared with the fact that we can solve various problems from the trading data, to solve the problems that users have, please look at this valuation indicators. It is easier to understand. The same implication is the difference between the way in which the cause is communicated and the way in which the cause is traced and the way in which the cause goes to the conclusion.

### (Specific Examples of Problem Solving Systems)

### Example 1

What percentage of winners can be calculated by the information processing system based on the number of winners and the number of trades (number of winners/number of trades) from the trading profit/loss data.

### Specific Example 2

The problem of winning profit ratio of what percentage can be calculated by the information processing system on the average of winning profit/winning purchase price from winning trade data.

### Example 3

The problem of the percentage of unrealized loss ratio can be calculated by the information processing system from the average of the purchase price of unrealized loss/unrealized loss from the unrealized loss level trading data.

### Example 4

In order to solve the problem of how many days the average number of trading days is, the number of trading days can be calculated from the trading profit and loss data, and the total number of trading days can be calculated by the information processing system if the number of trading days is divided by the number of trading days. Although these are possible levels in the first embodiment, the following cases are possible in the fourth embodiment.

### Example 5

The question of what percentage of targets in 2020 is: Mr. A's data on sales and purchases by period in 2020 is compiled, and the trading profit/loss level data is compiled (even if it is in the previous process), and the number of winners/purchases can be calculated by the information processing system.

### Example 6

The question of what percentage of A's stock A's winning profit margin is: A's stock A's trading data for each type of investment can be compiled, and winning profit trading data can be compiled and calculated from the average winning profit/purchase price. If the information processing system performs these series of operations (i.e., compilation of trading data for A's A issues, compilation of winning profit trading data, and average of winning profit total/purchase price), anyone can calculate the trading profit/loss ratio for A stocks in 2020.

### Example 7

In 2020, the person who had the highest rate of trading profit and loss on A issues was asked what kind of trading was done by preparing trading data for each investment subject under the selection condition of A stocks in 2020, preparing component trading data classified by investor, and ranking them by trading profit and loss ratio (total trading profit and loss/average purchase price). In the fourth embodiment, although various valuation indicators can be calculated, the information processing system is capable of answering various issues in a reverse manner.

### Example 8

As shown in FIGS. 101 and 102, if various conditions are added in FIG. 101, a data set according to the purpose is created, the necessary valuation indicators is calculated, and the valuation indicators according to the purpose is calculated, so that various investment problems can be easily solved by various conditions and various types of valuation indicators even in this step. This process is just one step in FIG. 102, but since the evaluation target and the valuation indicators have been determined in a series of collaborations, it is possible to solve many problems with the evaluation target described in this specification using many forms of valuation indicators.

### (Selection Method and Table Reference Method)

In order to satisfy various needs of investors, clicking on the diagnosis result using the trading data displays the diagnosis result, and the like is one of the selection methods. The selection method described here clarifies this point.

### (Overview of Selection Method)

In the case of a problem solving system or an article generating system, a result set (a combination of results for displaying and distributing to a terminal) is provided in response to a request for a problem or an article from a user or an administrator in a user terminal. There are two methods of selecting and inputting a request for an issue and an article, and there are also a table lookup method and an AI method.

### (Operation of Selection Method)

Even in the conventional method, this selection method is possible (a selection method using only one button is displayed), but when the content derived from the trading data of Mr. A is listed in the terminal of Mr. A, which is the simplest case, by the selection method, and Mr. A selects the content, the result of his diagnosis is displayed or the result of ranking is displayed. This is one of the selection methods. A list is displayed, and the result set is sent and displayed when the list is selected. For example, in the case of a selection method, the method refers to a method in which a user terminal or an administrator terminal selects an extraction condition or the like by selecting a problem or an article required by the user by pull-down or selecting an article in a list format, and executes the selection condition or the like, whereby the second step to the eleventh step is executed, and the result is displayed. In this case, for example, when an example of the creation of the transaction data to be aggregated is taken, it is necessary for the user to make a selection by providing options such as “extraction conditions: year, issue, investment type, etc.”, “classification criteria: brand, investor”, and “aggregation criteria: brand by brand”.

### (Definition of Inquiry)

The inquiry is a problem to be solved concerning an investment product, and refers to at least one of comparison of valuation indicators, ranking of valuation indicators, display of valuation indicators, diagnosis by valuation indicators, and advice by valuation indicators. By knowing this, it is possible for investors to find ways to solve problems (improve investment results). These inquiries are information generated by the information processing system of the first embodiment and the fourth embodiment. Of course, these pieces of information can be used well as news and topical articles. FIG. 64 is a relationship diagram of a server and a terminal, but the relationship between the transaction data and the valuation indicators, the relationship between the result and the inquiry, and, if reversed, the result of the advice and the work procedure are sequentially accumulated as the cooperation with the database is also displayed here (see FIG. 2).

FIG. 75 is a diagram illustrating a reference of a table of a display method of an information processing process according to the fourth embodiment of the present invention. That is, FIG. 75 is a reference diagram of the display table. A table is created to associate the valuation indicators with the display method for easy-to-understand display in a suitable display. When the profit composition ratio of a stock is determined as valuation indicators, a pie chart with the stock name in the pie chart is more suitable than a mere list of the composition ratios. In the case of “valuation indicators=profit composition ratio of the issue”, the pie chart is displayed with reference to this table. In addition to the valuation indicators, by referring to a table that connects operations such as problems, profit and loss, extraction conditions, and advice, compare, and ranking, and a display method, an appropriate display method can be selected, and an easy-to-understand display can be performed.

### (Significance of Table Reference Method)

FIG. 89 is a diagram illustrating a table reference system of an information processing process according to Embodiment 4 of the present invention. If necessary, a request for necessary data is a request made by a user or an administrator to the information processing system, which is expressed as a problem. A problem is transmitted, the information processing system receives the problem, refers to the table, and if the problem is a problem in the table, refers to the table, and recognizes that the problem is not a new problem, and creates a new condition. In the case of anew issue, new conditions such as extraction, classify, and aggregate, profit/loss level, and necessary valuation indicators are set. In the case of an existing problem, by calling these conditions and the like from a table and issuing an instruction to the information processing system, various types of trading data are created, valuation indicators are calculated, and various operations are performed. In the case of a new problem, a command such as a condition, a calculation valuation indicators, an operation to be executed, and the like is issued, and when the next same problem comes, the command is recorded in a table so that the command can be automatically read. This schematic is FIG. 89.

As described in FIG. 71, by referring to the reference table, this relationship becomes clearer, and it is possible to add patterns more and more, and it is possible to solve various problems by making it easier to display the problem solving and the result of the maintenance. The flow from the reception of the trading data is the same as that of a normal information processing system. The extraction method, the aggregation, and the classification method of the sales data generated here are accumulated in the storage unit 33 each time, and the history of the calculation of the valuation indicators, the specification of the valuation indicators, which operation (evaluation or compare or diagnosis, or advice) has been performed, and how the display has been performed is accumulated (see FIGS. 2 and 42).

In the case of the table reference method, the problem to be associated with the table, the article, the extraction condition, and the like are associated with each other in a table such as an extraction condition, and in the case of the problem or the article (request for the article) that has been in the past, the extraction condition, the classification condition, and the aggregate condition are used to create the sales data with reference to the table, and in the case where the extraction condition, the classification condition, and the aggregation condition are not used, the correspondence table is enhanced by creating a new one. The table lookup method plays an important role in connecting each step (the first to eleventh steps) in an important method when an issue or an article is not input by a selection method or a management screen method.

### (Important Role of Information Generation Table)

It is a table having data such as a user and an advice generation date, extraction conditions of trading data, classification conditions and aggregation conditions, types of created trading data, calculated valuation indicators, what has been performed (display of valuation indicators, diagnosis result, comparison, ranking, advice), what results (text of diagnosis results, etc.), and the like (if there are many items, the table may be divided). These pieces of information are data calculated by the advice generation system and stored in the storage unit 33, but in the reference table method, it is possible to expect effects such as easier reference later by managing the information in a separate table. This is an information generation table, and as mentioned above, this table is also an effective table for solving the problem. That is, in a simple example of what has been performed, for example, the display of the winning rate, if there is data that has displayed the winning rate in this table, it is possible to immediately refer to the operation procedure such as the extraction condition of the trading data used therein and the type of the created trading data. Therefore, the work procedure can be clarified from the problem of calculation of the winning rate, and a route for solving the problem can be achieved. As this table is expanded, in the storage unit 33, the diagnosis result, the advice result, the calculation of various valuation indicators, and the like are gradually accumulated, and the procedure of how to perform the work in the information processing system is accumulated for a large number of inquiries.

(Issues with Conventional Methods)

Although the diagnosis result presented by the advice generation system and the route from which the diagnosis result is output are stored in the storage unit 33 without creating the reference table, there are problems such as lack of listability and difficulty in management. On the other hand, in the reference table method, various advice data, diagnosis results, ranking results, comparison results, and the like are executed in what process, and what valuation indicators has been used becomes clear at a glance.

### (Operation of Table Reference Method (Refer to FIG. 93))

The normal advice data generation route is as described above. On the other hand, the inquiry route is the first inquiry, and the inquiry is referred to in the information generation table. For example, if the task of calculating the win rate is found, the work procedure is clarified from the table, and if the work is continued until the result is obtained, as in the case of the normal route, the present win rate is immediately calculated. As a matter of course, the same winning rate for Mr. A will also differ if the dates are different. The procedure once remembered is automated and recalculated every day, and all the calculation results and processes can be stored in the storage unit 33 and retrieved at any time.

As shown in FIG. 93, the steps from the second step to the eleventh step are automated by the table method. For example, to address the problem of wanting the overall P/L ranking in 2020, we will instruct the compilation of transaction data by period in 2020 (extraction condition: period=2020), compile the component trading data by issue, aggregate by issue (classification condition: investment target: issue, aggregation rule: individual issue), and profit/loss correspond to the word general profit/loss ratio (profit and loss level trading data), and select the presentation method corresponding to these result sets with “valuation indicators=total profit/loss ratio” and “operation:=ranking,” and the table reference for all phases is determined, and as a result, the results of trade/loss ranking in 2020 are displayed. Once recorded in a table, these associations are set in the table at one time, and the articles and issues are automatically resolved. All of these fourth phases may be automated or part of them. The creation of these tables also plays a crucial part in AI of learning AI.

### (Effect of Table Reference Method (FIG. 93))

As the data in the information generation table is added, the number of inquiries that can be referred to increases, and a special effect that various investment issues can be solved can be expected. Since the conventional method is not managed by a separate table, it is difficult to centralize management, but in this method, it is easy to centralize management, the history can be easily confirmed, and it is also possible to easily display the past result history to the user. Even in the inputting method, various problems and articles can be automatically generated by the information processing system. However, in the table looking-up method, AI can be improved and various needs can be identified, so that a particular advantage can be expected. In the selection method, when an administrator prepares a problem or an article and a user or an administrator makes a selection on the user terminal, various conditions are determined, and steps from the second step to the eleventh step are performed, and a result is output. In the table reference method, an input can be selected by a user or an administrator, and if the input is a problem or an article in a table, the input proceeds from the first phase, and if there is no corresponding table, a screen for adding a new item of the corresponding table to create a new rule appears, and when the new item is added, the input can be created so as to proceed to the next step. Users and administrators can draw out the articles and issues they need, enrich tables, and often have special effects that allow them to answer quickly.

### (Specific Example of Table Reference Method)

Accumulation of data in a normal route: The calculation of valuation indicators, the calculation of a diagnosis result, and the like are managed from the trading data in the normal route. In addition to the above examples, for example, in response to the question of the average profit ratio of the winners of SoftBank shares, the trading data for each investment target (extraction condition: brand=SoftBank) and the winning profit level trading data (profit/loss=winning profit ratio) are created (valuation indicators=average winning profit ratio for each investor), and the operation is the display of the valuation indicators. These are familiar to all of the previously described embodiments and are applicable to all of the described embodiments.

### (Specific Example of Table Reference Method)

As illustrated in FIG. 89, for example, when the information processing system is requested to determine whether the average profit-loss ratio of the entire investor of S Company's shares in 2019 is satisfied, the following procedure is instructed to the information processing system in the case of the first problem requested. In 2019, it is recorded in a table by instructing create of trading data subject to period-by-period aggregate by “Brand code=xxxx (S1 Co., Ltd.)” and instructing “instruction of creation of trading profit and loss level trading data of the trading data, calculation of trading profit/loss ratio for each trading record, calculation of average trading profit/loss ratio, and display of this in an appropriate manner”. To address the problem of whether S2 shares were invested in 2020 or whether the overall average trading profit/loss ratio would be the same as in 2020, it is necessary to change the brand code. Therefore, if the fiscal and brand code were prepared in a separate table, they could be referred to by the information processing system. Therefore, they could be regarded as existing issues rather than new issues.

### (Accumulation of Data in the Query Route)

The inquiry routes are also recorded in the same table. If the win rate is desired every day, it is executed in the same procedure, but since various data are refreshed every day, the win rate also changes. As the data is accumulated with the date, the transition of the winning rate and the like can be easily displayed. As mentioned above, the advice generation process is a query elimination process. If we can quickly refer to the history and graph the transition, we can expect a special effect of clarifying how the problem has been solved.

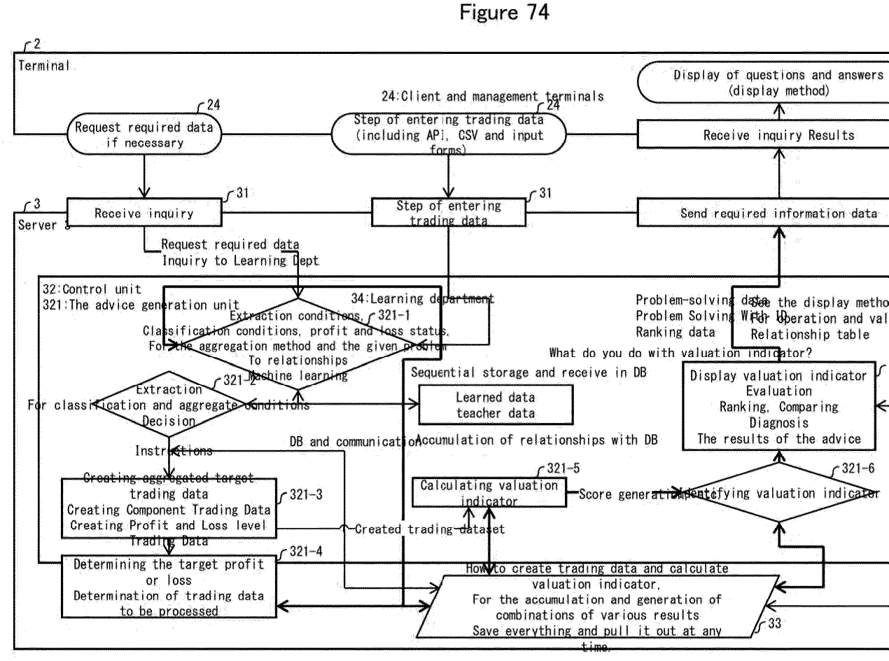

FIG. 74 is a diagram showing an AI machine learning process of the information processing process according to the fourth embodiment of the present invention.

### (AI Learning Method (Description of FIG. 74))

The problem of the above-described look-up table method is that it is necessary to accumulate a look-up table, and the more the accumulation proceeds, the more convenient and various problems can be solved, but there is a problem that the accuracy varies depending on the degree of accumulation of this table. On the other hand, since AI learning method learns the relationship between the creation method of the trading data, the calculation of the valuation indicators, and the combination of various outcomes, it is possible to use what has been learned from the learning of the relationships for the first time and the generation of the advice for the first time, to solve the problem or to generate the advice (including the diagnosis and the like) and to generate the article. The more it is used, the more the information processing system can learn the extraction and the like from various angles by creating such trading data at this time, and the effect which is not in the table can be expected. In the look-up table method, an administrator or a user must manually input an unprecedented problem, an article, or an unprecedented association to increase the association. In AI method, this association is automated, and machine-learning is performed so that AI responds to the demands of the user and the administrator, and the estimation and verification are repeated to improve the accuracy of the association.

(Issues with Conventional Methods)

As mentioned above, the problem of the table method and the previous method is the problem of the conventional method. The look-up table method requires the task of adding something not as described above, and various table associations must be prepared in order to produce the same result, such as the expression fluctuation, for example, 2020 being set to 2020, the current year, and the user input differently.

### (Operation of Selection Method)

Different from the table method, there is a learning unit, which enables machine learning of advice generation data and problem solving. How to generate a winning profit rate and how to generate a losing loss rate must be calculated from different trading data. As AI machine-learning progresses, the winning profit trading table and the losing loss trading table can be referenced from the relationship between the profit rate and the loss rate. This is a special effect that is not available in the table scheme.

### (Effects of AI Method)

In addition to the effects described above, there are many possibilities for machine learning, such as displaying this data for this person, this advice for this person, and this ranking for the weak part of this person. In the case of AI method, it becomes possible to gradually read the agreement between the previous example of 2020 and 2020, and last year, and the learning effectiveness works and improves so that the demand can be met. The tables used in the table method can be used as teacher data as they are, and the learned data is accumulated as it is used, and the more data that can be referred to, the higher the accuracy, and the more investment issues and news can be met. In this way, the learned data and the like become very valuable.

(Examples of AI method)

The embodiments described in the above-described steps are AI embodiments, and all of them apply, and the steps from the second step to the eleventh step may be AI, or may be stepwise, or may be AI in all of the steps (from the first phase to the fourth phase). It is a very useful method for the information processing system which has very complicated and diverse analysis and functions such as investment problem and problem solving, diagnosis and generation of advice data.

In addition to the examples mentioned above, there are the following specific examples.

### Example 1

The number of people making trading profits on A issues is increasing. In particular, it is conceivable that investors with high probability of success have begun to buy this information, and that this information be presented as recommended information to failing investors.

### Specific Example 2

In today's market, where more people have failed with reference to Twitter, investors referencing the quarterly report are outperforming, rather than referencing Twitter. For example, AI derives and displays the comparative data in order to convey the fact.

### Example 3

Mr. A's investment results are now far worse than everyone's average. The cause is shown in this evaluation value, and it is clear at a glance when compared with the average, so it is possible to sufficiently expect that it is displayed and comments are also given.

### [Software Implementation]

The control blocks (in particular, the control unit 22, the control unit 32, the control unit 302, the advice generation unit 321, and the information generation unit 3021) of the terminal 2, the server 3, and the server 30 may be realized by a logic circuit (hardware) formed in an integrated circuit (IC chip) or the like, or may be realized by software.

In the latter case, terminal 2 and server 3 are equipped with computers that execute the instructions of the program, which is the software that realizes each function. The computer is equipped with one or more processors, for example, and a computer-readable recording medium storing the above program. In the computer, the object of the present invention is achieved by the processor reading the program from the recording medium and executing the program. For example, a CPU (Central Processing Unit) can be used as the above processor. The above recording media can be “non-temporary tangible media,” e.g., ROM (Read Only Memory), etc., as well as tapes, disks, cards, semiconductor memory, programmable logic circuits, etc. The system may be further equipped with RAM (Random Access Memory) or the like to expand the above program. The above program may be supplied to the above computer via any transmission medium (communication network, broadcast wave, etc.) capable of transmitting the program. It should be noted that one embodiment of the present invention can also be realized in the form of a data signal embedded in a carrier wave, in which the program is embodied by electronic transmission.

The present invention is not limited to the above-described embodiments, and various modifications can be made within the scope of the claims, and embodiments obtained by appropriately combining the technical means disclosed in the different embodiments are also included in the technical scope of the present invention.

### EXPLANATION OF REFERENCE NUMERALS

1 Advice Presentation System
2 Terminal (Terminal equipment)
3,30 Server (information generating apparatus)
4 Network
321 Advice Generation Section (Information Generation Section)
3021 Information generator

1-7. (canceled)

8. An information generating apparatus for generating information on profit and loss of an investment commodity, the information generating apparatus acquiring trading data of the investment commodity, and performing an evaluation change on the investment commodity held at the beginning of a predetermined period and/or the investment commodity held at the end of a predetermined period with respect to the trading data.

9. The information generating apparatus according to claim 1, wherein that the information generating apparatus revalues the trading data of the investment commodity held at the beginning of the predetermined period at a price at the beginning of the predetermined period, and revalues the trading data of the investment commodity held at the end of the predetermined period at the price at the end of the predetermined period.

10. The information generation apparatus according to claim 1, wherein the information generation apparatus generates unrealized profit and loss including the investment commodity held at the end of the predetermined period.

11. The information generating apparatus according to claim 1, wherein the information generating apparatus generates information on trading profit and loss by investment type and includes an information generation unit that acquires the trading data for the investment commodity, generates investment subject-specific trading data in which the trading data by investment target, and generates information on trading profit and loss for each investment subject and/or information on unrealized profit and loss for each investment subject using the investment subject-specific trading data.

12. An information generating apparatus which generates information about profit and loss of an investment commodity, comprising: an information generating unit which generates trading data according to investment objects which acquired the trading data of an investment commodity, and the trading data classified for every investment object, and generates a realized profit-and-loss valuation indicator for evaluating trading profit and loss for every investment object using the trading data according to the investment objects, and/or an unrealized profit-and-loss valuation indicator for evaluating unrealized profit and loss for every investment object.

13. The information generating apparatus according to claim 5, wherein the information generating unit compares sales profit/loss level evaluation information and/or unrealized profit/loss level evaluation information between the investment targets, and generates characteristic comparison information of the trading profit and loss between the investment objects and/or comparison information of the unrealized profit and loss between the investment objects.

14. An information presentation system comprising: the information generating apparatus according to claim 1; and a terminal device, wherein the terminal device presents the information generated by the information generation unit to a user.

15. A computer program product comprising a non-transitory computer-usable medium having a computer-readable program code embodied therein, the computer-readable program code causing a computer to function as the information generation apparatus according to claim 1.
